(19) United States
(12) Patent Application Publication
(10) Pub. No.: US 2025/0324973 A1
(43) Pub. Date: Oct. 23, 2025

(54) Pest Control Composition and Control Method

(71) Applicant: SUMITOMO CHEMICAL COMPANY, LIMITED, Tokyo (JP)

(72) Inventors: Hiroshi Okamoto, Hyogo (JP); Yoshihiro Takebayashi, Tokyo (JP); Eiji Horikawa, Tokyo (JP); Koji Okumura, Tokyo (JP)

(73) Assignee: SUMITOMO CHEMICAL COMPANY, LIMITED, Tokyo (JP)

(21) Appl. No.: 18/287,087

(22) PCT Filed: Apr. 15, 2022
(86) PCT No.: PCT/JP2022/017903

§ 371 Date: Aug. 6, 2024

(30) Foreign Application Priority Data
Apr. 16, 2021 (JP) 2021-069475
Jul. 7, 2021 (JP) 2021-112754

(51) Int. Cl. A01N 53/00; A01N 25/06; A01N 43/90; A01N 65/40; A01P 7/04

(52) U.S. Cl. CPC A01N 53/00; A01N 25/06; A01N 43/90; A01N 65/40; A01P 7/04

(57) ABSTRACT

The present invention provides pest control compositions and control methods, and the pest control compositions containing natural pyrethrin can be used to control pests.

### TECHNICAL FIELD

This application claims priority to and the benefit of Japanese Patent Application No. 2021-069475 filed on Apr. 16, 2021 and Japanese Patent Application No. 2021-112754 filed on Jul. 7, 2021, the entire contents of which are incorporated by reference into this application.

This invention relates to a pest control composition containing natural pyrethrin and a method for controlling pests using the same.

### BACKGROUND ART

Various compounds have been investigated for the purpose of pest control. For example, Patent Document 1 describes that certain compounds have pest control effects.

### CITATION LIST

### Patent Literature

[PTL1] WO2016/129684

### SUMMARY OF THE INVENTION

### Problem to be Solved by the Invention

The present invention is to provide a composition for controlling pests and a method for controlling pests.

### Means for Solving the Problem

The present invention includes the following aspects.
1. A pest control composition containing natural pyrethrin.
2. A method for controlling pests by using the pest control composition according to the preceding clause.
3. The method for controlling pests according to the preceding clause 2, wherein the pests are pest arthropods.
4. A method for controlling a pest arthropod, including applying a pest arthropod control composition containing as active ingredients natural pyrethrin and one or more ingredients selected from the group consisting of sabadilla seed extract, cevadine, and veratridine, to the pest arthropod, or to a place where the pest arthropod occurs.
5. The pest arthropod control method according to the preceding clause 4, wherein the pest arthropod control composition is an aerosol formulation.
6. The pest arthropod control method according to the preceding clause 5, wherein the aerosol formulation is an aerosol formulation containing at least one of dimethyl ether and liquefied petroleum gas as propellant.
7. The pest arthropod control method according to the preceding clause 5 or 6, wherein the aerosol formulation is an aerosol formulation further containing as liquid carrier at least one selected from the group consisting of aliphatic hydrocarbons, aromatic hydrocarbons, esters, carbonates, and alcohols.
8. The pest arthropod control method according to any one of the preceding clauses 5 to 7, wherein the aerosol formulation is an aerosol formulation further containing water.
9. The pest arthropod control method according to the preceding clause 4, wherein the pest arthropod control composition is a pump spray formulation.
10. The pest arthropod control method according to the preceding clause 9, wherein the pump spray formulation is a pump spray formulation containing as a liquid carrier at least one selected from the group consisting of water, aliphatic hydrocarbons, aromatic hydrocarbons, esters, carbonates, and alcohols.
11. The pest arthropod control method according to any one of the preceding clauses 4 to 10, wherein the pest arthropod is at least one pest arthropod selected from the group consisting of Blattodea, Hymenoptera, Diptera, Siphonaptera, Acari, Lepidoptera, and Coleoptera.
12. The pest arthropod control method according to any one of the preceding clauses 4 to 10, wherein the pest arthropod is at least one pest arthropod selected from the group consisting of Blattodea, Hymenoptera, and Diptera.
13. The pest arthropod control method according to any one of the preceding clauses 4 to 10, wherein the pest arthropod is at least one of pest arthropod in Blattodea selected from the following groups;
A group of Ectobiidae consisting of German cockroach (Blattella germanica);
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
14. The pest arthropod control method according to any one of the preceding clauses 4 to 10, wherein the pest arthropod is at least one of pest arthropod in Blattodea selected from the following groups;
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
15. The pest arthropod control method according to any one of the preceding clauses 4 to 10, wherein the pest arthropod is at least one of hymenopteran pest arthropod selected from the following groups;
A group of Formicidae consisting of Solenopsis spp. consisting of red imported fire ant (Solenopsis invicta) and tropical fire ant (Solenopsis geminata); Atta spp. consisting of brown leaf-cutting ant (Atta capiguara); Acromyrmex spp.; Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala); Camponotus spp. consisting of Kurooari (Camponotus japonicus), Muneakaoari (Camponotus obscuripes); Pogonomyrmex spp. consisting of western harvester ant (Pogonomyrmex occidentalis); Wasmania spp. consisting of Kokamiari (Wasmania auropunctata); and long-legged ant (Anoplolepis gracilipes);
A group of Vespidae consisting of Asian giant hornet (Vespa mandarinia), Kebukasuzumebachi (Vespa simillima), Kogatasuzumebachi (Vespa analis), Asian hornet (Vespa velutina), Seguroashinagabachi (Polistes jokahamae);
A group of Siricidae consisting of pine wood wasp (Urocerus gigas); and
A group of Bethylidae.
16. The pest arthropod control method according to any one of the preceding clauses 4 to 10, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, and Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of house fly (Musca domestica), false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
17. The pest arthropod control method according to any one of the preceding clauses 4 to 10, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), northern house mosquito (Culex pipiens pipiens), Niseshirohashiieka (Culex vishnui), Asian tiger mosquito (Aedes albopictus), Chinese malaria mosquito (Anopheles sinensis), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
18. The pest arthropod control method according to any one of the preceding clauses 4 to 10, wherein the pest arthropod is at least one pest arthropod selected from the group consisting of German cockroach (Blattella germanica), American cockroach (Periplaneta americana), Formosan termite (Coptotermes formosanus), red imported fire ant (Solenopsis invicta), little red ant (Monomorium pharaonis), western harvester ant (Pogonomyrmex occidentalis), brown house mosquito (Culex quinquefasciatus), northern house mosquito (Culex pipiens pipiens), dengue mosquito (Aedes aegypti), Ganbiehamadaraka (Anopheles gambiae) and house fly (Musca domestica).
19. The pest arthropod control method according to any one of the preceding clauses 4 to 10, wherein the pest arthropod is at least one pest arthropod selected from the group consisting of American cockroach (Periplaneta americana), Formosan termite (Coptotermes formosanus), red imported fire ant (Solenopsis invicta), little red ant (Monomorium pharaonis), western harvester ant (Pogonomyrmex occidentalis) and northern house mosquito (Culex pipiens pipiens).
20. The pest arthropod control method according to any one of the preceding clauses 4 to 19, wherein the pest arthropod is a pest arthropod having reduced susceptibility to at least one selected from the group consisting of insecticides, acaricides, molluscicides and nematicides.
21. The pest arthropod control method according to any one of the preceding clauses 4 to 19, wherein the pest arthropod is a pest arthropod having reduced susceptibility to at least one insecticide selected from the group consisting of GABA-gated chloride channel blockers, sodium channel modulators, and nicotinic acetylcholine receptor competitive modulators.
22. The pest arthropod control method according to any one of the preceding clauses 4 to 21, wherein the pest arthropod control composition is a pest arthropod control composition further containing dill extract.
23. An aerosol formulation according to any one of the preceding clauses 5 to 8 and 11 to 22.
24. A pump spray formulation according to any one of the preceding clauses 9 to 22.
25. A method for controlling a pest arthropod, including applying a pest arthropod control composition containing as active ingredients natural pyrethrin and one or more ingredients selected from the group consisting of sabadilla seed extract, cevadine, and veratridine, to a place where the pest arthropod occurs so that an amount of one active ingredient is 0.01 to 1000 mg per 1 m².
26. The pest arthropod control method according to the preceding clause 25, wherein the amount of one active ingredient is 10 to 500 mg per 1 m².
27. The pest arthropod control method according to the preceding clause 25 or 26, wherein the place where the pest arthropod occurs is at least one selected from the group consisting of architectural structures, outdoors, foods, and daily necessities.
28. The pest arthropod control method according to any one of the preceding clauses 25 to 27, including applying the pest arthropod control composition on a surface of the place where the pest arthropod occurs.
29. The pest arthropod control method according to any one of the preceding clauses 25 to 28, wherein the pest arthropod is at least one pest arthropod selected from the group consisting of Blattodea, Hymenoptera, Diptera, Siphonaptera, Acari, Lepidoptera, and Coleoptera.
30. The pest arthropod control method according to any one of the preceding clauses 25 to 28, wherein the pest arthropod is at least one pest arthropod selected from the group consisting of Blattodea, Hymenoptera, and Diptera.
31. The pest arthropod control method according to any one of the preceding clauses 25 to 28, wherein the pest arthropod is at least one of pest arthropod in Blattodea selected from the following groups;
A group of Ectobiidae consisting of German cockroach (Blattella germanica);
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
32. The pest arthropod control method according to any one of the preceding clauses 25 to 28, wherein the pest arthropod is at least one of pest arthropod in Blattodea selected from the following groups;
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
33. The pest arthropod control method according to any one of the preceding clauses 25 to 28, wherein the pest arthropod is at least one of hymenopteran pest arthropod selected from the following groups;
A group of Formicidae consisting of Solenopsis spp. consisting of red imported fire ant (Solenopsis invicta) and tropical fire ant (Solenopsis geminata); Atta spp. consisting of brown leaf-cutting ant (Atta capiguara); Acromyrmex spp.; Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala); Camponotus spp. consisting of Kurooari (Camponotus japonicus), Muneakaoari (Camponotus obscuripes); Pogonomyrmex spp. consisting of western harvester ant (Pogonomyrmex occidentalis); Wasmania spp. consisting of Kokamiari (Wasmania auropunctata); and long-legged ant (Anoplolepis gracilipes);
A group of Vespidae consisting of Asian giant hornet (Vespa mandarinia), Kebukasuzumebachi (Vespa simillima), Kogatasuzumebachi (Vespa analis), Asian hornet (Vespa velutina), Seguroashinagabachi (Polistes jokahamae);
A group of Siricidae consisting of pine wood wasp (Urocerus gigas); and
A group of Bethylidae.
34. The pest arthropod control method according to any one of the preceding clauses 25 to 28, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, and Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of house fly (Musca domestica), false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
35. The pest arthropod control method according to any one of the preceding clauses 25 to 28, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), northern house mosquito (Culex pipiens pipiens), Niseshirohashiieka (Culex vishnui), Asian tiger mosquito (Aedes albopictus), Chinese malaria mosquito (Anopheles sinensis), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
36. The pest arthropod control method according to any one of the preceding clauses 25 to 28, wherein the pest arthropod is at least one pest arthropod selected from the group consisting of German cockroach (Blattella germanica), American cockroach (Periplaneta americana), Formosan termite (Coptotermes formosanus), red imported fire ant (Solenopsis invicta), little red ant (Monomorium pharaonis), western harvester ant (Pogonomyrmex occidentalis), brown house mosquito (Culex quinquefasciatus), northern house mosquito (Culex pipiens pipiens), dengue mosquito (Aedes aegypti), Ganbiehamadaraka (Anopheles gambiae) and house fly (Musca domestica).
37. The pest arthropod control method according to any one of the preceding clauses 25 to 28, wherein the pest arthropod is at least one pest arthropod selected from the group consisting of American cockroach (Periplaneta americana), Formosan termite (Coptotermes formosanus), red imported fire ant (Solenopsis invicta), little red ant (Monomorium pharaonis), western harvester ant (Pogonomyrmex occidentalis) and northern house mosquito (Culex pipiens pipiens).
38. The pest arthropod control method according to any one of the preceding clauses 25 to 37, wherein the pest arthropod is a pest arthropod having reduced susceptibility to at least one selected from the group consisting of insecticides, acaricides, molluscicides and nematicides.
39. The pest arthropod control method according to any one of the preceding clauses 25 to 37, wherein the pest arthropod is a pest arthropod having reduced susceptibility to at least one insecticide selected from the group consisting of GABA-gated chloride channel blockers, sodium channel modulators, and nicotinic acetylcholine receptor competitive modulators.
40. The pest arthropod control method according to any one of the preceding clauses 25 to 39, wherein the pest arthropod control composition is an aerosol formulation further containing dill extract.
41. The pest arthropod control method according to any one of the preceding clauses 25 to 40, including applying by diluting the pest arthropod control composition with water and spraying.
42. The pest arthropod control method according to any one of the preceding clauses 25 to 41, wherein the pest arthropod control composition is an oil formulation, an emulsifiable concentrate, a wettable powder, a water dispersible granule, a flowable formulation or a microcapsule formulation.
43. The pest arthropod control method according to any one of the preceding clauses 25 to 41, wherein the pest arthropod control composition is a microcapsule formulation.
44. A method for controlling a pest arthropod, including applying a pest arthropod control composition containing as active ingredients natural pyrethrin and dill extract to the pest arthropod or a place where the pest arthropod occurs.
45. The pest arthropod control method according to the preceding clause 44, wherein the pest arthropod control composition is an aerosol formulation.
46. The pest arthropod control method according to the preceding clause 45, wherein the aerosol formulation is an aerosol formulation containing at least one of dimethyl ether and liquefied petroleum gas as propellant.
47. The pest arthropod control method according to the preceding clause 45 or 46, wherein the aerosol formulation is an aerosol formulation further containing as liquid carrier at least one selected from the group consisting of aliphatic hydrocarbons, aromatic hydrocarbons, esters, carbonates, and alcohols.
48. The pest arthropod control method according to any one of the preceding clauses 45 to 47, wherein the aerosol formulation is an aerosol formulation further containing water.
49. The pest arthropod control method according to the preceding clause 44, wherein the pest arthropod control composition is a pump spray formulation.
50. The pest arthropod control method according to the preceding clause 49, wherein the pump spray formulation is a pump spray formulation containing as a liquid carrier at least one selected from the group consisting of water, aliphatic hydrocarbons, aromatic hydrocarbons, esters, carbonates, and alcohols.
51. The pest arthropod control method according to any one of the preceding clauses 44 to 50, wherein the pest arthropod is at least one pest arthropod selected from the group consisting of Blattodea, Hymenoptera, Diptera, Siphonaptera, Acari, Lepidoptera, and Coleoptera.
52. The pest arthropod control method according to any one of the preceding clauses 44 to 50, wherein the pest arthropod is at least one pest arthropod selected from the group consisting of Blattodea, Hymenoptera, and Diptera.
53. The pest arthropod control method according to any one of the preceding clauses 44 to 50, wherein the pest arthropod is at least one of pest arthropod in Blattodea selected from the following groups;
A group of Ectobiidae consisting of German cockroach (Blattella germanica);
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
54. The pest arthropod control method according to any one of the preceding clauses 44 to 50, wherein the pest arthropod is at least one of pest arthropod in Blattodea selected from the following groups;
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
55. The pest arthropod control method according to any one of the preceding clauses 44 to 50, wherein the pest arthropod is at least one of hymenopteran pest arthropod selected from the following groups;
A group of Formicidae consisting of Solenopsis spp. consisting of red imported fire ant (Solenopsis invicta) and tropical fire ant (Solenopsis geminata); Atta spp. consisting of brown leaf-cutting ant (Atta capiguara); Acromyrmex spp.; Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala); Camponotus spp. consisting of Kurooari (Camponotus japonicus), Muneakaoari (Camponotus obscuripes); Pogonomyrmex spp. consisting of western harvester ant (Pogonomyrmex occidentalis); Wasmania spp. consisting of Kokamiari (Wasmania auropunctata); and long-legged ant (Anoplolepis gracilipes);
A group of Vespidae consisting of Asian giant hornet (Vespa mandarinia), Kebukasuzumebachi (Vespa simillima), Kogatasuzumebachi (Vespa analis), Asian hornet (Vespa velutina), Seguroashinagabachi (Polistes jokahamae);
A group of Siricidae consisting of pine wood wasp (Urocerus gigas); and
A group of Bethylidae.
56. The pest arthropod control method according to any one of the preceding clauses 44 to 50, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, and Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of house fly (Musca domestica), false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
57. The pest arthropod control method according to any one of the preceding clauses 44 to 50, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), northern house mosquito (Culex pipiens pipiens), Niseshirohashiieka (Culex vishnui), Asian tiger mosquito (Aedes albopictus), Chinese malaria mosquito (Anopheles sinensis), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
58. The pest arthropod control method according to any one of the preceding clauses 44 to 50, wherein the pest arthropod is at least one pest arthropod selected from the group consisting of German cockroach (Blattella germanica), American cockroach (Periplaneta americana), Formosan termite (Coptotermes formosanus), red imported fire ant (Solenopsis invicta), little red ant (Monomorium pharaonis), western harvester ant (Pogonomyrmex occidentalis), brown house mosquito (Culex quinquefasciatus), northern house mosquito (Culex pipiens pipiens), dengue mosquito (Aedes aegypti), Ganbiehamadaraka (Anopheles gambiae) and house fly (Musca domestica).
59. The pest arthropod control method according to any one of the preceding clauses 44 to 50, wherein the pest arthropod is at least one pest arthropod selected from the group consisting of American cockroach (Periplaneta americana), Formosan termite (Coptotermes formosanus), red imported fire ant (Solenopsis invicta), little red ant (Monomorium pharaonis), western harvester ant (Pogonomyrmex occidentalis) and northern house mosquito (Culex pipiens pipiens).
60. The pest arthropod control method according to any one of the preceding clauses 44 to 59, wherein the pest arthropod is a pest arthropod having reduced susceptibility to at least one selected from the group consisting of insecticides, acaricides, molluscicides and nematicides.
61. The pest arthropod control method according to any one of the preceding clauses 44 to 59, wherein the pest arthropod is a pest arthropod having reduced susceptibility to at least one insecticide selected from the group consisting of GABA-gated chloride channel blockers, sodium channel modulators, and nicotinic acetylcholine receptor competitive modulators.
62. An aerosol formulation according to any one of the preceding clauses 45 to 48 and 51 to 61.
63. A pump spray formulation according to any one of the preceding clauses 49 to 61.
64. A method for controlling a pest arthropod, including applying a pest arthropod control composition containing as active ingredients natural pyrethrin and dill extract to a place where the pest arthropod occurs so that an amount of one active ingredient is 0.01 to 1000 mg per 1 m².
65. The pest arthropod control method according to the preceding clause 64, wherein the amount of one active ingredient is 10 to 500 mg per 1 m².
66. The pest arthropod control method according to the preceding clause 64 or 65, wherein the place where the pest arthropod occurs is at least one selected from the group consisting of architectural structures, outdoors, foods, and daily necessities.
67. The pest arthropod control method according to any one of the preceding clauses 64 to 66, including applying the pest arthropod control composition on a surface of the place where the pest arthropod occurs.
68. The pest arthropod control method according to any one of the preceding clauses 64 to 67, wherein the pest arthropod is at least one pest arthropod selected from the group consisting of Blattodea, Hymenoptera, Diptera, Siphonaptera, Acari, Lepidoptera, and Coleoptera.
69. The pest arthropod control method according to any one of the preceding clauses 64 to 67, wherein the pest arthropod is at least one pest arthropod selected from the group consisting of Blattodea, Hymenoptera, and Diptera.
70. The pest arthropod control method according to any one of the preceding clauses 64 to 67, wherein the pest arthropod is at least one of pest arthropod in Blattodea selected from the following groups;
A group of Ectobiidae consisting of German cockroach (Blattella germanica);
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
71. The pest arthropod control method according to any one of the preceding clauses 64 to 67, wherein the pest arthropod is at least one of pest arthropod in Blattodea selected from the following groups;
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
72. The pest arthropod control method according to any one of the preceding clauses 64 to 67, wherein the pest arthropod is at least one of hymenopteran pest arthropod selected from the following groups;
A group of Formicidae consisting of Solenopsis spp. consisting of red imported fire ant (Solenopsis invicta) and tropical fire ant (Solenopsis geminata); Atta spp. consisting of brown leaf-cutting ant (Atta capiguara); Acromyrmex spp.; Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala); Camponotus spp. consisting of Kurooari (Camponotus japonicus), Muneakaoari (Camponotus obscuripes); Pogonomyrmex spp. consisting of western harvester ant (Pogonomyrmex occidentalis); Wasmania spp. consisting of Kokamiari (Wasmania auropunctata); and long-legged ant (Anoplolepis gracilipes);
A group of Vespidae consisting of Asian giant hornet (Vespa mandarinia), Kebukasuzumebachi (Vespa simillima), Kogatasuzumebachi (Vespa analis), Asian hornet (Vespa velutina), Seguroashinagabachi (Polistes jokahamae);
A group of Siricidae consisting of pine wood wasp (Urocerus gigas); and
A group of Bethylidae.
73. The pest arthropod control method according to any one of the preceding clauses 64 to 67, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, and Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of house fly (Musca domestica), false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
74. The pest arthropod control method according to any one of the preceding clauses 64 to 67, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), northern house mosquito (Culex pipiens pipiens), Niseshirohashiieka (Culex vishnui), Asian tiger mosquito (Aedes albopictus), Chinese malaria mosquito (Anopheles sinensis), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
75. The pest arthropod control method according to any one of the preceding clauses 64 to 67, wherein the pest arthropod is at least one pest arthropod selected from the group consisting of German cockroach (Blattella germanica), American cockroach (Periplaneta americana), Formosan termite (Coptotermes formosanus), red imported fire ant (Solenopsis invicta), little red ant (Monomorium pharaonis), western harvester ant (Pogonomyrmex occidentalis), brown house mosquito (Culex quinquefasciatus), northern house mosquito (Culex pipiens pipiens), dengue mosquito (Aedes aegypti), Ganbiehamadaraka (Anopheles gambiae) and house fly (Musca domestica).
76. The pest arthropod control method according to any one of the preceding clauses 64 to 67, wherein the pest arthropod is at least one pest arthropod selected from the group consisting of American cockroach (Periplaneta americana), Formosan termite (Coptotermes formosanus), red imported fire ant (Solenopsis invicta), little red ant (Monomorium pharaonis), western harvester ant (Pogonomyrmex occidentalis) and northern house mosquito (Culex pipiens pipiens).
77. The pest arthropod control method according to any one of the preceding clauses 64 to 76, wherein the pest arthropod is a pest arthropod having reduced susceptibility to at least one selected from the group consisting of insecticides, acaricides, molluscicides and nematicides.
78. The pest arthropod control method according to any one of the preceding clauses 64 to 76, wherein the pest arthropod is a pest arthropod having reduced susceptibility to at least one insecticide selected from the group consisting of GABA-gated chloride channel blockers, sodium channel modulators, and nicotinic acetylcholine receptor competitive modulators.
79. The pest arthropod control method according to any one of the preceding clauses 64 to 78, including applying by diluting the pest arthropod control composition with water and spraying.
80. The pest arthropod control method according to any one of the preceding clauses 64 to 79, wherein the pest arthropod control composition is an oil formulation, an emulsifiable concentrate, a wettable powder, a water dispersible granule, a flowable formulation or a microcapsule formulation.
81. The pest arthropod control method according to any one of the preceding clauses 64 to 79, wherein the pest arthropod control composition is a microcapsule formulation.
82. A method for controlling a pest arthropod, including applying a pest arthropod control composition containing as active ingredients natural pyrethrin and azadirachtin, to the pest arthropod, or to a place where the pest arthropod occurs.
83. The pest arthropod control method according to the preceding clause 82, wherein the pest arthropod control composition is an aerosol formulation.
84. The pest arthropod control method according to the preceding clause 83, wherein the aerosol formulation is an aerosol formulation containing at least one of dimethyl ether and liquefied petroleum gas as propellant.
85. The pest arthropod control method according to the preceding clause 83 or 84, wherein the aerosol formulation is an aerosol formulation further containing as liquid carrier at least one selected from the group consisting of aliphatic hydrocarbons, aromatic hydrocarbons, esters, carbonates, and alcohols.
86. The pest arthropod control method according to any one of the preceding clauses 83 to 85, wherein the aerosol formulation is an aerosol formulation further containing water.
87. The pest arthropod control method according to the preceding clause 82, wherein the pest arthropod control composition is a pump spray formulation.
88. The pest arthropod control method according to the preceding clause 87, wherein the pump spray formulation is a pump spray formulation containing as a liquid carrier at least one selected from the group consisting of water, aliphatic hydrocarbons, aromatic hydrocarbons, esters, carbonates, and alcohols.
89. The pest arthropod control method according to any one of the preceding clauses 82 to 88, wherein the pest arthropod is at least one pest arthropod selected from the group consisting of Blattodea, Hymenoptera, Diptera, Siphonaptera, Acari, Lepidoptera, and Coleoptera.
90. The pest arthropod control method according to any one of the preceding clauses 82 to 88, wherein the pest arthropod is at least one pest arthropod selected from the group consisting of Blattodea, Hymenoptera, and Diptera.
91. The pest arthropod control method according to any one of the preceding clauses 82 to 88, wherein the pest arthropod is at least one of pest arthropod in Blattodea selected from the following groups;
A group of Ectobiidae consisting of German cockroach (Blattella germanica);
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
92. The pest arthropod control method according to any one of the preceding clauses 82 to 88, wherein the pest arthropod is at least one of pest arthropod in Blattodea selected from the following groups;
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
93. The pest arthropod control method according to any one of the preceding clauses 82 to 88, wherein the pest arthropod is at least one of hymenopteran pest arthropod selected from the following groups;
A group of Formicidae consisting of Solenopsis spp. consisting of red imported fire ant (Solenopsis invicta) and tropical fire ant (Solenopsis geminata); Atta spp. consisting of brown leaf-cutting ant (Atta capiguara); Acromyrmex spp.; Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala); Camponotus spp. consisting of Kurooari (Camponotus japonicus), Muneakaoari (Camponotus obscuripes); Pogonomyrmex spp. consisting of western harvester ant (Pogonomyrmex occidentalis); Wasmania spp. consisting of Kokamiari (Wasmania auropunctata); and long-legged ant (Anoplolepis gracilipes);
A group of Vespidae consisting of Asian giant hornet (Vespa mandarinia), Kebukasuzumebachi (Vespa simillima), Kogatasuzumebachi (Vespa analis), Asian hornet (Vespa velutina), Seguroashinagabachi (Polistes jokahamae);
A group of Siricidae consisting of pine wood wasp (Urocerus gigas); and
A group of Bethylidae.
94. The pest arthropod control method according to any one of the preceding clauses 82 to 88, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, and Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of house fly (Musca domestica), false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
95. The pest arthropod control method according to any one of the preceding clauses 82 to 88, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), northern house mosquito (Culex pipiens pipiens), Niseshirohashiieka (Culex vishnui), Asian tiger mosquito (Aedes albopictus), Chinese malaria mosquito (Anopheles sinensis), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
96. The pest arthropod control method according to any one of the preceding clauses 82 to 88, wherein the pest arthropod is at least one pest arthropod selected from the group consisting of German cockroach (Blattella germanica), American cockroach (Periplaneta americana), Formosan termite (Coptotermes formosanus), red imported fire ant (Solenopsis invicta), little red ant (Monomorium pharaonis), western harvester ant (Pogonomyrmex occidentalis), brown house mosquito (Culex quinquefasciatus), northern house mosquito (Culex pipiens pipiens), dengue mosquito (Aedes aegypti), Ganbiehamadaraka (Anopheles gambiae) and house fly (Musca domestica).
97. The pest arthropod control method according to any one of the preceding clauses 82 to 88, wherein the pest arthropod is at least one pest arthropod selected from the group consisting of American cockroach (Periplaneta americana), Formosan termite (Coptotermes formosanus), red imported fire ant (Solenopsis invicta), little red ant (Monomorium pharaonis), western harvester ant (Pogonomyrmex occidentalis) and northern house mosquito (Culex pipiens pipiens).
98. The pest arthropod control method according to any one of the preceding clauses 82 to 97, wherein the pest arthropod is a pest arthropod having reduced susceptibility to at least one selected from the group consisting of insecticides, acaricides, molluscicides and nematicides.
99. The pest arthropod control method according to any one of the preceding clauses 82 to 97, wherein the pest arthropod is a pest arthropod having reduced susceptibility to at least one insecticide selected from the group consisting of GABA-gated chloride channel blockers, sodium channel modulators, and nicotinic acetylcholine receptor competitive modulators.
100. The pest arthropod control method according to any one of the preceding clauses 82 to 99, wherein the pest arthropod control composition is a pest arthropod control composition further containing dill extract.
101. An aerosol formulation according to any one of the preceding clauses 83 to 86 and 89 to 100.
102. A pump spray formulation according to any one of the preceding clauses 87 to 100.
103. A method for controlling a pest arthropod, including applying a pest arthropod control composition containing as active ingredients natural pyrethrin and azadirachtin to a place where the pest arthropod occurs so that an amount of one active ingredient is 0.01 to 1000 mg per 1 m².
104. The pest arthropod control method according to the preceding clause 103, wherein the amount of one active ingredient is 10 to 500 mg per 1 m².
105. The pest arthropod control method according to the preceding clause 103 or 104, wherein the place where the pest arthropod occurs is at least one selected from the group consisting of architectural structures, outdoors, foods, and daily necessities.
106. The pest arthropod control method according to any one of the preceding clauses 103 to 105, including applying the pest arthropod control composition on a surface of the place where the pest arthropod occurs.
107. The pest arthropod control method according to any one of the preceding clauses 103 to 106, wherein the pest arthropod is at least one pest arthropod selected from the group consisting of Blattodea, Hymenoptera, Diptera, Siphonaptera, Acari, Lepidoptera, and Coleoptera.
108. The pest arthropod control method according to any one of the preceding clauses 103 to 106, wherein the pest arthropod is at least one pest arthropod selected from the group consisting of Blattodea, Hymenoptera, and Diptera.
109. The pest arthropod control method according to any one of the preceding clauses 103 to 106, wherein the pest arthropod is at least one of pest arthropod in Blattodea selected from the following groups;
A group of Ectobiidae consisting of German cockroach (Blattella germanica);
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
110. The pest arthropod control method according to any one of the preceding clauses 103 to 106, wherein the pest arthropod is at least one of pest arthropod in Blattodea selected from the following groups;
A group of Blattidae consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis);
A group of Termitidae consisting of Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.
111. The pest arthropod control method according to any one of the preceding clauses 103 to 106, wherein the pest arthropod is at least one of hymenopteran pest arthropod selected from the following groups;
A group of Formicidae consisting of Solenopsis spp. consisting of red imported fire ant (Solenopsis invicta) and tropical fire ant (Solenopsis geminata); Atta spp. consisting of brown leaf-cutting ant (Atta capiguara); Acromyrmex spp.; Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala); Camponotus spp. consisting of Kurooari (Camponotus japonicus), Muneakaoari (Camponotus obscuripes); Pogonomyrmex spp. consisting of western harvester ant (Pogonomyrmex occidentalis); Wasmania spp. consisting of Kokamiari (Wasmania auropunctata); and long-legged ant (Anoplolepis gracilipes);
A group of Vespidae consisting of Asian giant hornet (Vespa mandarinia), Kebukasuzumebachi (Vespa simillima), Kogatasuzumebachi (Vespa analis), Asian hornet (Vespa velutina), Seguroashinagabachi (Polistes jokahamae);
A group of Siricidae consisting of pine wood wasp (Urocerus gigas); and
A group of Bethylidae.
112. The pest arthropod control method according to any one of the preceding clauses 103 to 106, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, and Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of house fly (Musca domestica), false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
113. The pest arthropod control method according to any one of the preceding clauses 103 to 106, wherein the pest arthropod is at least one of Dipteran pest arthropod selected from the following groups;
A group of Drosophilidae consisting of cherry drosophila (Drosophila suzukii) and common fruit fly (Drosophila melanogaster);
A group of Phoridae consisting of Okimonnomibae (Megaselia spiracularis);
A group of Psychodidae consisting of Ochobae (Clogmia albipunctata);
A group of Sciaridae consisting of Chibikurobanekinokobae (Bradysia difformis);
A group of Cecidomyiidae consisting of hessian fly (Mayetiola destructor) and paddy gall fly (Orseolia oryzae);
A group of Diopsidae consisting of Diopsis macrophthalma;
A group of Glossinidae consisting of Glossina palpalis, and Glossina morsitans;
A group of Simuliidae consisting of Ashimadarabuyu (Simulium japonicum) and Simulium damnosum;
A group of Phlebotominae;
A group of Tipulidae consisting of rice crane fly (Tipula aino), common cranefly (Tipula oleracea), European cranefly (Tipula paludosa);
A group of Culicidae consisting of southern house mosquito (Culex pipiens pallens), Kogataakaieka (Culex tritaeniorhynchus), Chikaieka (Culex pipiens f. molestus), northern house mosquito (Culex pipiens pipiens), Niseshirohashiieka (Culex vishnui), Asian tiger mosquito (Aedes albopictus), Chinese malaria mosquito (Anopheles sinensis), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti, Anopheles minimus;
A group of Simulidae consisting of Kiashiobuyu (Prosimulium yezoensis) and Tsumetogebuyu (Simulium ornatum);
A group of Tabanidae consisting of Ushiabu (Tabanus trigonus);
A group of Muscidae consisting of false stable fly (Muscina stabulans), biting house fly (Stomoxys calcitrans), and buffalo fly (Haematobia irritans);
A group of Calliphoridae;
A group of Sarcophagidae;
A group of Chironomidae consisting of Oyusurika (Chironomus plumosus), Sesujiyusurika (Chironomus yoshimatsui), and Haiiroyusurika (Glyptotendipes tokunagai); and
A group of Fannidae.
114. The pest arthropod control method according to any one of the preceding clauses 103 to 106, wherein the pest arthropod is at least one pest arthropod selected from the group consisting of German cockroach (Blattella germanica), American cockroach (Periplaneta americana), Formosan termite (Coptotermes formosanus), red imported fire ant (Solenopsis invicta), little red ant (Monomorium pharaonis), western harvester ant (Pogonomyrmex occidentalis), brown house mosquito (Culex quinquefasciatus), northern house mosquito (Culex pipiens pipiens), dengue mosquito (Aedes aegypti), Ganbiehamadaraka (Anopheles gambiae) and house fly (Musca domestica).
115. The pest arthropod control method according to any one of the preceding clauses 103 to 106, wherein the pest arthropod is at least one pest arthropod selected from the group consisting of American cockroach (Periplaneta americana), Formosan termite (Coptotermes formosanus), red imported fire ant (Solenopsis invicta), little red ant (Monomorium pharaonis), western harvester ant (Pogonomyrmex occidentalis) and northern house mosquito (Culex pipiens pipiens).
116. The pest arthropod control method according to any one of the preceding clauses 103 to 115, wherein the pest arthropod is a pest arthropod having reduced susceptibility to at least one selected from the group consisting of insecticides, acaricides, molluscicides and nematicides.
117. The pest arthropod control method according to any one of the preceding clauses 103 to 115, wherein the pest arthropod is a pest arthropod having reduced susceptibility to at least one insecticide selected from the group consisting of GABA-gated chloride channel blockers, sodium channel modulators, and nicotinic acetylcholine receptor competitive modulators.
118. The pest arthropod control method according to any one of the preceding clauses 103 to 117, wherein the pest arthropod control composition is an aerosol formulation further containing dill extract.
119. The pest arthropod control method according to any one of the preceding clauses 103 to 118, including applying by diluting the pest arthropod control composition with water and spraying.
120. The pest arthropod control method according to any one of the preceding clauses 103 to 119, wherein the pest arthropod control composition is an oil formulation, an emulsifiable concentrate, a wettable powder, a water dispersible granule, a flowable formulation or a microcapsule formulation.
121. The pest arthropod control method according to any one of the preceding clauses 103 to 119, wherein the pest arthropod control composition is a microcapsule formulation.
122. A method for controlling at least one pest selected from the group consisting of Hemiptera, Lepidoptera, Thysanoptera, Diptera, Coleoptera, Orthoptera, Hymenoptera, Blattodea, Siphonaptera, Psocodae, Thysanura, Acari, Araneae, Polydesmida, Isopoda, Chilopoda, Gatropoda, and Nematoda by using a pest control composition containing as active ingredients natural pyrethrin and one or more ingredients selected from the following Group (a);
Group (a): acetylcholinesterase inhibitors, GABA-gated chloride channel blockers, sodium channel modulators, nicotinic acetylcholine receptor competitive modulators, nicotinic acetylcholine receptor allosteric modulators, glutamate-gated chloride channel allosteric modulators, juvenile Hormone mimics, multisite inhibitors, chordotonal organ TRPV channel modulators, mite growth inhibitors, mitochondrial ATP synthase inhibitors, oxidative phosphorylation uncouplers, nicotinic acetylcholine receptor channel blockers, chitin synthesis inhibitors, moulting disruptors, ecdysone receptor agonists, octopamine receptor agonists, inhibitors of mitochondrial electron transport chain complexes I, II, III and IV, voltage-dependent sodium channel blockers, acetyl-CoA carboxylase inhibitors, ryanodine receptor modulators, and chordotonal organ modulators.
123. The control method according to the preceding clause 122, wherein the ingredient of the Group (a) is a nicotinic acetylcholine receptor allosteric modulator.
124. The control method according to the preceding clause 123, wherein the nicotinic acetylcholine receptor allosteric modulator is spinosad.
125. The control method according to any one of the preceding clauses 122 to 124, wherein the pest is a pest arthropod, a pest mollusc and a pest nematode which have reduced susceptibility to at least one of insecticides, acaricides, molluscicides and nematicides.
126. A method for controlling one or more pests selected from the group consisting of Hemiptera, Lepidoptera, Thysanoptera, Diptera, Coleoptera, Orthoptera, Hymenoptera, Blattodea, Siphonaptera, Psocodae, Thysanura, Acari, Araneae, Polydesmida, Isopoda, Chilopoda, Gatropoda, and Nematoda by using a pest control composition containing as active ingredients natural pyrethrin and a microbial material having a pest control effect or a plant growth regulating effect on rhizobium or mycorrhizal fungi.
127. The control method according to the preceding clause 126, wherein the microbial material is a bacterium of the genus Bacillus.
128. The control method according to the preceding clause 127, wherein the bacterium of the genus Bacillus is Bacillus thuringiensis.
129. The control method according to the preceding clause 128, wherein the Bacillus thuringiensis is one or more strains selected from the group consisting of Bacillus thuringiensis strain AQ52, Bacillus thuringiensis strain BD #32, Bacillus thuringiensis strain CR-371, Bacillus thuringiensis strain EX297512, Bacillus thuringiensis subsp. Aizawai strain ABTS-1857, Bacillus thuringiensis subsp. Aizawai strain GC-91, Bacillus thuringiensis subsp. Aizawai Serotype H-7, Bacillus thuringiensis subsp. Kurstaki strain ABTS351, Bacillus thuringiensis subsp. Kurstaki strain BMP123, Bacillus thuringiensis subsp. Kurstaki strain EG234, Bacillus thuringiensis subsp. Kurstaki strain EG7841, Bacillus thuringiensis subsp. Kurstaki strain EVB113-19, Bacillus thuringiensis subsp. Kurstaki strain F810, Bacillus thuringiensis subsp. Kurstaki strain HD-1, Bacillus thuringiensis subsp. Kurstaki strain PB54, Bacillus thuringiensis subsp. Kurstaki strain SA-11, Bacillus thuringiensis subsp. Kurstaki strain SA-12, Bacillus thuringiensis subsp. morrisoni, Bacillus thuringiensis subsp. Tenebriosis strain NB176, Bacillus thuringiensis subsp. Thuringiensis strain MPPLOO2, Bacillus thuringiensis subsp. var. colmeri, Bacillus thuringiensis subsp. var. darmstadiensis strain 24-91, Bacillus thuringiensis subsp. var. dendrolimus, Bacillus thuringiensis subsp. var. galleriae, Bacillus thuringiensis subsp. israelensis strain BMP144, Bacillus thuringiensis subsp. israelensis strain AM65-52, Bacillus thuringiensis subsp. var. japonensis strain buibui, Bacillus thuringiensis subsp. var. aegypti, Bacillus thuringiensis var. 7216, Bacillus thuringiensis var. sandiego strain M-7, and Bacillus thuringiensis var. T36.
130. The control method according to any one of the preceding clauses 126 to 129, wherein the pest is a pest arthropod, a pest mollusc and a pest nematode which have reduced susceptibility to at least one of insecticides, acaricides, molluscicides and nematicides.
131. A method for controlling one or more pests selected from the group consisting of Hemiptera, Lepidoptera, Thysanoptera, Diptera, Coleoptera, Orthoptera, Hymenoptera, Blattodea, Siphonaptera, Psocodae, Thysanura, Acari, Araneae, Polydesmida, Isopoda, Chilopoda, Gatropoda, and Nematoda by using a pest control composition containing as active ingredients natural pyrethrin and azadirachtin.
132. The control method according to the preceding clause 131, wherein the pest is a pest arthropod, a pest mollusc and a pest nematode which have reduced susceptibility to at least one of insecticides, acaricides, molluscicides and nematicides.
133. A method for controlling one or more pests selected from the group consisting of Hemiptera, Lepidoptera, Thysanoptera, Diptera, Coleoptera, Orthoptera, Hymenoptera, Blattodea, Siphonaptera, Psocodae, Thysanura, Acari, Araneae, Polydesmida, Isopoda, Chilopoda, Gatropoda, and Nematoda by using a pest control composition containing as active ingredients natural pyrethrin and dill extract.
134. The control method according to the preceding clause 133, wherein the pest is a pest arthropod, a pest mollusc and a pest nematode which have reduced susceptibility to at least one of insecticides, acaricides, molluscicides and nematicides.
135. A method for controlling one or more pests selected from the group consisting of Hemiptera, Lepidoptera, Thysanoptera, Diptera, Coleoptera, Orthoptera, Hymenoptera, Blattodea, Siphonaptera, Psocodae, Thysanura, Acari, Araneae, Polydesmida, Isopoda, Chilopoda, Gatropoda, and Nematoda by using a pest control composition containing as active ingredients natural pyrethrin and one or more ingredients selected from the group consisting of sabadilla seed extract, cevadine, and veratridine.
136. The control method according to the preceding clause 135, wherein the pest is at least one pest of Orthoptera and nematoda.
137. The control method according to the preceding clause 135, wherein the pest is at least one pest selected from the group consisting of stink bug, psylla, diamondback moth and cabbage moth.
138. The control method according to any one of the preceding clauses 135 to 137, wherein the pest is a pest arthropod, a pest mollusc and a pest nematode which have reduced susceptibility to at least one of insecticides, acaricides, molluscicides and nematicides.
139. A method for controlling one or more pests selected from the group consisting of Hemiptera, Lepidoptera, Thysanoptera, Diptera, Coleoptera, Orthoptera, Hymenoptera, Blattodea, Siphonaptera, Psocodae, Thysanura, Acari, Araneae, Polydesmida, Isopoda, Chilopoda, Gatropoda, and Nematoda by using a pest control composition containing as active ingredients natural pyrethrin and machine oil.
140. The control method according to the preceding clause 139, wherein the pest is a pest arthropod, a pest mollusc and a pest nematode which have reduced susceptibility to at least one of insecticides, acaricides, molluscicides and nematicides.

The aforementioned pest control compositions containing natural pyrethrin (hereinafter sometimes referred to as “Present Composition”) are described below.

The present composition may contain one or more ingredients selected from the group consisting of group (a), group (b), group (c), group (d), group (e), group (f), group (g), group (h), group (i), group (j) and group (k) besides the natural pyrethrin.
Group (a): a group consisting of insecticidal active ingredients, acaricidal active ingredients and nematicidal active ingredients;
Group (b): fungicidal active ingredients;
Group (c): plant growth regulating ingredients;
Group (d): safeners;
Group (e): synergists;
Group (f): repellent ingredients;
Group (g): molluscicidal ingredients;
Group (h): insect pheromones;
Group (i): herbicidal active ingredients;
Group (j): microbial materials;
Group (k): a group consisting of plant extracts and plant-derived ingredients.

According to the present invention, pests can be controlled.

### DESCRIPTION OF EMBODIMENTS

A pest control composition containing natural pyrethrin (hereinafter sometimes referred to as “Present Composition”) are described below.

In this description, natural pyrethrin means a mixture of six types of natural pyrethrin compounds of pyrethrin I, pyrethrin II, cinerin I, cinerin II, jasmolin I, and jasmolin II. The aforementioned natural pyrethrin is typically available as extracted essence or pyrethrum dry powder which can be obtained by picking only floret part of pyrethrum (Shirobanamushiyokegiku; Scientific name: Tanacetum cinerariifolium or Chrysanthemum cinerariaefolium), followed by drying and grinding to obtain powder, and then extracting with solvents suitable for dissolving active ingredients, for example, organic solvent such as methanol. Thus obtained natural pyrethrin may contain plant derived impurities (fatty acids, flavonoid, and the like) besides the aforementioned six compounds, and additionally, may contain auxiliaries such as solvents and/or stabilizers for some situations.

As the plants from which the natural pyrethrin can be obtained, besides the aforementioned Shirobanamushiyokegiku, Pot Marigold (Calendula officinalis), pyrethum daisy (Chrysanthemum coccinum), Aztec marigold (Tagetes erecta), Southern Cone Marigold (Tagetes minuta), Common zinnia (Zinnia elegans), creeping zinnia (Zinia linnearis) and the like are also known (Reference literature 1: Adnane. H. Alain, C. & Chantal, B. 2000. The Production of Pyrethrins by Plant Cell and Tissue Cultures of Chrysanthemum cinerariae folium and Tagetes Species. Critical Reviews in Plant Sciences, 19(1):69-89, Reference literature 2: Kudakasseril, G. J. and Staba, E. J. 1988. Insecticidal phytochemicals. In: Cell Culture and Somatic Cell Genetics of Plants. pp. 537-552. Constabel, F. and Vasil, I. K., Eds., Academic Press, New York., Reference literature 3: John E. Casida, Gary B. Quistad. 1995. PYRETHRUM FLOWERS, Production, Chemistry, Toxicology, and Uses. pp. 123-125, Oxford University Press.), and plant species and varieties which are sources of the natural pyrethrin are not limited to those mentioned above.

The cultivation method, cultivation conditions (weather, production area, soil properties, etc.), harvest season, harvest site, harvest method, washing method, extraction method and purification method of said plants are not particularly limited, and the natural pyrethrins include, for example, natural pyrethrins obtained using vectors to which genes encoding pyrethrin biosynthetic enzymes has been incorporated.

The weight ratio of the six compounds of pyrethrin I, pyrethrin II, cinerin I, cinerin II, jasmolin I, and jasmolin II in the natural pyrethrin is not particularly limited, and each compound can be within the range of 0.001 to 99% to set any weight ratios, however typically, when whole six compounds are taken as 100%, 10% to 70% of pyrethrin I, 10 to 70% of pyrethrin II, 1 to 20% of cinerin I, 1 to 20% of cinerin II, 1 to 20% of jasmolin I, and 1 to 20% of jasmolin II are included by weight.

Specifically, examples of the mixing ratios (weight ratios) include the followings, for example, [pyrethrin I: cinerin I: jasmolin I: pyrethrin II: cinerin II: jasmolin II]=38.0:7.3:4.0:35.0:11.7:4.0 (Reference 3).

Also, the natural pyrethrin is evaluated with pyrethrins I (total amount of pyrethrin I, cinerin I and jasmolin II) and pyrethrins II (total amount of pyrethrin II, cinerin II, jasmolin II), and the total content (% by weight) of pyrethrins I and pyrethrins II is typically 10-99%, preferably 15-90%, more preferably 20-85%. Examples of such natural pyrethrin include usually those having pyrethrins I content (% by weight) of 20 to 40% and pyrethrins II content (% by weight) of 12 to 31%.

Examples of the natural pyrethrin, more specifically, includes those containing said six compounds of pyrethrin I, cinerin I, jasmolin I, pyrethrin II, cinerin II and jasmolin II, at the following weight ratios (% by weight). Examples of the natural pyrethrin include that in which [pyrethrin I: cinerin I: jasmolin I: pyrethrin II: cinerin II: jasmolin II]=[35:6:4:25:6:4] as well as those in which the weight ratios of each of six compounds are the following.
35:6:4:25:6:2
35:6:4:25:6:1
35:6:4:25:6:0.5
35:6:4:25:4:4
35:6:4:25:4:2
35:6:4:25:4:1
35:6:4:25:4:0.5
35:6:4:25:2:4
35:6:4:25:2:2
35:6:4:25:2:1
35:6:4:25:2:0.5
35:6:4:25:1:4
35:6:4:25:1:2
35:6:4:25:1:1
35:6:4:25:1:0.5
35:6:4:25:0.5:4
35:6:4:25:0.5:2
35:6:4:25:0.5:1
35:6:4:25:0.5:0.5
35:6:4:15:6:4
35:6:4:15:6:2
35:6:4:15:6:1
35:6:4:15:6:0.5
35:6:4:15:4:4
35:6:4:15:4:2
35:6:4:15:4:1
35:6:4:15:4:0.5
35:6:4:15:2:4
35:6:4:15:2:2
35:6:4:15:2:1
35:6:4:15:2:0.5
35:6:4:15:1:4
35:6:4:15:1:2
35:6:4:15:1:1
35:6:4:15:1:0.5
35:6:4:15:0.5:4
35:6:4:15:0.5:2
35:6:4:15:0.5:1
35:6:4:15:0.5:0.5
35:6:4:5:6:4
35:6:4:5:6:2
35:6:4:5:6:1
35:6:4:5:6:0.5
35:6:4:5:4:4
35:6:4:5:4:2
35:6:4:5:4:1
35:6:4:5:4:0.5
35:6:4:5:2:4
35:6:4:5:2:2
35:6:4:5:2:1
35:6:4:5:2:0.5
35:6:4:5:1:4
35:6:4:5:1:2
35:6:4:5:1:1
35:6:4:5:1:0.5
35:6:4:5:0.5:4
35:6:4:5:0.5:2
35:6:4:5:0.5:1
35:6:4:5:0.5:0.5
35:6:2:25:6:4
35:6:2:25:6:2
35:6:2:25:6:1
35:6:2:25:6:0.5
35:6:2:25:4:4
35:6:2:25:4:2
35:6:2:25:4:1
35:6:2:25:4:0.5
35:6:2:25:2:4
35:6:2:25:2:2
35:6:2:25:2:1
35:6:2:25:2:0.5
35:6:2:25:1:4
35:6:2:25:1:2
35:6:2:25:1:1
35:6:2:25:1:0.5
35:6:2:25:0.5:4
35:6:2:25:0.5:2
35:6:2:25:0.5:1
35:6:2:25:0.5:0.5
35:6:2:15:6:4
35:6:2:15:6:2
35:6:2:15:6:1
35:6:2:15:6:0.5
35:6:2:15:4:4
35:6:2:15:4:2
35:6:2:15:4:1
35:6:2:15:4:0.5
35:6:2:15:2:4
35:6:2:15:2:2
35:6:2:15:2:1
35:6:2:15:2:0.5
35:6:2:15:1:4
35:6:2:15:1:2
35:6:2:15:1:1
35:6:2:15:1:0.5
35:6:2:15:0.5:4
35:6:2:15:0.5:2
35:6:2:15:0.5:1
35:6:2:15:0.5:0.5
35:6:2:5:6:4
35:6:2:5:6:2
35:6:2:5:6:1
35:6:2:5:6:0.5
35:6:2:5:4:4
35:6:2:5:4:2
35:6:2:5:4:1
35:6:2:5:4:0.5
35:6:2:5:2:4
35:6:2:5:2:2
35:6:2:5:2:1
35:6:2:5:2:0.5
35:6:2:5:1:4
35:6:2:5:1:2
35:6:2:5:1:1
35:6:2:5:1:0.5
35:6:2:5:0.5:4
35:6:2:5:0.5:2
35:6:2:5:0.5:1
35:6:2:5:0.5:0.5
35:6:1:25:6:4
35:6:1:25:6:2
35:6:1:25:6:1
35:6:1:25:6:0.5
35:6:1:25:4:4
35:6:1:25:4:2
35:6:1:25:4:1
35:6:1:25:4:0.5
35:6:1:25:2:4
35:6:1:25:2:2
35:6:1:25:2:1
35:6:1:25:2:0.5
35:6:1:25:1:4
35:6:1:25:1:2
35:6:1:25:1:1
35:6:1:25:1:0.5
35:6:1:25:0.5:4
35:6:1:25:0.5:2
35:6:1:25:0.5:1
35:6:1:25:0.5:0.5
35:6:1:15:6:4
35:6:1:15:6:2
35:6:1:15:6:1
35:6:1:15:6:0.5
35:6:1:15:4:4
35:6:1:15:4:2
35:6:1:15:4:1
35:6:1:15:4:0.5
35:6:1:15:2:4
35:6:1:15:2:2
35:6:1:15:2:1
35:6:1:15:2:0.5
35:6:1:15:1:4
35:6:1:15:1:2
35:6:1:15:1:1
35:6:1:15:1:0.5
35:6:1:15:0.5:4
35:6:1:15:0.5:2
35:6:1:15:0.5:1
35:6:1:15:0.5:0.5
35:6:1:5:6:4
35:6:1:5:6:2
35:6:1:5:6:1
35:6:1:5:6:0.5
35:6:1:5:4:4
35:6:1:5:4:2
35:6:1:5:4:1
35:6:1:5:4:0.5
35:6:1:5:2:4
35:6:1:5:2:2
35:6:1:5:2:1
35:6:1:5:2:0.5
35:6:1:5:1:4
35:6:1:5:1:2
35:6:1:5:1:1
35:6:1:5:1:0.5
35:6:1:5:0.5:4
35:6:1:5:0.5:2
35:6:1:5:0.5:1
35:6:1:5:0.5:0.5
35:6:0.5:25:6:4
35:6:0.5:25:6:2
35:6:0.5:25:6:1
35:6:0.5:25:6:0.5
35:6:0.5:25:4:4
35:6:0.5:25:4:2
35:6:0.5:25:4:1
35:6:0.5:25:4:0.5
35:6:0.5:25:2:4
35:6:0.5:25:2:2
35:6:0.5:25:2:1
35:6:0.5:25:2:0.5
35:6:0.5:25:1:4
35:6:0.5:25:1:2
35:6:0.5:25:1:1
35:6:0.5:25:1:0.5
35:6:0.5:25:0.5:4
35:6:0.5:25:0.5:2
35:6:0.5:25:0.5:1
35:6:0.5:25:0.5:0.5
35:6:0.5:15:6:4
35:6:0.5:15:6:2
35:6:0.5:15:6:1
35:6:0.5:15:6:0.5
35:6:0.5:15:4:4
35:6:0.5:15:4:2
35:6:0.5:15:4:1
35:6:0.5:15:4:0.5
35:6:0.5:15:2:4
35:6:0.5:15:2:2
35:6:0.5:15:2:1
35:6:0.5:15:2:0.5
35:6:0.5:15:1:4
35:6:0.5:15:1:2
35:6:0.5:15:1:1
35:6:0.5:15:1:0.5
35:6:0.5:15:0.5:4
35:6:0.5:15:0.5:2
35:6:0.5:15:0.5:1
35:6:0.5:15:0.5:0.5
35:6:0.5:5:6:4
35:6:0.5:5:6:2
35:6:0.5:5:6:1
35:6:0.5:5:6:0.5
35:6:0.5:5:4:4
35:6:0.5:5:4:2
35:6:0.5:5:4:1
35:6:0.5:5:4:0.5
35:6:0.5:5:2:4
35:6:0.5:5:2:2
35:6:0.5:5:2:1
35:6:0.5:5:2:0.5
35:6:0.5:5:1:4
35:6:0.5:5:1:2
35:6:0.5:5:1:1
35:6:0.5:5:1:0.5
35:6:0.5:5:0.5:4
35:6:0.5:5:0.5:2
35:6:0.5:5:0.5:1
35:6:0.5:5:0.5:0.5
35:4:4:25:6:4
35:4:4:25:6:2
35:4:4:25:6:1
35:4:4:25:6:0.5
35:4:4:25:4:4
35:4:4:25:4:2
35:4:4:25:4:1
35:4:4:25:4:0.5
35:4:4:25:2:4
35:4:4:25:2:2
35:4:4:25:2:1
35:4:4:25:2:0.5
35:4:4:25:1:4
35:4:4:25:1:2
35:4:4:25:1:1
35:4:4:25:1:0.5
35:4:4:25:0.5:4
35:4:4:25:0.5:2
35:4:4:25:0.5:1
35:4:4:25:0.5:0.5
35:4:4:15:6:4
35:4:4:15:6:2
35:4:4:15:6:1
35:4:4:15:6:0.5
35:4:4:15:4:4
35:4:4:15:4:2
35:4:4:15:4:1
35:4:4:15:4:0.5
35:4:4:15:2:4
35:4:4:15:2:2
35:4:4:15:2:1
35:4:4:15:2:0.5
35:4:4:15:1:4
35:4:4:15:1:2
35:4:4:15:1:1
35:4:4:15:1:0.5
35:4:4:15:0.5:4
35:4:4:15:0.5:2
35:4:4:15:0.5:1
35:4:4:15:0.5:0.5
35:4:4:5:6:4
35:4:4:5:6:2
35:4:4:5:6:1
35:4:4:5:6:0.5
35:4:4:5:4:4
35:4:4:5:4:2
35:4:4:5:4:1
35:4:4:5:4:0.5
35:4:4:5:2:4
35:4:4:5:2:2
35:4:4:5:2:1
35:4:4:5:2:0.5
35:4:4:5:1:4
35:4:4:5:1:2
35:4:4:5:1:1
35:4:4:5:1:0.5
35:4:4:5:0.5:4
35:4:4:5:0.5:2
35:4:4:5:0.5:1
35:4:4:5:0.5:0.5
35:4:2:25:6:4
35:4:2:25:6:2
35:4:2:25:6:1
35:4:2:25:6:0.5
35:4:2:25:4:4
35:4:2:25:4:2
35:4:2:25:4:1
35:4:2:25:4:0.5
35:4:2:25:2:4
35:4:2:25:2:2
35:4:2:25:2:1
35:4:2:25:2:0.5
35:4:2:25:1:4
35:4:2:25:1:2
35:4:2:25:1:1
35:4:2:25:1:0.5
35:4:2:25:0.5:4
35:4:2:25:0.5:2
35:4:2:25:0.5:1
35:4:2:25:0.5:0.5
35:4:2:15:6:4
35:4:2:15:6:2
35:4:2:15:6:1
35:4:2:15:6:0.5
35:4:2:15:4:4
35:4:2:15:4:2
35:4:2:15:4:1
35:4:2:15:4:0.5
35:4:2:15:2:4
35:4:2:15:2:2
35:4:2:15:2:1
35:4:2:15:2:0.5
35:4:2:15:1:4
35:4:2:15:1:2
35:4:2:15:1:1
35:4:2:15:1:0.5
35:4:2:15:0.5:4
35:4:2:15:0.5:2
35:4:2:15:0.5:1
35:4:2:15:0.5:0.5
35:4:2:5:6:4
35:4:2:5:6:2
35:4:2:5:6:1
35:4:2:5:6:0.5
35:4:2:5:4:4
35:4:2:5:4:2
35:4:2:5:4:1
35:4:2:5:4:0.5
35:4:2:5:2:4
35:4:2:5:2:2
35:4:2:5:2:1
35:4:2:5:2:0.5
35:4:2:5:1:4
35:4:2:5:1:2
35:4:2:5:1:1
35:4:2:5:1:0.5
35:4:2:5:0.5:4
35:4:2:5:0.5:2
35:4:2:5:0.5:1
35:4:2:5:0.5:0.5
35:4:1:25:6:4
35:4:1:25:6:2
35:4:1:25:6:1
35:4:1:25:6:0.5
35:4:1:25:4:4
35:4:1:25:4:2
35:4:1:25:4:1
35:4:1:25:4:0.5
35:4:1:25:2:4
35:4:1:25:2:2
35:4:1:25:2:1
35:4:1:25:2:0.5
35:4:1:25:1:4
35:4:1:25:1:2
35:4:1:25:1:1
35:4:1:25:1:0.5
35:4:1:25:0.5:4
35:4:1:25:0.5:2
35:4:1:25:0.5:1
35:4:1:25:0.5:0.5
35:4:1:15:6:4
35:4:1:15:6:2
35:4:1:15:6:1
35:4:1:15:6:0.5
35:4:1:15:4:4
35:4:1:15:4:2
35:4:1:15:4:1
35:4:1:15:4:0.5
35:4:1:15:2:4
35:4:1:15:2:2
35:4:1:15:2:1
35:4:1:15:2:0.5
35:4:1:15:1:4
35:4:1:15:1:2
35:4:1:15:1:1
35:4:1:15:1:0.5
35:4:1:15:0.5:4
35:4:1:15:0.5:2
35:4:1:15:0.5:1
35:4:1:15:0.5:0.5
35:4:1:5:6:4
35:4:1:5:6:2
35:4:1:5:6:1
35:4:1:5:6:0.5
35:4:1:5:4:4
35:4:1:5:4:2
35:4:1:5:4:1
35:4:1:5:4:0.5
35:4:1:5:2:4
35:4:1:5:2:2
35:4:1:5:2:1
35:4:1:5:2:0.5
35:4:1:5:1:4
35:4:1:5:1:2
35:4:1:5:1:1
35:4:1:5:1:0.5
35:4:1:5:0.5:4
35:4:1:5:0.5:2
35:4:1:5:0.5:1
35:4:1:5:0.5:0.5
35:4:0.5:25:6:4
35:4:0.5:25:6:2
35:4:0.5:25:6:1
35:4:0.5:25:6:0.5
35:4:0.5:25:4:4
35:4:0.5:25:4:2
35:4:0.5:25:4:1
35:4:0.5:25:4:0.5
35:4:0.5:25:2:4
35:4:0.5:25:2:2
35:4:0.5:25:2:1
35:4:0.5:25:2:0.5
35:4:0.5:25:1:4
35:4:0.5:25:1:2
35:4:0.5:25:1:1
35:4:0.5:25:1:0.5
35:4:0.5:25:0.5:4
35:4:0.5:25:0.5:2
35:4:0.5:25:0.5:1
35:4:0.5:25:0.5:0.5
35:4:0.5:15:6:4
35:4:0.5:15:6:2
35:4:0.5:15:6:1
35:4:0.5:15:6:0.5
35:4:0.5:15:4:4
35:4:0.5:15:4:2
35:4:0.5:15:4:1
35:4:0.5:15:4:0.5
35:4:0.5:15:2:4
35:4:0.5:15:2:2
35:4:0.5:15:2:1
35:4:0.5:15:2:0.5
35:4:0.5:15:1:4
35:4:0.5:15:1:2
35:4:0.5:15:1:1
35:4:0.5:15:1:0.5
35:4:0.5:15:0.5:4
35:4:0.5:15:0.5:2
35:4:0.5:15:0.5:1
35:4:0.5:15:0.5:0.5
35:4:0.5:5:6:4
35:4:0.5:5:6:2
35:4:0.5:5:6:1
35:4:0.5:5:6:0.5
35:4:0.5:5:4:4
35:4:0.5:5:4:2
35:4:0.5:5:4:1
35:4:0.5:5:4:0.5
35:4:0.5:5:2:4
35:4:0.5:5:2:2
35:4:0.5:5:2:1
35:4:0.5:5:2:0.5
35:4:0.5:5:1:4
35:4:0.5:5:1:2
35:4:0.5:5:1:1
35:4:0.5:5:1:0.5
35:4:0.5:5:0.5:4
35:4:0.5:5:0.5:2
35:4:0.5:5:0.5:1
35:4:0.5:5:0.5:0.5
35:2:4:25:6:4
35:2:4:25:6:2
35:2:4:25:6:1
35:2:4:25:6:0.5
35:2:4:25:4:4
35:2:4:25:4:2
35:2:4:25:4:1
35:2:4:25:4:0.5
35:2:4:25:2:4
35:2:4:25:2:2
35:2:4:25:2:1
35:2:4:25:2:0.5
35:2:4:25:1:4
35:2:4:25:1:2
35:2:4:25:1:1
35:2:4:25:1:0.5
35:2:4:25:0.5:4
35:2:4:25:0.5:2
35:2:4:25:0.5:1
35:2:4:25:0.5:0.5
35:2:4:15:6:4
35:2:4:15:6:2
35:2:4:15:6:1
35:2:4:15:6:0.5
35:2:4:15:4:4
35:2:4:15:4:2
35:2:4:15:4:1
35:2:4:15:4:0.5
35:2:4:15:2:4
35:2:4:15:2:2
35:2:4:15:2:1
35:2:4:15:2:0.5
35:2:4:15:1:4
35:2:4:15:1:2
35:2:4:15:1:1
35:2:4:15:1:0.5
35:2:4:15:0.5:4
35:2:4:15:0.5:2
35:2:4:15:0.5:1
35:2:4:15:0.5:0.5
35:2:4:5:6:4
35:2:4:5:6:2
35:2:4:5:6:1
35:2:4:5:6:0.5
35:2:4:5:4:4
35:2:4:5:4:2
35:2:4:5:4:1
35:2:4:5:4:0.5
35:2:4:5:2:4
35:2:4:5:2:2
35:2:4:5:2:1
35:2:4:5:2:0.5
35:2:4:5:1:4
35:2:4:5:1:2
35:2:4:5:1:1
35:2:4:5:1:0.5
35:2:4:5:0.5:4
35:2:4:5:0.5:2
35:2:4:5:0.5:1
35:2:4:5:0.5:0.5
35:2:2:25:6:4
35:2:2:25:6:2
35:2:2:25:6:1
35:2:2:25:6:0.5
35:2:2:25:4:4
35:2:2:25:4:2
35:2:2:25:4:1
35:2:2:25:4:0.5
35:2:2:25:2:4
35:2:2:25:2:2
35:2:2:25:2:1
35:2:2:25:2:0.5
35:2:2:25:1:4
35:2:2:25:1:2
35:2:2:25:1:1
35:2:2:25:1:0.5
35:2:2:25:0.5:4
35:2:2:25:0.5:2
35:2:2:25:0.5:1
35:2:2:25:0.5:0.5
35:2:2:15:6:4
35:2:2:15:6:2
35:2:2:15:6:1
35:2:2:15:6:0.5
35:2:2:15:4:4
35:2:2:15:4:2
35:2:2:15:4:1
35:2:2:15:4:0.5
35:2:2:15:2:4
35:2:2:15:2:2
35:2:2:15:2:1
35:2:2:15:2:0.5
35:2:2:15:1:4
35:2:2:15:1:2
35:2:2:15:1:1
35:2:2:15:1:0.5
35:2:2:15:0.5:4
35:2:2:15:0.5:2
35:2:2:15:0.5:1
35:2:2:15:0.5:0.5
35:2:2:5:6:4
35:2:2:5:6:2
35:2:2:5:6:1
35:2:2:5:6:0.5
35:2:2:5:4:4
35:2:2:5:4:2
35:2:2:5:4:1
35:2:2:5:4:0.5
35:2:2:5:2:4
35:2:2:5:2:2
35:2:2:5:2:1
35:2:2:5:2:0.5
35:2:2:5:1:4
35:2:2:5:1:2
35:2:2:5:1:1
35:2:2:5:1:0.5
35:2:2:5:0.5:4
35:2:2:5:0.5:2
35:2:2:5:0.5:1
35:2:2:5:0.5:0.5
35:2:1:25:6:4
35:2:1:25:6:2
35:2:1:25:6:1
35:2:1:25:6:0.5
35:2:1:25:4:4
35:2:1:25:4:2
35:2:1:25:4:1
35:2:1:25:4:0.5
35:2:1:25:2:4
35:2:1:25:2:2
35:2:1:25:2:1
35:2:1:25:2:0.5
35:2:1:25:1:4
35:2:1:25:1:2
35:2:1:25:1:1
35:2:1:25:1:0.5
35:2:1:25:0.5:4
35:2:1:25:0.5:2
35:2:1:25:0.5:1
35:2:1:25:0.5:0.5
35:2:1:15:6:4
35:2:1:15:6:2
35:2:1:15:6:1
35:2:1:15:6:0.5
35:2:1:15:4:4
35:2:1:15:4:2
35:2:1:15:4:1
35:2:1:15:4:0.5
35:2:1:15:2:4
35:2:1:15:2:2
35:2:1:15:2:1
35:2:1:15:2:0.5
35:2:1:15:1:4
35:2:1:15:1:2
35:2:1:15:1:1
35:2:1:15:1:0.5
35:2:1:15:0.5:4
35:2:1:15:0.5:2
35:2:1:15:0.5:1
35:2:1:15:0.5:0.5
35:2:1:5:6:4
35:2:1:5:6:2
35:2:1:5:6:1
35:2:1:5:6:0.5
35:2:1:5:4:4
35:2:1:5:4:2
35:2:1:5:4:1
35:2:1:5:4:0.5
35:2:1:5:2:4
35:2:1:5:2:2
35:2:1:5:2:1
35:2:1:5:2:0.5
35:2:1:5:1:4
35:2:1:5:1:2
35:2:1:5:1:1
35:2:1:5:1:0.5
35:2:1:5:0.5:4
35:2:1:5:0.5:2
35:2:1:5:0.5:1
35:2:1:5:0.5:0.5
35:2:0.5:25:6:4
35:2:0.5:25:6:2
35:2:0.5:25:6:1
35:2:0.5:25:6:0.5
35:2:0.5:25:4:4
35:2:0.5:25:4:2
35:2:0.5:25:4:1
35:2:0.5:25:4:0.5
35:2:0.5:25:2:4
35:2:0.5:25:2:2
35:2:0.5:25:2:1
35:2:0.5:25:2:0.5
35:2:0.5:25:1:4
35:2:0.5:25:1:2
35:2:0.5:25:1:1
35:2:0.5:25:1:0.5
35:2:0.5:25:0.5:4
35:2:0.5:25:0.5:2
35:2:0.5:25:0.5:1
35:2:0.5:25:0.5:0.5
35:2:0.5:15:6:4
35:2:0.5:15:6:2
35:2:0.5:15:6:1
35:2:0.5:15:6:0.5
35:2:0.5:15:4:4
35:2:0.5:15:4:2
35:2:0.5:15:4:1
35:2:0.5:15:4:0.5
35:2:0.5:15:2:4
35:2:0.5:15:2:2
35:2:0.5:15:2:1
35:2:0.5:15:2:0.5
35:2:0.5:15:1:4
35:2:0.5:15:1:2
35:2:0.5:15:1:1
35:2:0.5:15:1:0.5
35:2:0.5:15:0.5:4
35:2:0.5:15:0.5:2
35:2:0.5:15:0.5:1
35:2:0.5:15:0.5:0.5
35:2:0.5:5:6:4
35:2:0.5:5:6:2
35:2:0.5:5:6:1
35:2:0.5:5:6:0.5
35:2:0.5:5:4:4
35:2:0.5:5:4:2
35:2:0.5:5:4:1
35:2:0.5:5:4:0.5
35:2:0.5:5:2:4
35:2:0.5:5:2:2
35:2:0.5:5:2:1
35:2:0.5:5:2:0.5
35:2:0.5:5:1:4
35:2:0.5:5:1:2
35:2:0.5:5:1:1
35:2:0.5:5:1:0.5
35:2:0.5:5:0.5:4
35:2:0.5:5:0.5:2
35:2:0.5:5:0.5:1
35:2:0.5:5:0.5:0.5
35:1:4:25:6:4
35:1:4:25:6:2
35:1:4:25:6:1
35:1:4:25:6:0.5
35:1:4:25:4:4
35:1:4:25:4:2
35:1:4:25:4:1
35:1:4:25:4:0.5
35:1:4:25:2:4
35:1:4:25:2:2
35:1:4:25:2:1
35:1:4:25:2:0.5
35:1:4:25:1:4
35:1:4:25:1:2
35:1:4:25:1:1
35:1:4:25:1:0.5
35:1:4:25:0.5:4
35:1:4:25:0.5:2
35:1:4:25:0.5:1
35:1:4:25:0.5:0.5
35:1:4:15:6:4
35:1:4:15:6:2
35:1:4:15:6:1
35:1:4:15:6:0.5
35:1:4:15:4:4
35:1:4:15:4:2
35:1:4:15:4:1
35:1:4:15:4:0.5
35:1:4:15:2:4
35:1:4:15:2:2
35:1:4:15:2:1
35:1:4:15:2:0.5
35:1:4:15:1:4
35:1:4:15:1:2
35:1:4:15:1:1
35:1:4:15:1:0.5
35:1:4:15:0.5:4
35:1:4:15:0.5:2
35:1:4:15:0.5:1
35:1:4:15:0.5:0.5
35:1:4:5:6:4
35:1:4:5:6:2
35:1:4:5:6:1
35:1:4:5:6:0.5
35:1:4:5:4:4
35:1:4:5:4:2
35:1:4:5:4:1
35:1:4:5:4:0.5
35:1:4:5:2:4
35:1:4:5:2:2
35:1:4:5:2:1
35:1:4:5:2:0.5
35:1:4:5:1:4
35:1:4:5:1:2
35:1:4:5:1:1
35:1:4:5:1:0.5
35:1:4:5:0.5:4
35:1:4:5:0.5:2
35:1:4:5:0.5:1
35:1:4:5:0.5:0.5
35:1:2:25:6:4
35:1:2:25:6:2
35:1:2:25:6:1
35:1:2:25:6:0.5
35:1:2:25:4:4
35:1:2:25:4:2
35:1:2:25:4:1
35:1:2:25:4:0.5
35:1:2:25:2:4
35:1:2:25:2:2
35:1:2:25:2:1
35:1:2:25:2:0.5
35:1:2:25:1:4
35:1:2:25:1:2
35:1:2:25:1:1
35:1:2:25:1:0.5
35:1:2:25:0.5:4
35:1:2:25:0.5:2
35:1:2:25:0.5:1
35:1:2:25:0.5:0.5
35:1:2:15:6:4
35:1:2:15:6:2
35:1:2:15:6:1
35:1:2:15:6:0.5
35:1:2:15:4:4
35:1:2:15:4:2
35:1:2:15:4:1
35:1:2:15:4:0.5
35:1:2:15:2:4
35:1:2:15:2:2
35:1:2:15:2:1
35:1:2:15:2:0.5
35:1:2:15:1:4
35:1:2:15:1:2
35:1:2:15:1:1
35:1:2:15:1:0.5
35:1:2:15:0.5:4
35:1:2:15:0.5:2
35:1:2:15:0.5:1
35:1:2:15:0.5:0.5
35:1:2:5:6:4
35:1:2:5:6:2
35:1:2:5:6:1
35:1:2:5:6:0.5
35:1:2:5:4:4
35:1:2:5:4:2
35:1:2:5:4:1
35:1:2:5:4:0.5
35:1:2:5:2:4
35:1:2:5:2:2
35:1:2:5:2:1
35:1:2:5:2:0.5
35:1:2:5:1:4
35:1:2:5:1:2
35:1:2:5:1:1
35:1:2:5:1:0.5
35:1:2:5:0.5:4
35:1:2:5:0.5:2
35:1:2:5:0.5:1
35:1:2:5:0.5:0.5
35:1:1:25:6:4
35:1:1:25:6:2
35:1:1:25:6:1
35:1:1:25:6:0.5
35:1:1:25:4:4
35:1:1:25:4:2
35:1:1:25:4:1
35:1:1:25:4:0.5
35:1:1:25:2:4
35:1:1:25:2:2
35:1:1:25:2:1
35:1:1:25:2:0.5
35:1:1:25:1:4
35:1:1:25:1:2
35:1:1:25:1:1
35:1:1:25:1:0.5
35:1:1:25:0.5:4
35:1:1:25:0.5:2
35:1:1:25:0.5:1
35:1:1:25:0.5:0.5
35:1:1:15:6:4
35:1:1:15:6:2
35:1:1:15:6:1
35:1:1:15:6:0.5
35:1:1:15:4:4
35:1:1:15:4:2
35:1:1:15:4:1
35:1:1:15:4:0.5
35:1:1:15:2:4
35:1:1:15:2:2
35:1:1:15:2:1
35:1:1:15:2:0.5
35:1:1:15:1:4
35:1:1:15:1:2
35:1:1:15:1:1
35:1:1:15:1:0.5
35:1:1:15:0.5:4
35:1:1:15:0.5:2
35:1:1:15:0.5:1
35:1:1:15:0.5:0.5
35:1:1:5:6:4
35:1:1:5:6:2
35:1:1:5:6:1
35:1:1:5:6:0.5
35:1:1:5:4:4
35:1:1:5:4:2
35:1:1:5:4:1
35:1:1:5:4:0.5
35:1:1:5:2:4
35:1:1:5:2:2
35:1:1:5:2:1
35:1:1:5:2:0.5
35:1:1:5:1:4
35:1:1:5:1:2
35:1:1:5:1:1
35:1:1:5:1:0.5
35:1:1:5:0.5:4
35:1:1:5:0.5:2
35:1:1:5:0.5:1
35:1:1:5:0.5:0.5
35:1:0.5:25:6:4
35:1:0.5:25:6:2
35:1:0.5:25:6:1
35:1:0.5:25:6:0.5
35:1:0.5:25:4:4
35:1:0.5:25:4:2
35:1:0.5:25:4:1
35:1:0.5:25:4:0.5
35:1:0.5:25:2:4
35:1:0.5:25:2:2
35:1:0.5:25:2:1
35:1:0.5:25:2:0.5
35:1:0.5:25:1:4
35:1:0.5:25:1:2
35:1:0.5:25:1:1
35:1:0.5:25:1:0.5
35:1:0.5:25:0.5:4
35:1:0.5:25:0.5:2
35:1:0.5:25:0.5:1
35:1:0.5:25:0.5:0.5
35:1:0.5:15:6:4
35:1:0.5:15:6:2
35:1:0.5:15:6:1
35:1:0.5:15:6:0.5
35:1:0.5:15:4:4
35:1:0.5:15:4:2
35:1:0.5:15:4:1
35:1:0.5:15:4:0.5
35:1:0.5:15:2:4
35:1:0.5:15:2:2
35:1:0.5:15:2:1
35:1:0.5:15:2:0.5
35:1:0.5:15:1:4
35:1:0.5:15:1:2
35:1:0.5:15:1:1
35:1:0.5:15:1:0.5
35:1:0.5:15:0.5:4
35:1:0.5:15:0.5:2
35:1:0.5:15:0.5:1
35:1:0.5:15:0.5:0.5
35:1:0.5:5:6:4
35:1:0.5:5:6:2
35:1:0.5:5:6:1
35:1:0.5:5:6:0.5
35:1:0.5:5:4:4
35:1:0.5:5:4:2
35:1:0.5:5:4:1
35:1:0.5:5:4:0.5
35:1:0.5:5:2:4
35:1:0.5:5:2:2
35:1:0.5:5:2:1
35:1:0.5:5:2:0.5
35:1:0.5:5:1:4
35:1:0.5:5:1:2
35:1:0.5:5:1:1
35:1:0.5:5:1:0.5
35:1:0.5:5:0.5:4
35:1:0.5:5:0.5:2
35:1:0.5:5:0.5:1
35:1:0.5:5:0.5:0.5
35:0.5:4:25:6:4
35:0.5:4:25:6:2
35:0.5:4:25:6:1
35:0.5:4:25:6:0.5
35:0.5:4:25:4:4
35:0.5:4:25:4:2
35:0.5:4:25:4:1
35:0.5:4:25:4:0.5
35:0.5:4:25:2:4
35:0.5:4:25:2:2
35:0.5:4:25:2:1
35:0.5:4:25:2:0.5
35:0.5:4:25:1:4
35:0.5:4:25:1:2
35:0.5:4:25:1:1
35:0.5:4:25:1:0.5
35:0.5:4:25:0.5:4
35:0.5:4:25:0.5:2
35:0.5:4:25:0.5:1
35:0.5:4:25:0.5:0.5
35:0.5:4:15:6:4
35:0.5:4:15:6:2
35:0.5:4:15:6:1
35:0.5:4:15:6:0.5
35:0.5:4:15:4:4
35:0.5:4:15:4:2
35:0.5:4:15:4:1
35:0.5:4:15:4:0.5
35:0.5:4:15:2:4
35:0.5:4:15:2:2
35:0.5:4:15:2:1
35:0.5:4:15:2:0.5
35:0.5:4:15:1:4
35:0.5:4:15:1:2
35:0.5:4:15:1:1
35:0.5:4:15:1:0.5
35:0.5:4:15:0.5:4
35:0.5:4:15:0.5:2
35:0.5:4:15:0.5:1
35:0.5:4:15:0.5:0.5
35:0.5:4:5:6:4
35:0.5:4:5:6:2
35:0.5:4:5:6:1
35:0.5:4:5:6:0.5
35:0.5:4:5:4:4
35:0.5:4:5:4:2
35:0.5:4:5:4:1
35:0.5:4:5:4:0.5
35:0.5:4:5:2:4
35:0.5:4:5:2:2
35:0.5:4:5:2:1
35:0.5:4:5:2:0.5
35:0.5:4:5:1:4
35:0.5:4:5:1:2
35:0.5:4:5:1:1
35:0.5:4:5:1:0.5
35:0.5:4:5:0.5:4
35:0.5:4:5:0.5:2
35:0.5:4:5:0.5:1
35:0.5:4:5:0.5:0.5
35:0.5:2:25:6:4
35:0.5:2:25:6:2
35:0.5:2:25:6:1
35:0.5:2:25:6:0.5
35:0.5:2:25:4:4
35:0.5:2:25:4:2
35:0.5:2:25:4:1
35:0.5:2:25:4:0.5
35:0.5:2:25:2:4
35:0.5:2:25:2:2
35:0.5:2:25:2:1
35:0.5:2:25:2:0.5
35:0.5:2:25:1:4
35:0.5:2:25:1:2
35:0.5:2:25:1:1
35:0.5:2:25:1:0.5
35:0.5:2:25:0.5:4
35:0.5:2:25:0.5:2
35:0.5:2:25:0.5:1
35:0.5:2:25:0.5:0.5
35:0.5:2:15:6:4
35:0.5:2:15:6:2
35:0.5:2:15:6:1
35:0.5:2:15:6:0.5
35:0.5:2:15:4:4
35:0.5:2:15:4:2
35:0.5:2:15:4:1
35:0.5:2:15:4:0.5
35:0.5:2:15:2:4
35:0.5:2:15:2:2
35:0.5:2:15:2:1
35:0.5:2:15:2:0.5
35:0.5:2:15:1:4
35:0.5:2:15:1:2
35:0.5:2:15:1:1
35:0.5:2:15:1:0.5
35:0.5:2:15:0.5:4
35:0.5:2:15:0.5:2
35:0.5:2:15:0.5:1
35:0.5:2:15:0.5:0.5
35:0.5:2:5:6:4
35:0.5:2:5:6:2
35:0.5:2:5:6:1
35:0.5:2:5:6:0.5
35:0.5:2:5:4:4
35:0.5:2:5:4:2
35:0.5:2:5:4:1
35:0.5:2:5:4:0.5
35:0.5:2:5:2:4
35:0.5:2:5:2:2
35:0.5:2:5:2:1
35:0.5:2:5:2:0.5
35:0.5:2:5:1:4
35:0.5:2:5:1:2
35:0.5:2:5:1:1
35:0.5:2:5:1:0.5
35:0.5:2:5:0.5:4
35:0.5:2:5:0.5:2
35:0.5:2:5:0.5:1
35:0.5:2:5:0.5:0.5
35:0.5:1:25:6:4
35:0.5:1:25:6:2
35:0.5:1:25:6:1
35:0.5:1:25:6:0.5
35:0.5:1:25:4:4
35:0.5:1:25:4:2
35:0.5:1:25:4:1
35:0.5:1:25:4:0.5
35:0.5:1:25:2:4
35:0.5:1:25:2:2
35:0.5:1:25:2:1
35:0.5:1:25:2:0.5
35:0.5:1:25:1:4
35:0.5:1:25:1:2
35:0.5:1:25:1:1
35:0.5:1:25:1:0.5
35:0.5:1:25:0.5:4
35:0.5:1:25:0.5:2
35:0.5:1:25:0.5:1
35:0.5:1:25:0.5:0.5
35:0.5:1:15:6:4
35:0.5:1:15:6:2
35:0.5:1:15:6:1
35:0.5:1:15:6:0.5
35:0.5:1:15:4:4
35:0.5:1:15:4:2
35:0.5:1:15:4:1
35:0.5:1:15:4:0.5
35:0.5:1:15:2:4
35:0.5:1:15:2:2
35:0.5:1:15:2:1
35:0.5:1:15:2:0.5
35:0.5:1:15:1:4
35:0.5:1:15:1:2
35:0.5:1:15:1:1
35:0.5:1:15:1:0.5
35:0.5:1:15:0.5:4
35:0.5:1:15:0.5:2
35:0.5:1:15:0.5:1
35:0.5:1:15:0.5:0.5
35:0.5:1:5:6:4
35:0.5:1:5:6:2
35:0.5:1:5:6:1
35:0.5:1:5:6:0.5
35:0.5:1:5:4:4
35:0.5:1:5:4:2
35:0.5:1:5:4:1
35:0.5:1:5:4:0.5
35:0.5:1:5:2:4
35:0.5:1:5:2:2
35:0.5:1:5:2:1
35:0.5:1:5:2:0.5
35:0.5:1:5:1:4
35:0.5:1:5:1:2
35:0.5:1:5:1:1
35:0.5:1:5:1:0.5
35:0.5:1:5:0.5:4
35:0.5:1:5:0.5:2
35:0.5:1:5:0.5:1
35:0.5:1:5:0.5:0.5
35:0.5:0.5:25:6:4
35:0.5:0.5:25:6:2
35:0.5:0.5:25:6:1
35:0.5:0.5:25:6:0.5
35:0.5:0.5:25:4:4
35:0.5:0.5:25:4:2
35:0.5:0.5:25:4:1
35:0.5:0.5:25:4:0.5
35:0.5:0.5:25:2:4
35:0.5:0.5:25:2:2
35:0.5:0.5:25:2:1
35:0.5:0.5:25:2:0.5
35:0.5:0.5:25:1:4
35:0.5:0.5:25:1:2
35:0.5:0.5:25:1:1
35:0.5:0.5:25:1:0.5
35:0.5:0.5:25:0.5:4
35:0.5:0.5:25:0.5:2
35:0.5:0.5:25:0.5:1
35:0.5:0.5:25:0.5:0.5
35:0.5:0.5:15:6:4
35:0.5:0.5:15:6:2
35:0.5:0.5:15:6:1
35:0.5:0.5:15:6:0.5
35:0.5:0.5:15:4:4
35:0.5:0.5:15:4:2
35:0.5:0.5:15:4:1
35:0.5:0.5:15:4:0.5
35:0.5:0.5:15:2:4
35:0.5:0.5:15:2:2
35:0.5:0.5:15:2:1
35:0.5:0.5:15:2:0.5
35:0.5:0.5:15:1:4
35:0.5:0.5:15:1:2
35:0.5:0.5:15:1:1
35:0.5:0.5:15:1:0.5
35:0.5:0.5:15:0.5:4
35:0.5:0.5:15:0.5:2
35:0.5:0.5:15:0.5:1
35:0.5:0.5:15:0.5:0.5
35:0.5:0.5:5:6:4
35:0.5:0.5:5:6:2
35:0.5:0.5:5:6:1
35:0.5:0.5:5:6:0.5
35:0.5:0.5:5:4:4
35:0.5:0.5:5:4:2
35:0.5:0.5:5:4:1
35:0.5:0.5:5:4:0.5
35:0.5:0.5:5:2:4
35:0.5:0.5:5:2:2
35:0.5:0.5:5:2:1
35:0.5:0.5:5:2:0.5
35:0.5:0.5:5:1:4
35:0.5:0.5:5:1:2
35:0.5:0.5:5:1:1
35:0.5:0.5:5:1:0.5
35:0.5:0.5:5:0.5:4
35:0.5:0.5:5:0.5:2
35:0.5:0.5:5:0.5:1
35:0.5:0.5:5:0.5:0.5
25:6:4:25:6:4
25:6:4:25:6:2
25:6:4:25:6:1
25:6:4:25:6:0.5
25:6:4:25:4:4
25:6:4:25:4:2
25:6:4:25:4:1
25:6:4:25:4:0.5
25:6:4:25:2:4
25:6:4:25:2:2
25:6:4:25:2:1
25:6:4:25:2:0.5
25:6:4:25:1:4
25:6:4:25:1:2
25:6:4:25:1:1
25:6:4:25:1:0.5
25:6:4:25:0.5:4
25:6:4:25:0.5:2
25:6:4:25:0.5:1
25:6:4:25:0.5:0.5
25:6:4:15:6:4
25:6:4:15:6:2
25:6:4:15:6:1
25:6:4:15:6:0.5
25:6:4:15:4:4
25:6:4:15:4:2
25:6:4:15:4:1
25:6:4:15:4:0.5
25:6:4:15:2:4
25:6:4:15:2:2
25:6:4:15:2:1
25:6:4:15:2:0.5
25:6:4:15:1:4
25:6:4:15:1:2
25:6:4:15:1:1
25:6:4:15:1:0.5
25:6:4:15:0.5:4
25:6:4:15:0.5:2
25:6:4:15:0.5:1
25:6:4:15:0.5:0.5
25:6:4:5:6:4
25:6:4:5:6:2
25:6:4:5:6:1
25:6:4:5:6:0.5
25:6:4:5:4:4
25:6:4:5:4:2
25:6:4:5:4:1
25:6:4:5:4:0.5
25:6:4:5:2:4
25:6:4:5:2:2
25:6:4:5:2:1
25:6:4:5:2:0.5
25:6:4:5:1:4
25:6:4:5:1:2
25:6:4:5:1:1
25:6:4:5:1:0.5
25:6:4:5:0.5:4
25:6:4:5:0.5:2
25:6:4:5:0.5:1
25:6:4:5:0.5:0.5
25:6:2:25:6:4
25:6:2:25:6:2
25:6:2:25:6:1
25:6:2:25:6:0.5
25:6:2:25:4:4
25:6:2:25:4:2
25:6:2:25:4:1
25:6:2:25:4:0.5
25:6:2:25:2:4
25:6:2:25:2:2
25:6:2:25:2:1
25:6:2:25:2:0.5
25:6:2:25:1:4
25:6:2:25:1:2
25:6:2:25:1:1
25:6:2:25:1:0.5
25:6:2:25:0.5:4
25:6:2:25:0.5:2
25:6:2:25:0.5:1
25:6:2:25:0.5:0.5
25:6:2:15:6:4
25:6:2:15:6:2
25:6:2:15:6:1
25:6:2:15:6:0.5
25:6:2:15:4:4
25:6:2:15:4:2
25:6:2:15:4:1
25:6:2:15:4:0.5
25:6:2:15:2:4
25:6:2:15:2:2
25:6:2:15:2:1
25:6:2:15:2:0.5
25:6:2:15:1:4
25:6:2:15:1:2
25:6:2:15:1:1
25:6:2:15:1:0.5
25:6:2:15:0.5:4
25:6:2:15:0.5:2
25:6:2:15:0.5:1
25:6:2:15:0.5:0.5
25:6:2:5:6:4
25:6:2:5:6:2
25:6:2:5:6:1
25:6:2:5:6:0.5
25:6:2:5:4:4
25:6:2:5:4:2
25:6:2:5:4:1
25:6:2:5:4:0.5
25:6:2:5:2:4
25:6:2:5:2:2
25:6:2:5:2:1
25:6:2:5:2:0.5
25:6:2:5:1:4
25:6:2:5:1:2
25:6:2:5:1:1
25:6:2:5:1:0.5
25:6:2:5:0.5:4
25:6:2:5:0.5:2
25:6:2:5:0.5:1
25:6:2:5:0.5:0.5
25:6:1:25:6:4
25:6:1:25:6:2
25:6:1:25:6:1
25:6:1:25:6:0.5
25:6:1:25:4:4
25:6:1:25:4:2
25:6:1:25:4:1
25:6:1:25:4:0.5
25:6:1:25:2:4
25:6:1:25:2:2
25:6:1:25:2:1
25:6:1:25:2:0.5
25:6:1:25:1:4
25:6:1:25:1:2
25:6:1:25:1:1
25:6:1:25:1:0.5
25:6:1:25:0.5:4
25:6:1:25:0.5:2
25:6:1:25:0.5:1
25:6:1:25:0.5:0.5
25:6:1:15:6:4
25:6:1:15:6:2
25:6:1:15:6:1
25:6:1:15:6:0.5
25:6:1:15:4:4
25:6:1:15:4:2
25:6:1:15:4:1
25:6:1:15:4:0.5
25:6:1:15:2:4
25:6:1:15:2:2
25:6:1:15:2:1
25:6:1:15:2:0.5
25:6:1:15:1:4
25:6:1:15:1:2
25:6:1:15:1:1
25:6:1:15:1:0.5
25:6:1:15:0.5:4
25:6:1:15:0.5:2
25:6:1:15:0.5:1
25:6:1:15:0.5:0.5
25:6:1:5:6:4
25:6:1:5:6:2
25:6:1:5:6:1
25:6:1:5:6:0.5
25:6:1:5:4:4
25:6:1:5:4:2
25:6:1:5:4:1
25:6:1:5:4:0.5
25:6:1:5:2:4
25:6:1:5:2:2
25:6:1:5:2:1
25:6:1:5:2:0.5
25:6:1:5:1:4
25:6:1:5:1:2
25:6:1:5:1:1
25:6:1:5:1:0.5
25:6:1:5:0.5:4
25:6:1:5:0.5:2
25:6:1:5:0.5:1
25:6:1:5:0.5:0.5
25:6:0.5:25:6:4
25:6:0.5:25:6:2
25:6:0.5:25:6:1
25:6:0.5:25:6:0.5
25:6:0.5:25:4:4
25:6:0.5:25:4:2
25:6:0.5:25:4:1
25:6:0.5:25:4:0.5
25:6:0.5:25:2:4
25:6:0.5:25:2:2
25:6:0.5:25:2:1
25:6:0.5:25:2:0.5
25:6:0.5:25:1:4
25:6:0.5:25:1:2
25:6:0.5:25:1:1
25:6:0.5:25:1:0.5
25:6:0.5:25:0.5:4
25:6:0.5:25:0.5:2
25:6:0.5:25:0.5:1
25:6:0.5:25:0.5:0.5
25:6:0.5:15:6:4
25:6:0.5:15:6:2
25:6:0.5:15:6:1
25:6:0.5:15:6:0.5
25:6:0.5:15:4:4
25:6:0.5:15:4:2
25:6:0.5:15:4:1
25:6:0.5:15:4:0.5
25:6:0.5:15:2:4
25:6:0.5:15:2:2
25:6:0.5:15:2:1
25:6:0.5:15:2:0.5
25:6:0.5:15:1:4
25:6:0.5:15:1:2
25:6:0.5:15:1:1
25:6:0.5:15:1:0.5
25:6:0.5:15:0.5:4
25:6:0.5:15:0.5:2
25:6:0.5:15:0.5:1
25:6:0.5:15:0.5:0.5
25:6:0.5:5:6:4
25:6:0.5:5:6:2
25:6:0.5:5:6:1
25:6:0.5:5:6:0.5
25:6:0.5:5:4:4
25:6:0.5:5:4:2
25:6:0.5:5:4:1
25:6:0.5:5:4:0.5
25:6:0.5:5:2:4
25:6:0.5:5:2:2
25:6:0.5:5:2:1
25:6:0.5:5:2:0.5
25:6:0.5:5:1:4
25:6:0.5:5:1:2
25:6:0.5:5:1:1
25:6:0.5:5:1:0.5
25:6:0.5:5:0.5:4
25:6:0.5:5:0.5:2
25:6:0.5:5:0.5:1
25:6:0.5:5:0.5:0.5
25:4:4:25:6:4
25:4:4:25:6:2
25:4:4:25:6:1
25:4:4:25:6:0.5
25:4:4:25:4:4
25:4:4:25:4:2
25:4:4:25:4:1
25:4:4:25:4:0.5
25:4:4:25:2:4
25:4:4:25:2:2
25:4:4:25:2:1
25:4:4:25:2:0.5
25:4:4:25:1:4
25:4:4:25:1:2
25:4:4:25:1:1
25:4:4:25:1:0.5
25:4:4:25:0.5:4
25:4:4:25:0.5:2
25:4:4:25:0.5:1
25:4:4:25:0.5:0.5
25:4:4:15:6:4
25:4:4:15:6:2
25:4:4:15:6:1
25:4:4:15:6:0.5
25:4:4:15:4:4
25:4:4:15:4:2
25:4:4:15:4:1
25:4:4:15:4:0.5
25:4:4:15:2:4
25:4:4:15:2:2
25:4:4:15:2:1
25:4:4:15:2:0.5
25:4:4:15:1:4
25:4:4:15:1:2
25:4:4:15:1:1
25:4:4:15:1:0.5
25:4:4:15:0.5:4
25:4:4:15:0.5:2
25:4:4:15:0.5:1
25:4:4:15:0.5:0.5
25:4:4:5:6:4
25:4:4:5:6:2
25:4:4:5:6:1
25:4:4:5:6:0.5
25:4:4:5:4:4
25:4:4:5:4:2
25:4:4:5:4:1
25:4:4:5:4:0.5
25:4:4:5:2:4
25:4:4:5:2:2
25:4:4:5:2:1
25:4:4:5:2:0.5
25:4:4:5:1:4
25:4:4:5:1:2
25:4:4:5:1:1
25:4:4:5:1:0.5
25:4:4:5:0.5:4
25:4:4:5:0.5:2
25:4:4:5:0.5:1
25:4:4:5:0.5:0.5
25:4:2:25:6:4
25:4:2:25:6:2
25:4:2:25:6:1
25:4:2:25:6:0.5
25:4:2:25:4:4
25:4:2:25:4:2
25:4:2:25:4:1
25:4:2:25:4:0.5
25:4:2:25:2:4
25:4:2:25:2:2
25:4:2:25:2:1
25:4:2:25:2:0.5
25:4:2:25:1:4
25:4:2:25:1:2
25:4:2:25:1:1
25:4:2:25:1:0.5
25:4:2:25:0.5:4
25:4:2:25:0.5:2
25:4:2:25:0.5:1
25:4:2:25:0.5:0.5
25:4:2:15:6:4
25:4:2:15:6:2
25:4:2:15:6:1
25:4:2:15:6:0.5
25:4:2:15:4:4
25:4:2:15:4:2
25:4:2:15:4:1
25:4:2:15:4:0.5
25:4:2:15:2:4
25:4:2:15:2:2
25:4:2:15:2:1
25:4:2:15:2:0.5
25:4:2:15:1:4
25:4:2:15:1:2
25:4:2:15:1:1
25:4:2:15:1:0.5
25:4:2:15:0.5:4
25:4:2:15:0.5:2
25:4:2:15:0.5:1
25:4:2:15:0.5:0.5
25:4:2:5:6:4
25:4:2:5:6:2
25:4:2:5:6:1
25:4:2:5:6:0.5
25:4:2:5:4:4
25:4:2:5:4:2
25:4:2:5:4:1
25:4:2:5:4:0.5
25:4:2:5:2:4
25:4:2:5:2:2
25:4:2:5:2:1
25:4:2:5:2:0.5
25:4:2:5:1:4
25:4:2:5:1:2
25:4:2:5:1:1
25:4:2:5:1:0.5
25:4:2:5:0.5:4
25:4:2:5:0.5:2
25:4:2:5:0.5:1
25:4:2:5:0.5:0.5
25:4:1:25:6:4
25:4:1:25:6:2
25:4:1:25:6:1
25:4:1:25:6:0.5
25:4:1:25:4:4
25:4:1:25:4:2
25:4:1:25:4:1
25:4:1:25:4:0.5
25:4:1:25:2:4
25:4:1:25:2:2
25:4:1:25:2:1
25:4:1:25:2:0.5
25:4:1:25:1:4
25:4:1:25:1:2
25:4:1:25:1:1
25:4:1:25:1:0.5
25:4:1:25:0.5:4
25:4:1:25:0.5:2
25:4:1:25:0.5:1
25:4:1:25:0.5:0.5
25:4:1:15:6:4
25:4:1:15:6:2
25:4:1:15:6:1
25:4:1:15:6:0.5
25:4:1:15:4:4
25:4:1:15:4:2
25:4:1:15:4:1
25:4:1:15:4:0.5
25:4:1:15:2:4
25:4:1:15:2:2
25:4:1:15:2:1
25:4:1:15:2:0.5
25:4:1:15:1:4
25:4:1:15:1:2
25:4:1:15:1:1
25:4:1:15:1:0.5
25:4:1:15:0.5:4
25:4:1:15:0.5:2
25:4:1:15:0.5:1
25:4:1:15:0.5:0.5
25:4:1:5:6:4
25:4:1:5:6:2
25:4:1:5:6:1
25:4:1:5:6:0.5
25:4:1:5:4:4
25:4:1:5:4:2
25:4:1:5:4:1
25:4:1:5:4:0.5
25:4:1:5:2:4
25:4:1:5:2:2
25:4:1:5:2:1
25:4:1:5:2:0.5
25:4:1:5:1:4
25:4:1:5:1:2
25:4:1:5:1:1
25:4:1:5:1:0.5
25:4:1:5:0.5:4
25:4:1:5:0.5:2
25:4:1:5:0.5:1
25:4:1:5:0.5:0.5
25:4:0.5:25:6:4
25:4:0.5:25:6:2
25:4:0.5:25:6:1
25:4:0.5:25:6:0.5
25:4:0.5:25:4:4
25:4:0.5:25:4:2
25:4:0.5:25:4:1
25:4:0.5:25:4:0.5
25:4:0.5:25:2:4
25:4:0.5:25:2:2
25:4:0.5:25:2:1
25:4:0.5:25:2:0.5
25:4:0.5:25:1:4
25:4:0.5:25:1:2
25:4:0.5:25:1:1
25:4:0.5:25:1:0.5
25:4:0.5:25:0.5:4
25:4:0.5:25:0.5:2
25:4:0.5:25:0.5:1
25:4:0.5:25:0.5:0.5
25:4:0.5:15:6:4
25:4:0.5:15:6:2
25:4:0.5:15:6:1
25:4:0.5:15:6:0.5
25:4:0.5:15:4:4
25:4:0.5:15:4:2
25:4:0.5:15:4:1
25:4:0.5:15:4:0.5
25:4:0.5:15:2:4
25:4:0.5:15:2:2
25:4:0.5:15:2:1
25:4:0.5:15:2:0.5
25:4:0.5:15:1:4
25:4:0.5:15:1:2
25:4:0.5:15:1:1
25:4:0.5:15:1:0.5
25:4:0.5:15:0.5:4
25:4:0.5:15:0.5:2
25:4:0.5:15:0.5:1
25:4:0.5:15:0.5:0.5
25:4:0.5:5:6:4
25:4:0.5:5:6:2
25:4:0.5:5:6:1
25:4:0.5:5:6:0.5
25:4:0.5:5:4:4
25:4:0.5:5:4:2
25:4:0.5:5:4:1
25:4:0.5:5:4:0.5
25:4:0.5:5:2:4
25:4:0.5:5:2:2
25:4:0.5:5:2:1
25:4:0.5:5:2:0.5
25:4:0.5:5:1:4
25:4:0.5:5:1:2
25:4:0.5:5:1:1
25:4:0.5:5:1:0.5
25:4:0.5:5:0.5:4
25:4:0.5:5:0.5:2
25:4:0.5:5:0.5:1
25:4:0.5:5:0.5:0.5
25:2:4:25:6:4
25:2:4:25:6:2
25:2:4:25:6:1
25:2:4:25:6:0.5
25:2:4:25:4:4
25:2:4:25:4:2
25:2:4:25:4:1
25:2:4:25:4:0.5
25:2:4:25:2:4
25:2:4:25:2:2
25:2:4:25:2:1
25:2:4:25:2:0.5
25:2:4:25:1:4
25:2:4:25:1:2
25:2:4:25:1:1
25:2:4:25:1:0.5
25:2:4:25:0.5:4
25:2:4:25:0.5:2
25:2:4:25:0.5:1
25:2:4:25:0.5:0.5
25:2:4:15:6:4
25:2:4:15:6:2
25:2:4:15:6:1
25:2:4:15:6:0.5
25:2:4:15:4:4
25:2:4:15:4:2
25:2:4:15:4:1
25:2:4:15:4:0.5
25:2:4:15:2:4
25:2:4:15:2:2
25:2:4:15:2:1
25:2:4:15:2:0.5
25:2:4:15:1:4
25:2:4:15:1:2
25:2:4:15:1:1
25:2:4:15:1:0.5
25:2:4:15:0.5:4
25:2:4:15:0.5:2
25:2:4:15:0.5:1
25:2:4:15:0.5:0.5
25:2:4:5:6:4
25:2:4:5:6:2
25:2:4:5:6:1
25:2:4:5:6:0.5
25:2:4:5:4:4
25:2:4:5:4:2
25:2:4:5:4:1
25:2:4:5:4:0.5
25:2:4:5:2:4
25:2:4:5:2:2
25:2:4:5:2:1
25:2:4:5:2:0.5
25:2:4:5:1:4
25:2:4:5:1:2
25:2:4:5:1:1
25:2:4:5:1:0.5
25:2:4:5:0.5:4
25:2:4:5:0.5:2
25:2:4:5:0.5:1
25:2:4:5:0.5:0.5
25:2:2:25:6:4
25:2:2:25:6:2
25:2:2:25:6:1
25:2:2:25:6:0.5
25:2:2:25:4:4
25:2:2:25:4:2
25:2:2:25:4:1
25:2:2:25:4:0.5
25:2:2:25:2:4
25:2:2:25:2:2
25:2:2:25:2:1
25:2:2:25:2:0.5
25:2:2:25:1:4
25:2:2:25:1:2
25:2:2:25:1:1
25:2:2:25:1:0.5
25:2:2:25:0.5:4
25:2:2:25:0.5:2
25:2:2:25:0.5:1
25:2:2:25:0.5:0.5
25:2:2:15:6:4
25:2:2:15:6:2
25:2:2:15:6:1
25:2:2:15:6:0.5
25:2:2:15:4:4
25:2:2:15:4:2
25:2:2:15:4:1
25:2:2:15:4:0.5
25:2:2:15:2:4
25:2:2:15:2:2
25:2:2:15:2:1
25:2:2:15:2:0.5
25:2:2:15:1:4
25:2:2:15:1:2
25:2:2:15:1:1
25:2:2:15:1:0.5
25:2:2:15:0.5:4
25:2:2:15:0.5:2
25:2:2:15:0.5:1
25:2:2:15:0.5:0.5
25:2:2:5:6:4
25:2:2:5:6:2
25:2:2:5:6:1
25:2:2:5:6:0.5
25:2:2:5:4:4
25:2:2:5:4:2
25:2:2:5:4:1
25:2:2:5:4:0.5
25:2:2:5:2:4
25:2:2:5:2:2
25:2:2:5:2:1
25:2:2:5:2:0.5
25:2:2:5:1:4
25:2:2:5:1:2
25:2:2:5:1:1
25:2:2:5:1:0.5
25:2:2:5:0.5:4
25:2:2:5:0.5:2
25:2:2:5:0.5:1
25:2:2:5:0.5:0.5
25:2:1:25:6:4
25:2:1:25:6:2
25:2:1:25:6:1
25:2:1:25:6:0.5
25:2:1:25:4:4
25:2:1:25:4:2
25:2:1:25:4:1
25:2:1:25:4:0.5
25:2:1:25:2:4
25:2:1:25:2:2
25:2:1:25:2:1
25:2:1:25:2:0.5
25:2:1:25:1:4
25:2:1:25:1:2
25:2:1:25:1:1
25:2:1:25:1:0.5
25:2:1:25:0.5:4
25:2:1:25:0.5:2
25:2:1:25:0.5:1
25:2:1:25:0.5:0.5
25:2:1:15:6:4
25:2:1:15:6:2
25:2:1:15:6:1
25:2:1:15:6:0.5
25:2:1:15:4:4
25:2:1:15:4:2
25:2:1:15:4:1
25:2:1:15:4:0.5
25:2:1:15:2:4
25:2:1:15:2:2
25:2:1:15:2:1
25:2:1:15:2:0.5
25:2:1:15:1:4
25:2:1:15:1:2
25:2:1:15:1:1
25:2:1:15:1:0.5
25:2:1:15:0.5:4
25:2:1:15:0.5:2
25:2:1:15:0.5:1
25:2:1:15:0.5:0.5
25:2:1:5:6:4
25:2:1:5:6:2
25:2:1:5:6:1
25:2:1:5:6:0.5
25:2:1:5:4:4
25:2:1:5:4:2
25:2:1:5:4:1
25:2:1:5:4:0.5
25:2:1:5:2:4
25:2:1:5:2:2
25:2:1:5:2:1
25:2:1:5:2:0.5
25:2:1:5:1:4
25:2:1:5:1:2
25:2:1:5:1:1
25:2:1:5:1:0.5
25:2:1:5:0.5:4
25:2:1:5:0.5:2
25:2:1:5:0.5:1
25:2:1:5:0.5:0.5
25:2:0.5:25:6:4
25:2:0.5:25:6:2
25:2:0.5:25:6:1
25:2:0.5:25:6:0.5
25:2:0.5:25:4:4
25:2:0.5:25:4:2
25:2:0.5:25:4:1
25:2:0.5:25:4:0.5
25:2:0.5:25:2:4
25:2:0.5:25:2:2
25:2:0.5:25:2:1
25:2:0.5:25:2:0.5
25:2:0.5:25:1:4
25:2:0.5:25:1:2
25:2:0.5:25:1:1
25:2:0.5:25:1:0.5
25:2:0.5:25:0.5:4
25:2:0.5:25:0.5:2
25:2:0.5:25:0.5:1
25:2:0.5:25:0.5:0.5
25:2:0.5:15:6:4
25:2:0.5:15:6:2
25:2:0.5:15:6:1
25:2:0.5:15:6:0.5
25:2:0.5:15:4:4
25:2:0.5:15:4:2
25:2:0.5:15:4:1
25:2:0.5:15:4:0.5
25:2:0.5:15:2:4
25:2:0.5:15:2:2
25:2:0.5:15:2:1
25:2:0.5:15:2:0.5
25:2:0.5:15:1:4
25:2:0.5:15:1:2
25:2:0.5:15:1:1
25:2:0.5:15:1:0.5
25:2:0.5:15:0.5:4
25:2:0.5:15:0.5:2
25:2:0.5:15:0.5:1
25:2:0.5:15:0.5:0.5
25:2:0.5:5:6:4
25:2:0.5:5:6:2
25:2:0.5:5:6:1
25:2:0.5:5:6:0.5
25:2:0.5:5:4:4
25:2:0.5:5:4:2
25:2:0.5:5:4:1
25:2:0.5:5:4:0.5
25:2:0.5:5:2:4
25:2:0.5:5:2:2
25:2:0.5:5:2:1
25:2:0.5:5:2:0.5
25:2:0.5:5:1:4
25:2:0.5:5:1:2
25:2:0.5:5:1:1
25:2:0.5:5:1:0.5
25:2:0.5:5:0.5:4
25:2:0.5:5:0.5:2
25:2:0.5:5:0.5:1
25:2:0.5:5:0.5:0.5
25:1:4:25:6:4
25:1:4:25:6:2
25:1:4:25:6:1
25:1:4:25:6:0.5
25:1:4:25:4:4
25:1:4:25:4:2
25:1:4:25:4:1
25:1:4:25:4:0.5
25:1:4:25:2:4
25:1:4:25:2:2
25:1:4:25:2:1
25:1:4:25:2:0.5
25:1:4:25:1:4
25:1:4:25:1:2
25:1:4:25:1:1
25:1:4:25:1:0.5
25:1:4:25:0.5:4
25:1:4:25:0.5:2
25:1:4:25:0.5:1
25:1:4:25:0.5:0.5
25:1:4:15:6:4
25:1:4:15:6:2
25:1:4:15:6:1
25:1:4:15:6:0.5
25:1:4:15:4:4
25:1:4:15:4:2
25:1:4:15:4:1
25:1:4:15:4:0.5
25:1:4:15:2:4
25:1:4:15:2:2
25:1:4:15:2:1
25:1:4:15:2:0.5
25:1:4:15:1:4
25:1:4:15:1:2
25:1:4:15:1:1
25:1:4:15:1:0.5
25:1:4:15:0.5:4
25:1:4:15:0.5:2
25:1:4:15:0.5:1
25:1:4:15:0.5:0.5
25:1:4:5:6:4
25:1:4:5:6:2
25:1:4:5:6:1
25:1:4:5:6:0.5
25:1:4:5:4:4
25:1:4:5:4:2
25:1:4:5:4:1
25:1:4:5:4:0.5
25:1:4:5:2:4
25:1:4:5:2:2
25:1:4:5:2:1
25:1:4:5:2:0.5
25:1:4:5:1:4
25:1:4:5:1:2
25:1:4:5:1:1
25:1:4:5:1:0.5
25:1:4:5:0.5:4
25:1:4:5:0.5:2
25:1:4:5:0.5:1
25:1:4:5:0.5:0.5
25:1:2:25:6:4
25:1:2:25:6:2
25:1:2:25:6:1
25:1:2:25:6:0.5
25:1:2:25:4:4
25:1:2:25:4:2
25:1:2:25:4:1
25:1:2:25:4:0.5
25:1:2:25:2:4
25:1:2:25:2:2
25:1:2:25:2:1
25:1:2:25:2:0.5
25:1:2:25:1:4
25:1:2:25:1:2
25:1:2:25:1:1
25:1:2:25:1:0.5
25:1:2:25:0.5:4
25:1:2:25:0.5:2
25:1:2:25:0.5:1
25:1:2:25:0.5:0.5
25:1:2:15:6:4
25:1:2:15:6:2
25:1:2:15:6:1
25:1:2:15:6:0.5
25:1:2:15:4:4
25:1:2:15:4:2
25:1:2:15:4:1
25:1:2:15:4:0.5
25:1:2:15:2:4
25:1:2:15:2:2
25:1:2:15:2:1
25:1:2:15:2:0.5
25:1:2:15:1:4
25:1:2:15:1:2
25:1:2:15:1:1
25:1:2:15:1:0.5
25:1:2:15:0.5:4
25:1:2:15:0.5:2
25:1:2:15:0.5:1
25:1:2:15:0.5:0.5
25:1:2:5:6:4
25:1:2:5:6:2
25:1:2:5:6:1
25:1:2:5:6:0.5
25:1:2:5:4:4
25:1:2:5:4:2
25:1:2:5:4:1
25:1:2:5:4:0.5
25:1:2:5:2:4
25:1:2:5:2:2
25:1:2:5:2:1
25:1:2:5:2:0.5
25:1:2:5:1:4
25:1:2:5:1:2
25:1:2:5:1:1
25:1:2:5:1:0.5
25:1:2:5:0.5:4
25:1:2:5:0.5:2
25:1:2:5:0.5:1
25:1:2:5:0.5:0.5
25:1:1:25:6:4
25:1:1:25:6:2
25:1:1:25:6:1
25:1:1:25:6:0.5
25:1:1:25:4:4
25:1:1:25:4:2
25:1:1:25:4:1
25:1:1:25:4:0.5
25:1:1:25:2:4
25:1:1:25:2:2
25:1:1:25:2:1
25:1:1:25:2:0.5
25:1:1:25:1:4
25:1:1:25:1:2
25:1:1:25:1:1
25:1:1:25:1:0.5
25:1:1:25:0.5:4
25:1:1:25:0.5:2
25:1:1:25:0.5:1
25:1:1:25:0.5:0.5
25:1:1:15:6:4
25:1:1:15:6:2
25:1:1:15:6:1
25:1:1:15:6:0.5
25:1:1:15:4:4
25:1:1:15:4:2
25:1:1:15:4:1
25:1:1:15:4:0.5
25:1:1:15:2:4
25:1:1:15:2:2
25:1:1:15:2:1
25:1:1:15:2:0.5
25:1:1:15:1:4
25:1:1:15:1:2
25:1:1:15:1:1
25:1:1:15:1:0.5
25:1:1:15:0.5:4
25:1:1:15:0.5:2
25:1:1:15:0.5:1
25:1:1:15:0.5:0.5
25:1:1:5:6:4
25:1:1:5:6:2
25:1:1:5:6:1
25:1:1:5:6:0.5
25:1:1:5:4:4
25:1:1:5:4:2
25:1:1:5:4:1
25:1:1:5:4:0.5
25:1:1:5:2:4
25:1:1:5:2:2
25:1:1:5:2:1
25:1:1:5:2:0.5
25:1:1:5:1:4
25:1:1:5:1:2
25:1:1:5:1:1
25:1:1:5:1:0.5
25:1:1:5:0.5:4
25:1:1:5:0.5:2
25:1:1:5:0.5:1
25:1:1:5:0.5:0.5
25:1:0.5:25:6:4
25:1:0.5:25:6:2
25:1:0.5:25:6:1
25:1:0.5:25:6:0.5
25:1:0.5:25:4:4
25:1:0.5:25:4:2
25:1:0.5:25:4:1
25:1:0.5:25:4:0.5
25:1:0.5:25:2:4
25:1:0.5:25:2:2
25:1:0.5:25:2:1
25:1:0.5:25:2:0.5
25:1:0.5:25:1:4
25:1:0.5:25:1:2
25:1:0.5:25:1:1
25:1:0.5:25:1:0.5
25:1:0.5:25:0.5:4
25:1:0.5:25:0.5:2
25:1:0.5:25:0.5:1
25:1:0.5:25:0.5:0.5
25:1:0.5:15:6:4
25:1:0.5:15:6:2
25:1:0.5:15:6:1
25:1:0.5:15:6:0.5
25:1:0.5:15:4:4
25:1:0.5:15:4:2
25:1:0.5:15:4:1
25:1:0.5:15:4:0.5
25:1:0.5:15:2:4
25:1:0.5:15:2:2
25:1:0.5:15:2:1
25:1:0.5:15:2:0.5
25:1:0.5:15:1:4
25:1:0.5:15:1:2
25:1:0.5:15:1:1
25:1:0.5:15:1:0.5
25:1:0.5:15:0.5:4
25:1:0.5:15:0.5:2
25:1:0.5:15:0.5:1
25:1:0.5:15:0.5:0.5
25:1:0.5:5:6:4
25:1:0.5:5:6:2
25:1:0.5:5:6:1
25:1:0.5:5:6:0.5
25:1:0.5:5:4:4
25:1:0.5:5:4:2
25:1:0.5:5:4:1
25:1:0.5:5:4:0.5
25:1:0.5:5:2:4
25:1:0.5:5:2:2
25:1:0.5:5:2:1
25:1:0.5:5:2:0.5
25:1:0.5:5:1:4
25:1:0.5:5:1:2
25:1:0.5:5:1:1
25:1:0.5:5:1:0.5
25:1:0.5:5:0.5:4
25:1:0.5:5:0.5:2
25:1:0.5:5:0.5:1
25:1:0.5:5:0.5:0.5
25:0.5:4:25:6:4
25:0.5:4:25:6:2
25:0.5:4:25:6:1
25:0.5:4:25:6:0.5
25:0.5:4:25:4:4
25:0.5:4:25:4:2
25:0.5:4:25:4:1
25:0.5:4:25:4:0.5
25:0.5:4:25:2:4
25:0.5:4:25:2:2
25:0.5:4:25:2:1
25:0.5:4:25:2:0.5
25:0.5:4:25:1:4
25:0.5:4:25:1:2
25:0.5:4:25:1:1
25:0.5:4:25:1:0.5
25:0.5:4:25:0.5:4
25:0.5:4:25:0.5:2
25:0.5:4:25:0.5:1
25:0.5:4:25:0.5:0.5
25:0.5:4:15:6:4
25:0.5:4:15:6:2
25:0.5:4:15:6:1
25:0.5:4:15:6:0.5
25:0.5:4:15:4:4
25:0.5:4:15:4:2
25:0.5:4:15:4:1
25:0.5:4:15:4:0.5
25:0.5:4:15:2:4
25:0.5:4:15:2:2
25:0.5:4:15:2:1
25:0.5:4:15:2:0.5
25:0.5:4:15:1:4
25:0.5:4:15:1:2
25:0.5:4:15:1:1
25:0.5:4:15:1:0.5
25:0.5:4:15:0.5:4
25:0.5:4:15:0.5:2
25:0.5:4:15:0.5:1
25:0.5:4:15:0.5:0.5
25:0.5:4:5:6:4
25:0.5:4:5:6:2
25:0.5:4:5:6:1
25:0.5:4:5:6:0.5
25:0.5:4:5:4:4
25:0.5:4:5:4:2
25:0.5:4:5:4:1
25:0.5:4:5:4:0.5
25:0.5:4:5:2:4
25:0.5:4:5:2:2
25:0.5:4:5:2:1
25:0.5:4:5:2:0.5
25:0.5:4:5:1:4
25:0.5:4:5:1:2
25:0.5:4:5:1:1
25:0.5:4:5:1:0.5
25:0.5:4:5:0.5:4
25:0.5:4:5:0.5:2
25:0.5:4:5:0.5:1
25:0.5:4:5:0.5:0.5
25:0.5:2:25:6:4
25:0.5:2:25:6:2
25:0.5:2:25:6:1
25:0.5:2:25:6:0.5
25:0.5:2:25:4:4
25:0.5:2:25:4:2
25:0.5:2:25:4:1
25:0.5:2:25:4:0.5
25:0.5:2:25:2:4
25:0.5:2:25:2:2
25:0.5:2:25:2:1
25:0.5:2:25:2:0.5
25:0.5:2:25:1:4
25:0.5:2:25:1:2
25:0.5:2:25:1:1
25:0.5:2:25:1:0.5
25:0.5:2:25:0.5:4
25:0.5:2:25:0.5:2
25:0.5:2:25:0.5:1
25:0.5:2:25:0.5:0.5
25:0.5:2:15:6:4
25:0.5:2:15:6:2
25:0.5:2:15:6:1
25:0.5:2:15:6:0.5
25:0.5:2:15:4:4
25:0.5:2:15:4:2
25:0.5:2:15:4:1
25:0.5:2:15:4:0.5
25:0.5:2:15:2:4
25:0.5:2:15:2:2
25:0.5:2:15:2:1
25:0.5:2:15:2:0.5
25:0.5:2:15:1:4
25:0.5:2:15:1:2
25:0.5:2:15:1:1
25:0.5:2:15:1:0.5
25:0.5:2:15:0.5:4
25:0.5:2:15:0.5:2
25:0.5:2:15:0.5:1
25:0.5:2:15:0.5:0.5
25:0.5:2:5:6:4
25:0.5:2:5:6:2
25:0.5:2:5:6:1
25:0.5:2:5:6:0.5
25:0.5:2:5:4:4
25:0.5:2:5:4:2
25:0.5:2:5:4:1
25:0.5:2:5:4:0.5
25:0.5:2:5:2:4
25:0.5:2:5:2:2
25:0.5:2:5:2:1
25:0.5:2:5:2:0.5
25:0.5:2:5:1:4
25:0.5:2:5:1:2
25:0.5:2:5:1:1
25:0.5:2:5:1:0.5
25:0.5:2:5:0.5:4
25:0.5:2:5:0.5:2
25:0.5:2:5:0.5:1
25:0.5:2:5:0.5:0.5
25:0.5:1:25:6:4
25:0.5:1:25:6:2
25:0.5:1:25:6:1
25:0.5:1:25:6:0.5
25:0.5:1:25:4:4
25:0.5:1:25:4:2
25:0.5:1:25:4:1
25:0.5:1:25:4:0.5
25:0.5:1:25:2:4
25:0.5:1:25:2:2
25:0.5:1:25:2:1
25:0.5:1:25:2:0.5
25:0.5:1:25:1:4
25:0.5:1:25:1:2
25:0.5:1:25:1:1
25:0.5:1:25:1:0.5
25:0.5:1:25:0.5:4
25:0.5:1:25:0.5:2
25:0.5:1:25:0.5:1
25:0.5:1:25:0.5:0.5
25:0.5:1:15:6:4
25:0.5:1:15:6:2
25:0.5:1:15:6:1
25:0.5:1:15:6:0.5
25:0.5:1:15:4:4
25:0.5:1:15:4:2
25:0.5:1:15:4:1
25:0.5:1:15:4:0.5
25:0.5:1:15:2:4
25:0.5:1:15:2:2
25:0.5:1:15:2:1
25:0.5:1:15:2:0.5
25:0.5:1:15:1:4
25:0.5:1:15:1:2
25:0.5:1:15:1:1
25:0.5:1:15:1:0.5
25:0.5:1:15:0.5:4
25:0.5:1:15:0.5:2
25:0.5:1:15:0.5:1
25:0.5:1:15:0.5:0.5
25:0.5:1:5:6:4
25:0.5:1:5:6:2
25:0.5:1:5:6:1
25:0.5:1:5:6:0.5
25:0.5:1:5:4:4
25:0.5:1:5:4:2
25:0.5:1:5:4:1
25:0.5:1:5:4:0.5
25:0.5:1:5:2:4
25:0.5:1:5:2:2
25:0.5:1:5:2:1
25:0.5:1:5:2:0.5
25:0.5:1:5:1:4
25:0.5:1:5:1:2
25:0.5:1:5:1:1
25:0.5:1:5:1:0.5
25:0.5:1:5:0.5:4
25:0.5:1:5:0.5:2
25:0.5:1:5:0.5:1
25:0.5:1:5:0.5:0.5
25:0.5:0.5:25:6:4
25:0.5:0.5:25:6:2
25:0.5:0.5:25:6:1
25:0.5:0.5:25:6:0.5
25:0.5:0.5:25:4:4
25:0.5:0.5:25:4:2
25:0.5:0.5:25:4:1
25:0.5:0.5:25:4:0.5
25:0.5:0.5:25:2:4
25:0.5:0.5:25:2:2
25:0.5:0.5:25:2:1
25:0.5:0.5:25:2:0.5
25:0.5:0.5:25:1:4
25:0.5:0.5:25:1:2
25:0.5:0.5:25:1:1
25:0.5:0.5:25:1:0.5
25:0.5:0.5:25:0.5:4
25:0.5:0.5:25:0.5:2
25:0.5:0.5:25:0.5:1
25:0.5:0.5:25:0.5:0.5
25:0.5:0.5:15:6:4
25:0.5:0.5:15:6:2
25:0.5:0.5:15:6:1
25:0.5:0.5:15:6:0.5
25:0.5:0.5:15:4:4
25:0.5:0.5:15:4:2
25:0.5:0.5:15:4:1
25:0.5:0.5:15:4:0.5
25:0.5:0.5:15:2:4
25:0.5:0.5:15:2:2
25:0.5:0.5:15:2:1
25:0.5:0.5:15:2:0.5
25:0.5:0.5:15:1:4
25:0.5:0.5:15:1:2
25:0.5:0.5:15:1:1
25:0.5:0.5:15:1:0.5
25:0.5:0.5:15:0.5:4
25:0.5:0.5:15:0.5:2
25:0.5:0.5:15:0.5:1
25:0.5:0.5:15:0.5:0.5
25:0.5:0.5:5:6:4
25:0.5:0.5:5:6:2
25:0.5:0.5:5:6:1
25:0.5:0.5:5:6:0.5
25:0.5:0.5:5:4:4
25:0.5:0.5:5:4:2
25:0.5:0.5:5:4:1
25:0.5:0.5:5:4:0.5
25:0.5:0.5:5:2:4
25:0.5:0.5:5:2:2
25:0.5:0.5:5:2:1
25:0.5:0.5:5:2:0.5
25:0.5:0.5:5:1:4
25:0.5:0.5:5:1:2
25:0.5:0.5:5:1:1
25:0.5:0.5:5:1:0.5
25:0.5:0.5:5:0.5:4
25:0.5:0.5:5:0.5:2
25:0.5:0.5:5:0.5:1
25:0.5:0.5:5:0.5:0.5
15:6:4:25:6:4
15:6:4:25:6:2
15:6:4:25:6:1
15:6:4:25:6:0.5
15:6:4:25:4:4
15:6:4:25:4:2
15:6:4:25:4:1
15:6:4:25:4:0.5
15:6:4:25:2:4
15:6:4:25:2:2
15:6:4:25:2:1
15:6:4:25:2:0.5
15:6:4:25:1:4
15:6:4:25:1:2
15:6:4:25:1:1
15:6:4:25:1:0.5
15:6:4:25:0.5:4
15:6:4:25:0.5:2
15:6:4:25:0.5:1
15:6:4:25:0.5:0.5
15:6:4:15:6:4
15:6:4:15:6:2
15:6:4:15:6:1
15:6:4:15:6:0.5
15:6:4:15:4:4
15:6:4:15:4:2
15:6:4:15:4:1
15:6:4:15:4:0.5
15:6:4:15:2:4
15:6:4:15:2:2
15:6:4:15:2:1
15:6:4:15:2:0.5
15:6:4:15:1:4
15:6:4:15:1:2
15:6:4:15:1:1
15:6:4:15:1:0.5
15:6:4:15:0.5:4
15:6:4:15:0.5:2
15:6:4:15:0.5:1
15:6:4:15:0.5:0.5
15:6:4:5:6:4
15:6:4:5:6:2
15:6:4:5:6:1
15:6:4:5:6:0.5
15:6:4:5:4:4
15:6:4:5:4:2
15:6:4:5:4:1
15:6:4:5:4:0.5
15:6:4:5:2:4
15:6:4:5:2:2
15:6:4:5:2:1
15:6:4:5:2:0.5
15:6:4:5:1:4
15:6:4:5:1:2
15:6:4:5:1:1
15:6:4:5:1:0.5
15:6:4:5:0.5:4
15:6:4:5:0.5:2
15:6:4:5:0.5:1
15:6:4:5:0.5:0.5
15:6:2:25:6:4
15:6:2:25:6:2
15:6:2:25:6:1
15:6:2:25:6:0.5
15:6:2:25:4:4
15:6:2:25:4:2
15:6:2:25:4:1
15:6:2:25:4:0.5
15:6:2:25:2:4
15:6:2:25:2:2
15:6:2:25:2:1
15:6:2:25:2:0.5
15:6:2:25:1:4
15:6:2:25:1:2
15:6:2:25:1:1
15:6:2:25:1:0.5
15:6:2:25:0.5:4
15:6:2:25:0.5:2
15:6:2:25:0.5:1
15:6:2:25:0.5:0.5
15:6:2:15:6:4
15:6:2:15:6:2
15:6:2:15:6:1
15:6:2:15:6:0.5
15:6:2:15:4:4
15:6:2:15:4:2
15:6:2:15:4:1
15:6:2:15:4:0.5
15:6:2:15:2:4
15:6:2:15:2:2
15:6:2:15:2:1
15:6:2:15:2:0.5
15:6:2:15:1:4
15:6:2:15:1:2
15:6:2:15:1:1
15:6:2:15:1:0.5
15:6:2:15:0.5:4
15:6:2:15:0.5:2
15:6:2:15:0.5:1
15:6:2:15:0.5:0.5
15:6:2:5:6:4
15:6:2:5:6:2
15:6:2:5:6:1
15:6:2:5:6:0.5
15:6:2:5:4:4
15:6:2:5:4:2
15:6:2:5:4:1
15:6:2:5:4:0.5
15:6:2:5:2:4
15:6:2:5:2:2
15:6:2:5:2:1
15:6:2:5:2:0.5
15:6:2:5:1:4
15:6:2:5:1:2
15:6:2:5:1:1
15:6:2:5:1:0.5
15:6:2:5:0.5:4
15:6:2:5:0.5:2
15:6:2:5:0.5:1
15:6:2:5:0.5:0.5
15:6:1:25:6:4
15:6:1:25:6:2
15:6:1:25:6:1
15:6:1:25:6:0.5
15:6:1:25:4:4
15:6:1:25:4:2
15:6:1:25:4:1
15:6:1:25:4:0.5
15:6:1:25:2:4
15:6:1:25:2:2
15:6:1:25:2:1
15:6:1:25:2:0.5
15:6:1:25:1:4
15:6:1:25:1:2
15:6:1:25:1:1
15:6:1:25:1:0.5
15:6:1:25:0.5:4
15:6:1:25:0.5:2
15:6:1:25:0.5:1
15:6:1:25:0.5:0.5
15:6:1:15:6:4
15:6:1:15:6:2
15:6:1:15:6:1
15:6:1:15:6:0.5
15:6:1:15:4:4
15:6:1:15:4:2
15:6:1:15:4:1
15:6:1:15:4:0.5
15:6:1:15:2:4
15:6:1:15:2:2
15:6:1:15:2:1
15:6:1:15:2:0.5
15:6:1:15:1:4
15:6:1:15:1:2
15:6:1:15:1:1
15:6:1:15:1:0.5
15:6:1:15:0.5:4
15:6:1:15:0.5:2
15:6:1:15:0.5:1
15:6:1:15:0.5:0.5
15:6:1:5:6:4
15:6:1:5:6:2
15:6:1:5:6:1
15:6:1:5:6:0.5
15:6:1:5:4:4
15:6:1:5:4:2
15:6:1:5:4:1
15:6:1:5:4:0.5
15:6:1:5:2:4
15:6:1:5:2:2
15:6:1:5:2:1
15:6:1:5:2:0.5
15:6:1:5:1:4
15:6:1:5:1:2
15:6:1:5:1:1
15:6:1:5:1:0.5
15:6:1:5:0.5:4
15:6:1:5:0.5:2
15:6:1:5:0.5:1
15:6:1:5:0.5:0.5
15:6:0.5:25:6:4
15:6:0.5:25:6:2
15:6:0.5:25:6:1
15:6:0.5:25:6:0.5
15:6:0.5:25:4:4
15:6:0.5:25:4:2
15:6:0.5:25:4:1
15:6:0.5:25:4:0.5
15:6:0.5:25:2:4
15:6:0.5:25:2:2
15:6:0.5:25:2:1
15:6:0.5:25:2:0.5
15:6:0.5:25:1:4
15:6:0.5:25:1:2
15:6:0.5:25:1:1
15:6:0.5:25:1:0.5
15:6:0.5:25:0.5:4
15:6:0.5:25:0.5:2
15:6:0.5:25:0.5:1
15:6:0.5:25:0.5:0.5
15:6:0.5:15:6:4
15:6:0.5:15:6:2
15:6:0.5:15:6:1
15:6:0.5:15:6:0.5
15:6:0.5:15:4:4
15:6:0.5:15:4:2
15:6:0.5:15:4:1
15:6:0.5:15:4:0.5
15:6:0.5:15:2:4
15:6:0.5:15:2:2
15:6:0.5:15:2:1
15:6:0.5:15:2:0.5
15:6:0.5:15:1:4
15:6:0.5:15:1:2
15:6:0.5:15:1:1
15:6:0.5:15:1:0.5
15:6:0.5:15:0.5:4
15:6:0.5:15:0.5:2
15:6:0.5:15:0.5:1
15:6:0.5:15:0.5:0.5
15:6:0.5:5:6:4
15:6:0.5:5:6:2
15:6:0.5:5:6:1
15:6:0.5:5:6:0.5
15:6:0.5:5:4:4
15:6:0.5:5:4:2
15:6:0.5:5:4:1
15:6:0.5:5:4:0.5
15:6:0.5:5:2:4
15:6:0.5:5:2:2
15:6:0.5:5:2:1
15:6:0.5:5:2:0.5
15:6:0.5:5:1:4
15:6:0.5:5:1:2
15:6:0.5:5:1:1
15:6:0.5:5:1:0.5
15:6:0.5:5:0.5:4
15:6:0.5:5:0.5:2
15:6:0.5:5:0.5:1
15:6:0.5:5:0.5:0.5
15:4:4:25:6:4
15:4:4:25:6:2
15:4:4:25:6:1
15:4:4:25:6:0.5
15:4:4:25:4:4
15:4:4:25:4:2
15:4:4:25:4:1
15:4:4:25:4:0.5
15:4:4:25:2:4
15:4:4:25:2:2
15:4:4:25:2:1
15:4:4:25:2:0.5
15:4:4:25:1:4
15:4:4:25:1:2
15:4:4:25:1:1
15:4:4:25:1:0.5
15:4:4:25:0.5:4
15:4:4:25:0.5:2
15:4:4:25:0.5:1
15:4:4:25:0.5:0.5
15:4:4:15:6:4
15:4:4:15:6:2
15:4:4:15:6:1
15:4:4:15:6:0.5
15:4:4:15:4:4
15:4:4:15:4:2
15:4:4:15:4:1
15:4:4:15:4:0.5
15:4:4:15:2:4
15:4:4:15:2:2
15:4:4:15:2:1
15:4:4:15:2:0.5
15:4:4:15:1:4
15:4:4:15:1:2
15:4:4:15:1:1
15:4:4:15:1:0.5
15:4:4:15:0.5:4
15:4:4:15:0.5:2
15:4:4:15:0.5:1
15:4:4:15:0.5:0.5
15:4:4:5:6:4
15:4:4:5:6:2
15:4:4:5:6:1
15:4:4:5:6:0.5
15:4:4:5:4:4
15:4:4:5:4:2
15:4:4:5:4:1
15:4:4:5:4:0.5
15:4:4:5:2:4
15:4:4:5:2:2
15:4:4:5:2:1
15:4:4:5:2:0.5
15:4:4:5:1:4
15:4:4:5:1:2
15:4:4:5:1:1
15:4:4:5:1:0.5
15:4:4:5:0.5:4
15:4:4:5:0.5:2
15:4:4:5:0.5:1
15:4:4:5:0.5:0.5
15:4:2:25:6:4
15:4:2:25:6:2
15:4:2:25:6:1
15:4:2:25:6:0.5
15:4:2:25:4:4
15:4:2:25:4:2
15:4:2:25:4:1
15:4:2:25:4:0.5
15:4:2:25:2:4
15:4:2:25:2:2
15:4:2:25:2:1
15:4:2:25:2:0.5
15:4:2:25:1:4
15:4:2:25:1:2
15:4:2:25:1:1
15:4:2:25:1:0.5
15:4:2:25:0.5:4
15:4:2:25:0.5:2
15:4:2:25:0.5:1
15:4:2:25:0.5:0.5
15:4:2:15:6:4
15:4:2:15:6:2
15:4:2:15:6:1
15:4:2:15:6:0.5
15:4:2:15:4:4
15:4:2:15:4:2
15:4:2:15:4:1
15:4:2:15:4:0.5
15:4:2:15:2:4
15:4:2:15:2:2
15:4:2:15:2:1
15:4:2:15:2:0.5
15:4:2:15:1:4
15:4:2:15:1:2
15:4:2:15:1:1
15:4:2:15:1:0.5
15:4:2:15:0.5:4
15:4:2:15:0.5:2
15:4:2:15:0.5:1
15:4:2:15:0.5:0.5
15:4:2:5:6:4
15:4:2:5:6:2
15:4:2:5:6:1
15:4:2:5:6:0.5
15:4:2:5:4:4
15:4:2:5:4:2
15:4:2:5:4:1
15:4:2:5:4:0.5
15:4:2:5:2:4
15:4:2:5:2:2
15:4:2:5:2:1
15:4:2:5:2:0.5
15:4:2:5:1:4
15:4:2:5:1:2
15:4:2:5:1:1
15:4:2:5:1:0.5
15:4:2:5:0.5:4
15:4:2:5:0.5:2
15:4:2:5:0.5:1
15:4:2:5:0.5:0.5
15:4:1:25:6:4
15:4:1:25:6:2
15:4:1:25:6:1
15:4:1:25:6:0.5
15:4:1:25:4:4
15:4:1:25:4:2
15:4:1:25:4:1
15:4:1:25:4:0.5
15:4:1:25:2:4
15:4:1:25:2:2
15:4:1:25:2:1
15:4:1:25:2:0.5
15:4:1:25:1:4
15:4:1:25:1:2
15:4:1:25:1:1
15:4:1:25:1:0.5
15:4:1:25:0.5:4
15:4:1:25:0.5:2
15:4:1:25:0.5:1
15:4:1:25:0.5:0.5
15:4:1:15:6:4
15:4:1:15:6:2
15:4:1:15:6:1
15:4:1:15:6:0.5
15:4:1:15:4:4
15:4:1:15:4:2
15:4:1:15:4:1
15:4:1:15:4:0.5
15:4:1:15:2:4
15:4:1:15:2:2
15:4:1:15:2:1
15:4:1:15:2:0.5
15:4:1:15:1:4
15:4:1:15:1:2
15:4:1:15:1:1
15:4:1:15:1:0.5
15:4:1:15:0.5:4
15:4:1:15:0.5:2
15:4:1:15:0.5:1
15:4:1:15:0.5:0.5
15:4:1:5:6:4
15:4:1:5:6:2
15:4:1:5:6:1
15:4:1:5:6:0.5
15:4:1:5:4:4
15:4:1:5:4:2
15:4:1:5:4:1
15:4:1:5:4:0.5
15:4:1:5:2:4
15:4:1:5:2:2
15:4:1:5:2:1
15:4:1:5:2:0.5
15:4:1:5:1:4
15:4:1:5:1:2
15:4:1:5:1:1
15:4:1:5:1:0.5
15:4:1:5:0.5:4
15:4:1:5:0.5:2
15:4:1:5:0.5:1
15:4:1:5:0.5:0.5
15:4:0.5:25:6:4
15:4:0.5:25:6:2
15:4:0.5:25:6:1
15:4:0.5:25:6:0.5
15:4:0.5:25:4:4
15:4:0.5:25:4:2
15:4:0.5:25:4:1
15:4:0.5:25:4:0.5
15:4:0.5:25:2:4
15:4:0.5:25:2:2
15:4:0.5:25:2:1
15:4:0.5:25:2:0.5
15:4:0.5:25:1:4
15:4:0.5:25:1:2
15:4:0.5:25:1:1
15:4:0.5:25:1:0.5
15:4:0.5:25:0.5:4
15:4:0.5:25:0.5:2
15:4:0.5:25:0.5:1
15:4:0.5:25:0.5:0.5
15:4:0.5:15:6:4
15:4:0.5:15:6:2
15:4:0.5:15:6:1
15:4:0.5:15:6:0.5
15:4:0.5:15:4:4
15:4:0.5:15:4:2
15:4:0.5:15:4:1
15:4:0.5:15:4:0.5
15:4:0.5:15:2:4
15:4:0.5:15:2:2
15:4:0.5:15:2:1
15:4:0.5:15:2:0.5
15:4:0.5:15:1:4
15:4:0.5:15:1:2
15:4:0.5:15:1:1
15:4:0.5:15:1:0.5
15:4:0.5:15:0.5:4
15:4:0.5:15:0.5:2
15:4:0.5:15:0.5:1
15:4:0.5:15:0.5:0.5
15:4:0.5:5:6:4
15:4:0.5:5:6:2
15:4:0.5:5:6:1
15:4:0.5:5:6:0.5
15:4:0.5:5:4:4
15:4:0.5:5:4:2
15:4:0.5:5:4:1
15:4:0.5:5:4:0.5
15:4:0.5:5:2:4
15:4:0.5:5:2:2
15:4:0.5:5:2:1
15:4:0.5:5:2:0.5
15:4:0.5:5:1:4
15:4:0.5:5:1:2
15:4:0.5:5:1:1
15:4:0.5:5:1:0.5
15:4:0.5:5:0.5:4
15:4:0.5:5:0.5:2
15:4:0.5:5:0.5:1
15:4:0.5:5:0.5:0.5
15:2:4:25:6:4
15:2:4:25:6:2
15:2:4:25:6:1
15:2:4:25:6:0.5
15:2:4:25:4:4
15:2:4:25:4:2
15:2:4:25:4:1
15:2:4:25:4:0.5
15:2:4:25:2:4
15:2:4:25:2:2
15:2:4:25:2:1
15:2:4:25:2:0.5
15:2:4:25:1:4
15:2:4:25:1:2
15:2:4:25:1:1
15:2:4:25:1:0.5
15:2:4:25:0.5:4
15:2:4:25:0.5:2
15:2:4:25:0.5:1
15:2:4:25:0.5:0.5
15:2:4:15:6:4
15:2:4:15:6:2
15:2:4:15:6:1
15:2:4:15:6:0.5
15:2:4:15:4:4
15:2:4:15:4:2
15:2:4:15:4:1
15:2:4:15:4:0.5
15:2:4:15:2:4
15:2:4:15:2:2
15:2:4:15:2:1
15:2:4:15:2:0.5
15:2:4:15:1:4
15:2:4:15:1:2
15:2:4:15:1:1
15:2:4:15:1:0.5
15:2:4:15:0.5:4
15:2:4:15:0.5:2
15:2:4:15:0.5:1
15:2:4:15:0.5:0.5
15:2:4:5:6:4
15:2:4:5:6:2
15:2:4:5:6:1
15:2:4:5:6:0.5
15:2:4:5:4:4
15:2:4:5:4:2
15:2:4:5:4:1
15:2:4:5:4:0.5
15:2:4:5:2:4
15:2:4:5:2:2
15:2:4:5:2:1
15:2:4:5:2:0.5
15:2:4:5:1:4
15:2:4:5:1:2
15:2:4:5:1:1
15:2:4:5:1:0.5
15:2:4:5:0.5:4
15:2:4:5:0.5:2
15:2:4:5:0.5:1
15:2:4:5:0.5:0.5
15:2:2:25:6:4
15:2:2:25:6:2
15:2:2:25:6:1
15:2:2:25:6:0.5
15:2:2:25:4:4
15:2:2:25:4:2
15:2:2:25:4:1
15:2:2:25:4:0.5
15:2:2:25:2:4
15:2:2:25:2:2
15:2:2:25:2:1
15:2:2:25:2:0.5
15:2:2:25:1:4
15:2:2:25:1:2
15:2:2:25:1:1
15:2:2:25:1:0.5
15:2:2:25:0.5:4
15:2:2:25:0.5:2
15:2:2:25:0.5:1
15:2:2:25:0.5:0.5
15:2:2:15:6:4
15:2:2:15:6:2
15:2:2:15:6:1
15:2:2:15:6:0.5
15:2:2:15:4:4
15:2:2:15:4:2
15:2:2:15:4:1
15:2:2:15:4:0.5
15:2:2:15:2:4
15:2:2:15:2:2
15:2:2:15:2:1
15:2:2:15:2:0.5
15:2:2:15:1:4
15:2:2:15:1:2
15:2:2:15:1:1
15:2:2:15:1:0.5
15:2:2:15:0.5:4
15:2:2:15:0.5:2
15:2:2:15:0.5:1
15:2:2:15:0.5:0.5
15:2:2:5:6:4
15:2:2:5:6:2
15:2:2:5:6:1
15:2:2:5:6:0.5
15:2:2:5:4:4
15:2:2:5:4:2
15:2:2:5:4:1
15:2:2:5:4:0.5
15:2:2:5:2:4
15:2:2:5:2:2
15:2:2:5:2:1
15:2:2:5:2:0.5
15:2:2:5:1:4
15:2:2:5:1:2
15:2:2:5:1:1
15:2:2:5:1:0.5
15:2:2:5:0.5:4
15:2:2:5:0.5:2
15:2:2:5:0.5:1
15:2:2:5:0.5:0.5
15:2:1:25:6:4
15:2:1:25:6:2
15:2:1:25:6:1
15:2:1:25:6:0.5
15:2:1:25:4:4
15:2:1:25:4:2
15:2:1:25:4:1
15:2:1:25:4:0.5
15:2:1:25:2:4
15:2:1:25:2:2
15:2:1:25:2:1
15:2:1:25:2:0.5
15:2:1:25:1:4
15:2:1:25:1:2
15:2:1:25:1:1
15:2:1:25:1:0.5
15:2:1:25:0.5:4
15:2:1:25:0.5:2
15:2:1:25:0.5:1
15:2:1:25:0.5:0.5
15:2:1:15:6:4
15:2:1:15:6:2
15:2:1:15:6:1
15:2:1:15:6:0.5
15:2:1:15:4:4
15:2:1:15:4:2
15:2:1:15:4:1
15:2:1:15:4:0.5
15:2:1:15:2:4
15:2:1:15:2:2
15:2:1:15:2:1
15:2:1:15:2:0.5
15:2:1:15:1:4
15:2:1:15:1:2
15:2:1:15:1:1
15:2:1:15:1:0.5
15:2:1:15:0.5:4
15:2:1:15:0.5:2
15:2:1:15:0.5:1
15:2:1:15:0.5:0.5
15:2:1:5:6:4
15:2:1:5:6:2
15:2:1:5:6:1
15:2:1:5:6:0.5
15:2:1:5:4:4
15:2:1:5:4:2
15:2:1:5:4:1
15:2:1:5:4:0.5
15:2:1:5:2:4
15:2:1:5:2:2
15:2:1:5:2:1
15:2:1:5:2:0.5
15:2:1:5:1:4
15:2:1:5:1:2
15:2:1:5:1:1
15:2:1:5:1:0.5
15:2:1:5:0.5:4
15:2:1:5:0.5:2
15:2:1:5:0.5:1
15:2:1:5:0.5:0.5
15:2:0.5:25:6:4
15:2:0.5:25:6:2
15:2:0.5:25:6:1
15:2:0.5:25:6:0.5
15:2:0.5:25:4:4
15:2:0.5:25:4:2
15:2:0.5:25:4:1
15:2:0.5:25:4:0.5
15:2:0.5:25:2:4
15:2:0.5:25:2:2
15:2:0.5:25:2:1
15:2:0.5:25:2:0.5
15:2:0.5:25:1:4
15:2:0.5:25:1:2
15:2:0.5:25:1:1
15:2:0.5:25:1:0.5
15:2:0.5:25:0.5:4
15:2:0.5:25:0.5:2
15:2:0.5:25:0.5:1
15:2:0.5:25:0.5:0.5
15:2:0.5:15:6:4
15:2:0.5:15:6:2
15:2:0.5:15:6:1
15:2:0.5:15:6:0.5
15:2:0.5:15:4:4
15:2:0.5:15:4:2
15:2:0.5:15:4:1
15:2:0.5:15:4:0.5
15:2:0.5:15:2:4
15:2:0.5:15:2:2
15:2:0.5:15:2:1
15:2:0.5:15:2:0.5
15:2:0.5:15:1:4
15:2:0.5:15:1:2
15:2:0.5:15:1:1
15:2:0.5:15:1:0.5
15:2:0.5:15:0.5:4
15:2:0.5:15:0.5:2
15:2:0.5:15:0.5:1
15:2:0.5:15:0.5:0.5
15:2:0.5:5:6:4
15:2:0.5:5:6:2
15:2:0.5:5:6:1
15:2:0.5:5:6:0.5
15:2:0.5:5:4:4
15:2:0.5:5:4:2
15:2:0.5:5:4:1
15:2:0.5:5:4:0.5
15:2:0.5:5:2:4
15:2:0.5:5:2:2
15:2:0.5:5:2:1
15:2:0.5:5:2:0.5
15:2:0.5:5:1:4
15:2:0.5:5:1:2
15:2:0.5:5:1:1
15:2:0.5:5:1:0.5
15:2:0.5:5:0.5:4
15:2:0.5:5:0.5:2
15:2:0.5:5:0.5:1
15:2:0.5:5:0.5:0.5
15:1:4:25:6:4
15:1:4:25:6:2
15:1:4:25:6:1
15:1:4:25:6:0.5
15:1:4:25:4:4
15:1:4:25:4:2
15:1:4:25:4:1
15:1:4:25:4:0.5
15:1:4:25:2:4
15:1:4:25:2:2
15:1:4:25:2:1
15:1:4:25:2:0.5
15:1:4:25:1:4
15:1:4:25:1:2
15:1:4:25:1:1
15:1:4:25:1:0.5
15:1:4:25:0.5:4
15:1:4:25:0.5:2
15:1:4:25:0.5:1
15:1:4:25:0.5:0.5
15:1:4:15:6:4
15:1:4:15:6:2
15:1:4:15:6:1
15:1:4:15:6:0.5
15:1:4:15:4:4
15:1:4:15:4:2
15:1:4:15:4:1
15:1:4:15:4:0.5
15:1:4:15:2:4
15:1:4:15:2:2
15:1:4:15:2:1
15:1:4:15:2:0.5
15:1:4:15:1:4
15:1:4:15:1:2
15:1:4:15:1:1
15:1:4:15:1:0.5
15:1:4:15:0.5:4
15:1:4:15:0.5:2
15:1:4:15:0.5:1
15:1:4:15:0.5:0.5
15:1:4:5:6:4
15:1:4:5:6:2
15:1:4:5:6:1
15:1:4:5:6:0.5
15:1:4:5:4:4
15:1:4:5:4:2
15:1:4:5:4:1
15:1:4:5:4:0.5
15:1:4:5:2:4
15:1:4:5:2:2
15:1:4:5:2:1
15:1:4:5:2:0.5
15:1:4:5:1:4
15:1:4:5:1:2
15:1:4:5:1:1
15:1:4:5:1:0.5
15:1:4:5:0.5:4
15:1:4:5:0.5:2
15:1:4:5:0.5:1
15:1:4:5:0.5:0.5
15:1:2:25:6:4
15:1:2:25:6:2
15:1:2:25:6:1
15:1:2:25:6:0.5
15:1:2:25:4:4
15:1:2:25:4:2
15:1:2:25:4:1
15:1:2:25:4:0.5
15:1:2:25:2:4
15:1:2:25:2:2
15:1:2:25:2:1
15:1:2:25:2:0.5
15:1:2:25:1:4
15:1:2:25:1:2
15:1:2:25:1:1
15:1:2:25:1:0.5
15:1:2:25:0.5:4
15:1:2:25:0.5:2
15:1:2:25:0.5:1
15:1:2:25:0.5:0.5
15:1:2:15:6:4
15:1:2:15:6:2
15:1:2:15:6:1
15:1:2:15:6:0.5
15:1:2:15:4:4
15:1:2:15:4:2
15:1:2:15:4:1
15:1:2:15:4:0.5
15:1:2:15:2:4
15:1:2:15:2:2
15:1:2:15:2:1
15:1:2:15:2:0.5
15:1:2:15:1:4
15:1:2:15:1:2
15:1:2:15:1:1
15:1:2:15:1:0.5
15:1:2:15:0.5:4
15:1:2:15:0.5:2
15:1:2:15:0.5:1
15:1:2:15:0.5:0.5
15:1:2:5:6:4
15:1:2:5:6:2
15:1:2:5:6:1
15:1:2:5:6:0.5
15:1:2:5:4:4
15:1:2:5:4:2
15:1:2:5:4:1
15:1:2:5:4:0.5
15:1:2:5:2:4
15:1:2:5:2:2
15:1:2:5:2:1
15:1:2:5:2:0.5
15:1:2:5:1:4
15:1:2:5:1:2
15:1:2:5:1:1
15:1:2:5:1:0.5
15:1:2:5:0.5:4
15:1:2:5:0.5:2
15:1:2:5:0.5:1
15:1:2:5:0.5:0.5
15:1:1:25:6:4
15:1:1:25:6:2
15:1:1:25:6:1
15:1:1:25:6:0.5
15:1:1:25:4:4
15:1:1:25:4:2
15:1:1:25:4:1
15:1:1:25:4:0.5
15:1:1:25:2:4
15:1:1:25:2:2
15:1:1:25:2:1
15:1:1:25:2:0.5
15:1:1:25:1:4
15:1:1:25:1:2
15:1:1:25:1:1
15:1:1:25:1:0.5
15:1:1:25:0.5:4
15:1:1:25:0.5:2
15:1:1:25:0.5:1
15:1:1:25:0.5:0.5
15:1:1:15:6:4
15:1:1:15:6:2
15:1:1:15:6:1
15:1:1:15:6:0.5
15:1:1:15:4:4
15:1:1:15:4:2
15:1:1:15:4:1
15:1:1:15:4:0.5
15:1:1:15:2:4
15:1:1:15:2:2
15:1:1:15:2:1
15:1:1:15:2:0.5
15:1:1:15:1:4
15:1:1:15:1:2
15:1:1:15:1:1
15:1:1:15:1:0.5
15:1:1:15:0.5:4
15:1:1:15:0.5:2
15:1:1:15:0.5:1
15:1:1:15:0.5:0.5
15:1:1:5:6:4
15:1:1:5:6:2
15:1:1:5:6:1
15:1:1:5:6:0.5
15:1:1:5:4:4
15:1:1:5:4:2
15:1:1:5:4:1
15:1:1:5:4:0.5
15:1:1:5:2:4
15:1:1:5:2:2
15:1:1:5:2:1
15:1:1:5:2:0.5
15:1:1:5:1:4
15:1:1:5:1:2
15:1:1:5:1:1
15:1:1:5:1:0.5
15:1:1:5:0.5:4
15:1:1:5:0.5:2
15:1:1:5:0.5:1
15:1:1:5:0.5:0.5
15:1:0.5:25:6:4
15:1:0.5:25:6:2
15:1:0.5:25:6:1
15:1:0.5:25:6:0.5
15:1:0.5:25:4:4
15:1:0.5:25:4:2
15:1:0.5:25:4:1
15:1:0.5:25:4:0.5
15:1:0.5:25:2:4
15:1:0.5:25:2:2
15:1:0.5:25:2:1
15:1:0.5:25:2:0.5
15:1:0.5:25:1:4
15:1:0.5:25:1:2
15:1:0.5:25:1:1
15:1:0.5:25:1:0.5
15:1:0.5:25:0.5:4
15:1:0.5:25:0.5:2
15:1:0.5:25:0.5:1
15:1:0.5:25:0.5:0.5
15:1:0.5:15:6:4
15:1:0.5:15:6:2
15:1:0.5:15:6:1
15:1:0.5:15:6:0.5
15:1:0.5:15:4:4
15:1:0.5:15:4:2
15:1:0.5:15:4:1
15:1:0.5:15:4:0.5
15:1:0.5:15:2:4
15:1:0.5:15:2:2
15:1:0.5:15:2:1
15:1:0.5:15:2:0.5
15:1:0.5:15:1:4
15:1:0.5:15:1:2
15:1:0.5:15:1:1
15:1:0.5:15:1:0.5
15:1:0.5:15:0.5:4
15:1:0.5:15:0.5:2
15:1:0.5:15:0.5:1
15:1:0.5:15:0.5:0.5
15:1:0.5:5:6:4
15:1:0.5:5:6:2
15:1:0.5:5:6:1
15:1:0.5:5:6:0.5
15:1:0.5:5:4:4
15:1:0.5:5:4:2
15:1:0.5:5:4:1
15:1:0.5:5:4:0.5
15:1:0.5:5:2:4
15:1:0.5:5:2:2
15:1:0.5:5:2:1
15:1:0.5:5:2:0.5
15:1:0.5:5:1:4
15:1:0.5:5:1:2
15:1:0.5:5:1:1
15:1:0.5:5:1:0.5
15:1:0.5:5:0.5:4
15:1:0.5:5:0.5:2
15:1:0.5:5:0.5:1
15:1:0.5:5:0.5:0.5
15:0.5:4:25:6:4
15:0.5:4:25:6:2
15:0.5:4:25:6:1
15:0.5:4:25:6:0.5
15:0.5:4:25:4:4
15:0.5:4:25:4:2
15:0.5:4:25:4:1
15:0.5:4:25:4:0.5
15:0.5:4:25:2:4
15:0.5:4:25:2:2
15:0.5:4:25:2:1
15:0.5:4:25:2:0.5
15:0.5:4:25:1:4
15:0.5:4:25:1:2
15:0.5:4:25:1:1
15:0.5:4:25:1:0.5
15:0.5:4:25:0.5:4
15:0.5:4:25:0.5:2
15:0.5:4:25:0.5:1
15:0.5:4:25:0.5:0.5
15:0.5:4:15:6:4
15:0.5:4:15:6:2
15:0.5:4:15:6:1
15:0.5:4:15:6:0.5
15:0.5:4:15:4:4
15:0.5:4:15:4:2
15:0.5:4:15:4:1
15:0.5:4:15:4:0.5
15:0.5:4:15:2:4
15:0.5:4:15:2:2
15:0.5:4:15:2:1
15:0.5:4:15:2:0.5
15:0.5:4:15:1:4
15:0.5:4:15:1:2
15:0.5:4:15:1:1
15:0.5:4:15:1:0.5
15:0.5:4:15:0.5:4
15:0.5:4:15:0.5:2
15:0.5:4:15:0.5:1
15:0.5:4:15:0.5:0.5
15:0.5:4:5:6:4
15:0.5:4:5:6:2
15:0.5:4:5:6:1
15:0.5:4:5:6:0.5
15:0.5:4:5:4:4
15:0.5:4:5:4:2
15:0.5:4:5:4:1
15:0.5:4:5:4:0.5
15:0.5:4:5:2:4
15:0.5:4:5:2:2
15:0.5:4:5:2:1
15:0.5:4:5:2:0.5
15:0.5:4:5:1:4
15:0.5:4:5:1:2
15:0.5:4:5:1:1
15:0.5:4:5:1:0.5
15:0.5:4:5:0.5:4
15:0.5:4:5:0.5:2
15:0.5:4:5:0.5:1
15:0.5:4:5:0.5:0.5
15:0.5:2:25:6:4
15:0.5:2:25:6:2
15:0.5:2:25:6:1
15:0.5:2:25:6:0.5
15:0.5:2:25:4:4
15:0.5:2:25:4:2
15:0.5:2:25:4:1
15:0.5:2:25:4:0.5
15:0.5:2:25:2:4
15:0.5:2:25:2:2
15:0.5:2:25:2:1
15:0.5:2:25:2:0.5
15:0.5:2:25:1:4
15:0.5:2:25:1:2
15:0.5:2:25:1:1
15:0.5:2:25:1:0.5
15:0.5:2:25:0.5:4
15:0.5:2:25:0.5:2
15:0.5:2:25:0.5:1
15:0.5:2:25:0.5:0.5
15:0.5:2:15:6:4
15:0.5:2:15:6:2
15:0.5:2:15:6:1
15:0.5:2:15:6:0.5
15:0.5:2:15:4:4
15:0.5:2:15:4:2
15:0.5:2:15:4:1
15:0.5:2:15:4:0.5
15:0.5:2:15:2:4
15:0.5:2:15:2:2
15:0.5:2:15:2:1
15:0.5:2:15:2:0.5
15:0.5:2:15:1:4
15:0.5:2:15:1:2
15:0.5:2:15:1:1
15:0.5:2:15:1:0.5
15:0.5:2:15:0.5:4
15:0.5:2:15:0.5:2
15:0.5:2:15:0.5:1
15:0.5:2:15:0.5:0.5
15:0.5:2:5:6:4
15:0.5:2:5:6:2
15:0.5:2:5:6:1
15:0.5:2:5:6:0.5
15:0.5:2:5:4:4
15:0.5:2:5:4:2
15:0.5:2:5:4:1
15:0.5:2:5:4:0.5
15:0.5:2:5:2:4
15:0.5:2:5:2:2
15:0.5:2:5:2:1
15:0.5:2:5:2:0.5
15:0.5:2:5:1:4
15:0.5:2:5:1:2
15:0.5:2:5:1:1
15:0.5:2:5:1:0.5
15:0.5:2:5:0.5:4
15:0.5:2:5:0.5:2
15:0.5:2:5:0.5:1
15:0.5:2:5:0.5:0.5
15:0.5:1:25:6:4
15:0.5:1:25:6:2
15:0.5:1:25:6:1
15:0.5:1:25:6:0.5
15:0.5:1:25:4:4
15:0.5:1:25:4:2
15:0.5:1:25:4:1
15:0.5:1:25:4:0.5
15:0.5:1:25:2:4
15:0.5:1:25:2:2
15:0.5:1:25:2:1
15:0.5:1:25:2:0.5
15:0.5:1:25:1:4
15:0.5:1:25:1:2
15:0.5:1:25:1:1
15:0.5:1:25:1:0.5
15:0.5:1:25:0.5:4
15:0.5:1:25:0.5:2
15:0.5:1:25:0.5:1
15:0.5:1:25:0.5:0.5
15:0.5:1:15:6:4
15:0.5:1:15:6:2
15:0.5:1:15:6:1
15:0.5:1:15:6:0.5
15:0.5:1:15:4:4
15:0.5:1:15:4:2
15:0.5:1:15:4:1
15:0.5:1:15:4:0.5
15:0.5:1:15:2:4
15:0.5:1:15:2:2
15:0.5:1:15:2:1
15:0.5:1:15:2:0.5
15:0.5:1:15:1:4
15:0.5:1:15:1:2
15:0.5:1:15:1:1
15:0.5:1:15:1:0.5
15:0.5:1:15:0.5:4
15:0.5:1:15:0.5:2
15:0.5:1:15:0.5:1
15:0.5:1:15:0.5:0.5
15:0.5:1:5:6:4
15:0.5:1:5:6:2
15:0.5:1:5:6:1
15:0.5:1:5:6:0.5
15:0.5:1:5:4:4
15:0.5:1:5:4:2
15:0.5:1:5:4:1
15:0.5:1:5:4:0.5
15:0.5:1:5:2:4
15:0.5:1:5:2:2
15:0.5:1:5:2:1
15:0.5:1:5:2:0.5
15:0.5:1:5:1:4
15:0.5:1:5:1:2
15:0.5:1:5:1:1
15:0.5:1:5:1:0.5
15:0.5:1:5:0.5:4
15:0.5:1:5:0.5:2
15:0.5:1:5:0.5:1
15:0.5:1:5:0.5:0.5
15:0.5:0.5:25:6:4
15:0.5:0.5:25:6:2
15:0.5:0.5:25:6:1
15:0.5:0.5:25:6:0.5
15:0.5:0.5:25:4:4
15:0.5:0.5:25:4:2
15:0.5:0.5:25:4:1
15:0.5:0.5:25:4:0.5
15:0.5:0.5:25:2:4
15:0.5:0.5:25:2:2
15:0.5:0.5:25:2:1
15:0.5:0.5:25:2:0.5
15:0.5:0.5:25:1:4
15:0.5:0.5:25:1:2
15:0.5:0.5:25:1:1
15:0.5:0.5:25:1:0.5
15:0.5:0.5:25:0.5:4
15:0.5:0.5:25:0.5:2
15:0.5:0.5:25:0.5:1
15:0.5:0.5:25:0.5:0.5
15:0.5:0.5:15:6:4
15:0.5:0.5:15:6:2
15:0.5:0.5:15:6:1
15:0.5:0.5:15:6:0.5
15:0.5:0.5:15:4:4
15:0.5:0.5:15:4:2
15:0.5:0.5:15:4:1
15:0.5:0.5:15:4:0.5
15:0.5:0.5:15:2:4
15:0.5:0.5:15:2:2
15:0.5:0.5:15:2:1
15:0.5:0.5:15:2:0.5
15:0.5:0.5:15:1:4
15:0.5:0.5:15:1:2
15:0.5:0.5:15:1:1
15:0.5:0.5:15:1:0.5
15:0.5:0.5:15:0.5:4
15:0.5:0.5:15:0.5:2
15:0.5:0.5:15:0.5:1
15:0.5:0.5:15:0.5:0.5
15:0.5:0.5:5:6:4
15:0.5:0.5:5:6:2
15:0.5:0.5:5:6:1
15:0.5:0.5:5:6:0.5
15:0.5:0.5:5:4:4
15:0.5:0.5:5:4:2
15:0.5:0.5:5:4:1
15:0.5:0.5:5:4:0.5
15:0.5:0.5:5:2:4
15:0.5:0.5:5:2:2
15:0.5:0.5:5:2:1
15:0.5:0.5:5:2:0.5
15:0.5:0.5:5:1:4
15:0.5:0.5:5:1:2
15:0.5:0.5:5:1:1
15:0.5:0.5:5:1:0.5
15:0.5:0.5:5:0.5:4
15:0.5:0.5:5:0.5:2
15:0.5:0.5:5:0.5:1
15:0.5:0.5:5:0.5:0.5
10:6:4:25:6:4
10:6:4:25:6:2
10:6:4:25:6:1
10:6:4:25:6:0.5
10:6:4:25:4:4
10:6:4:25:4:2
10:6:4:25:4:1
10:6:4:25:4:0.5
10:6:4:25:2:4
10:6:4:25:2:2
10:6:4:25:2:1
10:6:4:25:2:0.5
10:6:4:25:1:4
10:6:4:25:1:2
10:6:4:25:1:1
10:6:4:25:1:0.5
10:6:4:25:0.5:4
10:6:4:25:0.5:2
10:6:4:25:0.5:1
10:6:4:25:0.5:0.5
10:6:4:15:6:4
10:6:4:15:6:2
10:6:4:15:6:1
10:6:4:15:6:0.5
10:6:4:15:4:4
10:6:4:15:4:2
10:6:4:15:4:1
10:6:4:15:4:0.5
10:6:4:15:2:4
10:6:4:15:2:2
10:6:4:15:2:1
10:6:4:15:2:0.5
10:6:4:15:1:4
10:6:4:15:1:2
10:6:4:15:1:1
10:6:4:15:1:0.5
10:6:4:15:0.5:4
10:6:4:15:0.5:2
10:6:4:15:0.5:1
10:6:4:15:0.5:0.5
10:6:4:5:6:4
10:6:4:5:6:2
10:6:4:5:6:1
10:6:4:5:6:0.5
10:6:4:5:4:4
10:6:4:5:4:2
10:6:4:5:4:1
10:6:4:5:4:0.5
10:6:4:5:2:4
10:6:4:5:2:2
10:6:4:5:2:1
10:6:4:5:2:0.5
10:6:4:5:1:4
10:6:4:5:1:2
10:6:4:5:1:1
10:6:4:5:1:0.5
10:6:4:5:0.5:4
10:6:4:5:0.5:2
10:6:4:5:0.5:1
10:6:4:5:0.5:0.5
10:6:2:25:6:4
10:6:2:25:6:2
10:6:2:25:6:1
10:6:2:25:6:0.5
10:6:2:25:4:4
10:6:2:25:4:2
10:6:2:25:4:1
10:6:2:25:4:0.5
10:6:2:25:2:4
10:6:2:25:2:2
10:6:2:25:2:1
10:6:2:25:2:0.5
10:6:2:25:1:4
10:6:2:25:1:2
10:6:2:25:1:1
10:6:2:25:1:0.5
10:6:2:25:0.5:4
10:6:2:25:0.5:2
10:6:2:25:0.5:1
10:6:2:25:0.5:0.5
10:6:2:15:6:4
10:6:2:15:6:2
10:6:2:15:6:1
10:6:2:15:6:0.5
10:6:2:15:4:4
10:6:2:15:4:2
10:6:2:15:4:1
10:6:2:15:4:0.5
10:6:2:15:2:4
10:6:2:15:2:2
10:6:2:15:2:1
10:6:2:15:2:0.5
10:6:2:15:1:4
10:6:2:15:1:2
10:6:2:15:1:1
10:6:2:15:1:0.5
10:6:2:15:0.5:4
10:6:2:15:0.5:2
10:6:2:15:0.5:1
10:6:2:15:0.5:0.5
10:6:2:5:6:4
10:6:2:5:6:2
10:6:2:5:6:1
10:6:2:5:6:0.5
10:6:2:5:4:4
10:6:2:5:4:2
10:6:2:5:4:1
10:6:2:5:4:0.5
10:6:2:5:2:4
10:6:2:5:2:2
10:6:2:5:2:1
10:6:2:5:2:0.5
10:6:2:5:1:4
10:6:2:5:1:2
10:6:2:5:1:1
10:6:2:5:1:0.5
10:6:2:5:0.5:4
10:6:2:5:0.5:2
10:6:2:5:0.5:1
10:6:2:5:0.5:0.5
10:6:1:25:6:4
10:6:1:25:6:2
10:6:1:25:6:1
10:6:1:25:6:0.5
10:6:1:25:4:4
10:6:1:25:4:2
10:6:1:25:4:1
10:6:1:25:4:0.5
10:6:1:25:2:4
10:6:1:25:2:2
10:6:1:25:2:1
10:6:1:25:2:0.5
10:6:1:25:1:4
10:6:1:25:1:2
10:6:1:25:1:1
10:6:1:25:1:0.5
10:6:1:25:0.5:4
10:6:1:25:0.5:2
10:6:1:25:0.5:1
10:6:1:25:0.5:0.5
10:6:1:15:6:4
10:6:1:15:6:2
10:6:1:15:6:1
10:6:1:15:6:0.5
10:6:1:15:4:4
10:6:1:15:4:2
10:6:1:15:4:1
10:6:1:15:4:0.5
10:6:1:15:2:4
10:6:1:15:2:2
10:6:1:15:2:1
10:6:1:15:2:0.5
10:6:1:15:1:4
10:6:1:15:1:2
10:6:1:15:1:1
10:6:1:15:1:0.5
10:6:1:15:0.5:4
10:6:1:15:0.5:2
10:6:1:15:0.5:1
10:6:1:15:0.5:0.5
10:6:1:5:6:4
10:6:1:5:6:2
10:6:1:5:6:1
10:6:1:5:6:0.5
10:6:1:5:4:4
10:6:1:5:4:2
10:6:1:5:4:1
10:6:1:5:4:0.5
10:6:1:5:2:4
10:6:1:5:2:2
10:6:1:5:2:1
10:6:1:5:2:0.5
10:6:1:5:1:4
10:6:1:5:1:2
10:6:1:5:1:1
10:6:1:5:1:0.5
10:6:1:5:0.5:4
10:6:1:5:0.5:2
10:6:1:5:0.5:1
10:6:1:5:0.5:0.5
10:6:0.5:25:6:4
10:6:0.5:25:6:2
10:6:0.5:25:6:1
10:6:0.5:25:6:0.5
10:6:0.5:25:4:4
10:6:0.5:25:4:2
10:6:0.5:25:4:1
10:6:0.5:25:4:0.5
10:6:0.5:25:2:4
10:6:0.5:25:2:2
10:6:0.5:25:2:1
10:6:0.5:25:2:0.5
10:6:0.5:25:1:4
10:6:0.5:25:1:2
10:6:0.5:25:1:1
10:6:0.5:25:1:0.5
10:6:0.5:25:0.5:4
10:6:0.5:25:0.5:2
10:6:0.5:25:0.5:1
10:6:0.5:25:0.5:0.5
10:6:0.5:15:6:4
10:6:0.5:15:6:2
10:6:0.5:15:6:1
10:6:0.5:15:6:0.5
10:6:0.5:15:4:4
10:6:0.5:15:4:2
10:6:0.5:15:4:1
10:6:0.5:15:4:0.5
10:6:0.5:15:2:4
10:6:0.5:15:2:2
10:6:0.5:15:2:1
10:6:0.5:15:2:0.5
10:6:0.5:15:1:4
10:6:0.5:15:1:2
10:6:0.5:15:1:1
10:6:0.5:15:1:0.5
10:6:0.5:15:0.5:4
10:6:0.5:15:0.5:2
10:6:0.5:15:0.5:1
10:6:0.5:15:0.5:0.5
10:6:0.5:5:6:4
10:6:0.5:5:6:2
10:6:0.5:5:6:1
10:6:0.5:5:6:0.5
10:6:0.5:5:4:4
10:6:0.5:5:4:2
10:6:0.5:5:4:1
10:6:0.5:5:4:0.5
10:6:0.5:5:2:4
10:6:0.5:5:2:2
10:6:0.5:5:2:1
10:6:0.5:5:2:0.5
10:6:0.5:5:1:4
10:6:0.5:5:1:2
10:6:0.5:5:1:1
10:6:0.5:5:1:0.5
10:6:0.5:5:0.5:4
10:6:0.5:5:0.5:2
10:6:0.5:5:0.5:1
10:6:0.5:5:0.5:0.5
10:4:4:25:6:4
10:4:4:25:6:2
10:4:4:25:6:1
10:4:4:25:6:0.5
10:4:4:25:4:4
10:4:4:25:4:2
10:4:4:25:4:1
10:4:4:25:4:0.5
10:4:4:25:2:4
10:4:4:25:2:2
10:4:4:25:2:1
10:4:4:25:2:0.5
10:4:4:25:1:4
10:4:4:25:1:2
10:4:4:25:1:1
10:4:4:25:1:0.5
10:4:4:25:0.5:4
10:4:4:25:0.5:2
10:4:4:25:0.5:1
10:4:4:25:0.5:0.5
10:4:4:15:6:4
10:4:4:15:6:2
10:4:4:15:6:1
10:4:4:15:6:0.5
10:4:4:15:4:4
10:4:4:15:4:2
10:4:4:15:4:1
10:4:4:15:4:0.5
10:4:4:15:2:4
10:4:4:15:2:2
10:4:4:15:2:1
10:4:4:15:2:0.5
10:4:4:15:1:4
10:4:4:15:1:2
10:4:4:15:1:1
10:4:4:15:1:0.5
10:4:4:15:0.5:4
10:4:4:15:0.5:2
10:4:4:15:0.5:1
10:4:4:15:0.5:0.5
10:4:4:5:6:4
10:4:4:5:6:2
10:4:4:5:6:1
10:4:4:5:6:0.5
10:4:4:5:4:4
10:4:4:5:4:2
10:4:4:5:4:1
10:4:4:5:4:0.5
10:4:4:5:2:4
10:4:4:5:2:2
10:4:4:5:2:1
10:4:4:5:2:0.5
10:4:4:5:1:4
10:4:4:5:1:2
10:4:4:5:1:1
10:4:4:5:1:0.5
10:4:4:5:0.5:4
10:4:4:5:0.5:2
10:4:4:5:0.5:1
10:4:4:5:0.5:0.5
10:4:2:25:6:4
10:4:2:25:6:2
10:4:2:25:6:1
10:4:2:25:6:0.5
10:4:2:25:4:4
10:4:2:25:4:2
10:4:2:25:4:1
10:4:2:25:4:0.5
10:4:2:25:2:4
10:4:2:25:2:2
10:4:2:25:2:1
10:4:2:25:2:0.5
10:4:2:25:1:4
10:4:2:25:1:2
10:4:2:25:1:1
10:4:2:25:1:0.5
10:4:2:25:0.5:4
10:4:2:25:0.5:2
10:4:2:25:0.5:1
10:4:2:25:0.5:0.5
10:4:2:15:6:4
10:4:2:15:6:2
10:4:2:15:6:1
10:4:2:15:6:0.5
10:4:2:15:4:4
10:4:2:15:4:2
10:4:2:15:4:1
10:4:2:15:4:0.5
10:4:2:15:2:4
10:4:2:15:2:2
10:4:2:15:2:1
10:4:2:15:2:0.5
10:4:2:15:1:4
10:4:2:15:1:2
10:4:2:15:1:1
10:4:2:15:1:0.5
10:4:2:15:0.5:4
10:4:2:15:0.5:2
10:4:2:15:0.5:1
10:4:2:15:0.5:0.5
10:4:2:5:6:4
10:4:2:5:6:2
10:4:2:5:6:1
10:4:2:5:6:0.5
10:4:2:5:4:4
10:4:2:5:4:2
10:4:2:5:4:1
10:4:2:5:4:0.5
10:4:2:5:2:4
10:4:2:5:2:2
10:4:2:5:2:1
10:4:2:5:2:0.5
10:4:2:5:1:4
10:4:2:5:1:2
10:4:2:5:1:1
10:4:2:5:1:0.5
10:4:2:5:0.5:4
10:4:2:5:0.5:2
10:4:2:5:0.5:1
10:4:2:5:0.5:0.5
10:4:1:25:6:4
10:4:1:25:6:2
10:4:1:25:6:1
10:4:1:25:6:0.5
10:4:1:25:4:4
10:4:1:25:4:2
10:4:1:25:4:1
10:4:1:25:4:0.5
10:4:1:25:2:4
10:4:1:25:2:2
10:4:1:25:2:1
10:4:1:25:2:0.5
10:4:1:25:1:4
10:4:1:25:1:2
10:4:1:25:1:1
10:4:1:25:1:0.5
10:4:1:25:0.5:4
10:4:1:25:0.5:2
10:4:1:25:0.5:1
10:4:1:25:0.5:0.5
10:4:1:15:6:4
10:4:1:15:6:2
10:4:1:15:6:1
10:4:1:15:6:0.5
10:4:1:15:4:4
10:4:1:15:4:2
10:4:1:15:4:1
10:4:1:15:4:0.5
10:4:1:15:2:4
10:4:1:15:2:2
10:4:1:15:2:1
10:4:1:15:2:0.5
10:4:1:15:1:4
10:4:1:15:1:2
10:4:1:15:1:1
10:4:1:15:1:0.5
10:4:1:15:0.5:4
10:4:1:15:0.5:2
10:4:1:15:0.5:1
10:4:1:15:0.5:0.5
10:4:1:5:6:4
10:4:1:5:6:2
10:4:1:5:6:1
10:4:1:5:6:0.5
10:4:1:5:4:4
10:4:1:5:4:2
10:4:1:5:4:1
10:4:1:5:4:0.5
10:4:1:5:2:4
10:4:1:5:2:2
10:4:1:5:2:1
10:4:1:5:2:0.5
10:4:1:5:1:4
10:4:1:5:1:2
10:4:1:5:1:1
10:4:1:5:1:0.5
10:4:1:5:0.5:4
10:4:1:5:0.5:2
10:4:1:5:0.5:1
10:4:1:5:0.5:0.5
10:4:0.5:25:6:4
10:4:0.5:25:6:2
10:4:0.5:25:6:1
10:4:0.5:25:6:0.5
10:4:0.5:25:4:4
10:4:0.5:25:4:2
10:4:0.5:25:4:1
10:4:0.5:25:4:0.5
10:4:0.5:25:2:4
10:4:0.5:25:2:2
10:4:0.5:25:2:1
10:4:0.5:25:2:0.5
10:4:0.5:25:1:4
10:4:0.5:25:1:2
10:4:0.5:25:1:1
10:4:0.5:25:1:0.5
10:4:0.5:25:0.5:4
10:4:0.5:25:0.5:2
10:4:0.5:25:0.5:1
10:4:0.5:25:0.5:0.5
10:4:0.5:15:6:4
10:4:0.5:15:6:2
10:4:0.5:15:6:1
10:4:0.5:15:6:0.5
10:4:0.5:15:4:4
10:4:0.5:15:4:2
10:4:0.5:15:4:1
10:4:0.5:15:4:0.5
10:4:0.5:15:2:4
10:4:0.5:15:2:2
10:4:0.5:15:2:1
10:4:0.5:15:2:0.5
10:4:0.5:15:1:4
10:4:0.5:15:1:2
10:4:0.5:15:1:1
10:4:0.5:15:1:0.5
10:4:0.5:15:0.5:4
10:4:0.5:15:0.5:2
10:4:0.5:15:0.5:1
10:4:0.5:15:0.5:0.5
10:4:0.5:5:6:4
10:4:0.5:5:6:2
10:4:0.5:5:6:1
10:4:0.5:5:6:0.5
10:4:0.5:5:4:4
10:4:0.5:5:4:2
10:4:0.5:5:4:1
10:4:0.5:5:4:0.5
10:4:0.5:5:2:4
10:4:0.5:5:2:2
10:4:0.5:5:2:1
10:4:0.5:5:2:0.5
10:4:0.5:5:1:4
10:4:0.5:5:1:2
10:4:0.5:5:1:1
10:4:0.5:5:1:0.5
10:4:0.5:5:0.5:4
10:4:0.5:5:0.5:2
10:4:0.5:5:0.5:1
10:4:0.5:5:0.5:0.5
10:2:4:25:6:4
10:2:4:25:6:2
10:2:4:25:6:1
10:2:4:25:6:0.5
10:2:4:25:4:4
10:2:4:25:4:2
10:2:4:25:4:1
10:2:4:25:4:0.5
10:2:4:25:2:4
10:2:4:25:2:2
10:2:4:25:2:1
10:2:4:25:2:0.5
10:2:4:25:1:4
10:2:4:25:1:2
10:2:4:25:1:1
10:2:4:25:1:0.5
10:2:4:25:0.5:4
10:2:4:25:0.5:2
10:2:4:25:0.5:1
10:2:4:25:0.5:0.5
10:2:4:15:6:4
10:2:4:15:6:2
10:2:4:15:6:1
10:2:4:15:6:0.5
10:2:4:15:4:4
10:2:4:15:4:2
10:2:4:15:4:1
10:2:4:15:4:0.5
10:2:4:15:2:4
10:2:4:15:2:2
10:2:4:15:2:1
10:2:4:15:2:0.5
10:2:4:15:1:4
10:2:4:15:1:2
10:2:4:15:1:1
10:2:4:15:1:0.5
10:2:4:15:0.5:4
10:2:4:15:0.5:2
10:2:4:15:0.5:1
10:2:4:15:0.5:0.5
10:2:4:5:6:4
10:2:4:5:6:2
10:2:4:5:6:1
10:2:4:5:6:0.5
10:2:4:5:4:4
10:2:4:5:4:2
10:2:4:5:4:1
10:2:4:5:4:0.5
10:2:4:5:2:4
10:2:4:5:2:2
10:2:4:5:2:1
10:2:4:5:2:0.5
10:2:4:5:1:4
10:2:4:5:1:2
10:2:4:5:1:1
10:2:4:5:1:0.5
10:2:4:5:0.5:4
10:2:4:5:0.5:2
10:2:4:5:0.5:1
10:2:4:5:0.5:0.5
10:2:2:25:6:4
10:2:2:25:6:2
10:2:2:25:6:1
10:2:2:25:6:0.5
10:2:2:25:4:4
10:2:2:25:4:2
10:2:2:25:4:1
10:2:2:25:4:0.5
10:2:2:25:2:4
10:2:2:25:2:2
10:2:2:25:2:1
10:2:2:25:2:0.5
10:2:2:25:1:4
10:2:2:25:1:2
10:2:2:25:1:1
10:2:2:25:1:0.5
10:2:2:25:0.5:4
10:2:2:25:0.5:2
10:2:2:25:0.5:1
10:2:2:25:0.5:0.5
10:2:2:15:6:4
10:2:2:15:6:2
10:2:2:15:6:1
10:2:2:15:6:0.5
10:2:2:15:4:4
10:2:2:15:4:2
10:2:2:15:4:1
10:2:2:15:4:0.5
10:2:2:15:2:4
10:2:2:15:2:2
10:2:2:15:2:1
10:2:2:15:2:0.5
10:2:2:15:1:4
10:2:2:15:1:2
10:2:2:15:1:1
10:2:2:15:1:0.5
10:2:2:15:0.5:4
10:2:2:15:0.5:2
10:2:2:15:0.5:1
10:2:2:15:0.5:0.5
10:2:2:5:6:4
10:2:2:5:6:2
10:2:2:5:6:1
10:2:2:5:6:0.5
10:2:2:5:4:4
10:2:2:5:4:2
10:2:2:5:4:1
10:2:2:5:4:0.5
10:2:2:5:2:4
10:2:2:5:2:2
10:2:2:5:2:1
10:2:2:5:2:0.5
10:2:2:5:1:4
10:2:2:5:1:2
10:2:2:5:1:1
10:2:2:5:1:0.5
10:2:2:5:0.5:4
10:2:2:5:0.5:2
10:2:2:5:0.5:1
10:2:2:5:0.5:0.5
10:2:1:25:6:4
10:2:1:25:6:2
10:2:1:25:6:1
10:2:1:25:6:0.5
10:2:1:25:4:4
10:2:1:25:4:2
10:2:1:25:4:1
10:2:1:25:4:0.5
10:2:1:25:2:4
10:2:1:25:2:2
10:2:1:25:2:1
10:2:1:25:2:0.5
10:2:1:25:1:4
10:2:1:25:1:2
10:2:1:25:1:1
10:2:1:25:1:0.5
10:2:1:25:0.5:4
10:2:1:25:0.5:2
10:2:1:25:0.5:1
10:2:1:25:0.5:0.5
10:2:1:15:6:4
10:2:1:15:6:2
10:2:1:15:6:1
10:2:1:15:6:0.5
10:2:1:15:4:4
10:2:1:15:4:2
10:2:1:15:4:1
10:2:1:15:4:0.5
10:2:1:15:2:4
10:2:1:15:2:2
10:2:1:15:2:1
10:2:1:15:2:0.5
10:2:1:15:1:4
10:2:1:15:1:2
10:2:1:15:1:1
10:2:1:15:1:0.5
10:2:1:15:0.5:4
10:2:1:15:0.5:2
10:2:1:15:0.5:1
10:2:1:15:0.5:0.5
10:2:1:5:6:4
10:2:1:5:6:2
10:2:1:5:6:1
10:2:1:5:6:0.5
10:2:1:5:4:4
10:2:1:5:4:2
10:2:1:5:4:1
10:2:1:5:4:0.5
10:2:1:5:2:4
10:2:1:5:2:2
10:2:1:5:2:1
10:2:1:5:2:0.5
10:2:1:5:1:4
10:2:1:5:1:2
10:2:1:5:1:1
10:2:1:5:1:0.5
10:2:1:5:0.5:4
10:2:1:5:0.5:2
10:2:1:5:0.5:1
10:2:1:5:0.5:0.5
10:2:0.5:25:6:4
10:2:0.5:25:6:2
10:2:0.5:25:6:1
10:2:0.5:25:6:0.5
10:2:0.5:25:4:4
10:2:0.5:25:4:2
10:2:0.5:25:4:1
10:2:0.5:25:4:0.5
10:2:0.5:25:2:4
10:2:0.5:25:2:2
10:2:0.5:25:2:1
10:2:0.5:25:2:0.5
10:2:0.5:25:1:4
10:2:0.5:25:1:2
10:2:0.5:25:1:1
10:2:0.5:25:1:0.5
10:2:0.5:25:0.5:4
10:2:0.5:25:0.5:2
10:2:0.5:25:0.5:1
10:2:0.5:25:0.5:0.5
10:2:0.5:15:6:4
10:2:0.5:15:6:2
10:2:0.5:15:6:1
10:2:0.5:15:6:0.5
10:2:0.5:15:4:4
10:2:0.5:15:4:2
10:2:0.5:15:4:1
10:2:0.5:15:4:0.5
10:2:0.5:15:2:4
10:2:0.5:15:2:2
10:2:0.5:15:2:1
10:2:0.5:15:2:0.5
10:2:0.5:15:1:4
10:2:0.5:15:1:2
10:2:0.5:15:1:1
10:2:0.5:15:1:0.5
10:2:0.5:15:0.5:4
10:2:0.5:15:0.5:2
10:2:0.5:15:0.5:1
10:2:0.5:15:0.5:0.5
10:2:0.5:5:6:4
10:2:0.5:5:6:2
10:2:0.5:5:6:1
10:2:0.5:5:6:0.5
10:2:0.5:5:4:4
10:2:0.5:5:4:2
10:2:0.5:5:4:1
10:2:0.5:5:4:0.5
10:2:0.5:5:2:4
10:2:0.5:5:2:2
10:2:0.5:5:2:1
10:2:0.5:5:2:0.5
10:2:0.5:5:1:4
10:2:0.5:5:1:2
10:2:0.5:5:1:1
10:2:0.5:5:1:0.5
10:2:0.5:5:0.5:4
10:2:0.5:5:0.5:2
10:2:0.5:5:0.5:1
10:2:0.5:5:0.5:0.5
10:1:4:25:6:4
10:1:4:25:6:2
10:1:4:25:6:1
10:1:4:25:6:0.5
10:1:4:25:4:4
10:1:4:25:4:2
10:1:4:25:4:1
10:1:4:25:4:0.5
10:1:4:25:2:4
10:1:4:25:2:2
10:1:4:25:2:1
10:1:4:25:2:0.5
10:1:4:25:1:4
10:1:4:25:1:2
10:1:4:25:1:1
10:1:4:25:1:0.5
10:1:4:25:0.5:4
10:1:4:25:0.5:2
10:1:4:25:0.5:1
10:1:4:25:0.5:0.5
10:1:4:15:6:4
10:1:4:15:6:2
10:1:4:15:6:1
10:1:4:15:6:0.5
10:1:4:15:4:4
10:1:4:15:4:2
10:1:4:15:4:1
10:1:4:15:4:0.5
10:1:4:15:2:4
10:1:4:15:2:2
10:1:4:15:2:1
10:1:4:15:2:0.5
10:1:4:15:1:4
10:1:4:15:1:2
10:1:4:15:1:1
10:1:4:15:1:0.5
10:1:4:15:0.5:4
10:1:4:15:0.5:2
10:1:4:15:0.5:1
10:1:4:15:0.5:0.5
10:1:4:5:6:4
10:1:4:5:6:2
10:1:4:5:6:1
10:1:4:5:6:0.5
10:1:4:5:4:4
10:1:4:5:4:2
10:1:4:5:4:1
10:1:4:5:4:0.5
10:1:4:5:2:4
10:1:4:5:2:2
10:1:4:5:2:1
10:1:4:5:2:0.5
10:1:4:5:1:4
10:1:4:5:1:2
10:1:4:5:1:1
10:1:4:5:1:0.5
10:1:4:5:0.5:4
10:1:4:5:0.5:2
10:1:4:5:0.5:1
10:1:4:5:0.5:0.5
10:1:2:25:6:4
10:1:2:25:6:2
10:1:2:25:6:1
10:1:2:25:6:0.5
10:1:2:25:4:4
10:1:2:25:4:2
10:1:2:25:4:1
10:1:2:25:4:0.5
10:1:2:25:2:4
10:1:2:25:2:2
10:1:2:25:2:1
10:1:2:25:2:0.5
10:1:2:25:1:4
10:1:2:25:1:2
10:1:2:25:1:1
10:1:2:25:1:0.5
10:1:2:25:0.5:4
10:1:2:25:0.5:2
10:1:2:25:0.5:1
10:1:2:25:0.5:0.5
10:1:2:15:6:4
10:1:2:15:6:2
10:1:2:15:6:1
10:1:2:15:6:0.5
10:1:2:15:4:4
10:1:2:15:4:2
10:1:2:15:4:1
10:1:2:15:4:0.5
10:1:2:15:2:4
10:1:2:15:2:2
10:1:2:15:2:1
10:1:2:15:2:0.5
10:1:2:15:1:4
10:1:2:15:1:2
10:1:2:15:1:1
10:1:2:15:1:0.5
10:1:2:15:0.5:4
10:1:2:15:0.5:2
10:1:2:15:0.5:1
10:1:2:15:0.5:0.5
10:1:2:5:6:4
10:1:2:5:6:2
10:1:2:5:6:1
10:1:2:5:6:0.5
10:1:2:5:4:4
10:1:2:5:4:2
10:1:2:5:4:1
10:1:2:5:4:0.5
10:1:2:5:2:4
10:1:2:5:2:2
10:1:2:5:2:1
10:1:2:5:2:0.5
10:1:2:5:1:4
10:1:2:5:1:2
10:1:2:5:1:1
10:1:2:5:1:0.5
10:1:2:5:0.5:4
10:1:2:5:0.5:2
10:1:2:5:0.5:1
10:1:2:5:0.5:0.5
10:1:1:25:6:4
10:1:1:25:6:2
10:1:1:25:6:1
10:1:1:25:6:0.5
10:1:1:25:4:4
10:1:1:25:4:2
10:1:1:25:4:1
10:1:1:25:4:0.5
10:1:1:25:2:4
10:1:1:25:2:2
10:1:1:25:2:1
10:1:1:25:2:0.5
10:1:1:25:1:4
10:1:1:25:1:2
10:1:1:25:1:1
10:1:1:25:1:0.5
10:1:1:25:0.5:4
10:1:1:25:0.5:2
10:1:1:25:0.5:1
10:1:1:25:0.5:0.5
10:1:1:15:6:4
10:1:1:15:6:2
10:1:1:15:6:1
10:1:1:15:6:0.5
10:1:1:15:4:4
10:1:1:15:4:2
10:1:1:15:4:1
10:1:1:15:4:0.5
10:1:1:15:2:4
10:1:1:15:2:2
10:1:1:15:2:1
10:1:1:15:2:0.5
10:1:1:15:1:4
10:1:1:15:1:2
10:1:1:15:1:1
10:1:1:15:1:0.5
10:1:1:15:0.5:4
10:1:1:15:0.5:2
10:1:1:15:0.5:1
10:1:1:15:0.5:0.5
10:1:1:5:6:4
10:1:1:5:6:2
10:1:1:5:6:1
10:1:1:5:6:0.5
10:1:1:5:4:4
10:1:1:5:4:2
10:1:1:5:4:1
10:1:1:5:4:0.5
10:1:1:5:2:4
10:1:1:5:2:2
10:1:1:5:2:1
10:1:1:5:2:0.5
10:1:1:5:1:4
10:1:1:5:1:2
10:1:1:5:1:1
10:1:1:5:1:0.5
10:1:1:5:0.5:4
10:1:1:5:0.5:2
10:1:1:5:0.5:1
10:1:1:5:0.5:0.5
10:1:0.5:25:6:4
10:1:0.5:25:6:2
10:1:0.5:25:6:1
10:1:0.5:25:6:0.5
10:1:0.5:25:4:4
10:1:0.5:25:4:2
10:1:0.5:25:4:1
10:1:0.5:25:4:0.5
10:1:0.5:25:2:4
10:1:0.5:25:2:2
10:1:0.5:25:2:1
10:1:0.5:25:2:0.5
10:1:0.5:25:1:4
10:1:0.5:25:1:2
10:1:0.5:25:1:1
10:1:0.5:25:1:0.5
10:1:0.5:25:0.5:4
10:1:0.5:25:0.5:2
10:1:0.5:25:0.5:1
10:1:0.5:25:0.5:0.5
10:1:0.5:15:6:4
10:1:0.5:15:6:2
10:1:0.5:15:6:1
10:1:0.5:15:6:0.5
10:1:0.5:15:4:4
10:1:0.5:15:4:2
10:1:0.5:15:4:1
10:1:0.5:15:4:0.5
10:1:0.5:15:2:4
10:1:0.5:15:2:2
10:1:0.5:15:2:1
10:1:0.5:15:2:0.5
10:1:0.5:15:1:4
10:1:0.5:15:1:2
10:1:0.5:15:1:1
10:1:0.5:15:1:0.5
10:1:0.5:15:0.5:4
10:1:0.5:15:0.5:2
10:1:0.5:15:0.5:1
10:1:0.5:15:0.5:0.5
10:1:0.5:5:6:4
10:1:0.5:5:6:2
10:1:0.5:5:6:1
10:1:0.5:5:6:0.5
10:1:0.5:5:4:4
10:1:0.5:5:4:2
10:1:0.5:5:4:1
10:1:0.5:5:4:0.5
10:1:0.5:5:2:4
10:1:0.5:5:2:2
10:1:0.5:5:2:1
10:1:0.5:5:2:0.5
10:1:0.5:5:1:4
10:1:0.5:5:1:2
10:1:0.5:5:1:1
10:1:0.5:5:1:0.5
10:1:0.5:5:0.5:4
10:1:0.5:5:0.5:2
10:1:0.5:5:0.5:1
10:1:0.5:5:0.5:0.5
10:0.5:4:25:6:4
10:0.5:4:25:6:2
10:0.5:4:25:6:1
10:0.5:4:25:6:0.5
10:0.5:4:25:4:4
10:0.5:4:25:4:2
10:0.5:4:25:4:1
10:0.5:4:25:4:0.5
10:0.5:4:25:2:4
10:0.5:4:25:2:2
10:0.5:4:25:2:1
10:0.5:4:25:2:0.5
10:0.5:4:25:1:4
10:0.5:4:25:1:2
10:0.5:4:25:1:1
10:0.5:4:25:1:0.5
10:0.5:4:25:0.5:4
10:0.5:4:25:0.5:2
10:0.5:4:25:0.5:1
10:0.5:4:25:0.5:0.5
10:0.5:4:15:6:4
10:0.5:4:15:6:2
10:0.5:4:15:6:1
10:0.5:4:15:6:0.5
10:0.5:4:15:4:4
10:0.5:4:15:4:2
10:0.5:4:15:4:1
10:0.5:4:15:4:0.5
10:0.5:4:15:2:4
10:0.5:4:15:2:2
10:0.5:4:15:2:1
10:0.5:4:15:2:0.5
10:0.5:4:15:1:4
10:0.5:4:15:1:2
10:0.5:4:15:1:1
10:0.5:4:15:1:0.5
10:0.5:4:15:0.5:4
10:0.5:4:15:0.5:2
10:0.5:4:15:0.5:1
10:0.5:4:15:0.5:0.5
10:0.5:4:5:6:4
10:0.5:4:5:6:2
10:0.5:4:5:6:1
10:0.5:4:5:6:0.5
10:0.5:4:5:4:4
10:0.5:4:5:4:2
10:0.5:4:5:4:1
10:0.5:4:5:4:0.5
10:0.5:4:5:2:4
10:0.5:4:5:2:2
10:0.5:4:5:2:1
10:0.5:4:5:2:0.5
10:0.5:4:5:1:4
10:0.5:4:5:1:2
10:0.5:4:5:1:1
10:0.5:4:5:1:0.5
10:0.5:4:5:0.5:4
10:0.5:4:5:0.5:2
10:0.5:4:5:0.5:1
10:0.5:4:5:0.5:0.5
10:0.5:2:25:6:4
10:0.5:2:25:6:2
10:0.5:2:25:6:1
10:0.5:2:25:6:0.5
10:0.5:2:25:4:4
10:0.5:2:25:4:2
10:0.5:2:25:4:1
10:0.5:2:25:4:0.5
10:0.5:2:25:2:4
10:0.5:2:25:2:2
10:0.5:2:25:2:1
10:0.5:2:25:2:0.5
10:0.5:2:25:1:4
10:0.5:2:25:1:2
10:0.5:2:25:1:1
10:0.5:2:25:1:0.5
10:0.5:2:25:0.5:4
10:0.5:2:25:0.5:2
10:0.5:2:25:0.5:1
10:0.5:2:25:0.5:0.5
10:0.5:2:15:6:4
10:0.5:2:15:6:2
10:0.5:2:15:6:1
10:0.5:2:15:6:0.5
10:0.5:2:15:4:4
10:0.5:2:15:4:2
10:0.5:2:15:4:1
10:0.5:2:15:4:0.5
10:0.5:2:15:2:4
10:0.5:2:15:2:2
10:0.5:2:15:2:1
10:0.5:2:15:2:0.5
10:0.5:2:15:1:4
10:0.5:2:15:1:2
10:0.5:2:15:1:1
10:0.5:2:15:1:0.5
10:0.5:2:15:0.5:4
10:0.5:2:15:0.5:2
10:0.5:2:15:0.5:1
10:0.5:2:15:0.5:0.5
10:0.5:2:5:6:4
10:0.5:2:5:6:2
10:0.5:2:5:6:1
10:0.5:2:5:6:0.5
10:0.5:2:5:4:4
10:0.5:2:5:4:2
10:0.5:2:5:4:1
10:0.5:2:5:4:0.5
10:0.5:2:5:2:4
10:0.5:2:5:2:2
10:0.5:2:5:2:1
10:0.5:2:5:2:0.5
10:0.5:2:5:1:4
10:0.5:2:5:1:2
10:0.5:2:5:1:1
10:0.5:2:5:1:0.5
10:0.5:2:5:0.5:4
10:0.5:2:5:0.5:2
10:0.5:2:5:0.5:1
10:0.5:2:5:0.5:0.5
10:0.5:1:25:6:4
10:0.5:1:25:6:2
10:0.5:1:25:6:1
10:0.5:1:25:6:0.5
10:0.5:1:25:4:4
10:0.5:1:25:4:2
10:0.5:1:25:4:1
10:0.5:1:25:4:0.5
10:0.5:1:25:2:4
10:0.5:1:25:2:2
10:0.5:1:25:2:1
10:0.5:1:25:2:0.5
10:0.5:1:25:1:4
10:0.5:1:25:1:2
10:0.5:1:25:1:1
10:0.5:1:25:1:0.5
10:0.5:1:25:0.5:4
10:0.5:1:25:0.5:2
10:0.5:1:25:0.5:1
10:0.5:1:25:0.5:0.5
10:0.5:1:15:6:4
10:0.5:1:15:6:2
10:0.5:1:15:6:1
10:0.5:1:15:6:0.5
10:0.5:1:15:4:4
10:0.5:1:15:4:2
10:0.5:1:15:4:1
10:0.5:1:15:4:0.5
10:0.5:1:15:2:4
10:0.5:1:15:2:2
10:0.5:1:15:2:1
10:0.5:1:15:2:0.5
10:0.5:1:15:1:4
10:0.5:1:15:1:2
10:0.5:1:15:1:1
10:0.5:1:15:1:0.5
10:0.5:1:15:0.5:4
10:0.5:1:15:0.5:2
10:0.5:1:15:0.5:1
10:0.5:1:15:0.5:0.5
10:0.5:1:5:6:4
10:0.5:1:5:6:2
10:0.5:1:5:6:1
10:0.5:1:5:6:0.5
10:0.5:1:5:4:4
10:0.5:1:5:4:2
10:0.5:1:5:4:1
10:0.5:1:5:4:0.5
10:0.5:1:5:2:4
10:0.5:1:5:2:2
10:0.5:1:5:2:1
10:0.5:1:5:2:0.5
10:0.5:1:5:1:4
10:0.5:1:5:1:2
10:0.5:1:5:1:1
10:0.5:1:5:1:0.5
10:0.5:1:5:0.5:4
10:0.5:1:5:0.5:2
10:0.5:1:5:0.5:1
10:0.5:1:5:0.5:0.5
10:0.5:0.5:25:6:4
10:0.5:0.5:25:6:2
10:0.5:0.5:25:6:1
10:0.5:0.5:25:6:0.5
10:0.5:0.5:25:4:4
10:0.5:0.5:25:4:2
10:0.5:0.5:25:4:1
10:0.5:0.5:25:4:0.5
10:0.5:0.5:25:2:4
10:0.5:0.5:25:2:2
10:0.5:0.5:25:2:1
10:0.5:0.5:25:2:0.5
10:0.5:0.5:25:1:4
10:0.5:0.5:25:1:2
10:0.5:0.5:25:1:1
10:0.5:0.5:25:1:0.5
10:0.5:0.5:25:0.5:4
10:0.5:0.5:25:0.5:2
10:0.5:0.5:25:0.5:1
10:0.5:0.5:25:0.5:0.5
10:0.5:0.5:15:6:4
10:0.5:0.5:15:6:2
10:0.5:0.5:15:6:1
10:0.5:0.5:15:6:0.5
10:0.5:0.5:15:4:4
10:0.5:0.5:15:4:2
10:0.5:0.5:15:4:1
10:0.5:0.5:15:4:0.5
10:0.5:0.5:15:2:4
10:0.5:0.5:15:2:2
10:0.5:0.5:15:2:1
10:0.5:0.5:15:2:0.5
10:0.5:0.5:15:1:4
10:0.5:0.5:15:1:2
10:0.5:0.5:15:1:1
10:0.5:0.5:15:1:0.5
10:0.5:0.5:15:0.5:4
10:0.5:0.5:15:0.5:2
10:0.5:0.5:15:0.5:1
10:0.5:0.5:15:0.5:0.5
10:0.5:0.5:5:6:4
10:0.5:0.5:5:6:2
10:0.5:0.5:5:6:1
10:0.5:0.5:5:6:0.5
10:0.5:0.5:5:4:4
10:0.5:0.5:5:4:2
10:0.5:0.5:5:4:1
10:0.5:0.5:5:4:0.5
10:0.5:0.5:5:2:4
10:0.5:0.5:5:2:2
10:0.5:0.5:5:2:1
10:0.5:0.5:5:2:0.5
10:0.5:0.5:5:1:4
10:0.5:0.5:5:1:2
10:0.5:0.5:5:1:1
10:0.5:0.5:5:1:0.5
10:0.5:0.5:5:0.5:4
10:0.5:0.5:5:0.5:2
10:0.5:0.5:5:0.5:1
10:0.5:0.5:5:0.5:0.5

In addition, the natural pyrethrin may contain solvents and stabilizers in the product form in which they are supplied, and the types thereof are not particularly limited, and synthetic stabilizers, natural stabilizers, and the like can be used.

Examples of combinations selected from the petroleum-based or vegetable-oil-based solvents, and stabilizers which may be contained in the aforementioned natural pyrethrin include [solvent+stabilizer]=[paraffinic solvent+dibutylhydroxytoluene] as well as the following combinations.
Paraffinic solvent+dibutylhydroxytoluene
Paraffinic solvent+butylated hydroxyanisole
Corn oil+tocopherols (α, β, γ, δ),
Corn Oil+Clove Extract
Corn Oil+Roman Chamomile Extract
Corn Oil+Rosemary Extract
Corn Oil+Lavender Extract
Corn oil+mint extract
Corn Oil+Spearmint Extract
Corn Oil+Sage Extract
Corn Oil+Fennel Extract
soybean oil+tocopherol (α, β, γ, δ),
Soybean Oil+Clove Extract
Soybean Oil+Roman Chamomile Extract
Soybean Oil+Rosemary Extract
Soybean Oil+Lavender Extract
Soybean Oil+Mint Extract
Soybean Oil+Spearmint Extract
Soybean Oil+Sage Extract
Soybean Oil+Fennel Extract

The stabilizer is usually added at an amount of 1-15% as opposed to the natural pyrethrin.

The natural pyrethrin can be mixed or used together with one or more components selected from the group consisting of the following group (a), group (b), group (c), group (d), group (e), group (f), group (g), group (h), group (i), group (j) and group (k) (hereinafter referred to as “present component”).

The aforementioned ‘mixed or used together’ means using the present compound and the present component at the same time, separately or with a time interval.

When the present compound and the present component are used at the same time, the present compound and the present component may be contained in separate formulations, respectively, or may be contained in one formulation.

One aspect of the present invention is a composition containing one or more components selected from the group consisting of group (a), group (b), group (c), group (d), group (e), group (f), group (g), group (h), group (i), group (j) and group (k), and the present compound (hereinafter referred to as “composition A”

Group (a) is the group consisting of acetylcholinesterase inhibitors (e.g. carbamate insecticides, organophosphate insecticides), GABA-gated chloride channel blockers (e.g. phenylpyrazole insecticides), sodium channel modulators (e.g. pyrethroid insecticides), nicotinic acetylcholine receptor competitive modulators (e.g., neonicotinoid insecticides), nicotinic acetylcholine receptor allosteric modulators, glutamate-gated chloride channel allosteric modulators (e.g. macrolide insecticides), juvenile Hormone mimics, multisite inhibitors, chordotonal organ TRPV channel modulators, mite growth inhibitors, mitochondrial ATP synthase inhibitors, oxidative phosphorylation uncouplers, nicotinic acetylcholine receptor channel blockers (e.g. Nereistoxin insecticides), chitin synthesis inhibitors, moulting disruptors, ecdysone receptor agonists, octopamine receptor agonists, inhibitors of mitochondrial electron transport chain complexes I, II, III and IV, voltage-dependent sodium channel blockers, acetyl-CoA carboxylase inhibitors, ryanodine receptor modulators (e.g. diamide insecticides), and chordotonal organ modulators, and other insecticidal, acaricidal and nematicidal active ingredients. They are described in the classification based on the IRAC mode of action.

Group (b) is the group consisting of nucleic acid synthesis inhibitors (e.g. phenylamide fungicides, acylamino acid fungicides), cell division and cytoskeletal inhibitors (e.g. MBC fungicides), respiratory inhibitors (e.g. Qol fungicides, Qil fungicides), amino acid synthesis and protein synthesis inhibitors (e.g. anilinopyridine fungicides), signal transduction inhibitors, lipid synthesis and membrane synthesis inhibitors, sterol biosynthesis inhibitors (e.g. DMI fungicides such as triazoles), cell wall synthesis inhibitors, melanin synthesis inhibitors, plant defense inducers, contact fungicides with multi-site inhibiting activity, microbial fungicides, and other fungicidal active ingredients. They are described in the classification based on FRAC mode of action.

Group (c) is a group of plant growth regulating ingredients.

Group (d) is a group of safeners.

Group (e) is a group of synergists.

Group (f) is the group of repellent ingredients consisting of bird repellents, insect repellents and animal repellents.

Group (g) is a group of molluscicidal ingredients.

Group (h) is a group of insect pheromones.

Group (i) is the group consisting of acetyl-CoA carboxylase (ACCase) inhibitors, acetolactate synthase (ALS) inhibitors, photosynthesis (photosystem II) inhibitors, photosystem I electron converters, protoporphyrinogen oxidase (PPO) inhibitors, phytoene desaturase system (PDS) inhibitors, 4-hydroxyphenylpyruvate dioxygenase (4-HPPD) inhibitors, carotenoid biosynthesis inhibitors, EPSP synthase inhibitors, glutamine synthetase inhibitors, dihydropteroate (DHP) synthase inhibitors, microtubule polymerization inhibitors, mitosis/microtubule formation inhibitors, very long chain fatty acid (VLCFA) inhibitors, cellulose synthesis inhibitors, uncoupling agents, lipid synthesis inhibitors, indoleacetic acid-like active agents, auxin transport inhibitors, and other herbicidal active ingredients. They are described in the classification based on HRAC mode of action.

Group (j) is the group of microbial materials (including proteins produced by microorganisms) having a pest control effect (e.g. insecticidal activity, acaricidal activity, nematicidal activity, fungicidal activity, herbicidal activity) or a plant growth regulating effect on rhizobium or mycorrhizal fungi.

Group (k) is a group of plant extracts and plant-derived ingredients.

Examples of combinations of the present component and the present compound are described below. For example, alanycarb+natural pyrethrin means a combination of alanycarb and natural pyrethrin.

In addition, all of the present components described below are known components and can be obtained from commercially available formulations or produced by known methods. In the case that the present component is a microorganism, it can be obtained from depository institutes of fungi as well. The numbers in parentheses represent CAS RN (registered trademark).

Combinations of the present component of the group (a) above and the present compound:
Abamectin+natural pyrethrin, acephate+natural pyrethrin, acequinocyl+natural pyrethrin, acetamiprid+natural pyrethrin, acetoprole+natural pyrethrin, acrinathrin+natural pyrethrin, acynonapyr+natural pyrethrin, afidopyropen+natural pyrethrin, afoxolaner+natural pyrethrin, alanycarb+natural pyrethrin, aldicarb+natural pyrethrin, allethrin+natural pyrethrin, alpha-cypermethrin+natural pyrethrin, alpha-endosulfan+natural pyrethrin, aluminum phosphide+natural pyrethrin, amitraz+natural pyrethrin, amidoflumet+natural pyrethrin, azamethiphos+natural pyrethrin, azinphos-ethyl+natural pyrethrin, azinphos-methyl+natural pyrethrin, azocyclotin+natural pyrethrin, bendiocarb+natural pyrethrin, benfluthrin+natural pyrethrin, benfuracarb+natural pyrethrin, bensultap+natural pyrethrin, benzoximate+natural pyrethrin, benzpyrimoxan+natural pyrethrin, beta-cyfluthrin+natural pyrethrin, beta-cypermethrin+natural pyrethrin, bifenazate+natural pyrethrin, bifenthrin+natural pyrethrin, bilobalide+natural pyrethrin, bioallethrin+natural pyrethrin, bioresmethrin+natural pyrethrin, bistrifluron+natural pyrethrin, borax+natural pyrethrin, boric acid+natural pyrethrin, broflanilide+natural pyrethrin, bromopropylate+natural pyrethrin, buprofezin+natural pyrethrin, butocarbboxim+natural pyrethrin, butoxycarboxim+natural pyrethrin, cadusafos+natural pyrethrin, calcium phosphide+natural pyrethrin, carbaryl+natural pyrethrin, carbofuran+natural pyrethrin, carbosulfan+natural pyrethrin, cartap hydrochloride+natural pyrethrin, cartap+natural pyrethrin, chinomethionat+natural pyrethrin, chlorantraniliprole+natural pyrethrin, chlordane+natural pyrethrin, chlorethoxyfos+natural pyrethrin, chlorfenapyr+natural pyrethrin, chlorfenvinphos+natural pyrethrin, chlorfluazuron+natural pyrethrin, chlormephos+natural pyrethrin, chloropicrin+natural pyrethrin, chlorpyrifos+natural pyrethrin, chlorpyrifos-methyl+natural pyrethrin, chromafenozide+natural pyrethrin, clofentezine+natural pyrethrin, clothianidin+natural pyrethrin, concanamycin A+natural pyrethrin, coumaphos+natural pyrethrin, cryolite+natural pyrethrin, cyanophos+natural pyrethrin, cyantraniliprole+natural pyrethrin, cyclaniliprole+natural pyrethrin, cyclobutrifluram+natural pyrethrin, cycloprothrin+natural pyrethrin, cycloxaprid+natural pyrethrin, cyenopyrafen+natural pyrethrin, cyetpyrafen+natural pyrethrin, cyflumetofen+natural pyrethrin, cyfluthrin+natural pyrethrin, cyhalodiamide+natural pyrethrin, cyhalothrin+natural pyrethrin, cyhexatin+natural pyrethrin, cypermethrin+natural pyrethrin, cyphenothrin+natural pyrethrin, cyproflanilide+natural pyrethrin, cyromazine+natural pyrethrin, dazomet+natural pyrethrin, deltamethrin+natural pyrethrin, demeton-S-methyl+natural pyrethrin, diafenthiuron+natural pyrethrin, diazinon+natural pyrethrin, dichlorvos+natural pyrethrin, dicloromezotiaz+natural pyrethrin, dicofol+natural pyrethrin, dicrotophos+natural pyrethrin, diflovidazin+natural pyrethrin, diflubenzuron+natural pyrethrin, dimefluthrin+natural pyrethrin, dimethoate+natural pyrethrin, dimethylvinphos+natural pyrethrin, dimpropyridaz+natural pyrethrin, dinotefuran+natural pyrethrin, disodium octaborate+natural pyrethrin, disulfoton+natural pyrethrin, DNOC (2-methyl-4,6-dinitrophenol)+natural pyrethrin, doramectin+natural pyrethrin, emamectin-benzoate+natural pyrethrin, empenthrin+natural pyrethrin, endosulfan+natural pyrethrin, EPN(O-ethyl O-(4-nitrophenyl) phenylphosphonothioate)+natural pyrethrin, epsilon-metofluthrin+natural pyrethrin, epsilon-momfluorothrin+natural pyrethrin, esfenvalerate+natural pyrethrin, ethiofencarb+natural pyrethrin, ethion+natural pyrethrin, ethiprole+natural pyrethrin, ethoprophos+natural pyrethrin, etofenprox+natural pyrethrin, etoxazole+natural pyrethrin, famphur+natural pyrethrin, fenamiphos+natural pyrethrin, fenazaquin+natural pyrethrin, fenbutatin oxide+natural pyrethrin, fenitrothion+natural pyrethrin, fenobucarb+natural pyrethrin, fenoxycarb+natural pyrethrin, fenpropathrin+natural pyrethrin, fenpyroximate+natural pyrethrin, fenthion+natural pyrethrin, fenvalerate+natural pyrethrin, fipronil+natural pyrethrin, flometoquin+natural pyrethrin, flonicamid+natural pyrethrin, fluacrypyrim+natural pyrethrin, fluazaindolizine+natural pyrethrin, fluazuron+natural pyrethrin, flubendiamide+natural pyrethrin, flucycloxuron+natural pyrethrin, flucythrinate+natural pyrethrin, fluensulfone+natural pyrethrin, flufenprox+natural pyrethrin, flufenoxuron+natural pyrethrin, flufiprole+natural pyrethrin, flumethrin+natural pyrethrin, flupentiofenox+natural pyrethrin, flupyradifurone+natural pyrethrin, flupyrimin+natural pyrethrin, fluralaner+natural pyrethrin, fluvalinate+natural pyrethrin, fluxametamide+natural pyrethrin, formetanate+natural pyrethrin, fosthiazate+natural pyrethrin, furamethrin+natural pyrethrin, furathiocarb+natural pyrethrin gamma-cyhalothrin+natural pyrethrin, GS-omega/kappa HXTX-Hvla peptide+natural pyrethrin, halfenprox+natural pyrethrin, halofenozide+natural pyrethrin, heptafluthrin+natural pyrethrin, heptenophos+natural pyrethrin, hexaflumuron+natural pyrethrin, hexythiazox+natural pyrethrin, hydramethylnon+natural pyrethrin, hydroprene+natural pyrethrin, imicyafos+natural pyrethrin, imidacloprid+natural pyrethrin, imidaclothiz+natural pyrethrin, imiprothrin+natural pyrethrin, indoxacarb+natural pyrethrin, isocycloseram+natural pyrethrin, isofenphos+natural pyrethrin, isoprocarb+natural pyrethrin, isopropyl-O-(methoxyaminothiophosphoryl) salicylate+natural pyrethrin, isoxathion+natural pyrethrin, ivermectin+natural pyrethrin, kadethrin+natural pyrethrin, kappa-tefluthrin+natural pyrethrin, kappa Bifenthrin+natural pyrethrin, kinoprene+natural pyrethrin, lambda-cyhalothrin+natural pyrethrin, lenoremycin+natural pyrethrin, lepimectin+natural pyrethrin, lime sulfur+natural pyrethrin, lotilaner+natural pyrethrin, lufenuron+natural pyrethrin, machine oil+natural pyrethrin, malathion+natural pyrethrin, mecarbam+natural pyrethrin, meperfluthrin+natural pyrethrin, metaflumizone+natural pyrethrin, metam+natural pyrethrin, methamidophos+natural pyrethrin, methidathion+natural pyrethrin, methiocarb+natural pyrethrin, methomyl+natural pyrethrin, methoprene+natural pyrethrin, methoxychlor+natural pyrethrin, methoxyfenozide+natural pyrethrin, methyl bromide+natural pyrethrin, metofluthrin+natural pyrethrin, metolcarb+natural pyrethrin, metoxadiazone+natural pyrethrin, mevinphos+natural pyrethrin, milbemectin+natural pyrethrin, milbemycin oxime+natural pyrethrin, momfluorothrin+natural pyrethrin, monocrotophos+natural pyrethrin, moxidectin+natural pyrethrin, naled+natural pyrethrin, nicofluprole+natural pyrethrin, nicotine+natural pyrethrin, nicotine-sulfate+natural pyrethrin, nitenpyram+natural pyrethrin, novaluron+natural pyrethrin, noviflumuron+natural pyrethrin, omethoate+natural pyrethrin, oxamyl+natural pyrethrin, oxazosulfyl+natural pyrethrin, oxydemeton-methyl+natural pyrethrin, parathion+natural pyrethrin, parathion-methyl+natural pyrethrin, permethrin+natural pyrethrin, phenothrin+natural pyrethrin, phenthoate+natural pyrethrin, phorate+natural pyrethrin, phosalone+natural pyrethrin, phosmet+natural pyrethrin, phosphamidon+natural pyrethrin, phosphine+natural pyrethrin, phoxim+natural pyrethrin, pirimicarb+natural pyrethrin, pirimiphos-methyl+natural pyrethrin, prallethrin+natural pyrethrin, profenofos+natural pyrethrin, profluthrin+natural pyrethrin, propargite+natural pyrethrin, propetamphos+natural pyrethrin, propoxur+natural pyrethrin, propylene glycol alginate+natural pyrethrin, prothiofos+natural pyrethrin, pyflubumide+natural pyrethrin, pymetrozine+natural pyrethrin, pyraclofos+natural pyrethrin, pyridaben+natural pyrethrin, pyridalyl+natural pyrethrin, pyridaphenthion+natural pyrethrin, pyrifluquinazone+natural pyrethrin, pyrimidifen+natural pyrethrin, pyriminostrobin+natural pyrethrin, pyriprole+natural pyrethrin, pyriproxyfen+natural pyrethrin, quinalphos+natural pyrethrin, resmethrin+natural pyrethrin, ryanodine+natural pyrethrin, sarolaner+natural pyrethrin, selamectin+natural pyrethrin, sigma-cypermethrin+natural pyrethrin, silafluofen+natural pyrethrin, sodium borate+natural pyrethrin, sodium metaborate+natural pyrethrin, spinetoram+natural pyrethrin, spinosad+natural pyrethrin, spirodiclofen+natural pyrethrin, spiromesifen+natural pyrethrin, spiropidion+natural pyrethrin, spirotetramat+natural pyrethrin, sulfluramid+natural pyrethrin, sulfotep+natural pyrethrin, sulfoxaflor+natural pyrethrin, sulfur+natural pyrethrin, sulfuryl fluoride+natural pyrethrin, tartar emetic+natural pyrethrin, tau-fluvalinate+natural pyrethrin, tebufenozide+natural pyrethrin, tebufenpyrad+natural pyrethrin, tebupirimfos+natural pyrethrin, teflubenzuron+natural pyrethrin, tefluthrin+natural pyrethrin, temephos+natural pyrethrin, terbufos+natural pyrethrin, tetrachlorantraniliprole+natural pyrethrin, tetrachlorvinphos+natural pyrethrin, tetradifon+natural pyrethrin, tetramethrin+natural pyrethrin, tetramethylfluthrin+natural pyrethrin, tetraniliprole+natural pyrethrin, theta-cypermethrin+natural pyrethrin, thiacloprid+natural pyrethrin, thiamethoxam+natural pyrethrin, thiocyclam+natural pyrethrin, thiodicarb+natural pyrethrin, thiofanox+natural pyrethrin, thiometon+natural pyrethrin, thiosultap-disodium+natural pyrethrin, thiosultap-monosodium+natural pyrethrin, tioxazafen+natural pyrethrin, tolfenpyrad+natural pyrethrin, tralomethrin+natural pyrethrin, transfluthrin+natural pyrethrin, triazamate+natural pyrethrin, triazophos+natural pyrethrin, trichlorfon+natural pyrethrin, triflumezopyrim+natural pyrethrin, triflumuron+natural pyrethrin, trimethacarb+natural pyrethrin, tyclopyrazoflor+natural pyrethrin, vamidothion+natural pyrethrin, XMC (3,5-dimethylphenyl N-methylcarbamate)+natural pyrethrin, xylylcarb+natural pyrethrin, zeta-cypermethrin+natural pyrethrin, zinc phosphide+natural pyrethrin, N-[3-chloro-1-(pyridin-3-yl)-1H-pyrazol-4-yl]-N-ethyl-3-(3,3,3-trifluoropropanesulfinyl)propanamide (1477923-37-7)+natural pyrethrin, 4-[5-(3,5-dichlorophenyl)-5-(trifluoromethyl)-4,5-dihydro-1,2-oxazol-3-yl]-2-methyl-N-(1-oxothietan-3-yl)benzamide (1241050-20-3)+natural pyrethrin, 3-methoxy-N-(5-{5-(trifluoromethyl)-5-[3-(trifluoromethyl)phenyl]-4,5-dihydro-1,2-oxazol-3-yl}indan-1-yl)propanamide (1118626-57-5)+natural pyrethrin, 2-({2-fluoro-4-methyl-5-[(2,2,2-trifluoroethyl)sulfinyl]phenyl}imino)-3-(2,2,2-trifluoroethyl)-1,3-thiazolidin-4-one (1445683-71-5)+natural pyrethrin, (3R)-3-(2-chlorothiazol-5-yl)-8-methyl-7-oxo-6-phenyl-2,3-dihydrothiazolo[3,2-a]pyrimidin-4-ium-5-olate (2249718-27-0)+natural pyrethrin, 2-chloro-N-cyclopropyl-5-{1-[2,6-dichloro-4-(1,1,1,2,3,3,3-heptafluoropropan-2-yl)phenyl]-1H-pyrazol-4-yl}-N-methylpyridine-3-carboxamide (1771741-86-6)+natural pyrethrin, N-{4-chloro-3-[(1-cyanocyclopropyl)carbamoyl]phenyl}-1-methyl-4-(methanesulfonyl)-3-(1,1,2,2,2-pentafluoroethyl)-1H-pyrazole-3-carboxamide (1400768-21-9)+natural pyrethrin, 11-(4-chloro-2,6-dimethylphenyl)-12-hydroxy-1,4-dioxa-9-azadispiro[4.2.4.2]tetradec-11-en-10-one (907187-07-9)+natural pyrethrin, 3-(4′-fluoro-2,4-dimethyl[1,1′-biphenyl]-3-yl)-4-hydroxy-8-oxa-1-azaspiro[4.5]dec-3-en-2-one (1031385-91-7)+natural pyrethrin, N-[3-chloro-1-(pyridin-3-yl)-1H-pyrazol-4-yl]-2-(methanesulfonyl)propanamide (2396747-83-2)+natural pyrethrin, 1,4-dimethyl-2-[2-(3-pyridinyl)-2H-indazol-5-yl]-1,2,4-triazolidine-3,5-dione (2171099-09-3)+natural pyrethrin, 2-isopropyl-5-[(3,4,4-trifluoro-3-buten-1-yl)sulfonyl]-1,3,4-thiadiazole (2058052-95-0)+natural pyrethrin, N-({2-fluoro-4-[(2S,3S)-2-hydroxy-3-(3,4,5-trichlorophenyl)-3-(trifluoromethyl)pyrrolidin-1-yl]phenyl}methyl)cyclopropanecarboxamide+natural pyrethrin.

Combinations of the present component of the group (b) above and the present compound:
acibenzolar-S-methyl+natural pyrethrin, aldimorph+natural pyrethrin, ametoctradin+natural pyrethrin, aminopyrifen+natural pyrethrin, amisulbrom+natural pyrethrin, anilazine+natural pyrethrin, azaconazole+natural pyrethrin, azoxystrobin+natural pyrethrin, basic copper sulfate+natural pyrethrin, benalaxyl+natural pyrethrin, benalaxyl-M+natural pyrethrin, benodanil+natural pyrethrin, benomyl+natural pyrethrin, benthiavalicarb+natural pyrethrin, benthiavalicarb-isopropyl+natural pyrethrin, benzovindiflupyr+natural pyrethrin, binapacryl+natural pyrethrin, biphenyl+natural pyrethrin, bitertanol+natural pyrethrin, bixafen+natural pyrethrin, blasticidin-S+natural pyrethrin, Bordeaux mixture+natural pyrethrin, boscalid+natural pyrethrin, bromothalonil+natural pyrethrin, bromuconazole+natural pyrethrin, bupirimate+natural pyrethrin, captafol+natural pyrethrin, captan+natural pyrethrin, carbendazim+natural pyrethrin, carboxin+natural pyrethrin, carpropamid+natural pyrethrin, chinomethionat+natural pyrethrin, chitin+natural pyrethrin, chloroinconazide+natural pyrethrin, chloroneb+natural pyrethrin, chlorothalonil+natural pyrethrin, chlozolinate+natural pyrethrin, colletochlorin B+natural pyrethrin, copper(II) acetate+natural pyrethrin, copper(II) hydroxide+natural pyrethrin, copper oxychloride+natural pyrethrin, copper(II) sulfate+natural pyrethrin, coumoxystrobin+natural pyrethrin, cyazofamid+natural pyrethrin, cyflufenamid+natural pyrethrin, cymoxanil+natural pyrethrin, cyproconazole+natural pyrethrin, cyprodinil+natural pyrethrin, dichlobentiazox+natural pyrethrin, dichlofluanid+natural pyrethrin, diclocymet+natural pyrethrin, diclomezine+natural pyrethrin, dicloran+natural pyrethrin, diethofencarb+natural pyrethrin, difenoconazole+natural pyrethrin, diflumetorim+natural pyrethrin, dimethachlone+natural pyrethrin, dimethirimol+natural pyrethrin, dimethomorph+natural pyrethrin, dimoxystrobin+natural pyrethrin, diniconazole+natural pyrethrin, diniconazole-M+natural pyrethrin, dinocap+natural pyrethrin, dipotassium hydrogenphosphite+natural pyrethrin, dipymetitrone+natural pyrethrin, dithianon+natural pyrethrin, dodecylbenzenesulphonic acid bisethylenediamine copper(II) salt+natural pyrethrin, dodemorph+natural pyrethrin, dodine+natural pyrethrin, edifenphos+natural pyrethrin, enoxastrobin+natural pyrethrin, epoxiconazole+natural pyrethrin, etaconazole+natural pyrethrin, ethaboxam+natural pyrethrin, ethirimol+natural pyrethrin, etridiazole+natural pyrethrin, famoxadone+natural pyrethrin, fenamidone+natural pyrethrin, fenaminstrobin+natural pyrethrin, fenarimol+natural pyrethrin, fenbuconazole+natural pyrethrin, fenfuram+natural pyrethrin, fenhexamid+natural pyrethrin, fenoxanil+natural pyrethrin, fenpiclonil+natural pyrethrin, fenpicoxamid+natural pyrethrin, fenpropidin+natural pyrethrin, fenpropimorph+natural pyrethrin, fenpyrazamine+natural pyrethrin, fentin acetate+natural pyrethrin, fentin chloride+natural pyrethrin, fentin hydroxide+natural pyrethrin, ferbam+natural pyrethrin, ferimzone+natural pyrethrin, florylpicoxamid+natural pyrethrin, fluazinam+natural pyrethrin, flubeneteram+natural pyrethrin, fludioxonil+natural pyrethrin, flufenoxystrobin+natural pyrethrin, fluindapyr+natural pyrethrin, flumorph+natural pyrethrin, fluopicolide+natural pyrethrin, fluopyram+natural pyrethrin, fluopimomide+natural pyrethrin, fluoroimide+natural pyrethrin, fluoxapiprolin+natural pyrethrin, fluoxastrobin+natural pyrethrin, fluquinconazole+natural pyrethrin, flusilazole+natural pyrethrin, flusulfamide+natural pyrethrin, flutianil+natural pyrethrin, flutolanil+natural pyrethrin, flutriafol+natural pyrethrin, fluxapyroxad+natural pyrethrin, folpet+natural pyrethrin, fosetyl+natural pyrethrin, fosetyl-aluminium+natural pyrethrin, fuberidazole+natural pyrethrin, furalaxyl+natural pyrethrin, furametpyr+natural pyrethrin, guazatine+natural pyrethrin, hexaconazole+natural pyrethrin, hymexazole+natural pyrethrin, imazalil+natural pyrethrin, imibenconazole+natural pyrethrin, iminoctadine+natural pyrethrin, iminoctadine triacetate+natural pyrethrin, inpyrfluxam+natural pyrethrin, iodocarb+natural pyrethrin, ipconazole+natural pyrethrin, ipfentrifluconazole+natural pyrethrin, ipflufenoquin+natural pyrethrin, iprobenfos+natural pyrethrin, iprodione+natural pyrethrin, iprovalicarb+natural pyrethrin, isofetamid+natural pyrethrin, isoflucypram+natural pyrethrin, isoprothiolane+natural pyrethrin, isopyrazam+natural pyrethrin, isotianil+natural pyrethrin, kasugamycin+natural pyrethrin, kresoxim-methyl+natural pyrethrin, laminarin+natural pyrethrin, mancozeb+natural pyrethrin, mandestrobin+natural pyrethrin, mandipropamid+natural pyrethrin, maneb+natural pyrethrin, mefentrifluconazole+natural pyrethrin, mepanipyrim+natural pyrethrin, mepronil+natural pyrethrin, meptyldinocap+natural pyrethrin, metalaxyl+natural pyrethrin, metalaxyl-M+natural pyrethrin, metconazole+natural pyrethrin, methasulfocarb+natural pyrethrin, metiram+natural pyrethrin, metominostrobin+natural pyrethrin, metrafenone+natural pyrethrin, metyltetraprole+natural pyrethrin, mineral oils+natural pyrethrin, myclobutanil+natural pyrethrin, naftifine+natural pyrethrin, nuarimol+natural pyrethrin, octhilinone+natural pyrethrin, ofurace+natural pyrethrin, orysastrobin+natural pyrethrin, oxadixyl+natural pyrethrin, oxathiapiprolin+natural pyrethrin, oxine-copper+natural pyrethrin, oxolinic acid+natural pyrethrin, oxpoconazole+natural pyrethrin, oxpoconazole fumarate+natural pyrethrin, oxycarboxin+natural pyrethrin, oxytetracycline+natural pyrethrin, pefurazoate+natural pyrethrin, penconazole+natural pyrethrin, pencycuron+natural pyrethrin, penflufen+natural pyrethrin, penthiopyrad+natural pyrethrin, phenamacril+natural pyrethrin, phosphorous acid+natural pyrethrin, phthalide+natural pyrethrin, picarbutrazox+natural pyrethrin, picoxystrobin+natural pyrethrin, piperalin+natural pyrethrin, polyoxins+natural pyrethrin, potassium hydrogencarbonate+natural pyrethrin, potassium dihydrogenphosphite+natural pyrethrin, probenazole+natural pyrethrin, prochloraz+natural pyrethrin, procymidone+natural pyrethrin, propamidine+natural pyrethrin, propamocarb+natural pyrethrin, propiconazole+natural pyrethrin, propineb+natural pyrethrin, proquinazid+natural pyrethrin, prothiocarb+natural pyrethrin, prothioconazole+natural pyrethrin, pydiflumetofen+natural pyrethrin, pyraclostrobin+natural pyrethrin, pyrametostrobin+natural pyrethrin, pyraoxystrobin+natural pyrethrin, pyrapropoyne+natural pyrethrin, pyraziflumid+natural pyrethrin, pyrazophos+natural pyrethrin, pyribencarb+natural pyrethrin, pyributicarb+natural pyrethrin, pyridachlometyl+natural pyrethrin, pyrifenox+natural pyrethrin, pyrimethanil+natural pyrethrin, pyrimorph+natural pyrethrin, pyriofenone+natural pyrethrin, pyrisoxazole+natural pyrethrin, pyroquilon+natural pyrethrin, quinconazole+natural pyrethrin, quinofumelin+natural pyrethrin, quinoxyfen+natural pyrethrin, quintozene+natural pyrethrin, sedaxane+natural pyrethrin, silthiofam+natural pyrethrin, simeconazole+natural pyrethrin, sodium hydrogencarbonate+natural pyrethrin, spiroxamine+natural pyrethrin, streptomycin+natural pyrethrin, sulfur+natural pyrethrin, tebuconazole+natural pyrethrin, tebufloquin+natural pyrethrin, teclofthalam+natural pyrethrin, tecnazene+natural pyrethrin, terbinafine+natural pyrethrin, tetraconazole+natural pyrethrin, thiabendazole+natural pyrethrin, thifluzamide+natural pyrethrin, thiophanate+natural pyrethrin, thiophanate-methyl+natural pyrethrin, thiram+natural pyrethrin, thymol+natural pyrethrin, tiadinil+natural pyrethrin, tolclofos-methyl+natural pyrethrin, tolfenpyrad+natural pyrethrin, tolprocarb+natural pyrethrin, tolylfluanid+natural pyrethrin, triadimefon+natural pyrethrin, triadimenol+natural pyrethrin, triazoxide+natural pyrethrin, triclopyricarb+natural pyrethrin, tricyclazole+natural pyrethrin, tridemorph+natural pyrethrin, trifloxystrobin+natural pyrethrin, triflumizole+natural pyrethrin, triforine+natural pyrethrin, triticonazole+natural pyrethrin, validamycin+natural pyrethrin, valifenalate+natural pyrethrin, vinclozolin+natural pyrethrin, zinc thiazole+natural pyrethrin, zineb+natural pyrethrin, ziram+natural pyrethrin, zoxamide+natural pyrethrin, 3-(difluoromethyl)-N-methoxy-1-methyl-N-[(1R)-1-methyl-2-(2,4,6-trichlorophenyl)ethyl]-1H-pyrazole-4-carboxamide (1639015-48-7)+natural pyrethrin, 3-(difluoromethyl)-N-methoxy-1-methyl-N-[(1S)-1-methyl-2-(2,4,6-trichlorophenyl)ethyl]-1H-pyrazole-4-carboxamide (1639015-49-8)+natural pyrethrin, 3-(difluoromethyl)-1-methyl-N-(1,1,3-trimethyl-2,3-dihydro-1H-inden-4-yl)-1H-pyrazole-4-carboxamide (141573-94-6)+natural pyrethrin, 3-(difluoromethyl)-N-[(3R)-7-fluoro-1,1,3-trimethyl-2,3-dihydro-1H-inden-4-yl]-1-methyl-1H-pyrazole-4-carboxamide (1513466-73-3)+natural pyrethrin, N′-[4-({3-[(4-chlorophenyl)methyl]-1,2,4-thiadiazol-5-yl}oxy)-2,5-dimethylphenyl]-N-ethyl-N-methylmethanimidamide (1202781-91-6)+natural pyrethrin, N′-{4-[(4,5-dichlorothiazol-2-yl)oxy]-2,5-dimethylphenyl}-N-ethyl-N-methylmethanimidamide (929908-57-6)+natural pyrethrin, N′-(2,5-dimethyl-4-phenoxyphenyl)-N-ethyl-N-methylmethanimidamide (1052688-31-9)+natural pyrethrin, N′-[5-choro-4-(2-fluorophenoxy)-2-methylphenyl)-N-ethyl-N-methylmethanimidamide (2055589-28-9)+natural pyrethrin, N′-[2-choro-4-(2-fluorophenoxy)-5-methylphenyl)-N-ethyl-N-methylmethanimidamide (2055756-21-1)+natural pyrethrin, N′-[4-(1-hydroxy-1-phenyl-2,2,2-trifluoroethyl)-2-methyl-5-methoxyphenyl)-N-isopropyl-N-methylmethanimidamide (2101814-55-3)+natural pyrethrin, N′-[5-bromo-6-(1-methyl-2-propoxyethoxy)-2-methylpyridin-3-yl)-N-ethyl-N-methylmethanimidamide (1817828-69-5)+natural pyrethrin, 4-(2-bromo-4-fluorophenyl)-N-(2-chloro-6-fluorophenyl)-1,3-dimethyl-1H-pyrazol-5-amine (1362477-26-6)+natural pyrethrin, 2-[6-(3-fluoro-4-methoxyphenyl)-5-methylpyridin-2-yl]quinazoline (1257056-97-5)+natural pyrethrin, 5-fluoro-4-imino-3-methyl-1-tosyl-3,4-dihydropyrimidin-2(1H)-one (1616664-98-2)+natural pyrethrin, ethyl(2Z)-3-amino-2-cyano-3-phenylacrylate (39491-78-6)+natural pyrethrin, N-[(2-chlorothiazol-5-yl)methyl]-N-ethyl-6-methoxy-3-nitropyridin-2-amine (1446247-98-8)+natural pyrethrin, α-[3-(4-chloro-2-fluorophenyl)-5-(2,4-difluorophenyl)-1,2-oxazol-4-yl]-3-pyridinemethanol (1229605-96-2)+natural pyrethrin, (αS)-[3-(4-chloro-2-fluorophenyl)-5-(2,4-difluorophenyl)-1,2-oxazol-4-yl]-3-pyridinemethanol (1229606-46-5)+natural pyrethrin, (αR)-[3-(4-chloro-2-fluorophenyl)-5-(2,4-difluorophenyl)-1,2-oxazol-4-yl]-3-pyridinemethanol (1229606-02-3)+natural pyrethrin, 5-(4-chlorobenzyl)-2-(chloromethyl)-2-methyl-1-(1H-1,2,4-triazol-1-ylmethyl)cyclopentan-1-ol (1394057-11-4)+natural pyrethrin, (1R,2S,5S)-5-(4-chlorobenzyl)-2-(chloromethyl)-2-methyl-1-(1H-1,2,4-triazol-1-ylmethyl)cyclopentan-1-ol (1801930-06-2)+natural pyrethrin, (1S,2R,5R)-5-(4-chlorobenzyl)-2-(chloromethyl)-2-methyl-1-(1H-1,2,4-triazol-1-ylmethyl)cyclopentan-1-ol (1801930-07-3)+natural pyrethrin, (1R,2R,5R)-5-(4-chlorobenzyl)-2-(chloromethyl)-2-methyl-1-(1H-1,2,4-triazol-1-ylmethyl)cyclopentan-1-ol (1801919-53-8)+natural pyrethrin, (1S,2S,5S)-5-(4-chlorobenzyl)-2-(chloromethyl)-2-methyl-1-(1H-1,2,4-triazol-1-ylmethyl)cyclopentan-1-ol (1801919-54-9)+natural pyrethrin, (1R,2R,5S)-5-(4-chlorobenzyl)-2-(chloromethyl)-2-methyl-1-(1H-1,2,4-triazol-1-ylmethyl)cyclopentan-1-ol (1801919-55-0)+natural pyrethrin, (1S,2S,5R)-5-(4-chlorobenzyl)-2-(chloromethyl)-2-methyl-1-(1H-1,2,4-triazol-1-ylmethyl)cyclopentan-1-ol (1801919-56-1)+natural pyrethrin, (1R,2S,5R)-5-(4-chlorobenzyl)-2-(chloromethyl)-2-methyl-1-(1H-1,2,4-triazol-1-ylmethyl) cyclopentan-1-ol (1801919-57-2)+natural pyrethrin, (1S,2R,5S)-5-(4-chlorobenzyl)-2-(chloromethyl)-2-methyl-1-(1H-1,2,4-triazol-1-ylmethyl)cyclopentan-1-ol (1801919-58-3)+natural pyrethrin, methyl 3-[(4-chlorophenyl)methyl]-2-hydroxy-1-methyl-2-(1H-1,2,4-triazol-1-ylmethyl)cyclopentane-1-carboxylate (1791398-02-1)+natural pyrethrin, methyl (1R,2S,3S)-3-[(4-chlorophenyl)methyl]-2-hydroxy-1-methyl-2-(1H-1,2,4-triazol-1-ylmethyl)cyclopentane-1-carboxylate (2080743-90-2)+natural pyrethrin, methyl (1S,2R,3R)-3-[(4-chlorophenyl)methyl]-2-hydroxy-1-methyl-2-(1H-1,2,4-triazol-1-ylmethyl)cyclopentane-1-carboxylate (2080743-91-3)+natural pyrethrin, methyl (1R,2R,3R)-3-[(4-chlorophenyl)methyl]-2-hydroxy-1-methyl-2-(1H-1,2,4-triazol-1-ylmethyl)cyclopentane-1-carboxylate (2080743-92-4)+natural pyrethrin, methyl (1S,2S,3S)-3-[(4-chlorophenyl)methyl]-2-hydroxy-1-methyl-2-(1H-1,2,4-triazol-1-ylmethyl)cyclopentane-1-carboxylate (2080743-93-5)+natural pyrethrin, methyl (1R,2R,3S)-3-[(4-chlorophenyl)methyl]-2-hydroxy-1-methyl-2-(1H-1,2,4-triazol-1-ylmethyl)cyclopentane-1-carboxylate (2080743-94-6)+natural pyrethrin, methyl (1S,2S,3R)-3-[(4-chlorophenyl)methyl]-2-hydroxy-1-methyl-2-(1H-1,2,4-triazol-1-ylmethyl)cyclopentane-1-carboxylate (2080743-95-7)+natural pyrethrin, methyl (1R,2S,3R)-3-[(4-chlorophenyl)methyl]-2-hydroxy-1-methyl-2-(1H-1,2,4-triazol-1-ylmethyl)cyclopentane-1-carboxylate (2081061-22-3)+natural pyrethrin, methyl (1S,2R,3S)-3-[(4-chlorophenyl)methyl]-2-hydroxy-1-methyl-2-(1H-1,2,4-triazol-1-ylmethyl) cyclopentane-1-carboxylate (2081061-23-4)+natural pyrethrin, 2-(chloromethyl)-5-(4-fluorobenzyl)-2-methyl-1-(1H-1,2,4-triazol-1-ylmethyl)cyclopentan-1-ol (1394057-13-6)+natural pyrethrin, (1R,2S,5S)-2-(chloromethyl)-5-(4-fluorobenzyl)-2-methyl-1-(1H-1,2,4-triazol-1-ylmethyl)cyclopentan-1-ol (1801930-08-4)+natural pyrethrin, (1S,2R,5R)-2-(chloromethyl)-5-(4-fluorobenzyl)-2-methyl-1-(1H-1,2,4-triazol-1-ylmethyl)cyclopentan-1-ol (1801930-09-5)+natural pyrethrin, (1R,2R,3R)-2-(chloromethyl)-5-(4-fluorobenzyl)-2-methyl-1-(1H-1,2,4-triazol-1-ylmethyl)cyclopentan-1-ol (1638898-08-4)+natural pyrethrin, (1S,2S,3S)-2-(chloromethyl)-5-(4-fluorobenzyl)-2-methyl-1-(1H-1,2,4-triazol-1-ylmethyl)cyclopentan-1-ol (1638898-10-8)+natural pyrethrin, (1R,2R,3S)-2-(chloromethyl)-5-(4-fluorobenzyl)-2-methyl-1-(1H-1,2,4-triazol-1-ylmethyl)cyclopentan-1-ol (1638898-13-1)+natural pyrethrin, (1S,2S,5R)-2-(chloromethyl)-5-(4-fluorobenzyl)-2-methyl-1-(1H-1,2,4-triazol-1-ylmethyl)cyclopentan-1-ol (1638898-16-4)+natural pyrethrin, (1R,2S,5R)-2-(chloromethyl)-5-(4-fluorobenzyl)-2-methyl-1-(1H-1,2,4-triazol-1-ylmethyl)cyclopentan-1-ol (1638898-20-0)+natural pyrethrin, (1S,2R,5S)-2-(chloromethyl)-5-(4-fluorobenzyl)-2-methyl-1-(1H-1,2,4-triazol-1-ylmethyl)cyclopentan-1-ol (1638898-24-4)+natural pyrethrin, 1-(2,4-difluorophenyl)-2-(1H-1,2,4-triazol-1-yl)-1-[1-(4-bromo-2,6-difluorophenoxy)cyclopropyl]ethanol (2019215-86-0)+natural pyrethrin, 1-(2,4-difluorophenyl)-2-(1H-1,2,4-triazol-1-yl)-1-[1-(4-chloro-2,6-difluorophenoxy)cyclopropyl]ethanol (2019215-84-8)+natural pyrethrin, 1-[2-(1-chlorocyclopropyl)-3-(2-fluorophenyl)-2-hydroxypropyl]-1H-imidazole-5-carbonitrile (2018316-13-5)+natural pyrethrin, 1-[2-(1-chlorocyclopropyl)-3-(2,3-difluorophenyl)-2-hydroxypropyl]-1H-imidazole-5-carbonitrile (2018317-25-2)+natural pyrethrin, 4-({6-[2-(2,4-difluorophenyl)-1,1-difluoro-2-hydroxy-3-(1H-1,2,4-triazol-1-yl)propyl]pyridin-3-yl}oxy)benzonitrile (2046300-61-0)+natural pyrethrin, 2-[6-(4-bromophenoxy)-2-(trifluoromethyl)pyridin-3-yl]-1-(1H-1,2,4-triazol-1-yl)propan-2-ol (2082661-43-4)+natural pyrethrin, 2-[6-(4-chlorophenoxy)-2-(trifluoromethyl)pyridin-3-yl]-1-(1H-1,2,4-triazol-1-yl)propan-2-ol (2082660-27-1)+natural pyrethrin, methyl({2-methyl-5-[1-(4-methoxy-2-methylphenyl)-1H-pyrazol-3-yl]phenyl}methyl)carbamate (1605879-98-8)+natural pyrethrin, 2-(difluoromethyl)-N-[1,1,3-trimethyl-2,3-dihydro-1H-inden-4-yl]pyridine-3-carboxamide (1616239-21-4)+natural pyrethrin, 2-(difluoromethyl)-N-[(3R)-1,1,3-trimethyl-2,3-dihydro-1H-inden-4-yl]pyridine-3-carboxamide (1616239-33-8)+natural pyrethrin, 2-(difluoromethyl)-N-[3-ethyl-1,1-dimethyl-2,3-dihydro-1H-inden-4-yl]pyridine-3-carboxamide (1847460-02-9)+natural pyrethrin, 2-(difluoromethyl)-N-[(3R)-3-ethyl-1,1-dimethyl-2,3-dihydro-1H-inden-4-yl]pyridine-3-carboxamide (1952305-97-3)+natural pyrethrin, 2-(difluoromethyl)-N-[3-propyl-1,1-dimethyl-2,3-dihydro-1H-inden-4-yl]pyridine-3-carboxamide (1847460-05-2)+natural pyrethrin, 2-(difluoromethyl)-N-[(3R)-3-propyl-1,1-dimethyl-2,3-dihydro-1H-inden-4-yl]pyridine-3-carboxamide (1952306-00-1)+natural pyrethrin, (2E,3Z)-5-{[1-(4-chlorophenyl)-1H-pyrazol-3-yl]oxy}-2-(methoxyimino)-N,3-dimethylpent-3-enamide (1445331-27-0)+natural pyrethrin, (2E,3Z)-5-{[1-(2,4-dichlorophenyl)-1H-pyrazol-3-yl]oxy}-2-(methoxyimino)-N,3-dimethylpent-3-enamide (1445331-54-3)+natural pyrethrin, 5-chloro-4-({2-[6-(4-chlorophenoxy)pyridin-3-yl]ethyl}amino)-6-methylpyrimidine (1605340-92-8)+natural pyrethrin, N-(1-benzyl-1,3-dimethylbutyl)-8-fluoroquinoline-3-carboxamide (2132414-04-9)+natural pyrethrin, N-[(1S)-1-benzyl-1,3-dimethylbutyl]-8-fluoroquinoline-3-carboxamide+natural pyrethrin, N-[(1R)-1-benzyl-1,3-dimethylbutyl]-8-fluoroquinoline-3-carboxamide (2132414-06-1)+natural pyrethrin, N-(1-benzyl-3,3,3-trifluoro-1-methylpropyl)-8-fluoroquinoline-3-carboxamide (2132414-00-5)+natural pyrethrin, N-[(1S)-1-benzyl-3,3,3-trifluoro-1-methylpropyl]-8-fluoroquinoline-3-carboxamide (2132414-01-6)+natural pyrethrin, N-[(1R)-1-benzyl-3,3,3-trifluoro-1-methylpropyl]-8-fluoroquinoline-3-carboxamide+natural pyrethrin, 4,4-dimethyl-2-({4-[5-(trifluoromethyl)-1,2,4-oxadiazol-3-yl]phenyl}methyl)isoxazolidin-3-one (2098918-25-1)+natural pyrethrin, 5,5-dimethyl-2-({4-[5-(trifluoromethyl)-1,2,4-oxadiazol-3-yl]phenyl}methyl)isoxazolidin-3-one (2098918-26-2)+natural pyrethrin, N-acetyl-2-(ethanesulfonyl)-N-[2-(methoxycarbonyl)-4-(trifluoromethoxy)phenyl]-4-(trifluoromethyl)benzamide (2043675-28-9)+natural pyrethrin, (2S,3S)-3-(2-methylphenyl)butan-2-yl N-[(3-acetoxy-4-methoxypyridin-2-yl)carbonyl]-L-alaninate (2376210-00-1)+natural pyrethrin, (2S,3S)-3-(4-fluoro-2-methylphenyl)butan-2-yl N-[(3-acetoxy-4-methoxypyridin-2-yl)carbonyl]-L-alaninate, (2S,3S)-3-(4-methoxy-2-methylphenyl)butan-2-yl N-[(3-acetoxy-4-methoxypyridin-2-yl)carbonyl]-L-alaninate, (2S,3S)-3-(2,4-dimethylphenyl)butan-2-yl N-[(3-acetoxy-4-methoxypyridin-2-yl)carbonyl]-L-alaninate (2376209-13-9)+natural pyrethrin, (2S,3S)-3-(2-methylphenyl)butan-2-yl N-({3-[(2-methylpropanoyl)oxy]-4-methoxypyridin-2-yl}carbonyl)-L-alaninate (2376210-02-3)+natural pyrethrin, (2S,3S)-3-(4-fluoro-2-methylphenyl)butan-2-yl N-({3-[(2-methylpropanoyl)oxy]-4-methoxypyridin-2-yl}carbonyl)-L-alaninate, (2S,3S)-3-(4-methoxy-2-methylphenyl)butan-2-yl N-({3-[(2-methylpropanoyl)oxy]-4-methoxypyridin-2-yl}carbonyl)-L-alaninate (2376209-40-2)+natural pyrethrin, (2S,3S)-3-(2,4-dimethylphenyl)butan-2-yl N-({3-[(2-methylpropanoyl)oxy]-4-methoxypyridin-2-yl}carbonyl)-L-alaninate (2376209-15-1)+natural pyrethrin, (2S,3S)-3-(2-methylphenyl)butan-2-yl N-[(3-hydroxy-4-methoxypyridin-2-yl)carbonyl]-L-alaninate+natural pyrethrin, (2S,3S)-3-(4-fluoro-2-methylphenyl)butan-2-yl N-[(3-hydroxy-4-methoxypyridin-2-yl)carbonyl]-L-alaninate+natural pyrethrin, (2S,3S)-3-(4-methoxy-2-methylphenyl)butan-2-yl N-[(3-hydroxy-4-methoxypyridin-2-yl)carbonyl]-L-alaninate+natural pyrethrin, (2S,3S)-3-(2,4-dimethylphenyl)butan-2-yl N-[(3-hydroxy-4-methoxypyridin-2-yl)carbonyl]-L-alaninate+natural pyrethrin, (2S,3S)-3-(4-fluoro-2-methylphenyl)-4-methylpentan-2-yl N-[(3-acetoxy-4-methoxypyridin-2-yl)carbonyl]-L-alaninate+natural pyrethrin, (2S,3S)-3-(2-fluoro-4-methylphenyl)-4-methylpentan-2-yl N-[(3-acetoxy-4-methoxypyridin-2-yl)carbonyl]-L-alaninate+natural pyrethrin, (2S,3S)-3-(2,4-difluorophenyl)-4-methylpentan-2-yl N-[(3-acetoxy-4-methoxypyridin-2-yl)carbonyl]-L-alaninate+natural pyrethrin, (2S,3S)-3-(2,4-dimethylphenyl)-4-methylpentan-2-yl N-[(3-acetoxy-4-methoxypyridin-2-yl)carbonyl]-L-alaninate+natural pyrethrin, (2S,3S)-3-(4-fluoro-2-methoxylphenyl)-4-methylpentan-2-yl N-[(3-acetoxy-4-methoxypyridin-2-yl)carbonyl]-L-alaninate+natural pyrethrin, (2S,3S)-3-(4-fluoro-2-methylphenyl)-4-methylpentan-2-yl N-{[3-(acetoxymethoxy)-4-methoxypyridin-2-yl]carbonyl}-L-alaninate+natural pyrethrin, (2S,3S)-3-(2-fluoro-4-methylphenyl)-4-methylpentan-2-yl N-{[3-(acetoxymethoxy)-4-methoxypyridin-2-yl]carbonyl}-L-alaninate+natural pyrethrin, (2S,3S)-3-(2,4-difluorophenyl)-4-methylpentan-2-yl N-{[3-(acetoxymethoxy)-4-methoxypyridin-2-yl]carbonyl}-L-alaninate+natural pyrethrin, (2S,3S)-3-(2,4-dimethylphenyl)-4-methylpentan-2-yl N-{[3-(acetoxymethoxy)-4-methoxypyridin-2-yl]carbonyl}-L-alaninate+natural pyrethrin, (2S,3S)-3-(4-fluoro-2-methoxylphenyl)-4-methylpentan-2-yl N-{[3-(acetoxymethoxy)-4-methoxypyridin-2-yl]carbonyl}-L-alaninate+natural pyrethrin, (2S,3S)-3-(4-fluoro-2-methylphenyl)-4-methylpentan-2-yl N-({3-[(isobutyryloxy)methoxy]-4-methoxypyridin-2-yl}carbonyl)-L-alaninate+natural pyrethrin, (2S,3S)-3-(2-fluoro-4-methylphenyl)-4-methylpentan-2-yl N-({3-[(isobutyryloxy)methoxy]-4-methoxypyridin-2-yl}carbonyl)-L-alaninate+natural pyrethrin, (2S,3S)-3-(2,4-difluorophenyl)-4-methylpentan-2-yl N-({3-[(isobutyryloxy)methoxy]-4-methoxypyridin-2-yl}carbonyl)-L-alaninate+natural pyrethrin, (2S,3S)-3-(2,4-dimethylphenyl)-4-methylpentan-2-yl N-({3-[(isobutyryloxy)methoxy]-4-methoxypyridin-2-yl}carbonyl)-L-alaninate+natural pyrethrin, (2S,3S)-3-(4-fluoro-2-methoxylphenyl)-4-methylpentan-2-yl N-({3-[(isobutyryloxy)methoxy]-4-methoxypyridin-2-yl}carbonyl)-L-alaninate+natural pyrethrin, (2S,3S)-3-(4-fluoro-2-methylphenyl)-4-methylpentan-2-yl N-[(3-hydroxy-4-methoxypyridin-2-yl)carbonyl]-L-alaninate+natural pyrethrin, (2S,3S)-3-(2-fluoro-4-methylphenyl)-4-methylpentan-2-yl N-[(3-hydroxy-4-methoxypyridin-2-yl)carbonyl]-L-alaninate+natural pyrethrin, (2S,3S)-3-(2,4-difluorophenyl)-4-methylpentan-2-yl N-[(3-hydroxy-4-methoxypyridin-2-yl)carbonyl]-L-alaninate+natural pyrethrin, (2S,3S)-3-(2,4-dimethylphenyl)-4-methylpentan-2-yl N-[(3-hydroxy-4-methoxypyridin-2-yl)carbonyl]-L-alaninate+natural pyrethrin, (2S,3S)-3-(4-fluoro-2-methoxylphenyl)-4-methylpentan-2-yl N-[(3-hydroxy-4-methoxypyridin-2-yl)carbonyl]-L-alaninate+natural pyrethrin, 3-(4-bromo-7-fluoroindol-1-yl)butan-2-yl N-[(3-hydroxy-4-methoxypyridin-2-yl)carbonyl]-L-alaninate+natural pyrethrin, 3-(7-bromoindol-1-yl)butan-2-yl N-[(3-hydroxy-4-methoxypyridin-2-yl)carbonyl]-L-alaninate+natural pyrethrin, 3-(7-bromo-4-fluoroindol-1-yl)butan-2-yl N-[(3-hydroxy-4-methoxypyridin-2-yl)carbonyl]-L-alaninate+natural pyrethrin, 3-(3,5-dichloropyridin-2-yl)butan-2-yl N-[(3-hydroxy-4-methoxypyridin-2-yl)carbonyl]-L-alaninate+natural pyrethrin, 3-(3,5-dichloropyridin-2-yl)butan-2-yl N-{[3-(acetoxymethoxy)-4-methoxypyridin-2-yl]carbonyl}-L-alaninate+natural pyrethrin, (1S)-1-[1-(naphthalen-1-yl)cyclopropyl]ethyl N-{[3-(acetoxymethoxy)-4-methoxypyridin-2-yl]carbonyl}-L-alaninate+natural pyrethrin, (1S)-1-[1-(naphthalen-1-yl)cyclopropyl]ethyl N-[(3-acetoxy-4-methoxypyridin-2-yl)carbonyl]-L-alaninate+natural pyrethrin, (1S)-1-[1-(naphthalen-1-yl)cyclopropyl]ethyl N-{[3-(acetoxymethoxy)-4-methoxypyridin-2-yl]carbonyl}-L-alaninate+natural pyrethrin.

Combinations of the present component of the group (c) above and the present compound:
1-methylcyclopropene+natural pyrethrin, 1,3-diphenylurea+natural pyrethrin, 1,3,5-triazinane-2,4,6-trithione+natural pyrethrin, 2,3,5-triiodobenzoic acid+natural pyrethrin, IAA ((1H-indol-3-yl)acetic acid)+natural pyrethrin, IBA (4-(1H-indol-3-yl)butyric acid)+natural pyrethrin, MCPA (2-(4-chloro-2-methylphenoxy)acetic acid)+natural pyrethrin, MCPB (4-(4-chloro-2-methylphenoxy)butyric acid)+natural pyrethrin, 4-CPA (4-chlorophenoxyacetic acid)+natural pyrethrin, 5-aminolevulinic acid hydrochloride+natural pyrethrin, 6-benzylaminopurine+natural pyrethrin, abscisic acid+natural pyrethrin, AVG (aminoethoxyvinylglycine)+natural pyrethrin, ancymidol+natural pyrethrin, butralin+natural pyrethrin, calcium carbonate+natural pyrethrin, calcium chloride+natural pyrethrin, calcium formate+natural pyrethrin, calcium peroxide+natural pyrethrin, calcium polysulfide+natural pyrethrin, calcium sulfate+natural pyrethrin, chlormequat-chloride+natural pyrethrin, chlorpropham+natural pyrethrin, choline chloride+natural pyrethrin, cloprop+natural pyrethrin, cyanamide+natural pyrethrin, cyclanilide+natural pyrethrin, cyprosulfamide+natural pyrethrin, daminozide+natural pyrethrin, decan-1-ol+natural pyrethrin, dichlorprop+natural pyrethrin, dikegulac+natural pyrethrin, dimethipin+natural pyrethrin, diquat+natural pyrethrin, ethephon+natural pyrethrin, ethychlozate+natural pyrethrin, flumetralin+natural pyrethrin, flurprimidol+natural pyrethrin, forchlorfenuron+natural pyrethrin, formononetin+natural pyrethrin, Gibberellin A+natural pyrethrin, Gibberellin A3+natural pyrethrin, inabenfide+natural pyrethrin, Kinetin+natural pyrethrin, lipochitooligosaccharide MOR116+natural pyrethrin, lipochitooligosaccharide SP104+natural pyrethrin, maleic hydrazide+natural pyrethrin, mefluidide+natural pyrethrin, mepiquat-chloride+natural pyrethrin, methyl-alpha-D-mannopyranoside+natural pyrethrin, oxidized glutathione+natural pyrethrin, pacrobutrazol+natural pyrethrin, pendimethalin+natural pyrethrin, prohexandione-calcium+natural pyrethrin, prohydrojasmon+natural pyrethrin, pyraflufen-ethyl+natural pyrethrin, pyroglutamic acid+natural pyrethrin, sintofen+natural pyrethrin, sodium 1-naphthaleneacetate+natural pyrethrin, sodium cyanate+natural pyrethrin, streptmycin+natural pyrethrin, thidiazuron+natural pyrethrin, titanium apatite+natural pyrethrin, triapenthenol+natural pyrethrin, Tribufos+natural pyrethrin, trinexapac-ethyl+natural pyrethrin, uniconazole-P+natural pyrethrin, 2-(naphthalen-1-yl)acetamide+natural pyrethrin, [4-oxo-4-(2-phenylethyl)amino]butyric acid+natural pyrethrin, methyl 5-(trifluoromethyl)benzo[b]thiophene-2-carboxylate+natural pyrethrin, 3-[(6-chloro-4-phenylquinazolin-2-yl)amino]propan-1-ol+natural pyrethrin, strigolactone+natural pyrethrin, (1E)-1-[[1-[3,5-bis(trifluoromethyl)phenyl]-4-methyl-5-oxo-2H-pyrrol-2-yl]oxymethylene]-3,3a,4,8b-tetrahydroindeno[2,1-b]pyrrol-2-one described in WO2018/145979+natural pyrethrin, (2R)-1-[3,5-bis(trifluoromethyl)phenyl]-4-methyl-2-[(E)-(2-oxo-4,8b-dihydro-3aH-indeno[2,1-b]furan-1-ylidene)methoxy]-2H-pyrrol-5-one described in WO2018/145979+natural pyrethrin, (2S)-1-[3,5-bis(trifluoromethyl)phenyl]-4-methyl-2-[(E)-(2-oxo-4,8b-dihydro-3aH-indeno[2,1-b]furan-1-ylidene)methoxy]-2H-pyrrol-5-one described in WO2018/145979+natural pyrethrin.

Combinations of the present component of the group (d) above and the present compound:
allidochlor+natural pyrethrin, benoxacor+natural pyrethrin, cloquintocet+natural pyrethrin, cloquintocet-mexyl+natural pyrethrin, cyometrinil+natural pyrethrin, cyprosulfamide+natural pyrethrin, dichlormid+natural pyrethrin, dicyclonone+natural pyrethrin, dimepiperate+natural pyrethrin, disulfoton+natural pyrethrin, dymron+natural pyrethrin, fenchlorazole+natural pyrethrin, fenchlorazole-ethyl+natural pyrethrin, fenclorim+natural pyrethrin, flurazole+natural pyrethrin, furilazole+natural pyrethrin, fluxofenim+natural pyrethrin, Hexim+natural pyrethrin, isoxadifen+natural pyrethrin, isoxadifen-ethyl+natural pyrethrin, mecoprop+natural pyrethrin, mefenpyr+natural pyrethrin, mefenpyr-ethyl+natural pyrethrin, mefenpyr-diethyl+natural pyrethrin, mephenate+natural pyrethrin, metcamifen+natural pyrethrin, oxabetrinil+natural pyrethrin, 1,8-naphthalic anhydride+natural pyrethrin, octane-1,8-diamine+natural pyrethrin, AD-67 (4-(dichloroacetyl)-1-oxa-4-azaspiro [4.5]decane)+natural pyrethrin, CL-304415 (4-carboxy-3,4-dihydro-2H-1-benzopyran-4-acetic acid)+natural pyrethrin, CSB (1-bromo-4-[(chloromethyl)sulfonyl]benzene)+natural pyrethrin, DKA-24 (2,2-dichloro-N-[2-oxo-2-(2-propenylamino)ethyl]-N-(2-propenyl)acetamide)+natural pyrethrin, MG191 (2-(dichloromethyl)-2-methyl-1,3-dioxolane)+natural pyrethrin, MG-838 (2-propenyl 1-oxa-4-azaspiro[4.5]decane-4-carbodithioate)+natural pyrethrin, PPG-1292 (2,2-dichloro-N-(1,3-dioxan-2-ylmethyl)-N-(2-propenyl)acetamide)+natural pyrethrin, R-28725 (3-(dichloroacetyl)-2,2-dimethyl-1,3-oxazolidine)+natural pyrethrin, R-29148 (3-(dichloroacetyl)-2,2,5-trimethyl-1,3-oxazolidine)+natural pyrethrin, TI-35 (1-(dichloroacetyl)azepane)+natural pyrethrin.

Combinations of the present component of the group (e) above and the present compound:
1-dodecyl-1H-imidazole+natural pyrethrin, N-(2-ethylhexyl)-8,9,10-trinorborn-5-ene-2,3-dicarboximide+natural pyrethrin, bucarpolate+natural pyrethrin, N,N-dibutyl-4-chlorobenzenesulfonamide+natural pyrethrin, dietholate+natural pyrethrin, diethylmaleate+natural pyrethrin, piperonyl butoxide+natural pyrethrin, piperonyl cyclonene+natural pyrethrin, piprotal+natural pyrethrin, propyl isome+natural pyrethrin, safroxan+natural pyrethrin, sesamex+natural pyrethrin, sesamolin+natural pyrethrin, sulfoxide+natural pyrethrin, Verbutin+natural pyrethrin, DMC (1,1-bis(4-chlorophenyl)ethanol)+natural pyrethrin, FDMC (1,1-bis(4-chlorophenyl)-2,2,2-trifluoroethanol)+natural pyrethrin, ETN (1,2-epoxy-1,2,3,4-tetrahydronaphthalene)+natural pyrethrin, ETP (1,1,1-trichloro-2,3-expoxypropane)+natural pyrethrin, PSCP (phenylsaligenin cyclic phosphate)+natural pyrethrin, TBPT (S,S,S-tributyl phosphorotrithioate)+natural pyrethrin, TPP (triphenyl phosphate)+natural pyrethrin.

Combinations of the present component of the group (f) above and the present compound:
anthraquinone+natural pyrethrin, chloralose+natural pyrethrin, acrep+natural pyrethrin, butopyronoxyl+natural pyrethrin, carboxide+natural pyrethrin, dibutyl phthalate+natural pyrethrin, deet+natural pyrethrin, dimethyl carbate+natural pyrethrin, dimethyl phthalate+natural pyrethrin, dibutyl succinate+natural pyrethrin, dibutyl adipate+natural pyrethrin, ethohexadiol+natural pyrethrin, hexamide+natural pyrethrin, icaridin+natural pyrethrin, methoquin-butyl+natural pyrethrin, methylneodecanamide+natural pyrethrin, 2-(octylthio)ethanol+natural pyrethrin, butoxypolypropylene glycol+natural pyrethrin, oxamate+natural pyrethrin, quwenzhi+natural pyrethrin, quyingding+natural pyrethrin, zengxiaon+natural pyrethrin, rebemide+natural pyrethrin, copper naphthenate+natural pyrethrin, zinc naphthenate+natural pyrethrin.

Combinations of the present component of the group (g) above and the present compound:
bis(tributyltin) oxide+natural pyrethrin, allicin+natural pyrethrin, bromoacetamide+natural pyrethrin, cloethocarb+natural pyrethrin, copper sulfate+natural pyrethrin, fentin+natural pyrethrin, ferric phosphate+natural pyrethrin, metaldehyde+natural pyrethrin, niclosamide+natural pyrethrin, pentachlorophenol+natural pyrethrin, sodium pentachlorophenoxide+natural pyrethrin, tazimcarb+natural pyrethrin, tralopyril+natural pyrethrin, trifenmorph+natural pyrethrin.

Combinations of the present component of the group (h) above and the present compound:
(E)-2-hexenal+natural pyrethrin, (E)-2-octadecenal+natural pyrethrin, (E)-4-tridecen-1-yl acetate+natural pyrethrin, (E)-5-decen-1-yl acetate+natural pyrethrin, (E)-5-decen-1-ol+natural pyrethrin, (E)-3,3-dimethylcyclohexylideneacetaldehyde+natural pyrethrin, (E)-7-dodecen-1-yl acetate+natural pyrethrin, (E)-8-dodecen-1-yl acetate+natural pyrethrin, (E)-9-dodecen-1-yl acetate+natural pyrethrin, (E)-10-hexadecenal+natural pyrethrin, (E)-11-hexadecen-1-yl acetate+natural pyrethrin, (E)-11-tetradecen-1-yl acetate+natural pyrethrin, (E)-11-tetradecen-1-ol+natural pyrethrin, (E)-4-tridecen-1-yl acetate+natural pyrethrin, (E)-6-methylhept-2-en-4-ol+natural pyrethrin, (Z)-2-(3,3-dimethylcyclohexylidene)ethanol+natural pyrethrin, (Z)-4-decen-1-yl acetate+natural pyrethrin, (Z)-4-tridecen-1-yl acetate+natural pyrethrin, (Z)-5-decen-1-yl acetate+natural pyrethrin, (Z)-5-decen-1-ol+natural pyrethrin, (Z)-7-tetradecenal+natural pyrethrin, (Z)-7-dodecen-1-yl acetate+natural pyrethrin, (Z)-8-dodecen-1-yl acetate+natural pyrethrin, (Z)-9-dodecen-1-yl acetate+natural pyrethrin, (Z)-8-dodecen-1-ol+natural pyrethrin, (Z)-9-hexadecenal+natural pyrethrin, (Z)-10-hexadecen-1-yl acetate+natural pyrethrin, (Z)-11-hexadecen-1-ol+natural pyrethrin, (Z)-11-hexadecenal+natural pyrethrin, (Z)-11-hexadecen-1-yl acetate+natural pyrethrin, (Z)-11-octadecenal+natural pyrethrin, (Z)-13-octadecenal+natural pyrethrin, (Z)-hexadec-13-en-11-yn-1-yl acetate+natural pyrethrin, (Z)-13-octadecenal+natural pyrethrin, (Z)-icos-13-en-10-one+natural pyrethrin, (Z)-7-tetradecenal+natural pyrethrin, (Z)-tetradec-9-en-1-ol+natural pyrethrin, (Z)-9-tetradecen-1-yl acetate+natural pyrethrin, (Z)-11-tetradecen-1-yl acetate+natural pyrethrin, (Z)-13-icosen-10-one+natural pyrethrin, (Z,E)-7,11-hexadecadien-1-yl acetate+natural pyrethrin, (Z,E)-9,12-tetradecadien-1-yl acetate+natural pyrethrin, (E,Z)-4,10-tetradecadien-1-yl acetate+natural pyrethrin, (E,E)-8,10-dodecadien-1-ol+natural pyrethrin, (E,E)-10,12-hexadecadienal+natural pyrethrin, (E,E)-9,11-tetradecadien-1-yl acetate+natural pyrethrin, (E,Z)-2,13-octadecadien-1-ol+natural pyrethrin, (E,Z)-3,13-octadecadien-1-ol+natural pyrethrin, (E,Z)-2,13-octadecadien-1-yl acetate+natural pyrethrin, (E,Z)-3,13-octadecadien-1-yl acetate+natural pyrethrin, (E,Z)-7,9-dodecadien-1-yl acetate+natural pyrethrin, (E,E)-7,9-dodecadien-1-yl acetate+natural pyrethrin, (Z,E)-9,12-tetradecadien-1-yl acetate+natural pyrethrin, (Z,E)-9,11-tetradecadien-1-yl acetate+natural pyrethrin, (Z,E)-7,11-hexadecadien-1-yl acetate+natural pyrethrin, (Z,Z)-3,13-octadecadien-1-ol+natural pyrethrin, (Z,Z)-4,7-decadien-1-yl acetate+natural pyrethrin, (Z,Z)-3,13-octadecadien-1-yl acetate+natural pyrethrin, (Z,Z)-7,11-hexadecadien-1-yl acetate+natural pyrethrin, (Z,Z,E)-7,11,13-hexadecatrienal+natural pyrethrin, (5R)-5-[(1Z)-1-decen-1-yl]dihydro-2(3H)-furanone+natural pyrethrin, (2R,5R)-ethyl-1,6-dioxaspiro[4,4]nonane+natural pyrethrin, (2R,5S)-ethyl-1,6-dioxaspiro[4,4]nonane+natural pyrethrin, (4R,8R)-4,8-dimethyldecanal+natural pyrethrin, (4R,8S)-4,8-dimethyldecanal+natural pyrethrin, 2,4-dimethyl-5-ethyl-6,8-dioxabicyclo[3,2,1]octane+natural pyrethrin, (−)-4-methyl-3-heptanol+natural pyrethrin, 1,7-dioxaspiro[5,5]undecane+natural pyrethrin, 3-carene+natural pyrethrin, 3-methylcyclohex-2-en-1-one+natural pyrethrin, 14-methyloctadec-1-ene+natural pyrethrin, 4-methylnonan-5-ol+natural pyrethrin, 4-methylnonan-5-one+natural pyrethrin, 4-(3-oxobutyl)phenyl acetate+natural pyrethrin, dodecyl acetate+natural pyrethrin, dodeca-8,10-dien-1-yl acetate+natural pyrethrin, ethyl (2E,4Z)-decadienoate+natural pyrethrin, ethyl 4-methyloctanoate+natural pyrethrin, methyl 2,6,10-trimethyldodecanoate+natural pyrethrin, tetradecan-1-ol+natural pyrethrin, tetradec-11-en-1-ol+natural pyrethrin, tetradec-11-en-1-yl acetate+natural pyrethrin, tridec-4-en-1-yl acetate+natural pyrethrin, (3S,6R)-3-methyl-6-isopropenyl-9-decen-1-yl acetate+natural pyrethrin, (3S,6S)-3-methyl-6-isopropenyl-9-decen-1-yl acetate+natural pyrethrin, alpha-multistriatin+natural pyrethrin, alpha-pinene+natural pyrethrin, endo-brevicomin+natural pyrethrin, exo-brevicomin+natural pyrethrin, camphene+natural pyrethrin, codlelure+natural pyrethrin, codlemone+natural pyrethrin, cuelure+natural pyrethrin, disparlure+natural pyrethrin, dominicalure+natural pyrethrin, eugenol+natural pyrethrin, farnesol+natural pyrethrin, ferrolure+natural pyrethrin, frontalin+natural pyrethrin, gossyplure+natural pyrethrin, grandlure+natural pyrethrin, grandlure I+natural pyrethrin, grandlure II+natural pyrethrin, grandlure III+natural pyrethrin, grandlure IV+natural pyrethrin, hexalure+natural pyrethrin, ipsdienol+natural pyrethrin, ipsenol+natural pyrethrin, japonilure+natural pyrethrin, lineatin+natural pyrethrin, litlue+natural pyrethrin, looplure+natural pyrethrin, medlure+natural pyrethrin, megatomoic acid+natural pyrethrin, methyl eugenol+natural pyrethrin, muscalure+natural pyrethrin, nerolidol+natural pyrethrin, orfralure+natural pyrethrin, oryctalure+natural pyrethrin, ostramone+natural pyrethrin, rhyncolure+natural pyrethrin, siglure+natural pyrethrin, sordidin+natural pyrethrin, sulcatol+natural pyrethrin, trimedlure+natural pyrethrin, trimedlure A+natural pyrethrin, trimedlure B1+natural pyrethrin, trimedlure B2+natural pyrethrin, trimedlure C+natural pyrethrin, trunc-call+natural pyrethrin, (E)-verbenol+natural pyrethrin, (Z)-verbenol+natural pyrethrin, trans-verbenol+natural pyrethrin, (S)-verbenone+natural pyrethrin.

Combinations of the present component of the group (i) above and the present compound:
2,3,6-TBA (2,3,6-trichlorobenzoic acid)+natural pyrethrin, 2,3,6-TBA-dimethylammonium+natural pyrethrin, 2,3,6-TBA-lithium+natural pyrethrin, 2,3,6-TBA-potassium+natural pyrethrin, 2,3,6-TBA-sodium+natural pyrethrin, 2,4-D+natural pyrethrin, 2,4-D choline salt+natural pyrethrin, 2,4-D-biproamine+natural pyrethrin, 2,4-D-doboxyl+natural pyrethrin, 2,4-D-2-ethylhexyl+natural pyrethrin, 2,4-D-3-butoxypropyl+natural pyrethrin, 2,4-D-ammonium+natural pyrethrin, 2,4-D-butotyl+natural pyrethrin, 2,4-D-butyl+natural pyrethrin, 2,4-D-diethylammonium+natural pyrethrin, 2,4-D-dimethylammonium+natural pyrethrin, 2,4-D-diolamine+natural pyrethrin, 2,4-D-dodecylammonium+natural pyrethrin, 2,4-D-ethyl+natural pyrethrin, 2,4-D-heptylammonium+natural pyrethrin, 2,4-D-isobutyl+natural pyrethrin, 2,4-D-isooctyl+natural pyrethrin, 2,4-D-isopropyl+natural pyrethrin, 2,4-D-isopropylammonium+natural pyrethrin, 2,4-D-lithium+natural pyrethrin, 2,4-D-mepty+natural pyrethrin, 2,4-D-methyl+natural pyrethrin, 2,4-D-octyl+natural pyrethrin, 2,4-D-pentyl+natural pyrethrin, 2,4-D-propyl+natural pyrethrin, 2,4-D-sodium+natural pyrethrin, 2,4-D-tefuryl+natural pyrethrin, 2,4-D-tetradecylammonium+natural pyrethrin, 2,4-D-triethylammonium+natural pyrethrin, 2,4-D-tris(2-hydroxypropyl)ammonium+natural pyrethrin, 2,4-D-trolamine+natural pyrethrin, 2,4-DB+natural pyrethrin, 2,4-DB choline salt+natural pyrethrin, 2,4-DB-biproamine+natural pyrethrin, 2,4-DB-butyl+natural pyrethrin, 2,4-DB-dimethylammonium+natural pyrethrin, 2,4-DB-isoctyl+natural pyrethrin, 2,4-DB-potassium+natural pyrethrin, 2,4-DB-sodium+natural pyrethrin, acetochlor+natural pyrethrin, acifluorfen+natural pyrethrin, acifluorfen-sodium+natural pyrethrin, aclonifen+natural pyrethrin, ACN (2-amino-3-chloronaphthalene-1,4-dione)+natural pyrethrin, alachlor+natural pyrethrin, alloxydim+natural pyrethrin, ametryn+natural pyrethrin, amicarbazone+natural pyrethrin, amidosulfuron+natural pyrethrin, aminocyclopyrachlor+natural pyrethrin, aminocyclopyrachlor-methyl+natural pyrethrin, aminocyclopyrachlor-potassium+natural pyrethrin, aminopyralid+natural pyrethrin, aminopyralid choline salt+natural pyrethrin, aminopyralid-potassium+natural pyrethrin, aminopyralid-tripromine+natural pyrethrin, amiprophos-methyl+natural pyrethrin, amitrole+natural pyrethrin, anilofos+natural pyrethrin, asulam+natural pyrethrin, atrazine+natural pyrethrin, azafenidin+natural pyrethrin, azimsulfuron+natural pyrethrin, beflubutamid+natural pyrethrin, benazolin-ethyl+natural pyrethrin, bencarbazone+natural pyrethrin, benfluralin+natural pyrethrin, benfuresate+natural pyrethrin, bensulfuron+natural pyrethrin, bensulfuron-methyl+natural pyrethrin, bensulide+natural pyrethrin, bentazon+natural pyrethrin, benthiocarb+natural pyrethrin, benzfendizone+natural pyrethrin, benzobicyclon+natural pyrethrin, benzofenap+natural pyrethrin, benzthiazuron+natural pyrethrin, bialaphos+natural pyrethrin, bicyclopyrone+natural pyrethrin, bifenox+natural pyrethrin, bispyribac+natural pyrethrin, bispyribac-sodium+natural pyrethrin, bixlozone+natural pyrethrin, bromacil+natural pyrethrin, bromobutide+natural pyrethrin, bromofenoxim+natural pyrethrin, bromoxynil+natural pyrethrin, bromoxynil-octanoate+natural pyrethrin, butachlor+natural pyrethrin, butafenacil+natural pyrethrin, butamifos+natural pyrethrin, butroxydim+natural pyrethrin, butylate+natural pyrethrin, cafenstrole+natural pyrethrin, carbetamide+natural pyrethrin, carfentrazone+natural pyrethrin, carfentrazone-ethyl+natural pyrethrin, chlomethoxyfen+natural pyrethrin, chloramben+natural pyrethrin, chloridazon+natural pyrethrin, chlorimuron+natural pyrethrin, chlorimuron-ethyl+natural pyrethrin, chlorobromuron+natural pyrethrin, chlorotoluron+natural pyrethrin, chloroxuron+natural pyrethrin, chlorpropham+natural pyrethrin, chlorsulfuron+natural pyrethrin, chlorthal-dimethyl+natural pyrethrin, chlorthiamid+natural pyrethrin, cinidon+natural pyrethrin, cinidon-ethyl+natural pyrethrin, cinmethylin+natural pyrethrin, cinosulfuron+natural pyrethrin, clethodim+natural pyrethrin, clodinafop+natural pyrethrin, clodinafop-propargyl+natural pyrethrin, clomazone+natural pyrethrin, clomeprop+natural pyrethrin, clopyralid+natural pyrethrin, clopyralid choline salt+natural pyrethrin, clopyralid-methyl+natural pyrethrin, clopyralid-olamine+natural pyrethrin, clopyralid-potassium+natural pyrethrin, clopyralid-tris(2-hydroxypropyl)ammonium+natural pyrethrin, cloransulam+natural pyrethrin, cloransulam-methyl+natural pyrethrin, cumyluron+natural pyrethrin, cyanazine+natural pyrethrin, cycloate+natural pyrethrin, cyclopyranil+natural pyrethrin, cyclopyrimorate+natural pyrethrin, cyclosulfamuron+natural pyrethrin, cycloxydim+natural pyrethrin, cyhalofop+natural pyrethrin, cyhalofop-butyl+natural pyrethrin, dalapon+natural pyrethrin, dazomet+natural pyrethrin, desmedipham+natural pyrethrin, desmetryn+natural pyrethrin, di-allate+natural pyrethrin, dicamba+natural pyrethrin, dicamba choline salt+natural pyrethrin, dicamba-biproamine+natural pyrethrin, dicamba-trolamine+natural pyrethrin, dicamba-diglycolamine+natural pyrethrin, dicamba-dimethylammonium+natural pyrethrin, dicamba-diolamine+natural pyrethrin, dicamba-isopropylammonium+natural pyrethrin, dicamba-methyl+natural pyrethrin, dicamba-olamine+natural pyrethrin, dicamba-potassium+natural pyrethrin, dicamba-sodium+natural pyrethrin, dichlobenil+natural pyrethrin, dichlorprop choline salt+natural pyrethrin, dichlorprop-biproamine+natural pyrethrin, dichlorprop-2-ethylhexyl+natural pyrethrin, dichlorprop-butotyl+natural pyrethrin, dichlorprop-dimethylammonium+natural pyrethrin, dichlorprop-ethylammonium+natural pyrethrin, dichlorprop-isoctyl+natural pyrethrin, dichlorprop-methyl+natural pyrethrin, dichlorprop-P+natural pyrethrin, dichlorprop-P choline salt+natural pyrethrin, dichlorprop-P-biproamine+natural pyrethrin, dichlorprop-P-etexyl+natural pyrethrin, dichlorprop-P-dimethylammonium+natural pyrethrin, dichlorprop-potassium+natural pyrethrin, dichlorprop-sodium+natural pyrethrin, diclofop+natural pyrethrin, diclofop-methyl+natural pyrethrin, diclosulam+natural pyrethrin, difenoxuron+natural pyrethrin, difenzoquat+natural pyrethrin, difenzoquat metilsulfate+natural pyrethrin, diflufenican+natural pyrethrin, diflufenzopyr+natural pyrethrin, diflufenzopyr-sodium+natural pyrethrin, dimefuron+natural pyrethrin, dimepiperate+natural pyrethrin, dimesulfazet+natural pyrethrin, dimethachlor+natural pyrethrin, dimethametryn+natural pyrethrin, dimethenamid+natural pyrethrin, dimethenamid-P+natural pyrethrin, dinitramine+natural pyrethrin, dinoseb+natural pyrethrin, dinoterb+natural pyrethrin, diphenamid+natural pyrethrin, diquat-dibromide+natural pyrethrin, DSMA (disodium methylarsonate)+natural pyrethrin, dithiopyr+natural pyrethrin, diuron+natural pyrethrin, DNOC (2-methyl-4,6-dinitrophenol)+natural pyrethrin, epyrifenacil+natural pyrethrin, esprocarb+natural pyrethrin, ethalfluralin+natural pyrethrin, ethametsulfuron+natural pyrethrin, ethametsulfuron-methyl+natural pyrethrin, ethidimuron+natural pyrethrin, ethofumesate+natural pyrethrin, ethoxyfen-ethyl+natural pyrethrin, ethoxysulfuron+natural pyrethrin, etobenzanid+natural pyrethrin, fenoxaprop+natural pyrethrin, fenoxaprop-ethyl+natural pyrethrin, fenoxaprop-P+natural pyrethrin, fenoxaprop-P-ethyl+natural pyrethrin, fenoxasulfone+natural pyrethrin, fenquinotrione+natural pyrethrin, fentrazamide+natural pyrethrin, fenuron+natural pyrethrin, flamprop-M+natural pyrethrin, flazasulfuron+natural pyrethrin, florasulam+natural pyrethrin, florpyrauxifen+natural pyrethrin, florpyrauxifen-benzyl+natural pyrethrin, fluazifop+natural pyrethrin, fluazifop-butyl+natural pyrethrin, fluazifop-P+natural pyrethrin, fluazifop-P-butyl+natural pyrethrin, fluazolate+natural pyrethrin, flucarbazone+natural pyrethrin, flucarbazone-sodium+natural pyrethrin, flucetosulfuron+natural pyrethrin, flufenacet+natural pyrethrin, flufenpyr+natural pyrethrin, flufenpyr-ethyl+natural pyrethrin, flumetsulam+natural pyrethrin, flumetsulam+natural pyrethrin, flumiclorac+natural pyrethrin, flumiclorac-pentyl+natural pyrethrin, flumioxazin+natural pyrethrin, fluometuron+natural pyrethrin, fluoroglycofen-ethyl+natural pyrethrin, flupoxam+natural pyrethrin, flupropanate+natural pyrethrin, flupyrsulfuron+natural pyrethrin, flupyrsulfuron-methyl-sodium+natural pyrethrin, flurenol+natural pyrethrin, fluridone+natural pyrethrin, flurochloridone+natural pyrethrin, fluroxypyr+natural pyrethrin, fluroxypyr-butometyl+natural pyrethrin, fluroxypyr-meptyl+natural pyrethrin, flurtamone+natural pyrethrin, fluthiacet+natural pyrethrin, fluthiacet-methyl+natural pyrethrin, fomesafen+natural pyrethrin, fomesafen-sodium+natural pyrethrin, foramsulfuron+natural pyrethrin, fosamine+natural pyrethrin, glufosinate+natural pyrethrin, glufosinate-ammonium+natural pyrethrin, glufosinate-P+natural pyrethrin, glufosinate-P-ammonium+natural pyrethrin, glufosinate-P-sodium+natural pyrethrin, glyphosate+natural pyrethrin, glyphosate choline salt+natural pyrethrin, glyphosate-isopropylammonium+natural pyrethrin, glyphosate-biproamine+natural pyrethrin, glyphosate-ammonium+natural pyrethrin, glyphosate-diammonium+natural pyrethrin, glyphosate-potassium+natural pyrethrin, glyphosate-sodium+natural pyrethrin, glyphosate-trimesium+natural pyrethrin, halauxifen+natural pyrethrin, halauxifen-methyl+natural pyrethrin, halosafen+natural pyrethrin, halosulfuron+natural pyrethrin, halosulfuron-methyl+natural pyrethrin, haloxyfop+natural pyrethrin, haloxyfop-etotyl+natural pyrethrin, haloxyfop-methyl+natural pyrethrin, haloxyfop-P+natural pyrethrin, haloxyfop-P-etotyl+natural pyrethrin, haloxyfop-P-methyl+natural pyrethrin, hexazinone+natural pyrethrin, imazamethabenz+natural pyrethrin, imazamethabenz-methyl+natural pyrethrin, imazamox+natural pyrethrin, imazamox-ammonium+natural pyrethrin, imazapic+natural pyrethrin, imazapic-ammonium+natural pyrethrin, imazapyr+natural pyrethrin, imazapyr-isopropylammonium+natural pyrethrin, imazaquin+natural pyrethrin, imazaquin-ammonium+natural pyrethrin, imazethapyr+natural pyrethrin, imazethapyr-ammonium+natural pyrethrin, imazosulfuron+natural pyrethrin, indanofan+natural pyrethrin, indaziflam+natural pyrethrin, iodosulfuron+natural pyrethrin, iodosulfuron-methyl-sodium+natural pyrethrin, iofensulfuron+natural pyrethrin, iofensulfuron-sodium+natural pyrethrin, ioxynil+natural pyrethrin, ioxynil-octanoate+natural pyrethrin, ipfencarbazone+natural pyrethrin, isoproturon+natural pyrethrin, isouron+natural pyrethrin, isoxaben+natural pyrethrin, isoxachlortole+natural pyrethrin, isoxaflutole+natural pyrethrin, lactofen+natural pyrethrin, lenacil+natural pyrethrin, linuron+natural pyrethrin, maleic hydrazide+natural pyrethrin, MCPA choline salt+natural pyrethrin, MCPA-biproamine+natural pyrethrin, MCPA-etexyl+natural pyrethrin, MCPA-butotyl+natural pyrethrin, MCPA-butyl+natural pyrethrin, MCPA-dimethylammonium+natural pyrethrin, MCPA-diolamine+natural pyrethrin, MCPA-ethyl+natural pyrethrin, MCPA-isobutyl+natural pyrethrin, MCPA-isoctyl+natural pyrethrin, MCPA-isopropyl+natural pyrethrin, MCPA-methyl+natural pyrethrin, MCPA-olamine+natural pyrethrin, MCPA-sodium+natural pyrethrin, MCPA-trolamine+natural pyrethrin, MCPB (4-(4-chloro-2-methylphenoxy)butanoic acid)+natural pyrethrin, MCPB choline salt+natural pyrethrin, MCPB-biproamine+natural pyrethrin, MCPB-ethyl+natural pyrethrin, MCPB-methyl+natural pyrethrin, MCPB-sodium+natural pyrethrin, mecoprop choline salt+natural pyrethrin, mecoprop-biproamine+natural pyrethrin, mecoprop-2-ethylhexyl+natural pyrethrin, mecoprop-dimethylammonium+natural pyrethrin, mecoprop-diolamine+natural pyrethrin, mecoprop-ethadyl+natural pyrethrin, mecoprop-isoctyl+natural pyrethrin, mecoprop-methyl+natural pyrethrin, mecoprop-potassium+natural pyrethrin, mecoprop-sodium+natural pyrethrin, mecoprop-trolamine+natural pyrethrin, mecoprop-P+natural pyrethrin, mecoprop-P choline salt+natural pyrethrin, mecoprop-P-2-ethylhexyl+natural pyrethrin, mecoprop-P-dimethylammonium+natural pyrethrin, mecoprop-P-isobutyl+natural pyrethrin, mecoprop-P-potassium+natural pyrethrin, mefenacet+natural pyrethrin, mesosulfuron+natural pyrethrin, mesosulfuron-methyl+natural pyrethrin, mesotrione+natural pyrethrin, metam+natural pyrethrin, metamifop+natural pyrethrin, metamitron+natural pyrethrin, metazachlor+natural pyrethrin, metazosulfuron+natural pyrethrin, methabenzthiazuron+natural pyrethrin, methiozolin+natural pyrethrin, methyldymron+natural pyrethrin, metobromuron+natural pyrethrin, metolachlor+natural pyrethrin, metosulam+natural pyrethrin, metoxuron+natural pyrethrin, metribuzin+natural pyrethrin, metsulfuron+natural pyrethrin, metsulfuron-methyl+natural pyrethrin, molinate+natural pyrethrin, monolinuron+natural pyrethrin, naproanilide+natural pyrethrin, napropamide+natural pyrethrin, napropamide-M+natural pyrethrin, naptalam+natural pyrethrin, neburon+natural pyrethrin, nicosulfuron+natural pyrethrin, norflurazon+natural pyrethrin, oleic acid+natural pyrethrin, orbencarb+natural pyrethrin, orthosulfamuron+natural pyrethrin, oryzalin+natural pyrethrin, oxadiargyl+natural pyrethrin, oxadiazon+natural pyrethrin, oxasulfuron+natural pyrethrin, oxaziclomefone+natural pyrethrin, oxyfluorfen+natural pyrethrin, paraquat+natural pyrethrin, paraquat-dichloride+natural pyrethrin, pebulate+natural pyrethrin, pelargonic acid+natural pyrethrin, pendimethalin+natural pyrethrin, penoxsulam+natural pyrethrin, pentanochlor+natural pyrethrin, pentoxazone+natural pyrethrin, pethoxamid+natural pyrethrin, phenisopham+natural pyrethrin, phenmedipham+natural pyrethrin, picloram+natural pyrethrin, picolinafen+natural pyrethrin, pinoxaden+natural pyrethrin, piperophos+natural pyrethrin, pretilachlor+natural pyrethrin, primisulfuron+natural pyrethrin, primisulfuron-methyl+natural pyrethrin, prodiamine+natural pyrethrin, profluazol+natural pyrethrin, profoxydim+natural pyrethrin, prometon+natural pyrethrin, prometryn+natural pyrethrin, propachlor+natural pyrethrin, propanil+natural pyrethrin, propaquizafop+natural pyrethrin, propazine+natural pyrethrin, propham+natural pyrethrin, propisochlor+natural pyrethrin, propoxycarbazone+natural pyrethrin, propoxycarbazone-sodium+natural pyrethrin, propyrisulfuron+natural pyrethrin, propyzamide+natural pyrethrin, prosulfocarb+natural pyrethrin, prosulfuron+natural pyrethrin, pyraclonil+natural pyrethrin, pyrasulfotole+natural pyrethrin, pyrazolynate+natural pyrethrin, pyrazosulfuron+natural pyrethrin, pyrazosulfuron-ethyl+natural pyrethrin, pyrazoxyfen+natural pyrethrin, pyribenzoxim+natural pyrethrin, pyributicarb+natural pyrethrin, pyridafol+natural pyrethrin, pyridate+natural pyrethrin, pyriftalid+natural pyrethrin, pyriminobac+natural pyrethrin, pyriminobac-methyl+natural pyrethrin, pyrimisulfan+natural pyrethrin, pyrithiobac+natural pyrethrin, pyrithiobac-sodium+natural pyrethrin, pyroxasulfone+natural pyrethrin, pyroxsulam+natural pyrethrin, quinclorac+natural pyrethrin, quinmerac+natural pyrethrin, quizalofop+natural pyrethrin, quizalofop-ethyl+natural pyrethrin, quizalofop-tefuryl+natural pyrethrin, quizalofop-P+natural pyrethrin, quizalofop-P-ethyl+natural pyrethrin, quizalofop-P-tefuryl+natural pyrethrin, rimsulfuron+natural pyrethrin, saflufenacil+natural pyrethrin, sethoxydim+natural pyrethrin, EPTC (S-ethyl N,N-dipropylcarbamothioate)+natural pyrethrin, siduron+natural pyrethrin, simazine+natural pyrethrin, simetryn+natural pyrethrin, S-metolachlor+natural pyrethrin, MSMA (sodium hydrogen methylarsonate)+natural pyrethrin, sulcotrione+natural pyrethrin, sulfentrazone+natural pyrethrin, sulfometuron+natural pyrethrin, sulfometuron-methyl+natural pyrethrin, sulfosulfuron+natural pyrethrin, swep+natural pyrethrin, TCA (2,2,2-trichloroacetic acid)+natural pyrethrin, TCA-ammonium+natural pyrethrin, TCA-calcium+natural pyrethrin, TCA-ethadyl+natural pyrethrin, TCA-magnesium+natural pyrethrin, TCA-sodium+natural pyrethrin, tebutam+natural pyrethrin, tebuthiuron+natural pyrethrin, tefuryltrione+natural pyrethrin, tembotrione+natural pyrethrin, tepraloxydim+natural pyrethrin, terbacil+natural pyrethrin, terbumeton+natural pyrethrin, terbuthylazine+natural pyrethrin, terbutryn+natural pyrethrin, tetflupyrolimet+natural pyrethrin, thaxtomin A+natural pyrethrin, thenylchlor+natural pyrethrin, thiazopyr+natural pyrethrin, thidiazimin+natural pyrethrin, thiencarbazone+natural pyrethrin, thiencarbazone-methyl+natural pyrethrin, thifensulfuron+natural pyrethrin, thifensulfuron-methyl+natural pyrethrin, tiafenacil+natural pyrethrin, tiocarbazil+natural pyrethrin, tolpyralate+natural pyrethrin, topramezone+natural pyrethrin, tralkoxydim+natural pyrethrin, triafamone+natural pyrethrin, tri-allate+natural pyrethrin, triasulfuron+natural pyrethrin, triaziflam+natural pyrethrin, tribenuron+natural pyrethrin, tribenuron-methyl+natural pyrethrin, triclopyr+natural pyrethrin, triclopyr-butotyl+natural pyrethrin, triclopyr-ethyl+natural pyrethrin, triclopyr-triethylammonium+natural pyrethrin, tridiphane+natural pyrethrin, trietazine+natural pyrethrin, trifloxysulfuron+natural pyrethrin, trifloxysulfuron-sodium+natural pyrethrin, trifludimoxazin+natural pyrethrin, trifluralin+natural pyrethrin, triflusulfuron+natural pyrethrin, triflusulfuron-methyl+natural pyrethrin, tritosulfuron+natural pyrethrin, vernolate+natural pyrethrin, 4-(4-fluorophenyl)-6-[(2-hydroxy-6-oxo-1-cyclohexen-1-yl)carbonyl]-2-methyl-1,2,4-triazine-3,5(2H,4H)-dione+natural pyrethrin, 2-chloro-N-(1-methyl-1H-tetrazol-5-yl)-3-(methylthio)-4-(trifluoromethyl)benzamide+natural pyrethrin, 2-methyl-N-(5-methyl-1,3,4-oxadiazol-2-yl)-3-(methanesulfonyl)-4-(trifluoromethyl)benzamide+natural pyrethrin, 4-amino-3-chloro-5-fluoro-6-(7-fluoro-1H-indol-6-yl)pyridine-2-carboxylic acid+natural pyrethrin, cyanomethyl 4-amino-3-chloro-5-fluoro-6-(7-fluoro-1H-indol-6-yl)pyridine-2-carboxylate (2251111-18-7)+natural pyrethrin, methyl (2R,4R)-4-({[(5S)-3-(3,5-difluorophenyl)-5-vinyl-4,5-dihydroisoxazol-5-yl]carbonyl}amino)tetrahydrofurane-2-carboxylate+natural pyrethrin, methyl (2S,4S)-4-({[(5R)-3-(3,5-difluorophenyl)-5-vinyl-4,5-dihydroisoxazol-5-yl]carbonyl}amino)tetrahydrofurane-2-carboxylate+natural pyrethrin, 3-[(isopropylsulfonyl)methyl]-N-(5-methyl-1,3,4-oxadiazol-2-yl)-5-(trifluoromethyl)-1,2,4-triazolo[4,3-a]pyridine-8-carboxamide (1994348-72-9)+natural pyrethrin, 1-{2-chloro-6-[(5-chloropyrimidin-2-yl)oxy]phenyl}-4,4,4-trifluorobutan-1-one (2052297-97-7)+natural pyrethrin, 5-chloro-2-{3-chloro-2-[5-(difluoromethyl)isoxazol-3-yl]phenoxy}pyrimidine (1801862-60-1)+natural pyrethrin.

Combinations of the present component of the group (j) above and the present compound:
Abbreviata caucasica+natural pyrethrin, Acuaria spp.+natural pyrethrin, Agamermis decaudata+natural pyrethrin, Agrobacterium radiobacter strain K1026+natural pyrethrin, Agrobacterium radiobacter strain K84+natural pyrethrin, Agrobacterium vitis strain VAR03-1+natural pyrethrin, Allantonema spp.+natural pyrethrin, Alternaria destruens strain 59+natural pyrethrin, Alternaria destruens+natural pyrethrin, Ampelomyces quisqualis strain AQ10+natural pyrethrin, Amphimermis spp.+natural pyrethrin, Arthrobotrys dactyloides+natural pyrethrin, Arthrobotrys superba+natural pyrethrin, Aschersonia aleyrodes+natural pyrethrin, Aspergillus flavus strain AF36+natural pyrethrin, Aspergillus flavus strain NRRL21882+natural pyrethrin, Aureobasidium pullulans strain DSM14940+natural pyrethrin, Aureobasidium pullulans strain DSM14941+natural pyrethrin, Azopirillum+natural pyrethrin, Azorhizobiuma caulinodans strain ZB-SK-5+natural pyrethrin, Azotobacter chroococcum strain H23+natural pyrethrin, Azotobacter chroocuccum+natural pyrethrin, Azotobacter cyst+natural pyrethrin, Azotobacter vinelandii strain ATCC12837+natural pyrethrin, Azotobacter+natural pyrethrin, Bacillus acidocaldarius+natural pyrethrin, Bacillus acidoterrestris+natural pyrethrin, Bacillus Albolactis+natural pyrethrin, Bacillus alcalophilus+natural pyrethrin, Bacillus alvei+natural pyrethrin, Bacillus aminoglucosidicus+natural pyrethrin, Bacillus aminovorans+natural pyrethrin, Bacillus amyloliquefaciens (Aveo (Trade Mark) EZ Nematicide)+natural pyrethrin, Bacillus amyloliquefaciens strain AT332+natural pyrethrin, Bacillus amyloliquefaciens strain B3+natural pyrethrin, Bacillus amyloliquefaciens strain D747+natural pyrethrin, Bacillus amyloliquefaciens strain DB101+natural pyrethrin, Bacillus amyloliquefaciens strain DB102+natural pyrethrin, Bacillus amyloliquefaciens strain FZB24+natural pyrethrin, Bacillus amyloliquefaciens strain FZB42+natural pyrethrin, Bacillus amyloliquefaciens strain GB03+natural pyrethrin, Bacillus amyloliquefaciens strain IN937a+natural pyrethrin, Bacillus amyloliquefaciens strain MBI600+natural pyrethrin, Bacillus amyloliquefaciens strain QST713+natural pyrethrin, Bacillus amyloliquefaciens isolate strain B246+natural pyrethrin, Bacillus amyloliquefaciens strain F727+natural pyrethrin, Bacillus amyloliquefaciens subsp. Plantarum strain D747+natural pyrethrin, Bacillus amylolyticus+natural pyrethrin, Bacillus aneurinolyticus+natural pyrethrin, Bacillus agri+natural pyrethrin, Bacillus atrophaeus+natural pyrethrin, Bacillus azotoformans+natural pyrethrin, Bacillus badius+natural pyrethrin, Bacillus cereus strain BP01+natural pyrethrin, Bacillus cereus CNCM strain I-1562+natural pyrethrin, Bacillus chitinosporus strain AQ746+natural pyrethrin, Bacillus chitinosporus strain CM-1+natural pyrethrin, Bacillus circulans+natural pyrethrin, Bacillus coagulans strain TQ33+natural pyrethrin, Bacillus fastidiosus+natural pyrethrin, Bacillus firmus strain GB-126+natural pyrethrin, Bacillus firmus strain I-1582+natural pyrethrin, Bacillus lacticola+natural pyrethrin, Bacillus lactimorbus+natural pyrethrin, Bacillus lactis+natural pyrethrin, Bacillus lautus+natural pyrethrin, Bacillus Lentimorbus+natural pyrethrin, Bacillus lentus+natural pyrethrin, Bacillus licheniformis strain FMCH001+natural pyrethrin, Bacillus licheniformis strain HB-2+natural pyrethrin, Bacillus licheniformis strain SB3086+natural pyrethrin, Bacillus maroccanus+natural pyrethrin, Bacillus medusa+natural pyrethrin, Bacillus megaterium strain YFM3.25+natural pyrethrin, Bacillus methylotrophicus strain BAC-9912+natural pyrethrin, Bacillus metiens+natural pyrethrin, Bacillus mojavensis strain SR11+natural pyrethrin, Bacillus mycoides strain AQ726+natural pyrethrin, Bacillus mycoides isolate J+natural pyrethrin, Bacillus nematocida+natural pyrethrin, Bacillus nigrificans+natural pyrethrin, Bacillus nigrum+natural pyrethrin, Bacillus popilliae+natural pyrethrin, Bacillus psychrosaccharolyticus+natural pyrethrin, Bacillus pumilus strain AQ717+natural pyrethrin, Bacillus pumilus strain BUF-33+natural pyrethrin, Bacillus pumilus strain GB34+natural pyrethrin, Bacillus pumilus strain QST2808+natural pyrethrin, Bacillus siamensis+natural pyrethrin, Bacillus simplex strain CGF2856+natural pyrethrin, Bacillus smithii+natural pyrethrin, Bacillus sp. strain AQ175+natural pyrethrin, Bacillus sp. strain AQ177+natural pyrethrin, Bacillus sp. strain AQ178+natural pyrethrin, Bacillus sphaericus strain 2362+natural pyrethrin, Bacillus sphaericus strain ABTS1743+natural pyrethrin, Bacillus sphaericus Serotype strain H5a5b+natural pyrethrin, Bacillus subtilis strain AQ153+natural pyrethrin, Bacillus subtilis strain AQ743+natural pyrethrin, Bacillus subtilis strain C-3102+natural pyrethrin, Bacillus subtilis strain D747+natural pyrethrin, Bacillus subtilis strain DB101+natural pyrethrin, Bacillus subtilis strain FMCH002+natural pyrethrin, Bacillus subtilis strain FZB24+natural pyrethrin, Bacillus subtilis strain GB03+natural pyrethrin, Bacillus subtilis strain HA10404+natural pyrethrin, Bacillus subtilis strain IAB/BSO3+natural pyrethrin, Bacillus subtilis strain MBI600+natural pyrethrin, Bacillus subtilis strain QST30002/AQ30002+natural pyrethrin, Bacillus subtilis strain QST30004/AQ30004+natural pyrethrin, Bacillus subtilis strain QST713+natural pyrethrin, Bacillus subtilis strain QST714+natural pyrethrin, Bacillus subtilis var. Amyloliquefaciens strain FZB24+natural pyrethrin, Bacillus subtilis strain Y1336+natural pyrethrin, Bacillus subtillis subsp. natto+natural pyrethrin, Bacillus subtilis strain RT1477+natural pyrethrin, Bacillus tequilensis strain NII-0943+natural pyrethrin, Bacillus thuringiensis strain AQ52+natural pyrethrin, Bacillus thuringiensis strain BD #32+natural pyrethrin, Bacillus thuringiensis strain CR-371+natural pyrethrin, Bacillus thuringiensis strain EX297512+natural pyrethrin, Bacillus thuringiensis subsp. Aizawai strain ABTS-1857+natural pyrethrin, Bacillus thuringiensis subsp. Aizawai strain GC-91+natural pyrethrin, Bacillus thuringiensis subsp. Aizawai Serotype H-7+natural pyrethrin, Bacillus thuringiensis subsp. Kurstaki strain ABTS351+natural pyrethrin, Bacillus thuringiensis subsp. Kurstaki strain BMP123+natural pyrethrin, Bacillus thuringiensis subsp. Kurstaki strain EG234+natural pyrethrin, Bacillus thuringiensis subsp. Kurstaki strain EG7841+natural pyrethrin, Bacillus thuringiensis subsp. Kurstaki strain EVB113-19+natural pyrethrin, Bacillus thuringiensis subsp. Kurstaki strain F810+natural pyrethrin, Bacillus thuringiensis subsp. Kurstaki strain HD-1+natural pyrethrin, Bacillus thuringiensis subsp. Kurstaki strain PB54+natural pyrethrin, Bacillus thuringiensis subsp. Kurstaki strain SA-11+natural pyrethrin, Bacillus thuringiensis subsp. Kurstaki strain SA-12+natural pyrethrin, Bacillus thuringiensis subsp. morrisoni+natural pyrethrin, Bacillus thuringiensis subsp. Tenebriosis strain NB 176+natural pyrethrin, Bacillus thuringiensis subsp. Thuringiensis strain MPPLOO2+natural pyrethrin, Bacillus thuringiensis subsp. var. colmeri+natural pyrethrin, Bacillus thuringiensis subsp. var. darmstadiensis strain 24-91+natural pyrethrin, Bacillus thuringiensis subsp. var. dendrolimus+natural pyrethrin, Bacillus thuringiensis subsp. var. galleriae+natural pyrethrin, Bacillus thuringiensis subsp. israelensis strain BMP144+natural pyrethrin, Bacillus thuringiensis subsp. israelensis strain AM65-52+natural pyrethrin, Bacillus thuringiensis subsp. var. japonensis strain buibui+natural pyrethrin, Bacillus thuringiensis subsp. var. aegypti+natural pyrethrin, Bacillus thuringiensis var. 7216+natural pyrethrin, Bacillus thuringiensis var. sandiego strain M-7+natural pyrethrin, Bacillus thuringiensis var. T36+natural pyrethrin, BT crop protein Cry1Ab+natural pyrethrin, BT crop protein Cry1Ac+natural pyrethrin, BT crop protein Cry1Fa+natural pyrethrin, BT crop protein Cry1A.105+natural pyrethrin, BT crop protein Cry2Ab+natural pyrethrin, BT crop protein Vip3A+natural pyrethrin, BT crop protein Cry3A+natural pyrethrin, BT crop protein Cry3Ab+natural pyrethrin, BT crop protein Cry3Bb+natural pyrethrin, BT crop protein Cry34Ab1/Cry35Ab1+natural pyrethrin, Bacillus uniflagellate+natural pyrethrin, Bacillus uniflagellatus+natural pyrethrin, Bacillus velezensis+natural pyrethrin, Bacillus velezensis strain RTI301+natural pyrethrin, bacteria spp.+natural pyrethrin, bacteriophage of Clavibacter michiganesis+natural pyrethrin, Bacteriophage active against Xanthomonas campestris pv. vesicatoria and Pseudomonas syringae pv. tomato+natural pyrethrin, Bacteriophage active against Clavibacter michiganensis subsp. michiganensis+natural pyrethrin, Beauveria bassiana strain ANT-03+natural pyrethrin, Beauveria bassiana strain ATCC74040+natural pyrethrin, Beauveria bassiana strain GHA+natural pyrethrin, Beauveria bassiana strain PPRI 5339+natural pyrethrin, Beauveria bassiana strain IM11389521+natural pyrethrin, Beauveria brongniartii+natural pyrethrin, Beddingia siridicola+natural pyrethrin, Bovienema spp.+natural pyrethrin, Brevibacillus brevis strain 2904+natural pyrethrin, Brevibacillus brevis strain SS86-3+natural pyrethrin, Brevibacillus brevis strain SS86-4+natural pyrethrin, Brevibacillus brevis strain SS86-5+natural pyrethrin, Brevibacillus laterosporus strain ATCC64+natural pyrethrin, Brevibacillus laterosporus strain BPM3+natural pyrethrin, Brevibacillus laterosporus strain G4+natural pyrethrin, Brevibacillus laterosporus strain NCIMB 41419+natural pyrethrin, Brevibacillus laterosporus strain NRS1111+natural pyrethrin, Brevibacillus laterosporus strain NRS1645+natural pyrethrin, Burkholderia cepacia type Wisconsin strain J82+natural pyrethrin, Burkholderia cepacia type Wisconsin strain M54+natural pyrethrin, Burkholderia cepacia+natural pyrethrin, Burkholderia gladii strain BA-7+natural pyrethrin, Burkholderia rinojensis strain A396+natural pyrethrin, Cameronia spp.+natural pyrethrin, Canadian thistle fungus+natural pyrethrin, Candida oleophila strain 0+natural pyrethrin, Candida saitoana+natural pyrethrin, Candida spp.+natural pyrethrin, Chaetomium cupreum+natural pyrethrin, Chitwoodiella ovofilamenta+natural pyrethrin, Chromobacterium subtsugae strain PRAA4-1T+natural pyrethrin, Cladosporium cladosporioides strain H39+natural pyrethrin, Clonostachys rosea+natural pyrethrin, Conidiobolus obscurus+natural pyrethrin, Coniothyrium minitans strain CGMCC8325+natural pyrethrin, Coniothyrium minitans strain CON/M/91-08+natural pyrethrin, Contortylenchus spp.+natural pyrethrin, cryptococcus albidus+natural pyrethrin, Culicimermis spp.+natural pyrethrin, Dactyllela ellipsospora+natural pyrethrin, Dectylaria thaumasia+natural pyrethrin, Delftia acidovorans strain RAY209+natural pyrethrin, Dilophosphora alopecuri+natural pyrethrin, Diplotriaena spp.+natural pyrethrin, Empidomermis spp.+natural pyrethrin, Entomophthora virulenta+natural pyrethrin, Erwinia carotovora subsp. carotovora strain CGE234M403+natural pyrethrin, Filipjevimermis leipsandra+natural pyrethrin, Fusarium oxysporum strain Fo47+natural pyrethrin, Fusarium oxysporum strain RS-21+natural pyrethrin, Fusarium oxysporum strain RS-25+natural pyrethrin, Fusariumproliferatum+natural pyrethrin, Gastromermis spp.+natural pyrethrin, Gliocladium catenulatum strain J1446+natural pyrethrin, Gluconacetobacter diazotrophicus+natural pyrethrin, Gongylonema spp.+natural pyrethrin, Gynopoecilia pseudovipara+natural pyrethrin, Harpin protein+natural pyrethrin, Heterorhabditis bacteriophora+natural pyrethrin, Heterorhabditis baujardi+natural pyrethrin, Heterorhabditis heliothidis+natural pyrethrin, Heterorhabditis indica+natural pyrethrin, Heterorhabditis marelatus+natural pyrethrin, Heterorhabditis megidis+natural pyrethrin, Heterorhabditis zealandica+natural pyrethrin, Hexamermis spp.+natural pyrethrin, Hirsutella minnesotensis+natural pyrethrin, Hirsutella rsiliensis+natural pyrethrin, Hirsutella thompsonii+natural pyrethrin, Hydromermis spp.+natural pyrethrin, Isaria fumosorosea+natural pyrethrin, Isomermis spp.+natural pyrethrin, Lactobacillus acidophilus+natural pyrethrin, Lactobacillus brevis+natural pyrethrin, Lactobacillus plantarum+natural pyrethrin, Lactobacillus spp.+natural pyrethrin, Lagenidium giganteum+natural pyrethrin, Lecanicillium lecanii KV01+natural pyrethrin, Lecanicillium lecanii conidia of strain DAOM198499+natural pyrethrin, Lecanicillium lecanii conidia of strain DAOM216596+natural pyrethrin, Lecanicillium muscarium (Formerly, Verticillium lecanii) strain Ve6)+natural pyrethrin, Limnomermis spp.+natural pyrethrin, Lysobacter antibioticus strain 13-1+natural pyrethrin, Lysobacter enzymogenes strain C3+natural pyrethrin, Maupasina weissi+natural pyrethrin, Mermis nigrescens+natural pyrethrin, Mesomermis spp.+natural pyrethrin, Metarhizium anisopliae strain F52+natural pyrethrin, Metarhizium anisopliae var. acridum+natural pyrethrin, Metarhizium anisopliae var. anisopliae BIPESCO 5/F52+natural pyrethrin, Metarhizium flavoviride+natural pyrethrin, metschnikowia dimerum+natural pyrethrin, Metschnikowia fructicola strain NRRLY-30752+natural pyrethrin, Microsphaeropsis ochracea+natural pyrethrin, Monacrosporium phymatopagum+natural pyrethrin, Mucor hiemalis+natural pyrethrin, Muscodor albus strain 620+natural pyrethrin, Muscodor albus strain QST 20799+natural pyrethrin, Muscodor albus strain SA13+natural pyrethrin, Muscodor roseus strain A3-5+natural pyrethrin, Myrothecium verrucaria strain AARC-0255+natural pyrethrin, Neomesomermis spp.+natural pyrethrin, Neoparasitylenchus rugulosi+natural pyrethrin, Nomuraea rileyi strain CG128+natural pyrethrin, Nomuraea rileyi strain GU87401+natural pyrethrin, Nomuraea rileyi strain SA86101+natural pyrethrin, Nomuraea rileyi strain SR86151+natural pyrethrin, Nomuraea rileyi strain VA9101+natural pyrethrin, Nosema locustae+natural pyrethrin, Octomyomermis spp.+natural pyrethrin, Ophiostoma piliferum strain D97+natural pyrethrin, Paecilomyces fumosoroseus Apopka strain 97 (Now known as Isaria fumosorosea Apopka strain 97)+natural pyrethrin, Paecilomyces lilacinus strain 251+natural pyrethrin, Paecilomyces tenuipes strain T1+natural pyrethrin, Paecilomyces variotii strain Q-09+natural pyrethrin, Paenibacillus alvei strain 2771+natural pyrethrin, Paenibacillus alvei strain 46C3+natural pyrethrin, Paenibacillus alvei strain 1112E+natural pyrethrin, Paenibacillus alvei strain III3DT-1A+natural pyrethrin, Paenibacillus alvei strain T36+natural pyrethrin, Paenibacillus macerans+natural pyrethrin, Paenibacillus polymyxa strain AC-1+natural pyrethrin, Paenibacillus polymyxa strain BS-0105+natural pyrethrin, Paenibacillus popilliae+natural pyrethrin, Pandora delphacis+natural pyrethrin, Pantoea agglomerans strain E325+natural pyrethrin, Pantoea vagans strain C9-1+natural pyrethrin, Parasitaphelenchus spp.+natural pyrethrin, Parasitorhabditis spp.+natural pyrethrin, Parasitylenchus spp.+natural pyrethrin, Pasteuria nishizawae strain Pn1+natural pyrethrin, Pasteuria penetrans+natural pyrethrin, Pasteuria ramose+natural pyrethrin, Pasteuria usgae+natural pyrethrin, Pectobacterium carotovorum+natural pyrethrin, Penicillium bilaiae strain ATCC22348+natural pyrethrin, Penicillium citrinum strain VFI-51+natural pyrethrin, Penicillium vermiculatum+natural pyrethrin, Perutilimermis culicis+natural pyrethrin, Pasteuria thoynei+natural pyrethrin, Phasmarhabditis hermaphrodita+natural pyrethrin, phlebiopsis gigantea strain VRA1992+natural pyrethrin, Physaloptera spp.+natural pyrethrin, phytophthora palmivora+natural pyrethrin, Pichia anomala strain WRL-076+natural pyrethrin, pichia guilliermondii strain Z1+natural pyrethrin, pichia guilliermondii strain Z8+natural pyrethrin, Pochonia chlamydosporia isolate strain PC10+natural pyrethrin, Pochonia chlamydosporia+natural pyrethrin, Protrellatus spp.+natural pyrethrin, Pseudomonas aeruginosa strain PN1+natural pyrethrin, Pseudomonas aeruginosa strain WS-1+natural pyrethrin, Pseudomonas aureofaciens strain TX-1+natural pyrethrin, Pseudomonas cepacia type Wisconsin strain J82+natural pyrethrin, Pseudomonas cepacia type Wisconsin strain M54+natural pyrethrin, Pseudomonas chlororaphis strain 63-28+natural pyrethrin, Pseudomonas chlororaphis strain AFS009+natural pyrethrin, Pseudomonas chlororaphis strain MA342+natural pyrethrin, Pseudomonas fluorescens strain 1629RS+natural pyrethrin, Pseudomonas fluorescens strain A506+natural pyrethrin, Pseudomonas fluorescens strain CL145A+natural pyrethrin, Pseudomonas fluorescens strain G7090+natural pyrethrin, Pseudomonas fluorescens biover B strain XJ3+natural pyrethrin, Pseudomonas fluorescens biover B strain XS18+natural pyrethrin, Pseudomonas fluorescens biover A strain LRS12+natural pyrethrin, Pseudomonas proradix+natural pyrethrin, Pseudomonas putida+natural pyrethrin, Pseudomonas reactans+natural pyrethrin, Pseudomonas resinovorans+natural pyrethrin, Pseudomonas rhodesiae strain HAI-0804+natural pyrethrin, Pseudomonas sp. strain CAB-02+natural pyrethrin, Pseudomonas syringae strain 742RS+natural pyrethrin, Pseudomonas syringae strain MA-4+natural pyrethrin, Pseudozyma flocculosa strain PF-A22UL+natural pyrethrin, Pterygodermatites spp.+natural pyrethrin, Puccinia thlaspeos strain woad+natural pyrethrin, Purpureocillium lilacinum+natural pyrethrin, Pythium oligandrum strain DV74+natural pyrethrin, Pythium oligandrum strain M1+natural pyrethrin, Rhodococcus globerulus strain AQ719+natural pyrethrin, Romanomermis spp.+natural pyrethrin, Saccharomyces cerevisiae strain LASO2+natural pyrethrin, Saccharomyces cerevisiae strain DDSF623+natural pyrethrin, sclerotinia minor strain IMI34414+natural pyrethrin, Serratia entomophila+natural pyrethrin, Serratia marcescens strain 35+natural pyrethrin, Serratia marcescens strain SRM+natural pyrethrin, Seuratum cadarachense+natural pyrethrin, Sphaerulariopsis spp.+natural pyrethrin, Spirura guianensis+natural pyrethrin, Sporothrix insectorum+natural pyrethrin, Steinernema bibionis+natural pyrethrin, Steinernema carpocapsae+natural pyrethrin, Steinernema feltiae+natural pyrethrin, Steinernema glaseri+natural pyrethrin, Steinernema kraussei+natural pyrethrin, Steinernema riobrave+natural pyrethrin, Steinernema scapterisci+natural pyrethrin, Steinernema scarabaei+natural pyrethrin, Steinernema siamkayai+natural pyrethrin, Steinernema spp.+natural pyrethrin, Strelkovimermis peterseni+natural pyrethrin, Streptomyces acidiscabies strain RL-110T+natural pyrethrin, Streptomyces candidus strain Y21007-2+natural pyrethrin, Streptomyces colombiensis+natural pyrethrin, Streptomyces galbus strain QST6047+natural pyrethrin, Streptomyces goshikiensis+natural pyrethrin, Streptomyces griseoviridis strain K61+natural pyrethrin, Streptomyces lavendulae+natural pyrethrin, Streptomyces lydicus strain WYCD108US+natural pyrethrin, Streptomyces lydicus strain WYEC108+natural pyrethrin, Streptomyces prasinus+natural pyrethrin, Streptomyces rimosus+natural pyrethrin, Streptomyces saraceticus+natural pyrethrin, Streptomyces sp. strain NRRL No. B-30145+natural pyrethrin, Streptomyces sp. strain WYE20+natural pyrethrin, Streptomyces sp. strain WYE 324+natural pyrethrin, Streptomyces venezuelae+natural pyrethrin, Subulura spp.+natural pyrethrin, Sulphuretylenchus elongatus+natural pyrethrin, Talaromyces flavus strain SAY-Y-94-01+natural pyrethrin, Talaromyces flavus strain V117b+natural pyrethrin, Tetrameres spp.+natural pyrethrin, Thelohania solenopsis+natural pyrethrin, Thiobacillus spp.+natural pyrethrin, Trichoderma album+natural pyrethrin, Trichoderma asperelloides strain JM41R+natural pyrethrin, Trichoderma asperellum strain ICC012+natural pyrethrin, Trichoderma asperellum T25+natural pyrethrin, Trichoderma asperellum strain T34+natural pyrethrin, Trichoderma asperellum strain SKT-1+natural pyrethrin, Trichoderma asperellum strain TV1+natural pyrethrin, Trichoderma atroviride strain CNCM 1-1237+natural pyrethrin, Trichoderma atroviride strain LC52+natural pyrethrin, Trichoderma atroviride strain IMI 206040+natural pyrethrin, Trichoderma atroviride strain SC1+natural pyrethrin, Trichoderma atroviride strain SKT-1+natural pyrethrin, Trichoderma atroviride strain T11+natural pyrethrin, Trichoderma gamsii strain ICC080+natural pyrethrin, Trichoderma harzianum strain 21+natural pyrethrin, Trichoderma harzianum strain DB 104+natural pyrethrin, Trichoderma harzianum strain DSM 14944+natural pyrethrin, Trichoderma harzianum strain ESALQ-1303+natural pyrethrin, Trichoderma harzianum strain ESALQ-1306+natural pyrethrin, Trichoderma harzianum strain IIHR-Th-2+natural pyrethrin, Trichoderma harzianum strain ITEM908+natural pyrethrin, Trichoderma harzianum strain kd+natural pyrethrin, Trichoderma harzianum strain MO1+natural pyrethrin, Trichoderma harzianum strain SF+natural pyrethrin, Trichoderma harzianum strain T22+natural pyrethrin, Trichoderma harzianum strain T39+natural pyrethrin, Trichoderma harzianum strain T78+natural pyrethrin, Trichoderma harzianum strain TH35+natural pyrethrin, Trichoderma harzianum rifai+natural pyrethrin, Trichoderma koningii+natural pyrethrin, Trichoderma lignorum+natural pyrethrin, Trichoderma polysporum strain IMI206039+natural pyrethrin, Trichoderma spp.+natural pyrethrin, trichoderma stromaticum+natural pyrethrin, Trichoderma virens strain G-41+natural pyrethrin, Trichoderma virens strain GL-21 (Formerly Gliocladium virens GL-21)+natural pyrethrin, Trichoderma viride+natural pyrethrin, Tsukamurella paurometabola+natural pyrethrin, Typhula phacorrhiza strain 94671+natural pyrethrin, Ulocladium oudemansii strain HRU3+natural pyrethrin, Vairimorpha spp. strain Q-09+natural pyrethrin, Variovorax paradoxus strain GF4526+natural pyrethrin, Verticillium alboatrum strain WCS850+natural pyrethrin, Verticillium chlamydosporium+natural pyrethrin, Verticillium dahliae+natural pyrethrin, Verticillium lecani strain NCIM1312+natural pyrethrin, Virgibacillus pantothenticus strain ATCC14576+natural pyrethrin, Virgibacillus pantothenticus strain DSM491+natural pyrethrin, Xanthomonas campestris pv poae+natural pyrethrin, Xanthomonas campestris+natural pyrethrin, Xenorhabdus luminescens+natural pyrethrin, Xenorhabdus nematophila+natural pyrethrin, Zoophtora radicans+natural pyrethrin, Adoxophyes orana granulosis virus (GV) strain BV-0001+natural pyrethrin, Agrotis segetum nuclear polyhedrosis virus (NPV)+natural pyrethrin, Anagraoha falcifera NPV+natural pyrethrin, Anticarsia gemmatalis mNPV+natural pyrethrin, Autographa californica mNPV+natural pyrethrin, Biston suppressaria NPV+natural pyrethrin, Bombyx mori NPV+natural pyrethrin, Cryptophlebia leucotreta GV+natural pyrethrin, Cydia pomonella GV strain V15+natural pyrethrin, Cydia pomonella GV strain V22+natural pyrethrin, Dendrolimus punctatus cypovirus+natural pyrethrin, Helicoverpa armigera NPV strain BV-0003+natural pyrethrin, Helicoverpa zea NPV+natural pyrethrin, Leucoma salicis NPV+natural pyrethrin, Lymantria dispar NPV+natural pyrethrin, Mamestra brassicae NPV+natural pyrethrin, Mamestra configurata NPV+natural pyrethrin, Neodiprion abietis NPV+natural pyrethrin, Neodiprion lecontei NPV+natural pyrethrin, Neodiprion sertifer NPV+natural pyrethrin, Orgyia pseudotsugata NPV+natural pyrethrin, pepino mosaic virus strain CH2 isolate 1906+natural pyrethrin, Phthorimaea operculella GV+natural pyrethrin, Pieris rapae GV+natural pyrethrin, Plodia interpunctella GV+natural pyrethrin, Plutella xylostella GV+natural pyrethrin, Plutella xylostella GV+natural pyrethrin, Spodoptera albula mNPV+natural pyrethrin, Spodoptera exempta mNPV+natural pyrethrin, Spodoptera exigua mNPV strain BV-0004+natural pyrethrin, Spodoptera frugiperda mNPV+natural pyrethrin, Spodoptera littoralis mNPV+natural pyrethrin, Spodoptera litura NPV+natural pyrethrin, Tobacco mild tobamovirus strain U2+natural pyrethrin, Zucchini Yellow Mosaik Virus weak strain+natural pyrethrin, Acaulospora spp.+natural pyrethrin, Ambispora spp.+natural pyrethrin, Archaeospora spp.+natural pyrethrin, Claroideoglomus spp. (Formerly, Glomus spp.)+natural pyrethrin, Claroideoglomus etunicatum (Formerly, Glomus etunicatum)+natural pyrethrin, Claroideoglomus claroideum (Formerly, Glomus claroideum)+natural pyrethrin, Diversispora spp.+natural pyrethrin, Entrophospora spp.+natural pyrethrin, Funneliformis spp. (Formerly, Glomus spp.)+natural pyrethrin, Funneliformis mosseae (Formerly, Glomus mosseae)+natural pyrethrin, Geosiphon spp.+natural pyrethrin, Gigaspora spp.+natural pyrethrin, Gigaspora margarita+natural pyrethrin, Gigaspora rosea+natural pyrethrin, Glomus spp.+natural pyrethrin, Glomus aggregatum+natural pyrethrin, Glomus deserticola+natural pyrethrin, Glomus monosporum+natural pyrethrin, Pacispora spp.+natural pyrethrin, Paraglomus spp.+natural pyrethrin, Paraglomus brasillianum (Formerly, Glomus brasillianum)+natural pyrethrin, Racocetra spp.+natural pyrethrin, Rhizophagus spp. (Formerly, Glomus spp.)+natural pyrethrin, Rhizophagus clarus (Formerly, Glomus clarum)+natural pyrethrin, Rhizophagus intraradices (Formerly, Glomus intraradices)+natural pyrethrin, Rhizophagus intraradices strain RTI-801+natural pyrethrin, Rhizophagus irregularis (Formerly, Glomus intraradices)+natural pyrethrin, Rhizophagus irregularis strain DAOM 197198+natural pyrethrin, Scutellospora spp.+natural pyrethrin, Azorhizobium spp.+natural pyrethrin, Azorhizobium caulinodans+natural pyrethrin, Azospirillum amazonense+natural pyrethrin, Azospirillum brasilense+natural pyrethrin, Azospirillum brasilense strain XOH+natural pyrethrin, Azospirillum brasilense strain Ab-V5+natural pyrethrin, Azospirillum brasilense strain Ab-V6+natural pyrethrin, Azospirillum caulinodans+natural pyrethrin, Azospirillum halopraeferens+natural pyrethrin, Azospirillum irakense+natural pyrethrin, Azospirillum lipoferum+natural pyrethrin, Bradyrhizobium spp.+natural pyrethrin, Bradyrhizobium elkanii+natural pyrethrin, Bradyrhizobium elkanii strain SEMIA 587+natural pyrethrin, Bradyrhizobium elkanii strain SEMIA 5019+natural pyrethrin, Bradyrhizobium japonicum+natural pyrethrin, Bradyrhizobium japonicum strain TA-11+natural pyrethrin, Bradyrhizobium japonicum strain USDA 110+natural pyrethrin, Bradyrhizobium liaoningense+natural pyrethrin, Bradyrhizobium lupini+natural pyrethrin, Bradyrhizobium sp. (Arachis)+natural pyrethrin, Bradyrhizobium sp. (Vigna)+natural pyrethrin, Delftia acidovorans+natural pyrethrin, Delftia acidovorans strain RAY209+natural pyrethrin, Metylobacterium spp.+natural pyrethrin, Mesorhizobium ciceri+natural pyrethrin, Mesorhizobium huakii+natural pyrethrin, Mesorhizobium loti+natural pyrethrin, Mesorhizobium spp.+natural pyrethrin, Rhizobium etli+natural pyrethrin, Rhizobium galegae+natural pyrethrin, Rhizobium leguminosarum bv. Phaseoli+natural pyrethrin, Rhizobium leguminosarum bv. Trifolii+natural pyrethrin, Rhizobium leguminosarum bv. Viciae+natural pyrethrin, Rhizobium trifolii+natural pyrethrin, Rhizobium tropici+natural pyrethrin, Sinorhizobium fredii+natural pyrethrin, Sinorhizobium meliloti+natural pyrethrin.

The components selected from the group (j) are usually prepared by culture methods known in the art. For example, when the components selected from group (j) are bacteria or fungi, they are prepared using media and fermentation methods known in the art. When the present component is a bacterium or fungus, a preparation contains×10⁴ to 1×10¹³ CFU (Colony Forming Units), preferably 1×10⁸ to 1×10¹² CFU of the present component per gram. When the present component is a virus, a preparation contains 1×10⁴ to 1×10¹³ occlurion bodies (sometimes referred to as Obs), preferably 1×10⁸ to 1×10¹² occlurion bodies of the present component per gram. When the present component is a nematode, a preparation contains 1×10⁴ to 1×10¹³ individual organisms, preferably 1×10⁸ to 1×10¹² individual organisms of the component per gram.

Combinations of the present component of the group (k) above and the present compound:
Saponins of Chenopodium quinoa+natural pyrethrin, azadirachtin+natural pyrethrin, extract of bark of Celastrus angulatus+natural pyrethrin, extract of Azadirachta indica+natural pyrethrin, rotenone+natural pyrethrin, extract of leaves of Dryopteris filix-mas+natural pyrethrin, extract of Artemisia absinthium+natural pyrethrin, extract of Cassia nigricans+natural pyrethrin, extract of clitoria ternatea+natural pyrethrin, extract of Symphytum officinale+natural pyrethrin, extracts or simulated blend of Chenopodium ambrosioides+natural pyrethrin, potassium salt of hop beta acid+natural pyrethrin, terpene constituents of the extract of chenopodium ambrosioides near ambrosioides (Brand name: Terpenoid blend QRD 460)+natural pyrethrin, extract of Matricaria chamomilla+natural pyrethrin, extract of Tanacetum vulgare+natural pyrethrin, extract of Urtica dioica+natural pyrethrin, extract of Viscum album+natural pyrethrin, oil of the seeds of Chenopodium anthelminticum+natural pyrethrin, wood extract of Quassia amara+natural pyrethrin, extract from Melaleuca alternifolia+natural pyrethrin, extract from Reynoutria sachalinensis+natural pyrethrin, extract from the cotyledons of lupine plantlets (“BLAD”)+natural pyrethrin, extract of Allium sativum+natural pyrethrin, extract of Equisetum arvense+natural pyrethrin, extract of Tropaeolum majus+natural pyrethrin, extract of leaves and bark of Quercus+natural pyrethrin, Quillaja extract+natural pyrethrin, yellow mustard powder+natural pyrethrin, abscisic acid+natural pyrethrin, Gibberellin A+natural pyrethrin, Gibberellin A3+natural pyrethrin, seed extract of Schoenocaulon spp.+natural pyrethrin, cevadine+natural pyrethrin, veratridine+natural pyrethrin, neem oil+natural pyrethrin, anise extract+natural pyrethrin, angelica extract+natural pyrethrin, ambrate extract+natural pyrethrin, catnip extract+natural pyrethrin, ylang-ylang extract+natural pyrethrin, wintergreen extract+natural pyrethrin, onion extract+natural pyrethrin, olibanum extract+natural pyrethrin, oregano extract+natural pyrethrin, orange extract+natural pyrethrin, garlic extract+natural pyrethrin, chamomile extract+natural pyrethrin, cardamom extract+natural pyrethrin, galbanum extract+natural pyrethrin, carrot seed extract+natural pyrethrin, Ginkgo biloba extract+natural pyrethrin, camphor+natural pyrethrin, d-camphor+natural pyrethrin, ginkgolide A+natural pyrethrin, ginkgolide B+natural pyrethrin, ginkgolide C+natural pyrethrin, ginkgolide J+natural pyrethrin, ginkgolide M+natural pyrethrin, guaiac wood extract+natural pyrethrin, camphor tree extract+natural pyrethrin, clove extract+natural pyrethrin, cumin extract+natural pyrethrin, grapefruit extract+natural pyrethrin, shell ginger extract+natural pyrethrin, pepper extract+natural pyrethrin, copaiba balsam extract+natural pyrethrin, coriander extract+natural pyrethrin, Japanese basil extract+natural pyrethrin, cedarwood extract+natural pyrethrin, citronella extract+natural pyrethrin, cinnamon extract+natural pyrethrin, jasmine extract+natural pyrethrin, ginger extract+natural pyrethrin, sweet flag extract+natural pyrethrin, cedar extract+natural pyrethrin, star anise extract+natural pyrethrin, spearmint extract+natural pyrethrin, Seiyonikkei extract+natural pyrethrin, yarrow extract+natural pyrethrin, sage extract+natural pyrethrin, geranium extract+natural pyrethrin, celery extract+natural pyrethrin, Cnidium Rhizome extract+natural pyrethrin, turmeric extract+natural pyrethrin, thyme extract+natural pyrethrin, tarragon extract+natural pyrethrin, tea extract+natural pyrethrin, cheddar leaf extract+natural pyrethrin, tea tree extract+natural pyrethrin, dill extract+natural pyrethrin, neroli extract+natural pyrethrin, violet extract+natural pyrethrin, pine extract+natural pyrethrin, basil extract+natural pyrethrin, parsley extract+natural pyrethrin, patchouli extract+natural pyrethrin, mint extract+natural pyrethrin, palmarosa extract+natural pyrethrin, valerian extract+natural pyrethrin, hyssop extract+natural pyrethrin, cypress extract+natural pyrethrin, hiba extract+natural pyrethrin, pimenta extract+natural pyrethrin, fennel extract+natural pyrethrin, petitgrain extract+natural pyrethrin, bay extract+natural pyrethrin, vetiver extract+natural pyrethrin, penyroyal extract+natural pyrethrin, peppermint extract+natural pyrethrin, perilla extract+natural pyrethrin, bergamot extract+natural pyrethrin, berber extract+natural pyrethrin, marjoram extract+natural pyrethrin, manuka extract+natural pyrethrin, mandarin extract+natural pyrethrin, eucalyptus extract+natural pyrethrin, artemisia extract+natural pyrethrin, Angelica dahurica extract+natural pyrethrin, lime extract+natural pyrethrin, lavandin extract+natural pyrethrin, lavender extract+natural pyrethrin, lemon extract+natural pyrethrin, lemongrass extract+natural pyrethrin, lemon eucalyptus extract+natural pyrethrin, Roman chamomile extract+natural pyrethrin, rosemary extract+natural pyrethrin, laurel extract+natural pyrethrin, 1,8-cineol+natural pyrethrin, 1-phenylethyl alcohol+natural pyrethrin, 2-phenylethyl alcohol+natural pyrethrin, 1-phenyl Ethyl propionate+natural pyrethrin, 2-phenylethyl propionate+natural pyrethrin, 4-tertbutyl cyclohexyl acetate+natural pyrethrin, cis-jasmone+natural pyrethrin, D-pulegone+natural pyrethrin, isoeugenol+natural pyrethrin, L-carvone+natural pyrethrin, L-menthol+natural pyrethrin, p-cymene+natural pyrethrin, p-menthane-3,8-diol+natural pyrethrin, trans-anethole+natural pyrethrin, α-terpineol+natural pyrethrin, α-terpinene+natural pyrethrin, γ-terpinene+natural pyrethrin, 6-terpinene+natural pyrethrin, α-pinene+natural pyrethrin, α-phellandrene+natural pyrethrin, β-ionone+natural pyrethrin, anisaldehyde+natural pyrethrin, amylcinnamaldehyde+natural pyrethrin, Amyl salicylate+natural pyrethrin, ionone+natural pyrethrin, ethyl vanillin+natural pyrethrin, ethyl linalool+natural pyrethrin, eugenol+natural pyrethrin, galaxolide+natural pyrethrin, carvacrol+natural pyrethrin, carveol+natural pyrethrin, carvone+natural pyrethrin, camphor+natural pyrethrin, camphene+natural pyrethrin, guaiacol+natural pyrethrin, cinnamyl alcohol+natural pyrethrin, geraniol+natural pyrethrin, geranyl formate+natural pyrethrin, citral+natural pyrethrin, citronellal+natural pyrethrin, citronellol+natural pyrethrin, Dihydromyrcenol+natural pyrethrin, diphenyl oxide+natural pyrethrin, dimethyl salicylate+natural pyrethrin, methyl jasmonate+natural pyrethrin, cinnamyl formate+natural pyrethrin, cinnamaldehyde+natural pyrethrin, terpineol+natural pyrethrin, damascone+natural pyrethrin, thymol+natural pyrethrin, terpinyl acetate+natural pyrethrin, terpineol+natural pyrethrin, terpinen-4-ol+natural pyrethrin, neral+natural pyrethrin, nonyl alcohol+natural pyrethrin, vanillin+natural pyrethrin, piperonal+natural pyrethrin, piperonyl acetate+natural pyrethrin, piperonyl alcohol+natural pyrethrin, phenylethyl acetate+natural pyrethrin, phenylethyl alcohol+natural pyrethrin, pulegone+natural pyrethrin, perillaldehyde+natural pyrethrin, perillaldehyde+natural pyrethrin, benzyl acetate+natural pyrethrin, benzyl alcohol+natural pyrethrin, benzyl benzoate+natural pyrethrin, borneol+natural pyrethrin, Methyl Anthranilate+natural pyrethrin, Methylionone+natural pyrethrin, Methylsalicylate+natural pyrethrin, Menthol+natural pyrethrin, Linalool+natural pyrethrin, Limonene+natural pyrethrin, Geranyl Acetate+natural pyrethrin, Citronellyl Acetate+natural pyrethrin, nopyl Acetate+natural pyrethrin, menthyl acetate+natural pyrethrin, linalyl acetate+natural pyrethrin.

Although the weight ratio of the application amount of natural pyrethrins to the application amount of the present component in the composition A is not particularly limited, it can be appropriately adjusted to be a optimum weight ratio depending on type of plants, animals and items which are targets to be protected; type and frequency of occurrence of pest arthropods, pest nematodes, pest mollusks, phytopathogenic microorganisms or weeds which are targets to be controlled; formulation type; application time; application method; application site; weather condition and the like. For example, in the field of agriculture, when applying to plants (especially, foliage, seeds, vegetative reproduction organs) or applying to cultivation carriers (especially soil) for cultivating plants, the following weight ratios can be exemplified.

The weight of the present component selected from the group (j) means the weight of the preparation. For example, a weight ratio of 1:500 means that the application amount of the preparation of one or more components selected from the group (j) is 500 parts by weight as opposed to 1 part by weight of natural pyrethrins.

Weight ratio [(Natural pyrethrin):(Present component)]=1:10\hat{ }15 to 10\hat{ }15:1, specifically, for example, approximately, 1:10\hat{ }15, 1:10\hat{ }14, 1:10\hat{ }13, 1:10\hat{ }12, 1:10\hat{ }11, 1:10\hat{ }10, 1:10\hat{ }9, 1:10\hat{ }8, 1:10\hat{ }7, 1:10\hat{ }6, 1:10\hat{ }5, 1:10000, 1:9000, 1:8000, 1:7000, 1:6000, 1:5000, 1:4000, 1:3000, 1:2000, 1:1000, 1:900, 1:800, 1:700, 1:600, 1:500, 1:400, 1:350, 1:300, 1:250, 1:200, 1:150, 1:100, 1:90, 1:80, 1:70, 1:60, 1:50, 1:40, 1:30, 1:20, 1:19, 1:18, 1:17, 1:16, 1:15, 1:14, 1:13, 1:12, 1:11, 1:10, 1:9, 1:8, 1:7, 1:6, 1:5, 2:9, 1:4, 2:7, 3:10, 1:3, 3:8, 2:5, 3:7, 4:9, 1:2, 5:9, 4:7, 3:5, 2:3, 7:10, 5:7, 5:8, 3:4, 7:9, 4:5, 5:6, 6:7, 7:8, 8:9, 9:10, 1:1, 10:9, 9:8, 8:7, 7:6, 6:5, 5:4, 9:7, 4:3, 7:5, 10:7, 3:2, 5:3, 7:4, 9:5, 2:1, 9:4, 7:3, 5:2, 8:3, 3:1, 10:3, 7:2, 4:1, 9:2, 5:1, 6:1, 7:1, 8:1, 9:1, 10:1, 11:1, 12:1, 13:1, 14:1, 15:1, 16:1, 17:1, 18:1, 19:1, 20:1, 30:1, 40:1, 50:1, 60:1, 70:1, 80:1, 90:1, 100:1, 150:1, 200:1, 250:1, 300:1, 400:1, 500:1, 600:1, 700:1, 800:1, 900:1, 1000:1, 2000:1, 3000:1, 4000:1, 5000:1, 6000:1, 7000:1, 8000:1, 9000:1, 10000:1, 10\hat{ }5:1, 10\hat{ }6:1, 10\hat{ }7:1, 10\hat{ }8:1, 10\hat{ }9:1, 10\hat{ }10:1, 10\hat{ }11:1, 10\hat{ }12:1, 10\hat{ }13:1, 10\hat{ }14:1, 10\hat{ }15:1. Here, the caret symbol “\hat{ }” is an operator for expressing powers, e.g., “10\hat{ }5” means “10⁵” (i.e., 10 to the fifth power). The “approximately” in the preceding paragraph includes a range of ratios increased or decreased by 10% by weight ratio relative to the specified ratio. For example, approximately 1:2 includes a range of 1:1.8 to 1:2.2.

The present compound can be mixed or used together with chemical fertilizers (ammonium sulfate, ammonium phosphate, ammonium nitrate, urea, ammonium chloride, etc.).

The natural pyrethrin or the composition A are usually used as a composition further containing an inert carrier (hereinafter referred to as ‘composition B’). For use, the composition B is usually formulated into aqueous suspension concentrates, oil based suspension concentrates, oil formulations, emulsifiable concentrates, emulsion formulations, microemulsion formulations, microcapsule formulations, microsphere formulations, wettable powders, water dispersible granules, dustable powders, granules, tablets, aerosols, resin formulations and the like by mixing the present compound or the composition A with a solid carrier, a liquid carrier, a surfactant and the like and optionally adding formulation auxiliaries such as a binder, a dispersant, a stabilizer, a gas and the like. They can be used by formulating into not only these formulations but also the formulation types described in Manual on development and use of FAO and WHO Specifications for pesticides, FAO Plant Production and Protection Papers 271-276, prepared by the FAO/WHO Joint Meeting on Pesticide Specifications, 2016, ISSN:0259-2517.

In addition, the composition B may be used by processing into, for example, spray formulations (aerosol formulations (direct spray type, space spray type, quantitative spray type, one-push type, once-spray type, intermittent spray type, etc.), pump spray formulations, electrospray formulations (Ultrasonic vibration type, electrostatic spray type, etc.)), poison baits (liquid form, paste form, solid form, etc.), combustion formulations (incense sticks, paper, resin, etc.), thermal transpiration formulations (electric mosquito mat, liquid mosquito formulations, etc.), air-driven transpiration formulations (fan type, electric fan installation type, air conditioner installation type, ventilation fan installation type, etc.), smoking formulations (self-combustion smoking formulations, chemical reaction type smoking formulations, porous ceramic plate smoking formulations, etc.), fumigants, fuming formulations, ULV formulations, mist formulations, foam formulations, paste form formulations, paints, wood protection paints, sealants, carbon dioxide formulations, sheet formulations, tape formulations, paper formulations, non-woven fabric formulations, formulations for animals (shampoo formulations, lotion formulations, spot-on formulations, pour-on formulations, paste formulations, poultice formulations, syrup formulations, suppositories, injection formulations, orally administered formulations (capsules, tablets, chewable formulations, feeding stuffs, etc.), implant formulations, etc.), sublimation tablets, mosquito nets, screen doors, attracting strings, agricultural and horticultural props, etc.

These formulations contain the present compound in an amount of usually 0.0001 to 99%, preferably 0.1 to 99%, more preferably 0.2 to 90% by weight.

Examples of the solid carriers include the following.

Inorganic materials: minerals (natural silicates, marble, pumice, limestone, rare earth minerals, cryolite, activated white earth, lime, activated carbon, talc, attapulgite, sodium montmorillonite, calcium montmorillonite, kaolinite, calcite, dolomite, diatomite, bentonite, zeolite, sepiolite, pyrophyllite, vermiculite, crystalline silica, amorphous silica, etc.), silicon dioxide, calcium sulfate, magnesium sulfate, barium sulfate, magnesium oxide, aluminum oxide, ammonium sulfate, ammonium phosphate, ammonium nitrate, calcium phosphate, sulfur, calcium carbonate, sodium hydrogen carbonate, sodium carbonate, synthetic silicates, and pulverized products thereof;

Organic materials: Grain powders (rice bran, rice flour, corn powder, wheat flour, etc.), sugars (cellulose, starch, lactose, glucose, fructose, sucrose, etc.), plant-derived powders (crushed nut shells (crushed nut shells such as coconuts, walnuts, peanuts), tree-derived powders (bark powder, sawdust, etc.), other crushed plant products (tobacco stems, soybeans, cottonseed husks, etc.)), lignin, waxes, shells, urea, polyethylene, polypropylene, Polyvinyl alcohol, polycarbonates, polyesters, polyamides, polyurethanes, polyvinyl chloride, polyvinyl acetate, ethylene-vinyl acetate copolymers, ethylene-methyl methacrylate copolymers, polyvinylpyrrolidone-methacrylic acid copolymers, polyvinylpyrrolidone-vinyl acetate copolymers, cellulose derivatives, phenolic resins, melamine resins, epoxy resins.

In addition, the above solid carriers can also be used as adsorptive carriers.

Examples of the liquid carriers include water, aliphatic hydrocarbons (hexane, 1-hexene, cyclohexane, octane, isooctane, 1-heptene, d-limonene, pinene, hexadecane, etc.), aromatic hydrocarbons (alkylbenzenes (toluene, xylene, isopropylbenzene, p-diethylbenzene, etc.), alkylbenzene derivatives, alkylnaphthalenes, alkylnaphthalene derivatives, tetrahydronaphthalene, etc.), chlorinated hydrocarbons (monochloroethylene, dichloroethylene, trichloroethylene, tetrachloroethylene, dichloromethane, 1,1,1-trichloroethane, 1,1,2-trichloroethane, 1,2-dichloropropane, etc.), ketones (cyclohexanone, acetone, 2-heptanone, isophorone, mesityl oxide, methyl isoamyl ketone, methyl ethyl ketone, methyl isobutyl ketone, acetophenone, diacetone alcohol, methylcyclohexanone, etc.), esters (fatty acid esters (ethyl acetate, butyl acetate, amyl acetate, isoamyl acetate, isobornyl acetate, hexyl acetate, heptyl acetate, octyl acetate, isopropyl myristate, methyl octanoate, methyl oleate, methyl laurate, dibutyl adipate, tributyl citrate, dibutyl phthalate, etc.), lactic acid esters (ethyl lactate, propyl lactate, etc.), carbonate esters (ethylene carbonate, propylene carbonate, butylene carbonate, diethyl carbonate, dibutyl carbonate, etc.), esterified polyols (glycerol acetate, glycol acetate, glycerin monoacetate, glycerin diacetate, glycerin triacetate, diethylene glycol abietate, dipropylene glycol dibenzoate, dipropylene glycol monomethyl ester, etc.), lactones (γ-butyl lactone, etc.), ethers (1,4-dioxane, tetrahydrofuran, dipropylene glycol methyl ether, ethylene glycol methyl ether, propylene glycol methyl ether, etc.), amides (N-octyl-caprolactam, N-dodecyl-caprolactam, N,N-dimethylformamide, fatty acid dimethylamide (N,N-dimethylacetamide, N,N-dimethyldecanamide, N,N-dimethyloctanamide, etc.), alkylpyrrolidones (N-methylpyrrolidone, N-octyl-pyrrolidone, N-dodecyl-pyrrolidone, etc.), lactams (α-lactams, β-lactams, γ-lactams, δ-lactams, etc.), amines (octylamine, octylamine acetate, oleylamine, diethanolamine, laurylamine, etc.), alcohols (methanol, ethanol, butanol, propanol, isopropanol, butanol, amyl alcohol, hexanol, heptanol, octanol, 2-ethylhexanol, etc.), hexylene glycol, cyclohexanol, phenol, benzyl alcohol, methoxypropanol (1-methoxy-2-propanol), tetrahydrofurfuryl alcohol, furfuryl Alcohol, polyethylene glycol, ethylene glycol, diethylene glycol, hexylene glycol, ethylene glycol methyl ether, diethylene glycol methyl ether, diethylene glycol butyl ether, triethylene glycol, propylene glycol methyl ether, dipropylene glycol, ethylene glycol monomethyl ether, ethylene glycol monoethyl ether, ethylene glycol butyl ether, dipropylene glycol methyl ether, dipropylene glycol ether, dipropylene glycol monomethyl ether, glycerin, etc.), mineral oils (naphtha, petroleum ether, kerosene, diesel oil, paraffin, olefin, etc.), animal and plant-derived oils, plant-derived oils (palm oil, rapeseed oil, sunflower oil, palm kernel oil, cottonseed oil, peanut oil, copra oil, olive oil, corn oil, sesame oil, castor oil, coconut oil, soybean oil, rice bran oil, safflower oil, linseed oil, malt oil and derivatives thereof, etc.), animal-derived oils (sardine oil, saury oil, whale oil and derivatives thereof, etc.), dimethyl sulfoxide, silicone oil, acetonitrile, propanenitrile, acid anhydrides (acetic anhydride, etc.), triethyl phosphate, oleic acid, propionic acid, lactic acid, and xylenesulfonic acid.

Examples of Gaseous carriers include fluorocarbon, butane gas, LPG (liquefied petroleum gas), dimethyl ether, nitrogen, and carbon dioxide gas.

Examples of anionic surfactants include carboxylic acids, sulfonic acids, sulfate esters, and phosphoric esters. Specific examples include the following.
Carboxylic acids: fatty acid salts (octanoate, decanoate, laurate, myristate, palmitate, stearate, behenate, oleate, polyoxyethylene alkyl ether carboxylate (Laureth-3-Carboxylate, α-(carboxymethyl)-ω-(dodecyloxy)poly(oxyethylene) salt, etc.), N-acylsarcosine salt (N-lauroylsarcosine salt, etc.), N-acylglutamate (N-lauroyl glutamate, etc.), polycarboxylates (polyacrylic acid salts, polyvinyl acetates, comb polymers of polyacid salts, derivatives thereof, etc.), sulfonic acids: alkylsulfonic acid and salts thereof (dodecylsulfonate, etc.), alpha olefin sulfonates (alkene (C14-18) hydroxysulfonates, alkapolyene (C12-20) hydroxysulfonates, alkene (C14-18) hydroxysulfonates, alkene (C12-20) Hydroxysulfonates, tetradecene-1-sulfonate, α-olefin (C14-16) sulfonate, etc.), alkylbenzenesulfonate (decylbenzenesulfonate, dodecylbenzenesulfonate, tridecylbenzenesulfonate, diphenylsulfonate, etc.), alkylnaphthalenesulfonates (naphthalenesulfonate, 6-methyl-2-naphthalenesulfonate, dibutylnaphthalenesulfonate, 2.2′-dinaphthylmethane-6.6′diphosultine naphthalenesulfonate, diisopropyl naphthalenesulfonate, triisopropylnaphthalenesulfonate, 1-isopropyl 2-naphthalenesulfonate, etc.), sulfosuccinic acid, monoalkylsulfosuccinate, dialkylsulfosuccinate, (di(2-ethylhexyl)sulfosuccinate, etc.), N-methyl-N-acyl taurate (oleoyl methyl taurate, etc.), lignin sulfonate, alkylphenol sulfonate, naphthalene sulfonate-formaldehyde condensate, benzimidazole sulfonate and its derivatives, as sulfate esters, alkyl sulfates (hexyl sulfate, heptyl sulfate, octyl sulfate, lauryl sulfate, lauryl sulfate diethanol salt, hexadecyl sulfate, octadecyl sulfate, etc.), polyoxyethylene alkyl ether sulfates and salts thereof (laureth-3-sulfate, polyoxyethylene monotridecyl ether sulfate, α-sulfo-ω-hydroxyalkyl (C6-10) ether poly(oxyethylene) salt, etc.), polyoxyethylene alkylphenyl ether sulfates (poly(oxyethylene) 2-decylphenyl ether sulfate, poly(oxyethylene) 3-decylphenyl ether sulfate, α-sulfo-ω-[2,4-bis(1,1,3,3-tetramethylbutyl)phenoxy]poly(oxyethylene) salts, etc.), polyoxypropylene alkyl ether sulfates, lignosulfite waste liquors, and derivatives thereof;
Phosphates: Alkyl phosphates (propyl phosphate, hexadecyl phosphate, lauryl phosphate, dioctyl phosphate, etc.), polyoxyethylene alkyl ether phosphates (polyoxyethylene decyl phosphate, α-phosphono-ω-butoxypoly(oxyethylene), etc.), polyoxyethylene alkylphenyl ether phosphates (α-(dinonylphenyl)-ω-hydroxypoly(oxyethylene) phosphate, α-(dodecylphenyl)-ω-hydroxypoly(oxyethylene) phosphate, α-(nonylphenyl)-ω-hydroxypoly(oxyethylene) phosphate, etc.), polyoxypropylene alkyl ether phosphate, and derivatives thereof.

Examples of cationic surfactants include amine salts and quaternary ammonium salts, and specific examples include the following.
Amine salts: alkylamine salts (monomethylamine salt, dimethylamine salt, trimethylamine salt, etc.), fatty acid amidoamine salts (stearamidopropyldimethylamine, behenamidopropyldimethylamine, etc.), polyamine salts (polyvinylamine, polyethyleneimine, etc.), and derivatives thereof;
Quaternary ammonium salts: lauryltrimethylammonium salt, cetyltrimethylammonium salt, dodecyltrimethylammonium salt, stearyltrimethylammonium salt, benzalkonium chloride, benzethonium chloride, benzylbis(2-chloroethyl)ethylammonium bromide.

Examples of amphoteric surfactants include betaines, alkylbetaines, alkyldimethylbetaine, imidazolines, taurine, alkyltaurine, dodecyldimethylammonioacetate, 4-carboxy-N,N,N-trimethyl-1-butanaminium, 1-carboxy-N,N,N-2-tetramethyl-1-propanaminium, N-alkyl (or alkenyl) (C12-18) glycine and its salts, N-dodecylglycine and its salts, and derivatives thereof.

Examples of nonionic surfactants include alcohols, amides, amines, esters, ethers, ether esters, and carboxylic acids, and specific examples include the following.
Alcohols: Aromatic alcohols (alkylphenols (allylphenol, octylphenol, nonylphenol, octylcresol, etc.), acylphenols, etc.), aliphatic alcohols (isotridecyl alcohol, oleyl alcohol, cetyl alcohol, etc.), polyhydric alcohols (polysaccharides, starches, starch derivatives, sucrose, alkyl polyglucosides, sorbitans, ethoxylated sorbitans, cellulose derivatives, gum arabic, etc.), synthetic polymers (polyvinyl alcohol, polyethylene glycol, etc.);
Amides: alkanolamides (fatty acid alkanolamides (lauric acid diethanolamide, etc.), fatty acid glucamides (alkoxylated propylene oxide fatty acid glucamide, etc.), alkoxylated amides (polyoxyethylene oleic acid amide, polyoxyethylene stearic acid amide, etc.), synthesis polymers (polyvinylpyrrolidone, etc.),
Amines: alkoxylated amines (polyoxyethylene oleylamine, α,α′-[(9-octadecenylimino)di2,1-ethanedyl]bis(ω-hydroxy)polyoxyethylene, etc.);
Esters: fatty acid esters (polyol fatty acid esters, monoglycerides, phospholipids, etc.), sugar-derived esters (sucrose fatty acid esters (sucrose stearate diester, etc.), sorbitan fatty acid esters (sorbitan oleic acid monoester, etc.), glucose esters, cellulose esters, etc.), synthetic polymers (vinyl acetate copolymers, polymethacrylic acid, copolymers of methacrylic acid and methacrylic acid ester, etc.);
Ethers: alcohol ethoxylates (fatty alcohol ethoxylates (tridecyl alcohol ethoxylate, isooctyl alcohol ethoxylate, lauryl alcohol ethoxylate, hexadecyl alcohol ethoxylate, stearyl alcohol ethoxylate), etc.), alkylphenol ethoxylates (nonylphenol ethoxylate tristyrylphenol ethoxylate, tributylphenol ethoxylate, octylphenol ethoxylate, etc.), arylalkylphenol ethoxylates, arylphenol ethoxylates (monobenzylbiphenol alcohol ethoxylate, etc.), alcohol propoxylates (aliphatic alcohol propoxylates, alkylphenol propoxylates, arylalkylphenol propoxylates, etc.), block polymers (block polymers of polyethylene oxide and polypropylene oxide, polyethylene oxide block polymers, polypropylene oxide block polymers, block polymers of alkanol, polyethylene oxide and polypropylene oxide, etc.);
Ether esters: polyoxyethylene fatty acid esters (polyoxyethylene castor oil ester, polyoxyethylene stearate, polyoxyethylene beef tallow fatty acid ester, etc.), polyoxyethylene sorbitan fatty acid esters (polyoxyethylene sorbitan monooleate, poly oxyethylene sorbitan trioleate, polyoxyethylene sorbitan monolaurate, polyoxyethylene sorbitan stearate, etc.), polyoxyethylene fatty acid amine esters, polyoxyethylene rosin ester, polyoxypropylene fatty acid esters (polyoxypropylene castor oil ester, etc.), polyoxypropylene fatty acid amine esters;
Carboxylic acids: undecafluorohexanoic acid.

Examples of other formulation auxiliaries include thickeners, antifreeze agents/moisturizers, antifoaming agents, antioxidants, pH adjusters, colorants, preservatives/bactericides, binders, adhesives/spreading agents, lubricants/lubricants, anti-caking agents, light stabilizers, fragrances, propellants, fertilizers, filming agents, deodorants, plasticizers, desiccants/moisture-proof agents, fumigant aids, attractants, clathrateing agents, and efficacy enhancers, and specific examples include the following.
Thickeners: polysaccharides (xanthan gum, cellulose esters, cellulose ethers, carboxymethylcellulose and its salts, dextrin, starches, guar gum, gum arabic, hydroxypropyl guar gum, tylose, carrageenan, etc.), clays (organic clays, organic modified clays, inorganic clays, inorganic modified clays, etc.), minerals (bentonite, attapulgite, silica, silicates, etc.), synthetic polymers (polycarboxylates, polyacrylic acid derivatives, polyvinylpyrrolidone, polyvinyl alcohol, etc.);
Antifreeze agents/moisturizers: alcohols (ethylene glycol, propylene glycol, dipropylene glycol, triethylene glycol, ethylene glycol methyl ether, propylene glycol methyl ether, dipropylene glycol methyl ether, ethylene glycol butyl ether, glycerin, polyethylene glycol, etc.), esters (dipropylene glycol dibenzoate, glycerol acetate, glycerol diacetate, glycerol triacetate, gamma-butyrolactone, etc.), ethers (1,4-dioxane, etc.), urea;
Antifoaming agents: silicones (polysiloxane, diblock ethoxyl siloxane, triblock ethoxyl siloxane, etc.), alkyl sulfosuccinates, higher alcohols, higher alcohol derivatives, fatty acid salts, fatty acid derivatives;
Antioxidants: phenols (2,6-di-t-butyl-p-cresol, 2,2′-methylenebis(4-methyl-6-t-butylphenol, 4-methoxyphenol (Mequinol, INN)) etc.), phenothiazine, 4-tert-butylcatechol (TBC), tert-butylhydroquinone (TBHQ), amines (p,p′-dioctyldiphenylamine, N,N′-diphenyl-p-phenylenediamine, etc.), dibutylhydroxy toluene (BHT), butyl hydroxyanisole (BHA), sodium erythorbate, sodium sulfite, potassium sulfite, potassium pyrosulfite, catechin, propyl gallate, sulfurs (didodecyl thiodipropionate, etc.), phosphoric acids (trisnonylphenyl phosphite, etc.), vitamins (α-tocopherol, β-tocopherol, γ-tocopherol, δ-tocopherol, α-tocotrienol, β-tocotrienol, γ-tocotrienol, δ-tocotrienol, L-ascorbic acid, sodium ascorbate, ascorbyl palmitate, etc.), chlorogenic acid, p-coumaric acid, 2,2-diphenyl-1-picrylhydrazyl (DPPH), ethoxyquin (6-ethoxy-1,2-dihydro-2,2,4-trimethylquinoline);
pH adjusters: sulfuric acid, nitric acid, hydrochloric acid, acetic acid, carbonic acid, oxalic acid, lactic acid, succinic acid, gluconic acid, citric acid, phosphoric acid, sorbic acid, and salts thereof, sodium hydrogen carbonate, sodium hydroxide, potassium hydroxide, calcium hydroxide, aluminum hydroxide, copper hydroxide, magnesium hydroxide, and in addition, chain carboxylic acids (formic acid, propionic acid, butyric acid, etc.), aromatic carboxylic acids (salicylic acid, benzoic acid, phthalic acid, etc.) and other organic acids (tartaric acid, fumaric acid, malic acid and ascorbic acid, etc.) and salts thereof can also be used as necessary;
Colorants: monoazos (Pigment Red 48:1, Pigment Red 48:2, Pigment Red 53:1, Pigment Red 57:1, Pigment Red 112, Pigment Brown 25, C.I. Solvent Red 1, Pigment Yellow 1, Pigment Orange 5, Acid Red 14, Acid Yellow 23, etc.), disazos (Pigment Yellow 13, Pigment Orange 34, etc.), phthalocyanines (Pigment Blue 15:1, Pigment Blue 15:2, Pigment Blue 15:3, Pigment Blue 15:4, Pigment Green 7, Pigment Green 36, etc.), anthraquinones (Pigment Red 83, etc.), dioxazines (Pigment Blue 80, etc.), xanthenes (Basic Violet 10 (Rhodamine B), Acid Red 51, Acid Red 52, etc.), triarylmethanes (Acid Blue 9, etc.), Pigment Orange 43, iron oxide, titanium, titanium oxide, zinc oxide, zinc sulfide, iron hexacyanoate, chrome vermillion, lead yellow, calcium carbonate, barite powder, aluminum powder;
Preservatives/bactericides: Phenols (orthophenylphenol, thymol, 3,5-dimethyl-4-chlorophenol, 2-isopropyl-5-methylphenol, 3-methyl-4-isopropylphenol), isothiazolinone derivatives (alkylisothiazolinone (5-chloro-2-methylisothiazolinone, 2-methylisothiazolinone, N-octylisothiazolinone), benzisothiazolinone (1,2-benzisothiazolinone, N-n-butylbenzisothiazolinone), bronopol derivatives (bronopol) benzyl alcohol hemiformal, parabens (methylparaben, ethylparaben, propylparaben, isopropylparaben, butylparaben, isobutylparaben, heptylparaben, benzylparaben), imidazoles (thiabendazole, 2-(4-Thiazolyl)benzimidazole), 2-benzimidazolyl methylcarbamate, benzalkonium chloride, didecyldimethylammonium chloride, glyceryl caprylate, glyceryl caprate, glycerin fatty acid esters, sodium dehydroacetate, hinokitiol, silver zeolite, silver salt, methylene bisthiocyanate, 2-bromo-2-nitropropane-1,3-diol, glutaraldehyde, iodopropynylbutylcarbamate, 1,2-dibromo-2,4-dicyanobutane, chlorhexidine gluconate, polyhexamethylenebiguanide, para-chloro-meta-xylenol, parachlorometacresol, polylysine, tetrachloroisophthalonitrile, diiodomethyl paratolylsulfone, parachlorophenyl-3-iodopropargyl formal, 2,3,5,6-tetrachloro-4-(methylsulfonyl) pyridine, lanthanum chloride, rare earth salts (scandium salts, yttrium salts, lanthanum salts, cerium salts, praseodymium salts, neodymium salts, samarium salts, europium salts, gadolinium salts, terbium salts, dysprosium salts, holmium salts, erbium salts, thulium salts, ytterbium salts, lutetium salts are exemplified, and counterions are chloride salts, sulfates, nitrates, bromide salts, iodide salts, carbonates, phosphates, organic acid salts, hydroxides, etc.), examples of organic acid salts include salts of monovalent or divalent carboxylic acids and hydroxy acids, specifically, as hydroxy acids, lactic acid, gluconic acid, tartaric acid, citric acid, malic acid, salicylic acid, as monovalent or divalent carboxylic acids, acetic acid, propionic acid, malonic acid, succinic acid, glutaric acid, adipic acid, azelaic acid, sorbic acid, benzoic acid, etc., and phosphoric acid and its salts; binders: polysaccharides (xanthan gum, cellulose esters, cellulose ethers, carboxy methylcellulose, hydroxypropyl guar gum, guar gum, natural gum arabic, synthetic gum arabic, dextrin, starches, carrageenan, etc.), clays (organic clay, organic modified clay, inorganic clay, inorganic modified clay), minerals (bentonite), synthetic polymers (polycarboxylic acid or salts thereof, polyvinylpyrrolidone, polyvinyl acetate, polyvinyl alcohol, polyacrylic acid or its salts), wax (vegetable fats and oils, animal fats and oils, and derivatives thereof, paraffins, olefins, etc.)
Adhesives/spreading agents: surfactants and liquid carriers described above (esters (alkyl fatty acid esters, sorbitan fatty acid esters, ethoxylated fatty acid esters, ethoxysorbitan fatty acids, etc.), alcohols (ethoxylated fatty alcohols, ethoxyl sorbitan fatty alcohols, etc.), waxes (vegetable fats and oils, animal fats and oils, and derivatives thereof, paraffins, olefins, etc.), vegetable oils (alkylated vegetable oils, etc.), mineral oils (mineral oils, etc.), silicone emulsions, synthetic polymers (styrene-butadiene copolymer, methyl methacrylate-butadiene copolymer, polyacrylic acid or its salts, polyvinyl acetate, polyvinyl alcohol, polyvinylpyrrolidone, polyethylene glycol, polypropylene glycol, etc.), natural polymers (xanthan gum, cellulose esters, cellulose ethers, carboxymethylcellulose or its salts, dextrin, starches, guar gum, gum arabic, hydroxypropyl guar gum, tylose, etc.);
Lubricants/lubricants: alcohols which are described in the above-mentioned liquid carriers and surfactants, fatty acid esters, sucrose fatty acid esters, glycerin fatty acid esters, hydrocarbons, paraffins, ethylene wax, aliphatic amides, erucic acid amide, stearamide, oleic acid amide, methylenebisstearic acid amide, ethylenebisstearic acid amide, metallic soaps, lead stearate, zinc stearate, calcium stearate, magnesium stearate, mineral oils, vegetable oils, kerosene, diesel oil;
Anti-caking agents: solid carriers and liquid carriers which are described above, calcium phosphate, sodium phosphate, sodium carbonate, sodium silicate, calcium silicate, magnesium silicate, potassium aluminum silicate, silicon dioxide, talc, sodium aluminosilicate, calcium aluminosilicate, bentonite, stearic acid, dimethylpolysiloxane, powdered cellulose;
Light stabilizers: titanium oxide, zinc oxide, activated carbon, carbon black, ethylhexyl methoxycinnamate, tert-butyl methoxydibenzoylmethane, hindered amines, ferulic acid, phenyl hydroxybenzoate, ethyl para-aminobenzoate, octyl salicylate, salicylic acid-t-butylphenyl, 4-tert-octylphenyl salicylate, 2-cyano-3,3-diphenylprop-2-enoic acid-2-ethylhexyl ester (octocrylene), drometrizole trisiloxane, 2,4,6-Tris[4-(2-ethylhexyloxycarbonyl)anilino]-1,3,5-triazine (octyltriazone, TEAT), 2,2′-methylenebis[6-(2H-benzotriazol-2-yl)-4-(1,1,3,3-tetramethylbutyl)phenol](MBP), 2-ethylhexyl paradimethylaminobenzoate (EDB), homomenthyl salicylate (HS), phenylbenzimidazole sulfonic acid (PBS), hydroxy methoxybenzophenone sulfonic acid (oxybenzone 4, OXB4), sodium hydroxymethoxybenzophenone sulfonate (oxybenzone 5, OXB5), sodium dihydroxydimethoxybenzophenone disulfonate (oxybenzone 9, OXB9), tetrahydroxybenzophenone, dihydroxybenzophenone, dihydroxydimethoxybenzophenone, 2-hydroxy-4-methoxybenzophenone, 2-ethylhexyl dimethoxybenzylidene dioxoimidazolidine propionate, 2,4-dihydroxybenzophenone, bis(2-methoxy-4-hydroxy-5-benzoylphenyl)methane;
Fragrances: Hydrocarbons, α-limonene, β-caryophyllene, alcohols, cis-3-hexenol, linalool, farnesol, β-phenylethyl alcohol, aldehydes, 2,6-nonadienal, citral, α-hexyl cinnamic aldehyde, ketones, β-ionone, L-carvone, cyclopentadecanone, esters, linalyl acetate, benzyl benzoate, lactones, γ-undecalactone, phenols, eugenol, oxides, rose oxide, acetals, phenyl acetaldehyde dimethyl acetal, α-pinene, pβ-pinene;
Propellants: liquefied petroleum gas, aliphatic hydrocarbons having 3 to 5 carbon atoms such as propane, normal butane, isobutane, normal pentane and isopentane, hydrofluoroolefins such as trans-1,3,3,3-tetrafluoroprop-1-ene, trans-2,3,3,3-tetrafluoroprop-1-ene, dimethyl ether, nitrogen gas, carbon dioxide gas, nitrous oxide gas, compressed air, and mixtures thereof;
Fertilizers: nitrogenous fertilizer components (urea, ammonium nitrate, ammonium magnesium nitrate, ammonium chloride, ammonium sulfate, ammonium phosphate, sodium nitrate, calcium nitrate, potassium nitrate, lime nitrogen, formaldehyde processed urea (UF), acetaldehyde processed urea (CDU), isobutyraldehyde processed urea (IBDU), guanyl urea (GU)), phosphate fertilizer components (superphosphate of lime, double superphosphate of lime, fused phosphate, humic acid phosphate, calcined phosphate, heavily calcined phosphate, magnesium superphosphate, ammonium polyphosphate, potassium metaphosphate, calcium metaphosphate, magnesium phosphate, Sulfate-phosphate-ammonium, phosphate-nitrate-ammonium-potassium, chloride-phosphate-ammonium, etc.), potassium fertilizer components (potassium chloride, potassium sulfate, sodium potassium sulfate, magnesium potassium sulfate, potassium bicarbonate, potassium phosphate, etc.), silicate fertilizer components (calcium silicate, etc.), magnesium fertilizer components (magnesium sulfate, magnesium chloride, etc.), calcium fertilizer components (calcined lime, hydrated lime, calcium carbonate, etc.), manganese fertilizer components (manganese sulfate, manganese magnesium sulfate, manganese slugs, etc.), boron fertilizer components (boric acid, borates, etc.), iron-containing fertilizer components (steel slag, etc.), and other fertilizer components (copper, cobalt, zinc, etc.);
Filming agents: natural rubbers, synthetic rubbers, resins (styrene-butadiene copolymer, polyacrylonitrile, polyesters, polyamides, polyurethanes, polyureas, polyethers, rosin, melamine, etc.), waxes (vegetable fats and oils, animal fats and oils, and derivatives thereof, paraffins, olefins, etc.), polysaccharides (xanthan gum, cellulose esters, cellulose ethers, carboxymethylcellulose or its salts, dextrin, starches, guar gum, gum arabic, hydroxypropyl guar gum, tylose, starch xanthate, carrageenan, etc.), proteins (gelatin, etc.);
Deodorants: organic clays, organic modified clays, unmodified clays, zinc silicate, silica gel;
Plasticizers: triethyl phosphate, citrates, phthalates, adipates, sebacates, phosphates;
Desiccants/moisture-proof agents: silica gel, calcium chloride, calcined lime, aluminum oxide, zeolite, allophane;
Fumigant aids: nitrocellulose, potassium chlorate, calcium oxide, melamine, potassium nitrate, azodicarbonamide;
Attractants: sugars such as sucrose, glucose, granulated sugar, fructose, lactose, maltose, raw cane sugar, jaggery, light brown sugar molasses, honey, arabinose, galactose, sorbitose, etc., dairy products such as defatted milk, skim milk powder, cheese etc., grain powders such as starches derived from corn, potato and sweet potato, etc., wheat flour, rice flour, corn flour, potato flour etc., animal powders and insect powders of cattle, pig, fishes and shellfishes and insects etc., vegetable oils such as copra oil, cacao oil, corn oil, sesame oil, peanut oil, and salad oil, body fats which are mammal oils, butter fat, animal oils such as oils obtained from birds, reptiles, amphibians, insects, etc., seasoning agents such as sauces, vinegar, alcohols, etc., yeast extract, cellulose, dextrin, Z-9-tricosene;
Clathrating agents: cyclodextrins, α-cyclodextrin, β-cyclodextrin, γ-cyclodextrin;
Efficacy enhancers: liquid carriers and surfactants described above.

In particular, in the case of granules or fine granules, a colorant can be added in order to facilitate identification of the granules and fine granules during and after application. Also, when applying the composition B to plant seeds or vegetative reproduction organs, a colorant can be added in order to facilitate confirmation of application.

Examples of base materials for the resin formulations include polyethylene, polypropylene, polyvinyl alcohol, polycarbonates, polyesters, polyamides, polyurethanes, polyvinyl chloride, polyvinyl acetate, ethylene-vinyl acetate copolymer, ethylene-methyl methacrylate copolymer, Polyvinylpyrrolidone-methacrylic acid copolymers, polyvinylpyrrolidone-vinyl acetate copolymers, cellulose derivatives, phenol resins, melamine resins, epoxy resins, natural materials, etc. The polyesters include aliphatic polyesters such as polylactic acid, polyglycol, polybutylene succinate, poly-ε-caprolactone etc., and copolymers thereof, and aromatic polyesters. Examples of the natural materials include cotton, kapok, hemp, linen, ramie, hemp, jute, kenaf, manila hemp, sisal hemp, New Zealand hemp, luobuma fiber, Palm, rush, straw, pulp, wool, wool, mohair, cashmere, alpaca, angora, camel, vicuna, silk, down, feather, cellulose, cellulose nanofiber, etc. Auxiliary components such as phthalates (dimethyl phthalate, dioctyl phthalate, etc.), adipates, and stearic acid may be added to these base materials as necessary. The resin formulations can be processed as necessary by molding into various forms, examples of which include plate-shaped, film-shaped, sheet-shaped (single-layer, multi-layer), tape-shaped, thread-shaped, net-shaped, fabric-shaped, ring-shaped, tube-shaped, pipe-shaped, string-shaped, mat-shaped, block-shaped, etc., and as specific product forms, they can be used in the forms of quilt covers, pillowcases, protective covers, product packages, curtains, mattresses, sofa parts, animal collars, animal ear tags, clothes, prevention hats, arm/leg covers, attracting strings, agricultural and horticultural props, crop protection films, agricultural mulches, greenhouse films, screen doors, mosquito nets, garbage bags, nets for garbage area, drain nets, waste materials, trash cans, drainage materials, cushioning materials, foam materials, heat insulating materials, various tubes, waste pipes, packings, etc. They can be molded by kneading the composition B into a resin during molding process, and can also be obtained by molding a resin followed by subjecting the composition B to post-processing (coating, impregnation, etc.).

Examples of the base material for the poison baits include grain powders, vegetable oils, sugars, crystalline cellulose etc., and in addition, antioxidants such as dibutylhydroxytoluene and nordihydroguaiaretic acid etc., and preservation agents such as dehydroacetic acid etc., agents for preventing accidentally eating by children and pets such as chili pepper powder etc., attractive fragrances, etc., may be added as necessary.

The control can be achieved by applying an effective amount of natural pyrethrin, the composition A, or the composition B directly to a pest arthropod or to a place where the pest arthropod occurs. The place of occurrence mentioned here includes not only places where the pest arthropod has occurred, but also places where the pest is expected to occur and places where the pest may occur even if it is not expected to occur. Specific examples include plants, plant cultivation areas, plant cultivation carriers, spaces, interiors of architectural structures, outdoors, construction materials, foods, daily necessities, electronic goods, mechanical products, precision products, vehicles, animal bodies, etc.

In the present invention, the plants include whole plants and specific parts of plants. Examples of the specific parts of plants include foliage, flowers, ears, fruits, trunks, branches, crowns, seeds, vegetative reproduction organs and nursery plants.

The vegetative reproduction organ means a part among plant roots, stems, leaves and the like which has the ability to grow when the part is separated from the main body, followed by placing on soil. Examples of the vegetative reproduction organs include tuberous roots, creeping roots, bulbs, corms or solid bulbs, tubers, rhizomes, stolons, rhizophores, cane cuttings, propagules and vine cuttings. The stolons are sometimes referred to as runners, and the propagules are also referred to as Shuga, which are classified into broad buds and bulbils. The vine cuttings mean shoots (a collective term for leaves and stems) of sweet potato, Japanese yam, etc. The Bulbs, the corms or the solid bulbs, tubers, rhizomes, cane cuttings, rhizophores or tuberous roots are collectively referred to as Kyukon as well. Cultivation of potatoes starts by planting tubers in the soil, and the tubers used are generally referred to as seed potatoes.

The nursery plants include seedlings and saplings.

Examples of the plant cultivation areas include agricultural lands such as fields, paddy fields, and orchards, and non-agricultural lands such as lawns and forests.

The plant cultivation carriers are supports for plants, and may be materials on which plants can grow, and examples thereof include soil, seedling mats, and water. Specific materials of the soil and the seedling mats include sand, pumice, vermiculite, diatomaceous earth, gelatinous materials, polymeric materials, rock wool, glass wool, wood chips and bark.

Examples of the architectural structures include houses, condominiums, commercial facilities, shops, restaurants, company buildings, factories, offices, warehouses, livestock barns, vinyl greenhouses, public facilities (parks, stations, airports, harbor facilities, libraries, community centers, health centers, Hospitals, nursing homes, government offices, schools, kindergartens, nursery schools, sewage treatment facilities, waste treatment facilities, etc., and as transportation facilities, for example, railways, stations, vehicles, airports, ports, highways, interchanges, etc.), and as sports facilities and equipment, for example, baseball fields, soccer fields, golf courses, tennis courts, table tennis arenas, bowling alleys, billiard halls, bouldering alleys, gymnasiums, playgrounds, sumo rings, dojos, swimming pools, beaches, rivers, changing rooms, ski resorts, skating rinks etc., and as leisure facilities and equipment, for example, tents, lodges, campsites, barbecue areas, villas, hotels, inns, clubs with live music, music halls, dressing rooms, recreation halls, movie theaters, hot springs, public bathhouses, undressing rooms, restaurants, pubs, bars, hostess bars, karaoke boxes, supermarkets, department stores, shopping malls, etc. In addition, examples of the interiors of architectural structures include spaces, entrances, corridors, toilets, lavatories, baths, undressing rooms, verandas, balconies, roofs, attics, floors, ceilings, above ceilings, walls, stairs, doors, chimneys, garages, warehouses, windows, screen doors, sashes, storm doors, shutters, verandas, balconies, attic storages, underfloor storages, pantries, book rooms, underfloor heating, fireplaces, pillars, walls, wallpapers, closets, Japanese-style closets, vases, living rooms, bedrooms, and dining rooms.

Examples of the outdoors include grounds, gardens, outer walls, doors, roofs, chimneys, walls, bars, fences, outer ditches, spaces, waterways, vessels of water, water storage tanks, wells, puddles, rainwater drainage pits, sewage inlets, drainage pipes, rainwater pipes, septic tanks, waste tires, water storage ponds, rivers, waterways, forests, lakes and marshes, empty cans, empty bottles, waste containers, wastes, trash cans, garbage areas, etc.

Examples of the construction materials include woods, concretes, mortars, bricks, roof tiles, tiles, sidings, slates, plastics, glasses, wallpapers, heat insulating materials, packings, pipe arrangements, electrical cables, paints, and sealants. Among these, examples of the woods include woods processed for construction (high density wood, laminated wood, plywood and fiberboard, hardboard, MDF, insulation board, particle board, insulation hardboard, OSB, LSL, laminated timber, cross-laminated timber, flooring, composite flooring, etc.), and if necessary, a wood preservative can be added for the purpose of maintaining quality during use.

Examples of the wood preservatives include organic iodine compounds such as 3-iodo-2-propynyl-N-butylcarbamate, parachlorophenyl-3-iodopropargyl formal, and 3-diiodo-2-propenylethyl carbonate; triazole compounds such as cyproconazole ((2RS,3RS)-2-(4-chlorophenyl)-3-cyclopropyl-1-(1H-1,2,4-triazol-1-yl)butan-2-ol), hexaconazole ((RS)-2-(2,4-dichlorophenyl)-1-(1H-1,2,4-triazol-1-yl)hexan-2-ol), propiconazole ((RS)-1-[2-(2,4-dichlorophenyl)-4-propyl-1,3-dioxolan-2-ylmethyl]-1H-1,2,4-triazole), tebuconazole ((RS)-1-p-chlorophenyl-4,4-dimethyl-3-(1H-1,2,4-triazol-1-ylmethyl)pentan-3-ol), ipconazole ((1RS,2SR,5RS; 1RS,2SR,5SR)-2-(4-chlorobenzyl)-5-isopropyl-1-(1H-1,2,4-triazol-1-ylmethyl)-1-cyclopentanol), azaconazole (1-[[2-(2,4-dichlorophenyl)-1,3-dioxolan-2-yl]methyl]-1H-1,2,4-triazole), epoxiconazole ((2RS,3SR)-1-[3-(2-chlorophenyl)-2,3-epoxy-2-(4-fluorophenyl)propyl]-1H-1,2,4-triazole), metconazole ((1RS,5RS,1RS,5SR)-5-(4-chlorobenzyl)-2,2-dimethyl-1-(1H-1,2,4-triazol-1-ylmethyl)cyclopentanol), tetraconazole ((RS)-2-(2,4-dichlorophenyl)-3-(1H-1,2,4-triazole-1-yl)propyl-1,1,2,2-tetrafluoroethyl ether), penconazole (1-(2,4-dichloro-β-propylphenethyl)-1H-1,2,4-triazole), triadimefon (1-(4-chlorophenoxy)-3,3-dimethyl-1-(1H-1,2,4-triazol-1-yl)butan-2-one), bitertanol (1-(biphenyl-4-yloxy)-3,3-dimethyl-1-(1H-1,2,4-triazol-1-yl)butan-2-ol), myclobutanil (2-p-chlorophenyl-2-(1H-1,2,4-triazol-1-ylmethyl)hexanenitrile), diniconazole ((E)-(RS)-1-(2,4-dichlorophenyl)-4,4-dimethyl-2-(1H-1,2,4-triazole-1-yl)pent-1-en-3-ol), difenoconazole (cis, trans-3-chloro-4-[4-methyl-2-(1H-1,2,4-triazol-1-ylmethyl)-1,3-dioxolan-2-yl]phenyl-4-chlorophenyl ether), imibenconazole (4-chlorobenzyl-N-(2,4-dichlorophenyl)-2-(1H-1,2,4-triazole-1-yl)thioacetamidate), and triadimenol ((1RS,2RS,1RS,2SR)-1-(4-chlorophenoxy-3,3-dimethyl-1-(1H-1,2,4-triazol-1-yl)butan-2-ol).

Examples of the foods include agricultural products (cereals, fruits, spices, processed products thereof, etc.), livestock and aquatic products (meats, fishes, eggs, milk, processed products thereof, etc.). In addition, examples of the daily necessities include plant-derived products (cotton, paper, tobacco, and products processed thereof), animal-derived products (leathers, pelages, wool, feathers, silk, and processed products thereof), textile products (clothes, hats, gloves, socks, curtains, noren, bamboo blinds, bath mats, bathroom mats, doormats, kitchen mats, carpets, sofas, futons), furnitures (chairs, tables, desks, sofas, legless chairs, food shelves, cupboards, bookshelves, chests of drawers, etc.), and other products (stationeries, toys, tableware, shoes, umbrellas, garbage bags, trash cans, etc.). In addition, examples of the electronic goods include electric lights, lights, refrigerators, washing machines, vacuum cleaners, drying machines, TVs, telephones, personal computers, facsimiles, mobile phones, audio systems, speakers, stoves, water heaters, dishwashers, futon drying machines, dryers, hot carpets, stoves, heaters, kotatsu, air conditioners, massage chairs, outlets, game consoles, drones, etc.

Examples of the vehicles include bicycles, motorcycles, tricycles, cars (private cars, buses, taxis, limousine, baggage carriers, etc.), trains, electric trains, steam trains, subways, bullet trains, monorails, aircrafts, rockets, ships, etc.

Examples of living organisms include large animals (cattle, horses, pigs, sheep, goats, wild boars, bears, pandas, monkeys, elephants, giraffes, zebras, lions, tigers, leopards, cheetahs, bisons, hyenas, wolfs, raccoon dogs, foxes, etc.), ‘chicken, etc.), small animals (dogs, cats, rats, mice, guinea pig, hedgehogs, etc.), birds (chickens, quails, pigeons, sparrows, geese, ducks, dabblers, peacocks, swans, flamingos, parrots, parakeets, eagles, hawks, kites, etc.) and other organisms (snakes, frogs, lizards, crocodiles, newts, geckos etc.).

When the composition B is used for controlling pest arthropods in the agricultural field, the application amount can be changed widely depending on type of plants to be applied, type and frequency of occurrence of pest arthropods which are targets to be controlled, formulation type; application time; application method; application site; weather condition and the like. Generally, examples of the application amounts of the present compound or one of the present components include 1 to 10000 g, preferably 5 to 5000 g, more preferably 50 to 2000 g (specifically, for example, 100 g, 200 g, 300 g, 500 g) per hectare. When the composition B is formulated into an emulsifiable concentrate, a wettable powder, flowable formulations, etc., it is applied by diluting with water so that the concentration of the present compound or one of the present components may be usually 0.01 to 10000 ppm, preferably 0.1 to 5000 ppm, more preferably 1 to 1000 ppm (specifically, for example, 10 ppm, 100 ppm, 500 ppm). When the composition B is formulated into a granule, a dustable powder, etc., it is usually applied as it is.

These formulations and water dilutions of these formulations may be directly applied on a pest arthropod or plants such as crops to be protected from the pest arthropod, and may be applied to soil of a cropland in order to control a pest arthropod which occurs in the soil.

In addition, the composition B which is a resin formulation processed into sheet-shape or string-shape can be applied by methods such as wrapping it around plant crops, tack it across near the crops, or laying it on the soil at the plant foot.

When the composition B is used for controlling pest arthropods in the non-agricultural field, the application amount can be changed widely depending on type and frequency of occurrence of pest arthropods which are targets to be controlled, formulation type; application time; application method; application site; weather condition and the like.

Examples of specific application methods include, in the case of application to an architectural structure, applications to wall surfaces, floors, underfloors, ceilings, walls, floors, tatami mats, roofs, attics, doors, windows, screen doors, shutters, etc. of the architectural structure, applications to the indoor space of the architectural structure, and placing a poison bait or a resin formulation.

Examples of applications outdoors include applications to ground, outer walls, roofs, chimneys, walls, fences, and trenches, soil injections into underfloor or ground, applications to space, and applications of a granule, a resin formulation and the like into water.

Examples of applications to the construction materials include methods such as kneading into or embrocating on construction materials.

Examples of applications to the foods and the daily necessities include applications of an emulsifiable concentrate, a wettable powder, a flowable formulation, an oil formulation and the like on the wall surfaces, floors, and ceilings of places where the foods and the daily necessities are stored, applications of a smoking formulation, a fumigant and a fuming formulation to the spaces, placing a poison bait, a resin preparation and the like, kneading into and embrocating on the daily necessities, and applications of a dustable powder, an emulsifiable concentrate and the like.

Examples of applications to the woods include embrocating, spraying, immersion, impregnation, injection to the woods, mixing during wood processing, and mixing into an adhesive.

Examples of applications to the vehicles include applications to space and wall surfaces inside the vehicle and placing a poison bait and a resin formulation.

Examples of applications to the animal bodies include methods of oral administration by capsules, chewables, syrups, tablets, powders, and mixing into feeds and the like; methods of administration by suppositories, injections (intramuscular, subcutaneous, intravenous, intraperitoneal, etc.) and surgical means (implants, etc.); methods of spraying, embrocating, or dripping liquid formulations such as spot-on formulations, pour-on formulations, shampoo formulations, lotion formulations, and paste formulations; or method of using by processing resin formulations into collars, chains, ear tags, bracelets, rearing cages, rearing mats, rearing sheets, huts, hut fences, hut curtains, clothing and the like. In addition, examples of applications to the clothes include methods of wearing what is available as an already treated state, method of treating with a spray containing chemicals before wearing clothes and treating when washing and drying, and specific examples include shirts, suits, coats, belts, underwear, suitcases, bags, school bags, hats, gloves, masks, socks, shoes, ankles, bracelets, leg covers, arm covers, shoe covers, mufflers, stoles, towels, handkerchiefs, etc.

When the composition B is used for controlling pest arthropods in the non-agricultural field, the application amount in the case of applications on surfaces is, as an amount of one active ingredient per 1 m² of area to be applied, usually 0.01 to 1000 mg, preferably 10 to 500 mg, more preferably 20 to 400 mg (specifically, for example, 25 mg, 50 mg, 400 mg), and the application amount in the case of applications to spaces is, as an amount of one active ingredient per 1 m³ of apace to be applied, usually 0.01 to 500 mg. The application amount in the case of applications in water is, as an amount of one active ingredient per 1 liter of water volume is usually 0.001 to 1000 mg, more preferably 0.01 to 100 mg. The application amount in the case of applications to animal bodies is, as an amount of one active ingredient per 1 kg of animal body weight, usually within the range of 0.01 to 1000 mg. When the composition B is formulated into an emulsifiable concentrate, a wettable powder, a flowable formulation and the like, it is usually applied after diluting with water so that the concentration of one active ingredient may be 0.1 to 10,000 ppm. When it is formulated into an oil formulation and the like, it is applied as it is or after diluting with kerosene or light oil so that the concentration of one active ingredient may be usually 0.1 to 10000 ppm. Granules, dustable powders, aerosol formulations, smoking formulations, fumigants, poison baits, resin formulations and the like are applied as they are. Also, incense sticks are lit and applied. Electric mosquito mats, liquid mosquito formulations, fan type mosquito formulations, ultrasonic vibration type formulations, electrostatic spray type formulations and the like are usually applied using power sources or a batteries.

The composition B can be used in order to inhibit the biting behavior and unpleasant behavior of pest arthropods such as mosquitoes, flies and the like by applying to the body surface of humans and animals. It can also be used in order to inhibit generations and a growths of flies and the like which may occur in excrement by blending in feeds to administrate orally to animal bodies.

In addition, the composition B can be used for prevention of infestations of infectious diseases mediated by pest arthropods (malaria, dengue fever, West Nile fever, yellow fever, Zika fever, filariasis, onchocerciasis, leishmania, Chagas' disease, African sleeping sickness, etc.). Examples of specific application methods include applications of the composition B on the inner walls of houses (Indoor Residual Spray; IRS), applications to outdoor spaces (Space spray), wallpapers and mosquito nets treated with the composition B (Long lasting insecticidal net), poison baits, spawning traps, decoying and killing traps, space repellent devices, uses of automatic drug delivery devices, applications of the compound B to vessels of water, water storage ponds, mountain streams, etc. (measures against the source of pest insects, larvicide).

Examples of the application method of the composition B include foliage treatments, soil treatments, root treatments, shower treatments, smoke treatments, water surface treatments, hydroponic liquid treatments and seed treatments.

Examples of the foliage treatments include methods of applying the composition B to the surface of s foliage, a tree trunk, a fruit, a flower or a ear.

Examples of root treatments include methods of immersing the roots in a chemical liquid containing the composition B, and methods of adhering a solid formulation containing the composition B to the root part of the plant.

Examples of the soil treatments include spraying on soil, soil incorporation, and chemical liquid irrigations to soil. In addition, examples of a place where soil treatments may be performed include planting holes, rows, near planting holes, near rows, whole surface of cultivation areas, plant parts near ground, spaces between the plants, under tree trunks, ridges on main trunks, culture soils, seedling boxes, seedling trays, nursery beds, and the like. Examples of treatment timings includes before sowing, at sowing, after sowing, during raising seedlings, before planting, at planting, and during growing season after planting. In the above soil treatments, the composition B may be applied to the plants at the same time, or a solid fertilizer such as a paste fertilizer containing the composition B may be applied to the soil. In addition, it may be mixed with an irrigation liquid, and examples thereof include injections into irrigation equipment (irrigation water tubes, irrigation water pipes, sprinklers, etc.), incorporating into inter-row flooding liquid, incorporating into hydroponic liquid, and the like. Further, an irrigation liquid and an active ingredient can be mixed in advance and applied by, for example, the above irrigation method or other appropriate irrigation methods such as sprinkling and flooding.

Examples of the shower treatments include methods of showering a diluted liquid of the composition B onto harvested fruits.

Examples of the smoke treatments include methods in which a mist of a diluted liquid of the composition B is generated to disperse into the air, followed by adhering to foliage of plants or fruits.

Examples of the water surface treatments include methods of applying a chemical liquid containing the composition B or a solid formulation containing the composition B on flooded paddy fields.

Examples of the hydroponic liquid treatments include methods of incorporating or mixing a chemical liquid containing the composition B or a solid formulation containing the composition B into a hydroponic liquid (hydroponic liquid incorporating treatment, hydroponic liquid mixing treatment, etc.).

### Seed Treatment

The seed treatments mean applications of the composition B to seeds or vegetative reproduction organs. Examples of methods of the seed treatments with the composition B include spraying treatments in which a mist of a suspension of the composition B is generated to spray on the surface of seeds or the surface of vegetative reproduction organs, smear treatments in which the composition B is applied to seeds or vegetative reproduction organs, immersion treatments in which seeds are immersed in a chemical liquid of the composition B for a certain period of time, and methods of coating seeds or vegetative reproduction organs with a carrier containing the composition B (film coating treatment, pellet coating treatment, etc.). Examples of the vegetative reproduction organs mentioned above include in particular, seed potatoes.

When the composition A is applied to seeds or vegetative reproduction organs, the composition A can be applied as a single formulation to the seeds or the vegetative reproduction organs, or the composition A can be applied more than once separately as a plurality of different formulations to the seeds or the vegetative reproduction organs. Examples of the methods of applying the composition A more than once separately as a plurality of different formulations include methods in which a formulation containing only the present compound as an active ingredient is applied, followed by air-drying seeds or vegetative reproduction organs, and then applying a formulation containing the present component; and methods in which a formulation containing the present compound and the present component as active ingredients, followed by air-drying the seeds or the vegetative reproduction organs, and then applying a formulation containing the other present component than the present component which has already applied.

After the seed treatments, an active ingredient may completely or partially cover seeds or vegetative reproduction organs, may be interspersed on their surface, and/or may be present inside thereof. In the case of treatment, it is preferable to use, among the compositions B, a composition containing one or more of the present component having fungicidal activity selected from the groups (b) and (j) particularly. In this case, commercially available seeds or vegetative reproduction organs treated with one or more of the present component having fungicidal activity selected from the groups (b) and (j) may be treated with the present compound.

When the composition B is applied to seeds or vegetative reproduction organs, manganese, copper, zinc and the like may be applied at the same time.

In the case of the seed treatments with the composition B, the application amount of the composition B is usually 0.001 to 100 g, preferably 0.02 to 50 g per 1 kg of seeds or vegetative reproduction organs, and the application amount of one active ingredient contained in the composition B is usually 0.001 to 100 g, preferably 0.01 to 50 g, more preferably 0.1 to 10 g per 1 kg of seeds or vegetative reproduction organs and specifical examples include the application amounts below.
0.05 g of active ingredient per 1 kg of seeds or vegetative reproduction organs;
0.5 g of active ingredient per 1 kg of seeds or vegetative reproduction organs;
5 g of active ingredient per 1 kg of seeds or vegetative reproduction organs.

A seed or a vegetative reproduction organ retaining the present compound or the composition A in the present invention means a state in which the present compound or composition A is attached to the surface of the seed or the vegetative reproduction organ. The seed or the vegetative reproduction organ retaining the present compound or the composition A mentioned above may allow to be adhered by materials other than the present compound or the composition A before or after the present compound or the composition A is attached to the seed or the vegetative reproduction organ.

In addition, when the composition A adheres to the surface of a seed or a vegetative reproduction organ as a coat, the coat consists of one layer or a plurality of layers. Also, when it consists of a plurality of layers, each layer is a layer containing one or more active ingredients, or consists of a layer containing one or more active ingredients and a layer not containing an active ingredient.

The seeds or the vegetative reproduction organs retaining the present compound or the composition A can be obtained by, for example, applying the composition B containing the present compound or the composition A to the seeds or the vegetative reproduction organs using the seed treatment methods described above.

As seed treatment formulations, DS, ES, FS, LS, WS, CF, GF, SS and the like are generally known, but CS, EG, EW, GW, ME, OD, OF, SC, SE, SG, SL, SP, ST, WG, WP, WT, ZC, ZE, ZW and the like can also be used. In these formulations, one of the present compound or the present component is contained at a weight ratio of 0.01 to 70%, preferably 0.1 to 50%. When these formulations are applied to seeds or vegetative reproduction organs, they may be used as they are or may be used after being diluted with water. When a formulation diluted with water is applied to seeds or vegetative reproduction organs, it can be diluted arbitrarily according to the active ingredient content in the formulation and the amount of active ingredient to be retained on the seeds or the vegetative reproduction organs, but generally it is often used after being diluted 2 to 1000 times.

When treating seeds, it can be applied to the seeds before sowing or can be applied to the seeds after germination.

When the present compound or the composition A is applied to seeds, an adjuvant such as colorants or binders may be mixed when formulating, or may be further mixed when the composition B after formulating is applied to seeds.

The colorants facilitates confirmation of whether the composition B has been able to be applied to each seed or vegetative reproduction organ. The binders may also be added to improve the adherence of the active ingredient to the seeds or the vegetative reproduction organs. Examples of specific colorants and binders are shown below.
Colorants: e.g. monoazos (Pigment Red 48:1, Pigment Red 48:2, Pigment Red 53:1, Pigment Red 57:1, Pigment Red 112, Pigment Brown 25, C.I. Solvent Red 1, Pigment Yellow 1, Pigment Orange 5, Acid Red 14, Acid Yellow 23, etc.), disazos (Pigment Yellow 13, Pigment Orange 34, etc.), phthalocyanines (Pigment Blue 15:1, Pigment Blue 15:2, Pigment Blue 15:3, Pigment Blue 15:4, Pigment Green 7, Pigment Green 36, etc.), anthraquinones (Pigment Red 83, etc.), dioxazines (Pigment Blue 80, etc.), xanthenes (Basic Violet 10 (Rhodamine B), Acid Red 51, Acid Red 52, etc.), triarylmethanes (acid blue 9, etc.), Pigment Orange 43, iron oxide, titanium, titanium oxide, zinc oxide, zinc sulfide, iron hexacyanoate, chrome vermillion, lead yellow, calcium carbonate, barite powder, aluminum powder;
Binders: polysaccharides (xanthan gum, cellulose esters, cellulose ethers, carboxymethylcellulose, hydroxypropyl guar gum, guar gum, natural gum arabic, synthetic gum arabic, dextrin, starches, carrageenan, etc.), clays (organic clays, organic modified clays, inorganic clays, inorganic modified clays, etc.), minerals (bentonite, etc.), synthetic polymers (polycarboxylic acids or salts thereof, polyvinylpyrrolidone, polyvinyl acetate, polyvinyl alcohol, polyacrylic acid or its salts, styrene-butadiene copolymer, methyl methacrylate-butadiene copolymer, polyacrylic acid or its salts, polyvinyl acetate, polyvinyl alcohol, polyvinylpyrrolidone, polyethylene glycol, polypropylene glycol, etc.), waxes (vegetable fats and oils, animal fats and oils, and derivatives thereof, paraffins, olefins, etc.).

When applying the composition B to seeds or vegetative reproduction organs, an adjuvant may be mixed with the composition B as necessary.

The seeds or vegetative reproduction organs treated with composition B are sown or planted in the field in a usual way.

When the composition B is used for controlling pest arthropods, the present compound and the present component may be applied to separate sites, and specifically, for example, before or after seeds or vegetative reproduction organs treated with either the present compound or the present component are planted in a cultivation carrier (e.g. soil and the like), the other may be applied to the cultivation carrier.

When performing foliage treatments, soil treatments, root treatments, shower treatments, smoke treatments, water surface treatments, seed treatments and hydroponic liquid treatments of the composition B, the composition B may be used in combination with an adjuvant. The type of the adjuvant is not particularly limited, but its examples include oil-based adjuvants such as AgriDex and MSO, nonionic adjuvants (esters or ethers of polyoxyethylene) such as Induce, anionic adjuvants (substituted sulfonate) such as Gramine S, cationic adjuvants (polyoxythyleneamine) such as Genamin T 200BM, and organic silicon-based adjuvants such as Silwett L77. Furthermore, a drift reducing agent such as Intact (polyethylene glycol) may be mixed to use.

When the composition B is applied in the form of a solution, the pH and hardness of the solution are not particularly limited, but the pH is usually within a range of 5 to 9, and the hardness is usually within a range of 0 to 500. The time period for applying the composition B is not particularly limited, but it is usually within a range of 5 AM to 9 PM. The photon flux density at the canopy level at the place where the composition B is applied is usually 10 to 2,500 micromole/m²/sec.

When a sprayer is used for applying the composition B, a spray pressure is not particularly limited, but it is usually 30 to 120 PSI and preferably 40 to 80 PSI. Here, the spray pressure is a set value just before introduction into the nozzle.

The composition B can be applied by a spot treatment. The spot treatment is a concept opposite to uniform treatment of the composition B and means a treatment of selectively spraying the composition B to a place where a pest arthropod occurs or a place where the pest arthropod may occur. The term “treatment to a place” means that treating plants or soil where a pest arthropod occurs or a pest arthropod may occur, but the case of treating plants is preferable. In the case of treating plants, it includes treating only individuals where pest arthropods occur or may occur in the group of individuals of the plants, and also includes treating a part in which pest arthropods occur or may occur in an individual of the plants.

A case where the composition B is somewhat sprayed due to spray drift, evaporation, or the like to a place where no pest arthropods occur or a place pest arthropods is no likely to occur is also included in the spot treatment as long as the treatment is not an uniform blanket treatment. In addition, it is not only a case where all of the places where pest arthropods occur or the places where pest arthropods may occur are selectively treated in a continuous cultivation area to be regarded as the spot treatment. In other words, a case where a part of the cultivation area is subjected to a blanket treatment, or even a case where a part of the place where pest arthropods occur or a part of the place where pest arthropods may occur is not treated with the composition B is included in the spot treatment as long as there is a spot-treated place in the continuous cultivation area.

The methods of the spot treatment will be specifically described below. The spot treatment may be performed such that, in the cultivation area of plants, a spraying person walks or gets on a ground-traveling equipment or a flight equipment in order to spray the composition B visually using a handheld nozzle or a robotic arm nozzle. Further, the spot treatment may be performed by mapping places where pest arthropods occur or may occur in advance, and spraying the composition B based on the map information. In the spraying based on the map information, in addition to the above method, the spot treatment may be performed such that, during traveling or flight of a sprayer, a nozzle on a boom or a robotic arm nozzle is automatically or manually opened and closed based on the position information of the sprayer (obtained by GPS or the like) and the map information. The map information may be created based on image information captured by a manned or unmanned flying object or the like, or may be created visually by an observer walking on the ground, an observer riding on a ground-traveling equipment, or an observer riding on a flight equipment. Further, the sprayer that travels or flies may have a function of detecting a place where pest arthropods occur or a place where pest arthropods may occur, and the spot treatment may be performed by the boom, the robotic arm, or the like while performing real-time mapping.

Places where pest arthropods occur can be recognized by visual recognition by a spraying person or an observer, as well as by image analysis using visible light, but may be recognized by image analysis of Hyperspectral images using specific wavelength. Image analysis may be a form in which occurrence of pest arthropods is recognized by checking visually the screen, but it is also possible to use image recognition by artificial intelligence (for example, press release of OPTiM CORPORATION on Dec. 26, 2017). These images may be taken by a manned or unmanned flying object or the like, or may be taken by a photographer walking on the ground, a photographer riding on a ground-traveling equipment, a photographer riding on a flight equipment, or the like. The places where pest arthropods may occur may be estimated based on the fact that the pest arthropods occurred in patches during the past cultivation season of crops, or may be estimated from a distribution of the pest arthropods in soil. The distribution of the pest arthropods in soil may be investigated by soil sampling or estimated by remote sensing. Also, it may be estimated by detecting the fact that the pest arthropods are latent in plants using image analysis. These techniques are known as a form of emerging agriculture called precision agriculture, smart agriculture, digital agriculture, or the like, and the non-uniform spraying manner generated by the spot treatment may also be referred to as variable rate application (VRA) as a term in the emerging agriculture.

Examples of methods of spot treatment of the composition B include a method of spraying it on the soil of a place where pest arthropods occur or the soil of a place where pest arthropods may occur (soil treatment), and a method of spraying the composition B to a plant where pest arthropods occur or a plant where pest arthropods may occur (foliage treatment). Spraying is usually carried out using a spray liquid prepared by mixing the composition B with water. Although the amount of the spray liquid is not particularly limited, it is usually 50 to 1000 L/ha, preferably 100 to 500 L/ha, more preferably 140 to 300 L/ha inside spot-treated section. The proportion of the area subjected to the spot treatment in the cultivation area of a plant (proportion of the area to which the composition B is sprayed, relative to the entire area of the continuous cultivation area) is usually 1 to 99%, and preferably 10 to 80%. Specific examples of the proportion include 20%, 30%, 40%, 50%, 60%, and 70%.

When performing a spot treatment, the application amount of the composition B is 5 to 2000 g per 1 ha, preferably 50 to 1500 g per 1 ha, more preferably 200 to 1000 g per 1 ha, and still more preferably 400 to 700 g per 1 ha, as the application amount of one active ingredient inside spot-treated section.

When a spot treatment is performed, an adjuvant may be mixed to use. The type of the adjuvant is not particularly limited, but its examples include oil-based adjuvants such as AgriDex and MSO, nonionic adjuvants (esters or ethers of polyoxyethylene) such as Induce, anionic adjuvants (substituted sulfonate) such as Gramine S, cationic adjuvants (polyoxythyleneamine) such as Genamin T 200BM, and organic silicon-based adjuvants such as Silwett L77. Furthermore, a drift reducing agent such as Intact (polyethylene glycol) may be mixed to use.

The aforementioned pH and hardness of the spray liquid are not particularly limited, but the pH is usually within a range of 5 to 9, and the hardness is usually within a range of 0 to 500.

The time period for performing the spot treatment is not particularly limited, but it is usually within a range of 5 AM to 9 PM, and the photon flux density at the canopy level at the place where the spot treatment is carried out is usually 10 to 2,500 micromole/m²/sec. Meanwhile, the spot application can also be carried out at night using the aforementioned map information and the position information.

A spray pressure when performing a spot treatment is not particularly limited, but it is usually 30 to 120 PSI and preferably 40 to 80 PSI. Here, the spray pressure is a set value just before introduction into the nozzle.

The methods of treating with the composition B is more particularly referred to as planting hole treatments (planting hole spraying, planting hole treatments and soil incorporation), plant foot treatments (plant foot spraying, plant foot soil incorporation, plant foot irrigation, plant foot treatment in late seedling growing season), planting trench treatments (planting trench spraying, planting trench soil incorporation), planting row treatments (planting row spraying, planting row soil incorporation, planting row spraying in growing season), planting row treatments at sowing (planting row spraying at sowing, planting row soil incorporation at sowing), overall treatments (overall soil spraying, overall soil incorporation), side row treatments, water surface treatments (water surface application, water surface application after flooding), other soil spray treatments (foliar application of granules in growing season, spraying under crowns or around main trunks, soil surface spraying, soil surface incorporation, seed hole spraying, spraying to ground surface of ridges, splaying to spaces between plants), other irrigation treatments (soil irrigation, irrigation during raising seedlings, chemical liquid injection treatment, irrigation to plant parts near ground, chemical liquid drip irrigation, chemigation), seedling box treatments (seedling box spraying, seedling box irrigation, flooding seedling box with chemical liquid), seedling tray treatments (seedling tray spraying, seedling tray irrigation, flooding seedling tray with chemical liquid), nursery bed treatments (nursery bed spraying, nursery bed irrigation, flooded nursery bed spraying, seedling immersion), bed soil incorporation treatments (bed soil incorporation, pre-sowing bed soil incorporation, spraying during sowing before covering with soil, spraying during sowing after covering with soil, cover soil incorporation), and other treatments (culture soil incorporation, plowing-in, surface soil incorporation, soil incorporation below end of canopy, planting position treatment, applying granule to flower truss, incorporation paste fertilizer, hydroponic liquid incorporation, hydroponic fluid mixing) etc.

Examples of plants for which the composition B can be used include the following.
Agricultural crops; corns (dent corn, flint corn, flour corn, pop corn, waxy corn, sweet corn, field corn), rice (long-grain rice, short-grain rice, medium-grain rice, japonica rice, tropical japonica rice, indica rice, javanica rice, paddy rice, upland rice, floating rice, rice for direct sowing, rice for transplanting, glutinous rice), wheats (bread wheat (hard wheat, soft wheat, medium wheat, red wheat, white wheat), durum wheat, spelt wheat, club wheat, and winter wheat types and spring wheat types thereof), barleys (two-row barley (=beer barley), six-row barley, naked barley, glutinous barley, and winter barley type and spring barley type thereof), ryes (winter rye type and spring rye type), triticales (winter triticale type and spring triticale type), oats (winter oat type and spring oat type), sorghum, cottons (upland cotton, pima cotton), soybeans (varieties for harvesting ripe seed, edamame varieties, green-cut varieties, and indeterminate growth type, determinate growth type and semi-determinate growth type thereof), groundnut (peanut), saito (kidney bean), lima bean, adzuki bean, cowpea, mung bean, black gram, scarlet runner bean, ricebean, moth bean, tepary bean, fava bean, pea, chickpea, lentil, lupine, pigeon pea, alfalfa, buckwheat, sugar beets (for sugar production, for feeding stuff, root vegetables, leafy vegetables, fuels), rapeseeds (winter rapeseed type and spring rapeseed type), canolas (winter canola type and spring canola type), sunflowers (for oil extraction, edible use, ornamental use), sugar cane, tobacco, tea tree, mulberry, etc.,
Vegetables: solanaceous vegetables (eggplant, tomato, green pepper, hot pepper, bell pepper, potato, etc.), cucurbitaceous vegetables (cucumber, pumpkin, zucchini, watermelon, melon, squash, etc.), cruciferous vegetables (daikon radish, turnip, horseradish, Kohlrabi, Chinese cabbage, cabbage, mustard, broccoli, cauliflower, etc.), Asteraceous vegetables (burdock, garland chrysanthemum, artichoke, lettuce, etc.), liliaceous vegetables (green onion, onion, garlic, asparagus, etc.), umbelliferous vegetables (carrot, parsley, celery, parsnip, etc.), chenopodiaceous vegetables (spinach, chard, etc.), Labiatae vegetables (Japanese basil, mint, basil, lavender, etc.), strawberry, sweet potato, Japanese yam, taro, etc.,
Orchard trees: pomaceous fruits (apple, pear, Japanese pear, Chinese pear, Chinese quince, quince, etc.), stone fruits (peach, plum, nectarine, ume, cherry, apricot, prune, etc.), citrus fruits (satsuma, orange, lemon, lime, grapefruit, etc.), nuts (chestnut, walnut, hazelnut, almond, pistachio, cashew nut, macadamia nut, etc.), berries (blueberry, cranberry, blackberry, raspberry, etc.), grape, persimmon, fig, olive, loquat, banana, coffee, date palm, coconut palm, etc.,
Ornamental plants; flowering trees and shrubs, roadside trees (Japanese ash, birch, Eastern flowering dogwood, eucalyptus, ginkgo, lilac, maple, oak, poplar, Chinese redbud, Formosan sweetgum, plane tree, Japanese zelkova, Japanese arborvitae, fir tree, southern Japanese hemlock, juniper, pine, spruce, Japanese yew), flowers, foliage plants, lawn grasses.

The aforementioned plants are not limited as long as they are varieties that are generally cultivated.

The aforementioned plants may be plants producible by natural crossing, plants producible by a mutation, F1 hybrid plants, or transgenic plants (also referred to as genetically modified plants). These plants generally have characteristics such as tolerance to herbicides, accumulation of a substance toxic to a pest (also referred to as a pest resistance), reduction in sensitivity to a disease (also referred to as a plant disease resistance), increase in yield potential, improvement in tolerance to a biotic or an abiotic stress factor, accumulation of a substance (e.g. increasing or decreasing the content of a specific component, changing a composition, improving storage stability or processability), and modification of harvest period (e.g. very early ripening, early ripening, middle ripening, late ripening, very late ripening).

The F1 hybrid plants are those which are each a first filial hybrid obtained by crossing two different varieties with each other and generally have characteristics of heterosis, which is a nature of having more excellent trait than both of the parents. The transgenic plants are plants which has been endowed with characteristics like those that cannot be easily obtained by crossbreeding, mutation induction, or natural recombination in natural environments by introducing an exogenous gene from other organisms such as microorganisms.

Examples of the techniques used to create the above plants include conventional type variety improvement techniques; genetic engineering techniques; genomic breeding techniques; new breeding techniques; and genome editing techniques. The conventional type variety improvement techniques are specifically techniques for obtaining plants having desired properties by mutation and crossing. The genetic engineering techniques are techniques in which a target gene (DNA) is extracted from a certain organism (e.g. microorganism) to introduce it into a genome of a different target organism, thereby imparting new properties to the organism, and antisense techniques or RNA interference techniques for imparting new or improved characteristics by silencing other genes existing in plants. The genomic breeding techniques are those improving breeding efficiency by using genome information and include DNA marker (also referred to as genomic markers or genetic markers) breeding techniques and genomic selection. For example, the DNA marker breeding is a method in which a progeny having a target gene with a useful trait is selected from a lot of cross progenies by using a DNA marker which is a DNA sequence and is a marker of the presence position of a gene with a specific useful trait on a genome. It has the characteristics that the time required for breeding can be effectively reduced by analyzing the cross progeny using a DNA marker when the progeny is a juvenile plant.

Also, the genomic selection is a method in which a prediction formula is created from a phenotype obtained in advance and genome information to predict the characteristics from the prediction formula and the genome information without any evaluation of the phenotype and is a technique contributing to improvement in efficient breeding. The new breeding techniques are a generic term of variety improvement (breeding) techniques that are combinations of molecular biological techniques. Examples thereof include cisgenesis/intragenesis, oligonucleotide-directed mutagenesis, RNA-dependent DNA methylation, genome editing, grafting onto a GM rootstock or scion, reverse breeding, agroinfiltration, and seed production technology (SPT). The genome editing techniques are those in which genetic information is transformed in a sequence-specific manner which enables, for example, deletion of a base sequence, substitution of an amino acid sequence, and introduction of an exogenous gene. Examples of tools for these techniques include zinc-finger nuclease (Zinc-Finger Nucleases, ZFN, ZFNs), TALEN, CRISPR/Cas9, CRISPER/Cpf1, and Meganuclease which each enable sequence-specific DNA scission. Also there is sequence-specific genome modification techniques such as CAS9 nickase and Target-AID which are created by modifying the aforementioned tools.

Examples of the aforementioned plants include plants listed in GM APPROVAL DATABASE of genetically modified crops in the electronic information site (http://www.isaaa.org/) of INTERNATINAL SERVICE for the ACQUISITION of AGRI-BIOTECH APPLICATIONS (ISAAA). More specific examples thereof include herbicide-tolerant plants, pest insect-resistant plants, disease-resistant plants, plants product quality of which has been modified (e.g. increasing or decreasing the content of a component, changing a composition, improving storage stability or processability), fertility trait modified plants, abiotic stress-tolerant plants, and plants in which traits related to growth and yield are modified.

Examples of plants to which herbicide tolerance has been imparted include the following.

Examples of mechanisms of herbicide tolerance include reducing the compatibility of a herbicide with its target; a rapid metabolism (e.g., breakdown or modification) resulting from expression of a herbicide deactivation enzyme; inhibiting the incorporation of a herbicide into a plant body; and inhibiting the transfer of a herbicide in a plant body.

Examples of plants to which herbicide tolerance has been imparted by the genetic engineering techniques include plants to which a tolerance to protoporphyrinogen oxidase (hereinafter abbreviated as PPO) inhibitors such as flumioxazin; 4-hydroxyphenylpyruvate dioxygenase (hereinafter abbreviated as HPPD) inhibitors such as isoxaflutole and mesotrione; acetolactate synthase (hereinafter abbreviated as ALS) inhibitors such as imidazolinone herbicides including imazethapyr and sulfonylurea herbicides including thifensulfuron-methyl; 5-enolpyruvylshikimate-3-phosphate synthase (hereinafter abbreviated as EPSPS) inhibitors such as glyphosate; glutamine synthetase inhibitors such as glufosinate; auxin type herbicides such as 2,4-D and dicamba; or oxynil herbicides such as bromoxynil has been imparted.

Preferred herbicide-tolerant transgenic plants are kinds of Mugi such as wheat, barley, rye, oat, canola, sorghum, soybean, corn, cotton, rice, rapeseed, sugar beet, sugar cane, grape, lentil, sunflower, alfalfa, pomaceous fruits, stone fruits, coffee, tea, strawberry, lawn grass, vegetables such as tomato, potato, cucumber, lettuce, more preferably kinds of Mugi such as wheat, barley, rye, oat, soybean, corn, rice, grape, tomato, potato and pomaceous fruits.

Specific herbicide-tolerant plants are shown below.

Glyphosate herbicide-tolerant plants: They are obtained by introduction of at least one of the glyphosate tolerant EPSPS gene (CP4 epsps) derived from Agrobacterium tumefaciens strain CP4, the glyphosate N-acetyltransferase gene (gat 4601 or gat 4621) which is the modified glyphosate N-acetyltransferase gene derived from Bacillus licheniformis, the glyphosate oxidase gene (goxv 247) derived from Ochrobacterum anthropi strain LBAA, or the EPSPS gene having a glyphosate-tolerant mutation derived from corn (Zea mays) (mepsps or 2mepsps). Examples of main plants include alfalfa (Medicago sativa), Argentina canola (Brassica napus), cotton (Gossypium hirsutum L.), creeping bentgrass (Agrostis stolonifera), corn (Zea mays L.), polish canola (Brassica rapa), potato (Solanum tuberosum L.), soybean (Glycine max L.), sugar beet (Beta vulgaris), and wheat (Triticum aestivum). Some glyphosate-tolerant plants are commercially available. For example, genetically modified plants to which CP4 epsps has been introduced are sold under the trade names including “Roundup Ready (registered trademark)”, genetically modified plants to which gat4601 or gat 4621 has been introduced are sold under the trade names such as “Optimum GAT (trademark)” and “Optimum (registered trademark) Gly canola”, and genetically modified plants to which mepsps or 2mepsps has been introduced are sold under the trade name of “GlyTol (trademark)”. As more specific glyphosate-tolerant plants, for example, corns are sold under the trade names such as “Roundup Ready (trademark) Maize”, “Roundup Ready (trademark) 2 Maize”, “Agrisure (trademark) GT”, “Agrisure (trademark) GT/CB/LL”, “Agrisure (trademark) GT/RW”, “Agrisure (trademark) 3000GT”, “YieldGard (trademark) VT (trademark) Rootworm (trademark) RR2” and “YieldGard (trademark) VT Triple”; soybeans are sold under the trade names such as “Roundup Ready (trademark) Soybean” and “Optimum GAT (trademark)”; cottons are sold under the trade names such as “Roundup Ready (trademark) Cotton”, “Roundup Ready (trademark) Flex Cotton” and “GlyTol (trademark)”; canolas are sold under the trade names such as “Roundup Ready (trademark) Canola” and “Optimum (registered trademark) Gly canola”; alfalfas are sold under the trade name of “Roundup Ready (trademark) Alfalfa”; rices are sold under the trade name of “Roundup Ready Rice”; sugarcanes are sold under the trade names such as “Roundup Ready (trademark) sugarbeet” and “InVigor (trademark) sugarbeet”; and wheats (Triticum aestivum) are sold under the trade name of “Roundup Ready (trademark) wheat”.

Glufosinate herbicide-tolerant plants: They are obtained by introduction of at least one of the Phosphinothricin N-acetyltransferase (hereinafter abbreviated as PAT) gene derived from Streptomyces hygroscopicus (bar), the PAT gene derived from Streptomyces viridochromogenes (pat), or the synthesized PAT gene derived from Streptomyces viridochromogenes strain Tu494 (pat syn). Examples of main plants include Argentina canola (Brassica napus), chicory (Cichorium intybus), cotton (Gossypium hirsutum L.), corn (Zea mays L.) polish canola (Brassica rapa), rice (Oryza sativa L.), soybean (Glycine max L.), and sugar beet (Beta vulgaris). Some glufosinate-tolerant plants are commercially available. For example, genetically modified plants to which bar or pat has been introduced are sold under the trade name such as “LibertyLink (trademark)”, “InVigor (trademark)”, and “WideStrike (trademark)”. As more specific glufosinate-tolerant plants, for example, corns are sold under the trade names such as “Roundup Ready (trademark) 2”, “Liberty Link (trademark)”, “Herculex (trademark) I”, “Herculex RW”, “Herculex XTRA (trademark)”, “Agrisure (trademark) GT/CB/LL”, “Agrisure (trademark) CB/LL/RW” and “Bt10”; cottons are sold under the trade name of “FiberMax (trademark) Liberty Link (trademark)”; rices are sold under the trade name of “Liberty Link (trademark) Rice”; canolas are sold under the trade name of “inVigor (trademark) Canola”; soybeans are sold under the trade name of “Liberty Link (trademark) Soybean”; and sugar canes are sold under the trade name of “Liberty Link (Trademark) sugarbeet”.

Oxynil herbicides (e.g., bromoxynil) tolerant plants: They are obtained by introducing the nitrilase gene derived from Klebsiella pneumoniae subsp. Ozaenae (bxn). Examples of main plants include Argentina canola (Brassica napus), cotton (Gossypium hirsutum L.), and tobacco (Nicotiana tabacum L.). Some oxynil herbicides-tolerant plants are commercially available. For example, they are sold under the trade names including “Navigator (trademark)” and “BXN (trademark)”. As more specific oxynil herbicide-tolerant plants, for example, cottons are sold under the trade name of “BXN (trademark) Cotton”; and Argentina canola is sold under the trade name of “Navigator (trademark) Cotton”.

ALS herbicide-tolerant plants: Carnation (Dianthus caryophyllus) to which the ALS herbicide-tolerant ALS gene derived from tobacco (Nicotiana tabacum) (surB) as a selective marker has been introduced, is sold under the trade names such as “Moondust (trademark)”, “Moonshadow (trademark)”, “Moonshade (trademark)”, “Moonlite (trademark)”, “Moonaqua (trademark)”, “Moonvista (trademark)”, “Moonique (trademark)”, “Moonpearl (trademark)”, “Moonberry (trademark)”, and “Moonvelvet (trademark)”. Flax (Linum usitatissumum L.) to which the ALS herbicide-tolerant ALS gene derived from thale cress (Arabidopsis thaliana) (als) has been introduced is sold, for example, under the trade name of “CDC Triffid Flax”. Corn (Zea mays L.) tolerant to sulfonylurea and imidazolinone herbicides to which the ALS herbicide-tolerant ALS gene derived from corn (zm-hra) has been introduced is sold, for example, under the trade name of “Optimum GAT (trademark). Soybean tolerant to imidazolinone herbicide to which the ALS herbicide tolerant ALS gene derived from thale cress (csrl-2) has been introduced is sold, for example, under the trade name of “Cultivance”. Soybean to which the ALS herbicide-tolerant ALS gene derived from soybean (Glycine max) (gm-hra) has been introduced is sold, for example, under the trade names such as “Treus (trademark)”, “Plenish (trademark)” and “Optimum GAT (trademark)”. In addition, there is cotton to which the ALS herbicide-tolerant ALS gene derived from tobacco (Nicotiana tabacum cv.Xanthi) (S4-HrA) has been introduced.

HPPD herbicide-tolerant plants: They are obtained by introducing the HPPD gene derived from oat (Avena sativa) (avhppd-03). For example, soybean to which the PAT gene derived from Streptomyces viridochromogenes (pat) has been introduced simultaneously with the aforementioned gene is sold under the trade name of “Herbicide-tolerant Soybean line” as soybean tolerant to mesotrione and glufosinate.

2,4-D-tolerant plants or ACCase herbicide-tolerant plans: Corn tolerant to 2,4-D or ACCase herbicides to which the aryloxyalkanoate dioxygenase gene derived from Sphingobium herbicidovorans (aad-1) has been introduced is sold, for example, under the trade name of “Enlist (trademark) Maize”. Soybean and cotton tolerant to 2,4-D or ACCase herbicides to which the aryloxyalkanoate dioxygenase gene derived from Delftia acidovorans (aad-12) has been introduced are known, and these are sold, for example, under the trade name of “Enlist (trademark) Soybean”.

Dicamba herbicide-tolerant plants: They are obtained by introducing the dicamba monooxygenase gene derived from Stenotrophomonas maltophilia strain DI-6 (dmo). Soybean and cotton to which the aforementioned gene has been introduced are known. Soybean (Glycine max L.) to which the glyphosate-tolerant EPSPS gene derived from Agrobacterium tumefaciens strain CP4 (CP4 epsps) has been introduced simultaneously with the aforementioned gene is sold, for example, under the trade name of “Genuity (registered trademark) Roundup Ready (trademark) 2 Xtend (trademark)”.

Additional plants with modified tolerance to herbicides are widely known, and examples thereof include alfalfa, apple, barley, eucalyptus, flax, grape, lentil, rapeseed, pea, potato, rice, sugar beet, sunflower, tobacco, tomato, lawn grass, and wheat which are tolerant to glyphosate (See, for example, U.S. Pat. Nos. 5,188,642, 4,940,835, 5,633,435, 5,804,425, and 5,627,061); bean, cotton, soybean, pea, potato, sunflower, tomato, tobacco, corn, sorghum, and sugarcane which are tolerant to dicamba (See, for example, WO 2008/051633, U.S. Pat. Nos. 7,105,724, and 5,670,454); soybean, sugar beet, potato, tomato, and tobacco which are tolerant to glufosinate (See, for example, U.S. Pat. Nos. 6,376,754, 5,646,024, and 5,561,236); cotton, peppers, apple, tomato, sunflower, tobacco, potato, corn, cucumber, wheat, soybean, sorghum, and coarse cereals which are tolerant to 2,4-D (See, for example, U.S. Pat. Nos. 6,153,401, 6,100,446, WO 2005/107437, U.S. Pat. Nos. 5,608,147, and 5,670,454); and canola, corn, millet, barley, cotton, mustard, lettuce, lentil, melon, foxtail millet, oat, nata, potato, rice, rye, sorghum, soybean, sugar beet, sunflower, tobacco, tomato, and wheat which are tolerant to ALS inhibiting herbicides (for example sulfonylurea herbicides or imidazolinone herbicides) (See, for example, U.S. Pat. No. 5,013,659, WO 2006/060634, U.S. Pat. Nos. 4,761,373, 5,304,732, 6,211,438, 6,211,439, and 6,222,100), in particular, rice tolerant to imidazolinone herbicides is known, and rice having specific mutations in the acetohydroxyacid synthase gene (for example, rice having S653N, S654K, A122T, S653(At)N, S654(At)K, and A122(At)T (See, for example, US 2003/0217381 and WO 2005/020673); barley, sugarcane, rice, corn, tobacco, soybean, cotton, rapeseed, sugar beet, wheat, and potato which are tolerant to HPPD inhibiting herbicides (for example, isoxazole herbicides such as isoxaflutole; triketone herbicides such as sulcotrione and mesotrione; and pyrazole herbicides such as pyrazolynate) or diketonitrile which is a degradation product of isoxaflutole (See, for example, WO 2004/055191, WO 1996/38567, WO 1997/049816, and U.S. Pat. No. 6,791,014); and wheat, soybean, cotton, sugar beet, rapeseed, rice, corn, sorghum, sugarcane and sugar beet which are tolerant to PPO inhibiting herbicides (See, for example, US2002/0073443, US2008/0052798, Pest Management Science, 61, 2005, 277-285).

Examples of plants to which herbicide tolerance has been imparted by the conventional type variety improvement techniques or the genomic breeding techniques include rice, “Clearfield (trademark) Rice”, wheat, “Clearfield (trademark) Wheat”, sunflower, “Clearfield (trademark) Sunflower”, lentil, “Clearfield (trademark) lentils”, and canola, “Clearfield (trademark) canola” (BASF products) which are tolerant to imidazolinone ALS inhibitory herbicides such as imazethapyr and imazamox; soybean, “STS soybean” which is tolerant to sulfonylurea ALS inhibitory herbicides such as thifensulfuron-methyl; corn, “SR corn” (also known as “Poast Protected (registered trademark) corn”) which is tolerant to acetyl-CoA carboxylase inhibitors such as trione oxime herbicides and aryloxyphenoxypropionic acid herbicides; sunflower, “ExpressSun (registered trademark)” which is tolerant to sulfonylurea herbicides such as tribenuron; rice, “Rrovisia (trademark) Rice” which is tolerant to acetyl-CoA carboxylase inhibitors such as quizalofop; and canola, “Triazinon Tolerant Canola” which is tolerant to photosystem II inhibitors; and sorghum, “Igrowth (trademark)” which is tolerant to imidazolinone herbicides.

Examples of plants to which herbicide tolerance has been imparted by the genome editing techniques include canola tolerant to sulfonylurea herbicides obtained by Rapid Trait Development System (RTDS (registered trademark)), “SU Canola (registered trademark)”. RTDS (registered trademark) corresponds to oligonucleotide-directed mutagenesis among the genome editing techniques, and is a technique capable of introducing a mutation through Gene Repair Oligonucleotide (GRON), that is, a chimeric oligonucleotide of DNA and RNA without cleaving DNA in a plant. Other examples include corn in which herbicide tolerance and the phytic acid content has been reduced by deletion of the endogenous gene IPK1 with a zinc-finger nuclease (See, for example, Nature 459, 437-441 2009); and rice to which herbicide tolerance has been imparted using CRISPR/Cas9 (See, for example, Rice, 7, 5 2014).

Examples of plants to which herbicide tolerance has been imparted by the new breeding techniques include soybeans in which character of the GM rootstock has been imparted to the scion by using the variety improvement technique in which grafting is used. Specific examples include soybean in which glyphosate-tolerance has been imparted to the non-transgenic soybean scion by using Roundup Ready (registered trademark) soybean with glyphosate tolerance as rootstock (See Weed Technology 2013, 27, 412).

Examples of plants to which pest resistance has been imparted include the following.

Examples of plants to which resistance to lepidopteran pest insects has been imparted by the genetic engineering techniques include corn (Zea mays L.), soybean (Glycine max L.), cotton (Gossypium hirsutum L.), rice (Oryza sativa L.), poplar (Populus sp.), tomato (Lycopersicon esculentum), eggplant (Solanum melongena) and sugar cane (Saccharum sp.) to which a gene encoding 5-endotoxin which is an insecticidal protein derived from the soil bacterium, Bacillus thuringiensis (hereinafter abbreviated as Bt bacteria) has been introduced. Examples of 5-endotoxins conferring resistance to lepidopteran pest insects include Cry1A, Cry1Ab, modified Cry1Ab (partially deleted Cry1Ab), Cry1Ac, Cry1Ab-Ac (hybrid protein in which Cry1Ab and Cry1Ac are fused), Cry1C, Cry1F, Cry1Fa2 (modified cry1F), moCry1F (modified Cry1F), Cry1A. 105 (hybrid protein in which Cry1Ab, Cry1Ac and Cry1F are fused), Cry2Ab2, Cry2Ae, Cry9C, Vip3A and Vip3Aa20.

Examples of plants to which resistance to coleopteran pest insects has been imparted by the genetic engineering techniques include corn and potato to which a gene encoding δ-endotoxin which is an insecticidal protein derived from the soil bacterium, Bt bacteria has been introduced. Examples of 5-endotoxins conferring resistance to coleopteran pest insects include Cry3A, mCry3A (modified Cry3A), Cry3Bb1, Cry34Ab1, Cry35Ab1, Cry6A, Cry6Aa and mCry6Aa (modified Cry6Aa).

Examples of plants to which resistance to dipteran pest insects has been imparted by the genetic engineering techniques include corn (Zea mays L.) to which a synthetic gene encoding a hybrid protein, eCry3.1Ab, in which Cry3A and Cry1Ab derived from the soil bacterium Bt bacteria are fused, has been introduced and cotton (Gossypium hirsutum L.) to which a gene encoding the trypsin inhibitor CpTI derived from cowpea (Vigna unguiculata) is introduced. Further examples include poplar to which a gene encoding API, which is a protease inhibitor protein A derived from arrowhead (Sagittaria sagittifolia), has been introduced, and they exhibit resistance to a wide range of pest insects.

Insecticidal proteins imparting pest insect resistance to plants also include hybrid proteins, partially deleted proteins, and modified proteins each of the above insecticidal proteins. A hybrid protein is created by combining different domains of multiple insecticidal proteins using the genetic engineering techniques, Cry1Ab-Ac and Cry1A. 105 and the like are known. As partially deleted proteins, Cry1Ab in which amino acid sequence is partially deleted, and the like are known. As modified proteins Cry1Fa2, moCry1F, mCry3A and the like, which are proteins in which one or more amino acids of natural 5-endotoxin are substituted, are known. The modified proteins also include cases where a protease recognition sequence which does not exist naturally is inserted to a toxin, and examples thereof include Cry3A055 in which cathepsin G-recognition sequence is inserted into Cry3A toxin (see WO2003/018810).

Cotton to which a modified BT protein, Cry51Aa2 (Cry51Aa2.834_16) has been introduced by the genetic engineering techniques (event MON88702) is under development by Monsanto, and it exhibits resistance to lygus species such as Lygus lineolaris, Hemiptera such as aphids, and Thysanoptera such as Frankliniella species.

Examples of other insecticidal proteins imparting pest insect resistance to plants by the genetic engineering techniques include insecticidal proteins derived from Bacillus cereus or Bacillus popilliae; plant insecticidal proteins Vip1, Vip2, and Vip3 (as subclasses, Vip3Aa to Vip3Aj, Vip3Ba, Vip3B and Vip3Ca are known, and specifically, for example, Vip3Aa20 and Vip3Aa61 are known) and Vip4; insecticidal proteins derived from nematode commensal (colonizing in nematode) bacteria such as Photorhabdus spp. including Photorhabdus luminescens or Xenorhabdus spp. such as Xenorhabdus nematophilus; toxins produced by animals including scorpion toxins, spider toxins, and insect-specific neurotoxins such as bee toxins; toxins produced by filamentous fungi such as Streptomycetes venom; plant lectins such as pea lectin, barley lectin, snowdrop lectin; agglutinin; protease inhibitors such as trypsin inhibitors, serine protease inhibitors, patatin, cystatin, papain inhibitors; ribosome-inactivating proteins (RIP) such as ricin, corn-RIP, abrin, rufin, saporin, bryodin; steroid metabolic enzymes such as 3-hydroxysteroid oxidase, ecdysteroid-UDP-glucosyltransferase, cholesterol oxidase; ecdysone inhibitors; HMG-CoA-reductase; ion channel inhibitors such as sodium channel inhibitors and calcium channel inhibitors; juvenile hormone esterase; diuretic hormone receptors;
stilbene synthase; bibenzyl synthase; chitinase; and glucanase.

In addition, plants to which resistance to pest insect has been imparted by introducing one or more insecticidal protein genes are already known, and some plants are commercially available.
Examples of cottons to which pest insect resistance has been imparted include “Bollgard (trademark) cotton”, “BXN (trademark) Plus Bollgard (trademark) Cotton”, “BXN (trademark) Plus Bollgard (trademark) Cotton”, “JK 1”, “Roundup Ready (trademark) Bollgard (trademark) Cotton” and “Ingard (trademark)” which express the insecticidal protein Cry1Ac derived from Bt bacteria; “Herculex (trademark) I” and “Herculex (trademark) CB” which express insecticidal protein, modified Cry1F (Cry1Fa2) derived from Bt bacteria; “VIPCOT (trademark) Cotton” which expresses the insecticidal protein Vip3A derived from Bt bacteria; “Bollgard II (trademark) cotton”, “Roundup Ready (trademark) Bollgard II (trademark) Cotton”, “Roundup Ready (trademark) Flex (trademark) Bollgard II (trademark) Cotton” and “Fivermax (trademark) Liberty Link (trademark) Bollgard II (trademark)” which express the insecticidal proteins Cry1Ac and Cry2Ab derived from Bt bacteria; “Bollgard III (registered trademark)” and “Bollgard (registered trademark) III×Roundup Ready (trademark) Flex (trademark)” which express the insecticidal proteins Cry1Ac, Cry2Ab and Vip3A derived from Bt bacteria; “VIPCOT (trademark) Roundup Ready Flex (trademark) Cotton” which expresses the insecticidal proteins Vip3A and Cry 1Ab derived from Bt bacteria; “VIPCOT (registered trademark) Cotton” which expresses the insecticidal proteins Vip3A and Cry1Ac derived from Bt bacteria; “WideStrike (trademark) Cotton”, “WideStrike (trademark) Roundup Ready (trademark) Cotton” and “Widestrike (trademark) Roundup Ready Flex (trademark) Cotton” which express the insecticidal proteins Cry1Ac and Cry1F derived from Bt bacteria; “TwinLink (trademark) Cotton” and “Glytol (trademark)×Twinlink (trademark)” which expresses the insecticidal proteins Cry1Ab and Cry2Ae derived from Bt bacteria; “Widestrike (registered trademark) 3” and “Widestrike (trademark)×Roundup Ready Flex (trademark)×VIPCOT (trademark) Cotton” which express the insecticidal proteins Cry1Ac, Cry1F and Vip3A derived from Bt bacteria; “Glytol (trademark)×Twinlink (trademark)×VIPCOT (trademark) Cotton” which expresses the insecticidal proteins Cry1Ab, Cry2Ae and Vip3A derived from Bt bacteria, and they are commercially available.

Examples of corns to which pest insect resistance has been imparted include “YieldGard (registered trademark) Rootworm RW”, “YieldGard (trademark) RW+RR”, “YieldGard (trademark) VT (trademark) Rootworm (trademark) RR2” and “MaxGard (trademark)” which express the insecticidal protein Cry3Bb1 derived from Bt bacteria; “YieldGard (registered trademark) VT Triple” and “YieldGard (trademark) Plus with RR” which express the insecticidal proteins Cry3Bb1 and Cry1Ab derived from Bt bacteria; “Bt Xtra (trademark) Maize” which expresses the insecticidal protein Cry1Ac derived from Bt bacteria; “YieldGard Plus (registered trademark)” which expresses the insecticidal proteins Cry1Ab and Cry3Bb1 derived from Bt bacteria; “Bt10”, “Liberty Link (trademark) Yieldgard (trademark) Maize”, “Agrisure (trademark) GT/CB/LL” and “YieldGard (trademark) CB+RR” which express the insecticidal protein Cry1A derived from Bt bacteria; “YieldGard (trademark) VT Pro (trademark)” and “Genuity (registered trademark) VT Double Pro (trademark)” which express the insecticidal proteins Cry 1A. 105 and Cry2Ab2 derived from Bt bacteria; “Agrisure (registered trademark) RW” and “Agrisure (trademark) GT/RW” which express the insecticidal protein mCry3A derived from Bt bacteria; “Starlink (trademark) Maize” which expresses the insecticidal protein Cry9C derived from Bt bacteria; “YieldGard (trademark)”, “MaizeGard (trademark)”, “NaturGard KnockOut (trademark)”, “Maximizer (trademark)”, “Roundup Ready (trademark) YieldGard (trademark) maize”, “Agrisure (trademark) CB/LL” and “Mavera (trademark) YieldGard (trademark) Maize” which express the insecticidal protein Cry1Ab derived from Bt bacteria; “Agrisure (registered trademark) 3122” which expresses the insecticidal proteins Cry1Ab, Cry1F, modified Cry3A, Cyr34Ab1 and Cyr35Ab1 derived from Bt bacteria; “Agrisure (registered trademark) Viptera” which expresses the insecticidal protein Vip3Aa20 derived from Bt bacteria; “Agrisure (registered trademark) Viptera (trademark) 2100” and “Agrisure (registered trademark) Viptera (trademark) 3110” which express the insecticidal proteins Vip3Aa20 and Cry1Ab derived from Bt bacteria; “Agrisure (registered trademark) Viptera (trademark) 3100”, “Agrisure (registered trademark) Viptera (trademark) 3111” and “Agrisure (registered trademark) Viptera (trademark) 4” which express the insecticidal proteins Vip3Aa20, Cry1Ab and modified Cry3A derived from Bt bacteria; “Agrisure (registered trademark) Viptera (trademark) 3220” which expresses the insecticidal protein Vip3Aa20, Cry1Ab and modified Cry1F derived from Bt bacteria; “Agrisure (registered trademark) Duracade (trademark)” which expresses the insecticidal protein eCry3.1Ab (chimeric protein of Cry3A-Cry1Ab) derived from Bt bacteria; “Agrisure (registered trademark) Duracade (trademark) 5122” which expresses the insecticidal proteins eCry3.1Ab (chimeric protein of Cry3A-Cry1Ab), modified Cry3A, Cry1Ab and modified Cry1F derived from Bt bacteria; “Agrisure (registered trademark) Duracade (trademark) 5222” which expresses the insecticidal proteins eCry3.1Ab (chimeric protein of Cry3A-Cry1Ab), modified Cry3A, modified Cry1Ab and Vip3A mutant derived from Bt bacteria; “Herculex (trademark) RW” which expresses the insecticidal proteins Cyr34Ab1 and Cyr35Ab1 from Bt bacteria; “Herculex XTRA (trademark)” which expresses the insecticidal proteins Cyr34Ab1, Cyr35Ab1 and Cry1F derived from Bt bacteria; “Genuity (registered trademark) VT Triple Pro (trademark)” which expresses the insecticidal proteins Cry1A. 105 Cry2Ab2 and Cry3Bb1 derived from Bt bacteria; “Genuity (registered trademark) SmartStax (trademark)” which expresses the insecticidal proteins Cry1F, Cry2Ab, Cyr34Ab1, Cyr35Ab1, Cry3Bb1 and Cry1A. 105 derived from Bt bacteria; “Power Core (trademark)” which expresses the insecticidal proteins, modified Cry1F, Cry2Ab and Cry1A. 105 derived from Bt bacteria; “Herculex XTRA (trademark) RR” which expresses the insecticidal proteins, modified Cry1F, Cyr34Ab1 and Cyr35Ab1 derived from Bt bacteria; “Optimum (registered trademark) Intrasect Xtreme” which expresses the insecticidal proteins, modified Cry1F, Cyr34Ab1, Cyr35Ab1, Cry1Ab and modified Cry3A derived from Bt bacteria; “Optimum (registered trademark) Intrasect XTRA” which expresses the insecticidal proteins, modified Cry1F, Cyr34Ab1, Cyr35Ab1 and Cry1Ab derived from Bt bacteria; “Optimum (registered trademark) TRisect” which expresses the insecticidal proteins, modified Cry1F and modified Cyr3A derived from Bt bacteria, and they are commercially available.

Examples of other plants to which pest insect resistance has been imparted include potato “Atlantic NewLeaf (trademark) potato”, “NewLeaf (trademark) Russet Burbank potato”, “Lugovskoi plus”, “Elizaveta plus”, “Hi-Lite NewLeaf (trademark) Y potato, Superior NewLeaf (trademark) potato” and “Shepody NewLeaf (trademark) Y potato” which express the insecticidal protein Cry3A derived from Bt bacteria; rice “hanyou 63” and “Huahui-1” which express the insecticidal proteins Cry1Ab and Cry1Ac derived from Bt bacteria; soybean “Intacta (trademark) Roundup Ready (trademark) 2 Pro” which expresses the insecticidal protein Cry1Ac derived from Bt bacteria; eggplant “BARI Bt Begun-1, -2, -3 and -4” which expresses the insecticidal protein Cry1Ac derived from Bt bacteria, and they are commercially available.

In addition, corn “YieldGard corn rootworm”, “YieldGard VT”, “Herculex RW”, “Herculex Rootworm” and “Agrisure CRW” which are resistant to corn rootworm; corn “YieldGard corn borer”, “YieldGard plus”, “YieldGard VT Pro”, “Agrisure CB/LL”, “Agrisure 3000GT”, “Hercules I”, “Hercules II”, “KnockOut”, “NatureGard” and “StarLink” which are resistant to corn borer; corn “Herculex I”, “Herculex Xtra”, “NewLeaf”, “NewLeaf Y” and “NewLeaf Plus” which are resistant to western bean cutworm, corn borer, black cutworm and fall armyworm; corn “YieldGard plus” which is resistant to corn borer and corn rootworm; cotton, “Bollgard I” and “Bollgard II” which are resistant to tobacco budworm; cotton, “Bollgard II”, “WideStrike (trademark)” and “VipCot” which are resistant to tobacco budworm, cotton bollworm, fall armyworm, beet armyworm, cabbage looper, soybean looper and pink bollworm; potato “NewLeaf”, “NewLeaf Y“and” NewLeaf Plus” which are resistant to tobacco hawk moth; eggplant “Bt brinjal”, “Dumaguete Long Purple” and “Mara” which are resistant to eggplant fruit and shoot borer, fruit borer and cotton bollworm (see for example U.S. Pat. No. 5,128,130) are known.

Additional plants which are resistant to pest insect are commonly known, and examples thereof include yellow rice borer-resistant rice (see, e.g., Molecular Breeding, Vol. 18 (2006), No. 1), Lepidoptera-resistant lettuce (see, e.g., U.S. Pat. No. 5,349,124), rice which is resistant to Lepidoptera (e.g., rice stem borer, straight swift, pink borer, rice leaf roller, rice caseworm, and rice armyworm)(see, for example, WO2001/021821). Methods for producing such plants are generally known to those skilled in the art and are described, for example, in the publications mentioned above.

As a plant to which pest insect resistance has been imparted by the RNA interference techniques, corns which are resistant to lepidopteran pest insects (e.g., corn borers, corn earworm, cutworms such as black cutworm, and fall armyworm) and coleopteran pest insects (corn rootworms) are commercially available or being developed under the trade name of “SmartStax (registered trademark),” “SmartStax (registered trademark) Pro,” or “Genuity (registered trademark) SmartStax Pro.”

Examples of plants to which pest insect resistance has been imparted by the conventional type variety improvement techniques or the genomic breeding techniques include soybean which have the aphid resistance gene “Rag1 (Resistance to Aphis glycines 1)” gene or “Rag2 (Resistance to Aphis glycines 2)” gene to exhibit resistance to soybean aphid (Aphis glycines) (see, J. Econ. Entomol., 2015, 108, 326); soybean which exhibits resistance to Soybean cyst nematode (Heterodera glycines) (see, Phytopathology, 2016, 106, 1444); cotton which exhibits resistance to Southern root-knot nematode (Meloidogyne incognita) (J. Nematol., 2009, 41, 140); rice “Kanto BPH 1go” which exhibits resistance to brown planthopper; and soybean “Fukuminori” which exhibits resistance to cotton worm.

These plants endowed with pest insect resistance are optionally endowed with resistance to pest insects (especially, lepidopteran insects, coleopteran insects, dipteran insects, coleopteran insects), arachnid pests and nematode pests. The plants endowed with pest insect resistance are preferably selected from kinds of Mugi (e.g., wheat, barley, rye, oat), corn, canola, sorghum, soybean, rice, rapeseed, sugar beet, sugar cane, grape, lentil, sunflower, alfalfa, pomaceous fruits, stone fruits, peanuts, coffee, tea, strawberries, lawn grass, vegetables (e.g., tomato, potato, cucurbitaceous plants and lettuce), more preferably selected from soybean, corn, tomatoes, rice and kinds of Mugi (e.g., wheat, barley, rye and oat), and most preferably selected from soybean, rice, corn and kinds of Mugi (e.g., wheat, barley, rye and oat).

Examples of plants to which disease resistance has been imparted include the following.

Plants to which disease resistance has been imparted by the genetic engineering techniques are, for example, plants which express so-called “pathogenesis-related proteins” (PRP, e.g., EP0392225) or so-called “antifungal proteins” (AFP, see e.g., U.S. Pat. No. 6,864,068). Various antifungal proteins having activity against phytopathogenic fungi have been isolated from specific plant species and are common knowledge. Examples of such antipathogenic substances and plants capable of synthesizing such antipathogenic substances are publicly known, for example, from EP0392225, WO1993/05153, WO1995/33818 and EP0353191. Plants having resistance to fungicidal pathogens, viral pathogens and bacterial pathogens are produced by introducing disease resistance gene. Numerous resistance genes have been identified, isolated and used to improve disease resistance, and examples of such resistance genes include the N gene, which was introduced into tobacco lines susceptible to tobacco mosaic virus (TMV) in order to create TMV-resistant tobacco plants (see, for example, U.S. Pat. No. 5,571,706), the Prf gene, which was introduced into plants in order to obtain enhanced pathogen resistance (see, e.g., WO1998/02545), and the Rps2 gene derived from thale cress (Arabidopsis thaliana), which has been used to create resistance to bacterial pathogens such as Pseudomonas syringae (see, e.g., WO1995/028423). Plants which exhibit systemic acquired resistance response have been obtained by introducing a nucleic acid molecule encoding the TIR domain of the N gene (see e.g., U.S. Pat. No. 6,630,618). Further examples of known resistance genes include the Xa21 gene that has been introduced into many rice cultivars (see, e.g., U.S. Pat. Nos. 5,952,485, 5,977,434, WO1999/009151, WO1996/022375), the Rcg1 gene for colletotrichum resistance (see, e.g., US2006/225152), the prpl gene (see, e.g., U.S. Pat. No. 5,859,332, WO2008/017706), the ppv-cp gene for introducing resistance to plum pox virus (see, e.g., US PP15,154Ps), the P1 gene (see, e.g., U.S. Pat. No. 5,968,828), genes such as Blb1, Blb2, Blb3, RB2 and Rpi-vntl for introducing resistance to Phytophthora infestans in potatoes (see e.g., U.S. Pat. No. 7,148,397), the LRPKmI gene (see e.g., WO1999/064600), the P1 gene for potato virus Y resistance (see e.g., U.S. Pat. No. 5,968,828), the HA5-1 gene (see e.g., U.S. Pat. Nos. 5,877,403 and 6,046,384), the PIP gene for introducing a wide spectrum of resistance to viruses such as potato virus X (PVX), potato virus Y (PVY) and potato leafroll virus (PLRV) (see, e.g., EP0707069), and genes such as the NI16 gene, the ScaM4 gene and the ScaM5 gene of Arabidopsis for obtaining fungal resistance (see, e.g., U.S. Pat. No. 6,706,952 and EP1018553). In addition, kidney bean which is resistant to Bean golden mosaic virus (hereinafter referred to as BGMV) is a plant to which resistance has been introduced by the RNA interference techniques, and the double-stranded RNA gene (sense and antisense the ac1 gene) of the replication protein has been introduced to inhibit the synthesis of the replication protein of BGMV, thereby exhibiting resistance to BGMV. Methods for producing such plants are generally known to those skilled in the art and are described, for example, in the publications mentioned above.

Examples of antipathogenic substances which can be expressed by such plants include ion channel blockers (sodium channel blockers, calcium channel blockers, etc.); viral KP1, KP4 and KP6 toxins; stilbene synthase; bibenzyl synthase; chitinase; glucanase; so-called “pathogenesis-related proteins” (PRP; see, e.g., EP0392225); antipathogenic substances produced by microorganisms (e.g., peptide antibiotics, heterocyclic antibiotics (see, e.g., WO1995/033818) and protein factors or polypeptide factors involved in plant's defense against pathogen (so-called “plant disease resistance genes” described in WO2003/000906)).

Antipathogenic substances produced by plants can protect plants from various pathogenic microorganisms such as fungi, viruses and bacteria. Useful plants of growing interest in connection with the present invention are kinds of Mugi (e.g., wheat, barley, rye and oat), soybean, corn, rice, rapeseed, pomaceous fruits, stone fruits, peanut, coffee, tea, strawberry, lawn grass; vines and vegetables (e.g., tomato, potato), cucurbitaceous plants, papaya, melon, lenses and lettuce, and more preferably selected from soybean, tomato, rice and kinds of Mugi (e.g., wheat, barley, rye and oat), and most preferably selected from soybean, rice and kinds of Mugi (e.g., wheat, barley, rye and oats).

Examples of plants having resistance to fungal pathogens include soybean having resistance to Phakopsora pachyrhizi and Phakopsora meibomiae (see, e.g., WO2008/017706); Solanaceous plants such as cotton, tomato, and potato which have resistance to Phytophthora infestans (see, e.g., U.S. Pat. Nos. 5,859,332, 7,148,397, EP1334979); corn having resistance to Colletotrichum such as Colletotrichum graminicola (see, e.g., US2006/225152); apple having resistance to Venturia inaequalis (see, e.g., WO1999/064600); plants (e.g., rice, wheat, barley, rye, corn, oat, potato, melon, soybean and sorghum) having resistance to fungi of the genus Fusarium (e.g., fusarium graminearum, fusarium sporotrichioides, fusarium lateritium, fusarium pseudograminearum, fusarium sambucinum, fusarium culmorum, fusarium poae, fusarium acuminatum, fusarium equiseti) (see, e.g., U.S. Pat. No. 6,646,184, EP1477557); plants such as corn, soybean, kinds of Mugi (especially wheat, barley, rye and oat), rice, tobacco, sorghum, sugar cane, potato which have a wide spectrum of fungicidal resistance (see, e.g., U.S. Pat. Nos. 5,859,332, 5,689,046, 6,706,952, EP1018553 and U.S. Pat. No. 6,020,129).

Examples of plants having resistance to bacterial pathogens include rice having resistance to xylella fastidiosa (see, e.g., U.S. Pat. No. 6,232,528); plants such as rice, cotton, soybean, potato, solgum, corn, wheat, barley, sugar cane, tomato and pepper which have resistance to fungi of bacterial blight disease (see, e.g., WO2006/42145, U.S. Pat. Nos. 5,952,485, 5,977,434, WO1999/09151, WO1996/22375); tomato having resistance to Pseudomonas syringae (see, e.g., Can. J. Plant Path., 1983, 5: 251-255).

Examples of plants having resistance to viral pathogens include stone fruits (e.g., plum, almond, apricot, cherry, peach, nectarine) having resistance to plum pox virus (see, e.g., US PP15154Ps, EP0626449); potato having resistance to potato virus Y (see, e.g., U.S. Pat. No. 5,968,828); plants such as potato, tomato, cucumber and leguminous plants which have resistance to tomato spotted fungus virus (see, e.g., EP0626449 and U.S. Pat. No. 5,973,135); corn having resistance to maize streak virus (see, e.g., U.S. Pat. No. 6,040,496); papaya having resistance to papaya ring spot virus (see, e.g., S5877403, U.S. Pat. No. 6,046,384); cucurbitaceous plants (e.g., cucumber, melon, watermelon, and pumpkin) and solanaceous plants (e.g., potato, tobacco, tomato, eggplant, paprika, chili pepper and pepper) which have resistance to cucumber mosaic virus (see, e.g., U.S. Pat. No. 6,849,780); cucurbitaceous plants (e.g., cucumber, melon, watermelon, and pumpkin) which have resistance to watermelon mosaic virus 2 and zucchini yellow mosaic virus (see, e.g., U.S. Pat. No. 6,015,942); potato having resistance to potato leafroll virus (see, e.g., U.S. Pat. No. 5,576,202); potato having a wide spectrum of resistance to viruses such as potato virus X (potato viru natural pyrethrin), potato virus Y and potato leafroll virus (see, e.g., EP0707069); kidney bean having resistance to bean golden mosaic virus (see, e.g., Mol Plant Microbe Interact. 2007 June; 20(6):717-26).

There are some plants having resistance to antibiotics (e.g., kanamycin, neomycin and ampicillin). The naturally occurring bacterial nptll gene expresses an enzyme that blocks the action of the antibiotics kanamycin and neomycin. The ampicillin resistance gene, ampR (also known as bIaTEM1) is derived from the bacterium Salmonella paratyphi and is used as a marker gene in transformations of microorganisms and plants. The ampR is involved in the synthesis of beta-lactamase, which is an enzyme that neutralizes the penicillin class antibiotics including ampicillin. Examples of plants having resistance to antibiotics include potato, tomato, flax, canola, rapeseed, seed of turnip rape and corn (see, e.g., Plant Cell Reports, 20, 2001, 610-615; Trends in Plant Science, 11, 2006, 317-319; Plant Molecular Biology, 37, 1998, 287-296; Mol Gen Gen Genet., 257, 1998, 606-13. Plant Cell Reports, 6, 1987, 333-336; Federal Register (USA), Vol. 60, No. 113, 1995, p. 31139. Federal Register (USA), Vol. 67, No. 226, 2002, p. 70392; Federal Register (USA), Vol. 63, No. 88, 1998, p. 25194; Federal Register (USA), Vol. 60, No. 141, 1995, p. 37870; Canadian Food Inspection Agency, FD/OFB-095-264-A, October 1999; FD/OFB-099-127-A, October 1999). Preferably, above-mentioned plants are selected from soybean, tomatoes and kinds of Mugi (e.g., wheat, barley, rye and oat), most preferably selected from soybean and kinds of Mugi (e.g., wheat, barley, rye and oat).

Examples of available plants to which resistance to plant viral diseases has been imparted include papaya “Rainbow”, “SunUp”, and “Huanong No. 1” to which resistance to Papaya ringspot virus has been imparted; potato “Innate (registered trademark) Hibernate”, “Innate (registered trademark) Glaciate”, and “Innate (registered trademark) Acclimate” which exhibit resistance to Phytophthora infestans; and Potato “Newleaf (trademark)” which exhibits resistance to potato virus Y and/or potato leafroll virus (PLRV).

Examples of plants to which disease resistance has been imparted by the conventional type variety improvement techniques or the genomic breeding techniques include rice endowed with resistance to blast; rice endowed with resistance to sheath blight; wheat endowed with resistance to leaf rust; wheat endowed with resistance to stripe rust; wheat endowed with resistance to stem rust; wheat endowed with resistance to powdery mildew; wheat endowed with resistance to leaf blotch; wheat endowed with resistance to glume blotch; wheat endowed with resistance to tan spot; barley endowed with resistance to powdery mildew; barley endowed with resistance to dwarf leaf rust; barley endowed with resistance to net blotch; barley endowed with resistance to scald; barley endowed with resistance to ramularia leaf spot disease (Ramularia disease); corn endowed with resistance to Anthracnose; corn endowed with resistance to gray leaf spot; corn endowed with resistance to Goss's wilt; corn endowed with resistance to Fusarium stalk rot; soybean endowed with resistance Asian soybean rust; soybean endowed with resistance to phytophthora stem and root rot; and soybean endowed with resistance to sudden death syndrome; pepper endowed with resistance to Phytophthora rot; lettuce endowed with resistance to powdery mildew; tomato endowed with resistance to bacterial wilt; tomato endowed with resistance to Gemini virus; lettuce endowed with resistance to downy mildew; cruciferous plants such as rapeseed, cabbage, brussels sprout, cauliflower, collard green (Borekale) and broccoli which have been endowed with resistance to clubroot; cruciferous plants such as rapeseed, cabbage, brussels sprout, cauliflower, collard green (Borekale) and broccoli which have been endowed with resistance to black leg; and melon endowed with resistance to Fusarimu wilt caused by Fusarium oxysporum f. sp. melonis (see, e.g., WO2009/000736).

Examples of plants to which disease resistance has been imparted by the genome editing techniques include bread wheat which exhibits resistance to powdery mildew by deleting the powdery mildew resistance gene (MILDEW RESISTANCE LOCUS 0, hereinafter referred to as MLO) using TALEN and CRISPR/Cas9 (see, e.g., Nat. Biotech., 32, 947-951 2014); slmlol tomato (Tomelo) which exhibits resistance to powdery mildew by deleting SIMLO1 which is one of the MLOs using CRISPR/Cas9 (see, e.g., Scientific Reports 7, Article number: 482 2017); rice which exhibits resistance to Xanthomonas oryzae pv. Oryzae that causes bacterial leaf blight by editing the OsSWEET14 gene in rice using TALEN (see, Nat. Biotechnol. 30, 390-392 2012); rice which exhibits resistance to Magnaporthe oryzae that causes blast by modifying the OsERF922 gene in rice using CRISPR/Cas9 (see, PLoS ONE 11:e0154027. doi: 10.1371/journal.pone.0154027 2016); cucumber which exhibits resistance to cucumber vein yellow ingvirus (CVYV), zucchini yellow mosaic virus (ZYMV) and papaya ringspot virus-typeW (PRSV-W) by disrupting the recessive eIF4E (eukaryotic translation initiation factor 4E) gene using CRISPR/Cas9 (see, Mol. PlantPathol. 17, 7 1140-1153 2016); soybean which exhibits resistance to phytophthora stem and root rot caused by Phytophthora sojae by disrupting the RXLR effector gene (Avr4/6) using CRISPR/Cas9 (see, Mol Plant Pathol 17(1) 127-139 2016).

Examples of plants to which disease resistance has been imparted by the new breeding techniques include apple to which the Rvi6 (Formerly referred to as HcrVf2) gene having resistance to Apple scab caused by Venturia inaequalis has been introduced using Cisgenesis, thereby exhibiting resistance to Apple scab (see, e.g., Plant Biotech. J., 12, 2-9, 2014); as an example that a character of the GM rootstock is imparted to the scion, which is the variety improvement technique in which grafting is used, sweet cherry in which resistance to infection with Prunus necrotic ringspot virus has been transferred from a transgenic rootstock having the property to a non-transgenic scion (see, Plant Biotech. J., 12, 1319-1328 2014).

Examples of plants product quality of which has been modified include the following.

Modification of product quality means the synthesis of modified component or increase or decrease in an amount of a component synthesized compared to the corresponding wild-type plant. Examples of plants product quality of which has been modified include modified plants the content of vitamins, amino acids, proteins, starches, or various oils of which has been increased or decreased and modified plants the content of nicotine of which has been decreased.

Examples of plants product quality of which has been modified by the genetic engineering techniques include alfalfa the lignin content of which has been decreased due to RNA interferential action by introducing a gene producing double-stranded RNA of the S-adenosyl-L-methionine:trans-caffeoyl CoA 3-methyltransferase (ccomt) gene that is derived from alfalfa and involved in lignin production; canola “Laurical (trademark) canola” the triacylglyceride content including lauric acid of which has been increased by introducing the 12:0 ACP thioesterase gene which is derived from California Laurel (Umbellularia californica) and involved in fatty acid synthesis; soybean “Plenish (trademark)” and “Treus (trademark)” the oleic acid content of which has been increased by introducing a partial gene of ω-6 desaturase derived from soybean (gm-fad2-1), which is fatty acid desaturase, thereby suppressing expression of said gene; soybean “Vistive Gold (trademark)” the saturated fatty acid content of which has been decreased by introducing a gene that produces double-stranded RNA of the acyl-acyl carrier protein thioesterase gene (fatbl-A) derived from soybean and a gene that produces double-stranded RNA of the δ-12 desaturase gene (fad2-1A) derived from soybean; genetically modified soybean in which stearidonic acid, which is one of the ω3 fatty acids, has been produced by introducing the δ-6 desaturase gene (Pj.D6D) derived from primrose and the δ-12 desaturase gene (Nc.Fad3) derived from red bread mold; corn “Enogen (registered trademark)” in which production of bioethanol has been enhanced by introducing the thermostable alpha-amylase gene (amy797E) of Thermococcales sp. which is involved in starch degradation; corn “Mavera (trademark) Maize” and “Mavera (trademark) YieldGard (trademark) Maize” in which lysine production has been increased by introducing the dihydrodipicolinate synthase gene (cordapA) which is derived from Corynebacterium glutamicum and involved in the production of amino acid lysine; potato “Amflora (trademark)” and “Starch Potato” in which the amylose content in starch grains has been decreased and the amylopectin content has been increased by introducing the antisense gene gbss of the starch synthase (granule-bound starch synthase enzyme, GBSS) derived from potato; Potato “Innate (registered trademark) Cultivate”, “Innate (registered trademark) Generate”, “Innate (registered trademark) Accelerate”, “Innate (registered trademark) Invigorate”, “Innate (registered trademark) Glaciate”, “Innate (registered trademark) Acclimate” and “Innate (registered trademark) Hibernate” in which starch degradation has been inhibited by introducing the genes pPhL and pR1, which generate double-stranded RNA of the transcription factor genes PhL and R1 derived from potato that promote starch degradation, asparagine synthesis has been inhibited by introducing the gene asn1, which generates double-stranded RNA of the gene Asn1 involved in asparagine production (The purpose is to inhibit the accumulation of asparagine and reducing sugars, which are involved in the heat induced formation of acrylamide, which is a carcinogen), and black spot formation has been inhibited by introducing the gene ppo5, which generates double-stranded RNA of the polyphenol oxidase gene Ppo5 derived from potato; tobacco the nicotine content of which has been decreased by introducing the antisense gene (NtQPT1) of the quinolinic acid phosphoribosyltransferase gene, QpTase derived from tobacco (Nicotiana tabacum); rice which is capable of producing β-carotene in the endosperm tissue to yield rice containing vitamin A by introducing the phytoene synthase gene (psy) derived from Wild daffodil (Narcissus pseudonarcissus) and the carotene desaturase gene (crtl) derived from Erwinia uredovora, a soil bacterium that synthesizes carotenoids to express in the endosperm specifically. Other examples include potatoes and corn each amylopectin content of which has been modified (see, e.g., U.S. Pat. No. 6,784,338, US2007/0261136, WO1997/04471); canola, corn, cotton, grape, cattail, catalpa, rice, soybean, rapeseed, wheat, sunflower, bitter cucumber, safflower and vernonia plants each oil content of which has been modified (see, e.g., U.S. Pat. Nos. 7,294,759, 7,157,621, 5,850,026, 6,441,278, 5,723,761, 6,380,462, 6,365,802, 6,974,898, WO2001/079499, US2006/0075515 and U.S. Pat. No. 7,294,759); sunflower the fatty acid content of which has increased (see, e.g., U.S. Pat. No. 6,084,164); soybean the allergen content of which has decreased (see, e.g., U.S. Pat. No. 6,864,362); tobacco the nicotine content of which has decreased (see, e.g., US2006/0185684, WO2005/000352 and WO2007/064636); canola and soybean each lysine content of which has increased (see, e.g., Bio/Technology 13,1995, 577-582); corn and soybean each composition of methionine, leucine, isoleucine and/or valine has been modified (see, e.g., U.S. Pat. Nos. 6,946,589, 6,905,877); soybean the sulfur amino acid content has increased (see, e.g., EP0929685, WO1997/041239); corn the methionine content of which has increased by leaf-specific expression of 3′-phosphoadenosine-5′-phosphosulfate reductase derived from Escherichia coli (see PNAS, 2017, 114(43), 11386.); tomato the free amino acid (e.g., asparagine, aspartic acid, serine, threonine, alanine, histidine and glutamic acid) content has increased (see, e.g., U.S. Pat. No. 6,727,411); corn the amino acid content of which has increased (see, e.g., WO05/077117); potato, corn and rice each starch content of which has been modified (see, e.g., WO1997/044471 and U.S. Pat. No. 7,317,146); tomato corn, grape, alfalfa, apple, pulses and pea each flavonoid content of which has been modified (see, e.g., WO00/04175); corn, rice, sorghum, cotton and soybean each phenolic compound content of which has been modified (see, e.g., US2008/0235829); tomato and canola each vitamin A content of which has increased (see, e.g., U.S. Pat. Nos. 6,797,498 and 7,348,167); tomato, canola, soybean, wheat, sunflower, rice, corn, barley and rye each vitamin E content of which has increased (see, e.g., U.S. Pat. No. 7,348,167, WO2004/058934); alfalfa, apple, bean, corn, grape, tomato, and pea each flavonoid content of which has been modified (see, e.g., WO00/04175). Methods for producing such plants are generally known to those skilled in the art and are described, for example, in the publications mentioned above. Preferably, the plants are selected from soybean, canola, tomatoes, rice and kinds of Mugi (e.g., wheat, barley, rye and oat), most preferably selected from soybean, canola, rice, wheat and barley.

As plants the product quality of which has been modified by the conventional type variety improvement techniques or the genomic breeding techniques, rapeseed “Nexera (registered trademark) Canola” which produces unsaturated omega-9 fatty acids; soybean “Yumeminori” the allergen content of which has decreased; rice the purpose of which is to modify to be good taste such as rice “Yumepirika” the amylose content has decreased are commercially available. In addition, citrus the fruit characteristics (e.g., fruit weight, much or little aroma, juiciness, and sugar content) of which has been modified by the genomic selection are known (see, Scientific Reports 7, 4721 2017).

Examples of plants the nutrient utilization of which has been modified include plants in which assimilation or metabolism of nitrogen or phosphorus has been enhanced. Examples of plants having nitrogen assimilation capability and nitrogen utilization capability which has been enhanced by the genetic engineering techniques include canola, corn, wheat, sunflower, rice, tobacco, soybean, cotton, alfalfa, tomato, wheat, potato, sugar beet, sugar cane and rapeseed (see, e.g., WO1995/009911, WO1997/030163, U.S. Pat. Nos. 6,084,153, 5,955,651 and 6,864,405). Examples of plants in which the phosphorus uptake has been improved by the genetic engineering techniques include alfalfa, barley, canola, corn, cotton, tomato, rapeseed, rice, soybean, sugar beet, sugar cane, sunflower, wheat, and potato (see, e.g., U.S. Pat. No. 7,417,181, US2005/0137386). Methods for producing such plants are generally known to those skilled in the art and are described, for example, in the publications mentioned above. Preferably, the plants are selected from soybean, tomatoes and kinds of Mugi (e.g., wheat, barley, rye and oat), most preferably selected from soybean, rice, corn and wheat.

Examples of plants fertility traits and the like of which have been modified by the genetic engineering techniques include plants to which male sterility and fertility restoration trait have been imparted. Examples thereof include corn and chicory to which the male sterility trait has been imparted by expressing the ribonuclease gene (barnase) derived from bacillus (Bacillus amyloliquefaciens) in tapetum cells of anther; corn to which the male sterility trait has been imparted by introducing the DNA adenine methyltransferase gene (dam) derived from Escherichia coli; corn the fertility trait of which has been regulated by introducing the alpha-amylase gene (zm-aal) which confers the male sterility trait and is derived from corn and the ms45 protein gene (ms45) which confers the fertility restoration trait and is derived from corn; canola to which the fertility restoration function has been imparted by expressing the ribonuclease inhibiting protein gene (barstar) derived from Bacillus in tapetum cells of anther; canola the fertility trait of which has been regulated by expressing the ribonuclease gene (barnase) which confers the male sterility trait and is derived from bacillus and the ribonuclease inhibiting protein gene (barstar) which confers the fertility restoration trait and is derived from bacillus. Examples of other plants to which fertility traits have been imparted by the genetic engineering techniques include tomato, rice, mustard, wheat, soybean, and sunflower (see, e.g., U.S. Pat. Nos. 6,720,481, 6,281,348, 5,659,124, 6,399,856, 7,345,222, 7,230,168, 6,072,102, EP1135982, WO2001/092544 and WO1996/040949). Methods for producing such plants are generally known to those skilled in the art and are described, for example, in the publications mentioned above. Preferably, the plants are selected from corn, canola, soybean, rice, tomatoes and kinds of Mugi (e.g., wheat), most preferably selected from corn, canola, soybean, rice and wheat.

Plants endowed with abiotic stress tolerance are plants which show increased tolerance to abiotic stress conditions such as drought, high salinity, high light intensity, high UV radiation, chemical contamination (e.g., high heavy metal concentration), low temperature or high temperature, limited supply of nutrients (i.e., nitrogen, phosphorus) and population stress (see, e.g., WO2000/004173, WO2007/131699, CA2521729 and US2008/0229448).

Examples of plants to which abiotic stress tolerance has been imparted by the genetic engineering techniques include rice, corn, soybean, sugar cane, alfalfa, wheat, tomato, potato, barley, rapeseed, bean, wild oat, sorghum and cotton which have tolerance to drought (see, e.g., WO2005/048693, WO2008/002480 and WO2007/030001); corn, soybean, wheat, cotton, rice, rapeseed and alfalfa which have tolerance to low temperature (see, e.g., U.S. Pat. No. 4,731,499 and WO 2007/112122); rice, cotton, potato, soybean, wheat, barley, rye, sorghum, alfalfa, grape, tomato, sunflower and tobacco which have tolerance to high salinity (see, e.g., U.S. Pat. Nos. 7,256,326, 7,034,139, WO/2001/030990). In addition, there is corn “DroughtGard (registered trademark)” (Monsanto product) to which the cold shock protein gene cspB of Bacillus subtilis has been introduced.

As plants to which non-biological stress tolerance has been imparted by the conventional type variety improvement techniques or the genomic breeding techniques, for example, corn having drought tolerance is developed under the trade names of “Agrisure Artesian (registered trademark)” and “Optimum (registered trademark) AQUAmax (registered trademark)”.

Examples of plants to which other characteristic has been imparted include plants the ripening characteristic has been modified. Examples of the modified ripening characteristics include delayed ripening, delayed softening, and early ripening. Examples of plants the ripening characteristic of which has been modified by the genetic engineering techniques include melon and tomato each shelf-life of which has been improved by introducing the S-adenosylmethion hydrolase gene (sam-K) derived from Escherichia coli bacteriophage T3 involved in ethylene production of the phytohormone; tomato the shelf-life of which has been improved by introducing at least one of a gene deleting a part of the ACC synthase gene which is involved in ethylene production of the phytohormone and derived from tomato, the ACC deaminase gene which degrades an ethylene precursor, ACC and is derived from pseudomonas (Pseudomonas chlororaphis), a gene producing double-stranded RNA of the polygalacturonase gene which degrade pectin of cell wall and is derived from tomato, or an ACC oxidase gene which is involved in ethylene production and derived from tomato; tomato “FLAVR SAVR (trademark)” the shelf-life of which has been improved by introducing a gene pg which produces double-stranded RNA of the polygalacturonase gene derived from tomato. Examples of other plants the ripening characteristic has been modified by the genetic engineering techniques include tomato, melon, raspberry, strawberry, muskmelon, pepper and papaya each ripening of which has been delayed (see, e.g., U.S. Pat. Nos. 5,767,376, 7,084,321, 6,107,548, 5,981,831, WO1995/035387, U.S. Pat. Nos. 5,952,546, 5,512,466, WO1997/001952, WO1992/008798 and Plant Cell. 1989, 53-63. Plant Molecular Biology, 50, 2002). Methods for producing such plants are generally known to those skilled in the art and are described, for example, in the publications mentioned above. Preferably, the plants are selected from fruits (e.g., tomato, vines, melon, papaya, banana, pepper, raspberry and strawberry); stone fruits (e.g., cherry, apricot and peach); pomaceous fruits (e.g., apple and pear); and citrus fruits (e.g., citron, lime, orange, pomelo, grapefruit, and mandarin), more preferably selected from tomato, melon, papaya, vines, apple, banana, orange and strawberry, and most preferably are tomato, melon and papaya.

Examples of plants to which other quality modifications have been imparted by the genetic engineering techniques include canola “Phytaseed (registered trademark) Canola” in which degradation of endogenous phytic acid has been enhanced by introducing the 3-phytase gene (phyA) derived from black mold (Aspergillus niger), which is an enzyme that degrades phytic acid in plants; carnation “Moondust (trademark)”, “Moonshadow (trademark)”, “Moonshade (trademark)”, “Moonlite (trademark)”, “Moonaqua (trademark)”, “Moonvista (trademark)”, “Moonique (trademark)”, “Moonpearl (trademark)”, “Moonberry (trademark)”, and “Moonvelvet (trademark)” the flower color of which has been controlled to be blue by introducing the dihydrodoflavonol-4-reductase gene which is an enzyme producing the blue pigment delphinidin and its derivatives and is derived from Petunia (Petunia hybrida) and the flavonoid-3′,5′-hydroxylase gene derived from petunia, pansy (Viola wittrockiana), salvia (Salvia splendens) or carnation; rose the flower color of which has been controlled to be blue by introducing the anthocyanin-5-acyltransferase gene which is an enzyme producing the blue pigment delphinidin and its derivatives and is derived from torenia (Torenia sp.) and the flavonoid-3,5′-hydroxylase gene which is derived from pansy; rice which has an immune tolerant effect to alleviate hay fever by introducing the modified antigen protein gene (7crp) of cedar pollen; corn in which the degradation of endogenous phytic acid has been enhanced by introducing the 3-phytase gene (phyA) derived from black mold; cotton the fiber micronaire, increased fiber strength, the uniformity of length and color of which have been improved thereby producing high-quality fiber (see, e.g., WO1996/26639, U.S. Pat. Nos. 7,329,802, 6,472,588, and WO2001/17333).

Examples of plants whose traits related to plant growth and yield have been modified include plants the growth capability of which has been enhanced. As plants whose traits related to plant growth and yield have been modified by the genetic engineering techniques, for example, soybean for which high yield can be expected as the result of enhanced plant growth by introducing the gene (bbx32) encoding a transcription factor which control diurnality and is derived from Thale Cress; corn for which high yield can be expected as the result of the increased female ear weight by introducing the transcription factor gene (athb17) which belongs to homeodomain-leucine 14 zipper (HD-Zip) family class II HD-Zip II) and is derived from Thale Cress are developed.

Examples of plants the quality of which has been modified by the genome editing techniques include corn “ZFN-12 maize” the phytic acid content of which has been reduced by deleting the IPK1 gene encoding inositol-1,3,4,5,6-pentakisphosphate 2-kinase which is an enzyme for phytic acid biosynthesis using zinc finger nuclease; mushroom to which tolerance to browning has been imparted by deleting a gene encoding polyphenol oxidase using Crisper Cass Nine (see, e.g., Nature., Vol 532, 21 Apr. 2016).

Examples of plants the quality of which has been modified by the new breeding techniques include apple “Arctic (registered trademark)” which does not turn brown by introducing the low polyphenol oxidase (enzyme that causes browning) production gene sequence GEN-03 isolated from apple into a new apple variety using cisgenesis, thereby reducing polyphenol oxidase expression levels; as an example that a character of the GM rootstock is imparted to the scion, which is the variety improvement technique in which grafting is used, tomato in which salinity tolerance has been imparted to non-transgenic scion by using the tomato rootstock having salinity tolerance.

For rice, numerous genes which exhibit resistance to diseases, pest insects, and abiotic stresses are known, and productions of resistant varieties to which these have been introduced have been popular. As genes which exhibit resistance to disease and abiotic stresses in rice, for example, brown planthopper resistance genes such as BPH1, BPH2, BPH3, BPH4, BPH5, BPH6, BPH7, BPH8, BPH9, BPH10, BPH11, BPH12, BPH13, BPH14, BPH15, BPH17, BPH 18, BPH19, BPH20, BPH21, BPH22, BPH23, BPH24, BPH25, BPH26, BPH27, BPH28, BPH29, BPH32, qBPH-12, qBPHR-1, qBPHR-3, qBPHR-8, qBPHR-5-1qBPHR-5-2qBPHR-11-1, qBPHR-11-2, etc.; white-backed planthopper resistance genes such as WBPH1, WBPH2, WBPH3, WBPH4, WBPH5, WBPH6, OVC, qOVA-5-2, qOVA1-3, qOVA5-1, etc.; small brown planthopper resistance genes such as Qsbph2b, Qsbph3, Qsbph3b, Qsbph3c, Qsbph3d, Qsbph4, Qsbph8, Qsbph11, Qsbph11d, Qsbph11e, Qsbph11f, Qsbph11g, Qsbph12a etc.; leafhopper resistance genes such as GLH, GLH1, GLH3, GLH4, GLH5, GLH6, GLH7, GLH8, GLH9, GLH10, GLH11, GLH12, GLH13, GRH1, GRH2, GRH3, GRH4, GRH5, Zlh1, Zlh2, Zlh3, qGRH-4, qGRH-2, qGRH-5, qGRH-6, qGRH-11, qGRH-3 etc.; rice stem borer resistance genes such as SB etc.; blast resistance genes such as Pii, PI65, PIZT, PI24, PI29, PI25, Pi-jnw1, PB1, PIQ6, PID3, PI67, PITQ5, PITP, PITQ6, PLM2, PISE3, IPI, PISE1, PI157, PIQ4, PI21, PIA, PIB, PIK, PIKUR1, PIKUR2, PI3, PIF, PIZH, PIR4, PIR7, PI30, PI, PIGD2, PIG, PIGD3, PIGD1, PIZ, PI(, P118, PIM, P117, P120, P11, P119, PI5, PISH, P110, P19, P121, P122, P144, P122, P113, PII, PIB1, PIQ1, PIQ2, PIQ3, PIIS1, P112, P162, P112, IP13, P114, P115, P116, PIT, P111, P16, P123, P114, P111, PIIS2, PIB2, P112, P139, P140, PITA, PIR2-3, PIR9-2, PIR12-2, PIRF2-1, qRBR-2, qRBR-3, P127, P128, P126, PIGM, P147, P148, P17, P156, P149, P134, PIKG, P138, P132, P131, P146, PIX, PIXY, Pita3, P141, P142, P12, P136, P137, PIKH, PIKM, PIKP, P135, PIZ5, PIB2, P143, P150, P151, PID1, PIY1, PIY2, P155-2, PIC039, P155-1, PIBH8, PIR7A, PIR7B, PID2, P133, qBFR4-1, qBFR4-2, qRBR-2, qRBR-3, qRBR-8, qRBR-1-1, qRBR-1-3, qRBR-7-1, qRBR-7-2, qRBR-9-1, qRBR-9-2, qRBR-9-3, qRBR-1-2, and qRBR-1-4; stripe resistance genes such as STVA, STVB, Stvb-i; bacterial leaf blight resistance genes such as XA21D, XA, XA40, XA NM, XA8, XA33, XA34, XA35, XA36, XA37, XA7, XA3, XA25, XA28, XA29, XA30, XA31, XA32, XA38, XA39, XA11, XA16, XA17, XA18, XA19, XA20, XA14, XA2, XA12, XA1, XA K, XA A, XA H, XA10, XA23, XA22, XA24, XA21, SERRT13, XA4, XAS, XA13 etc.; sheath blight resistance genes such as qSB-2, qSB-3, qSB 7, qSB-11, qSB-9-1, etc.; brown spot resistance genes such as CE etc.; downy mildew resistance genes such as YDV etc.; black-streaked dwarf resistance genes such as BSV etc.; genes having tolerance to high temperature at ripening stage such as Amy1A, Amy1C, Amy3A, Amy3B etc.; low amylose genes such as dul3, qAC9.3, rsr1, Wx and Wx1-1, etc.; lodging resistance genes such as AP01, SCM2, Sd1, etc.; pre-harvest sprouting resistance genes such as Sdr4 etc.; low temperature tolerance genes such as CTB1, CTB2, qLTG3-1 etc.; drought tolerance genes such as Dro1 etc.; genes involved in spikelets number and seed shape such as DEP1, Cnla, GPS, SPIKE, PTB1, TAWAWA1, WFP, IPA1, GS3, GSS, GS6, GL3.1, GW2, GW8, qGL3, qSS7, qSWS, etc.; genes regulating day-length response such as Hd1, Ghd8, DTH8 etc.; floury endosperm genes such as FLO4, PDIL1 etc.; lipoxygenase deletion (reducing old rice odor) genes such as LOX3 etc.; genes involved in amylopectin chain length such as Alk, etc. are known. Rice varieties to which one or a plural of these genes simultaneously has been incorporated are developed or commercially available.

The aforementioned plants include plants to which two or more of the characteristics of the parental line have been imparted by crossing a line endowed with two or more of the aforementioned abiotic stress tolerance, disease resistance, herbicide tolerance, pest insect resistance, growth and yield trait, modified nutrient utilization, modified product quality, fertility trait and the like using the genetic engineering techniques, the conventional type variety improvement techniques, the genomic breeding techniques, the new breeding techniques, the genome editing techniques or the like and a plant having the same or different characteristics.

Examples of commercially available plants to which tolerance to two or more herbicides has been imparted include cotton “GlyTol (trademark) LibertyLink (trademark)” and “GlyTol (trademark) LibertyLink (trademark)” which have tolerance to glyphosate and glufosinate; corn “Roundup Ready (trademark) LibertyLink (trademark) Maize” which has glyphosate tolerance and glufosinate tolerance; soybean “Enlist (trademark) Soybean” which has glufosinate tolerance and 2,4-D tolerance; soybean “Genuity (registered trademark) Roundup Ready (trademark) 2 Xtend (trademark)” which has glyphosate tolerance and dicamba tolerance; corn and soybean “OptimumGAT (trademark)” which have glyphosate tolerance and ALS inhibitor tolerance; genetically modified soybean “Enlist E3 (trademark)” and “Enlist (trademark) Roundup Ready 2 Yield (registered trademark)” which are tolerant to three herbicides of glyphosate, glufosinate and 2,4-D; corn “Enlist (trademark) Roundup Ready (registered trademark) Corn 2” which is tolerant to glyphosate, 2,4-D and aryloxyphenoxypropionic acid (FOPs) herbicides; corn “Enlist (trademark) Roundup Ready (registered trademark) Corn 2” which is tolerant to glyphosate, 2,4-D and aryloxyphenoxypropionic acid (FOPs) herbicides; cotton “Bollgard II (registered trademark) XtendFlex (trademark) Cotton” which is tolerant to dicamba, glyphosate and glufosinate; cotton “Enlist (trademark) Cotton” which is tolerant to three herbicides of glyphosate, glufosinate and 2,4-D; soybean “Liberty Link (registered trademark) GT27 (trademark)” which is tolerant to three herbicides of glyphosate, glufosinate and HPPD herbicides (e.g., isoxaflutole). In addition, cotton which has tolerance to both glufosinate and 2,4-D; cotton which has tolerance to both glufosinate and dicamba; corn which has tolerance to both glyphosate and 2,4-D; soybean which exhibits tolerance to both glyphosate and HPPD herbicides; corn which has tolerance to glyphosate, glufosinate, 2,4-D, aryloxyphenoxypropionic acid (FOPs) herbicides and cyclohexadione (DIMs) herbicides are also developed.

Examples of commercially available plants to which herbicide tolerance and pest insect resistance have been imparted include corn “YieldGard Roundup Ready (trademark)” and “YieldGard Roundup Ready 2 (trademark)” which have glyphosate tolerance and resistance to corn borer; corn “Agrisure CB/LL (trademark)” which has glufosinate tolerance and corn borer resistance; corn “Yield Gard VT Root worm/RR2 (trademark)” which has glyphosate tolerance and corn rootworm resistance; corn “Yield Gard VT Triple (trademark)” which has glyphosate tolerance and resistance to corn rootworm and corn borer; corn “Herculex I (trademark)” which has glufosinate tolerance and lepidopteran pest insect resistance (Cry1F) (e.g., resistance to western bean cutworm, corn borer, black cutworm and fall armyworm); corn “YieldGard Corn Rootworm/Roundup Ready 2 (trademark)” which has glyphosate tolerance and corn rootworm resistance; corn “Agrisure GT/RW (trademark)” which has glufosinate tolerance and resistance to coleopteran pest insects for corn (Cry3A) (e.g., resistance to western corn rootworm, northern corn rootworm, and Mexican corn rootworm); corn “Herculex RW (trademark)” which has glufosinate tolerance and coleopteran pest insect resistance (Cry34/35Ab1) (e.g., resistance to western corn rootworm, northern corn rootworm, and Mexican corn rootworm); corn “Yield Gard VT Root worm/RR2 (trademark)” which has glyphosate tolerance and corn rootworm resistance; cotton “Bollgard (registered trademark) 3 XtendFlex (registered trademark)” which has dicamba tolerance, glyphosate tolerance, glufosinate tolerance, and resistance to lepidopteran pest insects for cotton (e.g., resistance to bollworms and tobacco budworms, armyworms, etc.).

Examples of commercially available plants to which disease resistance and pest insect resistance have been imparted include potato “Hi-Lite NewLeaf (trademark) Y Potato”, “NewLeaf (trademark) Y Russet Burbank Potato” and “Shepody NewLeaf (trademark) Y Potato” to which Potato virus Y resistance and pest insect resistance have been imparted; potato “NewLeaf (trademark) Plus Russet Burbank Potato” to which potato leafroll virus-resistance and pest insect resistance have been imparted.

Examples of commercially available plants to which herbicide tolerance and trait for product quality modification have been imparted include canola “InVigor (trademark) Canola” to which glufosinate tolerance and fertility trait have been imparted; corn “InVigor (trademark) Maize” to which glufosinate tolerance and fertility trait have been imparted; soybean “Vistive Gold (trademark)” which has been endowed with glyphosate tolerance and has been modified oil content.

Examples of commercially available plants which have three or more traits include corn “Herculex I/Roundup Ready 2 (trademark)” which has glyphosate tolerance, glufosinate tolerance and lepidopteran pest insect resistance (Cry1F) (i.e., resistance to western bean cutworm, corn borer, black cutworm, and fall armyworm); corn “YieldGard Plus/Roundup Ready 2 (trademark)” which has glyphosate tolerance, corn rootworm resistance and corn borer resistance; corn “Agrisure GT/CB/LL (trademark)” which has glyphosate tolerance, glufosinate tolerance and corn borer resistance; corn “Herculex Xtra (trademark)” which has glufosinate tolerance, lepidopteran pest insect resistance (Cry1F) and coleopteran pest insect resistance (Cry34/35Ab1) (i.e. resistance to lepidopteran pest insects such as western bean cutworm, corn borer, black cutworm and fall armyworm and coleopteran pest insects such as western corn rootworm, northern corn rootworm, and Mexican corn rootworm); corn “Agrisure CB/LL/RW (trademark)” which has glufosinate tolerance, corn borer resistance (Cry1Ab) and coleopteran pest insect resistance (Cry3A) (i.e., resistance to western corn rootworm, northern corn rootworm and Mexican corn rootworm); corn “Agrisure (Trademark) 3000GT” which has glyphosate tolerance, corn borer resistance (Cry1Ab) and coleopteran pest insect resistance (Cry3A) (i.e., resistance to western corn rootworm, northern corn rootworm, and Mexican corn rootworm); corn “Mavera high-value corn” which has glyphosate tolerance, resistance to corn rootworm and European corn borer and high lysine trait; corn “Optimum (registered trademark) Leptra (trademark)” which has resistance to pest insects that damage aerial part of plants such as European corn borer, southwestern corn borer, corn earworm, fall armyworm, black cutworm and/or western beanworm; soybean “Credenz (registered trademark) soybean” which has glyphosate tolerance, glufosinate tolerance, soybean frogeye leaf spot resistance, and sudden death Syndrome resistance, southern stem canker resistance, phytophthora stem and root rot resistance, southern root-knot nematode resistance, stem rot resistance, brown stem rot resistance, soybean cyst nematode resistance, and in which iron chlorosis has been improved and chloride sensitivity has been modified; cotton “Stoneville (registered trademark) Cotton” to which multiple herbicide tolerances and pest resistances have been imparted (There are nine varieties of ST5517GLTP, ST4848GLT, ST4949GLT, ST5020GLT, ST5115GLT, ST6182GLT, ST4747GLB2, ST4946GLB2, and ST6448GLB2 in order to address infestation conditions of weeds and insects in fields of each region).

Plants which are commercially available or under development are listed below (A1-A556). In brackets, [plant name, Event Name, Event code, Trademark name (Tradename)] are meant. Also, NA means “no information” or “information not available”. Many of these plants are listed in the registration database (GM APPROVAL DATABASE) in the electronic information site (http://www.isaaa.org/) of INTERNATINAL SERVICE for the ACQUISITION of AGRI-BIOTECH APPLICATIONS (ISAAA).
A1: [alfalfa, J101, MON-00101-8, Roundup Ready (trademark) Alfalfa], A2: [alfalfa, J101×J163, MON-00101-8×MON-00163-7, Roundup Ready (trademark) Alfalfa], A3: [alfalfa, J163, MON-00163-7, Roundup Ready (trademark) Alfalfa], A4: [alfalfa, KK179, MON-00179-5, HarvXtra (trademark)], A5: [alfalfa, KK179×J101, MON-00179-5×MON-00101-8], A6: [apple, GD743, OKA-NB001-8, Arctic (trademark) “Golden Delicious” Apple], A7: [apple, GS784, OKA-NB002-9, Arctic (trademark)], A8: [apple, NF872, OKA-NB003-1, Arctic (trademark) Fuji Apple], A9: [Argentina canola, 23-18-17 (Event 18), CGN-89111-8, Laurical (trademark) Canola], A10: [Argentina canola, 23-198 (Event 23), CGN-89465-2, Laurical (trademark) Canola], A11: [Argentina canola, 61061, DP-061061-7], A12: [Argentina canola, 73496, DP-073496-4, Optimum (registered trademark) Gly canola], A13: [Argentina canola, 73496×RF3, DP-073496-4×ACS-BN003-6, NA], A14: [Argentina canola, GT200 (RT200), MON-89249-2, Roundup Ready (trademark) Canola], A15: [Argentina canola, GT73 (RT73), MON-00073-7, Roundup Ready (trademark) Canola], A16: [Argentina canola, HCN10 (Topas 19/2), NA, Liberty Link (trademark) Independence (trademark)], A17: [Argentina canola, HCN28 (T45), ACS-BN008-2, InVigor (trademark) Canola], A18: [Argentina canola, HCN28×MON88302, ACS-BN008-2×MON-88302-9, InVigor (trademark)×TruFlex (trademark) Roundup Ready (trademark) Canola], A19: [Argentina canola, HCN92 (Topas 19/2), ACS-BN007-1, Liberty Link (trademark) Innovator (trademark)], A20: [Argentina canola, HCN92×MON88302, ACS-BN007-1×MON-88302-9, Liberty Link (trademark) Innovator (trademark)×TruFlex (trademark) Roundup Ready (trademark) Canola], A21: [Argentina canola, MON88302, MON-88302-9, TruFlex (trademark) Roundup Ready (trademark) Canola], A22: [Argentina canola, MON88302×MS8×RF3, MON-88302-9×ACS-BN005-8×ACS-BN003-6, InVigor (trademark)×TruFlex (trademark) Roundup Ready (trademark) Canola], A23: [Argentina canola, MON88302×RF3, MON-88302-9×ACS-BN003-6, NA], A24: [Argentina canola, MPS961, NA, Phytaseed (trademark) Canola], A25: [Argentina canola, MPS962, NA, Phytaseed (trademark) Canola], A26: [Argentina canola, MPS963, NA, Phytaseed (trademark) Canola], A27: [Argentina canola, MPS964, NA, Phytaseed (trademark) Canola], A28: [Argentina canola, MPS965, NA, Phytaseed (trademark) Canola], A29: [Argentina canola, MS1 (B91-4), ACS-BN004-7, InVigor (trademark) Canola], A30: [Argentina canola, MS1×MON88302, ACS-BN004-7×MON-88302-9, InVigor(trademark)×TruFlex (trademark) Roundup Ready (trademark) Canola], A31: [Argentina canola, MS1×RF1 (PGS1), ACS-BN004-7×ACS-BN001-4, InVigor (trademark) Canola], A32: [Argentina canola, MS1×RF1 (PGS2), ACS-BN004-7×ACS-BN002-5, InVigor (trademark) Canola], A33: [Argentina canola, MS1×RF3, ACS-BN004-7×ACS-BN003-6, InVigor (trademark) Canola], A34: [Argentina canola, MS8, ACS-BN005-8, InVigor (trademark) Canola], A35: [Argentina canola, MS8×MON88302, ACS-BN005-8×MON-88302-9, InVigor (trademark)×TruFlex (trademark) Roundup Ready (trademark) Canola], A36: [Argentina canola, MS8×RF3, ACS-BN005-8×ACS-BN003-6, InVigor (trademark) Canola], A37: [Argentina canola, MS8×RF3×GT73 (RT73), ACS-BN005-8×ACS-BN003-6×MON-00073-7, NA], A38: [Argentina canola, OXY-235, ACS-BN011-5, Navigator (trademark) Canola], A39: [Argentina canola, PHY14, NA, NA], A40: [Argentina canola, PHY23, NA, NA], A41: [Argentina canola, PHY35, NA, NA], A42: [Argentina canola, PHY36, NA, NA], A43: [Argentina canola, RF1 (B93-101), ACS-BN001-4, InVigor (trademark) Canola], A44: [Argentina canola, RF1×MON88302, CS-BN001-4×MON-88302-9, InVigor (trademark)×TruFlex (trademark) Roundup Ready (trademark) Canola], A45: [Argentina canola, RF2 (B94-2), ACS-BN002-5, InVigor (trademark) Canola], A46: [Argentina canola, RF2×MON88302, ACS-BN002-5×MON-88302-9, InVigor (trademark)×TruFlex (trademark) Roundup Ready (trademark) Canola], A47: [Argentina canola, RF3, ACS-BN003-6, InVigor (trademark) Canola], A48: [bean, EMBRAPA5.1, EMB-PV051-1, NA], A49: [carnation, 11(7442), FLO-07442-4, Moondust (trademark)], A50: [carnation, 11363(1363A), FLO-11363-1, Moonshadow (trademark)], A51: [carnation, 1226A(11226), FLO-11226-8, Moonshade (trademark)], A52: [carnation, 123.2.2(40619), FLO-40619-7, Moonshade (trademark)], A53: [carnation, 123.2.38(40644), FLO-40644-4, Moonlite (trademark)], A54: [carnation, 123.8.12, FLO-40689-6, Moonaqua (trademark)], A55: [carnation, 123.8.8(40685), FLO-40685-1, Moonvista (trademark)], A56: [carnation, 1351A(11351), FLO-11351-7, Moonshade (trademark)], A57: [carnation, 1400A(11400), FLO-11400-2, Moonshade (trademark)], A58: [carnation, 15, FLO-00015-2, Moondust (trademark)], A59: [carnation, 16, FLO-00016-3, Moondust (trademark)], A60: [carnation, 19907, IFD-19907-9, Moonique (trademark)], A61: [carnation, 25947, IFD-25947-1, Moonpearl (trademark)], A62: [carnation, 25958, IFD-25958-3, Moonberry (trademark)], A63: [carnation, 26407, IFD-26407-2, Moonvelvet (trademark)], A64: [carnation, 4, FLO-00004-9, Moondust (trademark)], A65: [carnation, 66, FLO-00066-8, NA]A66: [carnation, 959A(11959), FLO-11959-3, Moonshade (trademark)], A67: [carnation, 988A(11988), FLO-11988-7, Moonshade (trademark)], A68: [chicory, RM3-3, NA, SeedLink (trademark)], A69: [chicory, RM3-4, NA, SeedLink (trademark)], A70: [chicory, RM3-6, NA, SeedLink (trademark)], A71: [cotton, 19-51a, DD-01951A-7, NA], A72: [cotton, 281-24-236, DAS-24236-5, NA], A73: [cotton, 281-24-236×3006-210-23(M×B-13), DAS-24236-5×DAS-21023-5, WideStrike (trademark) Cotton], A74: [cotton, 281-24-236×3006-210-23×COT102×81910, DAS-24236-5×DAS-21023-5×SYN-IR102-7×DAS-81910-7, NA], A75: [cotton, 3006-210-23, DAS-21023-5, NA], A76: [cotton, 3006-210-23×281-24-236×MON1445, DAS-21023-5×DAS-24236-5×MON-01445-2, WideStrike (trademark) RoundupReady (trademark) Cotton], A77: [cotton, 3006-210-23×281-24-236×MON88913, DAS-21023-5×DAS-24236-5×NAMON-88913-8, Widestrike (trademark) RoundupReadyFlex (trademark) Cotton], A78: [cotton, 3006-210-23×281-24-236×MON88913×COT102, DAS-21023-5×DAS-24236-5×MON-88913-8×SYN-IR102-7, Widestrike (trademark) RoundupReadyFlex (trademark) Cotton], A79: [cotton, 31707, NA, BXN (trademark) PlusBollgard (trademark) Cotton], A80: [cotton, 31803, NA, BXN (trademark) PlusBollgard (trademark) Cotton], A81: [cotton, 31807×31808, NA, NA], A82: [cotton, 31807, NA, BXN (trademark) PlusBollgard (trademark) Cotton], A83: [cotton, 31808, NA, BXN (trademark) PlusBollgard (trademark) Cotton], A84: [cotton, 42317, NA, BXN (trademark) PlusBollgard (trademark) Cotton], A85: [cotton, 81910, DAS-81910-7, NA], A86: [cotton, BNLA-601, NA, NA], A87: [cotton, BXN10211(10211), BXN-10211-9, NA], A88: [cotton, BXN10215(10215), BXN-10215-4NA, BXN (trademark) Cotton], A89: [cotton, BXN102 cotton 22(10222), BXN-10222-2, BXN (trademark) Cotton], A90: [cotton, BXN10224(10224), BXN-10224-4NA, BXN (trademark) Cotton], A91: [cotton, COT102(IR102), SYN-IR102-7, VIPCOT (trademark) Cotton], A92: [cotton, COT102×COT67B, SYN-IR102-7NA×NASYN-IR67B-1, VIPCOT (trademark) Cotton], A93: [cotton, COT102×COT67B×MON88913, SYN-IR102-7NA×NASYN-IR67B-1NA×NAMON-88913-8, VIPCOT (trademark) RoundupReadyFlex (trademark) Cotton], A94: [cotton, COT102×MON15985, SYN-IR102-7NA×NAMON-15985-7, Bollgard (registered trademark) III], A95: [cotton, COT102×MON15985×MON88913, SYN-IR102-7NA×NAMON-15985-7NA×NAMON-88913-8, Bollgard (registered trademark) III×RoundupReady (trademark) Flex (trademark)], A96: [cotton, COT102×MON15985×MON88913×MON88701, SYN-IR102-7NA×NAMON-15985-7NA×NAMON-88913-8NA×NAMONNA88701-3, NA], A97: [cotton, COT67B(IR67B), SYN-IR67B-1, NA], A98: [cotton, Event1, NA, JK1], A99: [cotton, GFMCry1A, GTL-GFM311-7, NA], A100: [cotton, GHB119, BCS-GH005-8, NA], A101: [cotton, GHB614, BCS-GH002-5, GlyTol (trademark)], A102: [cotton, GHB614×LLCotton25, BCS-GH002-5NA×NAACS-GH001-3, GlyTol (trademark) LibertyLink (trademark)], A103: [cotton, GHB614×LLCotton25×MON15985, BCS-GH002-5NA×NAACS-GH001-3NA×NAMON-15985-7, NA], A104: [cotton, GHB614×MON15985, BCS-GH002-5NAxNAMON-15985, NA], A105: [cotton, GHB614×T304-40×GHB119, BCS-GH002-5NA×NABCS-GH004-7NA×NABCS-GH005-8, Glytol (trademark)×Twinlink (trademark)], A106: [cotton, GHB614×T304-40×GHB119×COT102, BCS-GH002-5NA×NABCS-GH004-7NA×NABCS-GH005-8NA×NASYN-IR102-7, Glytol (trademark)×Twinlink (trademark)×VIPCOT (trademark) Cotton], A107: [cotton, GK12, NA, NA], A108: [cotton, LLCotton25, ACS-GH001-3NA, Fiberma×(trademark) LibertyLink (trademark)], A109: [cotton, LLCotton25×MON15985, ACS-GH001-3NA×NAMON-15985-7, Fiberma×(trademark) LibertyLink (trademark) Bollgardll (trademark)], A110: [cotton, MLS9124, NA, NA], A111: [cotton, MON1076, MON-89924-2, Bollgard (trademark) Cotton], A112: [cotton, MON1445, MON-01445-2, RoundupReady (trademark) Cotton], A113: [cotton, MON15985, MON-15985-7, Bollgardll (trademark) Cotton], A114: [cotton, MON15985×MON1445, MON-15985-7NA×NAMON-01445-2, RoundupReady (trademark) Bollgardll (trademark) Cotton], A115: [cotton, MON1698, MON-89383-1, RoundupReady (trademark) Cotton], A116: [cotton, MON531, MON-00531-6, Bollgard (trademark) Cotton, Ingard (trademark)], A117: [cotton, MON531×MON1445, MON-0531-6NA×NAMON-01445-2, RoundupReady (trademark) Bollgard (trademark) Cotton], A118: [cotton, MON757, MON-00757-7, Bollgard (trademark) Cotton], A119: [cotton, MON88701, MONNA88701-3, NA], A120: [cotton, MON88701×MON88913, MONNA88701-3NA×NAMON-88913-8, NA], A121: [cotton, MON88701×MON88913×MON15985, MONNA88701-3NA×NAMON-88913-8NA×NAMON-15985-7, Bollgard II (registered trademark) XtendFlex (trademark) Cotton], A122: [cotton, MON88913, MON-88913-8, RoundupReady (trademark) Flex (trademark) Cotton], A123: [cotton, MON88913×MON15985, MON-88913-8NA×NAMON-15985-7, RoundupReady (trademark) Flex (trademark) Bollgardll (trademark) Cotton], A124: [cotton, NgweChi6Bt, NA, NgweChi6Bt], A125: [cotton, SGK321, NA, NA], A126: [cotton, T303-3, BCS-GH003-6, NA], A127: [cotton, T304-40, BCS-GH004-7, NA], A128: [cotton, T304-40×GHB119, BCS-GH004-7NA×NABCS-GH005-8, TwinLink (trademark) Cotton], A129: [creeping bentgrass, ASR368, SMG-36800-2, NA], A130: [eggplant, BtBrinjalEventEE1, BtBrinjalEventEE1, BARIBtBegun-1, -2, -3and -4], A131: [eucalyptus, H421, H421, GMEucalyptus], A132: [flax, FP967(CDCTriffid), CDC-FL001-2, CDCTriffidFlax], A133: [lentil, RH44, RH44, Clearfield (registered trademark) lentil], A134: [corn, 32138, DP-32138-132138, 2138SPTmaintainer], A135: [corn, 3272, SYN-E3272-5, Enogen (trademark)], A136: [corn, 3272×Bt11, SYN-E3272-5×SYN-BT011-1, NA], A137: [corn, 3272×Bt11×GA21, SYN-E3272-5×SYN-BT011-1×MON-00021-9, NA], A138: [corn, 3272×Bt11×MIR604, SYN-E3272-5×SYN-BT011-1×SYN-IR604-5, NA], A139: [corn, 3272×BT11×MIR604×GA21, SYN-E3272-5×SYN-BT011-1×SYN-IR604-5×MON-00021-9, NA], A140: [corn, 3272×Bt11×MIR604×TC1507×5307×GA21, SYN-E3272-5×SYN-BT011-1×SYN-IR604-5×DAS-01507-1×SYN-05307-1×MON-00021-9, NA], A141: [corn, 3272×GA21, SYN-E3272-5×MON-00021-9, NA], A142: [corn, 3272×MIR604, SYN-E3272-5×SYN-IR604-5, NA], A143: [corn, 3272×MIR604×GA21, SYN-E3272-5×SYN-IR604-5×MON-00021-9, NA], A144: corn, 33121, DP-033121-3, NA], A145: [corn, 4114, DP-004114-3, NA], A146: [corn, 5307, SYN-05307-1, Agrisure (registered trademark) Duracade (trademark)], A147: [corn, 5307×GA21, SYN-05307-1×MON-00021-9, NA], A148: [corn, 5307×MIR604×Bt11×TC1507×GA21, SYN-05307-1×SYN-IR604-5×SYN-BT011-1×DAS-01507-1×MON-00021-9, Agrisure (registered trademark) Duracade (trademark) 5122], A149: [corn, 5307×MIR604×Bt11×TC1507×GA21×MIR162, SYN-05307-1×SYN-IR604-5×SYN-BT011-1×DAS-01507-1×MON-00021-9×SYN-IR162-4, Agrisure (registered trademark) Duracade (trademark) 5222], A150: [corn, 59122, DAS-59122-7, Hercule×(trademark) RW], A151: [corn, 59122×DAS40278, DAS-59122-7×DAS-40278-9, NA], A152: [corn, 59122×GA21, DAS-59122-7×MON-00021-9, NA], A153: [corn, 59122×MIR604, DAS-59122-7×SYN-IR604-5, NA], A154: [corn, 59122×MIR604×GA21, DAS-59122-7×SYN-IR604-5×MON-00021-9, NA], A155: [corn, 59122×MIR604×TC1507, DAS-59122-7×SYN-IR604-5×DAS-01507-1, NA], A156: [corn, 59122×MIR604×TC1507×GA21, DAS-59122-7×SYN-IR604-5×DAS-01507-1×MON-00021-9, NA], A157: [corn, 59122×MON810, DAS-59122-7×MON-00810-6, NA], A158: [corn, 59122×MON810×MIR604, DAS-59122-7×MON-00810-6×SYN-IR604-5, NA], A159: [corn, 59122×MON810×NK603, DAS-59122-7×MON-00810-6×MON-00603-6, NA], A160: [corn, 59122×MON810×NK603×MIR604, DAS-59122-7×MON-00810-6×MON-00603-6×SYN-IR604-5, NA], A161: [corn, 59122×MON88017, DAS-59122-7×MON-88017-3, NA], A162: [corn, 59122×MON88017×DAS40278, DAS-59122-7×MON-88017-3×DAS-40278-9, NA], A163: [corn, 59122×NK603, DAS-59122-7×MON-00603-6, Herculex (trademark) RWRoundupReady (trademark) 2], A164: [corn, 59122×NK603×MIR604, DAS-59122-7×MON-00603-6×SYN-IR604-5, NA], A165: [corn, 59122×TC1507×GA21, DAS-59122-7×DAS-01507-1×MON-00021-9, NA], A166: [corn, 676, PH-000676-7, NA], A167: [corn, 678, PH-000678-9, NA], A168: [corn, 680, PH-000680-2, NA], A169: [corn, 98140, DP-098140-6, Optimum GAT (trademark)], A170: [corn, 98140×59122, DP-098140-6×DAS-59122-7, NA], A171: [corn, 98140×TC1507, DP-098140-6×DAS-01507-1, NA], A172: [corn, 98140×TC1507×59122, DP-098140-6×DAS-01507-1×DAS-59122-7, NA], A173: [corn, Bt10, NA, Bt10], A174: [corn, Bt11(X 4334CBR, X 4734CBR), SYN-BT011-1, Agrisure (trademark) CB/LL], A175: [corn, Bt11×5307, SYN-BT011-1×SYN-05307-1, NA], A176: [corn, Bt11×5307×GA21, SYN-BT011-1×SYN-05307-1×MON-00021-9, NA], A177: [corn, Bt11×59122, SYN-BT011-1×DAS-59122-7, NA], A178: [corn, Bt11×59122×GA21, SYN-BT011-1×DAS-59122-7×MON-00021-9, NA], A179: [corn, Bt11×59122×MIR604, SYN-BT011-1×DAS-59122-7×SYN-IR604-5, NA], A180: [corn, Bt11×59122×MIR604×GA21, SYN-BT011-1×DAS-59122-7×SYN-IR604-5×MON-00021-9, NA], A181: [corn, Bt11×59122×MIR604×TC1507, SYN-BT011-1×DAS-59122-7×SYN-IR604-5×DAS-01507-1, NA], A182: [corn, BT11×59122×MIR604×TC1507×GA21, SYN-BT011-1×DAS-59122-7×SYN-IR604-5×DAS-01507-1×MON-00021-9, Agrisure (registered trademark) 3122], A183: [corn, Bt11×59122×TC1507, SYN-BT011-1×DAS-59122-7×DAS-01507-1, NA], A184: [corn, Bt11×59122×TC1507×GA21, SYN-BT011-1×DAS-59122-7×DAS-01507-1×MON-00021-9, NA], A185: [corn, Bt11×GA21, SYN-BT011-1×MON-00021-9, Agrisure (trademark) GT/CB/LL], A186: [corn, Bt11×MIR162, SYN-BT011-1×SYN-IR162-4, Agrisure (registered trademark) Viptera (trademark) 2100], A187: [corn, Bt11×MIR162×5307, SYN-BT011-1×SYN-IR162-4×SYN-05307-1, NA], A188: [corn, Bt11×MIR162×5307×GA21, SYN-BT011-1×SYN-IR162-4×SYN-05307-1×MON-00021-9, NA], A189: [corn, Bt11×MIR162×GA21, SYN-BT011-1×SYN-IR162-4×MON-00021-9, Agrisure (registered trademark) Viptera (trademark) 3110], A190: [corn, BT11×MIR162×MIR604, SYN-BT011-1×SYN-IR162-4×SYN-IR604-5, Agrisure (registered trademark) Viptera (trademark) 3100], A191: [corn, BT11×MIR162×MIR604×5307, SYN-BT011-1×SYN-IR162-4×SYN-IR604-5×SYN-05307-1, NA], A192: [corn, Bt11×MIR162×MIR604×5307×GA21, SYN-BT011-1×SYN-IR162-4×SYN-IR604-5×SYN-05307-1×MON-00021-9, NA], A193: [corn, Bt11×MIR162×MIR604×GA21, SYN-BT011-1×SYN-IR162-4×SYN-IR604-5×MON-00021-9, Agrisure (registered trademark) Viptera (trademark) 3111, Agrisure (registered trademark) Viptera (trademark) 4], A194: [corn, Bt11×MIR162×MIR604×MON89034×5307×GA21, SYN-BT011-1×SYN-IR162-4×SYN-IR604-5×MON-89034-3×SYN-05307-1×MON-00021-9, NA], A195: [corn, BT11×MIR162×MIR604×TC1507, SYN-BT011-1×SYN-IR162-4×SYN-IR604-5×DAS-01507-1, NA], A196: [corn, BT11×MIR162×MIR604×TC1507×5307, SYN-BT011-1×SYN-IR162-4×SYN-IR604-5×DAS-01507-1×SYN-05307-1, NA], A197: [corn, Bt11×MIR162×MIR604×TC1507×GA21, SYN-BT011-1×SYN-IR162-4×SYN-IR604-5×DAS-01507-1×MON-00021-9, NA], A198: [corn, Bt11×MIR162×MON89034, SYN-BT011-1×SYN-IR162-4×MON-89034-3, NA], A199: [corn, Bt11×MIR162×MON89034×GA21, SYN-BT011-1×SYN-IR162-4×MON-89034-3×MON-00021-9, NA], A200: [corn, Bt11×MIR162×TC1507, SYN-BT011-1×SYN-IR162-4×DAS-01507-1, NA], A201: [corn, Bt11×MIR162×TC1507×5307, SYN-BT011-1×SYN-IR162-4×DAS-01507-1×SYN-05307-1, NA], A202: [corn, Bt11×MIR162×TC1507×5307×GA21, SYN-BT011-1×SYN-IR162-4×DAS-01507-1×SYN-05307-1×MON-00021-9, NA], A203: [corn, Bt11×MIR162×TC1507×GA21, SYN-BT011-1×SYN-IR162-4×DAS-01507-1×MON-00021-9, Agrisure (trademark) Viptera3220], A204: [corn, Bt11×MIR604, SYN-BT011-1×SYN-IR604-5, Agrisure (trademark) CB/LL/RW], A205: [corn, Bt11×MIR604×5307, SYN-BT011-1×SYN-IR604-5×SYN-05307-1, NA], A206: [corn, Bt11×MIR604×5307×GA21, SYN-BT011-1×SYN-IR604-5×SYN-05307-1×MON-00021-9, NA], A207: [corn, BT11×MIR604×GA21, SYN-BT011-1×SYN-IR604-5×MON-00021-9, Agrisure (trademark) 3000GT], A208: [corn, Bt11×MIR604×TC1507, SYN-BT011-1×SYN-IR604-5×DAS-01507-1, NA], A209: [corn, Bt11×MIR604×TC1507×5307, SYN-BT011-1×SYN-IR604-5×DAS-01507-1×SYN-05307-1, NA], A210: [corn, Bt11×MIR604×TC1507×GA21, SYN-BT011-1×SYN-IR604-5×DAS-01507-1×MON-00021-9, NA], A211: [corn, Bt11×MON89034, SYN-BT011-1×MON-89034-3, NA], A212: [corn, Bt11×MON89034×GA21, SYN-BT011-1×MON-89034-3×MON-00021-9, NA], A213: [corn, Bt11×TC1507, SYN-BT011-1×DAS-01507-1, NA], A214: [corn, Bt11×TC1507×5307, SYN-BT011-1×DAS-01507-1×SYN-05307-1, NA], A215: [corn, Bt11×TC1507×5307×GA21, SYN-BT011-1×DAS-01507-1×SYN-05307-1×MON-00021-9, NA], A216: [corn, Bt11×TC1507×GA21, SYN-BT011-1×DAS-01507-1×MON-00021-9, NA], A217: [corn, Bt176(176), SYN-EV176-9, NaturGardKnockOut (trademark), Ma×imizer (trademark)], A218: [corn, BVLA430101, NA, NA], A219: [corn, CBH-351, ACS-ZM004-3, Starlink (trademark) Maize], A220: [corn, DAS40278, DAS-40278-9, Enlist (trademark) Maize], A221: [corn, DAS40278×NK603, DAS-40278-9×MON-00603-6, NA], A222: [corn, DBT418, DKB-89614-9, Bt×tra (trademark) Maize], A223: [corn, DLL25(B16), DKB-89790-5, NA], A224: [corn, GA21, MON-00021-9, RoundupReady (trademark) Maize, Agrisure (trademark) GT], A225: [corn, GA21×MON810, MON-00021-9×MON-00810-6, RoundupReady (trademark) YieldGard (trademark) maize], A226: [corn, GA21×T25, MON-00021-9×ACS-ZM003-2, NA], A227: [corn, HCEM485, HCEM485, NA], A228: [corn, LY038, REN-00038-3, Mavera (trademark) Maize], A229: [corn, LY038×MON810, REN-00038-3×MON-00810-6, Mavera (trademark) YieldGard (trademark) Maize], A230: [corn, MIR162, SYN-IR162-4, Agrisure (trademark) Viptera], A231: [corn, MIR162×5307, SYN-IR162-4×SYN-05307-1, NA], A232: [corn, MIR162×5307×GA21, SYN-IR162-4×SYN-05307-1×MON-00021-9, NA], A233: [corn, MIR162×GA21, SYN-IR162-4×MON-00021-9, NA], A234: [corn, MIR162×MIR604, SYN-IR162-4×SYN-IR604-5, NA], A235: [corn, MIR162×MIR604×5307, SYN-IR162-4×SYN-IR604-5×SYN-05307-1, NA], A236: [corn, MIR162×MIR604×5307×GA21, SYN-IR162-4×SYN-IR604-5×SYN-05307-1×MON-00021-9, NA], A237: [corn, MIR162×MIR604×GA21, SYN-IR162-4×SYN-IR604-5×MON-00021-9, NA], A238: [corn, MIR162×MIR604×TC1507×5307, SYN-IR162-4×SYN-IR604-5×DAS-01507-1×SYN-05307-1, NA], A239: [corn, MIR162×MIR604×TC1507×5307×GA21, SYN-IR162-4×SYN-IR604-5×DAS-01507-1×SYN-05307-1×MON-00021-9, NA], A240: [corn, MIR162×MIR604×TC1507×GA21, SYN-IR162-4×SYN-IR604-5×DAS-01507-1×MON-00021-9, NA], A241: [corn, MIR162×MON89034, SYN-IR162-4×MON-89034-3, NA], A242: [corn, MIR162×MON89034×GA21, SYN-IR162-4×MON-89034-3×MON-00021-9, NA], A243: [corn, MIR162×NK603, SYN-IR162-4×MON-00603-6, NA], A244: [corn, MIR162×TC1507, SYN-IR162-4×DAS-01507-1, NA], A245: [corn, MIR162×TC1507×5307, SYN-IR162-4×DAS-01507-1×SYN-05307-1, NA], A246: [corn, MIR162×TC1507×5307×GA21, SYN-IR162-4×DAS-01507-1×SYN-05307-1×MON-00021-9, NA], A247: [corn, MIR162×TC1507×GA21, SYN-IR162-4×DAS-01507-1×MON-00021-9, NA], A248: [corn, MIR604, SYN-IR604-5, Agrisure (trademark) RW], A249: [corn, MIR604×5307, SYN-IR604-5×SYN-05307-1, NA], A250: [corn, MIR604×5307×GA21, SYN-IR604-5×SYN-05307-1×MON-00021-9, NA], A251: [corn, MIR604×GA21, SYN-IR604-5×MON-00021-9, Agrisure (trademark) GT/RW], A252: [corn, MIR604×NK603, SYN-IR604-5×MON-00603-6, NA], A253: [corn, MIR604×TC1507, SYN-IR604-5×DAS-01507-1, Optimum (registered trademark) TRisect (trademark)], A254: [corn, MIR604×TC1507×5307, SYN-IR604-5×DAS-01507-1×SYN-05307-1, NA], A255: [corn, MIR604×TC1507×5307×GA21, SYN-IR604-5×TC1507×SYN-05307-1×MON-00021-9, NA], A256: [corn, MIR604×TC1507×GA21, SYN-IR604-5×TC1507×MON-00021-9, NA], A257: [corn, MON801(MON80100), MON801, NA], A258: [corn, MON802, MON-80200-7, NA], A259: [corn, MON809, PH-MON-809-2, NA], A260: [corn, MON810, MON-00810-6, YieldGard (trademark), MaizeGard (trademark)], A261: [corn, MON810×MIR162, MON-00810-6×SYN-IR162-4, NA], A262: [corn, MON810×MIR162×NK603, MON-00810-6×SYN-IR162-4×MON-00603-6, NA], A263: [corn, MON810×MIR604, MON-00810-6×SYN-IR604-5, NA], A264: [corn, MON810×MON88017, MON-00810-6×MON-88017-3, YieldGard (trademark) VTTriple], A265: [corn, MON810×NK603×MIR604, MON-00810-6×MON-00603-6×SYN-IR604-5, NA], A266: [corn, MON832, NA, RoundupReady (trademark) Maize], A267: [corn, MON863, MON-00863-5, YieldGard (trademark) Rootworm RW, MaxGard (trademark)], A268: [corn, MON863×MON810, MON-00863-5×MON-00810-6, YieldGard (trademark) Plus], A269: [corn, MON863×MON810×NK603, MON-00603-6×MON-00810-6×MON-00863-5, YieldGard (trademark) PluswithRR], A270: [corn, MON863×NK603, MON-00863-5×MON-00603-6, YieldGard (trademark) RW+RR], A271: [corn, MON87403, MON87403-1, NA], A272: [corn, MON87411, MON-87411-9, NA], A273: [corn, MON87419, MON87419-8, NA], A274: [corn, MON87427, MON-87427-7, RoundupReady (trademark) Maize], A275: [corn, MON87427×59122, MON-87427-7×DAS-59122-7, NA], A276: [corn, MON87427×MON88017, MON-87427-7×MON-88017-3, NA], A277:[corn, MON87427×MON88017×59122, MON-87427-7×MON-88017-3×DAS-59122-7, NA], A278: [corn, MON87427×MON89034, MON-87427-7×MON-89034-3, NA], A279: [corn, MON87427×MON89034×59122, MON-87427-7×MON-89034-3×DAS-59122-7, NA], A280: [corn, MON87427×MON89034×MON88017, MON-87427-7×MON-89034-3×MON-88017-3, NA], A281: [corn, MON87427×MON89034×MON88017×59122, MON-87427-7×MON-89034-3×MON-88017-3×59122, NA], A282: [corn, MON87427×MON89034×NK603, MON-87427-7×MON-89034-3×MON-00603-6, NA], A283: [corn, MON87427×MON89034×TC1507, MON-87427-7×MON-89034-3×DAS-01507-1, NA], A284: [corn, MON87427×MON89034×TC1507×59122, MON-87427-7×MON-89034-3×DAS-01507-1×DAS-59122-7, NA], A285: [corn, MON87427×MON89034×TC1507×MON87411×59122, MON-87427-7×MON-89034-3×DAS-01507-1×MON-87411-9×DAS-59122-7, NA], A286: [corn, MON87427×MON89034×TC1507×MON88017, MON-87427-7×MON-89034-3×DAS-01507-1×MON-88017-3, NA], A287: [corn, MON87427×MON89034×MIR162×NK603, MON-87427-7×MON-89034-3×SYN-IR162-4×MON-00603-6, NA], A288: [corn, MON87427×MON89034×TC1507×MON88017×59122, MON-87427-7×MON-89034-3×DAS-01507-1×MON-88017-3×DAS-59122-7, NA], A289: [corn, MON87427×NK603, MON-87427-7×MON-00603-6, NA], A290: [corn, MON87427×TC1507, MON-87427-7×DAS-01507-1, NA], A291: [corn, MON87427×TC1507×59122, MON-87427-7×DAS-01507-1×DAS-59122-7, NA], A292: [corn, MON87427×TC1507×MON88017, MON-87427-7×DAS-01507-1×MON-88017-3, NA], A293: [corn, MON87427×TC1507×MON88017×59122, MON-87427-7×DAS-01507-1×MON-88017-3×DAS-59122-7, NA], A294: [corn, MON87460, MON-87460-4, Genuity (registered trademark) DroughtGard (trademark)], A295: [corn, MON87460×MON88017, MON-87460-4×MON-88017-3, NA], A296: [corn, MON87460×MON89034×MON88017, MON-87460-4×MON-89034-3×MON-88017-3, NA], A297: [corn, MON87460×MON89034×NK603, MON-87460-4×MON-89034-3×MON-00603-6, NA], A298: [corn, MON87460×NK603, MON-87460-4×MON-00603-6, NA], A299: [corn, MON88017, MON-88017-3, YieldGard (trademark) VT (trademark) Rootworm (trademark) RR2], A300: [corn, MON88017×DAS40278, MON-88017-3×DAS-40278-9, NA], A301: [corn, MON89034, MON-89034-3, YieldGard (trademark) VTPro (trademark)], A302: [corn, MON89034×59122, MON-89034-3×DAS-59122-7, NA], A303: [corn, MON89034×59122×DAS40278, MON-89034-3×DAS-59122-7×DAS-40278-9, NA], A304: [corn, MON89034×59122×MON88017, MON-89034-3×DAS-59122-7×MON-88017-3, NA], A305: [corn, MON89034×59122×MON88017×DAS40278, MON-89034-3×DAS-59122-7×MON-88017-3×DAS-40278-9, NA], A306: [corn, MON89034×DAS40278, MON-89034-3×DAS-40278-9, NA], A307: [corn, MON89034×MON87460, MON-89034-3×MON-87460-4, NA], A308: [corn, MON89034×MON88017, MON-89034-3×MON-88017-3, Genuity (registered trademark) VTTriplePro (trademark)], A309: [corn, MON89034×MON88017×DAS40278, MON-89034-3×MON-88017-3×DAS-40278-9, NA], A310: [corn, MON89034×NK603, MON-89034-3×MON-00603-6, Genuity (registered trademark) VTDoublePro (trademark)], A311: [corn, MON89034×NK603×DAS40278, MON-89034-3×MON-00603-6×DAS-40278-9, NA], A312: [corn, MON89034×TC1507, MON-89034-3×DAS-01507-1, NA], A313: [corn, MON89034×TC1507×59122, MON-89034-3×DAS-01507-1×DAS-59122-7, NA], A314: [corn, MON89034×TC1507×59122×DAS40278, MON-89034-3×DAS-01507-1×DAS-59122-7×DAS-40278-9, NA], A315: [corn, MON89034×TC1507×DAS40278, MON-89034-3×DAS-01507-1×DAS-40278-9, NA], A316: [corn, MON89034×TC1507×MON88017, MON-89034-3×DAS-01507-1×MON-88017-3, NA], A317: [corn, MON89034×TC1507×MON88017×59122, MON-89034-3×DAS-01507-1×MON-88017-3×DAS-59122-7, Genuity (registered trademark) SmartSta×(trademark)], A318: [corn, MON89034×TC1507×MON88017×59122×DAS40278, MON-89034-3×DAS-01507-1×MON-88017-3×DAS-59122-7×DAS-40278-9, NA], A319: [corn, MON89034×TC1507×MON88017×DAS40278, MON-89034-3×DAS-01507-1×MON-88017-3×DAS-59122-7×DAS-40278-9, NA], A320: [corn, MON89034×TC1507×NK603, MON-89034-3×DAS-01507-1×MON-00603-6, PowerCore (trademark)], A321: [corn, MON89034×TC1507×NK603×DAS40278, MON-89034-3×DAS-01507-1×MON-00603-6×DAS-40278-9, NA], A322: [corn, MON89034×TC1507×NK603×MIR162, MON-89034-3×DAS-01507-1×MON-00603-6×SYN-IR162-4, NA], A323: [corn, MON89034×TC1507×NK603×MIR162×DAS40278, MON-89034-3×DAS-01507-1×MON-00603-6×SYN-IR162-4×DAS-40278-9, PowerCore (trademark)×MIR162×Enlist (trademark)], A324: [corn, MON89034×GA21, MON-89034-3×MON-00021-9, NA], A325: [corn, MS3, ACS-ZM001-9, InVigor (trademark) Maize], A326: [corn, MS6, ACS-ZM005-4, InVigor (trademark) Maize], A327: [corn, MZHGOJG, SYN-000JG-2, NA], A328: [corn, MZIR098, SYN-00098-3, NA], A329: [corn, NK603, MON-00603-6, RoundupReady (trademark) 2 Maize], A330: [corn, NK603×MON810×4114×MIR604, MON-00603-6×MON-00810-6×DP004114-3×SYN-IR604-4, NA], A331: [corn, NK603×MON810, MON-00603-6×MON-00810-6, YieldGard (trademark) CB+RR], A332: [corn, NK603×T25, MON-00603-6×ACS-ZM003-2, RoundupReady (trademark) LibertyLink (trademark) Maize], A333: [corn, T14, ACS-ZM002-1, LibertyLink (trademark) Maize], A334: [corn, T25, ACS-ZM003-2, LibertyLink (trademark) Maize], A335: [corn, T25×MON810, ACS-ZM003-2×MON-00810-6, LibertyLink (trademark) Yieldgard (trademark) Maize], A336: [corn, TC1507, DAS-01507-1, Hercule×(trademark) I, Hercule×(trademark) CB], A337: [corn, TC1507×59122×MON810×MIR604×NK603, DAS-01507-1×DAS-59122-7×MON-00810-6×SYN-IR604-5×MON-00603-6, Optimum (trademark) Intrasect×treme], A338: [corn, TC1507×MON810×MIR604×NK603, DAS-01507-1×MON-00810-6×SYN-IR604-5×MON-00603-6, NA], A339: [corn, TC1507×5307, DAS-01507-1×SYN-05307-1, NA], A340: [corn, TC1507×5307×GA21, DAS-01507-1×SYN-05307-1×MON-00021-9, NA], A341: [corn, TC1507×59122, DAS-01507-1×DAS-59122-7, Hercule×X TRA (trademark)], A342: [corn, TC1507×59122×DAS40278, DAS-01507-1×DAS-59122-7×DAS-40278-9, NA], A343: [corn, TC1507×59122×MON810, DAS-01507-1×DAS-59122-7×MON-00810-6, Optimum (registered trademark) AcreMa×(registered trademark) X tra], A344: [corn, TC1507×59122×MON810×MIR604, DAS-01507-1×DAS-59122-7×MON-00810-6×SYN-IR604-5, Optimum (registered trademark) AcreMa×(registered trademark) X Treme], A345: [corn, TC1507×59122×MON810×NK603, DAS-01507-1×DAS-59122-7×MON-00810-6×MON-00603-6, Optimum (trademark) Intrasect X TRA], A346: [corn, TC1507×59122×MON88017, DAS-01507-1×DAS-59122-7×MON-88017-3, NA], A347: [corn, TC1507×59122×MON88017×DAS40278, DAS-01507-1×DAS-59122-7×MON-88017-3×DAS-40278-9, NA], A348: [corn, TC1507×59122×NK603, DAS-01507-1×DAS-59122-7×MON-00603-6, Hercule×X TRA (trademark) RR], A349: [corn, TC1507×59122×NK603×MIR604, DAS-01507-1×DAS-59122-7×MON-00603-6×SYN-IR604-5, NA], A350: [corn, TC1507×DAS40278, DAS-01507-1×DAS-40278-9, NA], A351: [corn, TC1507×GA21, DAS-01507-1×MON-00021-9, NA], A352: [corn, TC1507×MIR162×NK603, DAS-01507-1×SYN-IR162-4×MON-00603-6, Optimum (registered trademark) Leptra (trademark)], A353: [corn, TC1507×MIR604×NK603, DAS-01507-1×SYN-IR604-5×MON-00603-6, Optimum (trademark) TRisect], A354: [corn, TC1507×MON810, DAS-01507-1×MON-00, NA], A355: [corn, TC1507×MON810×MIR162, DAS-01507-1×MON-00810-6×SYN-IR162-4, NA], A356: [corn, TC1507×MON810×MIR162×NK603, DAS-01507-1×MON-00810-6×SYN-IR162-4×MON-00603-6, NA], A357: [corn, TC1507×MON810×MIR604, DAS-01507-1×MON-00810-6×SYN-IR604-5, NA], A358: [corn, TC1507×MON810×NK603, DAS-01507-1×MON-00810-6×MON-00603-6, Optimum (trademark) Intrasect], A359: [corn, TC1507×MON810×NK603×MIR604, DAS-01507-1×MON-00810-6×MON-00603-6×SYN-IR604-5, NA], A360: [corn, TC1507×MON88017, DAS-01507-1×MON-88017-3, NA], A361: [corn, TC1507×MON88017×DAS40278, DAS-01507-1×MON-88017-3×DAS-40278-9, NA], A362: [corn, TC1507×NK603, DAS-01507-1×MON-00603-6, Hercule×(trademark) IRR], A363: [corn, TC1507×NK603×DAS40278, DAS-01507-1×MON-00603-6×DAS-40278-9, NA], A364: [corn, TC6275, DAS-06275-8, NA], A365: [corn, VCO-01981-5, VCO-01981-5, NA], A366: [corn, DK404SR, DK404SR, NA], A367: [corn, EXP1910IT, EXP1910IT, NA], A368: [melon, MelonA, NA, NA], A369: [melon, MelonB, NA, NA], A370: [papaya, 55-1, CUH-CP551-8, Rainbow, SunUp], A371: [papaya, 63-1, CUH-CP631-7, NA], A372: [papaya, Huanong No. 1, NA, Huanong No. 1], A373: [papaya, X17-2, UFL-X17CP-6, NA], A374: [petunia, Petunia-CHS, NA, NA], A375: [plum, C-5, ARS-PLMC5-6, NA], A376: [polish canola, HCR-1, NA, NA], A377: [polish canola, ZSR500, NA, Hysyn101RRRoundup-Ready (trademark)], A378: [polish canola, ZSR502, NA, Hysyn101RRRoundup-Ready (trademark)], A379: [polish canola, ZSR503, NA, Hysyn101RRRoundup-Ready (trademark)], A380: [poplar, Btpoplar, poplarl2(Populusnigra), NA, NA], A381: [poplar, Hybridpoplarclone741, NA, NA], A382: [potato, 1210amk, NA, Lugovskoiplus], A383: [potato, 2904/1kgs, NA, Elizavetaplus], A384: [potato, AM04-1020, BPS-A1020-5, StarchPotato], A385: [potato, ATBT04-27, NMK-89367-8, AtlanticNewLeaf (trademark) potato], A386: [potato, ATBT04-30, NMK-89613-2, AtlanticNewLeaf (trademark) potato], A387: [potato, ATBT04-31, NMK-89170-9, AtlanticNewLeaf (trademark) potato], A388: [potato, ATBT04-36, NMK-89279-1, AtlanticNewLeaf (trademark) potato], A389: [potato, ATBT04-6, NMK-89761-6, AtlanticNewLeaf (trademark) potato], A390: [potato, BT06, NMK-89812-3, NewLeaf (trademark) RussetBurbankpotato], A391: [potato, BT10, NMK-89175-5, NewLeaf (trademark) RussetBurbankpotato], A392: [potato, BT12, NMK-89601-8, NewLeaf (trademark) RussetBurbankpotato], A393: [potato, BT16, NMK-89167-6, NewLeaf (trademark) RussetBurbankpotato], A394: [potato, BT17, NMK-89593-9, NewLeaf (trademark) RussetBurbankpotato], A395: [potato, BT18, NMK-89906-7, NewLeaf (trademark) RussetBurbankpotato], A396: [potato, BT23, NMK-89675-1, NewLeaf (trademark) RussetBurbankpotato], A397: [potato, E12, SPS-00E12-8, Innate (registered trademark) Cultivate], A398: [potato, E24, SPS-00E24-2, NA], A399: [potato, EH92-527-1, BPS-25271EH92-527-1-9, Amflora (trademark)], A400: [potato, F10, SPS-00F10-7, Innate (registered trademark) Generate], A401: [potato, F37, SPS-00F37-7, NA], A402: [potato, G11, SPS-00G11-9, NA], A403: [potato, H37, SPS-00H37-9, NA], A404: [potato, H50, SPS-00H50-4, NA], A405: [potato, HLMT15-15, NA, Hi-LiteNewLeaf (trademark) Ypotato], A406: [potato, HLMT15-3, NA, Hi-LiteNewLeaf (trademark) Ypotato], A407: [potato, HLMT15-46, NA, Hi-LiteNewLeaf (trademark) Ypotato], A408: [potato, J3, SPS-000J3-4, Innate (registered trademark) Accelerate], A409: [potato, J55, SPS-00J55-2, NA], A410: [potato, J78, SPS-00J78-7, NA], A411: [potato, RBMT15-101, NMK-89653-6, NewLeaf (trademark) YRussetBurbankpotato], A412: [potato, RBMT21-129, NMK-89684-1, NewLeaf (trademark) PlusRussetBurbankpotato], A413: [potato, RBMT21-152, NA, NewLeaf (trademark) PlusRussetBurbankpotato], A414: [potato, RBMT21-350, NMK-89185-6, NewLeaf (trademark) PlusRussetBurbankpotato], A415:[potato, RBMT22-082, NMK-89896-6, NewLeaf (trademark) PlusRussetBurbankpotato], A416: [potato, RBMT22-186, NA, NewLeaf (trademark) PlusRussetBurbankpotato], A417: [potato, RBMT22-238, NA, NewLeaf (trademark) PlusRussetBurbankpotato], A418: [potato, RBMT22-262, NA, NewLeaf (trademark) PlusRussetBurbankpotato], A419: [potato, SEMT15-02, NMK-89935-9, ShepodyNewLeaf (trademark) Ypotato], A420: [potato, SEMT15-07, NA, ShepodyNewLeaf (trademark) Ypotato], A421: [potato, SEMT15-15, NMK-89930-4, ShepodyNewLeaf (trademark) Ypotato], A422: [potato, SPBT02-5, NMK-89576-1, SuperiorNewLeaf (trademark) potato], A423: [potato, SPBT02-7, NMK-89724-5, SuperiorNewLeaf (trademark) potato], A424: [potato, TIC-AR233-5, TIC-AR233-5, NA], A425: [potato, V11, SPS-00V11-6, Innate (registered trademark) Invigorate], A426: [potato, W8, SPS-000W8-4, Innate (registered trademark) Glaciate], A427: [potato, ×17, SPS-00×17-5, Innate (registered trademark) Acclimate], A428: [potato, Y9, SPS-000Y9-7, Innate (registered trademark) Hibernate], A429: [rice, 7Crp #10, NA, NA], A430: [rice, GMShanyou63, NA, BTShanyou63], A431: [rice, Huahui-1/TT51-1, NA, Huahui-1], A432: [rice, LLRICE06, ACS-OS001-4, LibertyLink (trademark) rice], A433: [rice, LLRICE601, BCS-OS003-7, LibertyLink (trademark) rice], A434: [rice, LLRICE62, ACS-OS002-5, LibertyLink (trademark) rice], A435: [rice, Tarommolaii+crylAb, NA, NA], A436: [rice, CL121×CL141×CF×51, CL121×CL141×CF×51, Clearfield (registered trademark) Rice], A437:[rice, IMINTA-1×IMINTA-4, IMINTA-1×IMINTA-4, Clearfield (registered trademark) Rice], A438: [rice, PWC16, PWC16, NA], A439: [rose, WKS82/130-4-1, IFD-52401-4, NA], A440: [rose, WKS92/130-9-1, IFD-52901-9, NA], A441: [soybean, 260-05(G94-1, G94-19, G168), DD-026005-3, NA], A442: [soybean, A2704-12, ACS-GM005-3, LibertyLink (trademark) soybean], A443: [soybean, A2704-21, ACS-GM004-2, LibertyLink (trademark) soybean], A444: [soybean, A5547-127, ACS-GM006-4, LibertyLink (trademark) soybean], A445: [soybean, A5547-35, ACS-GM008-6, LibertyLink (trademark) soybean], A446: [soybean, CV127, BPS-CV127-9, Cultivance], A447: [soybean, DAS44406-6, DAS-44406-6, NA], A448: [soybean, DAS68416-4, DAS-68416-4, Enlist (trademark) Soybean], A449: [soybean, DAS68416-4×MON89788, DAS-68416-4×MON-89788-1, NA], A450: [soybean, DAS81419, DAS-81419-2, NA], A451: [soybean, DAS81419×DAS44406-6, DAS-81419-2×DAS-44406-6, NA], A452: [soybean, DP305423, DP-305423-1, Treus (trademark) or Plenish (trademark)], A453: [soybean, DP305423×GTS40-3-2, DP-305423-1×MON-04032-6, NA], A454: [soybean, DP356043, DP-356043-5, OptimumGAT (trademark)], A455:[soybean, FG72(FG072-2, FG072-3), MST-FG072-3, NA], A456: [soybean, FG72×A5547-127, MST-FG072-3×ACS-GM006-4, Liberty Link (registered trademark) GT27 (trademark)], A457: [soybean, GTS40-3-2(40-3-2), MON-04032-6, RoundupReady (trademark) soybean], A458:[soybean, GU262, ACS-GM003-1, LibertyLink (trademark) soybean], A459: [soybean, IND-00410-5, IND-00410-5, VerdecaHB4Soybean], A460: [soybean, MON87701, MON-87701-2, NA], A461: [soybean, MON87701×MON89788, MON-87701-2×MON-89788-1, Intacta (trademark) RoundupReady (trademark) 2Pro], A462: [soybean, MON87705, MON-87705-6, VistiveGold (trademark)], A463: [soybean, MON87705×MON87708, MON-87705-6×MON-87708-9, NA], A464: [soybean, MON87705×MON87708×MON89788, MON-87705-6×MON-87708-9×MON-89788-1, NA], A465: soybean, MON87705×MON89788, MON-87705-6×MON-89788-1, NA], A466: [soybean, MON87708, MON-87708-9, Genuity (registered trademark) RoundupReady (trademark) 2×tend (trademark)], A467: [soybean, MON87708×MON89788, MON-87708-9×MON-89788-1, Roundup Ready 2×tend (registered trademark)], A468: [soybean, MON87712, MON-87712-4, NA], A469: [soybean, MON87751, MON-87751-7, NA], A470: [soybean, MON87751×MON87701×MON87708×MON89788, MON-87751-7×MON-87701-2×MON87708×MON89788, NA], A471: [soybean, MON87769, MON87769-7, NA], A472: [soybean, MON87769×MON89788, MON-87769-7×MON-89788-1, NA], A473: [soybean, MON89788, MON-89788-1, Genuity (registered trademark) Roundup Ready 2 Yield (trademark)], A474: [soybean, SYHTOH2, SYN-000H2-5, Herbicide-tolerantSoybeanline], A475: [soybean, W62, ACS-GM002-9, LibertyLink (trademark) soybean], A476: [soybean, W98, ACS-GM001-8, LibertyLink (trademark) soybean], A477: [soybean, OT96-15, OT96-15, NA], A478: [summer squash (Cucurbitapepo), CZW3, SEM-OCZW3-2, NA], A479: [summer squash (Cucurbita pepo), ZW20, SEM-0ZW20-7, NA], A480:[sugar beet, GTSB77(T9100152), SY-GTSB77-8, InVigor (trademark) sugarbeet], A481: [sugar beet, H7-1, KM-000H71-4, Roundup Ready (trademark) sugarbeet], A482: [sugar beet, T120-7, ACS-BV001-3, LibertyLink (trademark) sugarbeet], A483: [sugar cane, CTB141175/01-A, CTB141175/01-A, NA], A484: [sugar cane, NXI-1T, NXI-1T, NA], A485: [sugar cane, NXI-4T, NXI-4T, NA], A486: [sugar cane, NXI-6T, NXI-6T, NA], A487: [sunflower, X81359, X81359, Clearfield (registered trademark) Sunflower], A488: [sweet pepper, PK-SP01, X81359, NA], A489: [tobacco, C/F/93/08-02, NA, NA], A490: [tobacco, Vector21-41, NA, NA], A491: [tomato, 1345-4, NA, NA], A492: [tomato, 35-1-N, NA, NA], A493: [tomato, 5345, NA, NA], A494: [tomato, 8338, CGN-89322-3, NA], A495: [tomato, B, SYN-0000B-6, NA], A496: [tomato, Da, SYN-OOODA-9, NA], A497: [tomato, DaDongNo9, NA, NA], A498:[tomato, F(1401F, h38F,11013F,7913F), SYN-OOOOF-1, FLAVRSAVR (trademark)], A499: [tomato, FLAVRSAVR, CGN-89564-2, FLAVRSAVR (trademark)], A500: [tomato, HuafanNol, NA, NA], A501: [tomato, PK-TM8805R(8805R), NA, NA], A502: [wheat, MON71800, MON-71800-3, RoundupReady (trademark) wheat], A503: [wheat, AP205CL, AP205CL, Clearfield (registered trademark) Wheat], A504: [wheat, AP602CL, AP602CL, Clearfield (registered trademark) Wheat], A505: [wheat, BW255-2×BW238-3, BW255-2×BW238-3, Clearfield (registered trademark) Wheat], A506: [wheat, BW7, BW7, Clearfield (registered trademark) Wheat], A507: [wheat, Teal11A, Teal11A, Clearfield (registered trademark) Wheat], A508: [wheat, SWP965001, SWP965001, NA], A509: [corn, NA, NA, Agrisure Artesian (trademark)], A510: [corn, NA, NA, Optimum (registered trademark) AQUAmax (registered trademark)], A511: [canola, NA, NA, SU canola (registered trademark)], A512: [canola, NA, NA, Nexera (registered trademark) Canola], A513: [soybean, NA, NA, STS soybean], A514: [corn, NA, NA, SR corn], A514: [sunflower, NA, NA, ExpressSun (registered trademark)], A515: [rice, NA, NA, Golden rice], A516: [corn, NA, NA, Poast Protected (registered trademark) corn], A517: [sunflower, NA, NA, ExpressSun (registered trademark)], A518: [rice, NA, NA, Provisia (trademark) Rice┘, A519: [canola, NA, NA, Triazinon Tolerant Canola], A520: [corn, NA, NA, SmartStax (registered trademark) Pro], A521: [soybean, NA, NA, Credenz (registered trademark) soybean], A522: [corn, TC1507×59122, DAS-01507-1×DAS-59122-7, Optimum (registered trademark) AcreMax (registered trademark) 1], A523: [corn, 4114×MON810×MIR604, DP-004114-3×MON-00810-6×SYN-IR604-5, Qrome (trademark)], A524: [cotton, NA, NA, Stoneville (registered trademark) Cotton ST5517GLTP], A525: [cotton, NA, NA, Stoneville (registered trademark) Cotton ST4848GLT], A526: [cotton, NA, NA, Stoneville (registered trademark) Cotton ST4949GLT], A527: [cotton, NA, NA, Stoneville (registered trademark) Cotton ST5020GLT], A528: [cotton, NA, NA, Stoneville (registered trademark) Cotton ST5115GLT], A529: [cotton, NA, NA, Stoneville (registered trademark) Cotton ST6182GLT], A530: [cotton, NA, NA, Stoneville (registered trademark) Cotton ST4747GLB2], A531: [cotton, NA, NA, Stoneville (registered trademark) Cotton ST4946GLB2], A532: [cotton, NA, NA, Stoneville (registered trademark) Cotton ST6448GLB2], A533: [soybean, NA, NA, Enlist E3 (trademark)], A534: [soybean, NA, NA, Enlist (trademark) Roundup Ready 2 Yield (registered trademark)], A535: [corn, NA, NA, Enlist (trademark) Roundup Ready (registered trademark) Corn 2], A536: [corn, NA, NA, Smartstax (registered trademark) Enlist (trademark)], A537: [corn, NA, NA, Powercore (registered trademark) Enlist (trademark)], A538: [cotton, NA, NA, Enlist (trademark) Cotton], A539: [cotton, NA, NA, Bollgard (registered trademark) 3 XtendFlex (registered trademark)], A540: [corn, NA, NA, SmartStax (registered trademark) RIB Complete (registered trademark) Corn], A541: [corn, NA, NA, VT Double PRO (registered trademark) RIB Complete (registered trademark) Corn], A542: [corn, NA, NA, VT Double PRO (registered trademark) Corn], A543: [corn, NA, NA, Genuity (registered trademark) VT Triple PRO (registered trademark) RIB Complete Corn], A544: [corn, NA, NA, Trecepta (trademark) Corn], A545: [soybean, NA, NA, Fukuminori], A546: [soybean, NA, NA, Yumeminori], A547: [corn, NA, NA, ZFN-12 maize], A548: [rice, NA, NA, Yumepirika], A549:[rice NA, NA, Kanto BPH 1go], A550: [cotton, NA, MON88702, NA], A551: [soybean, DP305423×MON87708, DP-305423-1×MON-87708-9, NA], A552: [soybean, DP305423×MON87708×MON89788, DP-305423-1×MON-87708-9×MON-89788-1, NA], A553: [soybean, DP305423×MON89788, DP-305423-1×MON-89788-1, NA], A554: [cotton, 3006-210-23×281-24-236×MON88913×COT102×81910, DAS-21023-5×DAS-24236-5×MON-88913-8×SYN-IR102-7], A555: [cotton, GHB811, BCS-GH811-4, NA], A556: [sorghum, NA, NA, Igrowth (trademark)].

The natural pyrethrin or the composition A can be applied to the above modified plants A1-A556 or their cultivation areas. When the natural pyrethrin or the composition A is applied to the above plants, it is more preferable to apply to their seeds or vegetative reproduction organs.

The composition B can effectively control a wide spectrum of targets in grain fields where normal or no-till cultivation is practiced, vegetable fields, flower fields, orchard lands, or non-agricultural lands.

When applying the composition B to sugar cane, in the cultivation of sugar cane, a sugar cane which has been cut so as to have one joint in a stem fragment of sugar cane may be used, or a sugar cane which is 2 cm to 15 cm, preferably 3 cm to 8 cm as a size of a stem fragment of sugar cane may be used. Such cultivation technique for sugarcane in which stem fragments are used is publicly known (WO09/000398, WO09/000399, WO09/000400, WO09/000401, WO09/000402) and is carried out under the trade name of Plene (registered trademark).

When applying the composition B to rice, it may be applied to seedling fields, may be applied to paddy fields, or may be applied to rice seeds. The above mentioned seedling fields include seedling boxes, or seedling trays or nursery beds for paddy rice.

When applying the composition B to seedling boxes, the timing for application is not particularly limited as long as it is during raising seedling period from sowing to transplanting of rice. The timing for applying the composition B to seedling boxes when sowing may be not only the day of sowing, but also any days from several days before sowing to several days after sowing. The timing for applying the composition B to seedling boxes when transplanting may be not only the day of transplanting, but also any days from several days before transplanting to the day of transplanting. The raising seedling period may be different depending on whether a seedling to be transplanted is any of a young seedling (a seedling around 2.5 leaf stage), a medium seedling (a seedling around 3.5 leaf stage) or an adult seedling (a seedling around 4.5 leaf stage), and also varies depending on weather conditions and the like, however the composition B can be applied in any case. Examples of methods of applying the composition B to seedling boxes include a method of applying kneading-in granules or sand-coated granules on seedling boxes and a method in which a solution of the composition B is irrigated into seedling boxes. Alternatively, the composition B can be applied onto bed soil or cover soil, or can be applied by incorporating into bed soil or cover soil. Generally, methods of applying pesticides during raising seedling period are referred to as, for example, pre-sowing bed soil incorporation, treatment before soil covering during sowing, treatment after soil covering during sowing, treatment during greening period, treatment on the day of transplantation and treatment simultaneously with transplantation. The composition B may be applied to seedling boxes by any of the above-mentioned application methods. A culture medium for raising seedling is not particularly limited as long as it is culture soil for raising rice seedlings, and seedling mats other than soil may also be used. The seedlings to which the composition B has been applied may be cultivated by pool raising seedling.

When applying the composition B to paddy fields, it may be used for rice under transplanting cultivation, or may be used for rice under direct sowing cultivation. Though the methods of applying to paddy fields are not particularly limited, examples thereof include a method of applying the composition B to foliage of rice, a method of applying to paddy soil, and a method of applying to the water surface of a paddy field in a flooded state. Alternatively, it can be applied through supply of water in the labor-saving manner by applying a chemical liquid such as emulsifiable concentrates, flowable formulations or the like to inflow source of water to a paddy field such as puddy sluices, irrigation equipment and the like. The timing for applying to foliage of rice may be any time from raising seedlings period to harvest. Examples of formulations to be used include formulations to be applied as they are such as dustable powder, microgranules, and flowable formulation, dry flowable formulation, wettable powder, water dispersible granule, SE formulation, soluble powder, water soluble granule, soluble liquid, micro emulsion formulation, EW formulation, oil formulation, surf-formulation or emulsifiable concentrate. The spraying equipment may especially be equipment which is usually used, and hand sprayers, power applicators, pancle sprayers, radio control helicopters, manned helicopters, and the like can be used. Alternatively, the composition B may be applied by hand without using spraying equipment.

Examples of the method of applying the composition B to paddy soil include a method of treating the overall surface of paddy soil (overall treatment), a method of treating a trench provided when rice is sown (sowing trench treatments), a method of treating 0 to 10 cm directly under a rice seed, and a method of treating the vicinity of a rice plant or seed in a streaky manner or point-like manner (side row treatments).

When applying the composition B to paddy soil, it can be applied simultaneously with agricultural materials such as paste fertilizers and granular fertilizers, or can be applied by mixing with these agricultural materials. The timing for applying the composition B may be before sowing or before transplanting, may be at the same time as sowing or transplanting, or may be immediately after sowing or immediately after transplanting.

When applying simultaneously with sowing or transplanting, it may be applied using an attachment attached to a sowing machine or a transplanting machine, or it may be applied by other methods. In addition, in the case of the overall treatment, it may be a period until water is poured after sowing or transplanting, a period of midseason drainage, or a period of alternate wetting and drying. When using the composition B, the soil surface of the paddy field may be in a dry state, or may be a condition in which the soil surface is in a wet state but there is no flooding (water depth 0 cm). When applying to the water surface of a paddy field in a flooded state, it may be any time during the period from sowing or transplanting to harvest, and can be applied as long as the water depth is that which can be maintained by ordinary rice management.

When using the composition B for direct sowing cultivation of rice, rice seeds may be surface-treated with coating materials such as iron powders (iron oxide powder, reduced iron powder, atomized iron powder, electrolytic iron powder, etc.), calcium peroxide, molybdenum, or molybdenum compounds. These coating materials can be used each alone, or can also be mixed at any ratios to use. In addition, as necessary, auxiliaries such as calcined gypsum or montmorillonite can be added for the purpose of increasing weight or improving the adhesion to rice seeds. Mixtures of calcium peroxide, calcined gypsum, and mineral powder are available as a commercial product, and examples thereof include Calper dust-granule mixture 16 (manufactured by Hodogaya UPL Co., Ltd). Here, the rice seed means a seed of rice in a state before sowing in soil such as a paddy field.

When treating a rice seed with the composition B, the rice seed can be cultivated by directly sowing in a dry paddy field, a wet paddy field or a paddy field, or can be cultivated by sowing in a seedling box. A paddy field in a flooded state refers to a paddy field in a condition in which plowing, irrigating and soil puddling, or the like have been performed, and further irrigating has been performed as necessary. A paddy field in a wet soil state refers to a paddy field in a condition in which by performing drained treatment or the like from the flooded state, the water amount is maintained at the same level as the flooded state and the soil surface is exposed. It is possible to powder-coat a rice seed with the compound B, it is also possible to immerse a rice seed before stimulating germination in a solution containing the composition B, and alternatively it is possible to spraying a solution containing the composition B on a rice seed after stimulating germination. In any of the treatment methods, the composition B may contain one or more safener components selected from the group (d).

Sowing machines used for sowing rice seed are not particularly limited as long as those are generally used for direct sowing cultivation of rice such as paddy rice and upland rice, however examples thereof include the direct sowing machine for iron coating, NDS-6 (Tetsu Maki-chan, manufactured by Kubota Corporation), the direct sowing machine for iron coating, NDS-8 (Tetsu Maki-chan, manufactured by Kubota Corporation), the direct sowing dedicated machine for iron coating, EP4-TC (Cute Tetsu Maki-chan, manufactured by Kubota Corporation), the multipurpose working machine, RG6 (manufactured by Yanmar Co., Ltd.), the multipurpose working machine, RG8 (manufactured by Yanmar Co., Ltd.), the high-precision sowing machine, PZV60 (manufactured by Iseki & Co., Ltd.) and the high-precision sowing machine, PZV80 (manufactured by Iseki & Co., Ltd.).

Iron or its oxide as a coating material to be treated on rice seeds (hereinafter iron and its oxide are referred to as “coating material A”) is preferably in powder form. Examples of the coating material A in powder form include reduced iron powder, atomized iron powder, electrolytic iron powder, and iron oxide powder, and they are available as commercial products. In addition, two or more of these can also be mixed together to use. In the present invention, the use of reduced iron powder and/or iron oxide powder is preferred. Iron powder obtained by reducing iron oxide or iron salts with hydrogen or the like is referred to as reduced iron powder, iron powder obtained by injecting a high-pressure water jet of 8 to 20 MPa into a molten iron stream is referred to as atomized iron powder, and iron powder obtained by precipitating iron from solutions such as iron sulfate by electrolyzation to obtain electrolytic iron flakes, followed by milling with a rod mill or vibration mill to anneal is referred to as electrolytic iron powder, respectively. Also, iron oxide is an oxide of iron with an oxidation number of II and/or III. Though the particle size of the coating material A used in the present invention is not particularly limited, it is preferable to adjust the particle size to 10 to 100 μm to use. Examples of the coating material A which is available as a commercial product include DAE1K iron powder (manufactured by Dowa IP Creation Co. Ltd.), DSP317 iron powder (manufactured by Dowa IP Creation Co. Ltd.), agricultural iron powder (manufactured by Daitetsu Kogyo Co., Ltd.), agricultural iron powder (manufactured by TETSUGEN CORPORATION) and hematite (manufactured by DOWA IP Creation Co., Ltd.).

When the composition B is applied to a rice seed, it may be mixed with calcined gypsum. For example, when treating a rice seed with the composition B and the coating material A, calcined gypsum may be used as auxiliaries. As the calcined gypsum, calcium sulfate 1/2 hydrate (CaSO₄1/2H₂O) in powder form may be sufficient, the calcined gypsum is available as a commercial product, and examples thereof include KTS-1 (manufactured by Yoshino Gypsum Sales Co., Ltd.) and KTS-25 (manufactured by Yoshino Gypsum Sales Co., Ltd.). Alternatively, a mixture of the coating material A and calcined gypsum may also be used, such mixtures are available as commercial products, and examples of thereof include DAE1K mix (manufactured by Dowa IP Creation Co. Ltd.).

Though powder-coating treatment of rice seeds using the coating material A can be adopted to be various forms, it is usually carried out in the same operation as the method publicly known as methods of powder-coating treatment of rice seeds using iron powder (“Tetsu Ko-thingu Tansui Tyokuhan manyuaru 2010” the National Agriculture and Food Research Organization, Independent Administrative Agency, March 2010, ISBN 978-4-903078-05-2). Specifically, a dry pre-germinated rice seed is immersed in water (sometimes referred to as seed soaking), followed by draining, and then the rice seed is powder-coated with the coating material A and, as necessary, calcined gypsum. For the order of treatments of the coating material A and calcined gypsum, either may be first, or alternatively, a mixture of the coating material A and calcined gypsum may be applied at the same time. After these treatments has been carried out, as necessary, further powder-coating treatment is carried out using calcined gypsum as a finishing touch, followed by usually placing on a rush mat or the like laid out on a flat surface to let dry in the shade.

The used amount of coating material A as opposed to rice seeds is usually 100 to 2000 g of the coating material A per 1000 g dry weight of rice seeds. Also, in the case that further powder-coating treatment is carried out using calcined gypsum, the amount of calcined gypsum is usually 5 to 100 g per 1000 g dry weight of rice seeds, and in the case that further powder-coating treatment using calcined gypsum as a finishing touch, the amount of calcined gypsum is usually 0 to 50 g per 1000 g dry weight of rice seeds.

As calcium peroxide, calcium peroxide alone which has been prepared to be powder having a particle size of 10 to 150 μm can be used, however compositions into which as auxiliaries mineral powders such as montmorillonite or calcined gypsum are mixed can also be used as necessary. Such compositions containing calcium peroxide are available as commercial products, and examples thereof include Calper dust-granule mixture 16 (manufactured by Hodogaya UPL Co., Ltd).

Though powder-coating treatment of rice seeds using calcium peroxide can be adopted to be various forms, it is usually carried out in the same operation as the method publicly known as methods of powder-coating treatment of rice seeds using calcium peroxide (JP S61-015805A). Specifically, a dry pre-germinated rice seed is immersed in water (sometimes referred to as seed soaking), followed by draining, and then the rice seed is powder-coated with calcium peroxide powder or the composition containing calcium peroxide. These treatments has been carried out, followed by usually placing on a rush mat or the like laid out on a flat surface to let dry in the shade.

The used amount of calcium peroxide or the composition containing calcium peroxide as opposed to rice seeds is usually 100 to 1000 g in terms of calcium peroxide alone per 1000 g dry weight of rice seeds.

Examples of molybdenum and molybdenum compounds include molybdenum alone, molybdenum oxide, molybdic acid and its salts, molybdophosphoric acid and its salts, and molybdosilicic acid and its salts. Examples of molybdic acid salts include calcium molybdate, magnesium molybdate, ammonium molybdate, sodium molybdate, and potassium molybdate. Examples of molybdophosphoric acid salts include ammonium molybdophosphate, sodium molybdophosphate, and potassium molybdophosphate. Such molybdenum and molybdenum compounds are available as commercial products, and examples thereof include molybdenum trioxide (manufactured by NIPPON INORGANIC COLOUR & CHEMICAL CO., LTD.).

Though the treatment of rice seeds using molybdenum and molybdenum compounds can be adopted to be various forms, it is usually carried out in the same operation as the method publicly known as treatment method of rice seeds using molybdenum and molybdenum compounds (WO2011/093341). Specifically, examples of the operations include fixing on the rice seed surface using binders such as polyvinyl alcohol, preparing solution to immerse the rice seed therein, or mixing with a coating material containing iron powder and/or calcium peroxide to powder-coat on the rice seed.

In particular, “red iron oxide molybdenum coating” in which a molybdenum compound such as molybdenum trioxide, iron oxide powder (sometimes referred to as “red iron oxide powder”) and water-resistant polyvinyl alcohol are mixed to treat rice seeds therewith is known (Yoshitaka Hara 2013. Improvement of Rice Seedling Establishment on Sulfate-Applied Submerged Soil by Seed Coating with Poorly Soluble Molybdenum Compounds. Plant Prod. Sci. 16 (3): 271-275), and said method is also preferably used in the present invention.

The used amount of molybdenum and molybdenum compounds as opposed to rice seeds is usually 0.01 to 10 mol in terms of molybdenum per 1000 g dry weight of rice seeds.

Examples of combinations of the present compound or the composition A coating material with which rice seeds are treated include the following. natural pyrethrin+iron oxide powder, natural pyrethrin+reduced iron powder, natural pyrethrin+iron oxide powder+reduced iron powder, natural pyrethrin+calcium peroxide, natural pyrethrin+molybdenum compounds, natural pyrethrin+molybdenum compounds+iron oxide powder, natural pyrethrin+molybdenum trioxide, natural pyrethrin+molybdenum trioxide+iron oxide powder, natural pyrethrin+iron oxide powder+calcined gypsum, natural pyrethrin+reduced iron powder+calcined gypsum, natural pyrethrin+iron oxide powder+reduced iron powder+calcined gypsum, natural pyrethrin+calcium peroxide+calcined gypsum, the composition A+iron oxide powder, the composition A+reduced iron powder, the composition A+iron oxide powder+reduced iron powder, the composition A+calcium peroxide, the composition A+molybdenum compounds, the composition A+molybdenum compounds+iron oxide powder, the composition A+molybdenum trioxide, the composition A+molybdenum trioxide+iron oxide powder, the composition A+iron oxide powder+calcined gypsum, the composition A+reduced iron powder+calcined gypsum, the composition A+iron oxide powder+reduced iron powder+calcined gypsum, the composition A+calcium peroxide+calcined gypsum.

Here, as the present component contained in the composition A, especially, isotianil, furametpyr, inpyrfluxam, ethaboxam, benomyl, oxolinic acid, clothianidin, fenitrothion, cartap hydrochloride, oxazosulfyl, tetraniliprole, chlorantraniliprole, cyantraniliprole, triflumezopyrim, flupyrimin and ethiprole are preferred.

As the order of treatment of the above combinations to rice seeds, the rice seeds may be treated with the present compound or the composition A, followed by treating with the coating material, the rice seeds may be treated with a coating material, followed by treating with the present compound or the composition A, or the present compound or the composition A may be treated simultaneously with the coating material. When treating with the composition A, the order of treatment of the present compound and the present component contained in the composition A and the coating material may be the order of the present compound, the present component and the coating material, may be the order of the present compound, the coating material and the present component, may be the order of the present component, the present compound and the coating material, may be the order of the present component, the coating material, the present compound, may be the order of the coating material, the present compound, the present component, or may be the order of the coating material, the present component, the present compound. Alternatively, the rice seeds may be treated with the present compound, the present component and the coating material simultaneously.

When the composition B is applied to rice, stimulation of germination of rice seeds may be carried out by immersion in water or may be carried out by keeping wet condition after immersion in water. The wet condition means the condition in which part or all of the surface of the rice seed after immersion in water is able to contact with the outside air and the rice seed is able to retain moisture. For example, the wet condition can be achieved by covering the rice seed after immersion in water with a breathable material such as rice straw or cloth, followed by sprinkling water over the covering material as necessary, or by keeping containing the rice seed in the net-like or bag-like material used when immersing the rice seed in water.

When using the composition B for rice, it can also be used in combination with fertilizers. Examples of such fertilizers include Rakuichi (registered trademark, Sumitomo Chemical Co., Ltd.), Sumishort (registered trademark, Sumitomo Chemical Co., Ltd.), and Super SR Coat (registered trademark, Sumitomo Chemical Co., Ltd.). When a fertilizer is used in combination, it may be applied to the overall surface of the rice cultivation soil before sowing, or it may be applied to the overall surface of the rice cultivation soil after sowing or during the raising seedling period. A fertilizer may also be applied in a trench-like pattern along the rows to be sown when sowing (sometimes referred to as side-row fertilization).

When applying the composition B to rice, in any cases of applying to seedling fields, paddy fields, or seeds, disinfected seeds can be used in order to control seed-borne diseases and pest arthropods. Specifically, seeds which have been immersion-treated, smear-treated or powder-coating-treated with one or more insecticidal active ingredients and fungicidal active ingredients selected from the group (a) and the group (b) such as prochloraz, triflumizole, pefurazoate, oxolinic acid, ipconazole, fludioxonil, kasugamycin-hydrochloride, copper hydroxide, basic copper chloride, fenitrothion, cartap hydrochloride and the like, or one or more components of microbial materials selected from the group (j) such as Trichoderma atroviride strain SKT-1, Talaromyces flavus strain SAY-Y-94-01, Pseudomonas sp. strain CAB-02, Bacillus simplex strain CGF2856 and the like can be used.

When one or more of cartap hydrochloride and metaldehyde are applied to a paddy field before sowing rice, a paddy field before transplanting rice, a paddy field after sowing rice, or a paddy field after transplanting rice, golden apple snail and Lymnaeidae class can be effectively controlled. In addition, weeds which occurs in paddy fields can also be controlled by treating with one or more components having herbicidal activity selected from the group (i) and the group (j). The timing for applying the above component having herbicidal activity is not particularly limited as long as it is the timing during which rice injury by the component having herbicidal activity is not a problem.

Examples of one or more herbicidal active ingredients selected from the group (i) which can be used in paddy field include azimsulfuron, bensulfuron-methyl, chlorimuron-ethyl, cyclosulfamuron, ethoxysulfuron, flucetosulfuron, halosulfuron-methyl, imazosulfuron, orthosulfamuron, propyrisulfuron, pyrazosulfuron-ethyl, cinosulfuron, metsulfuron-methyl, metazosulfuron, benthiocarb, molinate, esprocarb, pyributicarb, dimepiperate, swep, butachlor, pretilachlor, thenylchlor, simetryn, dimethametryn, methyldymron, propanil, mefenacet, flufenacet, clomeprop, naproanilide, bromobutide, dymron, cumyluron, etobenzanid, bentazon, tridiphane, carfentrazone-ethyl, fenchlorazole-ethyl, isoxadifen-ethyl, fentrazamide, clomazone, maleic hydrazide, pyridate, oxaziclomefone, cinmethylin, benfuresate, oxadiazon, oxadiargyl, pentoxazone, cyhalofop-butyl, cafenstrole, ipfencarbazone, pyriminobac-methyl, bispyribac-sodium, pyrimisulfan, triafamone, pyribenzoxim, pyriftalid, indanofan, ACN, benzobicyclon, tefuryltrione, mesotrione, fenquinotrione, dithiopyr, dalapon, chlorthiamid, penoxsulam, anilofos, bensulide, butamifos, fenoxasulfone, benzofenap, pyrazolynate, pyrazoxyfen, imazamethabenz, imazamethabenz-methyl, imazamox, imazamox-ammonium, imazapic, imazapic-ammonium, imazapyr, imazaquin, imazethapyr, pendimethalin, fenoxaprop-ethyl, fenoxaprop-P-ethyl, metamifop, pyraclonil, quinclorac, 2,4-D and its salts, MCP and its salts, MCPA and its salts, MCPB and its salts, piperophos, fluroxypyr, cyclopyrimorate, benzobicyclon, florpyrauxifen-benzyl, florpyrauxifen and thaxtomin A.

The rice for which the composition B can be used means among annual plants of the genus Oryza, Oryza sativa, Oryza glaberrima, and their hybrids, which are cultivated species, and they may be japonica rice, javanica rice, or indica rice, and may be any of non-glutinous rice, glutinous rice, brewer's rice, and rice for animal feed. Rice varieties are not particularly limited, and as exemplified in the plant varieties above, they can be varieties created through crossing, and may be varieties created through the genetic engineering techniques. When applying to varieties to which herbicide tolerance, pest insect resistance, or disease resistance has been imparted, it can be a particularly labor-saving method. It may also be a multiline where multiple varieties to which different resistance genes have been incorporated are mixed to cultivate.

The composition A containing one or more components having herbicidal activity selected from the group (i) and the group (j) and one or more safener components selected from the group (d) may be a single formulation containing all active ingredients, may be multiple formulations consisting of a formulation containing one active ingredient and a formulation containing multiple active ingredients, or may be separate formulations containing each of all active ingredients. Examples of methods include before or after planting seeds or plant reproduction organs treated with one or more safener component selected from the group (d) to soil, a component having herbicidal activity selected from the group (i) and the group (j) is applied to the soil, followed by applying the present compound to pest arthropods, habitats of the pest arthropods, plants or the soil. In the case, commercially available seeds or plant reproduction organs treated with one or more safener components selected from the group (d) may be purchased to use.

The composition A containing one or more components having herbicidal activity selected from the group (i) and the group (j) and one or more plant growth regulating ingredients selected from the group (c) may be a single formulation containing all active ingredients, may be multiple formulations consisting of a formulation containing one active ingredient and a formulation containing multiple active ingredients, or may be separate formulations containing each of all active ingredients. When applying multiple formulations, these formulations may be applied to the pest arthropods, habitats of the pest arthropods, plants or soil at the same timing or different timings. Examples of methods include before or after planting seeds or plant reproduction organs treated with one or more plant growth regulating ingredient selected from the group (c) to soil, a component having herbicidal activity selected from the group (i) and the group (j) is applied to the soil, followed by applying the present compound to pest arthropods, habitats of the pest arthropods, plants or the soil. In the case, commercially available seeds or plant reproduction organs treated with one or more plant growth regulating ingredient selected from the group (c) may be purchased to use.

The composition A containing one or more components having herbicidal activity selected from the group (i) and the group (j) may be a single formulation containing all active ingredients, may be multiple formulations consisting of a formulation containing one active ingredient and a formulation containing multiple active ingredients, or may be separate formulations containing each of all active ingredients. When applying multiple formulations, these formulations may be applied to the pest arthropods, habitats of the pest arthropods, plants or soil at the same timing or different timings. Examples of the timing for applying components having herbicidal activity include the following.

When treating with one or more components having herbicidal activity selected from the group (i) and the group (j) before sowing seeds or planting vegetative reproduction organs or seedlings, the timing for treating with the components having herbicidal activity is between 50 days before sowing or planting and immediately before sowing or planting, preferably between 30 days before sowing or planting and immediately before sowing or planting, more preferably between 20 days before sowing or planting and immediately before sowing or planting, still more preferably between 10 days before sowing or planting and immediately before sowing or planting.

When treating with one or more components having herbicidal activity selected from the group (i) and the group (j) after sowing seeds or planting of vegetative reproduction organs or seedlings, the timing for treating with the components having herbicidal activity is preferably between immediately after sowing to planting and 50 days after sowing or planting, more preferably between immediately after sowing or planting and 3 days after seeding or planting.

It is possible to treat with one or more components selected from the group (i) and the group (j) simultaneously with sowing seeds or planting vegetative reproduction organs or seedlings.

When treating with one or more components having herbicidal activity selected from the group (i) and the group (j) after sowing soybean seeds, examples of the timing for treating with said components having herbicidal activity include between pre-budding and the flowering stage of the soybean. Among the periods between pre-budding and the flowering stage of the soybean, it is preferably between pre-budding and the timing when the soybean has 6 compound leaves, and further preferably between pre-budding and the timing when the soybean has 3 compound leaves.

When treating with one or more components having herbicidal activity selected from the group (i) and the group (j) after sowing corn seeds, the timing for treating with said components having herbicidal activity is, for example, between pre-budding and the 12-leaf stage, preferably between pre-budding to the 8-leaf stage, and more preferably from pre-budding to the 6-leaf stage. Note that the leaf age of corn is determined by the Leaf Collar Method.

When treating with one or more components having herbicidal activity selected from the group (i) and the group (j) are treated before sowing cotton seeds, the timing for treating with the components having herbicidal activity is between 50 days before sowing and just before sowing, preferably between 30 days before sowing and just before sowing, further preferably between 20 days before sowing and just before sowing. When treating with one or more components having herbicidal activity selected from the group (i) and the group (j) after sowing cotton seeds, the timing for treating with said components having herbicidal activity is between immediately after sowing and 70 days after sowing, preferably between 30 days after sowing and 50 days after sowing, and is for example, between pre-budding and the flowering stage of the cotton, preferably between the beginning of lignification of the cotton's stem base and the timing when the lignified part is 20 cm from the base.

When treating with one or more components having herbicidal activity selected from the group (i) and the group (j) before planting sugar canes, the timing for treating with said components having herbicidal activity is between 40 days before and just before planting, preferably between 30 days before and just before planting, and further preferably between 20 day before and just before planting. When treating with one or more components having herbicidal activity selected from the group (i) and the group (j) after planting sugar canes, the timing for treating with the components having herbicidal activity is between immediately after planting and 40 days after planting, preferably between immediately after planting and 20 days after sowing or planting, and further preferably between immediately after planting and 10 days after planting.

By the application of the composition B, depending on plant species or plant varieties, and their habitats and growing conditions (soil, climate, growing season, and nutrient), increase in the seedling establishment rate of plants, improvement of plant growth, improvement of tolerance to abiotic stresses (e.g., improvement of tolerance or tolerability to high temperature or low temperature, improvement of tolerance to drought, excessive moisture, or saline matter contained in water or soil, improvement of tolerance to osmotic stress, improvement of tolerance to desiccation stress, improvement of tolerance to ozone exposure, improvement of tolerance to UV stress, improvement of tolerance to wind stress, and improvement of tolerance to sunshine stress), improvement of flowering ability, improvement of easiness of harvesting, acceleration of ripening, increase in yield, increase in the number, the size or the weight of seeds or fruits, improvement of greenness of leaves, increase in the number of healthy leaves, mitigation of plant lodging, earlier flowering, increase in the flowering number and the fruiting number, increase in the fruition rate, improvement of quality and/or increase in nutritional value of harvested products (e.g., increase in the sugar content in the fruit, improvement of the gluten strength, optimization of the protein content, optimization of the oil content, increase in nutritional value), improvement of storage stability and/or improvement of processibility of harvested products or the like may be sometimes possible. More specific examples of the improvement of plant growth include promotion of stem elongation, promotion of stem enlargement, promotion of increase in the number or the total area of leaves, promotion of increase in the number of healthy leaves and stem branching (e.g., promotion of increase in the number of stem branches), promotion of lateral root formation (e.g., increase in the number of lateral roots), increase in auxin production parts in root parts (main roots or lateral roots), promotion of root elongation, improvement of root spread and promotion of root enlargement. In addition, it is sometimes possible to improve tolerance to nutritional stress caused by a deficiency of any of the 17 essential nutrients (essential elements) for plant growth.

When applying the composition B to a place where rice seedlings are grown, the application amount of the composition B is usually 5000 g or less, preferably 1000 g or less per 10 a of sowing area (cultivated area), and as the total amount of the present compound or the composition A contained in the composition B, usually 1000 g or less, preferable 500 g or less. In addition, the total amount of the present compound or the composition A contained in the composition B is usually 0.05 to 1000 g, preferably 0.5 to 200 g per 1 m² of the place where rice seedlings are grown.

When applying the composition B to rice seedling boxes, the application amount of the composition B in terms of the total amount of the present compound or the composition A contained in the composition B is usually 0.1 to 35 g, preferably 0.2 to 20 g per a box (about 60 cm wide and 30 cm long) of seedling boxes.

Natural pyrethrins and the composition A can control pest arthropods such as pest insects and pest mites, pest mollusks, and pest nematodes. Specific examples thereof include the following.
Hemiptera: Delphacidae such as small brown planthopper (Laodelphax striatellus), brown planthopper (Nilaparvata lugens), white-backed planthopper (Sogatella furcifera), corn planthopper (Peregrinus maidis), cereal leafhopper (Javesella pellucida), sugarcane leafhopper (Perkinsiella saccharicida) and Tagosodes orizicolus; Cicadellidae such as green rice leafhopper(Nephotettix cincticeps), green paddy leafhopper(Nephotettix virescens), rice leafhopper (Nephotettix nigropictus), zigzag-striped leafhopper (Recilia dorsalis), tea green leafhopper (Empoasca onukii), potato leafhopper (Empoasca fabae), corn leafhopper (Dalbulus maidis), rice leafhopper (Cofana spectra) and Amrasca biguttula biguttula; Aphrophoridae such as European spittlebug (Philaenus spumarius); Cercopidae such as Mahanarva posticata and Mahanarva fimbriolata; Aphididae such as bean aphid (Aphis fabae), soybean aphid (Aphis glycines), cotton aphid (Aphis gossypii), green apple aphid (Aphis pomi), apple aphid (Aphis spiraecola), green peach aphid (Myzus persicae), leaf-curling plum aphid (Brachycaudus helichrysi), cabbage aphid (Brevicoryne brassicae), rosy apple aphid (Dysaphis plantaginea), false cabbage aphid (Lipaphis erysimi), potato aphid (Macrosiphum euphorbiae), foxglove aphid (Aulacorthum solani), lettuce aphid (Nasonovia ribisnigri), grain aphid (Rhopalosiphum padi), corn aphid (Rhopalosiphum maidis), brown citrus aphid (Toxoptera citricida), mealy plum aphid (Hyalopterus pruni), cane aphid (Melanaphis sacchari), black rice root aphid (Tetraneura nigriabdominalis), sugarcane cottony aphid (Ceratovacuna lanigera), apple woolly aphid (Eriosoma lanigerum) and English grain aphid (Sitobion avenae); Phylloxeridae such as grapevine phylloxera (Daktulosphaira vitifoliae), Pecan phylloxera (Phylloxera devastatrix), Pecan leaf phylloxera (Phylloxera notabilis) and Southern pecan leaf phylloxera (Phylloxera russelae); Adelgidae such as hemlock woolly aphid (Adelges tsugae), balsam woolly aphid (Adelges piceae) and Himekasa aburamushi (Aphrastasia pectinatae); Pentatomidae such as black rice bug (Scotinophara lurida), black paddy bug (Scotinophara coarctata), common green stink bug (Nezara antennata), white-spotted spined bug (Eysarcoris aeneus), lewis spined bug (Eysarcoris lewisi), white-spotted bug (Eysarcoris ventralis), Murasakishirahoshi Kamemushi (Eysarcoris annamita), brown marmorated stink bug (Halyomorpha halys), green plant bug (Nezara viridula), brown stink bug (Euschistus heros), red banded stink bug (Piezodorus guildinii), Oebalus pugnax and Dichelops melacanthus; Cydnidae such as Scaptocoris castanea; Alydidae such as bean bug (Riptortus clavatus), corbett rice bug (Leptocorisa chinensis) and rice bug (Leptocorisa acuta); Coreidae such as Hosohari Kamemushi (Cletus punctiger) and Australian leaf-footed bug (Leptoglossus australis); Lygaeidae such as oriental chinch bug (Cavelerius saccharivorus), seed bug (Togo hemipterus) and chinch bug (Blissus leucopterus); Miridae such as rice leaf bug (Trigonotylus caelestialium), sorghum plant bug (Stenotus rubrovittatus), wheat leaf bug (Stenodema calcarata) and American tarnished plant bug (Lygus lineolaris); Aleyrodidae such as greenhouse whitefly (Trialeurodes vaporariorum), tobacco whitefly (Bemisia tabaci), citrus whitefly (Dialeurodes citri), citrus spiny whitefly (Aleurocanthus spiniferus), tea spiny whitefly (Aleurocanthus camelliae) and Hisakakiwatafuki Konajirami (Pealius euryae); Diaspididae such as Shuromaru Kaigaramushi (Abgrallaspis cyanophylli), red scale (Aonidiella aurantii), San Jose scale (Diaspidiotus perniciosus), white peach scale (Pseudaulacaspis pentagona), arrowhead scale (Unaspis yanonensis) and citrus snow scale (Unaspis citri); Coccidae such as pink wax scale (Ceroplastes rubens); Margarodidae such as fluted scale (Icerya purchasi) and seychelles fluted scale (Icerya seychellarum); Pseudococcidae such as solanum mealybug (Phenacoccus solani), cotton mealybug (Phenacoccus solenopsis), Japanese mealybug (Planococcus kraunhiae), white peach scale (Pseudococcus comstocki), citrus mealybug (Planococcus citri), currant mealybug (Pseudococcus calceolariae), long-tailed mealybug (Pseudococcus longispinus) and tuttle mealybug (Brevennia rehi); Psyllidae such as citrus psylla (Diaphorina citri), two-spotted citrus psyllid (Trioza erytreae), pear sucker (Cacopsylla pyrisuga), Chugokunashi Kijirami (Cacopsylla chinensis), potato psyllid (Bactericera cockerelli) and Pear psylla (Cacopsylla pyricola); Tingidae such as sycamore lace bug (Corythucha ciliata), aster tingid (Corythucha marmorata), Japanese pear lace bug (Stephanitis nashi) and azalea lace bug (Stephanitis pyrioides); Cimicidae such as common bed bug (Cimex lectularius) and tropical bed bug (Cimex hemipterus); Cicadidae such as Quesada gigas; Reduviidae such as Burajiru Sashigame (Triatoma infestans), large kissing bug (Triatoma rubrofasciata), Triatoma dimidiate and Benezuera Sashigame (Rhodonius prolixus).

Lepidoptera: Crambidae such as rice stem borer (Chilo suppressalis), Dark-headed stem borer (Chilo polychrysus), white stem borer (Scirpophaga innotata), yellow paddy borer (Scirpophaga incertulas), Rupela albina, rice leaf roller (Cnaphalocrocis medinalis), Marasmia patnalis, rice leaf roller (Marasmia exigua), cotton leaf roller (Notarcha derogata), corn borer (Ostrinia furnacalis), European corn borer (Ostrinia nubilalis), cabbage webworm (Hellula undalis), grape leafroller (Herpetogramma luctuosale), bluegrass webworm (Parapediasia teterrellus), rice case-worm (Nymphula depunctalis), Sugarcane borer (Diatraea saccharalis) and eggplant fruit borer (Leucinodes orbonalis); Pyralidae such as lesser cornstalk borer (Elasmopalpus lignosellus), mealworm moth (Plodia interpunctella), persimmon bark borer (Euzophera batangensis) and fig moth (Cadra cautella); Noctuidae such as cotton worm (Spodoptera litura), beet armyworm (Spodoptera exigua), rice armyworm (Mythimna separata), cabbage moth (Mamestra brassicae), pink borer (Sesamia inferens), grass armyworm (Spodoptera mauritia), green rice caterpillar (Naranga aenescens), Spodoptera frugiperda, true armyworm (Spodoptera exempta), Spodoptera cosmioides, semitropical armyworm (Spodoptera eridania), black cutworm (Agrotis ipsilon), beet worm (Autographa nigrisigna), rice looper (Plusia festucae), Soybean looper (Chrysodeixis includens), Trichoplusia spp., Heliothis spp. including tobacco budworm (Heliothis virescens), Helicoverpa spp. including tobacco budworm (Helicoverpa armigera), corn earworm (Helicoverpa zea), velvet-bean caterpillar (Anticarsia gemmatalis), cotton leafworm (Alabama argillacea) and hop vine borer (Hydraecia immanis); Pieridae such as common cabbage worm (Pieris rapae); Tortricidae such as oriental fruit moth (Grapholita molesta), Sumomohimeshinkui (Grapholita dimorpha), soybean moth (Leguminivora glycinivorella), Azukisayamushiga (Matsumuraeses azukivora), summer fruit tortrix (Adoxophyes orana fasciata), smaller tea tortrix (Adoxophyes honmai), Japanese tea tortrix (Homona magnanima), apple tortrix (Archips fuscocupreanus), codling moth (Cydia pomonella), sugarcane shoot borer (Tetramoera schistaceana), bean shoot borer (Epinotia aporema), citrus fruit borer (Citripestis sagittiferella) and European grapevine moth (Lobesia botrana); Gracillariidae such as tea leaf roller (Caloptilia theivora) and Asiatic apple leaf miner (Phyllonorycter ringoniella); Carposinidae such as peach fruit moth (Carposina sasakii); Lyonetiidae such as coffee leaf miner (Leucoptera coffeella), peach leaf miner (Lyonetia clerkella) and Ginmonhamoguriga (Lyonetia prunifoliella); Lymantriidae such as Lymantria spp. including gypsy moth (Lymantria dispar) and Euproctis spp. including tea lymantriid (Euproctis pseudoconspersa); Plutellidae such as diamondback moth (Plutella xylostella); Gelechiidae such as peach worm (Anarsia lineatella), sweetpotato leaf folder (Helcystogramma triannulella), pink bollworm (Pectinophora gossypiella), potato moth (Phthorimaea operculella) and Tuta absoluta; Arctiidae such as American white moth (Hyphantria cunea); Castniidae such as giant sugarcane borer (Telchin licus); Cossidae such as Himebokuto (Cossus insularis); Geometridae such as Yomogiedasyaku (Ascotis selenaria); Limacodidae such as blue-striped nettle grub (Parasa lepida); Stathmopodidae such as persimmon fruit moth (Stathmopoda masinissa); Sphingidae such as tobacco hornworm (Acherontia lachesis); Sesiidae such as Kikubisukashiba (Nokona feralis), cherry borer (Synanthedon hector) and Himekosukashiba (Synanthedon tenuis); Hesperiidae such as rice skipper (Parnara guttata); Tineidae such as casemaking clothes moth (Tinea translucens) and common clothes moth (Tineola bisselliella).

Thysanoptera: Thripidae such as western flower thrips (Frankliniella occidentalis), oriental thrips (Thrips palmi), yellow tea thrips (Scirtothrips dorsalis), onion thrips (Thrips tabaci), eastern flower thrips (Frankliniella intonsa), rice thrips (Stenchaetothrips biformis), Motojiroazamiuma (Echinothrips americanus) and avocado thrips (Scirtothrips perseae); Phlaeothripidae such as aculeated rice thrips (Haplothrips aculeatus).

Diptera: Anthomyiidae such as seedcorn maggot (Delia platura), onion maggot (Delia antiqua) and beet leaf miner (Pegomya cunicularia); Ulidiidae such as sugarbeet root maggot (Tetanops myopaeformis); Agromyzidae such as rice leaf miner (Agromyza oryzae), tomato leaf miner (Liriomyza sativae), chrysanthemum leaf miner (Liriomyza trifolii) and pea leafminer (Chromatomyia horticola); Chloropidae such as rice stem maggot (Chlorops oryzae); Tephritidae such as melon fly (Bactrocera cucurbitae), oriental fruit fly (Bactrocera dorsalis), Malaysian fruit fly (Bactrocera latifrons), olive fruit fly (Bactrocera oleae), Queensland fruit fly (Bactrocera tryoni), Mediterranean fruit fly (Ceratitis capitata), apple maggot (Rhagoletis pomonella) and Japanese cherry fruit fly (Rhacochlaena japonica); Ephydridae such as smaller rice leaf miner (Hydrellia griseola), whorl maggot (Hydrellia philippina) and paddy stem maggot (Hydrellia sasakii); Drosophilidae such as cherry drosophila (Drosophila suzukii) and common fruit fly (Drosophila melanogaster); Phoridae such as Okimonnomibae (Megaselia spiracularis); Psychodidae such as Ochobae (Clogmia albipunctata); Sciaridae such as Chibikurobanekinokobae (Bradysia difformis); Cecidomyiidae such as hessian fly (Mayetiola destructor), paddy gall fly (Orseolia oryzae); Diopsidae such as Diopsis macrophthalma; Glossinidae such as Glossina palpalis and Glossina morsitans; Simuliidae such as Ashimadarabuyu (Simulium japonicum), Simulium damnosum; Phlebotominae; Tipulidae such as rice crane fly (Tipula aino), common cranefly (Tipula oleracea) and European cranefly (Tipula paludosa); Culicidae such as southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti and Anopheles minimus; Simulidae such as Kiashiobuyu (Prosimulium yezoensis), Tsumetogebuyu (Simulium ornatum); Tabanidae such as Ushiabu (Tabanus trigonus); Muscidae such as house fly (Musca domestica), false stable fly (Muscina stabulans), biting house fly (Stomoxys calcitrans), buffalo fly (Haematobia irritans); Calliphoridae; Sarcophagidae; Chironomidae such as Oyusurika (Chironomus plumosus), Sesujiyusurika (Chironomus yoshimatsui), Haiiroyusurika (Glyptotendipes tokunagai); Fannidae.

Coleoptera: Chrysomelidae such as Diabrotica spp. (e.g., western corn rootworm (Diabrotica virgifera virgifera), southern corn rootworm (Diabrotica undecimpunctata howardi), northern corn rootworm (Diabrotica barberi), Mexican corn rootworm (Diabrotica virgifera zeae)), banded cucumber beetle (Diabrotica balteata), bean leaf beetle (Cerotoma trifurcata) including cucurbit beetle (Diabrotica speciosa), barley leaf beetle (Oulema melanopus), cucurbit leaf beetle (Aulacophora femoralis), striped flea beetle (Phyllotreta striolata), cabbage flea beetle (Phyllotreta cruciferae), western black flea beetle (Phyllotreta pusilla), cabbage stem flea beetle (Psylliodes chrysocephala), hop flea beetle (Psylliodes punctulata), Colorado potato beetle (Leptinotarsa decemlineata), rice leaf beetle (Oulema oryzae), grape colaspis (Colaspis brunnea), corn flea beetle (Chaetocnema pulicaria), sweet-potato flea beetle (Chaetocnema confinis), potato flea beetle (Epitrix cucumeris), rice leaf beetle (Dicladispa armigera), southern corn leaf beetle (Myochrous denticollis), Yotsumonkamenokohamushi (Laccoptera quadrimaculata), tobacco flea beetle (Epitrix hirtipennis); Carabidae such as Seedcorn beetle (Stenolophus lecontei), slender seed-corn ground beetle (Clivina impressifrons); Scarabaeidae such as cupreus chafer (Anomala cuprea), soybean beetle (Anomala rufocuprea), Aodogane (Anomala albopilosa), Japanese beetle (Popillia japonica), yellowish elongate chafer (Heptophylla picea), European Chafer (Rhizotrogus majalis), Kuromarukogane (Tomarus gibbosus), Holotrichia spp., Phyllophaga spp. including June beetle (Phyllophaga crinita), Diloboderus spp. including Diloboderus abderus; Anthriibidae such as coffee bean weevil (Araecerus coffeae); Aponidae such as sweet-potato weevil (Cylas formicarius); Bruchidae such as Mexican bean weevil (Zabrotes subfasciatus); Scolytidae such as pine beetle (Tomicus piniperda), coffee berry borer (Hypothenemus hampei); Curculionidae such as West Indian sweet-potato weevil (Euscepes postfasciatus), alfalfa weevil (Hypera postica), maize weevil (Sitophilus zeamais), rice weevil (Sitophilus oryzae), grain weevil (Sitophilus granarius), rice plant weevil (Echinocnemus squameus), rice water weevil (Lissorhoptrus oryzophilus), Shirosujiosazomushi (Rhabdoscelus lineaticollis), boll weevil (Anthonomus grandis), nunting billbug (Sphenophorus venatus), southern corn billbug (Sphenophorus callosus), soybean stalk weevil (Sternechus subsignatus), sugarcane weevil (Sphenophorus levis), rusty gourd-shaped weevil (Scepticus griseus), brown gourd-shaped weevil (Scepticus uniformis), Aracanthus spp. including Aracanthus mourei and cotton root borer (Eutinobothrus brasiliensis); Tenebrionidae such as red meal beetle (Tribolium castaneum), mason beetle (Tribolium confusum) and lesser mealworm (Alphitobius diaperinus); Coccinellidae such as twenty-eight-spotted ladybird (Epilachna vigintioctopunctata); Bostrychidae such as common powder-post beetle (Lyctus brunneus) and lesser grain borer (Rhizopertha dominica); Ptinidae; Cerambycidae such as citrus long-horned beetle (Anoplophora malasiaca), Migdolus fryanus and peach borer (Aromia bungii); Elateridae such as Okinawakansyakushikometsuki (Melanotus okinawensis), barley wireworm (Agriotes fuscicollis), Kushikometsuki (Melanotus legatus), Anchastus spp., Conoderus spp., Ctenicera spp., Limonius spp. and Aeolus spp.; Staphylinidae such as Aobaarigatahanekakushi (Paederus fuscipes); Dermestidae such as varied carpet beetle (Anthrenus verbasci), hide beetle (Dermestes maculates) and khapra beetle (Trogoderma granarium); Anobiidae such as tobacco beetle (Lasioderma serricorne) and biscuit beetle (Stegobium paniceum); Laemophloeidae such as flat grain beetle (Cryptolestes ferrugineus); Silvanidae such as saw-toothed grain beetle (Oryzaephilus surinamensis); Nitidulidae such as blossom beetle (Brassicogethes aeneus).

Orthoptera: Acrididae such as oriental migratory locust (Locusta migratoria), Moroccan locust (Dociostaurus maroccanus), Australian plague locust (Chortoicetes terminifera), red locust (Nomadacris septemfasciata), brown locust (Locustana pardalina), tree locust (Anacridium melanorhodon), Italian locust (Calliptamus italicus), differential grasshopper (Melanoplus differentialis), two-striped grasshopper (Melanoplus bivittatus), migratory grasshopper (Melanoplus sanguinipes), red-legged grasshopper (Melanoplus femurrubrum), clear-winged grasshopper (Camnula pellucida), desert locust (Schistocerca gregaria), Yellow-winged locust (Gastrimargus musicus), spur-throated locust (Austracris guttulosa), Japanese grasshopper (Oxya yezoensis), rice grasshopper (Oxya japonica) and Bombay locust (Patanga succincta); Gryllotalpidae such as oriental mole cricket (Gryllotalpa orientalis); Gryllidae such as house cricket (Acheta domestica), emma field cricket (Teleogryllus emma); Tettigoniidae such as mormon cricket (Anabrus simplex).

Hymenoptera: Tenthredinidae such as beet sawfly (Athalia rosae), nippon cabbage sawfly (Athalia japonica); Formicidae such as Solenopsis spp. including red imported fire ant (Solenopsis invicta), tropical fire ant (Solenopsis geminata), Atta spp. including brown leaf-cutting ant (Atta capiguara), Acromyrmex spp., Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala), Camponotus spp. including Kurooari (Camponotus japonicus), Muneakaoari (Camponotus obscuripes), Pogonomyrmex spp. including western harvester ant (Pogonomyrmex occidentalis), Wasmania spp. including Kokamiari (Wasmania auropunctata) and long-legged ant (Anoplolepis gracilipes); Vespidae such as Asian giant hornet (Vespa mandarinia), Kebukasuzumebachi (Vespa simillima), Kogatasuzumebachi (Vespa analis), Asian hornet (Vespa velutina) and Seguroashinagabachi (Polistes jokahamae); Siricidae such as pine wood wasp (Urocerus gigas); Bethylidae.

Blattodea: Ectobiidae such as German cockroach (Blattella germanica); Blattidae such as smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis); Termitidae such as Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae) and Cornitermes cumulans.

Siphonaptera: Pulicidae such as human flea (Pulex irritans), cat flea (Ctenocephalides felis), dog flea (Ctenocephalides canis), oriental rat flea (Xenopsylla cheopis) and chicken flea (Echidnophaga gallinacea); Hectopsyllidae such as chigoe flea (Tunga penetrans); Ceratophyllidae such as European rat flea (Nosopsyllus fasciatus).

Psocodae: Pediculidae such as head louse (Pediculus humanus capitis); Pthiridae such as crab louse (Pthirus pubis); Haematopinidae such as short-nosed cattle louse (Haematopinus eurysternus) and pig louse (Haematopinus suis); Linognathidae such as blue cattle louse (Linognathus vituli), sheep face louse (Linognathus ovillus) and capillate louse (Solenopotes capillatus); Bovicoliidae such as cattle biting louse (Bovicola bovis), sheep biting louse (Bovicola ovis), Bovicola breviceps, Damalinia forficula and Werneckiella spp.; Trichodectidae such as dog biting louse (Trichodectes canis) and cat louse (Felicola subrostratus); Menoponidae such as common chicken louse (Menopon gallinae), chicken body louse (Menacanthus stramineus), Trinoton spp.; Trimenoponidae such as Cummingsia spp.; Trogiidae such as death watch (Trogium pulsatorium); Liposcelidae or Liposcelididae such as book louse (Liposcelis corrodens), Hiratatyatate (Liposcelis bostrychophila), Somentyatate (Liposcelis pearmani) and Katsubushityatate (Liposcelis entomophila).

Thysanura: Lepismatidae such as oriental silverfish (Ctenolepisma villosa), and moth fish (Lepisma saccharina).

Acari: Tetranychidae such as common red spider mite (Tetranychus urticae), kanzawa spider mite (Tetranychus kanzawai), red spider mite (Tetranychus evansi), citrus red mite (Panonychus citri), fruit-tree red spider mite (Panonychus ulmi) and Oligonychus spp.; Eriophyidae such as Japanese citrus rust mite (Aculops pelekassi), Ryukyumikansabidani (Phyllocoptruta citri), tomato mite (Aculops lycopersici), purple mite (Calacarus carinatus), tea rust mite (Acaphylla theavagrans), Nisenashisabidani (Eriophyes chibaensis), apple bud mite (Aculus schlechtendali), Kakisabidani (Aceria diospyri), Aceria tosichella and Shisosabidani (Shevtchenkella sp.); Tarsonemidae such as broad mite (Polyphagotarsonemus latus); Tenuipalpidae such as Minamihimehadani (Brevipalpus phoenicis), Tuckerellidae; Ixodidae such as Futatogechimadani (Haemaphysalis longicornis), Kichimadani (Haemaphysalis flava), Yamatomadani (Haemaphysalis japonica), Tsuriganechimadani (Haemaphysalis campanulata), American dog tick (Dermacentor variabilis), Taiwankakumadani (Dermacentor taiwanensis), Rocky Mountain wood tick (Dermacentor andersoni), netted tick (Dermacentor reticulatus), Yamatomadani (Ixodes ovatus), Syurutsumadani (Ixodes persulcatus), black-legged tick (Ixodes scapularis), Seibu Kuroashimadani (Ixodes pacificus), Ixodes holocyclus, Ixodes ricinus, lone star tick (Amblyomma americanum), gulf coast tick (Amblyomma maculatum), Oushimadani (Rhipicephalus microplus), cattle tick (Rhipicephalus annulatus), brown dog tick (Rhipicephalus sanguineus), Rhipicephalus appendiculatus and Rhipicephalus decoloratus; Argasidae such as fowl tick (Argas persicus), Ornithodoros hermsi and Ornithodoros turicata; Acaridae such as cereal mite (Tyrophagus putrescentiae) and grassland mite (Tyrophagus similis); Pyroglyphidae such as American house dust mite (Dermatophagoides farinae) and European house dust mite (Dermatophagoides pteronyssinus); Cheyletidae such as Hosotsumedani (Cheyletus eruditus), Kuwagatatsumedani (Cheyletus malaccensis), Minamitsumedani (Chelacaropsis moorei), Inutsumedani (Cheyletiella yasguri); Psoroptidae such as sheep scab mite (Psoroptes ovis), horse psoroptic mange mite (Psoroptes equi), Knemidocoptes mutans, ear mange mite (Otodectes cynotis), Chorioptes spp.; Sarcoptidae such as Nekosyosenkouhizendani (Notoedres cati), Nezumisyosenkouhizendani (Notoedres muris) and itch mite (Sarcoptes scabiei); Listrophoridae such as Usagizutsukidani (Listrophorus gibbus); Dermanyssidae such as bird mite (Dermanyssus gallinae); Macronyssidae such as feather mite (Ornithonyssus sylviarum) and tropical rat mite (Ornithonyssus bacoti); Varroidae such as Mitsubachihegiitadani (Varroa jacobsoni); Demodicidae such as dog follicle mite (Demodex canis) and cat follicle mite (Demodex cati); Trombiculidae such as Akatsutsugamushi (Leptotrombidium akamushi), Futogetsutsugamushi (Leptotrombidium pallidum), Tatetsutsugamushi (Leptotrombidium scutellare).

Araneae: Eutichuridae such as Kabakikomachigumo (Cheiracanthium japonicum); Theridiidae such as red-back spider (Latrodectus hasseltii).

Polydesmida: Paradoxosomatidae such as flat-backed millipede (Oxidus gracilis), Akayasude (Nedyopus tambanus).

Isopoda: Armadillidiidae such as common pill bug (Armadillidium vulgare).

Chilopoda: Scutigeridae such as Geji (Thereuonema hilgendorfi); Scolopendridae such as giant tropical centipede (Scolopendra subspinipes); Ethopolyidae such as Issunmukade (Bothropolys rugosus).

Gastropoda: Limacidae such as tree slug (Limax marginatus) and garden tawny slug (Limax flavus); Philomycidae such as Namekuji (Meghimatium bilineatum); Ampullariidae such as golden apple snail (Pomacea canaliculata); Lymnaeidae such as Himemonoaragai (Austropeplea ollula).

Nematoda: Aphelenchoididae such as rice white-tip nematode (Aphelenchoides besseyi); Pratylenchidae such as root lesion nematode (Pratylenchus coffeae), Pratylenchus brachyurus, California meadow nematode (Pratylenchus neglectus) and Radopholus similis; Heteroderidae such as javanese root-knot nematode (Meloidogyne javanica), southern root-knot nematode (Meloidogyne incognita), guava root-knot nematodes (Meloidogyne enterolobii), northern root-knot nematode (Meloidogyne hapla), soybean cyst nematode (Heterodera glycines), potato cyst nematode (Globodera rostochiensis) and white potato cyst nematode (Globodera pallida); Hoplolaimidae such as Rotylenchulus reniformis; Anguinidae such as strawberry bud nematode (Nothotylenchus acris) and stem nematode (Ditylenchus dipsaci); Tylenchulidae such as citrus nematode (Tylenchulus semipenetrans); Longidoridae such as dagger nematode (Xiphinema index); Trichodoridae; Parasitaphelenchidae such as pine wilt disease (Bursaphelenchu natural pyrethrin ylophilus).

The growth stages within a species are not limited for the above pest arthropods such as pest insects and pest mites, pest mollusks and pest nematodes. That is, eggs, larvae, pronymphs, nymphs, chrysalises, subimagoes, imagoes, juvenile mites, young mites, adult mites and other larvae are all included.

The variations within a species are not limited for the above pest arthropods such as pest insects and pest mites, pest mollusks and pest nematodes. That is, pest arthropods, pest mollusks and pest nematodes which have reduced susceptibility (also referred to as exhibit resistance) to certain insecticides, acaricides, molluscicides and nematicides are also included. Examples of the insecticides, acaricides, molluscicides and nematicides include group A1 to group A26.
Group a1: Acetylcholinesterase inhibitors
Group consisting of the Group 1A carbamates and the Group 1B organophosphate compounds in the IRAC action classification, for example, alanycarb, aldicarb, bendiocarb, benfuracarb, butocarboxim, butoxycarboxim, carbaryl (NAC), carbofuran, carbosulfan, ethiofencarb, fenobucarb (BPMC), formetanate, furathiocarb, isoprocarb (MIPC), methiocarb, methomyl, methoxychlor, metolcarb, oxamyl, pirimicarb, promecarb, propoxur (PHC), thiodicarb, thiofanox, triazamate, trimethacarb, xylylcarb, acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos (CYAP), demeton, demeton-S-methyl), diazinon, dichlorvos (DDVP), dicrotophos, dimethoate, dimethylvinphos, disulfoton, EPN, ethion, ethoprophos, famphur, fenamiphos, fenchlorphos, fenitrothion (MEP), fenthion (MPP), fosthiazate, heptenophos, imicyafos, isofenphos, isopropyl-O-(methoxyaminothiophosphoryl)salicylate, isoxathion, malathion, mecarbam, methamidophos, methidathion (DMTP), mevinphos, monocrotophos, naled (BRP), omethoate), oxydemeton-methyl, parathion, parathion-methyl, phenthoate (PAP), phorate, phosalone, phosmet (PMP), phosphamidon, phoxim, pirimiphos-methyl, profenofos, propetamphos, prothiofos, pyraclofos, pyrazophos, pyridaphenthion, quinalphos, sulfotep, sulprofos, tebupirimfos, temephos, terbufos, tetrachlorvinphos, thiometon, toxaphene, triazophos, trichlorfon (DEP) and vamidothion.
Group a2: GABA-gated chloride channel blockers
Group consisting of the Group 2A cyclodiene organochlorines and the Group 2B phenylpyrazole compounds in the IRAC action classification, for example, chlordane, endosulfan, dieldrin, ethiprole, fipronil, flufiprole and pyriprole.
Group a3: sodium channel modulators
Group consisting of the Group 3A pyrethroids and the Group 3B in the IRAC action classification, for example, acrinathrin, allethrin, bifenthrin, kappa-bifenthrin, bioallethrin, bioresmethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, sigma-cypermethrin, cyphenothrin, deltamethrin, empenthrin, esfenvalerate, etofenprox, fenpropathrin, fenvalerate, flucythrinate, flumethrin, fluvalinate, tau-fluvalinate, halfenprox, heptafluthrin, imiprothrin, kadethrin, meperfluthrin, momfluorothrin, permethrin, phenothrin, prallethrin, pyrethrins, resmethrin, silafluofen, tefluthrin, kappa-tefluthrin, tetramethrin, tetramethylfluthrin, tralomethrin, transfluthrin, benfluthrin, flufenoprox, flumethrin, furamethrin, metofluthrin, profluthrin, dimefluthrin and DDT.
Group a4: nicotinic acetylcholine receptor competitive modulators
Group consisting of the groups 4A neonicotinoids, 4B nicotine, 4C butenolides, 4D sulfoximines and 4E mesoionics in the IRAC action classification, for example, acetamiprid, clothianidin, dinotefuran, imidacloprid, nitenpyram, thiacloprid, thiamethoxam, flupyradifurone, sulfoxaflor, cycloxaprid, triflumezopyrim, dicloromezotiaz and flupyrimin.
Group a5: nicotinic acetylcholine receptor allosteric modulators
Group consisting of the groups 5 spinosyns in the IRAC action classification, for example, spinosad and spinetoram.
Group a6: glutamate-gated chloride channel allosteric modulators
Group consisting of the groups 6 avermectins and milbemycins in the IRAC action classification, for example, abamectin, emamectin-benzoate, lepimectin, milbemectin, dimadectin, doramectin, eprinomectin, ivermectin, latidectin, selamectin, milbemycin D, moxidectin and nemadectin.
Group a7: juvenile hormone mimics
Group consisting of the group 7A juvenile hormone analogues, the group 7B fenoxycarb and the group 7C pyriproxyfen in the IRAC action classification, for example, hydroprene, kinoprene, Methoprene, fenoxycarb and pyriproxyfen.
Group a8: chordotonal organ TRPV channel modulators
Group consisting of the group 9 pyridine azomethine derivatives in the IRAC action classification, for example, pymetrozine and pyrifluquinazon.
Group a9: microbial disruptors of insect midgut membranes
Group consisting of the group 11A Bacillus thuringiensis and the group 11B Bacillus sphaericus in the IRAC action classification, for example, Bacillus sphaericus, Bacillus thuringiensis strain BD #32, Bacillus thuringiensis strain AQ52, Bacillus thuringiensis subsp. aizawai strain ABTS-1857, Bacillus thuringiensis subsp. kurstaki strain HD-1, Bacillus thuringiensis subsp. kurstaki strain BMP123, Bacillus thuringiensis subsp. Tenebriosis strain NB176, Bacillus thuringiensis var. israelensis, Bacillus thuringiensis var.aegypti, Bacillus thuringiensis var. colmeri, Bacillus thuringiensis var. darmstadiensis, Bacillus thuringiensis var. dendrolimus, Bacillus thuringiensis var. galleriae, Bacillus thuringiensis var. japonensis, Bacillus thuringiensis subsp. Morrisoni, Bacillus thuringiensis var. san diego, Bacillus thuringiensis subsp. Thuringiensis strain MPPLOO2, Bacillus thuringiensis var. 7216, Bacillus thuringiensis var. T36, 6-endotoxins conferring resistance to lepidopteran insects (e.g., Cry1A, Cry1Ab, modified Cry1Ab (partially deleted Cry1Ab), Cry1Ac, Cry1Ab-Ac (hybrid protein in which Cry1Ab and Cry1Ac are fused), Cry1C, Cry1F, Cry1Fa2 (modified cry1F), moCry1F (modified Cry1F), Cry1A. 105 (hybrid protein in which Cry1Ab, Cry1Ac and Cry1F are fused), Cry2Ab2, Cry2Ae, Cry9C, Vip3A and Vip3Aa20), δ-endotoxins conferring resistance to coleopteran insects (e.g., Cry3A, mCry3A (modified Cry3A), Cry3Bb1, Cry34Ab1, Cry35Ab1) and 5-endotoxins having insecticidal activity on Culicidae (e.g., Cry1A, Cry4A, Cry4B and Cry11A).
Group a10: uncouplers of oxidative phosphorylation via disruption of the proton gradient
Group consisting of the group 13 in the IRAC action classification, for example, chlorfenapyr and sulfluramid.
Group all: nicotinic acetylcholine receptor channel blockers
Group consisting of the group 14 nereistoxin analogues in the IRAC action classification, for example, bensultap, cartap, cartap hydrochloride, thiocyclam, thiosultap-disodium, thiosultap-monosodium.
Group a12: chitin biosynthesis inhibitors
Group consisting of the group 15 benzoylureas and the group 16 buprofezin in the IRAC action classification, for example, bistrifluron, chlorfluazuron, diflubenzuron, flucycloxuron, flufenoxuron, hexaflumuron, lufenuron, novaluron, noviflumuron, teflubenzuron, triflumuron and buprofezin.
Group a13: moulting disruptors
Group consisting of the group 17 in the IRAC action classification, for example, cyromazine.
Group a14: ecdysone receptor agonists Group consisting of the group 18 diacylhydrazines in the IRAC action classification, for example, chromafenozide, halofenozide, methoxyfenozide and tebufenozide.
Group a15: voltage-dependent sodium channel blockers
Group consisting of the group 22A oxadiazines and the group 22B semicarbazones in the IRAC action classification, for example, indoxacarb and metaflumizone.
Group a16: acetyl-CoA carboxylase inhibitors
Group consisting of the group 23 tetronic and tetramic acid derivatives in the IRAC action classification, for example, spirodiclofen, spiromesifen and spirotetramat.
Group a17: ryanodine receptor modulators
Group consisting of the group 28 diamides in the IRAC action classification, for example, chlorantraniliprole, cyantraniliprole, cycloniliprole, flubendiamide, tetraniliprole, cyhalodiamide and tetrachlorantraniliprole.
Group a18: chordotonal organ modulators
Group consisting of the group 29 in the IRAC action classification, for example, flonicamid.
Group a19: mite growth inhibitors
Group consisting of the group 10 in the IRAC action classification, for example, etoxozole, clofentezine and hexythiazox.
Group a20: octopamine receptor agonists
Group consisting of the group 19 in the IRAC action classification, for example, amitraz.
Group a21: mitochondrial complex IV electron transport inhibitors
Group consisting of the group 24 in the IRAC action classification, for example, phosphine.
Group a22: Group consisting of isooxazoline compounds, for example, afoxolaner, fluralaner, sarolaner and lotilaner.
Group a23: mitochondrial ATP synthase inhibitors
Group consisting of the group 12 in the IRAC action classification, for example, diafenthiuron.
Group a24: mitochondrial complex III electron transport inhibitors
Group consisting of the group 20 in the IRAC action classification, for example, acequinocyl and bifenazate.
Group a25: mitochondrial complex I electron transport inhibitors (MTEI)
Group consisting of the group 21 in the IRAC action classification, for example, pyridaben and fenpyroximate.
Group a26: Group consisting of azadiractin and pyridalyl.

Examples of factors for reduction of susceptibility include [1]amino acid substitutions in a target protein, [2] decrease of a target protein, [3] enhancement of metabolism, [4] decrease of skin permeability and [5] enhancement of elimination function by membrane transporters. In [1], the target protein may have one or more amino acid substitutions. The enhancement of metabolism in [3] means, for example, enhancement in activity of metabolic enzymes (also referred to as detoxification-degradation enzymes) such as cytochrome P450, carboxylesterase, and glutathione-S-transferase. It is also possible to have one or a plurality of any of [1]amino acid substitutions in a target protein, [2] decrease of a target protein, [3] enhancement of metabolism, [4] decrease of skin permeability and [5] enhancement of elimination function by membrane transporters, as factors for reduction of susceptibility.

Examples of pest arthropods such as pest insects and pest mites, pest mollusks and pest nematodes which have reduced susceptibility include the following.
Hemiptera having reduced susceptibility to one or more compounds selected from the group a2;
Hemiptera having reduced susceptibility to one or more compounds selected from the group a4;
Hemiptera having reduced susceptibility to one or more compounds selected from the group a8;
Hemiptera having reduced susceptibility to one or more compounds selected from the group a12;
Hemiptera having reduced susceptibility to one or more compounds selected from the group a2, and one or more compounds selected from the group a4;
Hemiptera having reduced susceptibility to one or more compounds selected from the group a2, and one or more compounds selected from the group a8;
Hemiptera having reduced susceptibility to one or more compounds selected from the group a2, and buprofezin belonging to the group a12;
Hemiptera having reduced susceptibility to one or more compounds selected from the group a4, and one or more compounds selected from the group a8;
Hemiptera having reduced susceptibility to one or more compounds selected from the group a4, and buprofezin belonging to the group a12;
Hemiptera having reduced susceptibility to one or more compounds selected from the group a8, and buprofezin belonging to the group a12;
Hemiptera having reduced susceptibility to one or more compounds selected from the group a4, and one or more compounds selected from the group a8;
Hemiptera having reduced susceptibility to one or more compounds selected from the group a2, one or more compounds selected from the group a4, and one or more compounds selected from the group a8;
Hemiptera having reduced susceptibility to one or more compounds selected from the group a2, one or more compounds selected from the group a4, and buprofezin belonging to the group a12;
Hemiptera having reduced susceptibility to one or more compounds selected from the group a2, one or more compounds selected from the group a8, and buprofezin belonging to the group a12;
Hemiptera having reduced susceptibility to one or more compounds selected from the group a4, one or more compounds selected from the group a8, and buprofezin belonging to the group a12;
Hemiptera having reduced susceptibility to one or more compounds selected from the group a2, one or more compounds selected from the group a4, one or more compounds selected from the group a8, and buprofezin belonging to the group a12;
Delphacidae having reduced susceptibility to one or more compounds selected from the group a2;
Delphacidae having reduced susceptibility to one or more compounds selected from the group a4;
Delphacidae having reduced susceptibility to one or more compounds selected from the group a8;
Delphacidae having reduced susceptibility to one or more compounds selected from the group a12;
Delphacidae having reduced susceptibility to one or more compounds selected from the group a2, and one or more compounds selected from the group a4;
Delphacidae having reduced susceptibility to one or more compounds selected from the group a2, and pymetrozine belonging to the group 8;
Delphacidae having reduced susceptibility to one or more compounds selected from the group a2, and buprofezin belonging to the group 12;
Delphacidae having reduced susceptibility to one or more compounds selected from the group a4, and pymetrozine belonging to the group 8;
Delphacidae having reduced susceptibility to one or more compounds selected from the group a4, and buprofezin belonging to the group 12;
Delphacidae having reduced susceptibility to one or more compounds selected from the group a2, one or more compounds selected from the group a4, and pymetrozine belonging to the group 8;
Delphacidae having reduced susceptibility to one or more compounds selected from the group a2, one or more compounds selected from the group a4, and buprofezin belonging to the group 12;
Delphacidae having reduced susceptibility to one or more compounds selected from the group a2, pymetrozine belonging to the group 8, and buprofezin belonging to the group 12;
Delphacidae having reduced susceptibility to one or more compounds selected from the group a4, pymetrozine belonging to the group 8, and buprofezin belonging to the group 12;
Delphacidae having reduced susceptibility to one or more compounds selected from the group a2, one or more compounds selected from the group a4, pymetrozine belonging to the group 8, and buprofezin belonging to the group 12;
brown planthopper, white-backed planthopper, or small brown planthopper which has reduced susceptibility to one or more compounds selected from the group a2;
brown planthopper, white-backed planthopper, or small brown planthopper which has reduced susceptibility to one or more compounds selected from the group a4;
brown planthopper, white-backed planthopper, or small brown planthopper which has reduced susceptibility to one or more compounds selected from the group a8;
brown planthopper, white-backed planthopper, or small brown planthopper which has reduced susceptibility to one or more compounds selected from the group a12;
brown planthopper, white-backed planthopper, or small brown planthopper which has reduced susceptibility to one or more compounds selected from the group a2, and one or more compounds selected from the group a4;
brown planthopper, white-backed planthopper, or small brown planthopper which has reduced susceptibility to one or more compounds selected from the group a2, and pymetrozine belonging to the group 8;
brown planthopper, white-backed planthopper, or small brown planthopper which has reduced susceptibility to one or more compounds selected from the group a2, and buprofezin belonging to the group 12;
brown planthopper, white-backed planthopper, or small brown planthopper which has reduced susceptibility to one or more compounds selected from the group a4, and pymetrozine belonging to the group 8;
brown planthopper, white-backed planthopper, or small brown planthopper which has reduced susceptibility to one or more compounds selected from the group a4, and buprofezin belonging to the group 12;
brown planthopper, white-backed planthopper, or small brown planthopper which has reduced susceptibility to one or more compounds selected from the group a2, one or more compounds selected from the group a4, and pymetrozine belonging to the group 8;
brown planthopper, white-backed planthopper, or small brown planthopper which has reduced susceptibility to one or more compounds selected from the group a2, one or more compounds selected from the group a4, and buprofezin belonging to the group 12;
brown planthopper, white-backed planthopper, or small brown planthopper which has reduced susceptibility to one or more compounds selected from the group a2, pymetrozine belonging to the group 8, and buprofezin belonging to the group 12;
brown planthopper, white-backed planthopper, or small brown planthopper which has reduced susceptibility to one or more compounds selected from the group a4, pymetrozine belonging to the group 8, and buprofezin belonging to the group 12;
brown planthopper, white-backed planthopper, or small brown planthopper which has reduced susceptibility to one or more compounds selected from the group a2, one or more compounds selected from the group a4, pymetrozine belonging to the group 8, and buprofezin belonging to the group 12;
Aphididae having reduced susceptibility to one or more compounds selected from the group a3;
Aphididae having reduced susceptibility to one or more compounds selected from the group a8;
Aphididae having reduced susceptibility to one or more compounds selected from the group a3, and one or more compounds selected from the group a4;
Aphididae having reduced susceptibility to one or more compounds selected from the group a3, and one or more compounds selected from the group a8;
Aphididae having reduced susceptibility to one or more compounds selected from the group a4, and one or more compounds selected from the group a8;
Aphididae having reduced susceptibility to one or more compounds selected from the group a3, one or more compounds selected from the group a4, and one or more compounds selected from the group a8;
green peach aphid which has reduced susceptibility to one or more compounds selected from the group a1;
cotton aphid or green peach aphid which has reduced susceptibility to one or more compounds selected from the group a3;
cotton aphid or green peach aphid which has reduced susceptibility to one or more compounds selected from the group a4;
cotton aphid or green peach aphid which has reduced susceptibility to one or more compounds selected from the group a8;
cotton aphid or green peach aphid which has reduced susceptibility to one or more compounds selected from the group a3, and one or more compounds selected from the group a4;
cotton aphid or green peach aphid which has reduced susceptibility to one or more compounds selected from the group a3, and one or more compounds selected from the group a8;
cotton aphid or green peach aphid which has reduced susceptibility to one or more compounds selected from the group a4, and one or more compounds selected from the group a8;
cotton aphid or green peach aphid which has reduced susceptibility to one or more compounds selected from the group a3, one or more compounds selected from the group a4, and one or more compounds selected from the group a8;
tobacco whitefly which has reduced susceptibility to one or more compounds selected from the group a3;
tobacco whitefly which has reduced susceptibility to one or more compounds selected from the group a4;
green peach aphid which has reduced susceptibility to one or more compounds selected from the group a1;
cotton aphid which has reduced susceptibility to carbamate compounds selected from the group a1 and/or organophosphate compounds selected from the group a1;
brown planthopper which has reduced susceptibility to malathion, chlorpyrifos, diazinon, fenobucarb, carbofuran, ethiprole, fipronil, flufiprole, etofenprox, dinotefuran, imidacloprid, nitenpyram, sulfoxaflor, thiacloprid, thiamethoxam, pymetrozine, and/or buprofezin;
white-backed planthopper which has reduced susceptibility to isoprocarb, chlorpyrifos, imidacloprid, and/or buprofezin;
Amrasca biguttula biguttula which has reduced susceptibility to imidacloprid, thiamethoxam, acetamiprid, thiacloprid, clothianidin, and/or dinotefuran;
cotton aphid which has reduced susceptibility to pirimicarb, and/or organophosphate compounds selected from the group a1;
green peach aphid which has reduced susceptibility to triazamate, pirimicarb, endosulfan, deltamethrin, lambda-cyhalothrin, DDT, and/or imidacloprid;
lettuce aphid which has reduced susceptibility to pirimicarb, methomyl, acephate, dieldrin, and/or endosulfan;
English grain aphid which has reduced susceptibility to lambda-cyhalothrin;
greenhouse whitefly which has reduced susceptibility to one or more compounds selected from the group a4, bifenthrin, and/or spiromesifen;
tobacco whitefly which has reduced susceptibility to pirimiphos-methyl, profenofos, endosulfan, fipronil, lambda-cyhalothrin, bifenthrin, alpha-cypermethrin, cartap, buprofezin, spiromesifen, chlorantraniliprole, diafenthiuron, and/or azadiractin;
citrus psylla which has reduced susceptibility to chlorpyrifos, bifenthrin, cypermethrin, acetamiprid, imidacloprid, thiamethoxam, nitenpyram, and/or chlorfenapyr;
brown stink bug which has reduced susceptibility to monocrotophos, methamidophos, acephate, endosulfan, beta-cyfluthrin, and/or imidacloprid;
Lepidoptera having reduced susceptibility to one or more compounds selected from the group a14;
Lepidoptera having reduced susceptibility to one or more compounds selected from the group a15;
Lepidoptera having reduced susceptibility to one or more compounds selected from the group a17;
Lepidoptera having reduced susceptibility to one or more compounds selected from the group a14, and one or more compounds selected from the group a17;
diamondback moth which has reduced susceptibility to one or more compounds selected from the group a15;
diamondback moth which has reduced susceptibility to one or more compounds selected from the group a17;
rice leaf roller which has reduced susceptibility to one or more compounds selected from the group a14;
rice leaf roller which has reduced susceptibility to one or more compounds selected from the group a17;
rice leaf roller which has reduced susceptibility to one or more compounds selected from the group a14, and one or more compounds selected from the group a17;
tobacco budworm which has reduced susceptibility to one or more compounds selected from the group a3;
tobacco budworm which has reduced susceptibility to one or more compounds selected from the group a9;
corn earworm which has reduced susceptibility to one or more compounds selected from the group a9;
Japanese tea tortrix which has reduced susceptibility to one or more compounds selected from the group a14;
Japanese tea tortrix which has reduced susceptibility to one or more compounds selected from the group a17;
smaller tea tortrix which has reduced susceptibility to one or more compounds selected from the group a14;
smaller tea tortrix which has reduced susceptibility to one or more compounds selected from the group a17;
smaller tea tortrix which has reduced susceptibility to one or more compounds selected from the group a14, and one or more compounds selected from the group a17;
diamondback moth which has reduced susceptibility to one or more compounds selected from the group a3;
Tuta absoluta which has reduced susceptibility to one or more compounds selected from the group a17;
rice stem borer which has reduced susceptibility to endosulfan, fipronil, and/or thiosultap-monosodium;
European corn borer which has reduced susceptibility to deltamethrin, and/or lambda-cyhalothrin;
Sugarcane borer which has reduced susceptibility to Cry1Ab, and/or Cry1Ac, which are 6-endotoxin;
eggplant fruit borer which has reduced susceptibility to profenofos, carbaryl, chlorpyrifos, endosulfan, deltamethrin, and/or fenvalerate;
cotton worm which has reduced susceptibility to profenofos, chlorpyrifos, quinalphos, phoxim, triazophos, methomyl, thiodicarb, endosulfan, fipronil, cypermethrin, deltamethrin, beta-cyfluthrin, spinosad, abamectin, emamectin-benzoate, lufenuron, diflubenzuron, methoxyfenozide, and/or indoxacarb;
beet armyworm which has reduced susceptibility to chlorpyrifos, deltamethrin, cypermethrin, spinosad, abamectin, emamectin-benzoate, lufenuron, indoxacarb, and/or methoxyfenozide;
cabbage moth which has reduced susceptibility to Cry1Ab, Cry1Ac, Cry2Ab2, Cry2Ae, and/or Cry1F, which are δ-endotoxin;
tobacco budworm which has reduced susceptibility to sulprofos, profenofos, monocrotophos, parathion-methyl, thiodicarb, methomyl, toxaphene, endosulfan, cypermethrin, deltamethrin, DDT, and/or spinosad;
tobacco budworm which has reduced susceptibility to monocrotophos, chlorpyrifos, profenofos, methomyl, thiodicarb, toxaphene, endosulfan, fenvalerate, deltamethrin, cypermethrin, DDT, indoxacarb, and/or chlorantraniliprole;
corn earworm which has reduced susceptibility to parathion-methyl, cypermethrin, endosulfan, and/or DDT;
codling moth which has reduced susceptibility to lambda-cyhalothrin, thiacloprid, and/or methoxyfenozide;
European grapevine moth which has reduced susceptibility to deltamethrin, and/or indoxacarb;
diamondback moth which has reduced susceptibility to methomyl, dieldrin, permethrin, fipronil, spinosad, abamectin, emamectin-benzoate, Cry1C, which is δ-endotoxin, lufenuron, indoxacarb, chlorantraniliprole, flubendiamide, and/or diafenthiuron;
Thysanoptera having reduced susceptibility to one or more compounds selected from the group a2;
Thysanoptera having reduced susceptibility to one or more compounds selected from the group a3;
Thysanoptera having reduced susceptibility to one or more compounds selected from the group a4;
Thysanoptera having reduced susceptibility to one or more compounds selected from the group a9;
Thysanoptera having reduced susceptibility to one or more compounds selected from the group a17;
onion thrips which has reduced susceptibility to one or more compounds selected from the group a3;
onion thrips which has reduced susceptibility to profenofos, chlorpyrifos, deltamethrin and/or lambda-cyhalothrin;
western flower thrips which has reduced susceptibility to methiocarb, methomyl, bendiocarb, formetanate, carbofuran, malathion, chlorpyrifos, diazinon, methamidophos, dimethoate, dichlorvos, acephate, methidathion, toxaphene, endosulfan, fipronil, acrinathrin, alpha-cypermethrin, bifenthrin, deltamethrin, esfenvalerate, permethrin, tau-fluvalinate, cypermethrin, fenvalerate, cyfluthrin, imidacloprid, spinosad, spinetoram, abamectin, pyriproxyfen, and/or cyantraniliprole;
Diptera having reduced susceptibility to one or more compounds selected from the group a2;
Diptera having reduced susceptibility to one or more compounds selected from the group a3;
Diptera having reduced susceptibility to one or more compounds selected from the group a4;
Diptera having reduced susceptibility to one or more compounds selected from the group a9;
Diptera having reduced susceptibility to one or more compounds selected from the group a17;
tomato leaf miner which has reduced susceptibility to permethrin, and/or fenvalerate;
chrysanthemum leaf miner which has reduced susceptibility to methamidophos, parathion-methyl, pyrazophos, demeton, chlorpyrifos, triazophos, permethrin, cypermethrin, DDT, spinosad, abamectin, and/or cyromazine;
Coleoptera having reduced susceptibility to one or more compounds selected from the group a2;
Coleoptera having reduced susceptibility to one or more compounds selected from the group a3;
Coleoptera having reduced susceptibility to one or more compounds selected from the group a4;
Coleoptera having reduced susceptibility to one or more compounds selected from the group a9;
Coleoptera having reduced susceptibility to one or more compounds selected from the group a17;
Coleoptera having reduced susceptibility to one or more compounds selected from the group a2, and one or more compounds selected from the group a4;
Chrysomelidae having reduced susceptibility to one or more compounds selected from the group a2;
Chrysomelidae having reduced susceptibility to one or more compounds selected from the group a3;
Chrysomelidae having reduced susceptibility to one or more compounds selected from the group a4;
Chrysomelidae having reduced susceptibility to one or more compounds selected from the group a9;
Chrysomelidae having reduced susceptibility to one or more compounds selected from the group a17;
Chrysomelidae having reduced susceptibility to one or more compounds selected from the group a2, and one or more compounds selected from the group a4;
rice leaf beetle which has reduced susceptibility to one or more compounds selected from the group a2;
rice leaf beetle which has reduced susceptibility to one or more compounds selected from the group a4;
rice leaf beetle which has reduced susceptibility to one or more compounds selected from the group a2, and one or more compounds selected from the group a4;
Diabrotica spp. having reduced susceptibility to one or more compounds selected from the group a2;
Diabrotica spp. having reduced susceptibility to one or more compounds selected from the group a3;
Diabrotica spp. having reduced susceptibility to one or more compounds selected from the group a4;
Diabrotica spp. having reduced susceptibility to one or more compounds selected from the group a9;
Diabrotica spp. having reduced susceptibility to one or more compounds selected from the group a17;
western corn rootworm which has reduced susceptibility to one or more compounds selected from the group a2;
western corn rootworm which has reduced susceptibility to one or more compounds selected from the group a3;
western corn rootworm which has reduced susceptibility to one or more compounds selected from the group a4;
western corn rootworm which has reduced susceptibility to one or more compounds selected from the group a9;
western corn rootworm which has reduced susceptibility to one or more compounds selected from the group a17;
western corn rootworm which has reduced susceptibility to one or more compounds selected from the group a2;
western corn rootworm which has reduced susceptibility to one or more compounds selected from the group a3;
southern corn rootworm which has reduced susceptibility to one or more compounds selected from the group a4;
southern corn rootworm which has reduced susceptibility to one or more compounds selected from the group a9;
southern corn rootworm which has reduced susceptibility to one or more compounds selected from the group a17;
northern corn rootworm which has reduced susceptibility to one or more compounds selected from the group a2;
northern corn rootworm which has reduced susceptibility to one or more compounds selected from the group a3;
northern corn rootworm which has reduced susceptibility to one or more compounds selected from the group a4;
northern corn rootworm which has reduced susceptibility to one or more compounds selected from the group a9;
northern corn rootworm which has reduced susceptibility to one or more compounds selected from the group a17;
cucurbit beetle which has reduced susceptibility to one or more compounds selected from the group a2;
cucurbit beetle which has reduced susceptibility to one or more compounds selected from the group a3;
cucurbit beetle which has reduced susceptibility to one or more compounds selected from the group a4;
cucurbit beetle which has reduced susceptibility to one or more compounds selected from the group a9;
cucurbit beetle which has reduced susceptibility to one or more compounds selected from the group a17;
Colorado potato beetle which has reduced susceptibility to one or more compounds selected from the group a2;
Colorado potato beetle which has reduced susceptibility to one or more compounds selected from the group a3;
Colorado potato beetle which has reduced susceptibility to one or more compounds selected from the group a4;
Colorado potato beetle which has reduced susceptibility to one or more compounds selected from the group a11;
Colorado potato beetle which has reduced susceptibility to one or more compounds selected from the group a17;
striped flea beetle which has reduced susceptibility to one or more compounds selected from the group a3;
striped flea beetle which has reduced susceptibility to one or more compounds selected from the group a4;
striped flea beetle which has reduced susceptibility to one or more compounds selected from the group a17;
cabbage flea beetle which has reduced susceptibility to one or more compounds selected from the group a3;
cabbage flea beetle which has reduced susceptibility to one or more compounds selected from the group a4;
cabbage flea beetle which has reduced susceptibility to one or more compounds selected from the group a17;
western black flea beetle which has reduced susceptibility to one or more compounds selected from the group a3;
western black flea beetle which has reduced susceptibility to one or more compounds selected from the group a4;
western black flea beetle which has reduced susceptibility to one or more compounds selected from the group a17;
cabbage stem flea beetle which has reduced susceptibility to one or more compounds selected from the group a3;
cabbage stem flea beetle which has reduced susceptibility to one or more compounds selected from the group a4;
cabbage stem flea beetle which has reduced susceptibility to one or more compounds selected from the group a17;
hop flea beetle which has reduced susceptibility to one or more compounds selected from the group a3;
hop flea beetle which has reduced susceptibility to one or more compounds selected from the group a4;
hop flea beetle which has reduced susceptibility to one or more compounds selected from the group a17;
Curculionidae having reduced susceptibility to one or more compounds selected from the group a2;
Curculionidae having reduced susceptibility to one or more compounds selected from the group a4;
Curculionidae having reduced susceptibility to one or more compounds selected from the group a2, and one or more compounds selected from the group a4;
rice water weevil which has reduced susceptibility to one or more compounds selected from the group a2;
rice water weevil which has reduced susceptibility to one or more compounds selected from the group a4;
rice water weevil which has reduced susceptibility to one or more compounds selected from the group a2, and one or more compounds selected from the group a4;
Elateridae having reduced susceptibility to one or more compounds selected from the group a2;
Elateridae having reduced susceptibility to one or more compounds selected from the group a3;
Elateridae having reduced susceptibility to one or more compounds selected from the group a4;
Okinawakansyakushikometsuki which has reduced susceptibility to one or more compounds selected from the group a2;
Okinawakansyakushikometsuki which has reduced susceptibility to one or more compounds selected from the group a3;
Okinawakansyakushikometsuki which has reduced susceptibility to one or more compounds selected from the group a4;
barley wireworm which has reduced susceptibility to one or more compounds selected from the group a2;
barley wireworm which has reduced susceptibility to one or more compounds selected from the group a3;
barley wireworm which has reduced susceptibility to one or more compounds selected from the group a4;
Kushikometsuki which has reduced susceptibility to one or more compounds selected from the group a2;
Kushikometsuki which has reduced susceptibility to one or more compounds selected from the group a3;
Kushikometsuki which has reduced susceptibility to one or more compounds selected from the group a4;
Anchastus spp. having reduced susceptibility to one or more compounds selected from the group a2;
Anchastus spp. having reduced susceptibility to one or more compounds selected from the group a3;
Anchastus spp. having reduced susceptibility to one or more compounds selected from the group a4;
Conoderus spp. having reduced susceptibility to one or more compounds selected from the group a2;
Conoderus spp. having reduced susceptibility to one or more compounds selected from the group a3;
Conoderus spp. having reduced susceptibility to one or more compounds selected from the group a4;
Ctenicera spp. having reduced susceptibility to one or more compounds selected from the group a2;
Ctenicera spp. having reduced susceptibility to one or more compounds selected from the group a3;
Ctenicera spp. having reduced susceptibility to one or more compounds selected from the group a4;
Limonius spp. having reduced susceptibility to one or more compounds selected from the group a2;
Limonius spp. having reduced susceptibility to one or more compounds selected from the group a3;
Limonius spp. having reduced susceptibility to one or more compounds selected from the group a4;
Aeolus spp. having reduced susceptibility to one or more compounds selected from the group a2;
Aeolus spp. having reduced susceptibility to one or more compounds selected from the group a3;
Aeolus spp. having reduced susceptibility to one or more compounds selected from the group a4;
cabbage stem flea beetle which has reduced susceptibility to lambda-cyhalothrin;
Colorado potato beetle which has reduced susceptibility to carbosulfan, carbofuran, phosalone, chlorpyrifos, azinphos-methyl, cyhalothrin, lambda-cyhalothrin, deltamethrin, permethrin, imidacloprid, dinotefuran, clothianidin, thiacloprid, thiamethoxam, and/or nitenpyram;
blossom beetle which has reduced susceptibility to phosalone, lambda-cyhalothrin, cypermethrin, alpha-cypermethrin, zeta-cypermethrin, bifenthrin, beta-cyfluthrin, deltamethrin, esfenvalerate, tau-fluvalinate, and/or acetamiprid;
Acari having reduced susceptibility to one or more compounds selected from the group a2;
Acari having reduced susceptibility to one or more compounds selected from the group a3;
Acari having reduced susceptibility to one or more compounds selected from the group a4;
Acari having reduced susceptibility to one or more compounds selected from the group a9;
Acari having reduced susceptibility to one or more compounds selected from the group a17;
common red spider mite which has reduced susceptibility to one or more compounds selected from the group a19, bifenthrin, abamectin, milbemectin, acequinocyl and/or bifenazate;
fruit-tree red spider mite which has reduced susceptibility to fenpropathrin, spirodiclofen, clofentezine, hexythiazox, pyridaben, and/or fenpyroximate;
common bed bug which has reduced susceptibility to one or more compounds selected from the group a1;
common bed bug which has reduced susceptibility to one or more compounds selected from the group a2;
common bed bug which has reduced susceptibility to one or more compounds selected from the group a3;
common bed bug which has reduced susceptibility to one or more compounds selected from the group a4;
common bed bug which has reduced susceptibility to one or more compounds selected from the group a5;
common bed bug which has reduced susceptibility to one or more compounds selected from the group a10;
common bed bug which has reduced susceptibility to bendiocarb, diazinon, dichlorvos, fenitrothion, fenobucarb, malathion, propoxur, dieldrin, fipronil, allethrin, bifenthrin, cyfluthrin, beta-cyfluthrin, lambda-cyhalothrin, cypermethrin, alpha-cypermethrin, deltamethrin, esfenvalerate, etofenprox, permethrin, phenothrin, pyrethrin, tetramethrin, DDT, acetamiprid, dinotefuran, imidacloprid, thiamethoxam, spinosad, and/or chlorfenapyr;
tropical bed bug which has reduced susceptibility to one or more compounds selected from the group a1;
tropical bed bug which has reduced susceptibility to one or more compounds selected from the group a2;
tropical bed bug which has reduced susceptibility to one or more compounds selected from the group a3;
tropical bed bug which has reduced susceptibility to one or more compounds selected from the group a4;
tropical bed bug which has reduced susceptibility to one or more compounds selected from the group a10;
tropical bed bug which has reduced susceptibility to bendiocarb, diazinon, fenitrothion, fenobucarb, malathion, propoxur, dieldrin, fipronil, allethrin, bifenthrin, cyfluthrin, lambda-cyhalothrin, cypermethrin, alpha-cypermethrin, deltamethrin, esfenvalerate, etofenprox, permethrin, DDT, imidacloprid, and/or chlorfenapyr;
house fly which has reduced susceptibility to one or more compounds selected from the group a1;
house fly which has reduced susceptibility to one or more compounds selected from the group a2;
house fly which has reduced susceptibility to one or more compounds selected from the group a3;
house fly which has reduced susceptibility to one or more compounds selected from the group a4;
house fly which has reduced susceptibility to one or more compounds selected from the group a5;
house fly which has reduced susceptibility to one or more compounds selected from the group a6;
house fly which has reduced susceptibility to one or more compounds selected from the group a7;
house fly which has reduced susceptibility to one or more compounds selected from the group a11;
house fly which has reduced susceptibility to one or more compounds selected from the group a12;
house fly which has reduced susceptibility to one or more compounds selected from the group a13;
house fly which has reduced susceptibility to one or more compounds selected from the group a14;
house fly which has reduced susceptibility to one or more compounds selected from the group a15;
house fly which has reduced susceptibility to azamethiphos, azinphos-methyl, chlorpyrifos, chlorpyrifos-methyl, diazinon, dichlorvos, dimethoate, fenchlorphos, fenitrothion, methomyl, methoxychlor, naled, parathion-methyl, phoxim, profenofos, propoxur, tetrachlorvinphos, triazophos, trichlorfon, dieldrin, endosulfan, fipronil, bifenthrin, cyfluthrin, beta-cyfluthrin, lambda-cyhalothrin, cypermethrin, beta-cypermethrin, cyphenothrin, deltamethrin, esfenvalerate, phenothrin, pyrethrin, resmethrin, DDT, acetamiprid, dinotefuran, imidacloprid, nitenpyram, thiamethoxam, spinosad, abamectin, emamectin-benzoate, methoprene, pyriproxyfen, cartap, diflubenzuron, lufenuron, triflumuron, cyromazine, methoxyfenozide, and/or indoxacarb;
Simulium damnosum which has reduced susceptibility to one or more compounds selected from the group a1;
Simulium damnosum which has reduced susceptibility to one or more compounds selected from the group a3;
Akaieka which has reduced susceptibility to one or more compounds selected from the group a2;
Akaieka which has reduced susceptibility to one or more compounds selected from the group a3;
Akaieka which has reduced susceptibility to bifenthrin, beta-cyfluthrin, lambda-cyhalothrin, cypermethrin, deltamethrin, permethrin, and/or resmethrin;
Chikaieka which has reduced susceptibility to one or more compounds selected from the group a3;
Chikaieka which has reduced susceptibility to deltamethrin, etofenprox, permethrin, and/or phenothrin;
brown house mosquito which has reduced susceptibility to one or more compounds selected from the group a1;
brown house mosquito which has reduced susceptibility to one or more compounds selected from the group a3;
brown house mosquito which has reduced susceptibility to temephos, bifenthrin, beta-cyfluthrin, lambda-cyhalothrin, cypermethrin, deltamethrin, permethrin, and/or resmethrin;
dengue mosquito which has reduced susceptibility to one or more compounds selected from the group a1;
dengue mosquito which has reduced susceptibility to one or more compounds selected from the group a3;
dengue mosquito which has reduced susceptibility to one or more compounds selected from the group a7;
dengue mosquito which has reduced susceptibility to one or more compounds selected from the group a9;
dengue mosquito which has reduced susceptibility to chlorpyrifos, dichlorvos, fenitrothion, fenthion, malathion, pirimiphos-methyl, propoxur, temephos, allethrin, bifenthrin, cyfluthrin, lambda-cyhalothrin, cypermethrin, alpha-cypermethrin, deltamethrin, etofenprox, permethrin, phenothrin, DDT, and/or Methoprene;
dengue mosquito which has reduced susceptibility to Cry4A and Cry4B, which are 6-endotoxin;
Ganbiehamadaraka which has reduced susceptibility to one or more compounds selected from the group a1;
Ganbiehamadaraka which has reduced susceptibility to one or more compounds selected from the group a2;
Ganbiehamadaraka which has reduced susceptibility to one or more compounds selected from the group a3;
Ganbiehamadaraka which has reduced susceptibility to bendiocarb, fenitrothion, pirimiphos-methyl, dieldrin, lambda-cyhalothrin, deltamethrin, permethrin, and/or DDT;
Anopheles coluzzii which has reduced susceptibility to one or more compounds selected from the group a1;
Anopheles coluzzii which has reduced susceptibility to one or more compounds selected from the group a2;
Anopheles coluzzii which has reduced susceptibility to one or more compounds selected from the group a3;
Anopheles coluzzii which has reduced susceptibility to bendiocarb, fenitrothion, dieldrin, lambda-cyhalothrin, deltamethrin, permethrin, and/or DDT;
Anopheles arabiensis which has reduced susceptibility to one or more compounds selected from the group a1;
Anopheles arabiensis which has reduced susceptibility to one or more compounds selected from the group a2;
Anopheles arabiensis which has reduced susceptibility to one or more compounds selected from the group a3;
Anopheles arabiensis which has reduced susceptibility to bendiocarb, malathion, dieldrin, lambda-cyhalothrin, deltamethrin, permethrin, and/or DDT;
Anopheles funestus which has reduced susceptibility to one or more compounds selected from the group a2;
Anopheles funestus which has reduced susceptibility to one or more compounds selected from the group a3;
Anopheles funestus which has reduced susceptibility to dieldrin, lambda-cyhalothrin, deltamethrin, permethrin, and/or DDT;
red meal beetle which has reduced susceptibility to one or more compounds selected from the group a1;
red meal beetle which has reduced susceptibility to one or more compounds selected from the group a3;
red meal beetle which has reduced susceptibility to one or more compounds selected from the group a5;
red meal beetle which has reduced susceptibility to one or more compounds selected from the group a21;
red meal beetle which has reduced susceptibility to carbaryl, chlorpyrifos, chlorpyrifos-methyl, cyanophos, diazinon, dichlorvos, fenitrothion, malathion, phoxim, pirimiphos-methyl, promecarb, propoxur, temephos, tetrachlorvinphos, bioresmethrin, cyfluthrin, cyhalothrin, cypermethrin, deltamethrin, permethrin, phenothrin, pyrethrin, DDT, spinosad, and/or phosphine;
German cockroach which has reduced susceptibility to one or more compounds selected from the group a1;
German cockroach which has reduced susceptibility to one or more compounds selected from the group a2;
German cockroach which has reduced susceptibility to one or more compounds selected from the group a3;
German cockroach which has reduced susceptibility to one or more compounds selected from the group a4;
German cockroach which has reduced susceptibility to one or more compounds selected from the group a6;
German cockroach which has reduced susceptibility to chlorpyrifos, malathion, propoxur, fipronil, beta-cyfluthrin, cypermethrin, deltamethrin, permethrin, pyrethrin, DDT, imidacloprid, and/or abamectin;
cat flea which has reduced susceptibility to one or more compounds selected from the group a1;
cat flea which has reduced susceptibility to one or more compounds selected from the group a2;
cat flea which has reduced susceptibility to one or more compounds selected from the group a3;
cat flea which has reduced susceptibility to one or more compounds selected from the group a4;
cat flea which has reduced susceptibility to one or more compounds selected from the group a5;
cat flea which has reduced susceptibility to bendiocarb, carbaryl, chlorfenvinphos, chlorpyrifos, diazinon, fenthion, isofenphos, propetamphos, propoxur, malathion, fipronil, cyfluthrin, cypermethrin, fluvalinate, permethrin, pyrethrin, imidacloprid, and/or Spinosad; American dog tick which has reduced susceptibility to one or more compounds selected from the group a3;
American dog tick which has reduced susceptibility to DDT;
Oushimadani which has reduced susceptibility to one or more compounds selected from the group a1;
Oushimadani which has reduced susceptibility to one or more compounds selected from the group a2;
Oushimadani which has reduced susceptibility to one or more compounds selected from the group a3;
Oushimadani which has reduced susceptibility to one or more compounds selected from the group a6;
Oushimadani which has reduced susceptibility to one or more compounds selected from the group a20;
Oushimadani which has reduced susceptibility to carbaryl, chlorpyrifos, coumaphos, fipronil, pyriprole, cypermethrin, deltamethrin, flumethrin, permethrin, ivermectin, and/or amitraz; brown dog tick which has reduced susceptibility to one or more compounds selected from the group a1;
brown dog tick which has reduced susceptibility to one or more compounds selected from the group a3;
brown dog tick which has reduced susceptibility to one or more compounds selected from the group a20;
brown dog tick which has reduced susceptibility to permethrin, and/or amitraz;

Examples of pest arthropods such as pest insects and pest mites, pest mollusks and pest nematodes which have reduced susceptibility due to amino acid substitutions in target proteins include the following.
cotton aphid which has an amino acid substitution of R81T in the β-subunit of the nicotinic acetylcholine receptor;
green peach aphid which has an amino acid substitution of R81T in the β-subunit of the nicotinic acetylcholine receptor;
diamondback moth which has an amino acid substitution of G4946E in the ryanodine receptor;
diamondback moth which has an amino acid substitution of F1845Y or V18481 in the sodium channel;
white-backed planthopper which has an amino acid substitution of A2′N in the GABA-gated chloride channel;
cotton aphid which has amino acid substitutions of S431F, and/or A302S in the acetylcholinesterase;
tobacco whitefly which has amino acid substitutions of L925I, and/or T929V in the voltage-dependent sodium channel; green peach aphid which has an amino acid substitution of S431F in the acetylcholinesterase;
green peach aphid which has amino acid substitutions of L1014F, M918T, and/or TL932F in the voltage-dependent sodium channel;
green peach aphid which has amino acid substitutions of A302S, and/or A302G in the GABA-gated chloride channel;
western flower thrips which has amino acid substitutions of L1014F, and/or M918T in the voltage-dependent sodium channel;
western flower thrips which has an amino acid substitution of G275E in the a6-subunit of the nicotinic acetylcholine receptor;
corn earworm which has amino acid substitutions of L1029H, V421M, V421A, V421G and/or 1951V in the voltage-dependent sodium channel;
tobacco budworm which has amino acid substitutions of L1029H, D1561V, E1565G, and/or V421M in the voltage-dependent sodium channel;
Colorado potato beetle which has amino acid substitutions of R30K, S291G, and/or 1392T in the acetylcholinesterase;
Colorado potato beetle which has an amino acid substitution of L1014F in the voltage-dependent sodium channel;
white-backed planthopper which has an amino acid substitution of S298P in the type 1 of the acetylcholinesterase;
common red spider mite which has an amino acid substitution of G323D in the GluC11-subunit of the glutamate receptor;
common red spider mite which has an amino acid substitution of G326E in the GluC13-subunit of the glutamate receptor;
onion thrips which has amino acid substitutions of M918T, M918L, T9291, V1010A, and/or L1014F in the voltage-dependent sodium channel;
greenhouse whitefly which has amino acid substitutions of L925I, and/or T9291 in the voltage-dependent sodium channel;
Tuta absoluta which has amino acid substitutions of G4903V, G4903E, 14746T, and/or 14746M in the ryanodine receptor;
brown planthopper which has an amino acid substitution of A301S in the GABA-gated chloride channel;
brown planthopper which has an amino acid substitution of Y151S in the a1 and a3-subunits of the nicotinic acetylcholine receptor;
European corn borer which has an amino acid substitution of L1014F in the voltage-dependent sodium channel;
fruit-tree red spider mite which has an amino acid substitution of F15381 in the voltage-dependent sodium channel;
cabbage stem flea beetle which has an amino acid substitution of L1014F in the voltage-dependent sodium channel;
English grain aphid which has an amino acid substitution of L1014F in the voltage-dependent sodium channel;
diamondback moth which has amino acid substitutions of A282S, A282G, and/or A302S in the GABA-gated chloride channel;
diamondback moth which has amino acid substitutions of M9181, T9291, and/or L1014F in the voltage-dependent sodium channel;
common bed bug which has amino acid substitutions of V419L, L925I, and/or 1936F in the α-subunit of the voltage-dependent sodium channel;
house fly which has amino acid substitutions of V180L, V260L, G262A, G262V, G342A, G342V, G365A, F327Y, F407Y, and/or G445A in the acetylcholinesterase;
house fly which has amino acid substitutions of M918T, L1014F and/or L1014H in the α-subunit of the voltage-dependent sodium channel;
house fly which has an amino acid substitution of A302S in the GABA-gated chloride channel; Akaieka which has amino acid substitutions of L1014F, and/or L1014S in the voltage-dependent sodium channel;
Akaieka which has an amino acid substitution of A302S in the GABA-gated chloride channel; Chikaieka which has amino acid substitutions of L1014F, and/or L1014S in the voltage-dependent sodium channel;
brown house mosquito which has amino acid substitutions of L1014F, and/or L1014S in the voltage-dependent sodium channel;
brown house mosquito which has an amino acid substitution of G119S in the acetylcholinesterase;
dengue mosquito which has amino acid substitutions of V410L, G923V, L982W, S989P, I1011M, I1011V, V10161, V1016G, T1520I, F1534C, and/or D1763Y in the voltage-dependent sodium channel;
Ganbiehamadaraka which has amino acid substitutions of L1014S, and/or N1575Y in the voltage-dependent sodium channel;
Ganbiehamadaraka which has an amino acid substitution of G119S in the acetylcholinesterase;
Anopheles coluzzii which has amino acid substitutions of L1014F, and/or N1575Y in the voltage-dependent sodium channel;
Anopheles arabiensis which has an amino acid substitution of L1014F in the voltage-dependent sodium channel; Anopheles funestus which has amino acid substitutions of A296S, and V3271 in the GABA-gated chloride channel;
red meal beetle which has an amino acid substitution of A302S in the GABA-gated chloride channel;
German cockroach which has amino acid substitutions of D58G, E434K, C764R, L933F, and/or P1880L in the voltage-dependent sodium channel;
German cockroach which has an amino acid substitution of A302S in the GABA-gated chloride channel;
cat flea which has amino acid substitutions of T929V, and/or L1014F in the voltage-dependent sodium channel;
cat flea which has an amino acid substitution of A302S in the GABA-gated chloride channel;
Oushimadani which has amino acid substitutions of C190A, and/or F15501 in the voltage-dependent sodium channel.

Examples of pest arthropods such as pest insects and pest mites, pest mollusks and pest nematodes which have reduced susceptibility due to decrease of a target protein include the following.
house fly in which the expression level of the a2 subunit of the nicotinic acetylcholine receptor has decreased.

Examples of factors that increase the activity of metabolic enzymes include overexpression of metabolic enzyme genes (also referred to as quantitative variation) and improvement of affinity for drugs due to amino acid substitutions in metabolic enzymes (also referred to as qualitative variation). It is possible to have one or a plurality of factors that increase the activity of metabolic enzymes.

Examples of pest arthropods such as pest insects and pest mites, pest mollusks and pest nematodes the activity of metabolic enzymes of which have increased due to overexpression of metabolic enzyme genes include the following.
brown planthopper overexpressing CYP6ER1 (a kind of cytochrome P450 genes);
Amrasca biguttula biguttula overexpressing the glutathione-S-transferase gene;
cotton aphid overexpressing the cytochrome P450 monooxygenase gene;
tobacco whitefly overexpressing CYP6CM1 (a kind of cytochrome P450-dependent monooxygenase genes);
tobacco whitefly overexpressing the cytochrome P450-dependent monooxygenase gene; rice stem borer overexpressing the carboxylesterase gene, and/or the microsomal-O-demethylase gene;
codling moth overexpressing the glutathion-S-transferase gene, and/or cytochrome P450 monooxygenase gene;
Sugarcane borer underexpressing three kinds of aminopeptidases N genes (DsAPN1, DsAPN2, and DsAPN3) and/or DsCAD1 (a kind of cadherin genes);
chrysanthemum leaf miner overexpressing the cytochrome P450 gene; blossom beetle overexpressing the cytochrome P450 gene;
green peach aphid overexpressing CYP6CY3 (a kind of cytochrome P450 genes);
green peach aphid overexpressing the E4 gene, which is a kind of carboxylesterases, and/or the FE4 gene, which is a kind of carboxylesterases;
lettuce aphid overexpressing the esterase gene;
lettuce aphid overexpressing the glutathione S-transferases gene;
brown stink bug overexpressing the esterase gene;
brown stink bug overexpressing the EST-2 gene, which is a kind of cholinesterase and/or the EST-4 gene, which is a kind of cholinesterase;
western flower thrips overexpressing the esterase gene;
western flower thrips overexpressing the cytochrome P450 monooxygenase gene;
western flower thrips overexpressing the glutathione S-transferases gene;
tobacco budworm overexpressing CYP337B3 (a kind of cytochrome P450 genes);
tobacco budworm overexpressing the cytochrome P450 monooxygenases gene;
tobacco budworm overexpressing the glutathione S-transferases gene;
tobacco budworm overexpressing the esterase gene;
tobacco budworm overexpressing the glutathione-S-transferase gene;
tobacco budworm overexpressing the esterase gene;
tobacco budworm overexpressing the cytochrome P450 gene;
Colorado potato beetle overexpressing the glutathione-S-transferase gene;
Colorado potato beetle overexpressing the esterase gene;
Colorado potato beetle overexpressing the cytochrome P450 gene;
common red spider mite overexpressing TuGSTd14 (a kind of glutathione-S-transferase genes);
greenhouse whitefly overexpressing CYP6CM1 (a kind of cytochrome P450 genes);
red meal beetle overexpressing the cytochrome P450 gene;
brown planthopper underexpressing CYP6AY1 (a kind of cytochrome P450 genes) brown planthopper overexpressing the carboxylesterase gene;
brown planthopper overexpressing the NI-EST1 gene, which is a kind of carboxylesterases;
brown planthopper overexpressing the CYP6ER1, CYP6AY1, and/or CYP6FU1 (a kind of cytochrome P450 genes);
European corn borer overexpressing the cytochrome P450 monooxygenase gene;
European corn borer overexpressing the glutathion-S-transferase gene;
fruit-tree red spider mite overexpressing the cytochrome P450-dependent monooxygenase gene;
cabbage stem flea beetle overexpressing the cytochrome P450 gene;
common bed bug overexpressing CYP397A1, CYP398A1, CYP6DN1, CYP4CM1, and/or CYP400A1 (all of them are a kind of cytochrome P450 genes);
common bed bug overexpressing CE3959, and/or CE21331 (both of them are a kind of carboxylesterase genes);
common bed bug overexpressing S1 (a kind of glutathione-S-transferase genes);
house fly overexpressing CYP6A1, CYP6A5v1, CYP6A5v2, CYP6A36, CYP6A40, CYP6D1, CYP6D1v1, CYP6D3, CYP6D8, CYP6G2, and/or CYP6G4 (all of them are a kind of cytochrome P450 genes);
brown house mosquito overexpressing CYP9M10, CYP6AA7 and/or CYP4H34 (all of them are a kind of cytochrome P450 genes);
dengue mosquito overexpressing the esterase gene;
dengue mosquito overexpressing the glutathione-S-transferase gene;
dengue mosquito overexpressing CYP4D24, CYP6BB2, CYP6F3, CYP6M11, CYP6N12, and/or CYP9M6 (all of them are a kind of cytochrome P450 genes);
dengue mosquito overexpressing the carboxylesterase gene;
Ganbiehamadaraka overexpressing CYP4P16, CYP4P17, CYP6P3, CYP6Z1, CYP12F1, and/or CYP325A3 (all of them are a kind of cytochrome P450 genes);
Ganbiehamadaraka overexpressing GSTE2 (a kind of glutathione-S-transferase genes);
Ganbiehamadaraka overexpressing PX13A, and/or PX13B (both of them are a kind of peroxidase genes);
Ganbiehamadaraka overexpressing the esterase genes;
Anopheles arabiensis overexpressing CYP6P4 (a kind of cytochrome P450 genes);
Anopheles arabiensis overexpressing the carboxylesterase gene;
Anopheles arabiensis overexpressing the beta-esterases gene;
Anopheles funestus overexpressing CYP6P4, and/or CYP6P9 (both of them are a kind of cytochrome P450 genes);
red meal beetle overexpressing CYP6BQ9 (a kind of cytochrome P450 genes);
red meal beetle overexpressing the glutathione-S-transferase gene;
red meal beetle overexpressing Epsilon (a kind of glutathione-S-transferase genes)
German cockroach overexpressing the CYP4G19 (a kind of cytochrome P450 genes).

Examples of pest arthropods such as pest insects and pest mites, pest mollusks and pest nematodes the activity of metabolic enzymes of which have increased by improvement of affinity for drugs due to amino acid substitutions in metabolic enzymes include the following.
brown planthopper which has CYP6ER1vA (a kind of variants of CYP6ER1) having amino acid substitutions of T318S, A375A and A376G;
brown planthopper which has CYP6ER1vB (a kind of variants of CYP6ER1) having amino acid substitutions of T318S and A377A;
house fly which has the carboxyesterase having amino acid substitutions of W251L, and/or W251S;
red meal beetle which has the dihydrolipoamide dehydrogenase having amino acid substitutions of P45S, and/or G131S;

Examples of pest arthropods such as pest insects and pest mites, pest mollusks and pest nematodes which have a plurality of factors that increase the activity of metabolic enzymes include brown planthopper which has reduced susceptibility to imidacloprid by having CYP6ER1vA and CYP6ER1vB in addition to overexpressing CYP6ER1.

Examples of pest arthropods such as pest insects and pest mites, pest mollusks and pest nematodes which have reduced susceptibility due to decrease of skin permeability include the following. tobacco budworm which has reduced susceptibility to pyrethroids (e.g., cypermethrin, esfenvalerate etc.) due to reduced cuticular penetration of drugs;
common bed bug which has reduced susceptibility to pyrethroids (beta-cyfluthrin etc.) due to overexpression of C2, C10, and/or C13 (all of them are a kind of presumptive epidermal protein genes).

Examples of pest arthropods such as pest insects and pest mites, pest mollusks and pest nematodes which have reduced susceptibility due to enhancement of elimination function by membrane transporters include the following.
common bed bug overexpressing Abc8, Abc9, Abc10 and/or Abc11, which are ABC transporter genes.

The present compound and the composition A can also be used to protect plants from plant diseases caused by insect-borne viruses or insect-borne bacteria.

Examples of the insect-borne viruses include the following.

Rice tungro spherical virus, Rice tungro bacilliform virus, Rice grassy stunt virus, Rice ragged stunt virus, Rice stripe virus, Rice black streaked dwarf virus, Southern rice black-streaked dwarf virus, Rice gall dwarf virus, Rice hoja blanca virus, Rice yellow stunt virus, Rice yellow mottle virus, Rice dwarf virus, Northern cereal mosaic virus, Barley yellow dwarf virus, Barley mild mosaic virus, Barley yellow dwarf virus-PAV, Cereal yellow dwarf virus-RPS, Wheat yellow leaf virus, Oat sterile dwarf virus, Wheat streak mosaic virus, Maize dwarf mosaic virus, Maize stripe virus, Maize chlorotic mottle virus, Maize chlorotic dwarf virus, Maize rayado fino virus, Sugarcane mosaic virus, Fiji disease virus, Sugarcane yellow leaf virus, Soybean mild mosaic virus, Cycas necrotic stunt virus, Soybean dwarf virus, Milk vetch dwarf virus, Soybean mosaic virus, Alfalfa mosaic virus, Bean yellow mosaic virus, Bean common mosaic virus, Southern bean mosaic virus, Peanut stunt virus, Broad bean wilt virus 1, Broad bean wilt virus 2, Broad bean necrosis virus, Broad bean yellow vein virus, Clover yellow vein virus, Peanut mottle virus, Tobacco streak virus, Bean pod mottle virus, Cowpea chlorotic mottle virus, Mung bean yellow mosaic virus, Soybean crinkle leaf virus, Tomato chlorosis virus, Tomato spotted wilt virus, Tomato yellow leaf curl virus, Tomato aspermy virus, Tomato infectious chlorosis virus, Potato leafroll virus, Potato virus Y, Melon yellow spot virus, Melon necrotic spot virus, Watermelon mosaic virus, Cucumber mosaic virus, Zucchini yellow mosaic virus, Turnip mosaic virus, Turnip yellow mosaic virus, Cauliflower mosaic virus, Lettuce mosaic virus, Celery mosaic virus, Beet mosaic virus, Cucurbit chlorotic yellows virus, Capsicum chlorosis virus, Beet pseudo yellows virus, Leak yellow stripe virus, Onion yellow dwarf virus, Sweet potato feathery mottle virus, Sweet potato shukuyo mosaic virus, Strawberry mottle virus, Strawberry mild yellow edge virus, Strawberry pseudo mild yellow edge virus, Strawberry crinkle virus, Strawberry vein banding virus, plum pox virus, Chrysanthemum stem necrosis virus, Impatiens necrotic spot virus, Iris yellow spot virus, Lily mottle virus, Lily symptomless virus, Tulip mosaic virus, and the like.

Examples of the insect-borne bacteria include the following.

Candidatus Phytoplasma oryzae, Candidatus Phytoplasma asteris, Maize bushy stunt phytoplasma, Candidatus Liberbacter asiaticus, Candidatus Liberbacter africanus, Candidatus Liberbacter americanus, Xylella fastidiosa, and the like.

The composition of the present invention can also be used to protect humans from diseases caused by arthropod-borne viruses.

Examples of the human diseases caused by arthropod-borne viruses for which the composition of the present invention has control effect include the following.

Malaria, Dengue fever, Zika fever, Chikungunya fever, Yellow fever, Japanese encephalitis, West Nile fever, Filariasis, Chagas disease, Leishmaniasis, African sleeping sickness, Lymphatic filariasis, Onchocerciasis (river blindness), Scrub typhus, Crimean-Congo hemorrhagic fever, Rocky Mountain spotted fever, Japanese spotted fever, Severe fever with thrombocytopenia syndrome (SFTS), Tick-borne encephalitis, Plague, Epidemic typhus, Relapsing fever, Lyme disease, Bartonellosis, and the like.

The composition of the present invention can also be used to protect animals from animal diseases caused by arthropod-borne viruses.

Examples of the animal diseases caused by arthropod-borne viruses for which the composition of the present invention has control effect include the following.

Enzootic encephalitis, Vesicular stomatitis, Rift Valley fever, bluetongue, Akabane disease, Chuzan disease, Lumpy skin disease, Bovine leukosis, Aino virus infection, Ibaraki disease, Bovine ephemeral fever, Nairobi sheep disease, Sheep pox, Goat pox, Equine infectious anemia, African horse sickness, Fowl pox, Myxomatosis, and the like.

The composition of the present invention can also be used to protect animals from animal diseases caused by insect-borne bacteria, rickettsiae, spirochetes, protozoa, and fungi.

Examples of the animal diseases caused by insect-borne bacteria, rickettsiae, spirochetes, protozoa, and fungi for which the composition of the present invention has control effect include the following.

Tularemia, Anaplasmosis, Rickettsiosis, Ehrlichiosis, Lyme disease, Pseudofarcy in horses and the like.

The present compound and the composition A also have effects of inhibiting feeding damage, repelling, inhibiting oviposition, sterility, inhibiting next generation production, inhibiting copulatory behavior, inhibiting moulting, and inhibiting eclosion. As a result, it is possible to protect crops from damages caused by pest arthropods such as pest insects and pest mites, pest mollusks and pest nematodes.

When the composition A contains one or more components having fungicidal activity selected from the group (b) and the group (j) as the present component, it can control plant diseases caused by phytopathogenic microorganisms such as fungi, Oomycetes, Phytomyxea, bacteria and the like. Examples of fungi include Ascomycota, Basidiomycota, Blasocladiomycota, Chytridiomycota, Mucoromycota and Olpidiomycota. Specific examples thereof include the following. In parentheses represent the scientific name of the phytopathogenic microorganism which causes each disease.

When the composition A contains one or more components having fungicidal activity selected from the group (b) and the group (j) as the present component, it can control plant diseases caused by phytopathogenic microorganisms such as fungi, Oomycetes, Phytomyxea, bacteria and the like. Examples of fungi include Ascomycota, Basidiomycota, Blasocladiomycota, Chytridiomycota, Mucoromycota and Olpidiomycota. Specific examples thereof include the following. In parentheses represent the scientific name of the phytopathogenic microorganism which causes each disease.

Rice disease: Blast (Pyricularia oryzae), brown spot (Cochliobolus miyabeanus), sheath blight (Rhizoctonia solani), bakanae disease (Gibberella fujikuroi), downy mildew (Sclerophthora macrospora), false blast and head blight (Epicoccum nigrum), seedling blight (Trichoderma viride, Rhizopus oryzae);
Wheat disease: powdery mildew (Blumeria graminis), fusarium blight (Fusarium graminearum, Fusarium avenaceum, Fusarium culmorum, Microdochium nivale), stripe rust (Puccinia striiformis), stem rust (Puccinia graminis), leaf rust (Puccinia recondita), snow mould (Microdochium nivale, Microdochium majus), typhula snow blight (Typhula incarnata, Typhula ishikariensis), loose smut (Ustilago tritici), stinking smut (Tilletia caries, Tilletia controversa), eyespot (Pseudocercosporella herpotrichoides), leaf blotch (Septoria tritici), glume blotch (Stagonospora nodorum), tan spot (Pyrenophora tritici-repentis), rhizoctonia seeding blight (Rhizoctonia solani), take-all disease (Gaeumannomyces graminis), and blast (Pyricularia graminis-tritici);
Barley diseases: powdery mildew (Blumeria graminis), fusarium head blight (Fusarium graminearum, Fusarium avenaceum, Fusarium culmorum, Microdochium nivale), stripe rust (Puccinia striiformis), stem rust (Puccinia graminis), dwarf leaf rust (Puccinia hordei), loose smut (Ustilago nuda), scald (Rhynchosporium secalis), net blotch (Pyrenophora teres), spot blotch (Cochliobolus sativus), stripe (Pyrenophora graminea), Ramularia disease (Ramularia collo-cygni), and rhizoctonia seeding blight (Rhizoctonia solani);
Corn diseases: rust (Puccinia sorghi), southern rust (Puccinia polysora), northern leaf blight (Setosphaeria turcica), tropical rust (Physopella zeae), southern leaf blight (Cochliobolus heterostrophus), anthracnose (Colletotrichum graminicola), gray leaf spot (Cercospora zeae-maydis), eyespot (Kabatiella zeae), phaeosphaeria leaf spot(Phaeosphaeria maydis), diplodia rot (Stenocarpella maydis, Stenocarpella macrospora), stalk rot (Fusarium graminearum, Fusarium verticilioides, Colletotrichum graminicola), smut(Ustilago maydis), and Physoderma brown spot and Physoderma stalk rot (Physoderma maydis);
Cotton diseases: anthracnose (Colletotrichum gossypii), grey mildew (Ramularia areola), alternaria leaf spot (Alternaria macrospora, Alternaria gossypii), and black root rot (Thielaviopsis basicola);
Coffee diseases: rust (Hemileia vastatrix), and leaf spot (Cercospora coffeicola);
Rape seed diseases: sclerotinia rot (Sclerotinia sclerotiorum), gray leaf spot (Alternaria brassicae), root rot (Phoma lingam), and light leaf spot (Pyrenopeziza brassicae);
Sugar cane diseases: rust (Puccinia melanocephela, Puccinia kuehnii), and smut (Ustilago scitaminea);
Sunflower diseases: rust (Puccinia helianthi), and downy mildew (Plasmopara halstedii);
Citrus diseases: melanose (Diaporthe citri), scab (Elsinoe fawcetti), green mold (Penicillium digitatum), blue mold (Penicillium italicum), Phytophthora rot (Phytophthora parasitica, Phytophthora citrophthora), and aspergillus rot (Aspergillus niger);
Apple diseases: blossom blight (Monilinia mali), valsa canker (Valsa ceratosperma), powdery mildew (Podosphaera leucotricha), alternaria leaf spot (Alternaria alternata apple pathotype), scab (Venturia inaequalis), bitter rot (Glomerella cingulata, Colletotrichum acutatum), blotch (Diplocarpon mali), ring rot (Botryosphaeria berengeriana), crown rot (Phytophtora cactorum), and rust (Gymnosporangium juniperi-virginianae, Gymnosporangium yamadae);
Pear diseases: scab (Venturia nashicola, Venturia pirina), black spot (Alternaria alternata Japanese pear pathotype), and rust (Gymnosporangium haraeanum);
Peach diseases: brown rot (Monilinia fructicola), scab (Cladosporium carpophilum), Phomopsis rot (Phomopsis sp.), and leaf curl (Taphrina deformans);
Grape diseases: anthracnose (Elsinoe ampelina), ripe rot (Glomerella cingulata, Colletotrichum acutatum), powdery mildew (Uncinula necator), rust (Phakopsora ampelopsidis), black rot (Guignardia bidwellii), and downy mildew (Plasmopara viticola);
Japanese persimmon diseases: anthracnose (Gloeosporium kaki, Colletotrichum acutatum), and leaf spot (Cercospora kaki, Mycosphaerella nawae);
Fig diseases: rust (Phakopsora nishidana);
Gourd diseases: anthracnose (Colletotrichum lagenarium), powdery mildew (Sphaerotheca fuliginea), gummy stem blight (Didymella bryoniae), Corynespora leaf spot (Corynespora cassiicola), fusarium wilt (Fusarium oxysporum), downy mildew (Pseudoperonospora cubensis), phytophthora rot (Phytophthora capsici), and damping-off (Pythium sp.);
Tomato diseases: early blight (Alternaria solani), leaf mold (Cladosporium fulvum), Cercospora leaf mold (Pseudocercospora fuligena), late blight (Phytophthora infestans), and powdery mildew (Leveillula taurica);
Eggplant diseases: brown spot (Phomopsis vexans), and powdery mildew (Erysiphe cichoracearum);
Cruciferous vegetables diseases: alternaria leaf spot (Alternaria japonica), white spot (Cercosporella brassicae), clubroot (Plasmodiophora brassicae), downy mildew (Peronospora parasitica), and white rust (Albugo candida);
Green onion diseases: rust (Puccinia allii);
Soybean diseases: purple stain (Cercospora kikuchii), sphaceloma scab (Elsinoe glycines), pod and stem blight (Diaporthe phaseolorum var. sojae), rust (Phakopsora pachyrhizi), target spot (Corynespora cassiicola), anthracnose (Colletotrichum glycines, Colletotrichum truncatum), Rhizoctonia rot (Rhizoctonia solani), septoria brown spot (Septoria glycines), Cercospora leaf spot (Cercospora sojina), stem rot (Sclerotinia sclerotiorum), powdery mildew (Microsphaera diffusa), phytophthora stem and root rot (Phytophthora sojae), downy mildew (Peronospora manshurica), sudden death syndrome (Fusarium virguliforme), red crown rot (Calonectria ilicicola), and Diaporthe/Phomopsis complex (Diaporthe longicolla);
Kidney bean diseases: stem rot (Sclerotinia sclerotiorum), rust (Uromyces appendiculatus), angular leaf spot (Phaeoisariopsis griseola), anthracnose (Colletotrichum lindemuthianum), and Fusarium root-rot (Fusarium solani);
Peanut diseases: leaf spot (Cercospora personata), brown leaf spot (Cercospora arachidicola), southern blight (Sclerotium rolfsii), and Cylindrocladium black rot (Calonectria ilicicola);
Pea disease: powdery mildew (Erysiphe pisi), and root rot (Fusarium solani);
Potato diseases: early blight (Alternaria solani), late blight (Phytophthora infestans), Pink rot (Phytophthora erythroseptica), powdery scab (Spongospora subterranea f. sp. subterranea), verticillium wilt (Verticillium albo-atrum, Verticillium dahliae, Verticillium nigrescens), dry rot (Fusarium solani), and potato wart (Synchytrium endobioticum);
Strawberry disease: powdery mildew (Sphaerotheca humuli);
Tea diseases: net blister blight (Exobasidium reticulatum), white scab (Elsinoe leucospila), gray blight (Pestalotiopsis sp.), and anthracnose (Colletotrichum theae-sinensis);
Tobacco diseases: brown spot (Alternaria longipes), anthracnose (Colletotrichum tabacum), blue mold (Peronospora tabacina), and black shank (Phytophthora nicotianae);
   Sugar beet diseases: cercospora leaf spot (Cercospora beticola), leaf blight (Thanatephorus cucumeris), root rot (Thanatephorus cucumeris), aphanomyces root rot (Aphanomyces cochlioides), and rust (Uromyces betae);
Rose diseases: black spot (Diplocarpon rosae), and powdery mildew (Sphaerotheca pannosa);
Chrysanthemum diseases: leaf blight (Septoria chrysanthemi-indici), and white rust (Puccinia horiana);
Onion diseases: botrytis leaf blight (Botrytis cinerea, Botrytis byssoidea, Botrytis squamosa), gray-mold neck rot (Botrytis allii), and small sclerotial neck rot (Botrytis squamosa);
Various crops diseases: Botrytis rot (Botrytis cinerea), sclerotinia rot (Sclerotinia sclerotiorum), seedling blight (Pythium aphanidermatum, Pythium irregulare, Pythium ultimum);
Daikon radish disease: alternaria leaf spot (Alternaria brassicicola);
Lawn grass diseases: dollar spot (Sclerotinia homoeocarpa), brown patch and large patch (Rhizoctonia solani), and pythium bligt (Pythium aphanidermatum);
Banana disease: Sigatoka disease (Mycosphaerella fijiensis, Mycosphaerella musicola);
Lentils disease: ascochyta blight (Ascochyta lentis);
Chickpea disease: ascochyta blight (Ascochyta rabiei);
Green pepper disease: anthracnose (Colletotrichum scovillei);
Mango disease: anthracnose (Colletotrichum acutatum);
Fruit trees diseases: white root rot (Rosellinia necatrix), and violet root rot (Helicobasidium mompa);
Post-harvest disease of fruits such as apple and pear: Mucor rot diseases (Mucor piriformis);
Seed diseases or diseases in the early stages of the growth caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. or Diplodia spp. and the like;
Viral diseases: big-vein disease of Lettuce transmitted by Olpidium brassicae, and viral diseases of various kinds of crops transmitted by Polymixa spp. (e.g., Polymyxa betae and Polymyxa graminis);
Diseases caused by bacteria; bacterial seedling blight of rice (Burkholderia plantarii), bacterial spot of cucumber (Pseudomonas syringae pv. lachrymans), bacterial wilt of eggplant (Ralstonia solanacearum), canker of citrus (Xanthomonas citri), bacterial soft rot of Chinese cabbage (Erwinia carotovora), scab of potato (Streptomyces scabiei), Goss's wilt of corn (Clavibacter michiganensis), Pierce's disease of grape, olive and peach (Xylella fastidiosa), and crown gall of Rosaceae plants such as apple, peach, cherry (Agrobacterium tumefaciens).

The variations within a species are not particularly limited for the above phytopathogenic microorganisms. That is, those which have reduced susceptibility (also referred to as exhibit resistance) to specific fungicides are also included. The reduction of susceptibility may be that having a mutation at a target site (a target-site mutation), or may rely on a factor which is not a target-site mutation (a nontarget-site mutation). The target-site mutations include those in which an amino acid substitution has been occurred in a protein which is target-site due to a mutation in the nucleic acid portion (open reading frame) sequence corresponding to the amino acid sequence of the protein, and those overexpressing a target-site protein due to mutations such as deletion of a suppressor sequence or amplification of an enhancer sequence in the promoter region and an increase in gene copy number. Examples of the nontarget-site mutations include enhancement of elimination function by which fungicides flowed into the inside of a cell can be evacuated to the outside of the cell by ABC transporters, MFS transporters and the like. They also include detoxification through metabolism of fungicides.

Examples of the specific fungicides above include nucleic acid synthesis inhibitors (e.g., phenylamide fungicides, acylamino acid fungicides and DNA topoisomerase type II fungicides), mitosis and cell division inhibitors (e.g., MBC fungicides and N-phenylcarbamate fungicides), respiratory inhibitors (e.g., Qol fungicides, Qil fungicides and SDHI fungicides), inhibitors of amino acid synthesis and protein synthesis (e.g., anilinopyrimidine fungicides), signal transduction inhibitors (e.g., phenylpyrrole fungicides and dicarboximide fungicides), inhibitors of lipid synthesis and cell membrane synthesis (e.g., phosphorothiolate fungicides, dithiolane fungicides, aromatic hydrocarbon fungicides, heteroaromatic fungicides and carbamate fungicides), sterol biosynthesis inhibitors (e.g., DMI fungicides such as triazoles, hydroxyanilide fungicides and aminopyrazolinone fungicides), cell wall synthesis inhibitors (e.g., polyoxin fungicides, carboxylic acid amide fungicides), melanin synthesis inhibitors (e.g., MBI-R fungicides, MBI-D fungicides, MBI-P fungicides), and other fungicides (e.g., cyanoacetamide oxime fungicides, phenylacetamide fungicides).

Examples of amino acid substitutions at target sites include the following.

Cytochrome b: G143A, F129L, G137R, 1147V, Y279C, Y279S, M295L, A126T, Y132C, C133Y, G137V, G137A, G137S, M139V, T145F, T145R, T145S, T145C, T145L, T145Y, T148M, T148V, T148L, T1481, T148T, N256Y, N256K, N256I, E272D, E272G, E272Q, W273L, W273F, Y274S, Y274F, L275F, L275S, L275T, L295F or, L299F, 117F, S20L/T, Q22E/T, I26L, W30C, N31K, G33A, S34L, S351, G37C/D/S/V/A, L198F, L201S, E203-DE-V204, M221Q/E, F225S/L, K228M/I/P, G232D or N256S;

In Cyp51 proteins, A311G, A379G, A381G, A410T, A61V, D107V, D134G, D282E, D411N, E297K, F120L, F219S, F449S, F489L, F4951, G138C/R/S, G312A, G412A, G432S, G434C, G448S, G460D/A, G462A, G464S, G484S, G510C, G54E/K/R/V/W, G54W, H147Y, H303Y, H399P, 1145F, 1330T, 1381V/A, 1471T, 1475T, K142R, K143E, K147Q, K175N, K197N, L50S, L98H, M145L, M220K/I/T/V, M288L, N1251, N178S, N22D, N284H, N513K, P216L, P384S, P394L, Q141H, Q88H, R467K, S188N, S208T, S297T, S405F, S508T, S509T, S524T, S52T, S79T, T289A, T440A, T454P, T469S, V101F, V136A/C/G, V490L, Y121F, Y131F/H, Y132F/H/N, Y134F, Y134F, Y136F, Y137F, Y140F/H, Y145F, Y431C, Y459C/D/N/S/P/A, Y461D/H/S/G/L/N/A, Y463D/H/N, Y491H, S259F, G476S or Y68N;
β-Tubulin: H6L/Y, Y50C/N/S, Q134K, A165V, E198A/D/G/K/L/Q/V, F200Y, M257L, F167Y, Q73R, L240F, Q8L, C165Y, M2331, C239S, 1258V or T3511;
SdhB: H277R/Y, P225H/F/L/T, N2301, H272L/R/V/Y, H278Y/R, H249L/N/Y, H273Y, N225I/T, T2681/A, 1269V, H242R, H257L, N224T or T2531;
SdhC: H134R, P80H/L, A85V, S73P, T90I, 186F, N88S, H154Y/R, K49E, R64K, N75S, G79R, S135R, N87S, H153R, H146R, 129V, N33T, N34T, T79I/N, W80S, A84V, N86K/S/A, G90R, R151T/S, H152R, 1161S, G169D, G171D or H151R;
SdhD: H133R, H132R, S89P, G109V, D124E/N, H134R, G138V, D145G, 150F, M114V or D129E;
OS-1 (Shk1): E753K, G420D, 1365N/R/S, V368F, Q369H/P, N373S, T447S, F267L, L290S, T765R, Q777R, T4891, E599K or G736Y;
ERG27: S9G, F26S, P57A, T631, G170R, V1921, L195F, N196T, A210G, 1232M, P238S/A, P250S, P269L, P298A, V309M, A314V, S336C, V365A, E368D, N369D, E375K, A378T, L400F/S, Y408S, F4121/S/V/C, A461S or R496T;
RPA190: F382Y, P980S or V1476G;
ORP1: L733W, G700V, S7681/F/K/Y, G769W, G770A/l/P/V/L, G818/F819A, N8371/F/Y/A, G839W, P861H, L863W/F or 1877F/Y;
CesA3: Q1077K, G1105S/V/W/A or V1109L/M

In addition, examples of phytopathogenic microorganisms which have reduced susceptibility to fungicides due to overexpression of the Cyp51 gene and their host plants include the following. Septoria tritici in wheat (Reference literature: Pest Management Science. 2012. 68(7). 1034-1040), Rhynchosporium secalis in barley (Reference literature: Molecular Bilogy and Evolution. 2014. 31(7). 1793-1802) Phakopsora pachyrhizi in soybean (Reference literature: Pest Management Science. 2014. 70(3). 378-388), Venturia inaequalis in apple (Reference literature: Phytopathology. 2016. 106(6). 562-571), Penicillium digitatum in citrus (Reference literature: Applied and Environmental Microbiology. 2000. 66(8). 3421-3426).

The phytopathogenic microorganisms which can be controlled by the composition A containing one or more components having fungicidal activity selected from the group (b) and the group (j) as the present component may have a plurality of amino acid substitutions described above. In the case, the plurality of amino acid substitutions may be in the same protein or in the different proteins. They may also have a plurality of target-site mutations and nontarget-site mutations. Examples thereof include phytopathogenic microorganisms causing amino acid substitutions of G143A, F129L, and G137R in cytochrome b; phytopathogenic microorganisms having an amino acid substitution of G143A in cytochrome b and an amino acid substitution of A311G in Cyp51; phytopathogenic microorganisms having amino acid substitutions of G143A and F129L in cytochrome b and an amino acid substitution of A311G in Cyp51; phytopathogenic microorganisms having amino acid substitutions of G143A and F129L in cytochrome b and an amino acid substitution of H6L/Y in β-tubulin and overexpressing the Cyp51 gene.

Examples of phytopathogenic microorganisms having target-site mutation include the following.
Alternaria alternate having an amino acid substitution of G143A in cytochrome b;
Alternaria arborescens having an amino acid substitution of G143A in cytochrome b;
Alternaria solani having an amino acid substitution of F129L in cytochrome b;
Alternaria tomato having an amino acid substitution of G143A in cytochrome b;
Botryotinia fuckeliana having an amino acid substitution of G143A in cytochrome b;
Glomerella graminicola having an amino acid substitution of G143A in cytochrome b;
Corynespora cassiicola having an amino acid substitution of G143A in cytochrome b;
Cercospora beticola having an amino acid substitution of G143A in cytochrome b;
Cercospora sojina having an amino acid substitution of G143A in cytochrome b;
Cladsporium carpophilum having an amino acid substitution of G143A in cytochrome b;
Colletotrichum graminicola having an amino acid substitution of G143A in cytochrome b;
Glomerella cingulata having an amino acid substitution of G143A in cytochrome b;
Blumeria graminis f. sp. hordei having an amino acid substitution of G143A in cytochrome b;
Blumeria graminis f. sp. tritici having an amino acid substitution of G143A in cytochrome b;
Parastagonospora nodorum having an amino acid substitution of G143A in cytochrome b;
Monographella nivalis having an amino acid substitution of G143A in cytochrome b;
Microdochium majus, nivale having an amino acid substitution of G143A in cytochrome b;
Mycosphaerella fijiensis having an amino acid substitution of G143A in cytochrome b;
Didymella rabiei having an amino acid substitution of G143A in cytochrome b;
Phakopsora pachyrhizi having an amino acid substitution of F129L in cytochrome b;
Plasmopara viticola having an amino acid substitution of F129L or G143A in cytochrome b;
Pleospora allii having an amino acid substitution of G143A in cytochrome b;
Podosphaera fusca having an amino acid substitution of G143A in cytochrome b;
Podosphaera xanthii having an amino acid substitution of G143A in cytochrome b;
Pseudoperonospora cubensis having an amino acid substitution of G143A in cytochrome b;
Magnaporthe oryzae having an amino acid substitution of F129L or G143A in cytochrome b;
Pyrenophora teres having an amino acid substitution of F129L in cytochrome b;
Pyrenophora tritici-repentis having an amino acid substitution of F129L, G137R or G143A in cytochrome b;
Pythium aphanidermatum having an amino acid substitution of F129L in cytochrome b;
Thanatephorus cucumeris having an amino acid substitution of F129L or G143A in cytochrome b;
Ramularia collo-cygni having an amino acid substitution of G143A in cytochrome b;
Rhynchosporium secalis having an amino acid substitution of G143A in cytochrome b;
Rhizoctonia solani having an amino acid substitution of F129L in cytochrome b;
Zymoseptoria tritici having an amino acid substitution of F129L, G137R or G143A in cytochrome b;
Erysiphe necator having an amino acid substitution of G143A in cytochrome b;
Venturia inaequalis having an amino acid substitution of G143A in cytochrome b;
Saccharomyces cerevisiae having an amino acid substitution of 1147V in cytochrome b;
Saccharomyces cerevisiae having an amino acid substitution of L275F in cytochrome b;
Saccharomyces cerevisiae having an amino acid substitution of Y279C in cytochrome b;
Saccharomyces cerevisiae having an amino acid substitution of Y279S in cytochrome b;
Saccharomyces cerevisiae having an amino acid substitution of M295L in cytochrome b;
Puccinia horiana having an amino acid substitution of N256S in cytochrome b;
Puccinia horiana having an amino acid substitution of L299F in cytochrome b;
Fungi and Oomycota which have an amino acid substitution of L299F in cytochrome b;
Fungi and Oomycota which have an amino acid substitution of A126T in cytochrome b;
Fungi and Oomycota which have an amino acid substitution of Y132C in cytochrome b;
Fungi and Oomycota which have an amino acid substitution of C133Y in cytochrome b;
Fungi and Oomycota which have an amino acid substitution of G137V in cytochrome b;
Fungi and Oomycota which have an amino acid substitution of G137A in cytochrome b;
Fungi and Oomycota which have an amino acid substitution of G137S in cytochrome b;
Fungi and Oomycota which have an amino acid substitution of M139V in cytochrome b;
Fungi and Oomycota which have an amino acid substitution of T145F in cytochrome b;
Fungi and Oomycota which have an amino acid substitution of T145R in cytochrome b;
Fungi and Oomycota which have an amino acid substitution of T145S in cytochrome b;
Fungi and Oomycota which have an amino acid substitution of T145C in cytochrome b;
Fungi and Oomycota which have an amino acid substitution of T145L in cytochrome b;
Fungi and Oomycota which have an amino acid substitution of T145Y in cytochrome b;
Fungi and Oomycota which have an amino acid substitution of T148M in cytochrome b;
Fungi and Oomycota which have an amino acid substitution of T148V in cytochrome b;
Fungi and Oomycota which have an amino acid substitution of T148L in cytochrome b;
Fungi and Oomycota which have an amino acid substitution of T1481 in cytochrome b;
Fungi and Oomycota which have an amino acid substitution of T148T in cytochrome b;
Fungi and Oomycota which have an amino acid substitution of N256Y in cytochrome b;
Fungi and Oomycota which have an amino acid substitution of N256K in cytochrome b;
Fungi and Oomycota which have an amino acid substitution of N256I in cytochrome b;
Fungi and Oomycota which have an amino acid substitution of E272D in cytochrome b;
Fungi and Oomycota which have an amino acid substitution of E272G in cytochrome b;
Fungi and Oomycota which have an amino acid substitution of E272Q in cytochrome b;
Fungi and Oomycota which have an amino acid substitution of W273L in cytochrome b;
Fungi and Oomycota which have an amino acid substitution of W273F in cytochrome b;
Fungi and Oomycota which have an amino acid substitution of Y274S in cytochrome b;
Fungi and Oomycota which have an amino acid substitution of Y274F in cytochrome b;
Fungi and Oomycota which have an amino acid substitution of L275S in cytochrome b;
Fungi and Oomycota which have an amino acid substitution of L275T in cytochrome b;
Fungi and Oomycota which have an amino acid substitution of L295F in cytochrome b;
Plasmopora viticola having an amino acid substitution of S34L, L201S or E203-DE-V204 in cytochrome b;
Zymoseptoria tritici having an amino acid substitution of G37V in cytochrome b;
Ajellomyces capsulatus having an amino acid substitution of Y136F in Cyp51;
Aspergillus flavus having an amino acid substitution of Y132N, K197N, D282E, M288L, T469S, H399P, D411N or T454P in Cyp51;
Aspergillus fumigatus having an amino acid substitution of N22D, S52T, G54E/K/R/V/W, Y68N, Q88H, L98H, V101F, Y121F, N1251, G138C/R/S, Q141H, H147Y, P216L, F219S, M220K/l/T/V, T289A, S297T, P394L, Y431C, G432S, G434C, T440A, G448S, Y491H or F4951 in Cyp51;
Aspergillus parasiticus having an amino acid substitution of G54W in Cyp51;
Candida albicans having an amino acid substitution of A61V, Y132F/H, K143E, S405F, F449S, G464S, R467K or 1471T in Cyp51;
Cercospora beticola having an amino acid substitution of E297K, 1330T or P384S in Cyp51;
Blumeria graminis f. sp. hordei having an amino acid substitution of Y136F, K147Q or S509T in Cyp51;
Blumeria graminis f. sp. tritici having an amino acid substitution of S79T, Y136F, or K175N in Cyp51;
Filobasidiella neoformans having an amino acid substitution of Y145F or G484S in Cyp51;
Monilinia fructicola having an amino acid substitution of Y136F in Cyp51, Mycosphaerella fijiensis having an amino acid substitution of Y136F, A313G, A381G, Y461D, G462A or Y463D/H/N in Cyp51;
Phakopsora pachyrhizi having an amino acid substitution of F120L, Y131F/H, K142R, 1145F or 1475T in Cyp51;
Puccinia triticina having an amino acid substitution of Y134F in Cyp51;
Pyrenophora teres having an amino acid substitution of F489L in Cyp51;
Pyrenopeziza brassicae having an amino acid substitution of S508T in Cyp51;
Saccharomyces cerevisiae having an amino acid substitution of Y140F/H in Cyp51;
Zymoseptoria tritici having an amino acid substitution of L50S, D107V, D134G, V136A/C/G, Y137F, M145L, N178S, S188N, S208T, N284H, H303Y, A311G, G312A, A379G, 1381V/A, A410T, G412A, Y459C/D/N/S/P/A, G460D/A, Y461D/H/S/G/L/N/A, V490L, G510C, N513K, S259F, G476S or S524T in Cyp51;
Erysiphe necator having an amino acid substitution of Y136F in Cyp51;
Emericella nidulans having an amino acid substitution of H6L/Y, Y50N/S, Q134K, A165V, E198D/K/Q, F200Y or M257L in β-tubulin;
Botryotinia fuckeliana having an amino acid substitution of E198A/G/K/V or F200Y in β-tubulin;
Cochliobolus heterostrophus having an amino acid substitution of F167Y in β-tubulin;
Cercospora beticola having an amino acid substitution of F167Y or E198A in β-tubulin;
Gibberella fujikuroi having an amino acid substitution of Y50N, E198V or F200Y in β-tubulin;
Gibberella zeae having an amino acid substitution of Y50C, Q73R, F167Y, E198K/L/Q or F200Y in β-tubulin;
Helminthosporium solani having an amino acid substitution of E198A/Q in β-tubulin;
Hypomyces odoratus having an amino acid substitution of Y50C in β-tubulin;
Parastagonospora nodorum having an amino acid substitution of H6Y in β-tubulin;
Monilinia fructicola having an amino acid substitution of H6Y or E198A/K in β-tubulin;
Monilinia laxa having an amino acid substitution of L240F in β-tubulin;
Microdochium majus, nivale having an amino acid substitution of E198A in β-tubulin;
Mycosphaerella fijiensis having an amino acid substitution of E198A in β-tubulin;
Neurospora crassa having an amino acid substitution of F167Y or E198G in β-tubulin;
Penicillium aurantiogriseum having an amino acid substitution of E198A/K or F200Y in @3-tubulin;
Penicillium expansum having an amino acid substitution of F167Y or E198A/K/V in β-tubulin;
Penicillium italicum having an amino acid substitution of E198K or F200Y in β-tubulin;
Pyrenopeziza brassicae having an amino acid substitution of L240F in β-tubulin;
Rhynchosporium secalis having an amino acid substitution of E198G/K or F200Y in β-tubulin;
Sclerotinia homoeocarpa having an amino acid substitution of E198A/K in β-tubulin;
Sclerotinia sclerotiorum having an amino acid substitution of E198A in β-tubulin;
Zymoseptoria tritici having an amino acid substitution of E198A/G in β-tubulin;
Venturia inaequalis having an amino acid substitution of E198A/K, F200Y or L240F in β-tubulin;
Phytophthora sojae having an amino acid substitution of Q8L, C165Y, C239S or 1258V in @3-tubulin;
Botrytis cinerea having an amino acid substitution of M2331 or T3511 in β-tubulin;
Alternaria alternata having an amino acid substitution of H277R/Y in SdhB;
Alternaria solani having an amino acid substitution of H277R/Y in SdhB;
Botryotinia fuckeliana having an amino acid substitution of P225H/F/L/T, N2301 or H272L/R/V/Y in SdhB;
Corynespora cassiicola having an amino acid substitution of H278Y/R in SdhB;
Stagonosporopsis cucurbitacearum having an amino acid substitution of H277R/Y in SdhB;
Eurotium oryzae having an amino acid substitution of H249L/N/Y in SdhB;
Pyrenophora teres having an amino acid substitution of H277Y in SdhB;
Ramularia collo-cygni having an amino acid substitution of N224T in SdhB;
Sclerotinia sclerotiorum having an amino acid substitution of H273Y in SdhB;
Zymoseptoria tritici having an amino acid substitution of N225I/T, H273Y, T2681/A or 1269V in SdhB;
Erysiphe necator having an amino acid substitution of H242R in SdhB;
Ustilago maydis having an amino acid substitution of H257L in SdhB;
Venturia inaequalis having an amino acid substitution of T2531 in SdhB;
Alternaria alternata having an amino acid substitution of H134R in SdhC;
Botryotinia fuckeliana having an amino acid substitution of P80H/L or A85V in SdhC;
Corynespora cassiicola having an amino acid substitution of S73P in SdhC;
Eurotium oryzae having an amino acid substitution of T90I in SdhC;
Phakopsora pachyrhizi having an amino acid substitution of 186F, N88S or H154Y/R in SdhC;
Pyrenophora teres having an amino acid substitution of K49E, R64K, N75S, G79R, H134R or S135R in SdhC;
Ramularia collo-cygni having an amino acid substitution of N87S, H146R, G171D or H153R in SdhC;
Sclerotinia sclerotiorum having an amino acid substitution of H146R in SdhC;
Zymoseptoria tritici having an amino acid substitution of 129V, N33T, N34T, T79I/N, W80S, A84V, N86K/S/A, G90R, R151T/S, H152R or 1161S in SdhC;
Erysiphe necator having an amino acid substitution of G169D in SdhC;
Venturia inaequalis having an amino acid substitution of H151R in SdhC;
Alternaria alternata having an amino acid substitution of H133R in SdhD;
Alternaria solani having an amino acid substitution of H133R in SdhD;
Botryotinia fuckeliana having an amino acid substitution of H132R in SdhD;
Corynespora cassiicola having an amino acid substitution of S89P or G109V in SdhD;
Eurotium oryzae having an amino acid substitution of D124E in SdhD;
Pyrenophora teres having an amino acid substitution of D124E/N, H134R, G138V or D145G in SdhD;
Sclerotinia sclerotiorum having an amino acid substitution of H132R in SdhD;
Zymoseptoria tritici having an amino acid substitution of 150F, M114V or D129E in SdhD;
Phytophthora capsici having an amino acid substitution of Q1077K or V1109L/M in CesA3;
Phytophthora drechsleri having an amino acid substitution of V1109L in CesA3;
Phytophthora infestans having an amino acid substitution of G1105A/V or V1109L in CesA3;
Plasmopara viticola having an amino acid substitution of G1105S/V in CesA3;
Pseudoperonospora cubensis having an amino acid substitution of G1105V/W in CesA3;
Alternaria brassicicola having an amino acid substitution of E753K in OS-1 (Shk1);
Alternaria longipes having an amino acid substitution of G420D in OS-1 (Shk1);
Botryotinia fuckeliana having an amino acid substitution of 1365N/R/S, V368F, Q369H/P, N373S or T447S in OS-1 (Shk1);
Pleospora allii having an amino acid substitution of F267L, L290S, T765R or Q777R in OS-1 (Shk1);
Sclerotinia sclerotiorum having an amino acid substitution of T4891, E599 K or G736Y in OS-1 (Shk1);
Botryotinia fuckeliana having an amino acid substitution of S9G, F26S, P57A, T631, G170R, V1921, L195F, N196T, A210G, 1232M, P238S/A, P250S, P269L, P298A, V309M, A314V, S336C, V365A, E368D, N369D, E375K, A378T, L400F/S, Y408S, F4121/S/V/C, A461S or R496T in ERG27;
Phytophthora infestans having an amino acid substitution of F382Y, P980S or V1476G in RPA190;
Pythium spp. having an amino acid substitution of F382Y, P980S or V1476G in RPA190;
Phytophthora infestans having an amino acid substitution of L733W, S7681/F/K/Y, G770A/l/P/V/L, G818/F819O, N8371/F/Y/A, G839W, P861H, L863W/F or 1877F/Y in ORP1;
Phytophthora sojae having an amino acid substitution of L733W, S768F/Y, G770V, N837F/Y/A, G839W, P861H, L863W or 1877Y in ORP1;
Phytophthora capsici having an amino acid substitution of G700V or G769W in ORP1;
Plasmopara viticola having an amino acid substitution of G770A/l/P/V/L, N8371/F/Y/A, or L863W/F in ORP1;
Pseudoperonospora cubensis having an amino acid substitution of G700A/l/P/V/L, N7671/F/Y/A or L793W/F in ORP1;
Plasmopara viticola having an amino acid substitution of G1105S in CesA3;
Pseudoperonospora cubensis having an amino acid substitution of G1105V/W in CesA3.

Zymoseptoria tritici means the same species as Septoria tritici. In addition, Microsphaera diffusa means the same species as Erysiphe diffusa.

When the composition A contains one or more components having herbicidal activity selected from the group (i) and the group (j) as the present component, it can control weeds. In the present invention, weeds mean plants whose growth is undesirable at the place. Examples of the weeds include the following.

Urticaceae weeds: small nettle (Urtica urens)
Polygonaceae weeds: black bindweed (Polygonum convolvulus), pale persicaria (Polygonum lapathifolium), Pennsylvania smartweed (Polygonum pensylvanicum), redshank (Polygonum persicaria), bristly lady's-thumb (Polygonum longisetum), knotgrass (Polygonum aviculare), equal-leaved knotgrass (Polygonum arenastrum), Japanese knotweed (Polygonum cuspidatum), Japanese dock (Rumex japonicus), curly dock (Rumex crispus), blunt-leaved dock (Rumex obtusifolius), and common sorrel (Rumex acetosa)
Portulacaceae weeds: common purslane (Portulaca oleracea)
Caryophyllaceae weeds: common chickweed (Stellaria media), water chickweed (Stellaria aquatica), common mouse-ear (Cerastium holosteoides), sticky mouse-ear (Cerastium glomeratum), corn spurrey (Spergula arvensis), and five-wound catchfly (Silene gallica)
Molluginaceae weeds: carpetweed (Mollugo verticillata)
Chenopodiaceae weeds: common lambsquarters (Chenopodium album), Indian goosefoot (Chenopodium ambrosioides), kochia (Kochia scoparia), spiny saltwort (Salsola kali), and Orach (Atriplex spp.)

Amaranthaceae weeds: redroot pigweed (Amaranthus retroflexus), slender amaranth (Amaranthus viridis), livid amaranth (Amaranthus lividus), spiny amaranth (Amaranthus spinosus), smooth pigweed (Amaranthus hybridus), Palmer amaranth (Amaranthus palmeri), green pigweed (Amaranthus patulus), waterhemp (Amaranthus tuberculatus=Amaranthus rudis=Amaranthus tamariscinus), prostrate pigweed (Amaranthus blitoides), large-fruit amaranth (Amaranthus deflexus), mucronate amaranth (Amaranthus quitensis), alligator weed (Alternanthera philoxeroides), sessile alligator weed (Alternanthera sessilis), and perrotleaf (Alternanthera tenella)
Papaveraceae weeds: common poppy (Papaver rhoeas), field poppy (Papaver dubium), and Mexican prickle poppy (Argemone mexicana)
Brassicaceae weeds: wild radish (Raphanus raphanistrum), radish (Raphanus sativus), wild mustard (Sinapis arvensis), shepherd's purse (Capsella bursa-pastoris), white mustard (Brassica juncea), oilseed rape (Brassica napus), pinnate tansy mustard (Descurainia pinnata), marsh yellowcress (Rorippa islandica), yellow fieldcress (Rorippa sylvestris), field pennycress (Thlaspi arvense), turnip weed (Myagrum rugosum), Virginia pepperweed (Lepidium virginicum), and slender wartcress (Coronopus didymus)
Capparaceae weeds: African cabbage (Cleome affinis)

Fabaceae weeds: Indian joint vetch (Aeschynomene indica), zigzag joint vetch (Aeschynomene rudis), hemp sesbania (Sesbania exaltata), sickle pod (Cassia obtusifolia), coffee senna (Cassia occidentalis), Florida beggar weed (Desmodium tortuosum), wild groundnut (Desmodium adscendens), Illinois tick trefoil (Desmodium illinoense), white clover (Trifolium repens), kudzu (Pueraria lobata), narrowleaf vetch (Vicia angustifolia), hairy indigo (Indigofera hirsuta), Indigofera truxillensis, and common cowpea (Vigna sinensis)
Oxalidaceae weeds: creeping wood sorrel (Oxalis corniculata), European wood sorrel (Oxalis stricta), and purple shamrock (Oxalis oxyptera)
Geraniaceae weeds: Carolina geranium (Geranium carolinense), and common storksbill (Erodium cicutarium)
Euphorbiaceae weeds: sun spurge (Euphorbia helioscopia), annual spurge (Euphorbia maculata), prostrate spurge (Euphorbia humistrata), Hungarian spurge (Euphorbia esula), wild poinsettia (Euphorbia heterophylla), hyssop-leaf sandmat (Euphorbia brasiliensis), Asian copperleaf (Acalypha australis), tropic croton (Croton glandulosus), lobed croton (Croton lobatus), long-stalked phyllanthus (Phyllanthus corcovadensis), and castor bean (Ricinus communis)

Malvaceae weeds: velvetleaf (Abutilon theophrasti), arrow-leaf sida (Sida rhombifolia), heart-leaf sida (Sida cordifolia), prickly sida (Sida spinosa), Sida glaziovii, Sida santaremnensis, bladder weed (Hibiscus trionum), spurred anoda (Anoda cristata), and spine-seeded false-mallow (Malvastrum coromandelianum)
Onagraceae weeds: Cyoujitade (Ludwigia epilobioides), long-fruited primrose willow (Ludwigia octovalvis), winged water primrose (Ludwigia decurrens), common evening-primrose (Oenothera biennis), and cutleaf evening-primrose (Oenothera laciniata)
Sterculiaceae weeds: Florida waltheria (Waltheria indica)
Violaceae weeds: field violet (Viola arvensis), and wild violet (Viola tricolor)
Cucurbitaceae weeds: bur cucumber (Sicyos angulatus), wild cucumber (Echinocystis lobata), and bitter balsam apple (Momordica charantia)
Lythraceae weeds: Himemisohagi (Ammannia multiflora), eared redstem (Ammannia auriculata), scarlet toothcup (Ammannia coccinea), purple loosestrife (Lythrum salicaria), and Indian toothcup (Rotala indica)
Elatinaceae weeds: three-stamen waterwort (Elatine triandra), and California waterwort (Elatine californica)

Apiaceae weeds: Chinese celery (Oenanthe javanica), wild carrot (Daucus carota), and hemlock (Conium maculatum)
Araliaceae weeds: lawn pennywort (Hydrocotyle sibthorpioides), and floating pennywort (Hydrocotyle ranunculoides)
Ceratophyllaceae weeds: common hornwort (Ceratophyllum demersum)
Cabombaceae weeds: Carolina fanwort (Cabomba caroliniana)
Haloragaceae weeds: Brazilian water milfoil (Myriophyllum aquaticum), whorled water milfoil (Myriophyllum verticillatum), water milfoils (Myriophyllum spicatum, and Myriophyllum heterophyllum etc.)
Sapindaceae weeds: heartseed (Cardiospermum halicacabum)
Primulaceae weeds: scarlet pimpernel (Anagallis arvensis)
Asclepiadaceae weeds: common milkweed (Asclepias syriaca), and honeyvine milkweed (Ampelamus albidus)
Rubiaceae weeds: catchweed bedstraw (Galium aparine), Yaemugura (Galium spurium var. echinospermon), broadleaf buttonweed (Spermacoce latifolia), Brazil calla lily (Richardia brasiliensis), and broadleaf buttonweed (Borreria alata)

Convolvulaceae weeds: Japanese morning glory (Ipomoea nil), ivy-leaf morning glory (Ipomoea hederacea), tall morning glory (Ipomoea purpurea), entire-leaf morning glory (Ipomoea hederacea var. integriuscula), pitted morning glory (Ipomoea lacunosa), three-lobe morning glory (Ipomoea triloba), blue morning glory (Ipomoea acuminata), scarlet morning glory (Ipomoea hederifolia), red morning glory (Ipomoea coccinea), cypress-vine morning glory (Ipomoea quamoclit), Ipomoea grandifolia, Ipomoea aristolochiaefolia, Cairo morning glory (Ipomoea cairica), field bindweed (Convolvulus arvensis), Japanese false bindweed (Calystegia hederacea), Japanese bindweed (Calystegia japonica), ivy woodrose (Merremia hederacea), hairy woodrose (Merremia aegyptia), roadside woodrose (Merremia cissoides), and small-flower morning glory (Jacquemontia tamnifolia)
Boraginaceae weeds: field forget-me-not (Myosotis arvensis)
Lamiaceae weeds: purple deadnettle (Lamium purpureum), common henbit (Lamium amplexicaule), lion's ear (Leonotis nepetaefolia), wild spikenard (Hyptis suaveolens), Hyptis lophanta, Siberian motherwort (Leonurus sibiricus), and field-nettle betony (Stachys arvensis)
Solanaceae weeds: jimsonweed (Datura stramonium), black nightshade (Solanum nigrum), American black nightshade (Solanum americanum), eastern black nightshade (Solanum ptycanthum), hairy nightshade (Solanum sarrachoides), buffalo bur (Solanum rostratum), soda-apple nightshade (Solanum aculeatissimum), sticky nightshade (Solanum sisymbriifolium), horse nettle (Solanum carolinense), cutleaf groundcherry (Physalis angulata), smooth groundcherry (Physalis subglabrata), and apple of Peru (Nicandra physalodes)
Scrophulariaceae weeds: ivyleaf speedwell (Veronica hederaefolia), common speedwell (Veronica persica), corn speedwell (Veronica arvensis), common false pimpernel (Lindernia procumbens), false pimpernel (Lindernia dubia), Azetougarashi (Lindernia angustifolia), round-leaf water hyssop (Bacopa rotundifolia), dopatrium (Dopatrium junceum), and Oabunome (Gratiola japonica)
Plantaginaceae weeds: Asiatic plantain (Plantago asiatica), narrow-leaved plantain (Plantago lanceolata), broadleaf plantain (Plantago major), and marsh water starwort (Callitriche palustris)

Asteraceae weeds: common cocklebur (Xanthium pensylvanicum), large cocklebur (Xanthium occidentale), Canada cocklebur (Xanthium italicum), common sunflower (Helianthus annuus), wild chamomile (Matricaria chamomilla), scentless chamomile (Matricaria perforata), corn marigold (Chrysanthemum segetum), rayless mayweed (Matricaria matricarioides), Japanese mugwort (Artemisia princeps), common mugwort (Artemisia vulgaris), Chinese mugwort (Artemisia verlotorum), tall goldenrod (Solidago altissima), common dandelion (Taraxacum officinale), hairy galinsoga (Galinsoga ciliata), small-flower galinsoga (Galinsoga parviflora), common groundsel (Senecio vulgaris), flower-of-souls (Senecio brasiliensis), Senecio grisebachii, fleabane (Conyza bonariensis), Guernsey fleabane (Conyza smatrensis), marestail (Conyza canadensis), common ragweed (Ambrosia artemisiifolia), giant ragweed (Ambrosia trifida), three-cleft bur-marigold (Bidens tripartita), hairy beggarticks (Bidens pilosa), common beggarticks (Bidens frondosa), greater beggarticks (Bidens subalternans), Canada thistle (Cirsium arvense), black thistle (Cirsium vulgare), blessed milkthistle (Silybum marianum), musk thistle (Carduus nutans), prickly lettuce (Lactuca serriola), annual sowthistle (Sonchus oleraceus), spiny sowthistle (Sonchus asper), beach creeping oxeye (Wedelia glauca), perfoliate blackfoot (Melampodium perfoliatum), red tasselflower (Emilia sonchifolia), wild marigold (Tagetes minuta), para cress (Blainvillea latifolia), coat buttons (Tridax procumbens), Bolivian coriander (Porophyllum ruderale), Paraguay starbur (Acanthospermum australe), bristly starbur (Acanthospermum hispidum), balloon vine (Cardiospermum halicacabum), tropic ageratum (Ageratum conyzoides), common boneset (Eupatorium perfoliatum), fireweed (Erechtites hieracifolia), American cudweed (Gamochaeta spicata), linear-leaf cudweed (Gnaphalium spicatum), Jaegeria hirta, ragweed parthenium (Parthenium hysterophorus), small yellow crownbeard (Siegesbeckia orientalis), lawn burweed (Soliva sessilis), white eclipta (Eclipta prostrata), American false daisy (Eclipta alba), and spreading sneezeweed (Centipeda minima)

Alismataceae weeds: dwarf arrowhead (Sagittaria pygmaea), threeleaf arrowhead (Sagittaria trifolia), arrowhead (Sagittaria sagittifolia), giant arrowhead (Sagittaria montevidensis), Aginashi (Sagittaria aginashi), channelled water plantain (Alisma canaliculatum), and common water plantain (Alisma plantago-aquatica)
Limnocharitaceae weeds: Sawah flowering rush (Limnocharis flava)
Hydrocharitaceae weeds: American frogbit (Limnobium spongia), Florida elodea (Hydrilla verticillata), and common water nymph (Najas guadalupensis)
Araceae weeds: Nile cabbage (Pistia stratiotes)
Lemnaceae weeds: three-nerved duckweed (Lemna aoukikusa, Lemna paucicostata, Lemna aequinoctialis), common duckmeat (Spirodela polyrhiza), and Wolffia spp.
Potamogetonaceae weeds: roundleaf pondweed (Potamogeton distinctus), pondweeds (Potamogeton crispus, Potamogeton illinoensis, and Stuckenia pectinata etc.)
Liliaceae weeds: wild onion (Allium canadense), wild garlic (Allium vineale), and Chinese garlic (Allium macrostemon)
Pontederiaceae weeds: common water hyacinth (Eichhornia crassipes), blue mud plantain (Heteranthera limosa), Mizuaoi (Monochoria korsakowii), and heartshape false pickerelweed (Monochoria vaginalis)
Commelinaceae weeds: common dayflower (Commelina communis), tropical spiderwort (Commelina benghalensis), erect dayflower (Commelina erecta), and Asian spiderwort (Murdannia keisak)

Poaceae weeds: common barnyardgrass (Echinochloa crus-galli), early barnyardgrass (Echinochloa oryzicola), barnyard grass (Echinochloa crus-galli var. formosensis), late watergrass (Echinochloa oryzoides), jungle rice (Echinochloa colona), Gulf cockspur (Echinochloa crus-pavonis), green foxtail (Setaria viridis), giant foxtail (Setaria faberi), yellow foxtail (Setaria glauca), knotroot foxtail (Setaria geniculata), southern crabgrass (Digitaria ciliaris), large crabgrass (Digitaria sanguinalis), Jamaican crabgrass (Digitaria horizontalis), sourgrass (Digitaria insularis), goosegrass (Eleusine indica), annual bluegrass (Poa annua), rough-stalked meadowgrass (Poa trivialis), Kentucky bluegrass (Poa pratensis), short-awn foxtail (Alopecurus aequalis), blackgrass (Alopecurus myosuroides), wild oat (Avena fatua), Johnsongrass (Sorghum halepense), shataken (Sorghum vulgare), quackgrass (Agropyron repens), Italian ryegrass (Lolium multiflorum), perennial ryegrass (Lolium perenne), rigid ryegrass (Lolium rigidum), rescue brome (Bromus catharticus), barren brome (Bromus sterilis), Japanese brome grass (Bromus japonicus), cheat (Bromus secalinus), cheatgrass (Bromus tectorum), foxtail barley (Hordeum jubatum), jointed goatgrass (Aegilops cylindrica), reed canarygrass (Phalaris arundinacea), little-seed canary grass (Phalaris minor), silky bentgrass (Apera spica-venti), fall panicum (Panicum dichotomiflorum), Texas panicum (Panicum texanum), guineagrass (Panicum maximum), broadleaf signalgrass (Brachiaria platyphylla), Congo signal grass (Brachiaria ruziziensis), Alexander grass (Brachiaria plantaginea), Surinam grass (Brachiaria decumbens), palisade grass (Brachiaria brizantha), creeping signalgrass (Brachiaria humidicola), southern sandbur (Cenchrus echinatus), field sandbur (Cenchrus pauciflorus), woolly cupgrass (Eriochloa villosa), feathery pennisetum (Pennisetum setosum), Rhodes grass (Chloris gayana), feathertop Rhodes grass (Chloris virgata), India lovegrass (Eragrostis pilosa), Natal grass (Rhynchelytrum repens), crowfoot grass (Dactyloctenium aegyptium), winkle grass (Ischaemum rugosum), swamp millet (Isachne globosa), common rice (Oryza sativa), bahiagrass (Paspalum notatum), coastal sand paspalum (Paspalum maritimum), mercergrass (Paspalum distichum), kikuyugrass (Pennisetum clandestinum), West Indies pennisetum (Pennisetum setosum), itch grass (Rottboellia cochinchinensis), Asian sprangletop (Leptochloa chinensis), salt-meadow grass (Leptochloa fascicularis), Christmas-tree grass (Leptochloa filiformis), Amazon sprangletop (Leptochloa panicoides), Japanese cutgrass (Leersia japonica), Sayanukagusa (Leersia sayanuka), cutgrass (Leersia oryzoides), Ukigaya (Glyceria leptorrhiza), sharpscale mannagrass (Glyceria acutiflora), great watergrass (Glyceria maxima), redtop (Agrostis gigantea), carpet bent (Agrostis stolonifera), Bermuda grass (Cynodon dactylon), cocksfoot (Dactylis glomerata), centipede grass (Eremochloa ophiuroides), tall fescue (Festuca arundinacea), red fescue (Festuca rubra), lalang (Imperata cylindrica), Chinese fairy grass (Miscanthus sinensis), switchgrass (Panicum virgatum), and Japanese lawngrass (Zoysia japonica)

Cyperaceae weeds: Asian flatsedge (Cyperus microiria), flatsedge (Cyperus iria), hedgehog cyperus (Cyperus compressus), small-flowered nutsedge (Cyperus difformis), lax-flat sedge (Cyperus flaccidus), Azegayatsuri (Cyperus globosus), Aogayatsuri (Cyperus nipponicus), fragrant flatsedge (Cyperus odoratus), mountain nutsedge (Cyperus serotinus), purple nutsedge (Cyperus rotundus), yellow nutsedge (Cyperus esculentus), pasture spike sedge (Kyllinga gracillima), green kyllinga (Kyllinga brevifolia), grasslike fimbristylis (Fimbristylis miliacea), annual fringerush (Fimbristylis dichotoma), slender spikerush (Eleocharis acicularis), Kuroguwai (Eleocharis kuroguwai), Japanese bulrush (Schoenoplectiella hotarui), hardstem bulrush (Schoenoplectiella juncoides), Taiwanyamai (Schoenoplectiella wallichii), rough-seed bulrush (Schoenoplectiella mucronatus), Kangarei (Schoenoplectiella triangulatus), Shizui (Schoenoplectiella nipponicus), triangular club-rush (Schoenoplectiella triqueter), Koukiyagara (Bolboschoenus koshevnikovii), and river bulrush (Bolboschoenus fluviatilis)
Equisetaceae weeds: field horsetail (Equisetum arvense), and marsh horsetail (Equisetum palustre)
Salviniaceae weeds: floating fern (Salvinia natans)
Azollaceae weeds: Japanese mosquitofern (Azolla japonica), and feathered mosquito fern (Azolla pinnata)
Marsileaceae weeds: clover fern (Marsilea quadrifolia)
Other: Filamentous algae (Pithophora, Cladophora), Bryopsida, liverwort, Anthocerotopsida, cyanobacteria, fern, and sucker of perennial crops (pomaceous fruits, stone fruits, berries, nuts, citrus, hops, grapes, etc.).

The variations within a species are not particularly limited for the above weeds. That is, those which have reduced susceptibility (also referred to as exhibit resistance) to specific herbicides are also included. The reduction of susceptibility may be that having a mutation at a target site (a target-site mutation), or may rely on a factor which is not a target-site mutation (a nontarget-site mutation). The target-site mutations include those in which an amino acid substitution has been occurred in a protein which is target-site due to a mutation in the nucleic acid portion (open reading frame) sequence corresponding to the amino acid sequence of the protein, and those overexpressing a target-site protein due to mutations such as deletion of a suppressor sequence, amplification of an enhancer sequence, or an increase in gene copy number in the promoter region. Examples of the nontarget-site mutations include enhancement of metabolism, malabsorption, transportation deficiency, out-of-system elimination and the like. Examples of factors for the enhancement of metabolism include those in which activity of metabolic enzymes such as cytochrome P450 monooxygenase, aryl acylamidase, esterase, and glutathione-S-transferase has been increased. Examples of out-of-system elimination include transportation to the vacuole by ABC transporters.

Examples of amino acid substitutions at target sites include the following. ALS: A122T, A122V, A122Y, P197S, P197H, P197T, P197R, P197L, P197Q, P197A, P1971, A205V, A205F, D376E, R377H, W574L, W574G, W574M, S653T, S653N, S6531, G654E or G654D; ACCase: I1781L, I1781V, I1781T, W1999C, W1999L, A2004V, W2027C, 12041N, 12041V, D2078G or C2088R, G2096A, G2096S; PPX2: G210A, R98L, R98M, R98G, R98H, G399A; EPSP: T1021, P106S, P106A or P106Lo

Weeds which can be controlled by the composition A containing one or more components having herbicidal activity selected from the group (i) and the group (j) as the present component may have a plurality of the amino acid substitutions described above. In the case, the plurality of the amino acid substitutions may be in the same protein or in the different proteins. It may also have a plurality of target-site mutations and nontarget-site mutations.

Examples of the weeds having target-site mutation include the following. Palmer amaranth which has an amino acid substitution of G210A, R98M, R98G or G399A in PPOX2;
Waterhemp which has an amino acid substitution of G210Δ, R98M, R98G or G399A in PPX2;
common ragweed which has an amino acid substitution of R98L in PPX2;
rigid ryegrass which has an amino acid substitution of R98H in PPX2;
goosegrass which has an amino acid substitution of T1021, P106S, P106A or P106L in EPSP;
rigid ryegrass which has an amino acid substitution of T1021, P106S, P106A or P106L in EPSP;
sourgrass which has an amino acid substitution of T1021, P106S, P106A or P106L in EPSP;
waterhemp which has an amino acid substitution of T1021, P106S, P106A or P106L in EPSP;
jungle rice which has an amino acid substitution of T1021, P106S, P106A or P106L in EPSP.

Palmer amaranth, waterhemp and common ragweed which have the target-site mutations above in PPX2 exhibit resistance to PPO inhibitors such as lactofen, fomesafen and flumioxazin.

Examples of the weeds having a plurality of amino acid substitutions above include goosegrass, Italian ryegrass, rigid ryegrass, sourgrass, tall waterhemp and jungle rice which have amino acid substitutions of T1021 and P106S to have resistance to glyphosate.

In addition, examples of other weeds include the following. Palmer amaranth, waterhemp and kochia which have reduced susceptibility to glyphosate due to overexpression of the EPSP gene;
Jungle rice which has reduced susceptibility to glyphosate due to increase in expression of aldo-keto reductase.
Marestail, Guernsey fleabane and fleabane which have reduced susceptibility to glyphosate due to involvement of ABC transporters thereby having resistance.

### EXAMPLES

The present invention is described in more detail below with examples of compositions, formulations, applications, and tests, however the present invention is not limited to these examples only.

Examples of embodiments of the composition A include the following.

Group 1, wherein a combination of natural pyrethrin and the present component is any combination of a “list of two active ingredients” described below, consists of the composition A consisting of 2 parts of natural pyrethrin and 0.5 parts of the present component.

In the “list of two active ingredients”, for example, ‘natural pyrethrin+spinetoram’ means a combination of natural pyrethrin and spinetoram.

The “list of two active ingredients”: natural pyrethrin+spinetoram, natural pyrethrin+clothianidin, natural pyrethrin+triflumezopyrim, natural pyrethrin+isotianil, natural pyrethrin+furametpyr, natural pyrethrin+inpyrfluxam, natural pyrethrin+orysastrobin, natural pyrethrin+phthalide, natural pyrethrin+validamycin A, natural pyrethrin+ferimzone, natural pyrethrin+azoxystrobin.

Group 2, wherein the combination of natural pyrethrin and the present component is any combination of the “list of two active ingredients” described above, consists of the composition A consisting of 2 parts of natural pyrethrin and 1.5 parts of the present component.

Group 3, wherein the combination of natural pyrethrin and the present component is any combination of the “list of two active ingredients” described above, consists of the composition A consisting of 1 part of natural pyrethrin and 1 part of the present component.

Group 4, wherein the combination of natural pyrethrin and the present component is any combination of the “list of two active ingredients” described above, consists of the composition A consisting of 1 part of natural pyrethrin and 2 parts of the present component.

Group 5, wherein the combination of natural pyrethrin and the present component is any combination of the “list of two active ingredients” described above, consists of the composition A consisting of 2 parts of natural pyrethrin and 7 parts of the present component.

Group 6, wherein the combination of natural pyrethrin and the present component is any combination of the “list of two active ingredients” described above, consists of the composition A consisting of 1 part of natural pyrethrin and 5 parts of the present component.

Group 7, wherein the combination of natural pyrethrin and the present component is any combination of the “list of two active ingredients” described above, consists of the composition A consisting of 1 part of natural pyrethrin and 15 parts of the present component.

Group 8, wherein the combination of natural pyrethrin and the present component is any combination of the “list of two active ingredients” described above, consists of the composition A consisting of 1 part of natural pyrethrin and 3 parts of the present component.

Group 9, wherein the combination of natural pyrethrin and the present component is any combination of the “list of two active ingredients” described above, consists of the composition A consisting of 5 parts of natural pyrethrin and 6.6 parts of the present component.

Group 10, wherein the combination of natural pyrethrin and the present component is any combination of the “list of two active ingredients” described above, consists of the composition A consisting of 1 part of natural pyrethrin and 4 parts of the present component.

Group 11, wherein the combination of natural pyrethrin and the present component is any combination of the “list of two active ingredients” described above, consists of the composition A consisting of 5 parts of natural pyrethrin and 8 parts of the present component.

Group 12, wherein a combination of natural pyrethrin, the present component 1 and the present component 2 is any combination of a “list of three active ingredients” described below, consists of the composition A consisting of 2 parts of natural pyrethrin, 0.5 parts of the present component 1 and 1.5 parts of the present component 2.

In the “list of three active ingredients”, for example, ‘natural pyrethrin+allethrin+cypermethrin’ means a combination of natural pyrethrin, allethrin and cypermethrin, and the present component 1 is allethrin and the present component 2 is cypermethrin.

The “list of three active ingredients”: natural pyrethrin+allethrin+azadirachtin
natural pyrethrin+allethrin+Spinosad
natural pyrethrin+allethrin+veratridine
natural pyrethrin+allethrin+dill extract
natural pyrethrin+bioallethrin+azadirachtin
natural pyrethrin+bioallethrin+spinosad
natural pyrethrin+bioallethrin+veratridine
natural pyrethrin+bioallethrin+dill extract
natural pyrethrin+bioresmethrin+azadirachtin
natural pyrethrin+bioresmethrin+spinosad
natural pyrethrin+bioresmethrin+veratridine
natural pyrethrin+bioresmethrin+dill extract
natural pyrethrin+dimefluthrin+azadirachtin
natural pyrethrin+dimefluthrin+spinosad
natural pyrethrin+dimefluthrin+veratridine
natural pyrethrin+dimefluthrin+dill extract
natural pyrethrin+empenthrin+azadirachtin
natural pyrethrin+empenthrin+Spinosad
natural pyrethrin+empenthrin+veratridine
natural pyrethrin+empenthrin+dill extract
natural pyrethrin+epsilon-metofluthrin+azadirachtin
natural pyrethrin+epsilon-metofluthrin+spinosad
natural pyrethrin+epsilon-metofluthrin+veratridine
natural pyrethrin+epsilon-metofluthrin+dill extract
natural pyrethrin+epsilon-momfluorothrin+azadirachtin
natural pyrethrin+epsilon-momfluorothrin+spinosad
natural pyrethrin+epsilon-momfluorothrin+veratridine
natural pyrethrin+epsilon-momfluorothrin+dill extract
natural pyrethrin+flumethrin+azadirachtin
natural pyrethrin+flumethrin+spinosad
natural pyrethrin+flumethrin+veratridine
natural pyrethrin+flumethrin+dill extract
natural pyrethrin+furamethrin+azadirachtin
natural pyrethrin+furamethrin+Spinosad
natural pyrethrin+furamethrin+veratridine
natural pyrethrin+furamethrin+dill extract
natural pyrethrin+imiprothrin+azadirachtin
natural pyrethrin+imiprothrin+Spinosad
natural pyrethrin+imiprothrin+veratridine
natural pyrethrin+imiprothrin+dill extract
natural pyrethrin+meperfluthrin+azadirachtin
natural pyrethrin+meperfluthrin+spinosad
natural pyrethrin+meperfluthrin+veratridine
natural pyrethrin+meperfluthrin+dill extract
natural pyrethrin+metofluthrin+azadirachtin
natural pyrethrin+metofluthrin+spinosad
natural pyrethrin+metofluthrin+veratridine
natural pyrethrin+metofluthrin+dill extract
natural pyrethrin+momfluorothrin+azadirachtin
natural pyrethrin+momfluorothrin+spinosad
natural pyrethrin+momfluorothrin+veratridine
natural pyrethrin+momfluorothrin+dill extract
natural pyrethrin+prallethrin+azadirachtin
natural pyrethrin+prallethrin+Spinosad natural pyrethrin+prallethrin+veratridine
natural pyrethrin+prallethrin+dill extract
natural pyrethrin+profluthrin+azadirachtin
natural pyrethrin+profluthrin+spinosad
natural pyrethrin+profluthrin+veratridine
natural pyrethrin+profluthrin+dill extract
natural pyrethrin+resmethrin+azadirachtin
natural pyrethrin+resmethrin+spinosad
natural pyrethrin+resmethrin+veratridine
natural pyrethrin+resmethrin+dill extract
natural pyrethrin+tetramethrin+azadirachtin
natural pyrethrin+tetramethrin+spinosad
natural pyrethrin+tetramethrin+veratridine
natural pyrethrin+tetramethrin+dill extract
natural pyrethrin+tetramethylfluthrin+azadirachtin
natural pyrethrin+tetramethylfluthrin+spinosad
natural pyrethrin+tetramethylfluthrin+veratridine
natural pyrethrin+tetramethylfluthrin+dill extract
natural pyrethrin+transfluthrin+azadirachtin
natural pyrethrin+transfluthrin+spinosad
natural pyrethrin+transfluthrin+veratridine
natural pyrethrin+transfluthrin+dill extract
natural pyrethrin+renofluthrin+azadirachtin
natural pyrethrin+renofluthrin+spinosad
natural pyrethrin+renofluthrin+veratridine
natural pyrethrin+renofluthrin+dill extract
natural pyrethrin+teflumethrin+azadirachtin
natural pyrethrin+teflumethrin+spinosad
natural pyrethrin+teflumethrin+veratridine
natural pyrethrin+teflumethrin+dill extract
natural pyrethrin+alpha-cypermethrin+azadirachtin
natural pyrethrin+alpha-cypermethrin+spinosad
natural pyrethrin+alpha-cypermethrin+veratridine
natural pyrethrin+alpha-cypermethrin+dill extract
natural pyrethrin+beta-cyfluthrin+azadirachtin
natural pyrethrin+beta-cyfluthrin+spinosad
natural pyrethrin+beta-cyfluthrin+veratridine
natural pyrethrin+beta-cyfluthrin+dill extract
natural pyrethrin+beta-cypermethrin+azadirachtin
natural pyrethrin+beta-cypermethrin+spinosad
natural pyrethrin+beta-cypermethrin+veratridine
natural pyrethrin+beta-cypermethrin+dill extract
natural pyrethrin+bifenthrin+azadirachtin
natural pyrethrin+bifenthrin+spinosad
natural pyrethrin+bifenthrin+veratridine
natural pyrethrin+bifenthrin+dill extract
natural pyrethrin+cyfluthrin+azadirachtin
natural pyrethrin+cyfluthrin+spinosad
natural pyrethrin+cyfluthrin+veratridine
natural pyrethrin+cyfluthrin+dill extract
natural pyrethrin+cyhalothrin+azadirachtin
natural pyrethrin+cyhalothrin+spinosad
natural pyrethrin+cyhalothrin+veratridine
natural pyrethrin+cyhalothrin+dill extract
natural pyrethrin+cypermethrin+azadirachtin
natural pyrethrin+cypermethrin+spinosad
natural pyrethrin+cypermethrin+veratridine
natural pyrethrin+cypermethrin+dill extract
natural pyrethrin+cyphenothrin+azadirachtin
natural pyrethrin+cyphenothrin+spinosad
natural pyrethrin+cyphenothrin+veratridine
natural pyrethrin+cyphenothrin+dill extract
natural pyrethrin+deltamethrin+azadirachtin
natural pyrethrin+deltamethrin+spinosad
natural pyrethrin+deltamethrin+veratridine
natural pyrethrin+deltamethrin+dill extract
natural pyrethrin+esfenvalerate+azadirachtin
natural pyrethrin+esfenvalerate+spinosad
natural pyrethrin+esfenvalerate+veratridine
natural pyrethrin+esfenvalerate+dill extract
natural pyrethrin+etofenprox+azadirachtin
natural pyrethrin+etofenprox+spinosad
natural pyrethrin+etofenprox+veratridine
natural pyrethrin+etofenprox+dill extract
natural pyrethrin+fenvalerate+azadirachtin
natural pyrethrin+fenvalerate+spinosad
natural pyrethrin+fenvalerate+veratridine
natural pyrethrin+fenvalerate+dill extract
natural pyrethrin+fenpropathrin+azadirachtin
natural pyrethrin+fenpropathrin+spinosad
natural pyrethrin+fenpropathrin+veratridine
natural pyrethrin+fenpropathrin+dill extract
natural pyrethrin+gamma-cyhalothrin+azadirachtin
natural pyrethrin+gamma-cyhalothrin+spinosad
natural pyrethrin+gamma-cyhalothrin+veratridine
natural pyrethrin+gamma-cyhalothrin+dill extract
natural pyrethrin+lambda-cyhalothrin+azadirachtin
natural pyrethrin+lambda-cyhalothrin+spinosad
natural pyrethrin+lambda-cyhalothrin+veratridine
natural pyrethrin+lambda-cyhalothrin+dill extract
natural pyrethrin+permethrin+azadirachtin
natural pyrethrin+permethrin+spinosad
natural pyrethrin+permethrin+veratridine
natural pyrethrin+permethrin+dill extract
natural pyrethrin+phenothrin+azadirachtin
natural pyrethrin+phenothrin+spinosad
natural pyrethrin+phenothrin+veratridine
natural pyrethrin+phenothrin+dill extract
natural pyrethrin+sigma-cypermethrin+azadirachtin
natural pyrethrin+sigma-cypermethrin+spinosad
natural pyrethrin+sigma-cypermethrin+veratridine
natural pyrethrin+sigma-cypermethrin+dill extract
natural pyrethrin+silafluofen+azadirachtin
natural pyrethrin+silafluofen+spinosad
natural pyrethrin+silafluofen+veratridine
natural pyrethrin+silafluofen+dill extract
natural pyrethrin+theta-cypermethrin+azadirachtin
natural pyrethrin+theta-cypermethrin+spinosad
natural pyrethrin+theta-cypermethrin+veratridine
natural pyrethrin+theta-cypermethrin+dill extract
natural pyrethrin+tralomethrin+azadirachtin
natural pyrethrin+tralomethrin+spinosad
natural pyrethrin+tralomethrin+veratridine
natural pyrethrin+tralomethrin+dill extract
natural pyrethrin+zeta-cypermethrin+azadirachtin
natural pyrethrin+zeta-cypermethrin+spinosad
natural pyrethrin+zeta-cypermethrin+veratridine
natural pyrethrin+zeta-cypermethrin+dill extract
natural pyrethrin+acetamiprid+dill extract
natural pyrethrin+afoxolaner+dill extract
natural pyrethrin+amidoflumet+dill extract
natural pyrethrin+azadirachtin+amitraz
natural pyrethrin+azadirachtin+bistrifluron
natural pyrethrin+azadirachtin+cyromazine
natural pyrethrin+azadirachtin+diflubenzuron
natural pyrethrin+azadirachtin+etoxazole
natural pyrethrin+azadirachtin+hexaflumuron
natural pyrethrin+azadirachtin+hydroprene
natural pyrethrin+azadirachtin+lufenuron
natural pyrethrin+azadirachtin+methoprene
natural pyrethrin+azadirachtin+metoxadiazone
natural pyrethrin+azadirachtin+novaluron
natural pyrethrin+azadirachtin+noviflumuron
natural pyrethrin+azadirachtin+pyriproxyfen
natural pyrethrin+azadirachtin+teflubenzuron
natural pyrethrin+azadirachtin+triflumuron
natural pyrethrin+azadirachtin+1-dodecyl-1H-imidazole
natural pyrethrin+azadirachtin)+N-(2-ethylhexyl)-8,9,10-trinorborn-5-ene-2,3-dicarboximide
natural pyrethrin+azadirachtin+bucarpolate
natural pyrethrin+azadirachtin+N,N-dibutyl-4-chlorobenzenesulfonamide
natural pyrethrin+azadirachtin+diethylmaleate
natural pyrethrin+azadirachtin+piperonyl butoxide
natural pyrethrin+azadirachtin+piperonyl cyclonene
natural pyrethrin+azadirachtin+piprotal
natural pyrethrin+azadirachtin+propyl isome
natural pyrethrin+azadirachtin+safroxan
natural pyrethrin+azadirachtin+sesamex
natural pyrethrin+azadirachtin+sesamolin
natural pyrethrin+azadirachtin+sulfoxide
natural pyrethrin+azadirachtin+Verbutin
natural pyrethrin+azadirachtin+DMC (1,1-bis(4-chlorophenyl)ethanol)
natural pyrethrin+azadirachtin+FDMC (1,1-bis(4-chlorophenyl)-2,2,2-trifluoroethanol)
natural pyrethrin+azadirachtin+ETN (1,2-epoxy-1,2,3,4-tetrahydronaphthalene)
natural pyrethrin+azadirachtin+ETP (1,1,1-trichloro-2,3-expoxypropane)
natural pyrethrin+azadirachtin+PSCP (phenylsaligenin cyclic phosphate)
natural pyrethrin+azadirachtin+TBPT (S,S,S-tributyl phosphorotrithioate)
natural pyrethrin+azadirachtin+TPP (triphenyl phosphate)
natural pyrethrin+azadirachtin+anise star extract
natural pyrethrin+azadirachtin+angelica extract
natural pyrethrin+azadirachtin+ambrate extract
natural pyrethrin+azadirachtin+catnip extract
natural pyrethrin+azadirachtin+ylang-ylang extract
natural pyrethrin+azadirachtin+wintergreen extract
natural pyrethrin+azadirachtin+onion extract
natural pyrethrin+azadirachtin+olibanum extract
natural pyrethrin+azadirachtin+oregano extract
natural pyrethrin+azadirachtin+garlic extract
natural pyrethrin+azadirachtin+chamomile extract
natural pyrethrin+azadirachtin+cardamom extract
natural pyrethrin+azadirachtin+galbanum extract
natural pyrethrin+azadirachtin+carrot seed extract
natural pyrethrin+azadirachtin+guaiac wood extract
natural pyrethrin+azadirachtin+camphor tree extract
natural pyrethrin+azadirachtin+clove extract
natural pyrethrin+azadirachtin+shell ginger extract
natural pyrethrin+azadirachtin+pepper extract
natural pyrethrin+azadirachtin+coriander extract
natural pyrethrin+azadirachtin+Japanese basil extract
natural pyrethrin+azadirachtin+cedarwood extract
natural pyrethrin+azadirachtin+citronella extract
natural pyrethrin+azadirachtin+cinnamon extract
natural pyrethrin+azadirachtin+ginger extract
natural pyrethrin+azadirachtin+sweet flag extract
natural pyrethrin+azadirachtin+cedar extract
natural pyrethrin+azadirachtin+star anise extract
natural pyrethrin+azadirachtin+spearmint extract
natural pyrethrin+azadirachtin+Seiyonikkei extract
natural pyrethrin+azadirachtin+yarrow extract
natural pyrethrin+azadirachtin+sage extract
natural pyrethrin+azadirachtin+geranium extract
natural pyrethrin+azadirachtin+celery extract
natural pyrethrin+azadirachtin+Cnidium Rhizome extract
natural pyrethrin+azadirachtin+turmeric extract
natural pyrethrin+azadirachtin+thyme extract
natural pyrethrin+azadirachtin+tarragon extract
natural pyrethrin+azadirachtin+cheddar leaf extract
natural pyrethrin+azadirachtin+tea tree extract
natural pyrethrin+azadirachtin+dill extract
natural pyrethrin+azadirachtin+neroli extract
natural pyrethrin+azadirachtin+violet extract
natural pyrethrin+azadirachtin+pine extract
natural pyrethrin+azadirachtin+basil extract
natural pyrethrin+azadirachtin+parsley extract
natural pyrethrin+azadirachtin+patchouli extract
natural pyrethrin+azadirachtin+mint extract
natural pyrethrin+azadirachtin+palmarosa extract
natural pyrethrin+azadirachtin+valerian extract
natural pyrethrin+azadirachtin+hyssop extract
natural pyrethrin+azadirachtin+cypress extract
natural pyrethrin+azadirachtin+hiba extract
natural pyrethrin+azadirachtin+pimenta extract
natural pyrethrin+azadirachtin+fennel extract
natural pyrethrin+azadirachtin+bay extract
natural pyrethrin+azadirachtin+vetiver extract
natural pyrethrin+azadirachtin+penyroyal extract
natural pyrethrin+azadirachtin+peppermint extract
natural pyrethrin+azadirachtin+perilla extract
natural pyrethrin+azadirachtin+bergamot extract
natural pyrethrin+azadirachtin+berber extract
natural pyrethrin+azadirachtin+marjoram extract
natural pyrethrin+azadirachtin+manuka extract
natural pyrethrin+azadirachtin+mandarin extract
natural pyrethrin+azadirachtin+eucalyptus extract
natural pyrethrin+azadirachtin+artemisia extract
natural pyrethrin+azadirachtin+Angelica dahurica extract
natural pyrethrin+azadirachtin+lime extract
natural pyrethrin+azadirachtin+lavandin extract
natural pyrethrin+azadirachtin+lavender extract
natural pyrethrin+azadirachtin+lemongrass extract
natural pyrethrin+azadirachtin+rosemary extract and laurel extract
natural pyrethrin+azadirachtin+anthraquinone
natural pyrethrin+azadirachtin+chloralose
natural pyrethrin+azadirachtin+acrep
natural pyrethrin+azadirachtin+butopyronoxyl
natural pyrethrin+azadirachtin+camphor
natural pyrethrin+azadirachtin+d-camphor
natural pyrethrin+azadirachtin+carboxide
natural pyrethrin+azadirachtin+dibutyl phthalate
natural pyrethrin+azadirachtin+deet
natural pyrethrin+azadirachtin+dimethyl carbate
natural pyrethrin+azadirachtin+dimethyl phthalate
natural pyrethrin+azadirachtin+dibutyl succinate
natural pyrethrin+azadirachtin+dibutyl adipate
natural pyrethrin+azadirachtin+ethohexadiol
natural pyrethrin+azadirachtin+hexamide
natural pyrethrin+azadirachtin+icaridin
natural pyrethrin+azadirachtin+methoquin-butyl
natural pyrethrin+azadirachtin+methylneodecanamide
natural pyrethrin+azadirachtin+2-(octylthio)ethanol
natural pyrethrin+azadirachtin+butoxypolypropylene glycol
natural pyrethrin+azadirachtin+oxamate
natural pyrethrin+azadirachtin+quwenzhi
natural pyrethrin+azadirachtin+quyingding
natural pyrethrin+azadirachtin+zengxiaon
natural pyrethrin+azadirachtin+rebemide
natural pyrethrin+azadirachtin+copper naphthenate
natural pyrethrin+azadirachtin+zinc naphthenate
natural pyrethrin+azamethiphos+dill extract
natural pyrethrin+bendiocarb+dill extract
natural pyrethrin+broflanilide+dill extract
natural pyrethrin+cartap+dill extract
natural pyrethrin+cartap hydrochloride+dill extract
natural pyrethrin+chlorantraniliprole+dill extract
natural pyrethrin+chlorfenapyr+dill extract
natural pyrethrin+chlorfluazuron+dill extract
natural pyrethrin+chlorpyrifos+dill extract
natural pyrethrin+chlorpyrifos-methyl+dill extract
natural pyrethrin+clothianidin+dill extract
natural pyrethrin+cyantraniliprole+dill extract
natural pyrethrin+cyclaniliprole+dill extract
natural pyrethrin+cyproflanilide+dill extract
natural pyrethrin+dichlorvos+dill extract
natural pyrethrin+dicloromezotiaz+dill extract
natural pyrethrin+dinotefuran+dill extract
natural pyrethrin+ethiprole+dill extract
natural pyrethrin+fenitrothion+dill extract
natural pyrethrin+fenobucarb+dill extract
natural pyrethrin+fenoxycarb+dill extract
natural pyrethrin+fenthion+dill extract
natural pyrethrin+fipronil+dill extract
natural pyrethrin+flubendiamide+dill extract
natural pyrethrin+fluralaner+dill extract
natural pyrethrin+fluxametamide+dill extract
natural pyrethrin+GS-omega/kappa HXTX-Hvla peptide+dill extract
natural pyrethrin+hydramethylnon+dill extract
natural pyrethrin+imidacloprid+dill extract
natural pyrethrin+indoxacarb+dill extract
natural pyrethrin+isocycloseram+dill extract
natural pyrethrin+ivermectin+dill extract
natural pyrethrin+lotilaner+dill extract
natural pyrethrin+metaflumizone+dill extract
natural pyrethrin+metoxadiazone+dill extract
natural pyrethrin+nicofluprole+dill extract
natural pyrethrin+nitenpyram+dill extract
natural pyrethrin+oxazosulfyl+dill extract
natural pyrethrin+propetamphos+dill extract
natural pyrethrin+propoxur+dill extract
natural pyrethrin+pyriprole+dill extract
natural pyrethrin+rotenone+dill extract
natural pyrethrin+sarolaner+dill extract
natural pyrethrin+selamectin+dill extract
natural pyrethrin+spinetoram+dill extract
natural pyrethrin+spinosad+amitraz
natural pyrethrin+spinosad+bistrifluron
natural pyrethrin+spinosad+cyromazine
natural pyrethrin+spinosad+diflubenzuron
natural pyrethrin+spinosad+etoxazole
natural pyrethrin+spinosad+hexaflumuron
natural pyrethrin+spinosad+hydroprene
natural pyrethrin+spinosad+lufenuron
natural pyrethrin+spinosad+methoprene
natural pyrethrin+spinosad+metoxadiazone
natural pyrethrin+spinosad+novaluron
natural pyrethrin+spinosad+noviflumuron
natural pyrethrin+spinosad+pyriproxyfen
natural pyrethrin+spinosad+teflubenzuron
natural pyrethrin+spinosad+triflumuron
natural pyrethrin+spinosad+1-dodecyl-1H-imidazole
natural pyrethrin+spinosad+N-(2-ethylhexyl)-8,9,10-trinorborn-5-ene-2,3-dicarboximide
natural pyrethrin+spinosad+bucarpolate
natural pyrethrin+spinosad+N,N-dibutyl-4-chlorobenzenesulfonamide
natural pyrethrin+spinosad+diethylmaleate
natural pyrethrin+spinosad+piperonyl butoxide
natural pyrethrin+spinosad+piperonyl cyclonene
natural pyrethrin+spinosad+piprotal
natural pyrethrin+spinosad+propyl isome
natural pyrethrin+spinosad+safroxan
natural pyrethrin+spinosad+sesamex
natural pyrethrin+spinosad+sesamolin
natural pyrethrin+spinosad+sulfoxide
natural pyrethrin+spinosad+Verbutin
natural pyrethrin+spinosad+DMC (1,1-bis(4-chlorophenyl)ethanol)
natural pyrethrin+spinosad+FDMC (1,1-bis(4-chlorophenyl)-2,2,2-trifluoroethanol)
natural pyrethrin+spinosad+ETN (1,2-epoxy-1,2,3,4-tetrahydronaphthalene)
natural pyrethrin+spinosad+ETP (1,1,1-trichloro-2,3-expoxypropane)
natural pyrethrin+spinosad+PSCP (phenylsaligenin cyclic phosphate)
natural pyrethrin+spinosad+TBPT (S,S,S-tributyl phosphorotrithioate)
natural pyrethrin+spinosad+TPP (triphenyl phosphate)
natural pyrethrin+spinosad+anise star extract
natural pyrethrin+spinosad+angelica extract
natural pyrethrin+spinosad+ambrate extract
natural pyrethrin+spinosad+catnip extract
natural pyrethrin+spinosad+ylang-ylang extract
natural pyrethrin+spinosad+wintergreen extract
natural pyrethrin+spinosad+onion extract
natural pyrethrin+spinosad+olibanum extract
natural pyrethrin+spinosad+oregano extract
natural pyrethrin+spinosad+garlic extract
natural pyrethrin+spinosad+chamomile extract
natural pyrethrin+spinosad+cardamom extract
natural pyrethrin+spinosad+galbanum extract
natural pyrethrin+spinosad+carrot seed extract
natural pyrethrin+spinosad+guaiac wood extract
natural pyrethrin+spinosad+camphor tree extract
natural pyrethrin+spinosad+clove extract
natural pyrethrin+spinosad+shell ginger extract
natural pyrethrin+spinosad+pepper extract
natural pyrethrin+spinosad+coriander extract
natural pyrethrin+spinosad+Japanese basil extract
natural pyrethrin+spinosad+cedarwood extract
natural pyrethrin+spinosad+citronella extract
natural pyrethrin+spinosad+cinnamon extract
natural pyrethrin+spinosad+ginger extract
natural pyrethrin+spinosad+sweet flag extract
natural pyrethrin+spinosad+cedar extract
natural pyrethrin+spinosad+star anise extract
natural pyrethrin+spinosad+spearmint extract
natural pyrethrin+spinosad+Seiyonikkei extract
natural pyrethrin+spinosad+yarrow extract
natural pyrethrin+spinosad+sage extract
natural pyrethrin+spinosad+geranium extract
natural pyrethrin+spinosad+celery extract
natural pyrethrin+spinosad+Cnidium Rhizome extract
natural pyrethrin+spinosad+turmeric extract
natural pyrethrin+spinosad+thyme extract
natural pyrethrin+spinosad+tarragon extract
natural pyrethrin+spinosad+cheddar leaf extract
natural pyrethrin+spinosad+tea tree extract
natural pyrethrin+spinosad+dill extract
natural pyrethrin+spinosad+neroli extract
natural pyrethrin+spinosad+violet extract
natural pyrethrin+spinosad+pine extract
natural pyrethrin+spinosad+basil extract
natural pyrethrin+spinosad+parsley extract
natural pyrethrin+spinosad+patchouli extract
natural pyrethrin+spinosad+mint extract
natural pyrethrin+spinosad+palmarosa extract
natural pyrethrin+spinosad+valerian extract
natural pyrethrin+spinosad+hyssop extract
natural pyrethrin+spinosad+cypress extract
natural pyrethrin+spinosad+hiba extract
natural pyrethrin+spinosad+pimenta extract
natural pyrethrin+spinosad+fennel extract
natural pyrethrin+spinosad+bay extract
natural pyrethrin+spinosad+vetiver extract
natural pyrethrin+spinosad+penyroyal extract
natural pyrethrin+spinosad+peppermint extract
natural pyrethrin+spinosad+perilla extract
natural pyrethrin+spinosad+bergamot extract
natural pyrethrin+spinosad+berber extract
natural pyrethrin+spinosad+marjoram extract
natural pyrethrin+spinosad+manuka extract
natural pyrethrin+spinosad+mandarin extract
natural pyrethrin+spinosad+eucalyptus extract
natural pyrethrin+spinosad+artemisia extract
natural pyrethrin+spinosad+Angelica dahurica extract
natural pyrethrin+spinosad+lime extract
natural pyrethrin+spinosad+lavandin extract
natural pyrethrin+spinosad+lavender extract
natural pyrethrin+spinosad+lemongrass extract
natural pyrethrin+spinosad+rosemary extract and laurel extract
natural pyrethrin+spinosad+anthraquinone
natural pyrethrin+spinosad+chloralose
natural pyrethrin+spinosad+acrep
natural pyrethrin+spinosad+butopyronoxyl
natural pyrethrin+spinosad+camphor
natural pyrethrin+spinosad+d-camphor
natural pyrethrin+spinosad+carboxide
natural pyrethrin+spinosad+dibutyl phthalate
natural pyrethrin+spinosad+deet
natural pyrethrin+spinosad+dimethyl carbate
natural pyrethrin+spinosad+dimethyl phthalate
natural pyrethrin+spinosad+dibutyl succinate
natural pyrethrin+spinosad+dibutyl adipate
natural pyrethrin+spinosad+ethohexadiol
natural pyrethrin+spinosad+hexamide
natural pyrethrin+spinosad+icaridin
natural pyrethrin+spinosad+methoquin-butyl
natural pyrethrin+spinosad+methylneodecanamide
natural pyrethrin+spinosad+2-(octylthio)ethanol
natural pyrethrin+spinosad+butoxypolypropylene glycol
natural pyrethrin+spinosad+oxamate
natural pyrethrin+spinosad+quwenzhi
natural pyrethrin+spinosad+quyingding
natural pyrethrin+spinosad+zengxiaon
natural pyrethrin+spinosad+rebemide
natural pyrethrin+spinosad+copper naphthenate
natural pyrethrin+spinosad+zinc naphthenate
natural pyrethrin+sulfoxaflor+dill extract
natural pyrethrin+temephos+dill extract
natural pyrethrin+tetrachlorantraniliprole+dill extract
natural pyrethrin+tetraniliprole+dill extract
natural pyrethrin+thiacloprid+dill extract
natural pyrethrin+thiamethoxam+dill extract
natural pyrethrin+tolfenpyrad+dill extract
natural pyrethrin+veratridine+amitraz
natural pyrethrin+veratridine+bistrifluron
natural pyrethrin+veratridine+cyromazine
natural pyrethrin+veratridine+diflubenzuron
natural pyrethrin+veratridine+etoxazole
natural pyrethrin+veratridine+hexaflumuron
natural pyrethrin+veratridine+hydroprene
natural pyrethrin+veratridine+lufenuron
natural pyrethrin+veratridine+methoprene
natural pyrethrin+veratridine+metoxadiazone
natural pyrethrin+veratridine+novaluron
natural pyrethrin+veratridine+noviflumuron
natural pyrethrin+veratridine+pyriproxyfen
natural pyrethrin+veratridine+teflubenzuron
natural pyrethrin+veratridine+triflumuron
natural pyrethrin+veratridine+1-dodecyl-1H-imidazole
natural pyrethrin+veratridine+N-(2-ethylhexyl)-8,9,10-trinorborn-5-ene-2,3-dicarboximide
natural pyrethrin+veratridine+bucarpolate
natural pyrethrin+veratridine+N,N-dibutyl-4-chlorobenzenesulfonamide
natural pyrethrin+veratridine+diethylmaleate
natural pyrethrin+veratridine+piperonyl butoxide
natural pyrethrin+veratridine+piperonyl cyclonene
natural pyrethrin+veratridine+piprotal
natural pyrethrin+veratridine+propyl isome
natural pyrethrin+veratridine+safroxan
natural pyrethrin+veratridine+sesamex
natural pyrethrin+veratridine+sesamolin
natural pyrethrin+veratridine+sulfoxide
natural pyrethrin+veratridine+Verbutin
natural pyrethrin+veratridine+DMC (1,1-bis(4-chlorophenyl)ethanol)
natural pyrethrin+veratridine+FDMC (1,1-bis(4-chlorophenyl)-2,2,2-trifluoroethanol)
natural pyrethrin+veratridine+ETN (1,2-epoxy-1,2,3,4-tetrahydronaphthalene)
natural pyrethrin+veratridine+ETP (1,1,1-trichloro-2,3-expoxypropane)
natural pyrethrin+veratridine+PSCP (phenylsaligenin cyclic phosphate)
natural pyrethrin+veratridine+TBPT (S,S,S-tributyl phosphorotrithioate)
natural pyrethrin+veratridine+TPP (triphenyl phosphate)
natural pyrethrin+veratridine+anise star extract
natural pyrethrin+veratridine+angelica extract
natural pyrethrin+veratridine+ambrate extract
natural pyrethrin+veratridine+catnip extract
natural pyrethrin+veratridine+ylang-ylang extract
natural pyrethrin+veratridine+wintergreen extract
natural pyrethrin+veratridine+onion extract
natural pyrethrin+veratridine+olibanum extract
natural pyrethrin+veratridine+oregano extract
natural pyrethrin+veratridine+garlic extract
natural pyrethrin+veratridine+chamomile extract
natural pyrethrin+veratridine+cardamom extract
natural pyrethrin+veratridine+galbanum extract
natural pyrethrin+veratridine+carrot seed extract
natural pyrethrin+veratridine+guaiac wood extract
natural pyrethrin+veratridine+camphor tree extract
natural pyrethrin+veratridine+clove extract
natural pyrethrin+veratridine+shell ginger extract
natural pyrethrin+veratridine+pepper extract
natural pyrethrin+veratridine+coriander extract
natural pyrethrin+veratridine+Japanese basil extract
natural pyrethrin+veratridine+cedarwood extract
natural pyrethrin+veratridine+citronella extract
natural pyrethrin+veratridine+cinnamon extract
natural pyrethrin+veratridine+ginger extract
natural pyrethrin+veratridine+sweet flag extract
natural pyrethrin+veratridine+cedar extract
natural pyrethrin+veratridine+star anise extract
natural pyrethrin+veratridine+spearmint extract
natural pyrethrin+veratridine+Seiyonikkei extract
natural pyrethrin+veratridine+yarrow extract
natural pyrethrin+veratridine+sage extract
natural pyrethrin+veratridine+geranium extract
natural pyrethrin+veratridine+celery extract
natural pyrethrin+veratridine+Cnidium Rhizome extract
natural pyrethrin+veratridine+turmeric extract
natural pyrethrin+veratridine+thyme extract
natural pyrethrin+veratridine+tarragon extract
natural pyrethrin+veratridine+cheddar leaf extract
natural pyrethrin+veratridine+tea tree extract
natural pyrethrin+veratridine+dill extract
natural pyrethrin+veratridine+neroli extract
natural pyrethrin+veratridine+violet extract
natural pyrethrin+veratridine+pine extract
natural pyrethrin+veratridine+basil extract
natural pyrethrin+veratridine+parsley extract
natural pyrethrin+veratridine+patchouli extract
natural pyrethrin+veratridine+mint extract
natural pyrethrin+veratridine+palmarosa extract
natural pyrethrin+veratridine+valerian extract
natural pyrethrin+veratridine+hyssop extract
natural pyrethrin+veratridine+cypress extract
natural pyrethrin+veratridine+hiba extract
natural pyrethrin+veratridine+pimenta extract
natural pyrethrin+veratridine+fennel extract
natural pyrethrin+veratridine+bay extract
natural pyrethrin+veratridine+vetiver extract
natural pyrethrin+veratridine+penyroyal extract
natural pyrethrin+veratridine+peppermint extract
natural pyrethrin+veratridine+perilla extract
natural pyrethrin+veratridine+bergamot extract
natural pyrethrin+veratridine+berber extract
natural pyrethrin+veratridine+marjoram extract
natural pyrethrin+veratridine+manuka extract
natural pyrethrin+veratridine+mandarin extract
natural pyrethrin+veratridine+eucalyptus extract
natural pyrethrin+veratridine+artemisia extract
natural pyrethrin+veratridine+Angelica dahurica extract
natural pyrethrin+veratridine+lime extract
natural pyrethrin+veratridine+lavandin extract
natural pyrethrin+veratridine+lavender extract
natural pyrethrin+veratridine+lemongrass extract
natural pyrethrin+veratridine+rosemary extract and laurel extract
natural pyrethrin+veratridine+anthraquinone
natural pyrethrin+veratridine+chloralose
natural pyrethrin+veratridine+acrep
natural pyrethrin+veratridine+butopyronoxyl
natural pyrethrin+veratridine+camphor
natural pyrethrin+veratridine+d-camphor
natural pyrethrin+veratridine+carboxide
natural pyrethrin+veratridine+dibutyl phthalate
natural pyrethrin+veratridine+deet
natural pyrethrin+veratridine+dimethyl carbate
natural pyrethrin+veratridine+dimethyl phthalate
natural pyrethrin+veratridine+dibutyl succinate
natural pyrethrin+veratridine+dibutyl adipate
natural pyrethrin+veratridine+ethohexadiol
natural pyrethrin+veratridine+hexamide
natural pyrethrin+veratridine+icaridin
natural pyrethrin+veratridine+methoquin-butyl
natural pyrethrin+veratridine+methylneodecanamide
natural pyrethrin+veratridine+2-(octylthio)ethanol
natural pyrethrin+veratridine+butoxypolypropylene glycol
natural pyrethrin+veratridine+oxamate
natural pyrethrin+veratridine+quwenzhi
natural pyrethrin+veratridine+quyingding
natural pyrethrin+veratridine+zengxiaon
natural pyrethrin+veratridine+rebemide
natural pyrethrin+veratridine+copper naphthenate
natural pyrethrin+veratridine+zinc naphthenate
natural pyrethrin+amitraz+dill extract
natural pyrethrin+bistrifluron+dill extract
natural pyrethrin+cyromazine+dill extract
natural pyrethrin+diflubenzuron+dill extract
natural pyrethrin+etoxazole+dill extract
natural pyrethrin+hexaflumuron+dill extract
natural pyrethrin+hydroprene+dill extract
natural pyrethrin+lufenuron+dill extract
natural pyrethrin+methoprene+dill extract
natural pyrethrin+metoxadiazone+dill extract
natural pyrethrin+novaluron+dill extract
natural pyrethrin+noviflumuron+dill extract
natural pyrethrin+pyriproxyfen+dill extract
natural pyrethrin+teflubenzuron+dill extract
natural pyrethrin+triflumuron+dill extract

Though specific combinations are not described in the “list of three active ingredients” in [0248], the following compounds may be used as the present component 1 and the present component 2. acrinathrin, benfluthrin, cycloprothrin, cyflumetofen, flufenoprox, halfenprox, heptafluthrin, kadethrin, kappa-tefluthrin, kappa-bifenthrin, tefluthrin, abamectin, acephate, acequinocyl, acetoprole, acynonapyr, afidopyropen, alanycarb, aldicarb, alpha-endosulfan, aluminium phosphide, azinphos-ethyl, azinphos-methyl, azocyclotin, benfuracarb, bensultap, benzoximate, benzpyrimoxan, bifenazate, bilobalide, borax, boric acid, bromopropylate, buprofezin, butocarboxim, butoxycarboxim, cadusafos, calcium phosphide, carbaryl, carbofuran, carbosulfan, cevadine, chinomethionat, chlordane, chlorethoxyfos, chlorfenvinphos, chlormephos, chloropicrin, chromafenozide, clofentezine, concanamycin A, coumaphos, cryolite, cyanophos, cyclobutrifluram, cycloxaprid, cyenopyrafen, cyetpyrafen, cyhalodiamide, cyhexatin, dazomet, demeton-S-methyl, diafenthiuron, diazinon, dicofol, dicrotophos, diflovidazin, dimethoate, dimethylvinphos, dimpropyridaz, disodium octaborate, disulfoton, DNOC (2-methyl-4,6-dinitrophenol), doramectin, dried leaves of Dryopteris filix-mas, emamectin-benzoate, endosulfan, EPN (O-ethyl O-(4-nitrophenyl) phenylphosphonothioate), ethiofencarb, ethion, ethoprophos, famphur, fenamiphos, fenazaquin, fenbutatin oxide, fenpyroximate, flometoquin, flonicamid, fluacrypyrim, fluazaindolizine, fluazuron, flucycloxuron, flucythrinate, fluensulfone, flufenoxuron, flufiprole, flupentiofenox, flupyradifurone, flupyrimin, fluvalinate, formetanate, fosthiazate, furathiocarb, ginkgolide A, ginkgolide B, ginkgolide C, ginkgolide J, ginkgolide M, halofenozide, heptenophos, hexythiazox, potassium salt of hop beta acid, imicyafos, imidaclothiz, isofenphos, isoprocarb, isopropyl-O-(methoxyaminothiophosphoryl) salicylate, isoxathion, kinoprene, lenoremycin, lepimectin, lime sulfur, machine oil, malathion, mecarbam, metam, methamidophos, methidathion, methiocarb, methomyl, methoxychlor, methoxyfenozide, methyl bromide, metolcarb, mevinphos, milbemectin, milbemycin oxime, monocrotophos, moxidectin, naled, nicotine, nicotine-sulfate, omethoate, oxamyl, oxydemeton-methyl, parathion, parathion-methyl, phenthoate, phorate, phosalone, phosmet, phosphamidon, phosphine, phoxim, pirimicarb, pirimiphos-methyl, profenofos, propargite, propylene glycol alginate, prothiofos, pyflubumide, pymetrozine, pyraclofos, pyridaben, pyridalyl, pyridaphenthion, pyrifluquinazone, pyrimidifen, pyriminostrobin, quinalphos, ryanodine, sodium borate, sodium metaborate, spirodiclofen, spiromesifen, spiropidion, spirotetramat, sulfluramid, sulfotep, sulfur, sulfuryl fluoride, tartar emetic, tau-fluvalinate, tebufenozide, tebufenpyrad, tebupirimfos, terbufos, tetrachlorvinphos, tetradifon, thiocyclam, thiodicarb, thiofanox, thiometon, thiosultap-disodium, thiosultap-monosodium, tioxazafen, triazamate, triazophos, trichlorfon, triflumezopyrim, trimethacarb, tyclopyrazoflor, vamidothion, xylylcarb, zinc phosphide.

Group 13, wherein the combination of natural pyrethrin, the present component 1 and the present component 2 is any combination of the “list of three active ingredients” described above, consists of the composition A consisting of 2 parts of natural pyrethrin, 0.5 parts of the present component 1 and 2 parts of the present component 2.

Group 14, wherein the combination of natural pyrethrin, the present component 1 and the present component 2 is any combination of the “list of three active ingredients” described above, consists of the composition A consisting of 2 parts of natural pyrethrin, 0.5 parts of the present component 1 and 4 parts of the present component 2.

Group 15, wherein the combination of natural pyrethrin, the present component 1 and the present component 2 is any combination of the “list of three active ingredients” described above, consists of the composition A consisting of 2 parts of natural pyrethrin, 0.5 parts of the present component 1 and 7 parts of the present component 2.

Group 16, wherein the combination of natural pyrethrin, the present component 1 and the present component 2 is any combination of the “list of three active ingredients” described above, consists of the composition A consisting of 2 parts of natural pyrethrin, 1.5 parts of the present component 1 and 2 parts of the present component 2.

Group 17, wherein the combination of natural pyrethrin, the present component 1 and the present component 2 is any combination of the “list of three active ingredients” described above, consists of the composition A consisting of 2 parts of natural pyrethrin, 1.5 parts of the present component 1 and 4 parts of the present component 2.

Group 18, wherein the combination of natural pyrethrin, the present component 1 and the present component 2 is any combination of the “list of three active ingredients” described above, consists of the composition A consisting of 2 parts of natural pyrethrin, 1.5 parts of the present component 1 and 7 parts of the present component 2.

Group 19, wherein the combination of natural pyrethrin, the present component 1 and the present component 2 is any combination of the “list of three active ingredients” described above, consists of the composition A consisting of 2 parts of natural pyrethrin, 2 parts of the present component 1 and 2.5 parts of the present component 2.

Group 20, wherein the combination of natural pyrethrin, the present component 1 and the present component 2 is any combination of the “list of three active ingredients” described above, consists of the composition A consisting of 1 part of natural pyrethrin, 1 part of the present component 1 and 2 parts of the present component 2.

Group 21, wherein the combination of natural pyrethrin, the present component 1 and the present component 2 is any combination of the “list of three active ingredients” described above, consists of the composition A consisting of 0.1 parts of natural pyrethrin, 0.5 parts of the present component 1 and 1.5 parts of the present component 2.

Group 22, wherein the combination of natural pyrethrin, the present component 1 and the present component 2 is any combination of the “list of three active ingredients” described above, consists of the composition A consisting of 0.1 parts of natural pyrethrin, 0.5 parts of the present component 1 and 0.3 parts of the present component 2.

Group 23, wherein the combination of natural pyrethrin, the present component 1 and the present component 2 is any combination of the “list of three active ingredients” described above, consists of the composition A consisting of 0.1 parts of natural pyrethrin, 2 parts of the present component 1 and 1.5 parts of the present component 2.

Group 24, wherein the combination of natural pyrethrin, the present component 1 and the present component 2 is any combination of the “list of three active ingredients” described above, consists of the composition A consisting of 5 parts of natural pyrethrin, 6.6 parts of the present component 1 and 20 parts of the present component 2.

Group 25, wherein the combination of natural pyrethrin, the present component 1 and the present component 2 is any combination of the “list of three active ingredients” described above, consists of the composition A consisting of 5 parts of natural pyrethrin, 6.6 parts of the present component 1 and 5 parts of the present component 2.

Group 26, wherein the combination of natural pyrethrin, the present component 1 and the present component 2 is any combination of the “list of three active ingredients” described above, consists of the composition A consisting of 5 parts of natural pyrethrin, 6.6 parts of the present component 1 and 8 parts of the present component 2.

Group 27, wherein the combination of natural pyrethrin, the present component 1 and the present component 2 is any combination of the “list of three active ingredients” described above, consists of the composition A consisting of 1 part of natural pyrethrin, 1 part of the present component 1 and 1 part of the present component 2.

Group 28, wherein the combination of natural pyrethrin, the present component 1 and the present component 2 is any combination of the “list of three active ingredients” described above, consists of the composition A consisting of 1 part of natural pyrethrin, 1 part of the present component 1 and 10 parts of the present component 2.

Group 29, wherein the combination of natural pyrethrin, the present component 1 and the present component 2 is any combination of the “list of three active ingredients” described above, consists of the composition A consisting of 1 part of natural pyrethrin, 10 parts of the present component 1 and 1 part of the present component 2.

Group 30, wherein the combination of natural pyrethrin, the present component 1 and the present component 2 is any combination of the “list of three active ingredients” described above, consists of the composition A consisting of 1 part of natural pyrethrin, 10 parts of the present component 1 and 10 parts of the present component 2.

Group 31, wherein the combination of natural pyrethrin, the present component 1 and the present component 2 is any combination of the “list of three active ingredients” described above, consists of the composition A consisting of 10 parts of natural pyrethrin, 1 part of the present component 1 and 1 part of the present component 2.

Group 32, wherein the combination of natural pyrethrin, the present component 1 and the present component 2 is any combination of the “list of three active ingredients” described above, consists of the composition A consisting of 10 parts of natural pyrethrin, 1 part of the present component 1 and 10 parts of the present component 2.

Group 33, wherein the combination of natural pyrethrin, the present component 1 and the present component 2 is any combination of the “list of three active ingredients” described above, consists of the composition A consisting of 10 parts of natural pyrethrin, 10 parts of the present component 1 and 1 part of the present component 2.

Next, examples of formulations are shown. Here, ‘part’ represents ‘part by weight’. The abbreviation ‘MX’ means any one composition A selected from the groups 1 to 33.

### Formulation Example 1

A formulation is obtained by mixing 35 parts of a mixture of polyoxyethylene alkyl ether sulfate ammonium salt and silica (weight ratio 1:1), 10 parts of natural pyrethrin or 10 parts of MX and 55 parts of water, followed by pulverizing by a wet milling method.

### Formulation Example 2

A formulation is obtained by grinding and mixing 50 parts of natural pyrethrin or 50 parts of MX, 3 parts of calcium lignin sulfonate, 2 parts of sodium lauryl sulfate, and 45 parts of silica.

### Formulation Example 3

A formulation is obtained by mixing 5 parts of natural pyrethrin or 5 parts of MX, 9 parts of polyoxyethylene styryl phenyl ether, 5 parts of polyoxyethylene decyl ether (the number of ethylene oxide added: 5), 6 parts of calcium dodecyl benzene sulfonate, and 75 parts of xylene.

### Formulation Example 4

A formulation is obtained by grinding and mixing 2 parts of natural pyrethrin or 2 parts of MX, 1 part of silica, 2 parts of calcium lignin sulfonate, 30 parts of bentonite, and 65 parts of kaolin clay, adding an appropriate amount of water, kneading, granulating with a granulator, and then drying.

### Formulation Example 5

A formulation is obtained by mixing 10 parts of natural pyrethrin or 10 parts of MX with a mixture of 18 parts of benzyl alcohol and 9 parts of DMSO, followed by adding 6.3 parts of GERONOL (registered trademark) TE250, 2.7 parts of Ethylan NS-500LQ (registered trademark), and 54 parts of solvent naphtha thereto to mix.

### Formulation Example 6

A formulation is obtained by mixing 10 parts of natural pyrethrin or 10 parts of MX, 5 parts of nonylphenol ethoxylate, and 85 parts of propylene glycol.

### Formulation Example 7

A formulation is obtained by mixing 10 parts of natural pyrethrin or 10 parts of MX and 20 parts of xylene, followed by dispersing them in 68 parts of water containing 2 parts of polyvinyl alcohol.

### Formulation Example 8

A formulation is obtained by grinding and mixing 30 parts of natural pyrethrin or 30 parts of MX, 3 parts of calcium lignin sulfonate, 2 parts of sodium lauryl sulfate, and 65 parts of kaolin clay, adding an appropriate amount of water, kneading, granulating with a granulator, and then drying.

### Formulation Example 9

A formulation is obtained by mixing 35 parts of a mixture of polyoxyethylene alkyl ether sulfate ammonium salt and white carbon (weight ratio 1:1), 10 parts of natural pyrethrin or 10 parts of MX, and 55 parts of water, followed by pulverizing by a wet milling method to obtain a mixture, and then granulating the mixture using a fluidized bed granulator.

### Formulation Example 10

A formulation is obtained by mixing 20 parts of natural pyrethrin or 20 parts of MX, 5 parts of polyoxyethylene nonylphenyl ether, 3 parts of carboxymethyl cellulose, and 72 parts of water.

### Formulation Example 11

Ten parts of natural pyrethrin or 10 parts of MX, 0.2 parts of hexamethylene diisocyanate, and 10 parts of xylene are mixed, followed by dispersing in 75.8 parts of water containing 2 parts of polyvinyl alcohol. Two parts of ethylenediamine is added thereto, followed by proceeding with encapsulation reaction while mixing to obtain a formulation.

### Formulation Example 12

A formulation is obtained by grinding and mixing 2 parts of natural pyrethrin or 2 parts of MX, 88 parts of kaolin clay, and 10 parts of talc.

### Formulation Example 13

A formulation is obtained by mixing and dissolving 0.1 parts of natural pyrethrin or 0.1 parts of MX and 39.9 parts of kerosene, followed by putting into an aerosol container, and then filling 60 parts of liquefied petroleum gas (a mixture of propane, isobutane and butane; saturation vapor pressure: 0.47 MPa (25° C.)).

### Formulation Example 14

Zero point zero two (0.02) parts of natural pyrethrin or 0.02 parts of MX, 0.18 parts of triethyl citrate, 3 parts of isopropyl myristate, 5.8 parts of paraffinic solvent (Neothiosol, manufactured by Chuo Kasei Co., Ltd.), 0.8 parts of a formulation of glyceryl oleate and propylene glycol (Leodor MO-60, manufactured by Kao Corporation) and 0.2 parts of polyoxyethylene sorbitan monooleate (Leodor TW-0120, manufactured by Kao Corporation) are mixed and dissolved to obtain a mixture. A formulation is obtained by putting the mixture and 40 parts of water into an aerosol container, followed by filling 50 parts of dimethyl ether/liquefied petroleum gas (a mixture of propane, butane and isobutane; saturation vapor pressure: 0.35 MPa (25° C.)) at 1/1 (weight ratio).

### Formulation Example 15

A formulation is obtained by mixing 0.2 parts of natural pyrethrin or 0.2 parts of MX, 50 parts of lees powder resulting from extraction of pyrethrum, 30 parts of Tabu powder, and 19.8 parts of wood powder, adding an appropriate amount of water, followed by kneading, subjecting to an extruder to obtain a plate sheet, and then subjecting to a punching machine so as to be a spiral shape.

### Formulation Example 16

A formulation is obtained by mixing 10 parts of natural pyrethrin or 10 parts of MX and 90 parts of a hydrocarbon solvent, followed by impregnating the resulting mixture into a porous mat for impregnation (molding of a mixture of wood pulp and linter pulp) which is 35 mm long×22 mm wide×2.8 mm thick.

### Formulation Example 17

A formulation is obtained by filling a chemical liquid prepared by mixing and dissolving 3 parts of natural pyrethrin or 3 parts of MX and 97 parts of deodorized kerosene into a 45-mL plastic container, followed by inserting a liquid-absorbing wick whose top part can be heated by a heater through an inner stopper.

### Formulation Example 18

An electric liquid mosquito formulation is obtained by mixing and dissolving 1.5 parts of natural pyrethrin or 1.5 parts of MX, 50 parts of diethylene glycol monobutyl ether, 1.8 parts of dibutylhydroxytoluene, and 46.7 parts of water to obtain a chemical liquid, filling it into a plastic bottle, followed by inserting a liquid-absorbing wick whose top can be heated by a heater through an inner stopper.

### Formulation Example 19

A formulation is obtained by having a porous solid carrier (textile, knitted fabric, non-woven fabric, paper, etc.) support 100 parts of natural pyrethrin or 100 parts of MX.

### Formulation Example 20

A master batch in pellet form was produced by kneading 50 parts of natural pyrethrin or 50 parts of MX, 18 parts of white carbon (Carplex #80, manufactured by Evonik Industries AG: average particle size: 15 μm), 20 parts of ethylene-vinylacetate copolymer (Ultrasen 710, manufactured by Tosoh Corporation: vinylacetate content in the copolymer: 28%) and 12 parts of LDPE (Suntech LDM6520, Asahi Kasei Corporation) at 120 to 140° C. Then, 100 parts of the resulting pellets and 300 parts of the LDPE described above are kneaded at 120-140° C., followed by injection molding to obtain a formulation.

### Formulation Example 21

A formulation is obtained by impregnating a predetermined amount of 4.4 parts of natural pyrethrin or 4.4 parts of MX, 1.5 parts of diethylene glycol mono2-ethylhexyl ether, and 4.4 parts of hydroxymethylpentylcyclohexene carboxyamide in a predetermined amount into a nonwoven polyester cloth (130 mm longitudinally, 64 mm shortitudinally, 0.46 mm thick, 170 g/m² of basis weight).

### Formulation Example 22

A cylindrical formulation (approximately 3 mm diameter in the circular direction and approximately 7 mm length) is obtained by mixing 22 parts of natural pyrethrin or 22 parts of MX, 0.1 parts of linalool, 2 parts of alpha starch (AMYCOL H, manufactured by Nippon Starch Chemical Co., Ltd.), 0.5 parts of zinc oxide (manufactured by Seido Chemical Industries, Co., Ltd.), and 75.4 parts of azodicarbonamide (Unifoam AZ, manufactured by Otsuka Chemical Co., Ltd.), followed by granulating and drying.

### Formulation Example 23

A formulation is obtained by mixing 0.5 parts of natural pyrethrin or 0.5 parts of MX, 4 parts of sesame oil, 25 parts of starch syrup, 35 parts of glycerin, 1 part of gellan gum, and 34.5 parts of water.

### Formulation Example 24

A formulation is obtained by mixing 100 parts of natural pyrethrin or 100 parts of MX, 68.75 parts of lactose, 237.5 parts of corn starch, 43.75 parts of microcrystalline cellulose, 18.75 parts of polyvinylpyrrolidone, 28.75 parts of sodium carboxymethyl starch, and 2.5 parts of magnesium stearate, followed by compression molding.

### Formulation Example 25

A formulation is obtained by mixing 200 parts of natural pyrethrin or 200 parts of MX, 148 parts of lactose, and 2 parts of magnesium stearate, followed by filling into hard gelatin capsules or hydroxypropyl methylcellulose capsules.

### Formulation Example 26

A formulation is obtained by mixing 1 part of natural pyrethrin or 1 part of MX, 74 parts of water for injection, and 25 parts of polyethylene glycol, followed by filling into a vial container, and then sterilizing in an autoclave.

### Formulation Example 27

A formulation is obtained by dissolving 5 parts of natural pyrethrin or 5 parts of MX in 70 parts of diethylene glycol monoethyl ether, followed by mixing with 25 parts of 2-octyldodecanol.

### Formulation Example 28

A formulation is obtained by adding and mixing 200 parts of natural pyrethrin or 200 parts of MX, 50 parts of fumaric acid, 200 parts of sodium chloride, 15 parts of methylparaben, 5 parts of propylparaben, 2500 parts of granulated sugar, 1300 parts of sorbitol (70% solution), 10 parts of Veegum K (manufactured by Vanderbilt Minerals, LCC), 3.5 parts of a fragrance, 50 parts of a coloring agent, and 6000 parts of water.

### Formulation Example 29

Silica capsules were produced by mixing 50 parts of natural pyrethrin or 50 parts of MX and 1.5 parts of dibutylhydroxytoluene (SUMILIZER BHT, Sumitomo Chemical Co., Ltd.), followed by adding to 48.5 parts of porous silica (Carplex #80, manufactured by Evonik Industries AG: average particle diameter 15 μm), and then stirring and mixing.

Resin pellets (diameter: 3 mm, length: 3 mm) containing pest insect control ingredients were produced by melt-kneading 31 parts of the silica capsules, 59.5 parts of linear low-density polyethylene (SUMIKATHENE-L GA807, manufactured by Sumitomo Chemical Co., Ltd.: density 0.912 kg/m³), 5 parts of zinc stearate, and 4.5 parts of a pigment at 150° C., followed by extruding from an extruder and cutting.

Resin fiber was obtained by melt spinning 14 parts of the resin pellets, 85.4 parts of high-density polyethylene (HI-ZEX 5000S, manufactured by Mitsui Chemicals, Inc.: density 0.950 kg/m³), and 0.6 parts of zinc stearate at 220 to 240° C. A net-like formulation is obtained by raschel knitting the resin fiber.

### Formulation Example 30

A total volume of 200 mL of a solution is obtained by adding ethanol to 2.291 g of natural pyrethrin or 2.291 g of MX. On the other hand, a total volume of 100 mL of a binder solution is obtained by adding ethanol to 18.94 g of 44% acrylic acid ester copolymerization emulsion. A total volume of 100 mL of an impregnating liquid is obtained by adding 14.5 ml of the solution and 25 ml of the binder solution to ethanol. A net-like formulation is obtained by adding the impregnating liquid to a polyester knitted fabric (length×width: 25 cm×25 cm) consisting of multifilaments to mix thoroughly, followed by drying under light-shielding conditions overnight.

### Formulation Example 31

A formulation whose total pyrethrin content is 1.0% by weight was prepared by weighing a predetermined amount of natural pyrethrin (containing a total content of 50.5% by weight of a mixture of six species (pyrethrin I+pyrethrin II+cinerin I+cinerin II+jasmolin I+ and jasmolin II)) in a pressure-resistant glass container, followed by filling 10 cc of liquefied carbon dioxide gas to the pressure-resistant glass container at 20° C., and then stirring.

Next, examples of applications of the composition B to plant seeds are shown.

### Application Example 1 (Application to Sorghum Seeds)

Treated seeds are obtained by smear-treating 100 kg of dry sorghum seeds with 200 mL of any one of the formulations which is obtainable by the method described in the Formulation Example 1 using a rotary seed treatment machine (Seed dresser, manufactured by Hans-Ulrich Hege GmbH).

### Application Example 2 (Application to Sorghum Seeds)

Two hundred mL of any one of the formulations which is obtainable by the method described in the Formulation Example 1 is mixed with 180 g of Concep (registered trademark) II (manufactured by Syngenta AG) (containing 136 g of oxabetrinyl). Treated seeds are obtained by smear-treating 100 kg of dry sorghum seeds with the resulting mixture using a rotary seed treatment machine (Seed dresser, manufactured by Hans-Ulrich Hege GmbH).

### Application Example 3 (Application to Sorghum Seeds)

Two hundred mL of any one of the formulations which is obtainable by the method described in the Formulation Example 1 is mixed with 2.1 L of Concep (registered trademark) III (manufactured by Syngenta AG) (containing 40 g of fluxofenim). Treated seeds are obtained by smear-treating 100 kg of dry sorghum seeds with the resulting mixture using a rotary seed treatment machine (Seed dresser, manufactured by Hans-Ulrich Hege GmbH).

### Application Example 4 (Application to Corn Seeds)

Treated seeds are obtained by smear-treating 10 kg of dry seeds of corn “SR corn” (corn to which tolerance to acetyl-CoA carboxylase inhibitors has been imparted) with 10 mL of any one of the formulations which is obtainable by the method described in the Formulation Example 1 using a rotary seed treatment machine (Seed dresser, manufactured by Hans-Ulrich Hege GmbH).

### Application Example 5 (Application to Corn Seeds)

Treated seeds are obtained by smear-treating 10 kg of dry seeds of corn “Mavera (trademark) YieldGard (trademark) Maize” (corn in which lysine production increases and to which resistance to lepidopteran pest insects has been imparted) with 40 mL of any one of the formulations which is obtainable by the method described in the Formulation Example 1 using a rotary seed treatment machine (Seed dresser, manufactured by Hans-Ulrich Hege GmbH).

### Application Example 6 (Application to Corn Seeds)

Treated seeds are obtained by smear-treating 10 kg of dry seeds of corn “Herculex Xtra” (corn to which tolerance to glufosinate, resistance to lepidopteran pest insects and resistance to coleopteran pest insects have been imparted) with 100 mL of any one of the formulations which is obtainable by the method described in the Formulation Example 1 using a rotary seed treatment machine (Seed dresser, manufactured by Hans-Ulrich Hege GmbH).

### Application Example 7 (Application to Corn Seeds)

Treated seeds are obtained by powder-coating-treating 10 kg of dry seeds of corn “ZFN-12 maize” (corn in which phytic acid content has reduce) with 50 g of any one of the formulations which is obtainable by the method described in the Formulation Example 2.

### Application Example 8 (Application to Soybean Seeds)

Treated seeds are obtained by smear-treating 10 kg of dry seeds of soybean “Plenish (trademark)” (soybean in which oleic acid content has increased and to which tolerance to sulfonylurea ALS inhibitory herbicides has been imparted) with 20 mL of any one of the formulations which is obtainable by the method described in the Formulation Example 1 using a rotary seed treatment machine (Seed dresser, manufactured by Hans-Ulrich Hege GmbH).

### Application Example 9 (Application to Soybean Seeds)

Treated seeds are obtained by smear-treating 10 kg of dry seeds of soybean “Intacta (trademark) Roundup Ready (trademark) 2 Pro” (soybean to which tolerance to glyphosate and resistance to lepidopteran pest insects have been imparted) with 100 mL of any one of the formulations which is obtainable by the method described in the Formulation Example 1 using a rotary seed treatment machine (Seed dresser, manufactured by Hans-Ulrich Hege GmbH).

### Application Example 10 (Application to Cotton Seeds)

Treated seeds are obtained by smear-treating 10 kg of dry seeds of cotton “Bollgard (registered trademark) 3 XtendFlex (registered trademark)” (cotton to which dicamba tolerance, glyphosate tolerance, glufosinate tolerance and resistance to lepidopteran pest insects have been imparted) with 50 mL of any one of the formulations which is obtainable by the method described in the Formulation Example 1 using a rotary seed treatment machine (Seed dresser, manufactured by Hans-Ulrich Hege GmbH).

### Application Example 11 (Application to Canola Seeds)

Each treated seed is obtained by smear-treating 10 kg of dry seeds of canola “Clearfield (registered trademark) canola” (canola to which tolerance to imidazolinone ALS inhibitory herbicides has been imparted) with 50 mL of any one of the formulations which is obtainable by the method described in the Formulation Example 1 using a rotary seed treatment machine (Seed dresser, manufactured by Hans-Ulrich Hege GmbH).

### Application Example 12 (Application to Rapeseed Seeds)

Treated seeds are obtained by smear-treating 10 kg of dry rapeseed seeds with 10 mL of any one of the formulations which is obtainable by the method described in the Formulation Example 1 using a rotary seed treatment machine (Seed dresser, manufactured by Hans-Ulrich Hege GmbH).

### Application Example 13 (Application to Wheat Seeds)

Treated seeds are obtained by smear-treating 10 kg of dry wheat seeds with 50 mL of any one of the formulations which is obtainable by the method described in the Formulation Example 1 using a rotary seed treatment machine (Seed dresser, manufactured by Hans-Ulrich Hege GmbH).

### Application Example 14 (Application to Seed Potatoes of Potato)

Treated seed potatoes are obtained by smear-treating 10 kg of seed potatoes of potato with 6 mL of any one of the formulations which is obtainable by the method described in the Formulation Example 1 so as to be uniform.

### Application Example 15

Ten kilograms of dried rice seeds (dried unhulled rice) are put in a mesh bag and soaked in a 50-fold water dilution of Benlate (registered trademark) wettable powder (Benomyl wettable powder, manufactured by Sumitomo Chemical Co., Ltd.) for 10 minutes, followed by soaking in tap water for 3 days. Drained rice seeds are put in a rotating pan-type rice seed coating machine, and while rotating, 5 kg of reduced iron powder, 600 g of calcined gypsum, and 5-fold water dilution of 100 g of any one of the formulations which is obtainable by the method described in the Formulation Example 1 are added thereto to powder-coat, followed by further powder-coating with 300 g of calcined gypsum. The rice seeds are then removed from the coating machine and dispersed on a plastic sheet so that its thickness may be 1 cm or less, and then leave to stand and dry to obtain treated seeds.

### Application Example 16

Ten kilograms of dried rice seeds (dried unhulled rice) are put in a mesh bag and soaked in a 20-fold water dilution of Starner (registered trademark) wettable powder (Oxolinic acid wettable powder, manufactured by Sumitomo Chemical Co., Ltd.) for 10 minutes, followed by soaking in tap water for 3 days. Drained rice seeds are put in a rotating pan-type rice seed coating machine, and while rotating, 20 kg of Calper (registered trademark) dust-granule mixture 16 (calcium peroxide dust-granule mixture, manufactured by Hodogaya UPL Co., Ltd) and 100 g of any one of the formulations which is obtainable by the method described in the Formulation Example 2 are added thereto to powder-coat. The rice seeds are then removed from the coating machine and dispersed on a plastic sheet so that its thickness may be 1 cm or less, and then leave to stand and dry to obtain treated seeds.

### Application Example 17

Ten kilograms of dried rice seeds (dried unhulled rice) are put in a mesh bag and soaked in 1500-fold water dilution of PADAN SG soluble powder (Cartap hydrochloride soluble powder, manufactured by Sumitomo Chemical Co., Ltd.) for 24 hours to disinfect, followed by soaking in tap water for 3 days to stimulate germination. Drained rice seeds are put in a rotating pan-type rice seed coating machine, and while rotating, an appropriate amount of Zojirushi Nole laundry starch (polyvinyl alcohol, Sanwa Yushi Industry K.K.), 200 g of molybdenum trioxide (NIPPON INORGANIC COLOUR & CHEMICAL CO., LTD.), and 2-fold water dilution of 100 g of any one of the formulations which is obtainable by the method described in the Formulation Example 1 are added thereto to treat the surface of the rice seeds therewith. The rice seeds are then removed from the coating machine and dispersed on a plastic sheet so that its thickness may be 1 cm or less, and then leave to stand and dry to obtain treated seeds.

The effects of the present invention are shown below in the test examples.

### Test Example 1

The treated seeds of corn which is obtainable by the method described in the Application Example 4 are sown at a depth of 5 cm at intervals of 15 cm using a sowing machine.

As a result, for the corn treated with natural pyrethrin or MX, effects on Rhizoctonia solani and Pythium spp., root-lesion nematodes, and pest arthropods that can damage corn can be confirmed.

### Test Example 2

The treated seeds of soybean which is obtainable by the method described in the Application Example 8 are sown to cultivate.

As a result, for the soybean treated with natural pyrethrin or MX, effects on Fusarium blight (Fusarium oxysporum) Rhizoctonia root rot (Rhizoctonia solani), soybean cyst nematode, and pest arthropods that can damage soybean can be confirmed.

### Test Example 3

The treated seeds of canola which is obtainable by the method described in the Application Example 11 are sown to cultivate.

As a result, for the soybean treated with natural pyrethrin or MX, effects on damping-off (Rhizoctonia solani), root-lesion nematodes, and pest arthropods that can damage canola can be confirmed.

### Test Example 4

The treated seeds of rice which is obtainable in the Application Example 15 are sown to paddy field to cultivate.

As a result, for the rice treated with natural pyrethrin or MX, effects on rice water weevil, rice leaf beetle, brown planthopper, white-backed planthopper, small brown planthopper, green rice leafhopper, rice leaf roller, green rice caterpillar, rice stem borer and locust can be confirmed. In addition, for the rice treated with natural pyrethrin or MX, by controlling Delphacidae or Cicadellidae, effects on rice waika, tungro, rice grassy stunt, rice ragged stunt, rice stripe, black streaked dwarf, rice southern black-streaked dwarf, downy mildew, rice transitory yellow dwarf, transitory yellow dwarf and rice dwarf which can be transmitted by such insects can be confirmed.

### Test Example 5

Twenty four kilograms of rice seeds are packed in a cloth bag and soaked in water with the bag for 24 hours. The rice seeds after soaking are placed on a concrete ground with the bag described above and are left to stand for 36 hours while being sprinkled with water as needed to prevent drying out. The rice seeds which are removed from the cloth bag after leaving to stand are spread on a sheet, spraying a water dilution of the formulation which is obtainable by the method described in the Formulation Example 2 thereto, followed by thoroughly stirring on the sheet. The rice seeds are sown by spreading them evenly by hand directly on the to a paddy field in which plowing, irrigating and soil puddling, or the like have been performed in advance and a depth of flooding water is maintained at about 2 cm by performing drained treatment, followed by cultivating.

As a result, for the rice treated with natural pyrethrin or MX, effects on rice water weevil, rice leaf beetle, brown planthopper, white-backed planthopper, small brown planthopper, green rice leafhopper, rice leaf roller, green rice caterpillar, rice stem borer and yellow paddy borer can be confirmed. Effects on rice water weevil, rice leaf beetle, brown planthopper, white-backed planthopper, small brown planthopper, green rice leafhopper, rice leaf roller, green rice caterpillar, rice stem borer and yellow paddy borer which have reduced susceptibility to one or more compounds selected from the group a1 to the group a26 can also be confirmed. Especially, effects on rice water weevil, rice leaf beetle, brown planthopper, white-backed planthopper, small brown planthopper and green rice leafhopper which have reduced susceptibility to one or more compounds selected from the group a4 can be confirmed. In addition, by controlling pest insects belonging to Delphacidae or Cicadellidae, the rice can be protected from rice waika, tungro, rice grassy stunt, rice ragged stunt, rice stripe, black streaked dwarf, rice southern black-streaked dwarf, downy mildew, rice transitory yellow dwarf, transitory yellow dwarf and rice dwarf which can be transmitted by such insects.

### Test Example 6

The rice seeds which are obtainable in the Application Example 16 are sown with a riding sowing machine in a streaky manner in a paddy field in which soil puddling has been performed and then draining has been managed for several days, followed by cultivating. In this case, the amount of sown seeds per 10 are is 4 kg as dried unhulled rice.

As a result, for the rice treated with natural pyrethrin or MX, effects on rice water weevil, rice leaf beetle, brown planthopper, white-backed planthopper, small brown planthopper, green rice leafhopper, zigzag-striped leafhopper, green rice caterpillar and rice stem borer can be confirmed. In addition, effects on rice water weevil, rice leaf beetle, brown planthopper, white-backed planthopper, small brown planthopper, green rice leafhopper, zigzag-striped leafhopper, green rice caterpillar and rice stem borer which have reduced susceptibility to one or more compounds selected from the group a1 to the group a26 can also be confirmed. Especially, effects on rice water weevil, rice leaf beetle, brown planthopper, white-backed planthopper, small brown planthopper and green rice leafhopper which have reduced susceptibility to one or more compounds selected from the group a4 can be confirmed.

### Test Example 7

The seeds of corn which is obtainable in the Application Example 7 are sown at a depth of 5 cm at intervals of 15 cm using a sowing machine to cultivate.

As a result, for the corn treated with natural pyrethrin or MX, effects on larvae of Elateridae (which are collectively referred to as wireworms) which are represented by Diabrotica spp. such as western corn rootworm, Agriotes spp. or Melanotus spp. can be confirmed. Effects on the above larvae of Elateridae which have reduced susceptibility to one or more compounds selected from the group a1 to the group a26 can also be confirmed.

### Test Example 8

The seeds of soybean which is obtainable in the Application Example 9 are sown to cultivate.

As a result, for the soybean treated with natural pyrethrin or MX, an effect on larvae of seedcorn maggot can be confirmed. An effect on larvae of seedcorn maggot which have reduced susceptibility to one or more compounds selected from the group a1 to the group a26 can also be confirmed.

### Test Example 9

The seeds of canola which is obtainable in the Application Example 11 are sown to cultivate.

As a result, for the canola treated with natural pyrethrin or MX, effects on larvae of Chrysomelidae can be confirmed. Effects on larvae of Chrysomelidae which have reduced susceptibility to one or more compounds selected from the group a1 to the group a26 can also be confirmed.

### Test Example 10

The seeds of wheat which is obtainable in the Application Example 13 are sown to cultivate.

As a result, for the wheat treated with natural pyrethrin or MX, effects on larvae of Elateridae can be confirmed. Effects on larvae of Elateridae which have reduced susceptibility to one or more compounds selected from the group a1 to the group a26 can also be confirmed.

### Test Example 11

The seed potatoes of potato which is obtainable in the Application Example 14 are planted in soil to cultivate.

As a result, for the potato treated with natural pyrethrin or MX, effects on larvae of Chrysomelidae can be confirmed. Effects on larvae of Chrysomelidae which have reduced susceptibility to one or more compounds selected from the group a1 to the group a26 can also be confirmed.

### Test Example 12

The granules which is obtainable in the Formulation Example 4 are incorporated into soil, and then cane cuttings of sugar cane are planted thereto to cultivate.

As a result, for the sugar cane treated with natural pyrethrin or MX, effects on larvae of Elateridae can be confirmed. Effects on larvae of Elateridae which have reduced susceptibility to one or more compounds selected from the group a1 to the group a26 can also be confirmed.

### Test Example 13

A water dilution of the formulation which is obtainable by the method described in the Formulation Example 1 is applied to planting trenches to which cane cuttings of sugar cane will be planted before covering with soil, followed by covering with soil to cultivate.

As a result, for the sugar cane treated with natural pyrethrin or MX, effects on larvae of Elateridae can be confirmed. Effects on larvae of Elateridae which have reduced susceptibility to one or more compounds selected from the group a1 to the group a26 can also be confirmed.

### Test Example 14

Rice seeds (150 g as dried unhulled rice) are disinfested with a mixed formulation of ipconazole and copper hydroxide. Bed soil is bedded in a seedling box (about 60 cm width and about 30 cm length), the disinfested rice seeds are uniformly sown thereon. Then, 50 g of the granules which are obtainable by the method described in the Formulation Example 4 are uniformly applied, followed by covering with soil, to grow seedlings. Rice seedlings grown to the 2.5-leaf stage are transplanted to a paddy field using a rice transplanting machine to cultivate.

As a result, for the rice treated with natural pyrethrin or MX, effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner can be confirmed. Effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner which have reduced susceptibility to one or more compounds selected from the group a1 to the group a26 can also be confirmed. Especially, effects on rice water weevil, rice leaf beetle, brown planthopper, white-backed planthopper, small brown planthopper and green rice leafhopper which have reduced susceptibility to one or more compounds selected from the group a4 can be confirmed. In addition, by controlling pest insects belonging to Delphacidae or Cicadellidae, the rice can be protected from rice waika, tungro, rice grassy stunt, rice ragged stunt, rice stripe, black streaked dwarf, rice southern black-streaked dwarf, downy mildew, rice transitory yellow dwarf, transitory yellow dwarf and rice dwarf which can be transmitted by such insects.

### Test Example 15

The formulation which is obtainable by the method described in the Formulation Example 1 is diluted 400-fold with water. Rice seedlings at the 3.5-leaf stage cultivated in a seedling box (about 60 cm width and about 30 cm length) are irrigation-treated with 500 mL of the resulting dilution using an irrigation apparatus. The treated rice seedlings are transplanted to a paddy field using a rice transplanting machine to cultivate.

As a result, for the rice treated with natural pyrethrin or MX, effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner can be confirmed. Effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner which have reduced susceptibility to one or more compounds selected from the group a1 to the group a26 can also be confirmed. Especially, effects on rice water weevil, rice leaf beetle, brown planthopper, white-backed planthopper, small brown planthopper and green rice leafhopper which have reduced susceptibility to one or more compounds selected from the group a4 can be confirmed. In addition, by controlling pest insects belonging to Delphacidae or Cicadellidae, the rice can be protected from rice waika, tungro, rice grassy stunt, rice ragged stunt, rice stripe, black streaked dwarf, rice southern black-streaked dwarf, downy mildew, rice transitory yellow dwarf, transitory yellow dwarf and rice dwarf which can be transmitted by such insects.

### Test Example 16

The formulation which is obtainable by the method described in the Formulation Example 1 is diluted 200-fold with water. Rice seedlings at the 2.5-leaf stage cultivated in a seedling box (about 60 cm width and about 30 cm length) are irrigation-treated with 500 mL of the resulting dilution using a watering can. The treated rice seedlings are transplanted to a paddy field using a rice transplanting machine to cultivate.

As a result, for the rice treated with natural pyrethrin or MX, effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner can be confirmed. Effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner which have reduced susceptibility to one or more compounds selected from the group a1 to the group a26 can also be confirmed. Especially, effects on rice water weevil, rice leaf beetle, brown planthopper, white-backed planthopper, small brown planthopper and green rice leafhopper which have reduced susceptibility to one or more compounds selected from the group a4 can be confirmed. In addition, by controlling pest insects belonging to Delphacidae or Cicadellidae, the rice can be protected from rice waika, tungro, rice grassy stunt, rice ragged stunt, rice stripe, black streaked dwarf, rice southern black-streaked dwarf, downy mildew, rice transitory yellow dwarf, transitory yellow dwarf and rice dwarf which can be transmitted by such insects.

### Test Example 17

Natural pyrethrin or MX is formulated according to the method described in the Formulation Example 1. Similarly, triflumezopyrim, flupyradifuron, or flupyrimin is formulated according to the method described in the Formulation Example 1, respectively. Each dilution is obtained by diluting each of the above formulations with water containing 0.05% by volume of a spreading agent (product name: Shindain (registered trademark)) so that the concentration of active ingredient may be 0.05 ppm, 0.2 ppm, 0.8 ppm, 3.1 ppm, 12.5 ppm, 50 ppm or 200 ppm. Each dilution is obtained by diluting Admire wettable powder (Active ingredient: imidacloprid, manufactured by Bayer CropScience K.K.) and Actara water dispersible granule (Active ingredient: thiamethoxam, manufactured by Syngenta Japan K.K.), which are commercial products, with water containing 0.05% by volume of a spreading agent (product name: Shindain (registered trademark)) so that the concentration of active ingredient may be 0.05 ppm, 0.2 ppm, 0.8 ppm, 3.1 ppm, 12.5 ppm, 50 ppm or 200 ppm. Cucumber seedlings (at the second true leaf unfolding stage) planted in a container are inoculated with 30 cotton aphids (including all growth stages) which are a susceptible line (a line that have been bred successively in Health & Crop Sciences Research Laboratory of Sumitomo Chemical Co., Ltd.) or a reduced susceptible line (a line that have been bred successively without selection after collecting in Miyazaki prefecture in 2016). One day later, the resulting dilution is sprayed to the seedlings at a rate of 10 ml/seedling. On the other hand, cucumbers are cultivated in the same way as in the treated plot, except that the dilution containing natural pyrethrin or MX is not sprayed (this is referred to as an untreated plot). Six days after spraying, the number of surviving insects is observed, and a control value is calculated by formula 1).

$$Control value ( \% ) = \{ 1 - ( Cb \times Tai ) / ( Cai \times Tb ) \} \times 100 \qquad Formula 1 )$$

Letters in the formula have the following meanings
Cb: The number of insects tested in the untreated plot
Cai: The number of surviving insects at the time of observation in the untreated plot
Tb: The number of tested insects in the treated plot
Tai: The number of surviving insects at the time of observation in the treated plot

As a result, it is confirmed that in the treated plots with triflumezopyrim, flupyradifuron, flupyrimin, imidacloprid or thiamethoxam, which is nicotinic acetylcholine receptor competitive modulators in the group a4, each effect on the reduced susceptible line is low compared with that on the sensitive line. From this, it is confirmed that the reduced susceptible line used in the test is a line that has reduced susceptibility to nicotinic acetylcholine receptor competitive modulators. On the other hand, in the treated plots with natural pyrethrin or MX, the same effect on the reduced susceptible line as that on the susceptible line can be confirmed.

### Test Example 18

Natural pyrethrin or MX is formulated according to the method described in the Formulation Example 1. Similarly, flupyradifuron and flupyrimin are formulated according to the method described in the Formulation Example 4, respectively. Each of the above formulations is diluted with water containing 0.05% by volume of a spreading agent (product name: Shindain (registered trademark)) so that the concentration of active ingredient may be 0.05 ppm, 0.2 ppm, 0.8 ppm, 3.1 ppm, 12.5 ppm, 50 ppm or 200 ppm. Admire wettable powder (Active ingredient: imidacloprid, manufactured by Bayer CropScience K.K.), which is a commercial product, is diluted with water containing 0.05% by volume of a spreading agent (product name: Shindain (registered trademark)) so that the concentration of active ingredient may be 0.05 ppm, 0.2 ppm, 0.8 ppm, 3.1 ppm, 12.5 ppm, 50 ppm or 200 ppm. The resulting dilution is sprayed to seedlings (at the 2.5-leaf stage) of rice (Oryza sativa) planted in a container at a rate of 10 ml/seedling. After that, 20 3rd-instar larvae of brown planthopper of a susceptible line (a line that have been bred successively in Health & Crop Sciences Research Laboratory of Sumitomo Chemical Co., Ltd.) or brown planthopper of a reduced susceptible line (a line that have been bred successively without selection after collecting in Nagasaki prefecture in 2016) are released thereto. Six days later, the number of surviving insects is observed, and a mortality rate of insect is calculated by formula 2). On the other hand, rice is cultivated in the same way as in the treated plot, except that the dilution containing natural pyrethrin or MX is not sprayed (this is referred to as an untreated plot).

$$Mortality rate of insect ( \% ) = \{ 1 - ' the number of surviving insects ' / 20 \} \times 100 \qquad Formula 2 )$$

As a result, it is confirmed that in the treated plots with flupyradifuron, flupyrimin or imidacloprid, which is nicotinic acetylcholine receptor competitive modulators in the group a4, each effect on the reduced susceptible line is low compared with that on the sensitive line. From this, it is confirmed that the reduced susceptible line used in the test is a line that has reduced susceptibility to nicotinic acetylcholine receptor competitive modulators. On the other hand, in the treated plots with natural pyrethrin or MX, the same effect on the reduced susceptible line as that on the susceptible line can be confirmed.

### Test Example 19

Natural pyrethrin or MX is formulated according to the method described in the Formulation Example 1. Each of the above formulations is diluted with water containing 0.05% by volume of a spreading agent (product name: Shindain (registered trademark)) so that the concentration of active ingredient may be 0.05 ppm, 0.2 ppm, 0.8 ppm, 3.1 ppm, 12.5 ppm, 50 ppm or 200 ppm. Phoenix water dispersible granule (Active ingredient: flubendiamide, manufactured by NIHON NOHYAKU CO., LTD), PREVATHON flowable 5 (Active ingredient: chlorantraniliprole, manufactured by Nissan Chemical Corporation) and BENEVIA OD (Active ingredient: cyantraniliprole, manufactured by KUMIAI CHEMICAL INDUSTRY CO., LTD.), which are commercial products, are diluted with water containing 0.05% by volume of a spreading agent (product name: Shindain (registered trademark)), respectively so that the concentration of active ingredient may be 0.05 ppm, 0.2 ppm, 0.8 ppm, 3.1 ppm, 12.5 ppm, 50 ppm or 200 ppm. The resulting dilution is sprayed to seedlings (at the 3rd to 4th true leaf unfolding stage) of cabbage (Brassicae oleracea) planted in a container at a rate of 20 ml/seedling. After that, 10 3rd-instar larvae of diamondback moth of a susceptible line (a line that have been bred successively in Health & Crop Sciences Research Laboratory of Sumitomo Chemical Co., Ltd.) or diamondback moth of a reduced susceptible line (a line that have been bred successively without selection after collecting in Kumamoto prefecture in 2016) are released thereto. Five days later, the number of surviving insects is counted, and a mortality rate of insect is calculated by formula 3). On the other hand, cabbages are cultivated in the same way as in the treated plot, except that the dilution containing natural pyrethrin or MX is not sprayed (this is referred to as an untreated plot).

$$Mortality rate of insect ( \% ) = \{ 1 - ' the number of surviving insects ' / 10 \} \times 100 \qquad Formula 3 )$$

As a result, it is confirmed that in the treated plots with flubendiamide, chlorantraniliprole or cyantraniliprole which is ryanodine receptor modulators in the group a17, each effect on the reduced susceptible line is low compared with that on the sensitive line. From this, it is confirmed that the reduced susceptible line used in the test is a line that has reduced susceptibility to ryanodine receptor modulators. On the other hand, in the treated plots with natural pyrethrin or MX, the same effect on the reduced susceptible line as that on the susceptible line can be confirmed.

### Test Example 20

Natural pyrethrin or MX is formulated according to the method described in the Formulation Example 1. Similarly, flupyradifuron and flupyrimin are formulated according to the method described in the Formulation Example 1, respectively. Each of the above formulations is diluted with water containing 0.05% by volume of a spreading agent (product name: Shindain (registered trademark)) so that the concentration of active ingredient may be 0.05 ppm, 0.2 ppm, 0.8 ppm, 3.1 ppm, 12.5 ppm, 50 ppm or 200 ppm. Admire water dispersible granule (Active ingredient: imidacloprid, manufactured by Bayer CropScience K.K.), TREBON emulsifiable concentrate (Active ingredient: etofenprox, manufactured by Mitsui Chemicals Agro, Inc.), PRINCE flowable (Active ingredient: fipronil, manufactured by BASF Japan Ltd.), KIRAPPU flowable (Active ingredient: ethiprole, manufactured by Bayer CropScience K.K.), and APPLAUD flowable (Active ingredient: buprofezin, manufactured by NIHON NOHYAKU CO., LTD), which are commercial products, are diluted with water containing 0.05% by volume of a spreading agent (product name: Shindain (registered trademark)), respectively so that the concentration of active ingredient may be 0.05 ppm, 0.2 ppm, 0.8 ppm, 3.1 ppm, 12.5 ppm, 50 ppm or 200 ppm. The resulting dilution is sprayed to seedlings (at the 2.5-leaf stage) of rice (Oryza sativa) planted in a container at a rate of 10 ml/seedling. After that, 20 3rd-instar larvae of small brown planthopper of a susceptible line (a line that have been bred successively in Health & Crop Sciences Research Laboratory of Sumitomo Chemical Co., Ltd.) or small brown planthopper of a reduced susceptible line (a line that have been bred successively without selection after collecting in Nagasaki prefecture in 2016) are released thereto. Six days later, the number of surviving insects is observed, and a mortality rate of insect is calculated by the formula 2). On the other hand, rice is cultivated in the same way as in the treated plot, except that the dilution containing natural pyrethrin or MX is not sprayed (this is referred to as an untreated plot).

$$Mortality rate of insect ( \% ) = \{ 1 - ' the number of surviving insects ' / 20 \} \times 100 \qquad Formula 2 )$$

As a result, it is confirmed that in the treated plots with flupyradifuron, flupyrimin or imidacloprid, which is nicotinic acetylcholine receptor competitive modulators in the group a4, fipronil or ethiprole, which is GABA-gated chloride channel blockers in the group a2, etofenprox, which is sodium channel modulators in the group a3, or buprofezin, which is chitin biosynthesis inhibitors in the group a12, each effect on the reduced susceptible line is low compared with that on the sensitive line. From this, it is confirmed that the reduced susceptible line used in the test is a line that has reduced susceptibility to these compounds. On the other hand, in the treated plots with natural pyrethrin or MX, the same effect on the reduced susceptible line as that on the susceptible line can be confirmed.

### Test Example 21

Natural pyrethrin or MX is formulated according to the method described in the Formulation Example 1. Each of the above formulations is diluted with water containing 0.05% by volume of a spreading agent (product name: Shindain (registered trademark)) so that the concentration of active ingredient may be 0.05 ppm, 0.2 ppm, 0.8 ppm, 3.1 ppm, 12.5 ppm, 50 ppm or 200 ppm. PRINCE flowable (Active ingredient: fipronil, manufactured by BASF Japan Ltd.) and KIRAPPU flowable (Active ingredient: ethiprole, manufactured by Bayer CropScience K.K.), which are commercial products, are diluted with water containing 0.05% by volume of a spreading agent (product name: Shindain (registered trademark)), respectively so that the concentration of active ingredient may be 0.05 ppm, 0.2 ppm, 0.8 ppm, 3.1 ppm, 12.5 ppm, 50 ppm or 200 ppm. The resulting dilution is sprayed to seedlings (at the 2.5-leaf stage) of rice planted in a container at a rate of 10 ml/seedling. After that, 20 3rd-instar larvae of white-backed planthopper of a susceptible line (a line that have been bred successively in Health & Crop Sciences Research Laboratory of Sumitomo Chemical Co., Ltd.) or white-backed planthopper of a reduced susceptible line (a line that have been bred successively without selection after collecting in Nagasaki prefecture in 2016) are released thereto. Six days later, the number of surviving insects is observed, and a mortality rate of insect is calculated by the formula 2). On the other hand, rice is cultivated in the same way as in the treated plot, except that the dilution containing natural pyrethrin or MX is not sprayed (this is referred to as an untreated plot).

$$Mortality rate of insect ( \% ) = \{ 1 - ' the number of surviving insects ' / 20 \} \times 100 \qquad Formula 2 )$$

As a result, it is confirmed that in the treated plots with fipronil or ethiprole, which is GABA-gated chloride channel blockers in the group a2, each effect on the reduced susceptible line is low compared with that on the sensitive line. From this, it is confirmed that the reduced susceptible line used in the test is a line that has reduced susceptibility to these compounds. On the other hand, in the treated plots with natural pyrethrin or MX, the same effect on the reduced susceptible line as that on the susceptible line can be confirmed.

### Test Example 22

Natural pyrethrin or MX is formulated according to the method described in the Formulation Example 1.

The above formulations are diluted 100-fold with water. Cell-molded seedling trays (about 60 cm width and about 30 cm length) of cabbage one day before planting are irrigation-treated with 500 mL of the resulting dilution, followed by planting to a field to cultivate.

As a result, for the cabbage treated with natural pyrethrin or MX, effects on pest insects belonging to Plutellidae, Noctuidae and Pieridae can be confirmed. Effects on pest insects belonging to Plutellidae, Noctuidae and Pieridae which have reduced susceptibility to one or more compounds selected from the group a1 to the group a26 can also be confirmed. Especially, effects on diamondback moth which has reduced susceptibility to one or more compounds selected from the group a17 can be confirmed.

### Test Example 23

Natural pyrethrin or MX is formulated according to the method described in the Formulation Example 4. The above formulation is applied at a rate of 1 kg/10 a at a depth of 1 cm directly below sowing position while sowing several rice seeds coated with iron oxide powder with a riding sowing machine in a paddy field in which soil puddling has been performed and then draining has been managed for several days. After that, the rice is cultivated.

As a result, for the rice treated with natural pyrethrin or MX, effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner can be confirmed. Effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner which have reduced susceptibility to one or more compounds selected from the group a1 to the group a26 can also be confirmed. Especially, effects on rice water weevil, rice leaf beetle, brown planthopper, white-backed planthopper, small brown planthopper and green rice leafhopper which has reduced susceptibility to one or more compounds selected from the group a4 can be confirmed. In addition, by controlling pest insects belonging to Delphacidae or Cicadellidae, the rice can be protected from rice waika, tungro, rice grassy stunt, rice ragged stunt, rice stripe, black streaked dwarf, rice southern black-streaked dwarf, downy mildew, rice transitory yellow dwarf, transitory yellow dwarf and rice dwarf which can be transmitted by such insects.

### Test Example 24

Natural pyrethrin or MX is formulated according to the method described in the Formulation Example 4. The above formulation is applied at a rate of 1 kg/10 a to a position of 3 cm lateral to sowing position at a depth of 3 cm while sowing several rice seeds coated with Calper (registered trademark) dust-granule mixture 16 (Calcium peroxide dust-granule mixture, Hodogaya UPL Co., Ltd) with a riding sowing machine in a paddy field in which soil puddling has been performed and then draining has been managed for several days. After that, the rice is cultivated.

As a result, for the rice treated with natural pyrethrin or MX, effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner can be confirmed. Effects on rice water weevil, rice leaf beetle, brown planthopper, white-backed planthopper, small brown planthopper, green rice leafhopper, zigzag-striped leafhopper, rice leaf roller, green rice caterpillar, rice stem borer, rice skipper and smaller rice leaf miner which have reduced susceptibility to one or more compounds selected from the group a1 to the group a26 can also be confirmed. Especially, effects on rice water weevil, rice leaf beetle, brown planthopper, white-backed planthopper, small brown planthopper and green rice leafhopper which has reduced susceptibility to one or more compounds selected from the group a4 can be confirmed. In addition, by controlling pest insects belonging to Delphacidae or Cicadellidae, the rice can be protected from rice waika, tungro, rice grassy stunt, rice ragged stunt, rice stripe, black streaked dwarf, rice southern black-streaked dwarf, downy mildew, rice transitory yellow dwarf, transitory yellow dwarf and rice dwarf which can be transmitted by such insects.

### Test Example 25

A formulation which is obtainable by mixing 20 parts of natural pyrethrin or MX, 35 parts of white carbon containing 50 parts of polyoxyethylene alkyl ether sulfate ammonium salt and 45 parts of water, followed by pulverizing by a wet milling method with water is diluted with water so that the concentration of both natural pyrethrin or MX may be 500 ppm to prepare a chemical liquid for test.

A filter paper with diameter of 5.5 cm is placed on the bottom of a polyethylene cup with diameter of 5.5 cm, followed by dropping 0.7 ml of the above chemical liquid for test onto the filter paper, and evenly putting 30 mg of sucrose as feed. Ten female imagoes of housefly (Musca domestica) are released into the polyethylene cup, followed by closing the lid. Twenty four hours later, the life and death of housefly are observed to determine a mortality rate of insect.

As a result, an effect on housefly can be confirmed.

### Test Example 26

A formulation which is obtainable by mixing 20 parts of natural pyrethrin or MX, 35 parts of white carbon containing 50 parts of polyoxyethylene alkyl ether sulfate ammonium salt and 45 parts of water, followed by pulverizing by a wet milling method with water is diluted with water so that the concentration of both natural pyrethrin or MX may be 500 ppm to prepare a chemical liquid for test.

A filter paper with diameter of 5.5 cm is placed on the bottom of a polyethylene cup with diameter of 5.5 cm, followed by dropping 0.7 ml of the above chemical liquid for test onto the filter paper, and evenly putting 30 mg of sucrose as feed. Two male imagoes of German cockroach (Blattella germanica) are released into the polyethylene cup, followed by closing the lid. Six days later, the life and death of German cockroach are observed to determine a mortality rate of insect.

As a result, an effect on German cockroach can be confirmed.

### Test Example 27

A formulation which is obtainable by mixing 20 parts of natural pyrethrin or MX, 35 parts of white carbon containing 50 parts of polyoxyethylene alkyl ether sulfate ammonium salt and 45 parts of water, followed by pulverizing by a wet milling method with water is diluted with water so that the concentration of both natural pyrethrin or MX may be 500 ppm to prepare a chemical liquid for test.

Zero point seven milliliters (0.7 ml) of the above chemical liquid for test is added to 100 ml of ion-exchange water (the concentration of active ingredient 3.5 ppm). Twenty final-instar larvae of southern house mosquito (Culex pipiens pallens) are released into the liquid, and 1 day later, the life and death are observed to determine a mortality rate of insect.

As a result, an effect on southern house mosquito can be confirmed.

### Test Example 28

An acetone solution of a predetermined concentration of natural pyrethrin or MX is prepared. One microliter of the acetone solution is dripped on the ventral side of the thorax of a female imago of German cockroach (Blattella germanica), followed by transferring the insect tested to a plastic cup with about 9 cm diameter and 4.5 cm height, and then leaving to stand at 25° C. with feed and water. Seven days later, the life and death of the insect tested are observed to determine a mortality rate of insect. The number of German cockroach tested is 10 per a test and they are transferred into one cup.

As a result, an effect on German cockroach treated with natural pyrethrin or MX can be confirmed.

### Test Example 29

An acetone solution of a predetermined concentration of natural pyrethrin or MX is prepared. One microliter of the acetone solution is dripped on the ventral side of the thorax of a female imago of smoky-brown cockroach (Periplaneta fuliginosa), followed by transferring the insect tested to a plastic cup, and then leaving to stand at 25° C. with feed and water. Seven days later, the life and death of the insect tested are observed to determine a mortality rate of insect. The number of smoky-brown cockroach tested is 10 per a test and they are transferred into one cup.

As a result, an effect on smoky-brown cockroach treated with natural pyrethrin or MX can be confirmed.

### Test Example 30

An acetone solution of a predetermined concentration of natural pyrethrin or MX is prepared. One microliter of the acetone solution is dripped on the ventral side of the thorax of a female imago of American cockroach (Periplaneta americana), followed by transferring the insect tested to a plastic cup, and then leaving to stand at 25° C. with feed and water. Seven days later, the life and death of the insect tested are observed to determine a mortality rate of insect. The number of American cockroach tested is 10 per a test and they are transferred into one cup.

As a result, an effect on American cockroach treated with natural pyrethrin or MX can be confirmed.

### Test Example 31

An acetone solution of a predetermined concentration of natural pyrethrin or MX is prepared. Zero point three microliters (0.3 μl) of the acetone solution is dripped on the dorsal side of the thorax of a female imago of southern house mosquito (Culex pipiens pallens), followed by transferring the insect tested to a plastic cup, and then leaving to stand at 25° C. together with sugar solution as feed. One day later, the life and death of the insect tested are observed to determine a mortality rate of insect. The number of southern house mosquito tested is 10 per a test and they are transferred into one cup.

As a result, an effect on southern house mosquito treated with natural pyrethrin or MX can be confirmed.

### Test Example 32

An acetone solution of a predetermined concentration of natural pyrethrin or MX is prepared. Zero point three microliters (0.3 μl) of the acetone solution is dripped on the dorsal side of the thorax of a female imago of brown house mosquito (Culex quinquefasciatus), followed by transferring the insect tested to a plastic cup, and then leaving to stand at 25° C. together with sugar solution as feed. One day later, the life and death of the insect tested are observed to determine a mortality rate of insect. The number of brown house mosquito tested is 10 per a test and they are transferred into one cup.

As a result, an effect on brown house mosquito treated with natural pyrethrin or MX can be confirmed.

### Test Example 33

An acetone solution of a predetermined concentration of natural pyrethrin or MX is prepared. Zero point three microliters (0.3 μl) of the acetone solution is dripped on the dorsal side of the thorax of a female imago of Asian tiger mosquito (Aedes albopictus), followed by transferring the insect tested to a plastic cup, and then leaving to stand at 25° C. together with sugar solution as feed. One day later, the life and death of the insect tested are observed to determine a mortality rate of insect. The number of Asian tiger mosquito tested is 10 per a test and they are transferred into one cup.

As a result, an effect on Asian tiger mosquito treated with natural pyrethrin or MX can be confirmed.

### Test Example 34

An acetone solution of a predetermined concentration of natural pyrethrin or MX is prepared. Zero point three microliters (0.3 μl) of the acetone solution is dripped on the dorsal side of the thorax of a female imago of dengue mosquito (Aedes aegypti), followed by transferring the insect tested to a plastic cup, and then leaving to stand at 25° C. together with sugar solution as feed. One day later, the life and death of the insect tested are observed to determine a mortality rate of insect. The number of dengue mosquito tested is 10 per a test and they are transferred into one cup.

As a result, an effect on dengue mosquito treated with natural pyrethrin or MX can be confirmed.

### Test Example 35

An acetone solution of a predetermined concentration of natural pyrethrin or MX is prepared. Zero point three microliters (0.3 μl) of the acetone solution is dripped on the dorsal side of the thorax of a female imago of Ganbiehamadaraka (Anopheles gambiae), followed by transferring the insect tested to a plastic cup, and then leaving to stand at 25° C. together with sugar solution as feed. One day later, the life and death of the insect tested are observed to determine a mortality rate of insect. The number of Ganbiehamadaraka tested is 10 per a test and they are transferred into one cup.

As a result, an effect on Ganbiehamadaraka treated with natural pyrethrin or MX can be confirmed.

### Test Example 36

Two milligrams (2 mg) of natural pyrethrin or MX is weighed into a screw tube (Maruemu No. 5; 27×55 mm), followed by adding 0.2 mL of acetone, and then closing the lid to dissolve. The screw tube is rotated and inverted to coat the entire inner wall evenly with the chemical liquid, the lid is removed to be allowed to air-dry for about 2 hours, and then one group of five unbloodsucking young mites of Futatogechimadani (Haemaphysalis longicornis) are released therein, followed by closing the lid. Two days later, the number of the dead insect is counted to determine a mortality rate of insect.

$$Mortality rate of insect ( \% ) = 100 \times ( the number of dead insects / number of insects insect )$$

As a result, an effect on Futatogechimadani can be observed.

### Test Example 37

A chemical liquid for test is prepared by dissolving 5 mg of natural pyrethrin or MX in 5 mL of propylene carbonate so as to be 0.1% w/v. On the day before the administration of the chemical liquid for test, a mouse is inoculated with 30 mites tested (Futatogechimadani, young mite). Before a drip treatment, non-parasitic mites are removed.

Two hundred microliters (200 μl) of the above chemical liquid for test is drip-administrated using a pipette on the whole body surface of the mouse. To a control group, 200 μL of propylene carbonate is solely administrated. Three repetitions are performed per group. Two days after drip-administrating, the lethal number of mites tested is observed and a mortality rate of insect is calculated by the following formula.

$$Mortality rate of insect ( \% ) = 100 \times ( number of dead insects / number of parasitic insects before dripping )$$

As a result, an effect on Futatogechimadani can be observed.

### INDUSTRIAL APPLICABILITY

According to the present invention, pest arthropods can be controlled.

1-3. (canceled)

4. A method for controlling a pest arthropod, comprising applying a pest arthropod control composition comprising natural pyrethrin and one or more ingredients selected from the group consisting of sabadilla seed extract, cevadine, and veratridine, to the pest arthropod, or to a place where the pest arthropod occurs.

5. The pest arthropod control method according to claim 4, wherein the pest arthropod control composition is an aerosol formulation.

6. The pest arthropod control method according to claim 5, wherein the aerosol formulation is an aerosol formulation comprising at least one of dimethyl ether and liquefied petroleum gas as propellant.

7. The pest arthropod control method according to claim 5, wherein the aerosol formulation is an aerosol formulation further comprising as liquid carrier at least one selected from the group consisting of aliphatic hydrocarbons, aromatic hydrocarbons, esters, carbonates, and alcohols.

8. The pest arthropod control method according to claim 5, wherein the aerosol formulation is an aerosol formulation further comprising water.

9. The pest arthropod control method according to claim 4, wherein the pest arthropod control composition is a pump spray formulation.

10. The pest arthropod control method according to claim 9, wherein the pump spray formulation is a pump spray formulation comprising as a liquid carrier at least one selected from the group consisting of water, aliphatic hydrocarbons, aromatic hydrocarbons, esters, carbonates, and alcohols.

11. The pest arthropod control method according to claim 4, wherein the pest arthropod comprises at least one pest arthropod selected from the group consisting of Blattodea, Hymenoptera, Diptera, Siphonaptera, Acari, Lepidoptera, and Coleoptera.

12. The pest arthropod control method according to claim 4, wherein the pest arthropod comprises at least one pest arthropod selected from the group consisting of Blattodea, Hymenoptera, and Diptera.

13. The pest arthropod control method according to claim 4, wherein the pest arthropod comprises is at least one of pest arthropod in Blattodea selected from the group consisting of German cockroach (Blattella germanica), smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis), Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.

14. The pest arthropod control method according to claim 4, wherein the pest arthropod comprises at least one of pest arthropod in Blattodea selected from the group consisting of smoky-brown cockroach (Periplaneta fuliginosa), American cockroach (Periplaneta americana), Australian cockroach (Periplaneta australasiae), brown cockroach (Periplaneta brunnea), black cockroach (Blatta orientalis), Japanese termite (Reticulitermes speratus), Formosan termite (Coptotermes formosanus), western drywood termite (Incisitermes minor), Daikokushiroari (Cryptotermes domesticus), Taiwanshiroari (Odontotermes formosanus), Koshunshiroari (Neotermes koshunensis), Satsumashiroari (Glyptotermes satsumensis), Nakajimashiroari (Glyptotermes nakajimai), Katanshiroari (Glyptotermes fuscus), Oshiroari (Hodotermopsis sjostedti), Koshuieshiroari (Coptotermes guangzhouensis), Amamishiroari (Reticulitermes amamianus), Miyatakeshiroari (Reticulitermes miyatakei), Kanmonshiroari (Reticulitermes kanmonensis), Takasagoshiroari (Nasutitermes takasagoensis), Nitobeshiroari (Pericapritermes nitobei), Mushashiroari (Sinocapritermes mushae), and Cornitermes cumulans.

15. The pest arthropod control method according to claim 4, wherein the pest arthropod comprises at least one of hymenopteran pest arthropod selected from the group consisting of red imported fire ant (Solenopsis invicta), tropical fire ant (Solenopsis geminata), Atta spp. consisting of brown leaf-cutting ant (Atta capiguara), Acromyrmex spp., Sashihariari (Paraponera clavata), black house ant (Ochetellus glaber), little red ant (Monomorium pharaonis), Argentine ant (Linepithema humile), Kuroyamaari (Formica japonica), Amimeari (Pristomyrmex punctutus), Ozuari (Pheidole noda), big-headed ant (Pheidole megacephala), Kurooari (Camponotus japonicus), Muneakaoari (Camponotus obscuripes), western harvester ant (Pogonomyrmex occidentalis), Kokamiari (Wasmania auropunctata), long-legged ant (Anoplolepis gracilipes), Asian giant hornet (Vespa mandarinia), Kebukasuzumebachi (Vespa simillima), Kogatasuzumebachi (Vespa analis), Asian hornet (Vespa velutina), Seguroashinagabachi (Polistes jokahamae), pine wood wasp (Urocerus gigas); and Bethylidae.

16. The pest arthropod control method according to claim 4, wherein the pest arthropod comprises at least one of Dipteran pest arthropod selected from the group consisting of cherry drosophila (Drosophila suzukii), fruit fly (Drosophila melanogaster), Okimonnomibae (Megaselia spiracularis), Ochobae (Clogmia albipunctata), Chibikurobanekinokobae (Bradysia difformis), hessian fly (Mayetiola destructor), paddy gall fly (Orseolia oryzae), Diopsis macrophthalma, Glossina palpalis, Glossina morsitans, Ashimadarabuyu (Simulium japonicum), Simulium damnosum, Phlebotominae, rice crane fly (Tipula aino), cranefly (Tipula oleracea), European cranefly (Tipula paludosa), southern house mosquito (Culex pipiens pallens), Kogataakaieka (Culex tritaeniorhynchus), Chikaieka (Culex pipiens f. molestus), brown house mosquito (Culex quinquefasciatus), northern house mosquito (Culex pipiens pipiens), Niseshirohashiieka (Culex vishnui), Asian tiger mosquito (Aedes albopictus), dengue mosquito (Aedes aegypti), Chinese malaria mosquito (Anopheles sinensis), Ganbiehamadaraka (Anopheles gambiae), Sutefensuhamadaraka (Anopheles stephensi), Anopheles coluzzii, Anopheles albimanus, Anopheles sundaicus, Anopheles arabiensis, Anopheles funestus, Anopheles darlingi, and Anopheles farauti, Anopheles minimus, Kiashiobuyu (Prosimulium yezoensis) and Tsumetogebuyu (Simulium ornatum), Ushiabu (Tabanus trigonus); house fly (Musca domestica), false stable fly (Muscina stabulans), biting house fly (Stomoxys calcitrans), buffalo fly (Haematobia irritans), Calliphoridae, Sarcophagidae, Oyusurika (Chironomus plumosus), Sesujiyusurika (Chironomus yoshimatsui), Haiiroyusurika (Glyptotendipes tokunagai), and Fannidae.

17. The pest arthropod control method according to claim 4, wherein the pest arthropod comprises at least one of Dipteran pest arthropod selected from the group consisting of cherry drosophila (Drosophila suzukii), fruit fly (Drosophila melanogaster), Okimonnomibae (Megaselia spiracularis), Ochobae (Clogmia albipunctata), Chibikurobanekinokobae (Bradysia difformis), hessian fly (Mayetiola destructor), paddy gall fly (Orseolia oryzae), Diopsis macrophthalma, Glossina palpalis, Glossina morsitans, Ashimadarabuyu(Simulium japonicum), Simulium damnosum, Phlebotominae, rice crane fly (Tipula aino), cranefly (Tipula oleracea), European cranefly (Tipula paludosa); southern house mosquito (Culex pipiens pallens), Kogataakaieka (Culex tritaeniorhynchus), Chikaieka (Culex pipiens f. molestus), northern house mosquito (Culex pipiens pipiens), Niseshirohashiieka (Culex vishnui), Asian tiger mosquito (Aedes albopictus), Chinese malaria mosquito (Anopheles sinensis), Sutefensuhamadaraka (Anopheles stephensi), Anopheles coluzzii, Anopheles albimanus, Anopheles sundaicus, Anopheles arabiensis, Anopheles funestus, Anopheles darlingi, Anopheles farauti, Anopheles minimus, Kiashiobuyu (Prosimulium yezoensis), Tsumetogebuyu (Simulium ornatum), Ushiabu (Tabanus trigonus), false stable fly (Muscina stabulans), biting house fly (Stomoxys calcitrans), buffalo fly (Haematobia irritans), Calliphoridae, Sarcophagidae, Oyusurika (Chironomus plumosus), Sesujiyusurika (Chironomus yoshimatsui), Haiiroyusurika (Glyptotendipes tokunagai), and Fannidae.

18. The pest arthropod control method according to claim 4, wherein the pest arthropod comprises at least one pest arthropod selected from the group consisting of German cockroach (Blattella germanica), American cockroach (Periplaneta americana), Formosan termite (Coptotermes formosanus), red imported fire ant (Solenopsis invicta), little red ant (Monomorium pharaonis), western harvester ant (Pogonomyrmex occidentalis), brown house mosquito (Culex quinquefasciatus), northern house mosquito (Culex pipiens pipiens), dengue mosquito (Aedes aegypti), Ganbiehamadaraka (Anopheles gambiae) and house fly (Musca domestica).

19. The pest arthropod control method according to claim 4, wherein the pest arthropod comprises at least one pest arthropod selected from the group consisting of American cockroach (Periplaneta americana), Formosan termite (Coptotermes formosanus), red imported fire ant (Solenopsis invicta), little red ant (Monomorium pharaonis), western harvester ant (Pogonomyrmex occidentalis) and northern house mosquito (Culex pipiens pipiens).

20. The pest arthropod control method according to claim 4, wherein the pest arthropod comprises a pest arthropod having reduced susceptibility to at least one selected from the group consisting of insecticides, acaricides, molluscicides and nematicides.

21. The pest arthropod control method according to claim 4, wherein the pest arthropod comprises is a pest arthropod having reduced susceptibility to at least one insecticide selected from the group consisting of GABA-gated chloride channel blockers, sodium channel modulators, and nicotinic acetylcholine receptor competitive modulators.

22. The pest arthropod control method according to claim 4, wherein the pest arthropod control composition further comprises dill extract.

23-24. (canceled)

25. The pest arthropod control method according to claim 4, wherein the pest arthropod control composition is applied to the place where the pest arthropod occurs, wherein at least one ingredient selected from the group consisting of the natural pyrethrin and the one or more ingredients is applied in an amount from 0.01 to 1000 mg per 1 m².

26. The pest arthropod control method according to claim 25, wherein the amount is from 10 to 500 mg per 1 m².

27. The pest arthropod control method according to claim 25, wherein the place where the pest arthropod occurs is at least one selected from the group consisting of architectural structures, outdoors, foods, and daily necessities.

28. The pest arthropod control method according to claim 25, comprising applying the pest arthropod control composition on a surface of the place where the pest arthropod occurs.

29-40. (canceled)

41. The pest arthropod control method according to claim 25, comprising applying by diluting the pest arthropod control composition with water and spraying.

42. The pest arthropod control method according to claim 25, wherein the pest arthropod control composition is an oil formulation, an emulsifiable concentrate, a wettable powder, a water dispersible granule, a flowable formulation or a microcapsule formulation.

43. The pest arthropod control method according to claim 25, wherein the pest arthropod control composition is a microcapsule formulation.

44-140. (canceled)
